(19) United States
(12) Patent Application Publication
(10) Pub. No.: US 2024/0265124 A1
(43) Pub. Date: Aug. 8, 2024

(54) DYNAMIC DATA PRODUCT CREATION

(71) Applicant: Dell Products L.P., Round Rock, TX (US)

(72) Inventors: David Edward Frattura, Stamford, CT (US); Stephen James Todd, North Andover, MA (US); Eloy Francisco Macha, Crowley, TX (US); Robert Anthony Lincourt, JR., Franklin, MA (US)

(21) Appl. No.: 18/162,208

(22) Filed: Jan. 31, 2023

(51) Int. Cl. G06F 21/62; G06F 16/908

(52) U.S. Cl. CPC G06F 21/6218; G06F 16/908; G06F 2221/2115

(57) ABSTRACT

A method and system for dynamic data product creation. A data product may refer to a collection of one or more datasets to which versioning, a set of policies, and/or a set of constraints may be attached. Existing systems/solutions offering data products today rely on the availability of static assets supported by static metadata descriptive thereof. As an improvement over said existing systems/solutions, embodiments disclosed herein enable newly introduced and ingested information, from across various data sources, to update any relevant data product(s) accordingly. Further, versions of any data products may be tracked and be made readily available to users seeking to reproduce work contingent on certain versions of one or more assets that may have been used to originally produce said work at a given point-in-time. Moreover, accessibility or inaccessibility to any given asset may depend on the access authority granted to the user(s) seeking said given asset.

### BACKGROUND

Organization strategy may reference a plan (or a sum of actions), intended to be pursued by an organization, directed to leveraging organization resources towards achieving one or more long-term goals. Said long-term goal(s) may, for example, relate to identifying or predicting future or emergent trends across one or more industries. Digitally-assisted organization strategy, meanwhile, references the scheming and/or implementation of organization strategy, at least in part, through insights distilled by artificial intelligence.

### SUMMARY

In general, in one aspect, embodiments disclosed herein relate to a method for creating data products. The method includes: receiving a data query including at least one data topic; obtaining a metadata graph representative of an asset catalog; filtering, based on the at least one data topic, the metadata graph to identify at least one node subset; generating a k-partite metadata graph using the at least one node subset; and creating a data product based on the k-partite metadata graph.

In general, in one aspect, embodiments disclosed herein relate to a non-transitory computer readable medium (CRM). The non-transitory CRM includes computer readable program code, which when executed by a computer processor, enables the computer processor to perform a method for creating data products. The method includes: receiving a data query including at least one data topic; obtaining a metadata graph representative of an asset catalog; filtering, based on the at least one data topic, the metadata graph to identify at least one node subset; generating a k-partite metadata graph using the at least one node subset; and creating a data product based on the k-partite metadata graph.

In general, in one aspect, embodiments disclosed herein relate to a system. The system includes: a client device; and an insight service operatively connected to the client device, and including a computer processor configured to perform a method for creating data products. The method includes: receiving, from the client device, a data query including at least one data topic; obtaining a metadata graph representative of an asset catalog; filtering, based on the at least one data topic, the metadata graph to identify at least one node subset; generating a k-partite metadata graph using the at least one node subset; and creating a data product based on the k-partite metadata graph.

Other aspects disclosed herein will be apparent from the following description and the appended claims.

### BRIEF DESCRIPTION OF DRAWINGS

FIG. 1A shows a system in accordance with one or more embodiments disclosed herein.

FIG. 1B shows a client device in accordance with one or more embodiments disclosed herein.

FIG. 2A shows an example connected graph in accordance with one or more embodiments disclosed herein.

FIGS. 2B-2D show example k-partite connected graphs in accordance with one or more embodiments disclosed herein.

FIGS. 3A-3C show flowcharts describing a method for dynamic data product creation in accordance with one or more embodiments disclosed herein.

FIG. 3D shows a flowchart describing a method for updating availability remarks in accordance with one or more embodiments disclosed herein.

FIGS. 4A and 4B show flowcharts describing a method for metadata-based learning curriculum generation in accordance with one or more embodiments disclosed herein.

FIGS. 5A-5C show flowcharts describing a method for metadata-based query rewriting in accordance with one or more embodiments disclosed herein.

FIGS. 6A-6C show flowcharts describing a method for insight lineage tracking in accordance with one or more embodiments disclosed herein.

FIGS. 7A-7H show flowcharts describing a method for metadata-based feature expansion for automated machine learning processes in accordance with one or more embodiments disclosed herein.

FIGS. 8A and 8B flowcharts describing a method for intent-driven adaptive learning delivery in accordance with one or more embodiments disclosed herein.

FIG. 9 shows a flowchart describing a method for learning acceleration using insight-assisted introductions in accordance with one or more embodiments disclosed herein.

FIGS. 10A and 10B show flowcharts describing a method for business intent-assisted search in accordance with one or more embodiments disclosed herein.

FIG. 11 shows a flow chart describing a method for insight gap recommendations in accordance with one or more embodiments disclosed herein.

FIGS. 12A-12D show flowcharts describing a method for insight value assessments using post-insight feedback in accordance with one or more embodiments disclosed herein.

FIGS. 13A-13F show flowcharts describing a method for impact enhancing recommendations for research papers and initiatives in accordance with one or more embodiments disclosed herein.

FIGS. 14A-14C show flowcharts describing a method for insight creation filtering in accordance with one or more embodiments disclosed herein.

FIGS. 15A and 15B show flowcharts describing a method for insight creation transparency in accordance with one or more embodiments disclosed herein.

FIG. 16A shows a flowchart describing a method for the prediction of and support readiness for future business intents in accordance with one or more embodiments disclosed herein.

FIG. 16B shows a flowchart describing a method for pursuing an inter-intent roadmap in accordance with one or more embodiments disclosed herein.

FIGS. 17A and 17B show flowcharts describing a method for dynamic questioning intelligence in accordance with one or more embodiments disclosed herein.

FIGS. 17C and 17D show flowcharts describing a method for performing a pre-work pipeline in accordance with one or more embodiments disclosed herein.

FIGS. 18A and 18B show flowcharts describing a method for business intent based communications enhancement in accordance with one or more embodiments disclosed herein.

FIG. 19 shows a flowchart describing a method for crowd-sourced research relevance tracking and analytics in accordance with one or more embodiments disclosed herein.

FIG. 20 shows an example computing system in accordance with one or more embodiments disclosed herein.

FIGS. 21A-21G show an example scenario in accordance with one or more embodiments disclosed herein.

FIGS. 22A-22I show an example scenario in accordance with one or more embodiments disclosed herein.

FIGS. 23A-23L show an example scenario in accordance with one or more embodiments disclosed herein.

FIGS. 24A-24C show an example scenario in accordance with one or more embodiments disclosed herein.

FIGS. 25A-250 show an example scenario in accordance with one or more embodiments disclosed herein.

FIGS. 26A-26J show an example scenario in accordance with one or more embodiments disclosed herein.

FIGS. 27A-27C show an example scenario in accordance with one or more embodiments disclosed herein.

FIGS. 28A-28Q show example scenarios in accordance with one or more embodiments disclosed herein.

FIGS. 29A-29F show an example scenario in accordance with one or more embodiments disclosed herein.

FIGS. 30A-30P show an example scenario in accordance with one or more embodiments disclosed herein.

FIGS. 31A-31C show an example scenario in accordance with one or more embodiments disclosed herein.

FIGS. 32A and 32B show an example scenario in accordance with one or more embodiments disclosed herein.

FIG. 33 shows an example scenario in accordance with one or more embodiments disclosed herein.

FIG. 34 shows an example scenario in accordance with one or more embodiments disclosed herein.

FIGS. 35A-35R show an example scenario in accordance with one or more embodiments disclosed herein.

FIGS. 36A and 36B show an example scenario in accordance with one or more embodiments disclosed herein.

FIG. 37A shows an example web browser in accordance with one or more embodiments disclosed herein.

FIGS. 37B-37L shows example scenarios in accordance with one or more embodiments disclosed herein.

### DETAILED DESCRIPTION

Specific embodiments disclosed herein will now be described in detail with reference to the accompanying figures. In the following detailed description of the embodiments disclosed herein, numerous specific details are set forth in order to provide a more thorough understanding disclosed herein. However, it will be apparent to one of ordinary skill in the art that the embodiments disclosed herein may be practiced without these specific details. In other instances, well-known features have not been described in detail to avoid unnecessarily complicating the description.

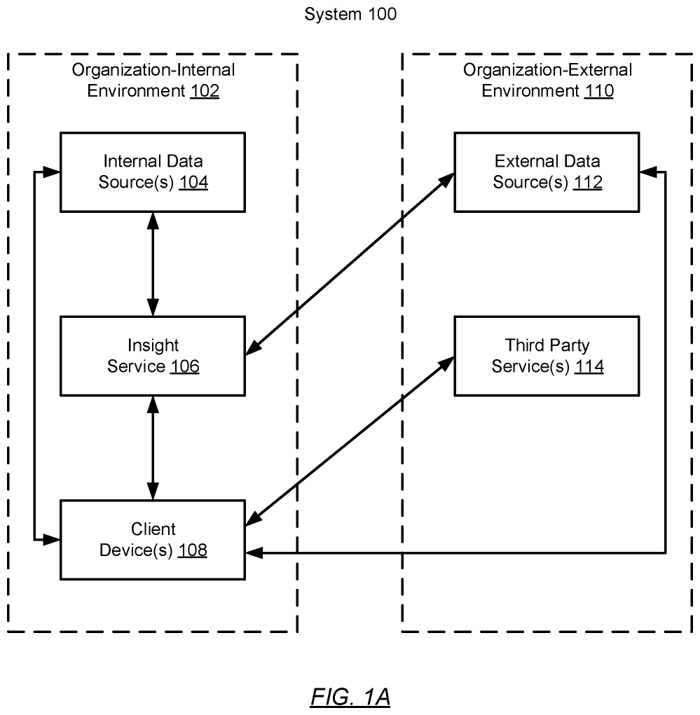

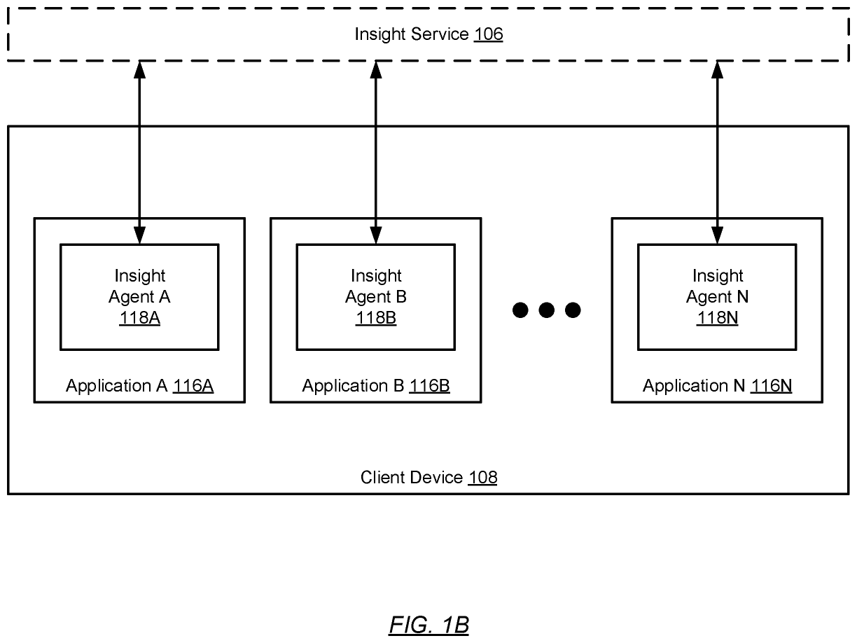

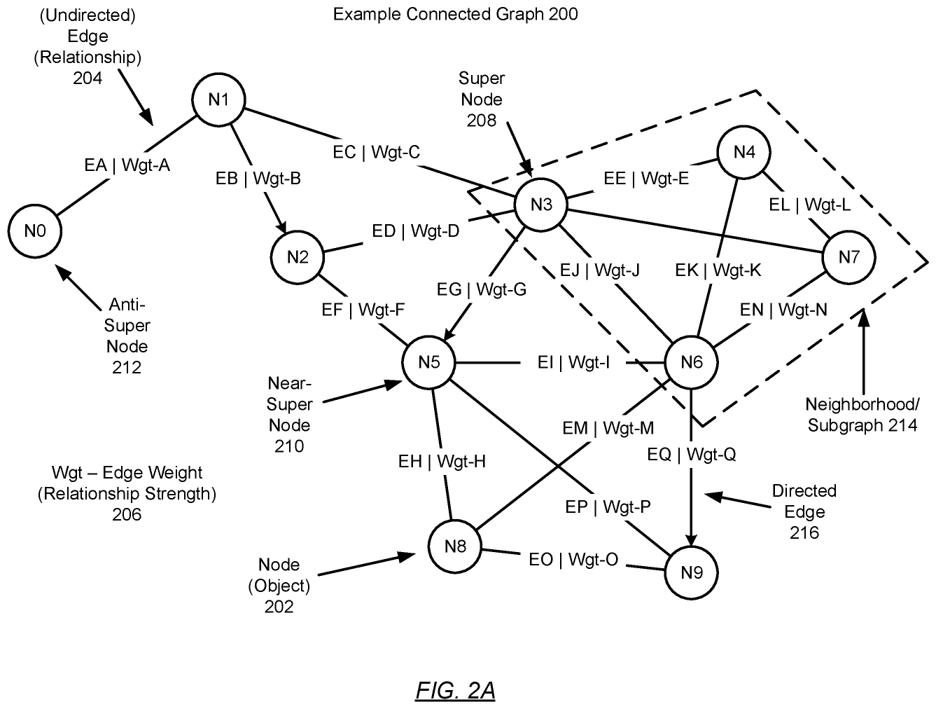

In the following description of FIGS. 1A-37L, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to necessarily imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and a first element may encompass more than one element and succeed (or precede) the second element in an ordering of elements.

In general, embodiments disclosed herein relate to dynamic data product creation. A data product may refer to a collection of one or more datasets to which versioning (e.g., a product version number), a set of policies, and/or a set of constraints may be attached. Existing systems or solutions offering data products today rely on the availability of static assets supported by static metadata descriptive thereof. As an improvement over said existing systems/solutions, embodiments disclosed herein enable newly introduced and ingested information, from across various data sources, to update any relevant data product(s) accordingly. Further, versions of any data products may be tracked and be made readily available to users seeking to reproduce work contingent on certain versions of one or more assets that may have been used to originally produce said work at a given point-in-time. Moreover, accessibility or inaccessibility to any given asset (e.g., dataset) may depend on the access authority granted to the user(s) seeking said given asset.

FIG. 1A shows a system in accordance with one or more embodiments disclosed herein. The system (100) may include an organization-internal environment (102) and an organization-external environment (110). Each of these system (100) components is described below.

In one or many embodiment(s) disclosed herein, the organization-internal environment (102) may represent any digital (e.g., information technology (IT)) ecosystem belonging to, and thus managed by, an organization. Examples of said organization may include, but are not limited to, a business/commercial entity, a higher education school, a government agency, and a research institute. The organization-internal environment (102), accordingly, may at least reference one or more data centers of which the organization is the proprietor. Further, the organization-internal environment (102) may include one or more internal data sources (104), an insight service (106), and one or more client devices (108). Each of these organization-internal environment (102) subcomponents may or may not be co-located, and thus reside and/or operate, in the same physical or geographical space. Moreover, each of these organization-internal environment (102) subcomponents is described below.

In one or many embodiment(s) disclosed herein, an internal data source (104) may represent any data source belonging to, and thus managed by, the above-mentioned organization. A data source, in turn, may generally refer to a location where data or information (also referred to herein as one or more assets) resides. An asset, accordingly, may be exemplified through structured data/information (e.g., tabular data/information or a dataset) or through unstructured data/information (e.g., text, an image, audio, a video, an animation, multimedia, etc.). Furthermore, any internal data source (104), more specially, may refer to a location that stores at least a portion of the asset(s) generated, modified, or otherwise interacted with, solely by entities (e.g., the insight service (106) and/or the client device(s) (108)) within the organization-internal environment (102). Entities outside the organization-internal environment may not be permitted to access any internal data source (104) and, therefore, may not be permitted to access any asset(s) maintained therein.

Moreover, in one or many embodiment(s) disclosed herein, any internal data source (104) may be implemented as physical storage (and/or as logical/virtual storage spanning at least a portion of the physical storage). The physical storage may, at least in part, include persistent storage, where examples of persistent storage may include, but are not limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM).

In one or many embodiment(s) disclosed herein, the insight service (106) may represent information technology infrastructure configured for digitally-assisted organization strategy. In brief, organization strategy may reference a plan (or a sum of actions), intended to be pursued by an organization, directed to leveraging organization resources towards achieving one or more long-term goals. Said long-term goal(s) may, for example, relate to identifying or predicting future or emergent trends across one or more industries. Digitally-assisted organization strategy, meanwhile, references the scheming and/or implementation of organization strategy, at least in part, through insights distilled by artificial intelligence. An insight, in turn, may be defined as a finding (or more broadly, as useful knowledge) gained through data analytics or, more precisely, through the discovery of patterns and/or relationships amongst an assortment of data/information (e.g., assets). The insight service (106), accordingly, may employ artificial intelligence to ingest assets maintained across various data sources (e.g., one or more internal data sources (104) and/or one or more external data sources (112)) and, subsequently, derive or infer insights therefrom that are supportive of an organization strategy for an organization.

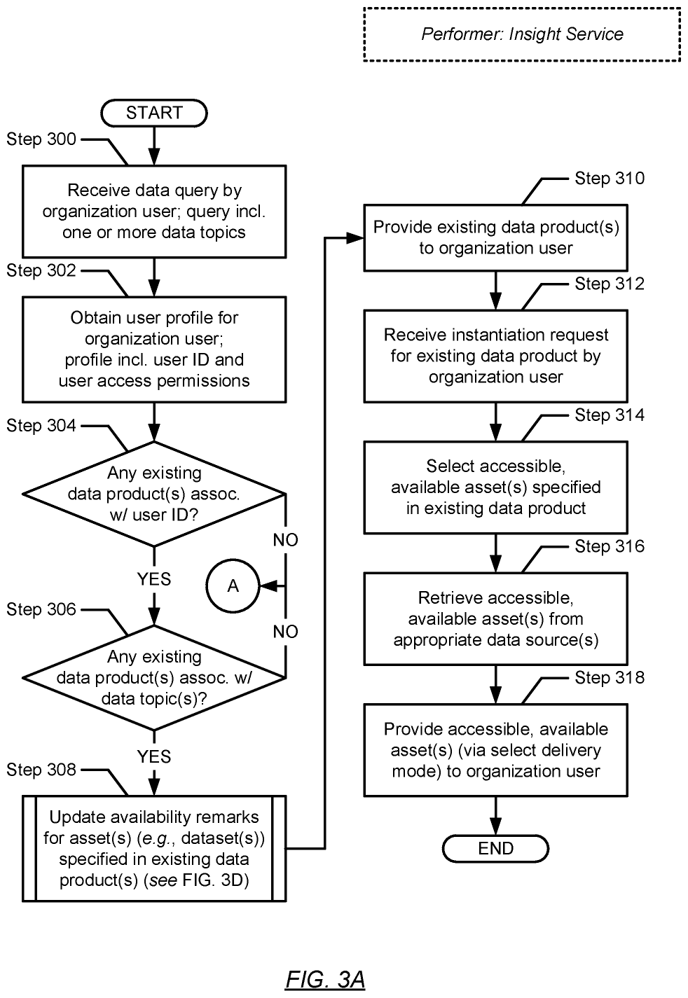

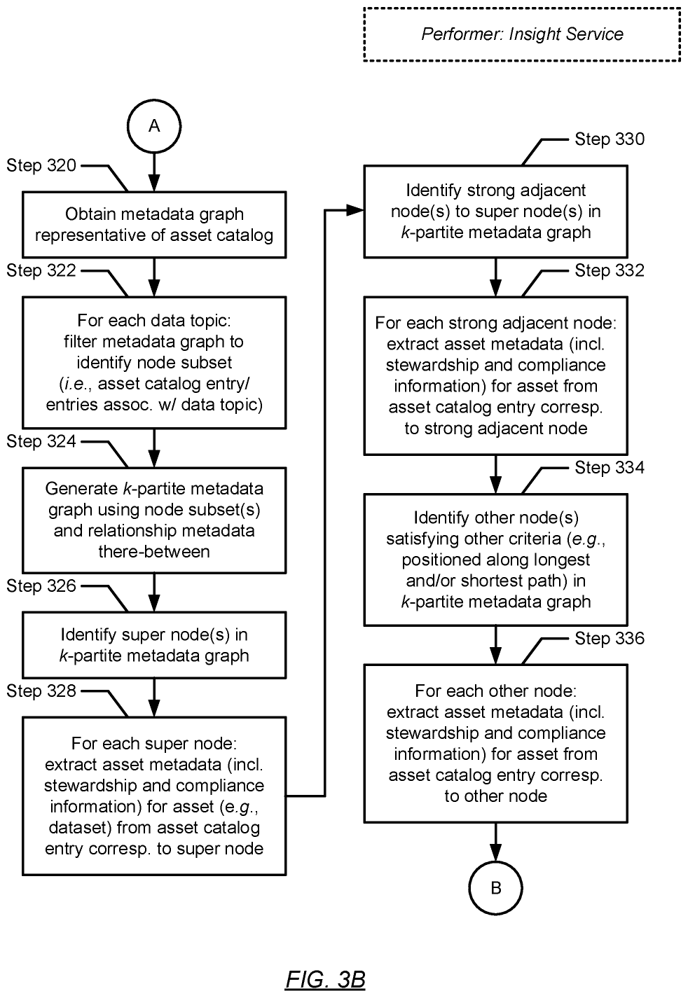

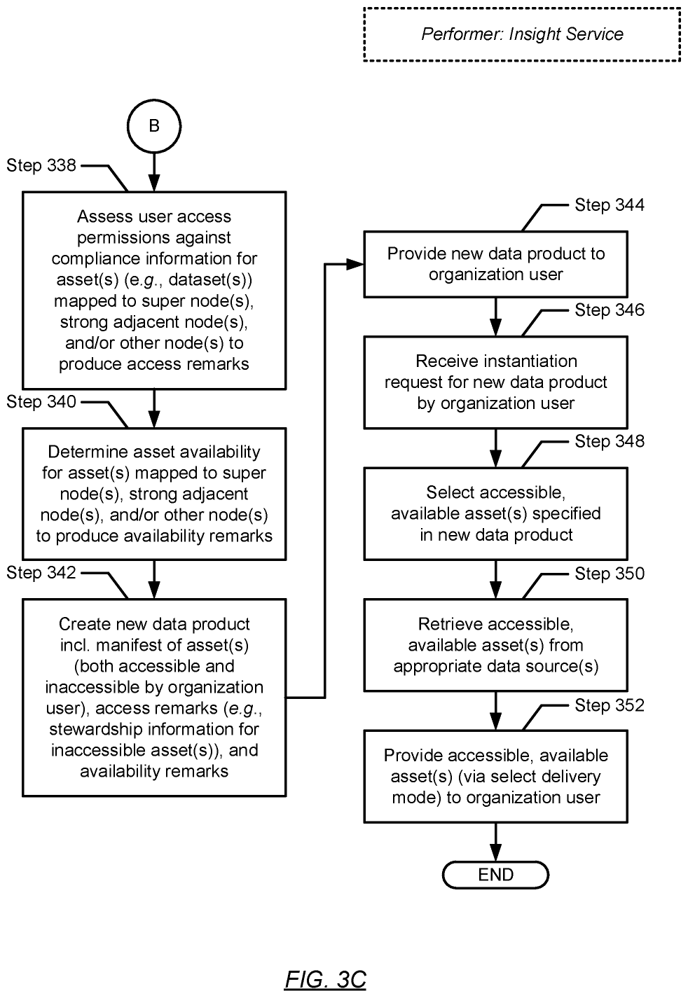

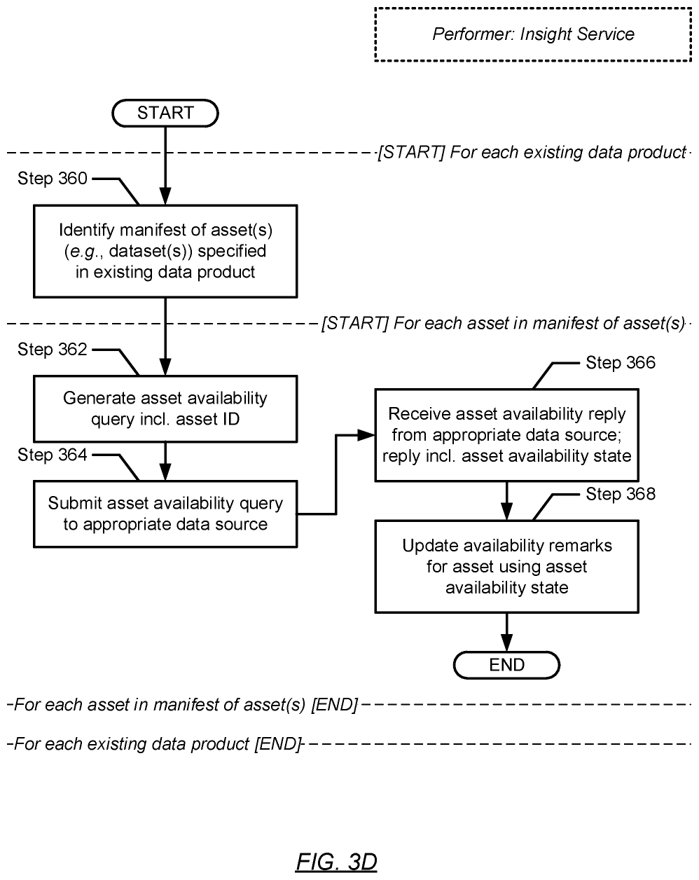

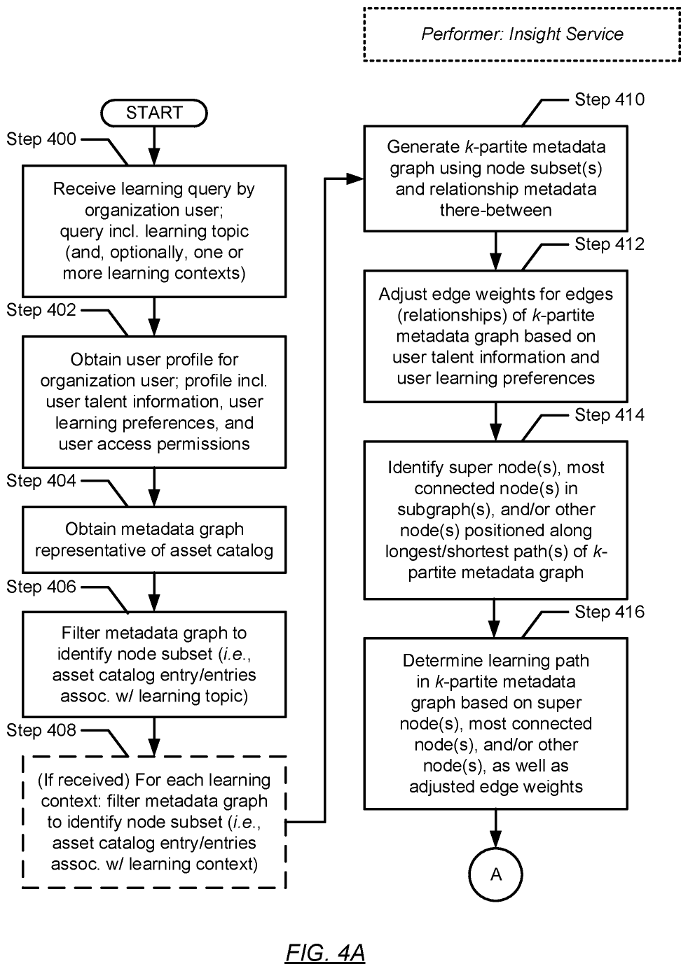

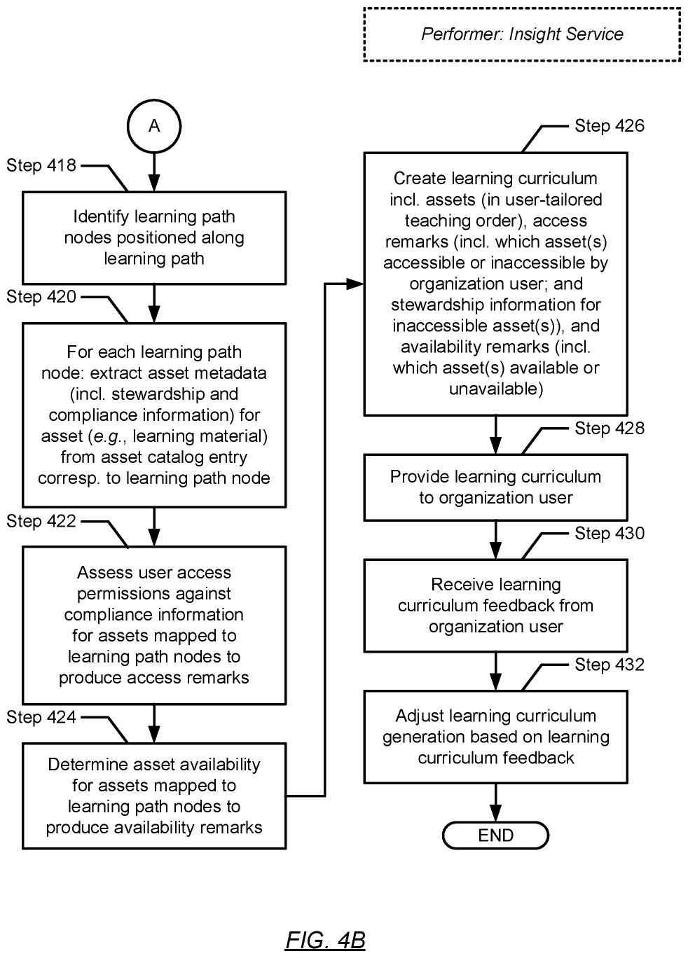

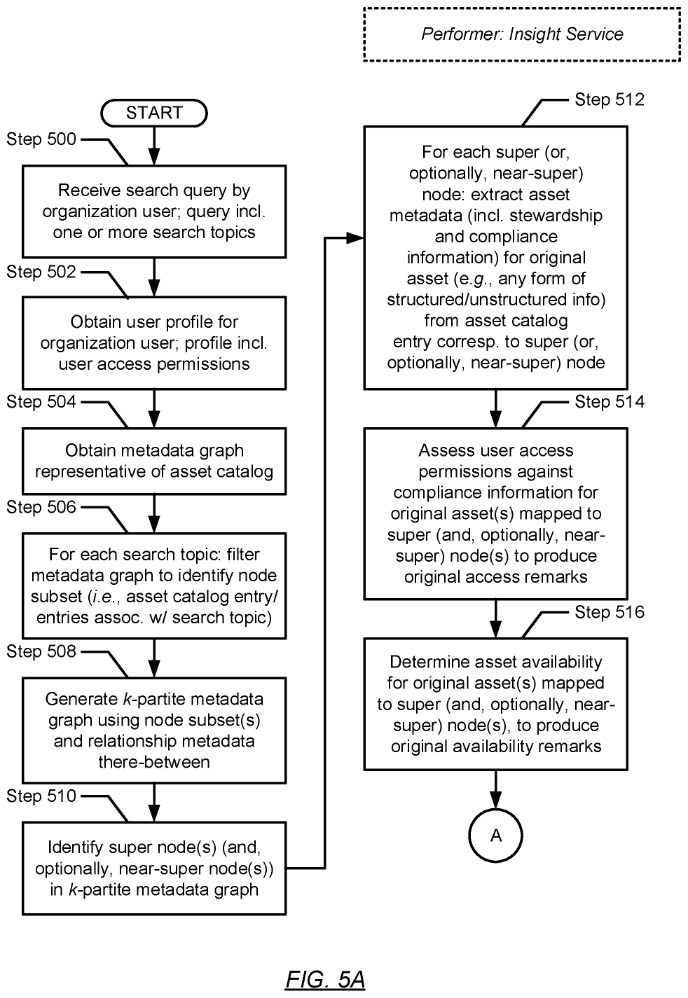

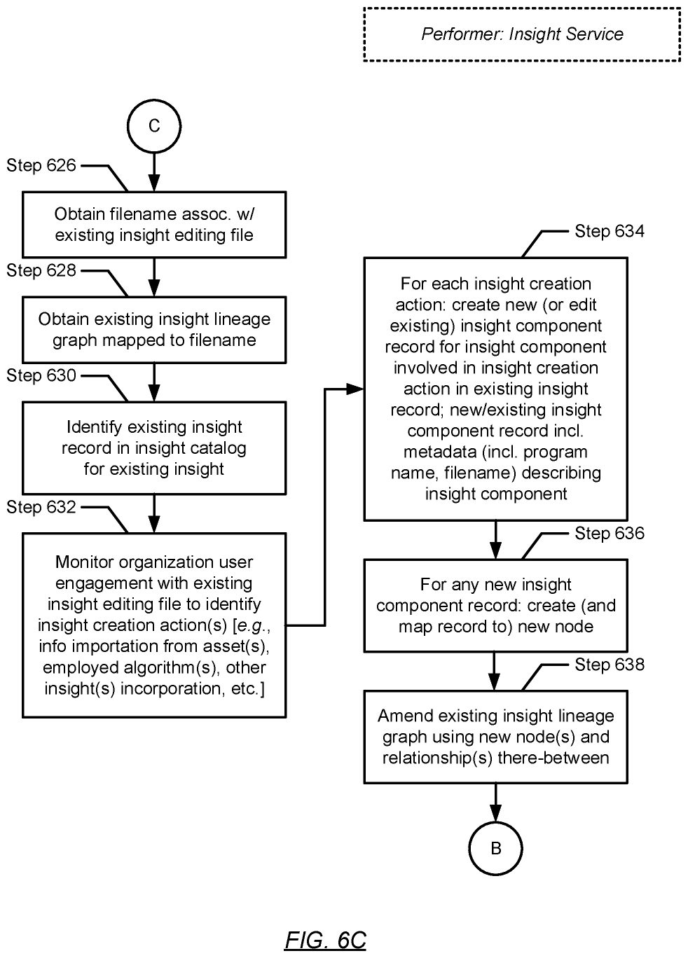

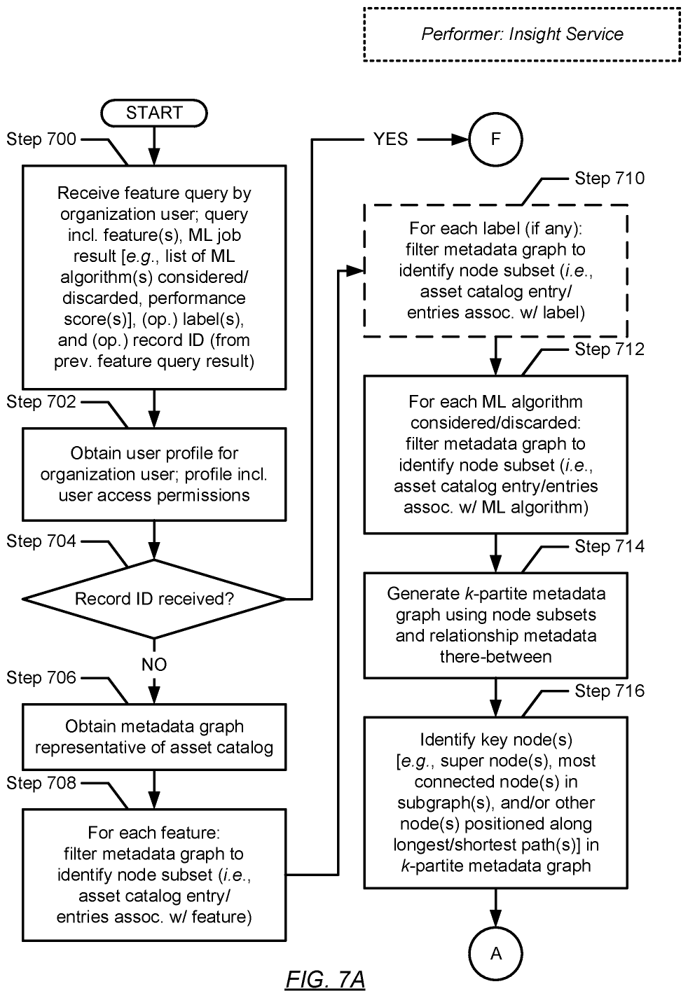

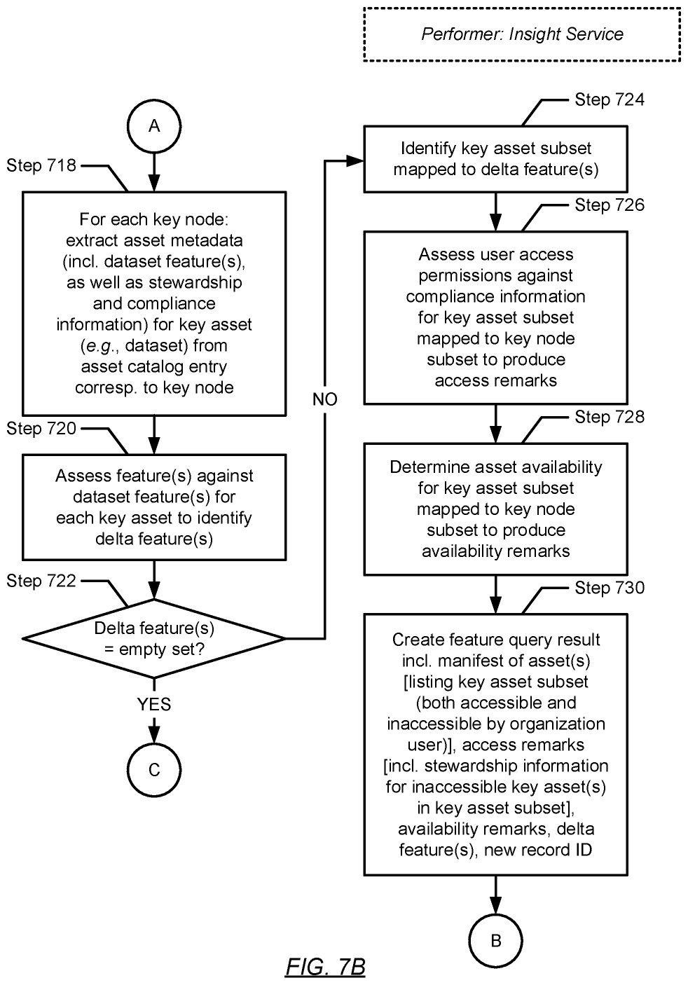

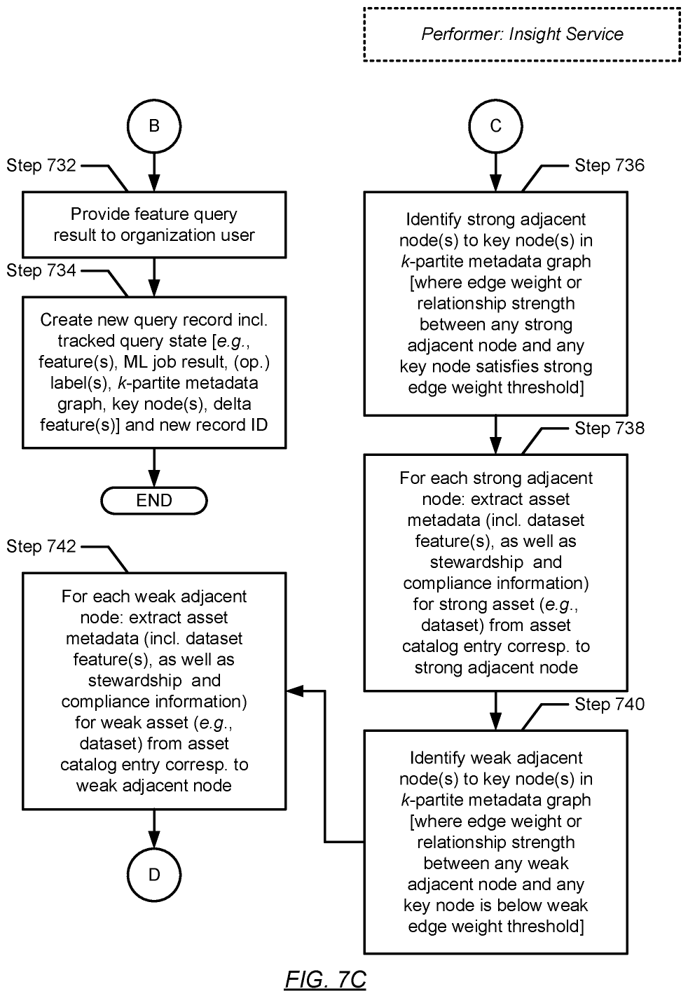

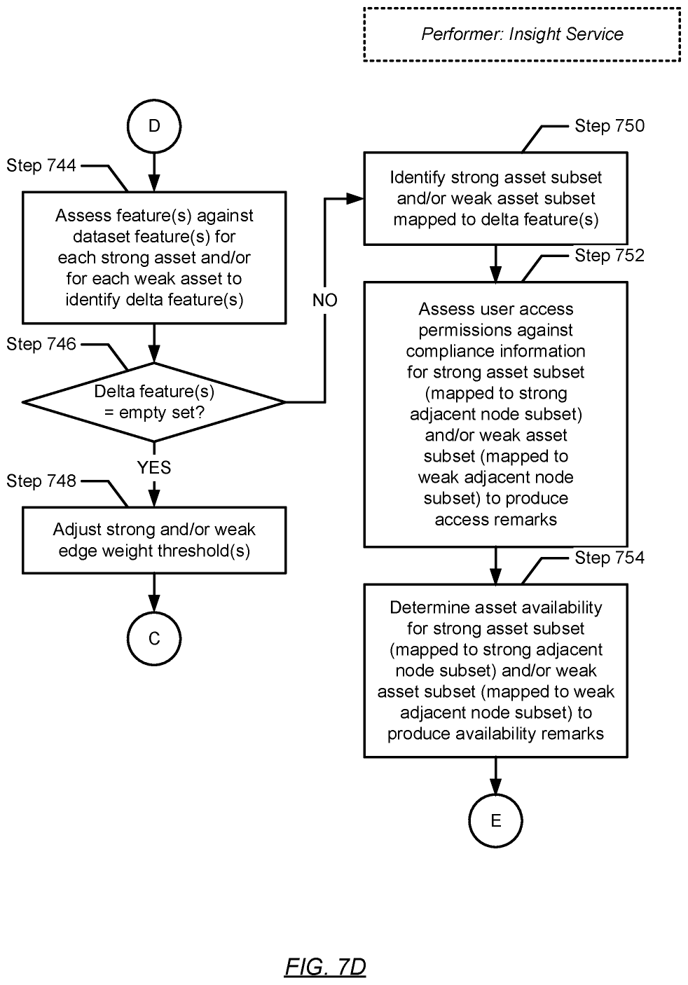

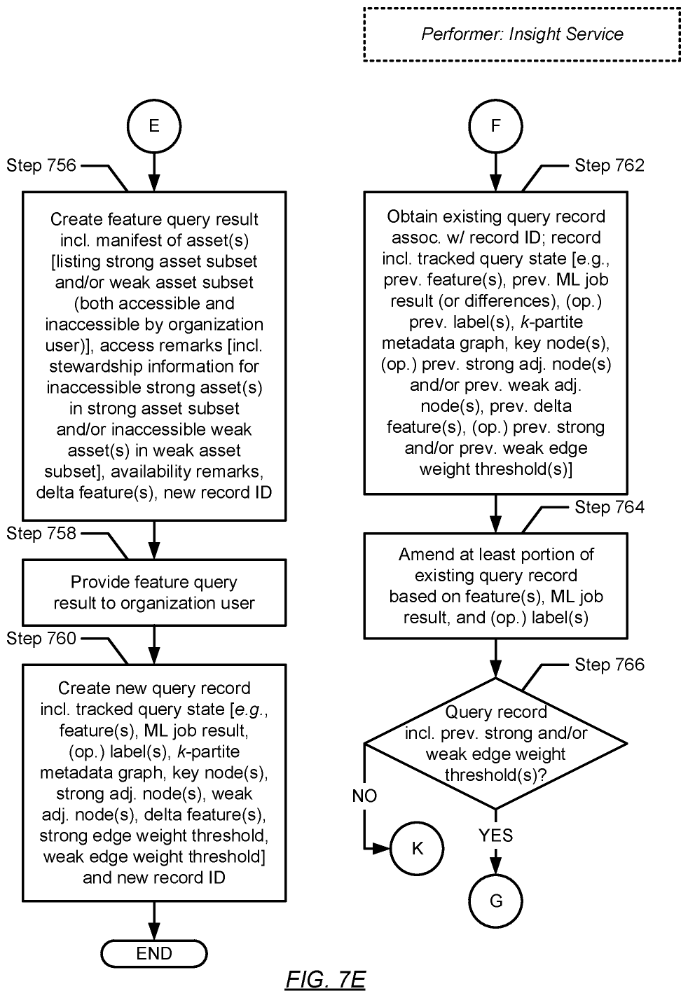

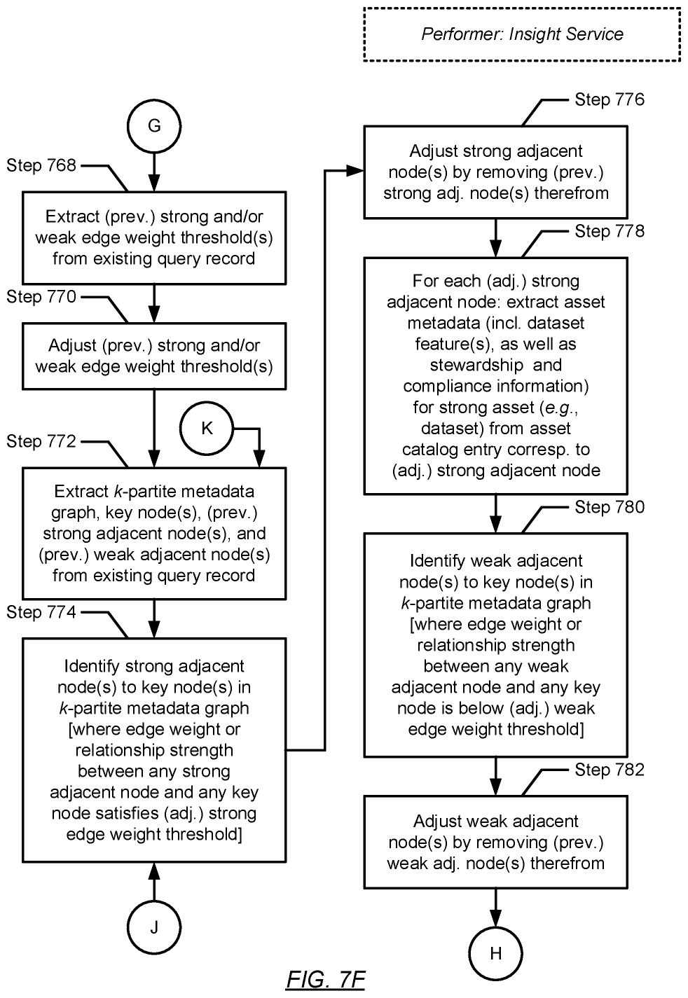

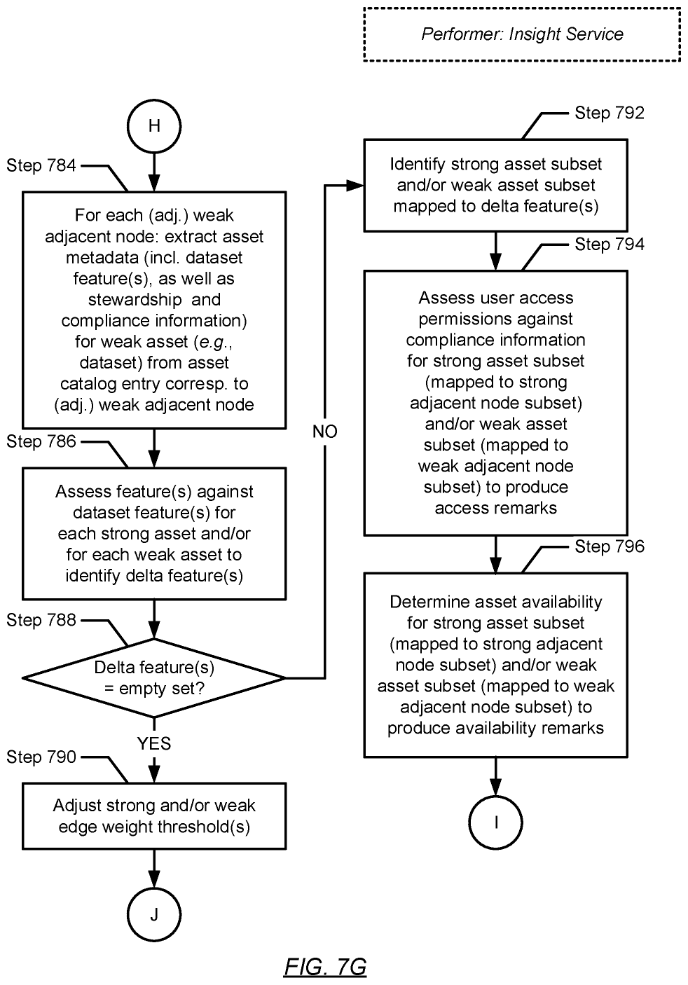

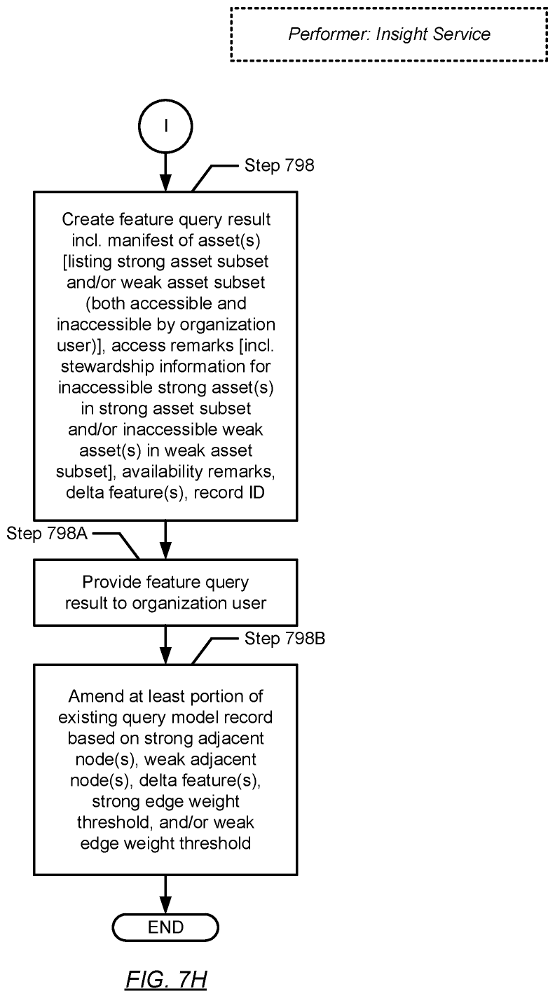

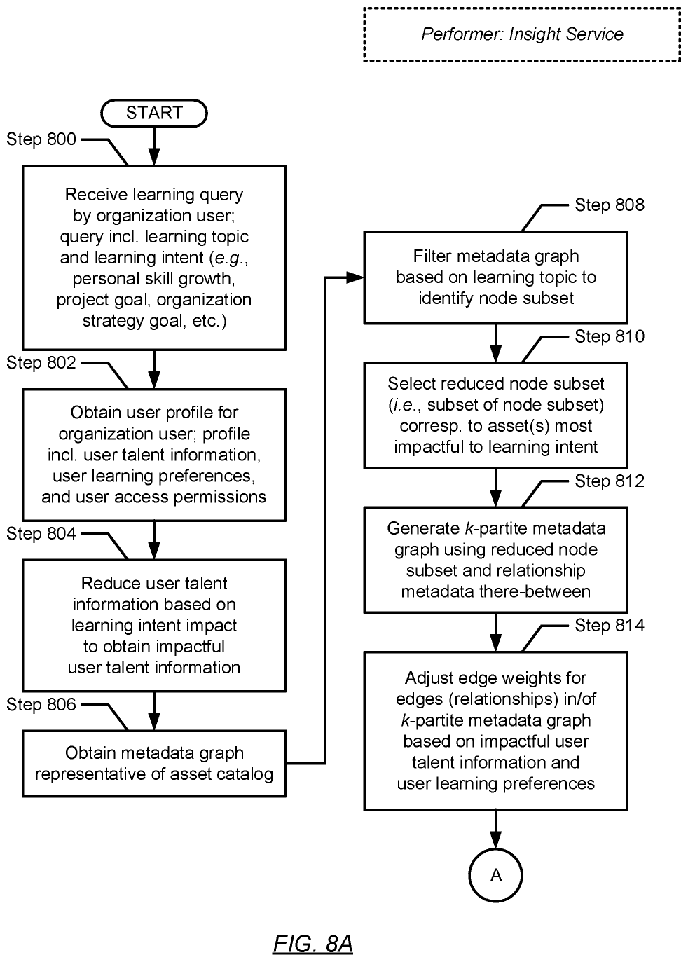

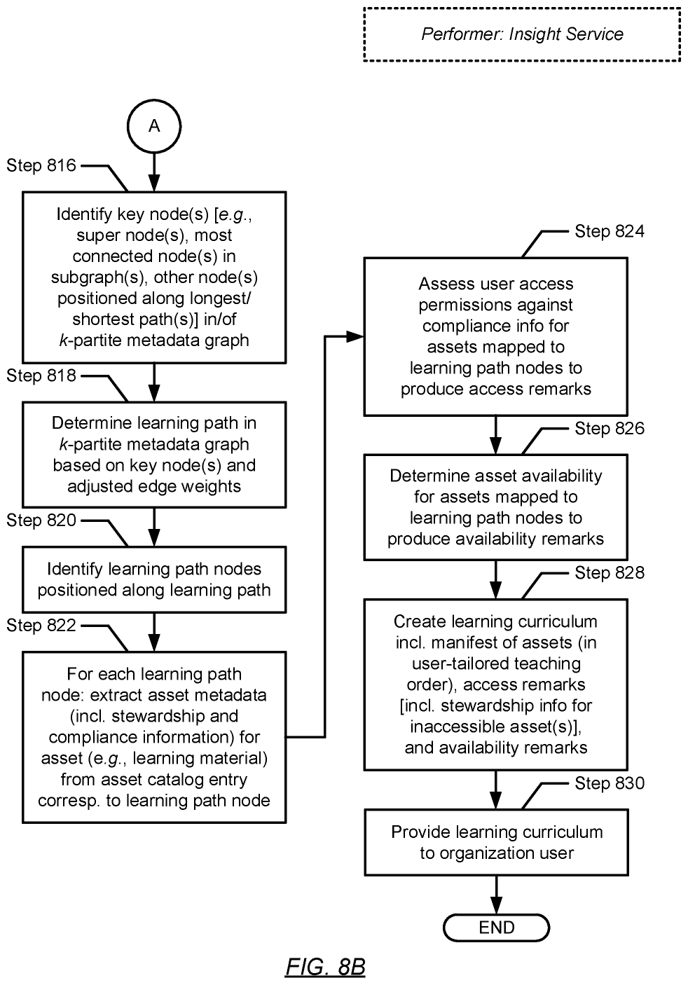

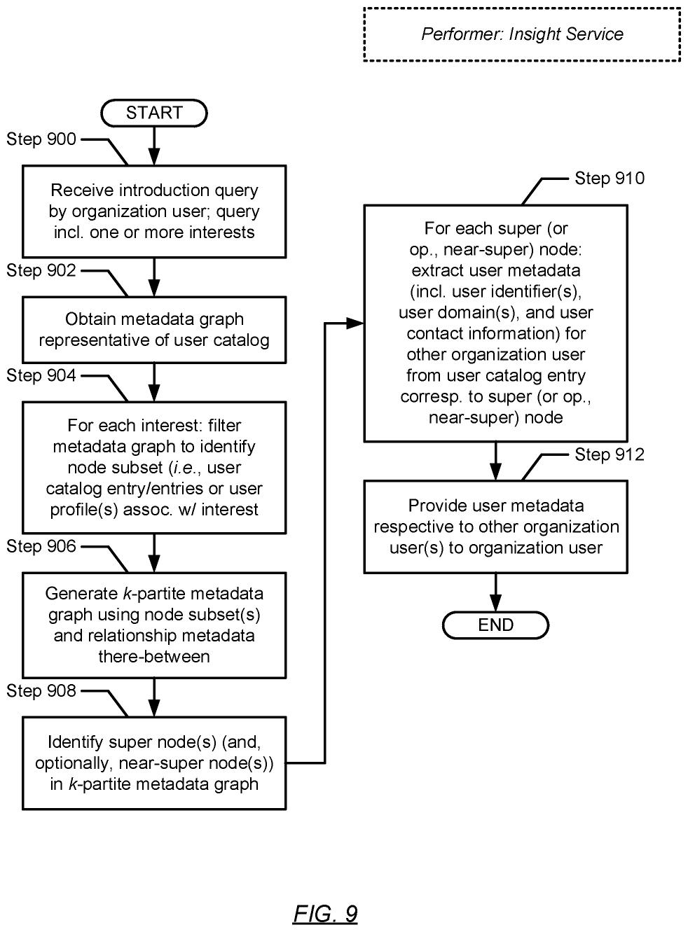

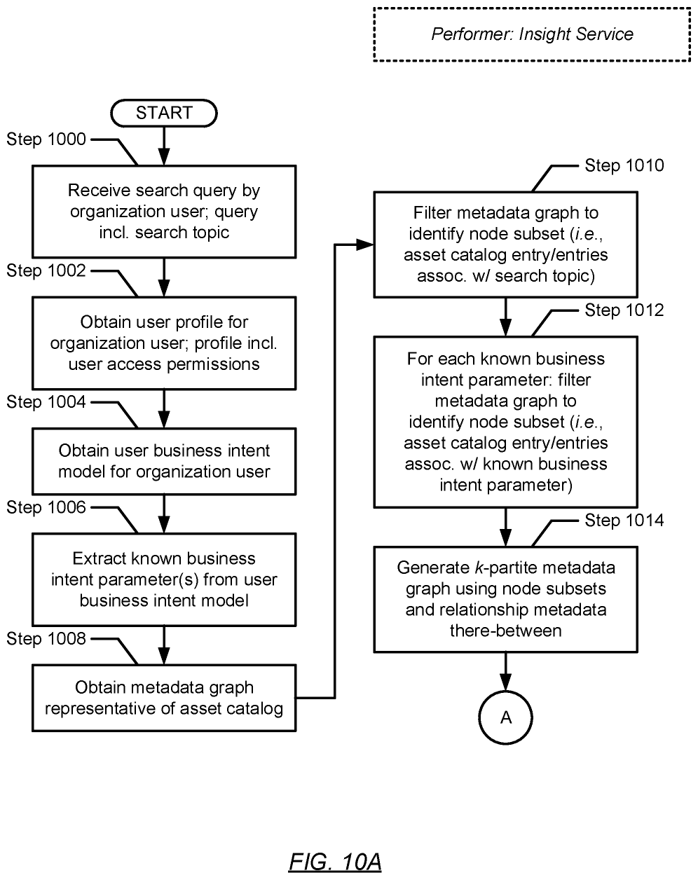

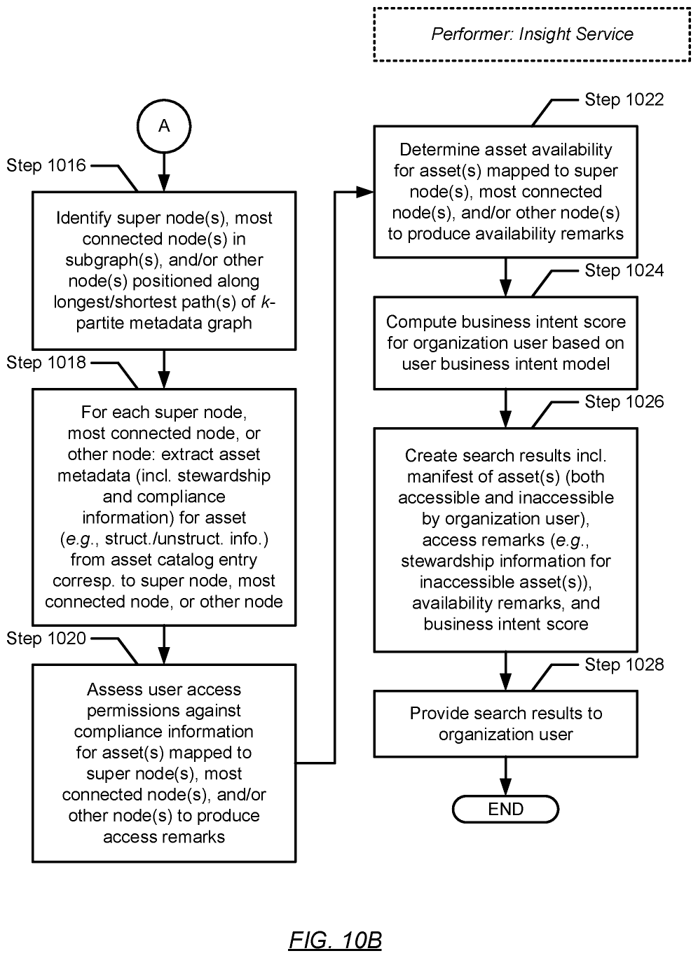

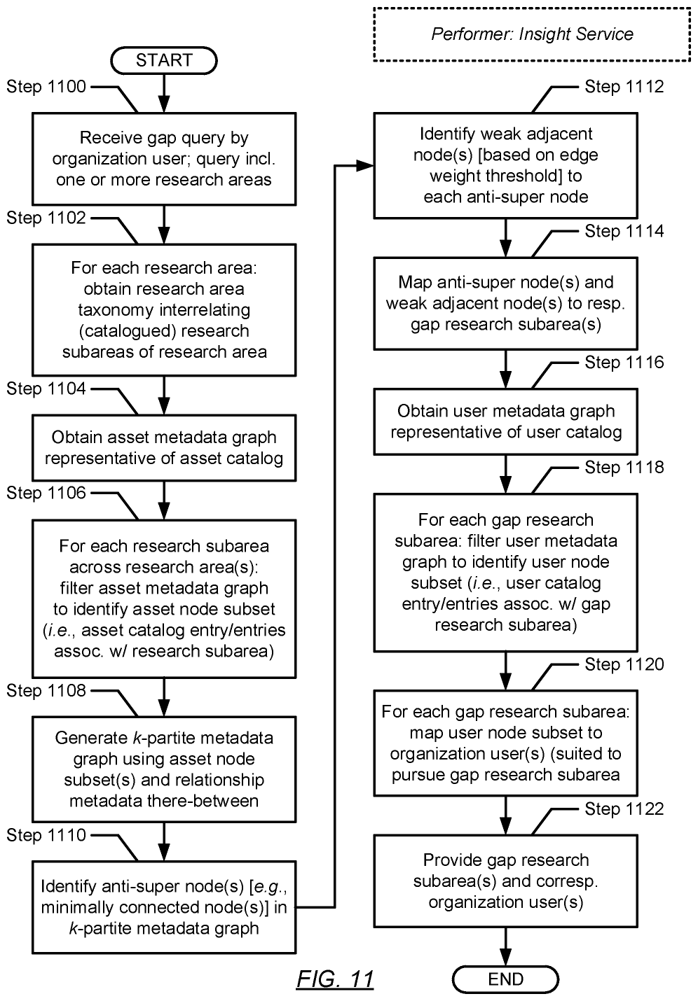

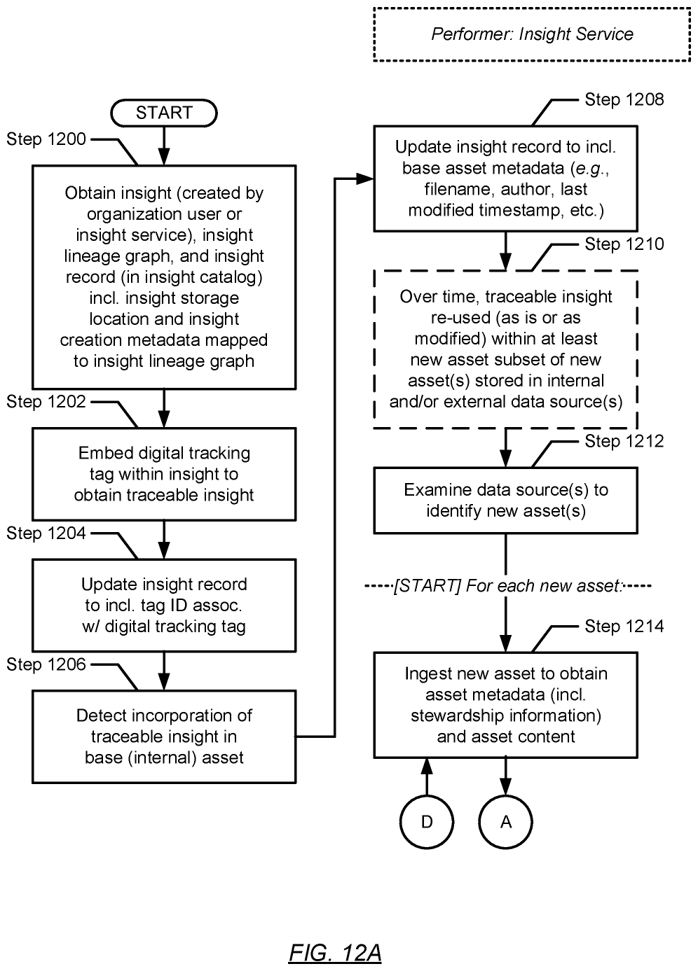

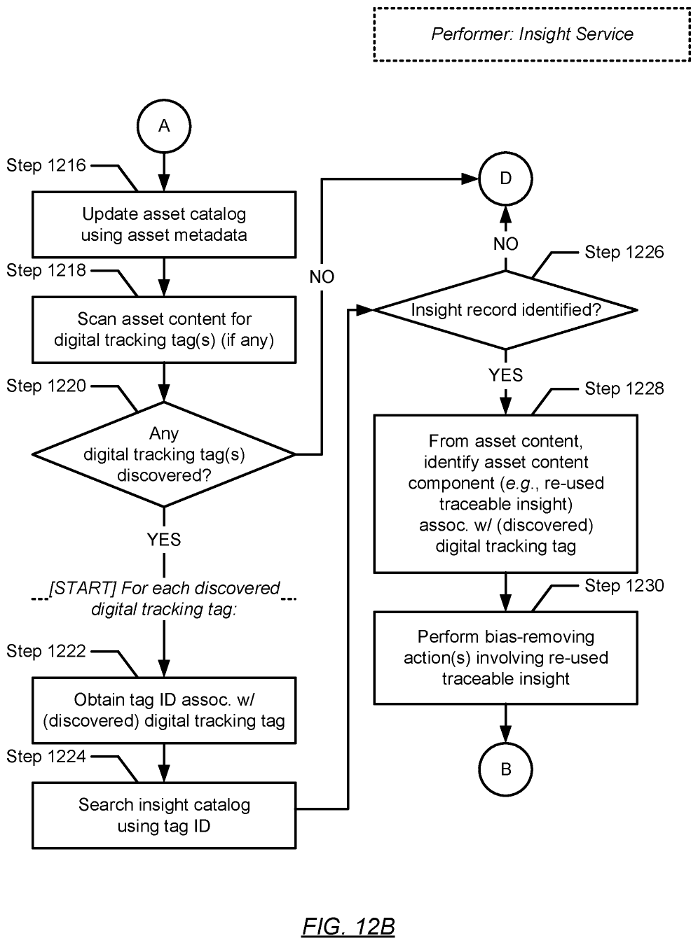

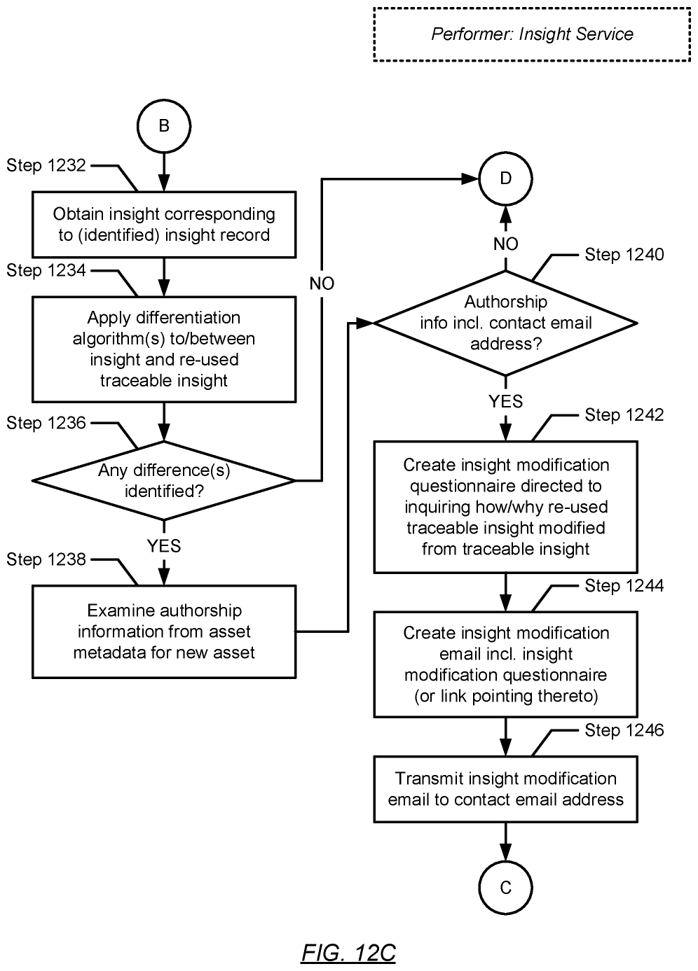

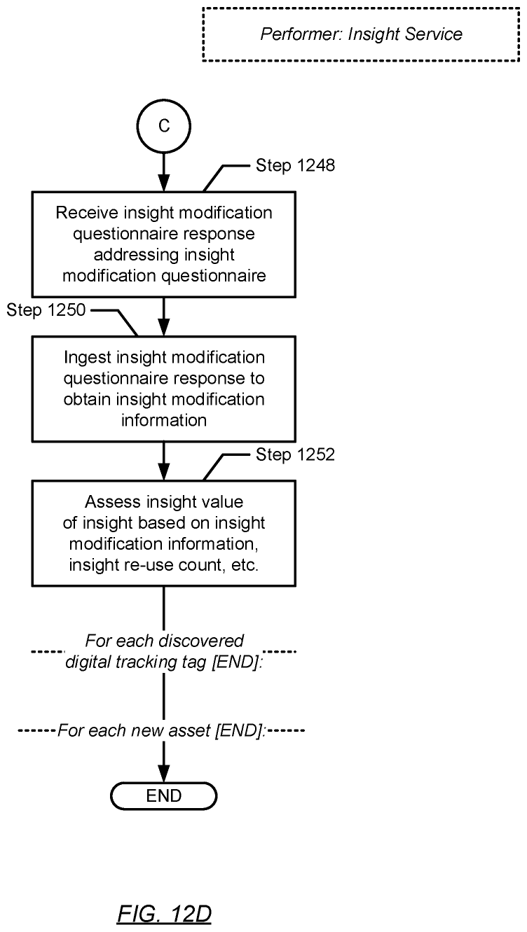

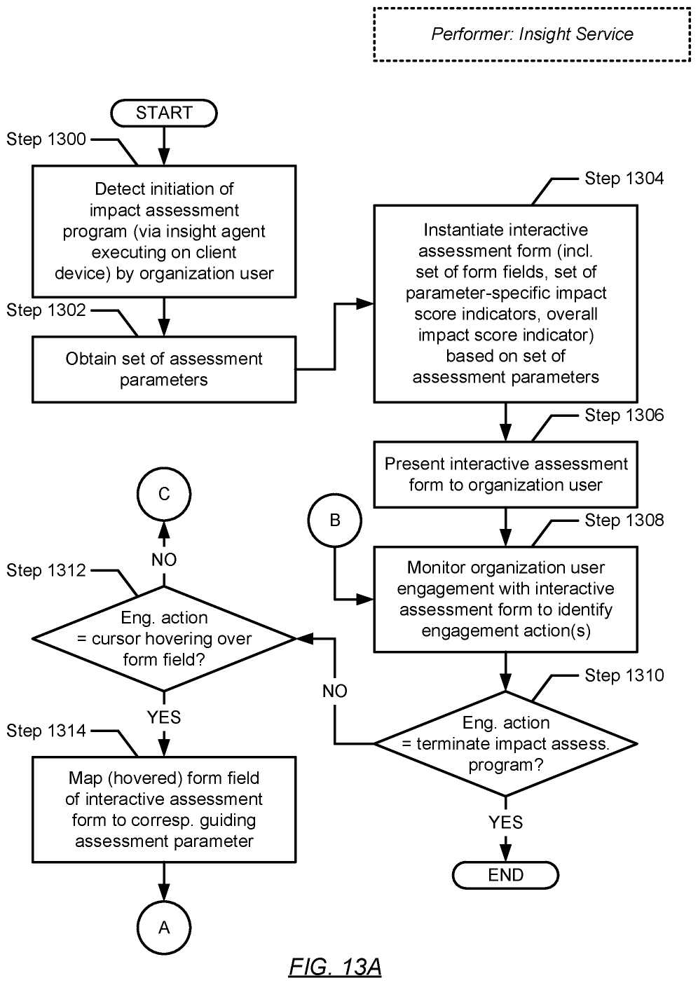

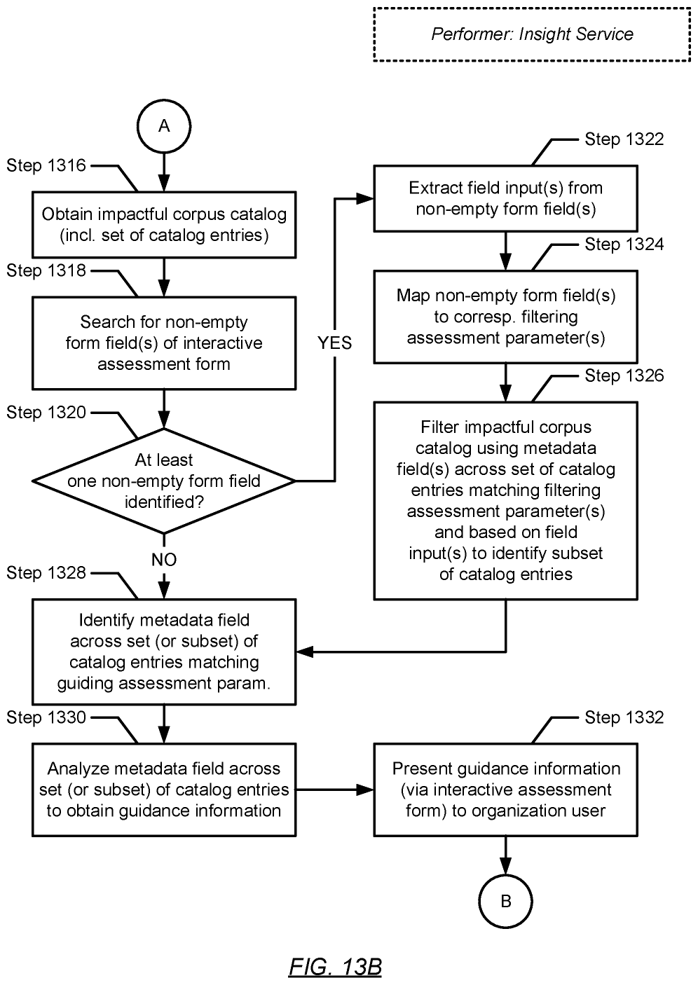

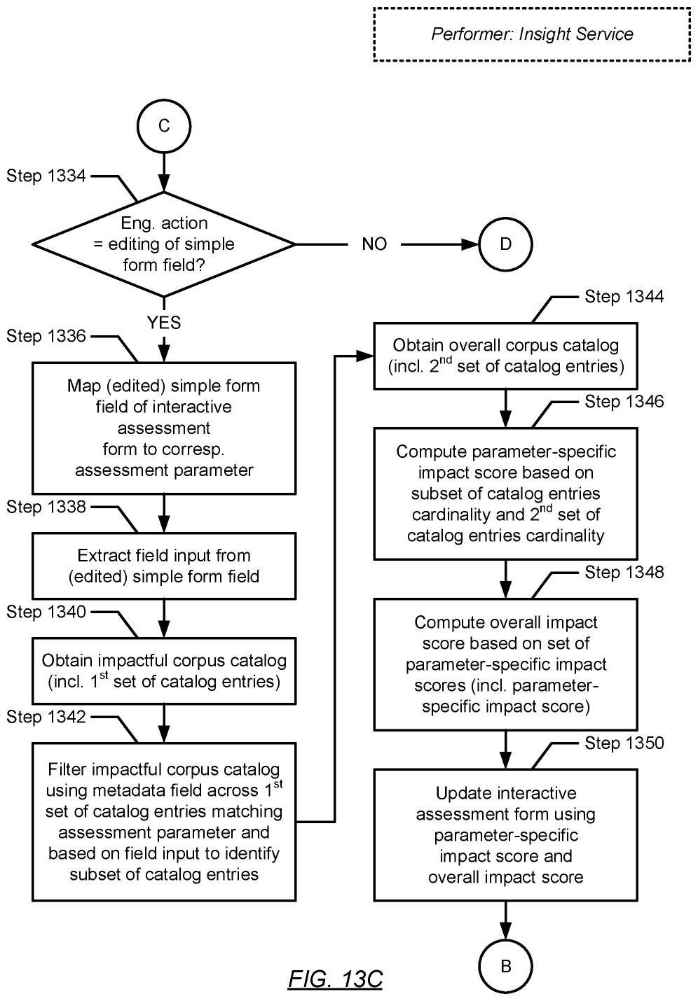

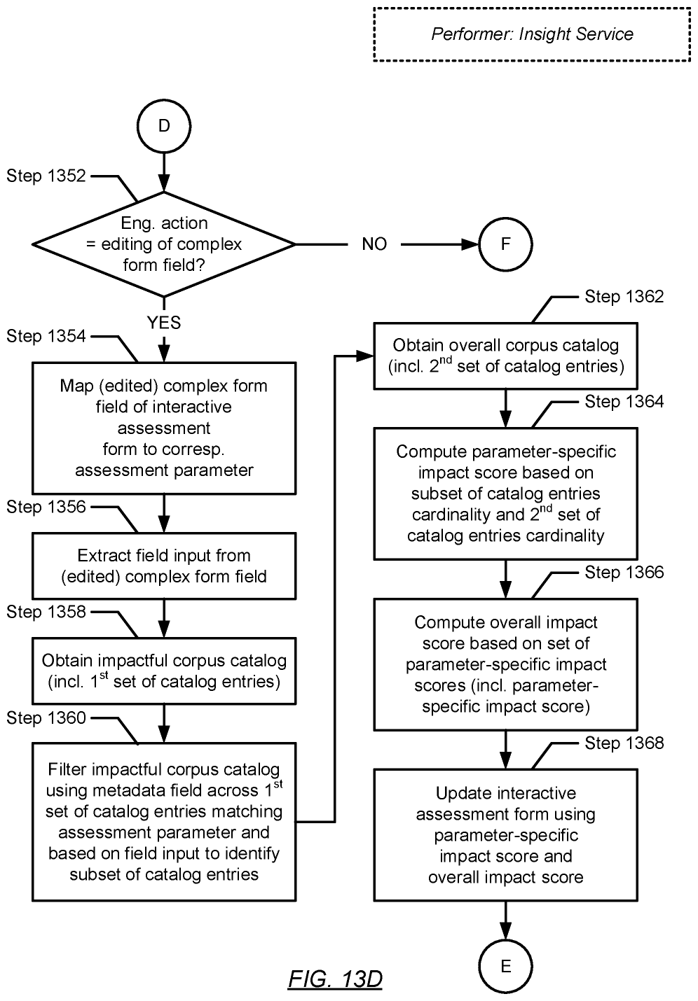

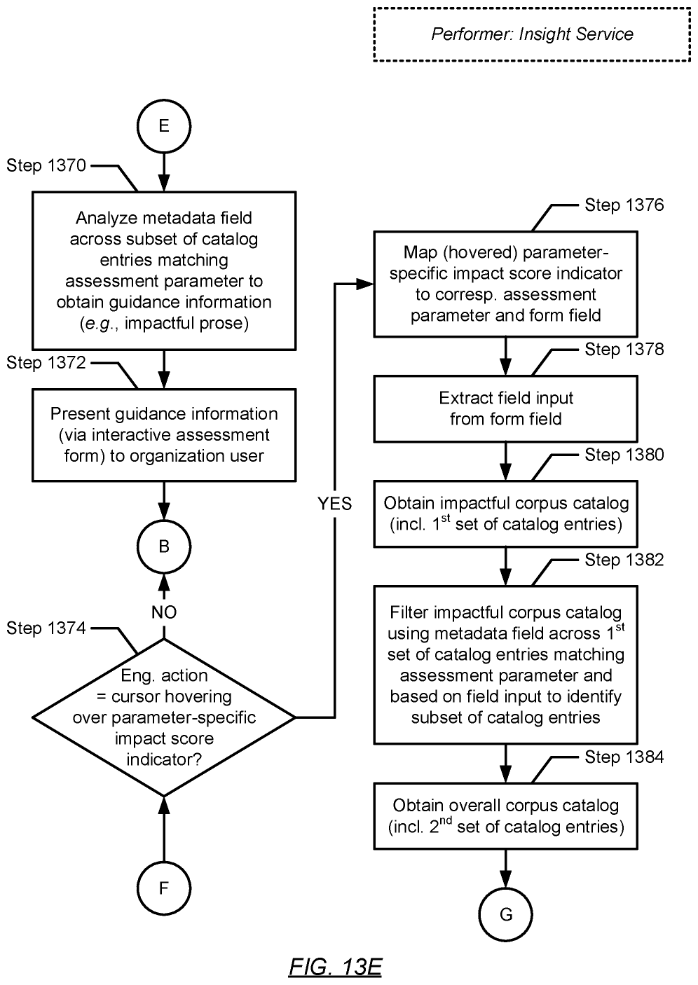

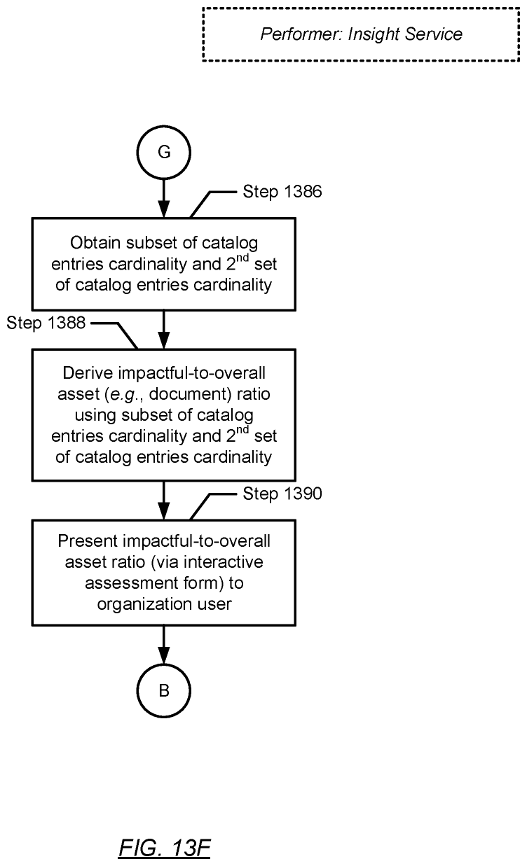

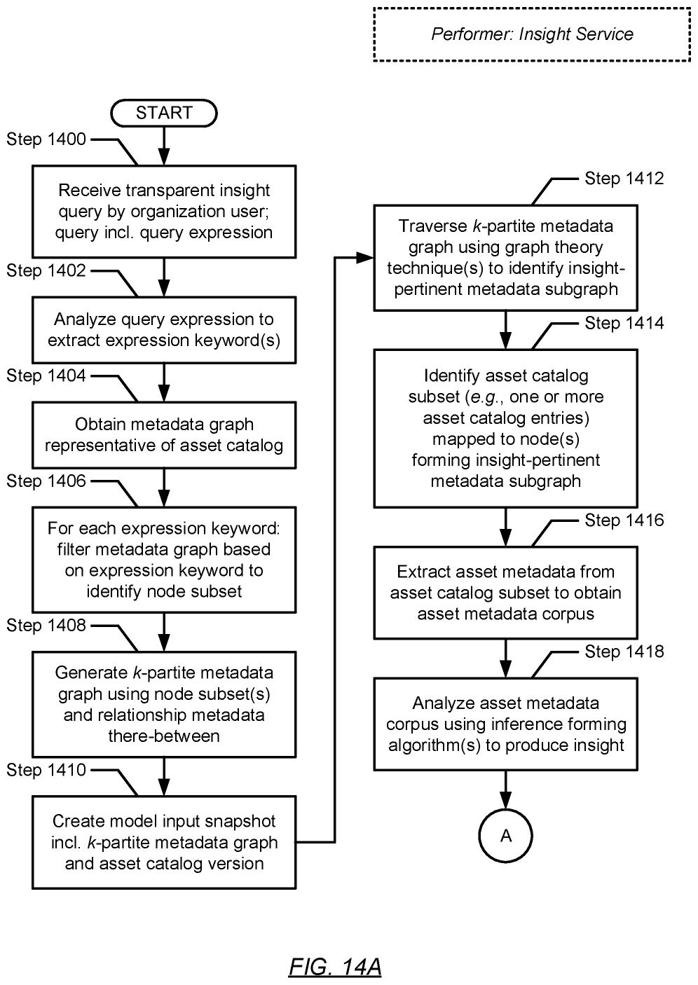

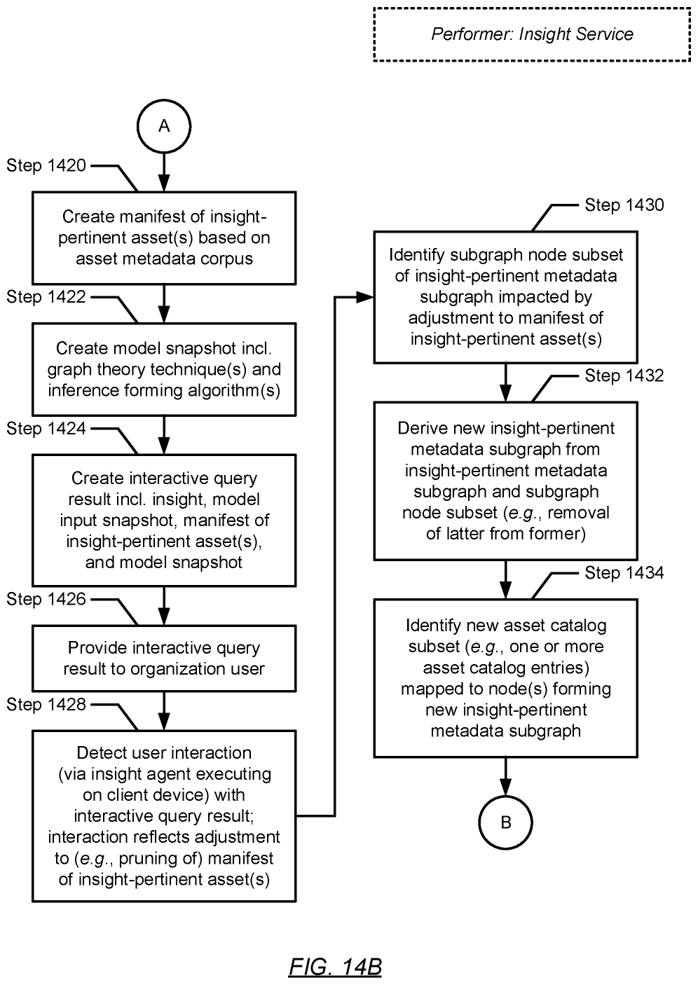

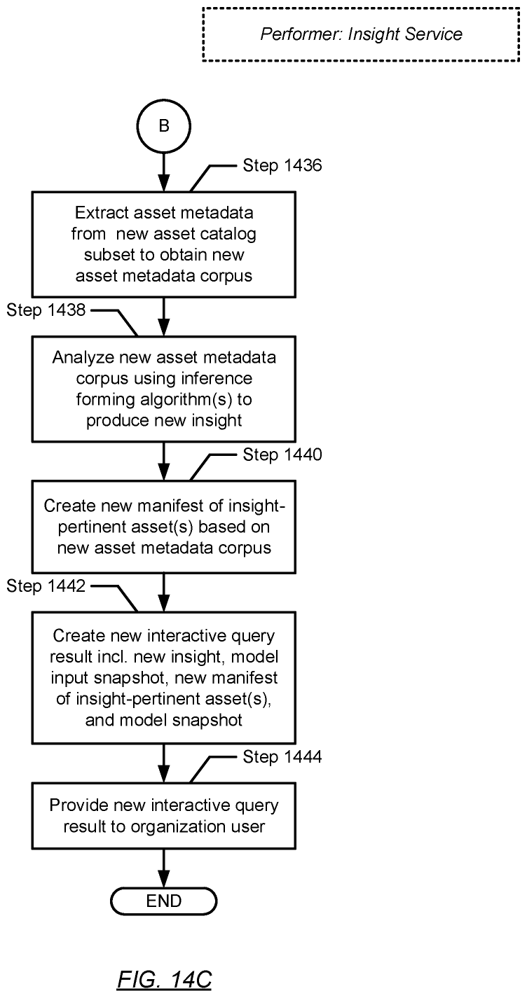

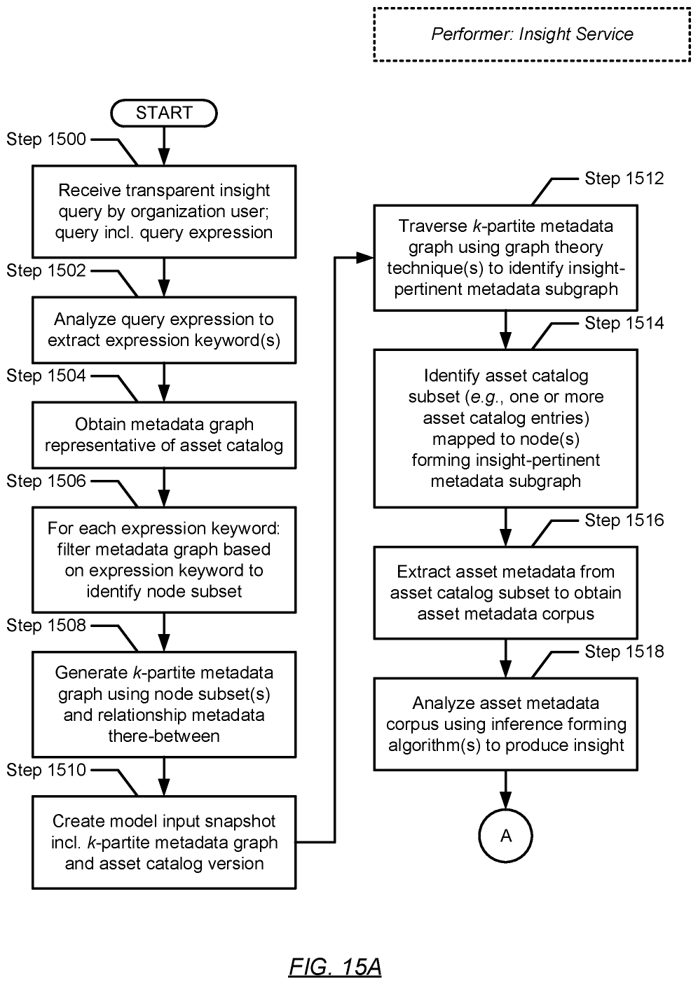

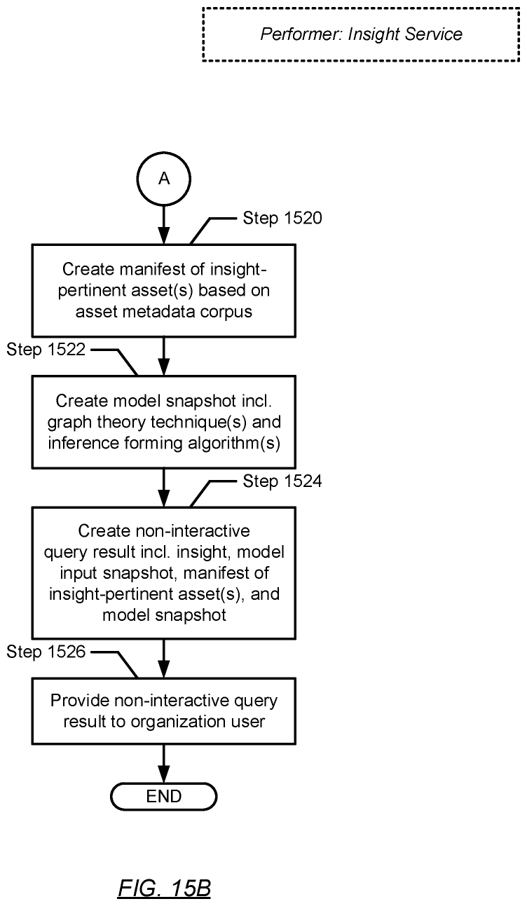

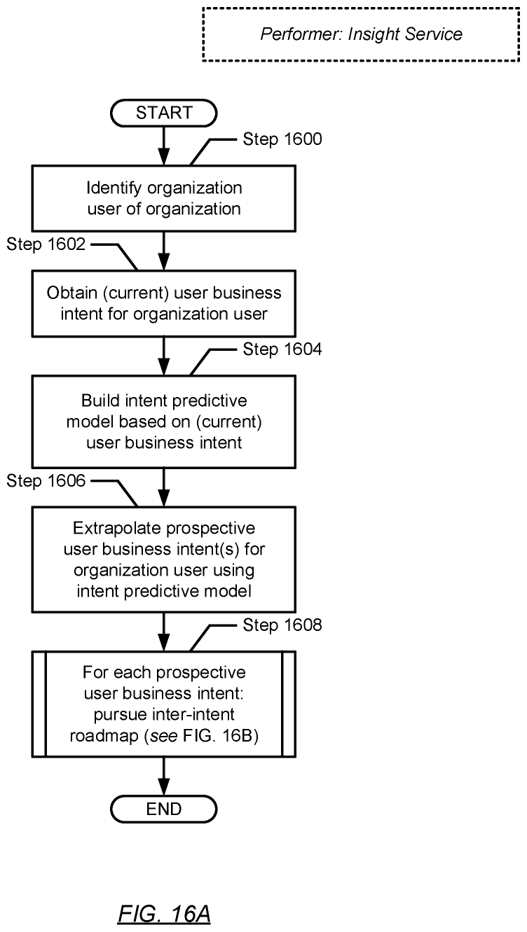

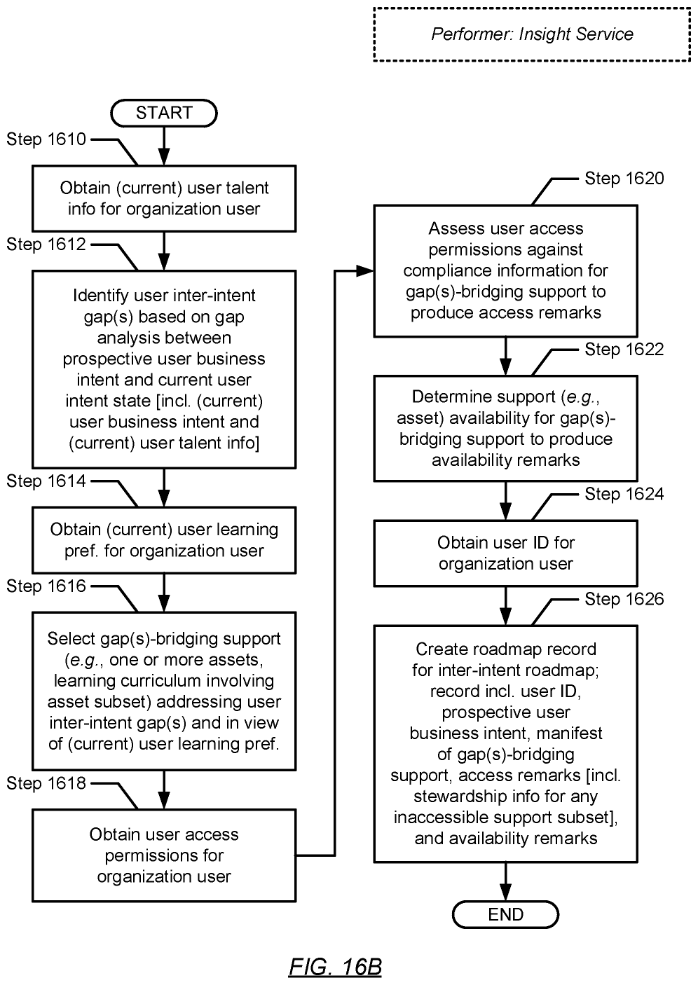

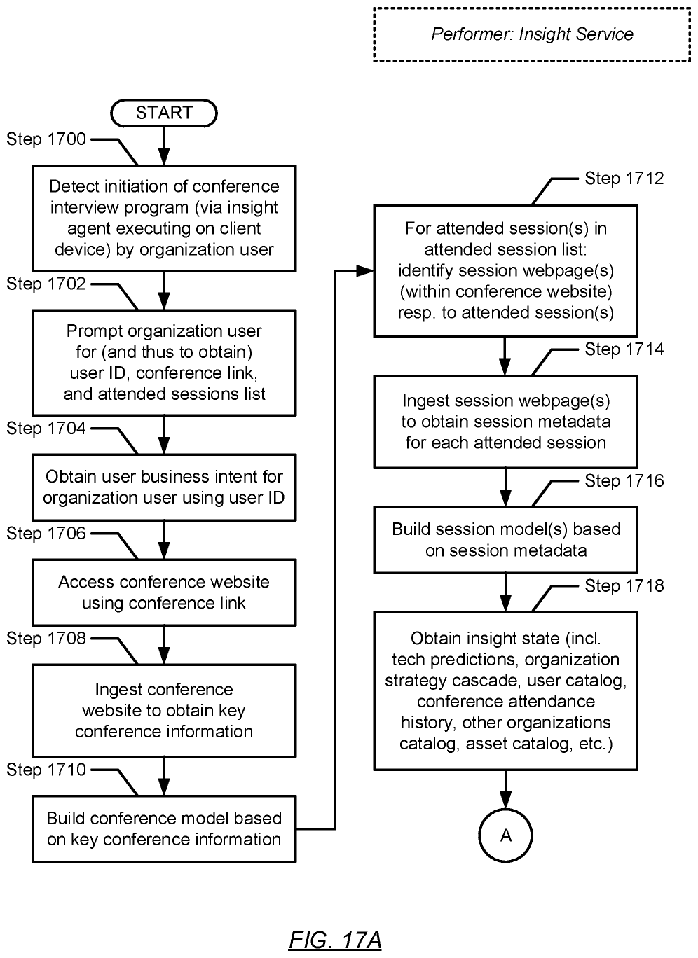

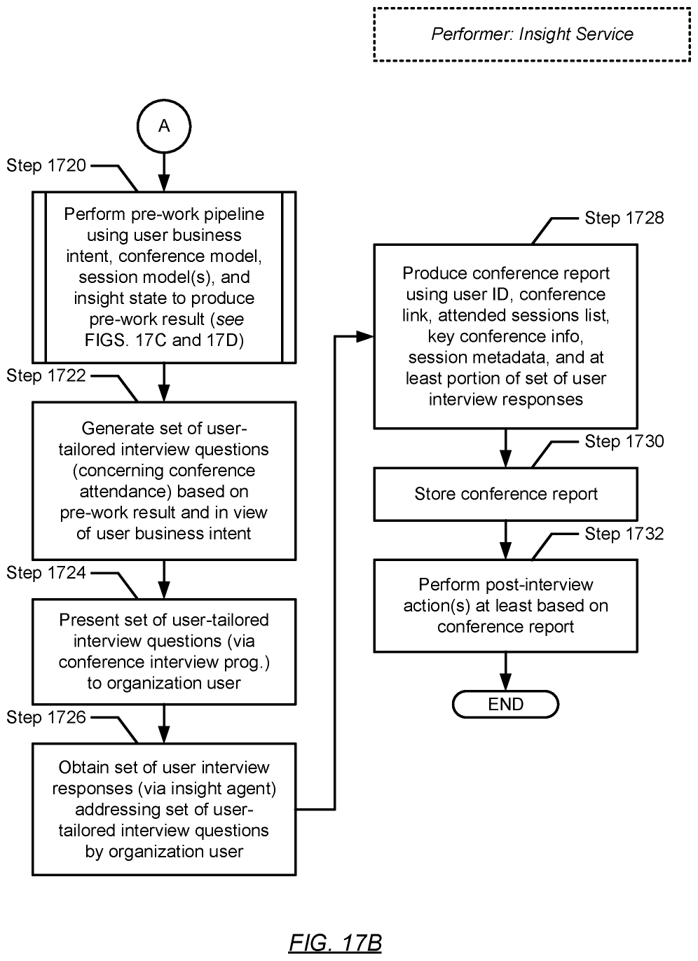

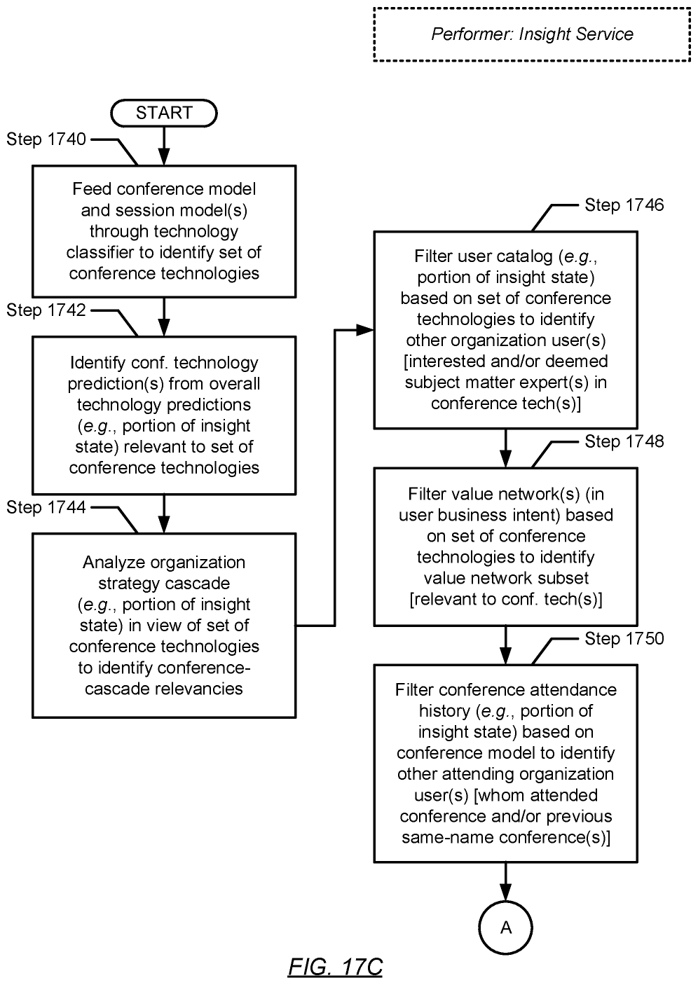

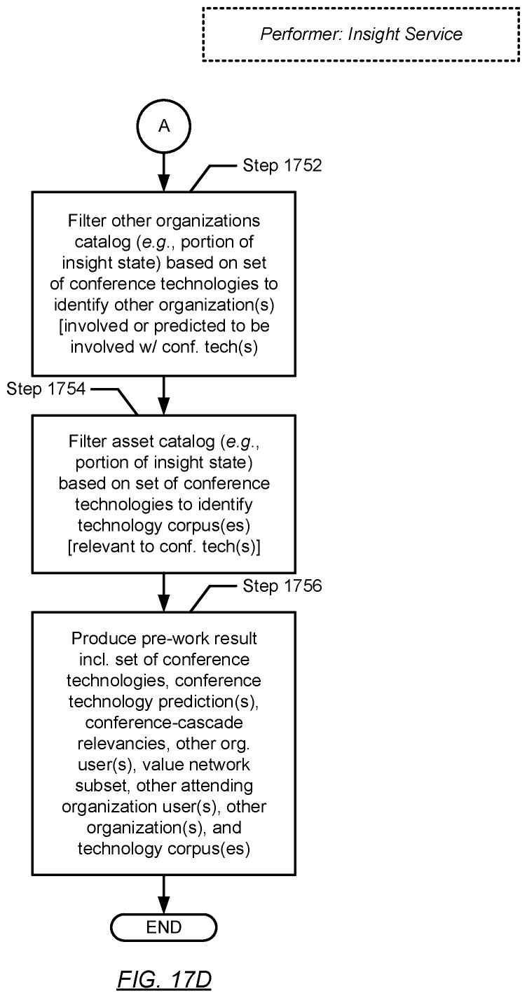

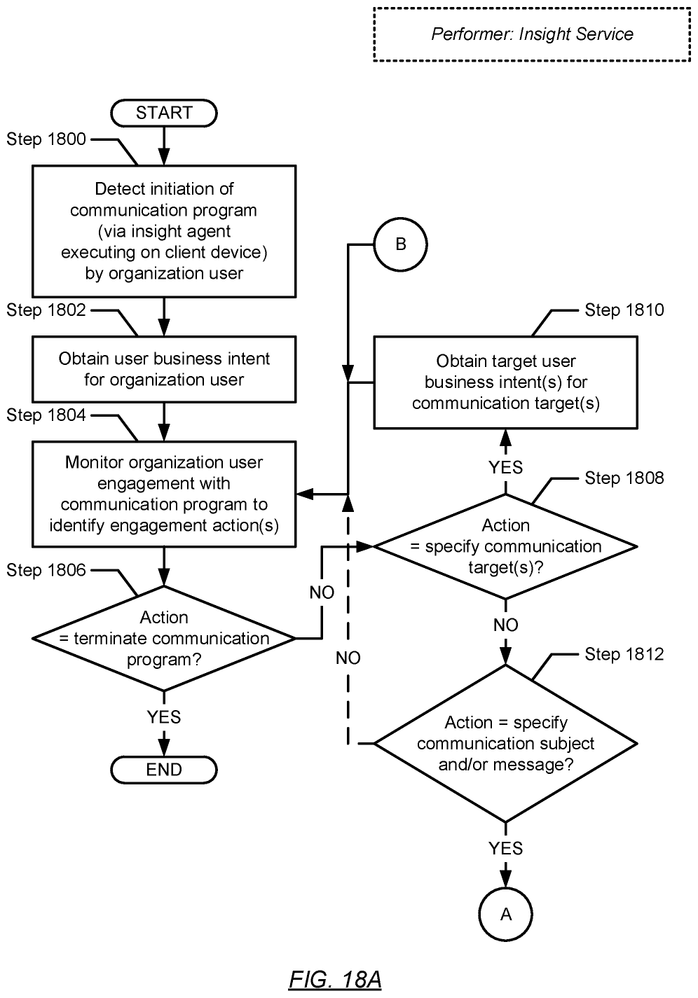

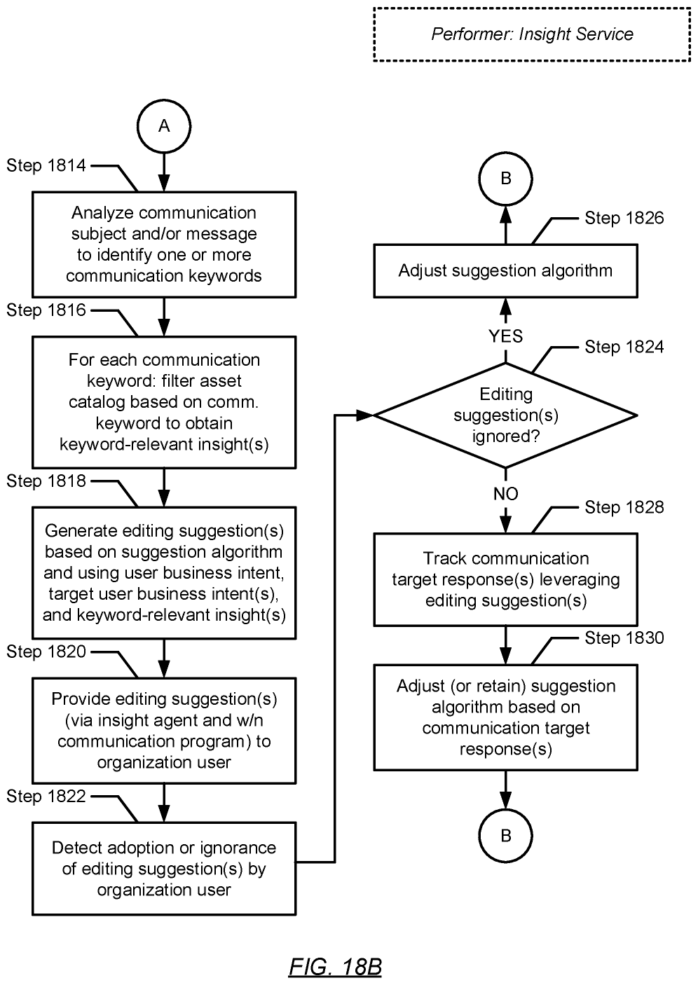

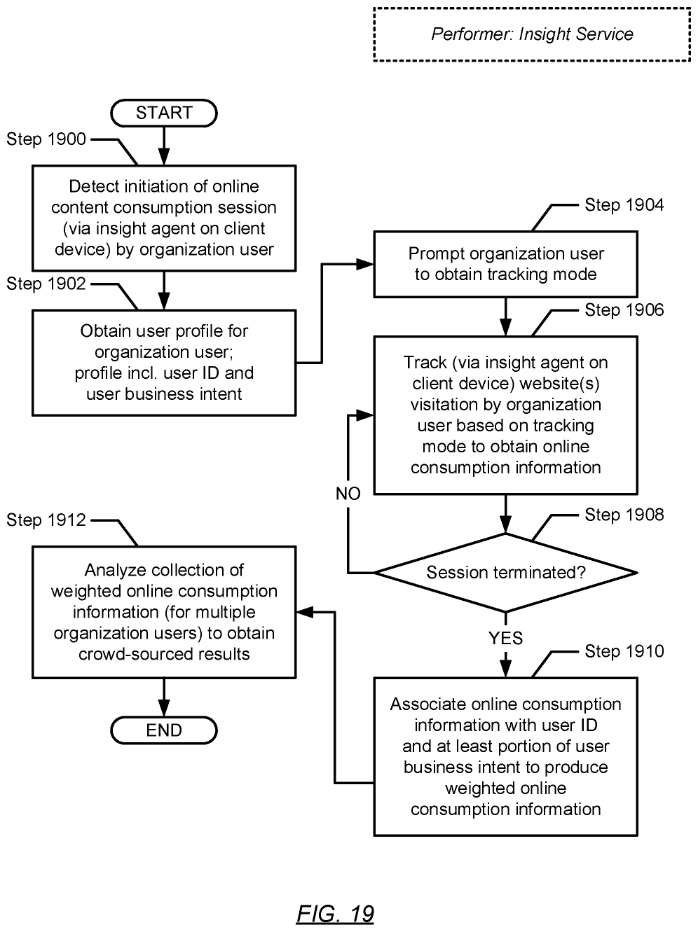

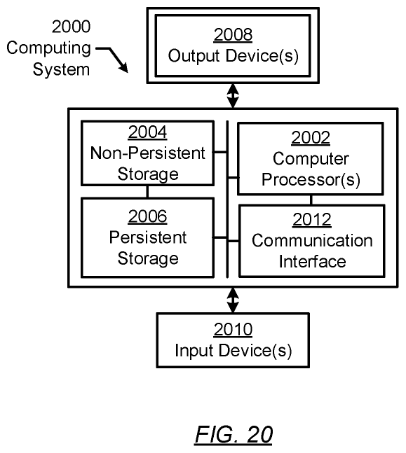

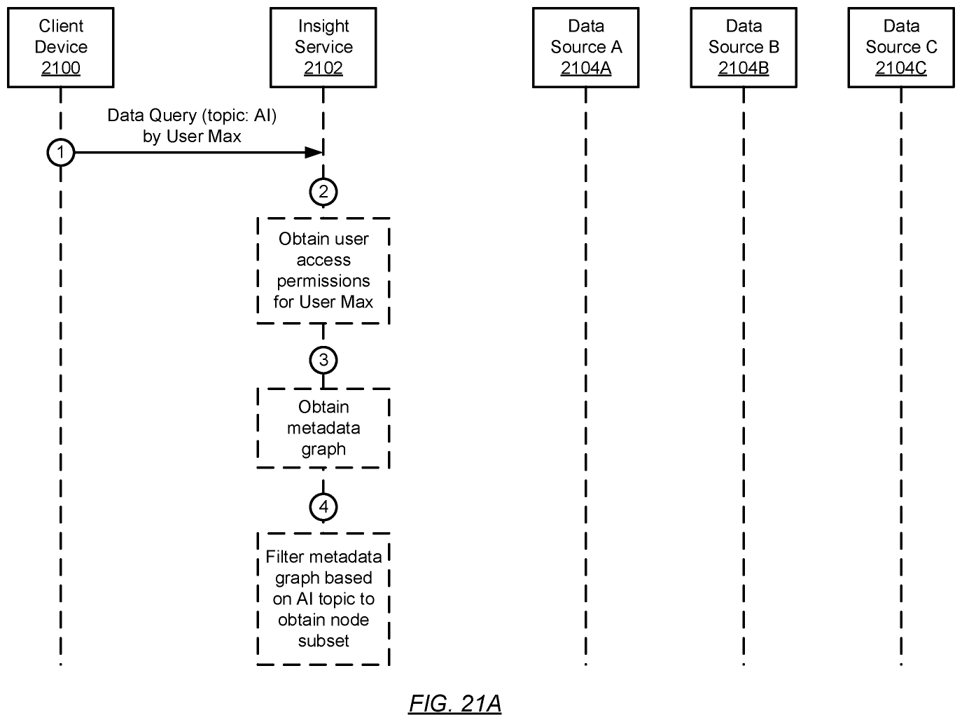

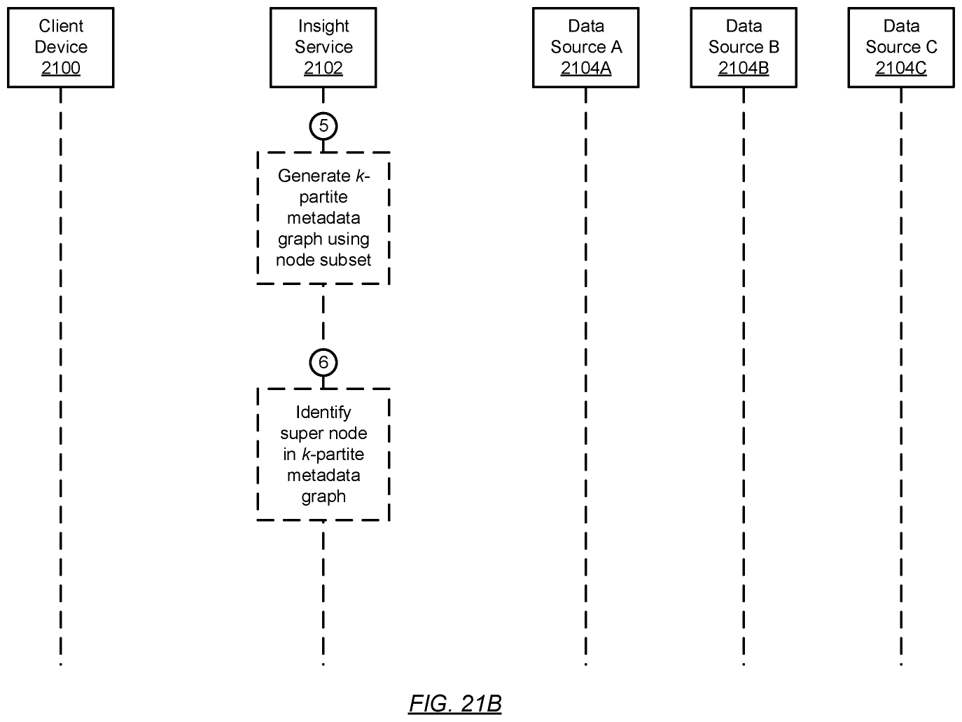

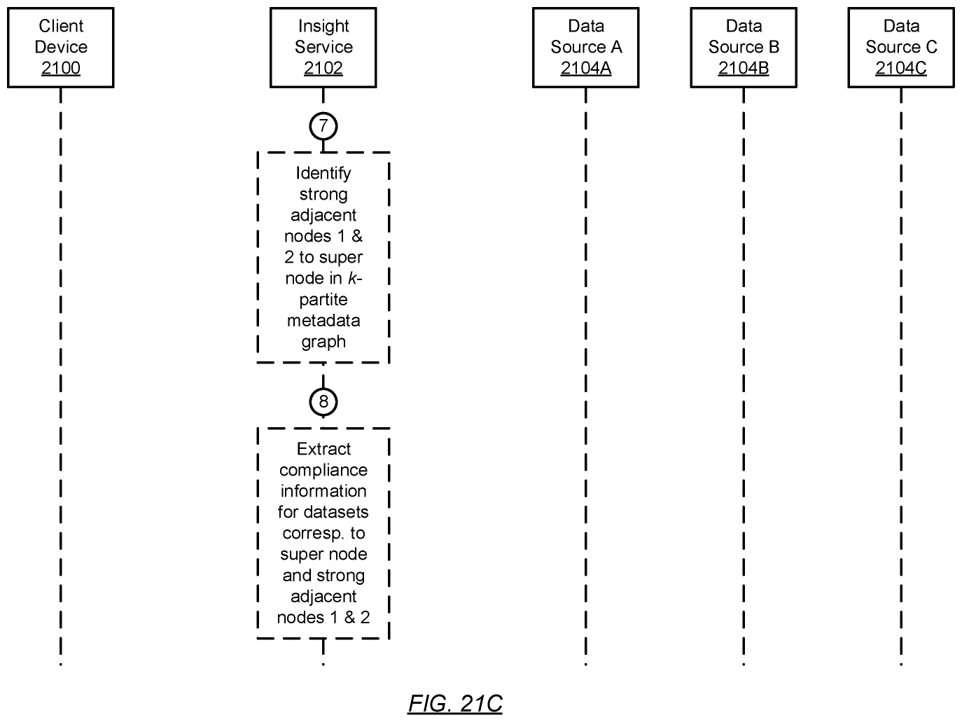

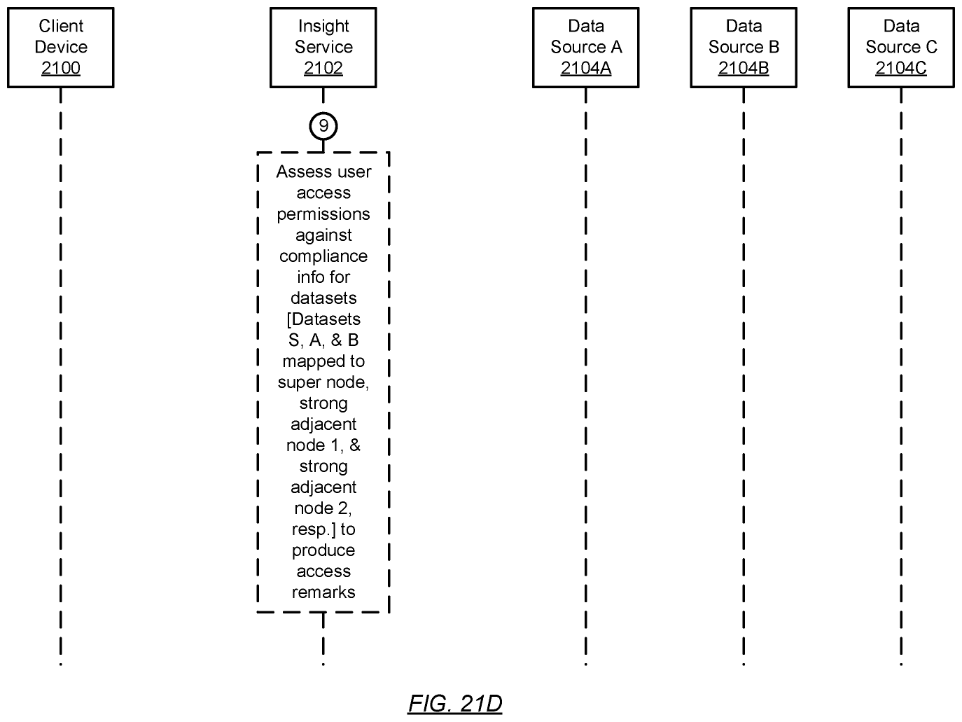

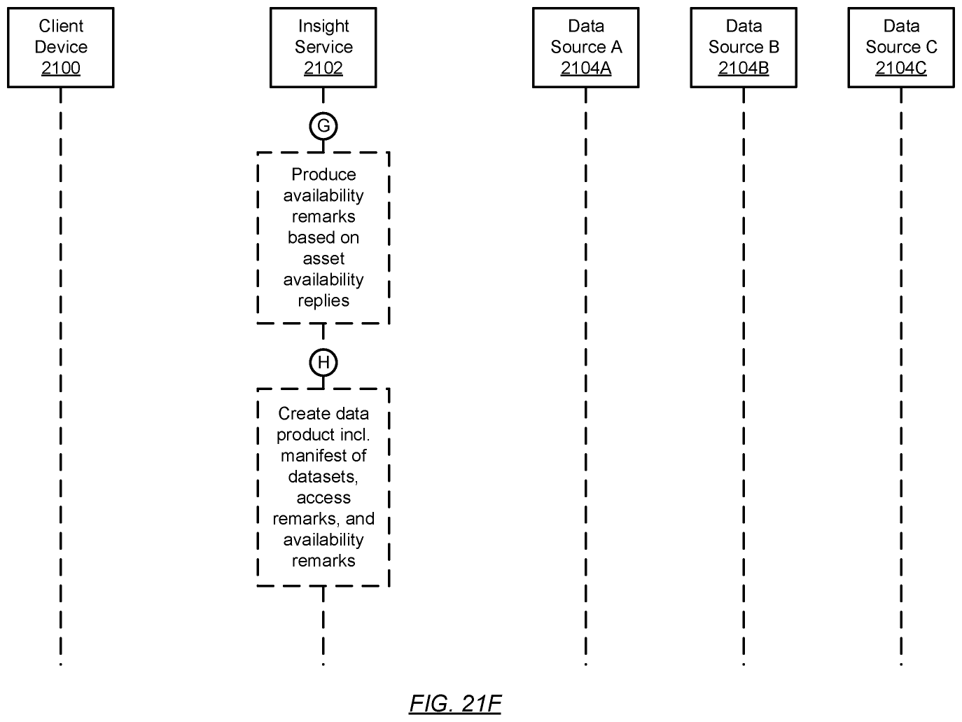

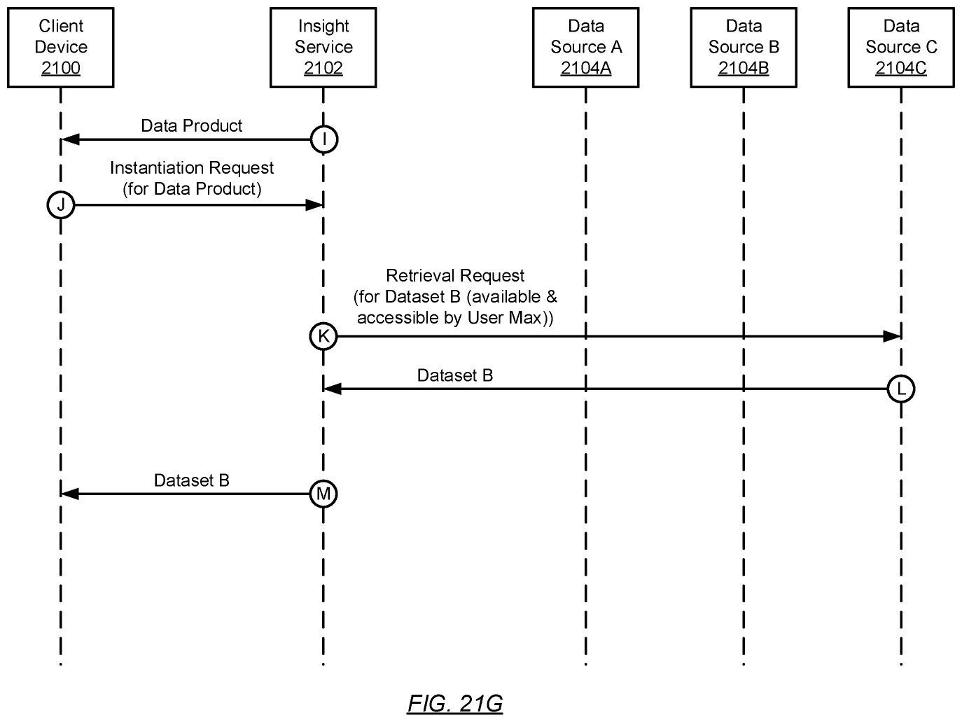

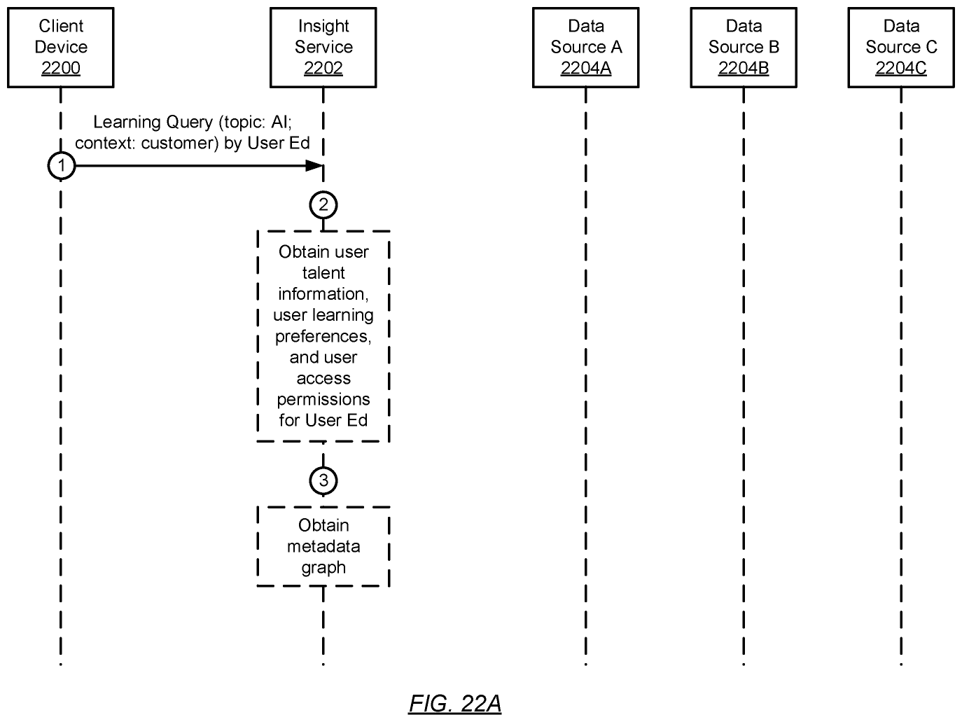

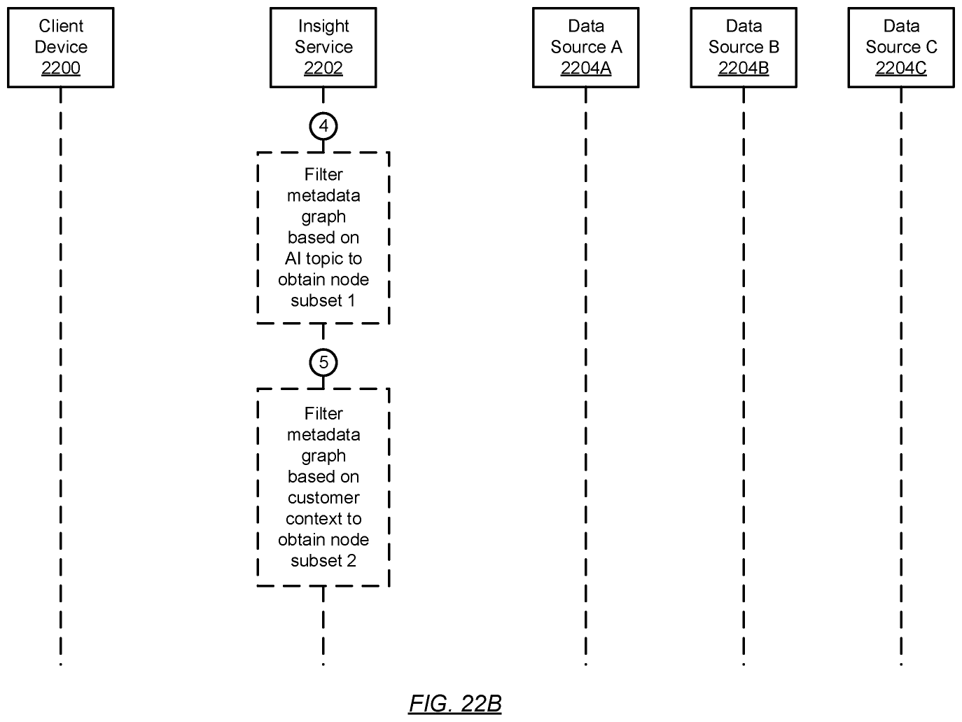

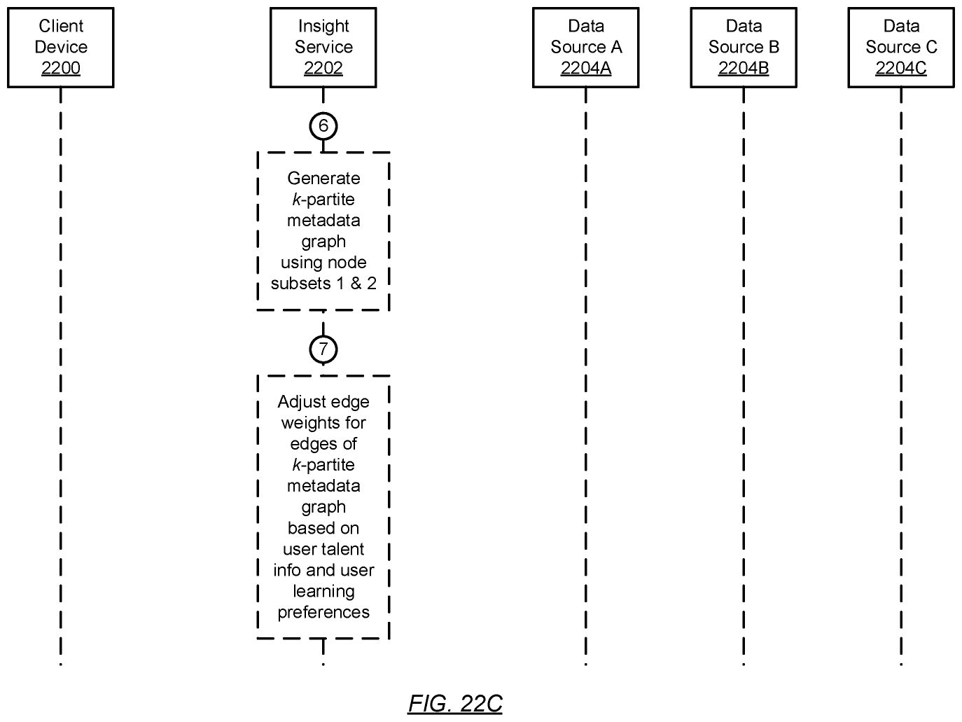

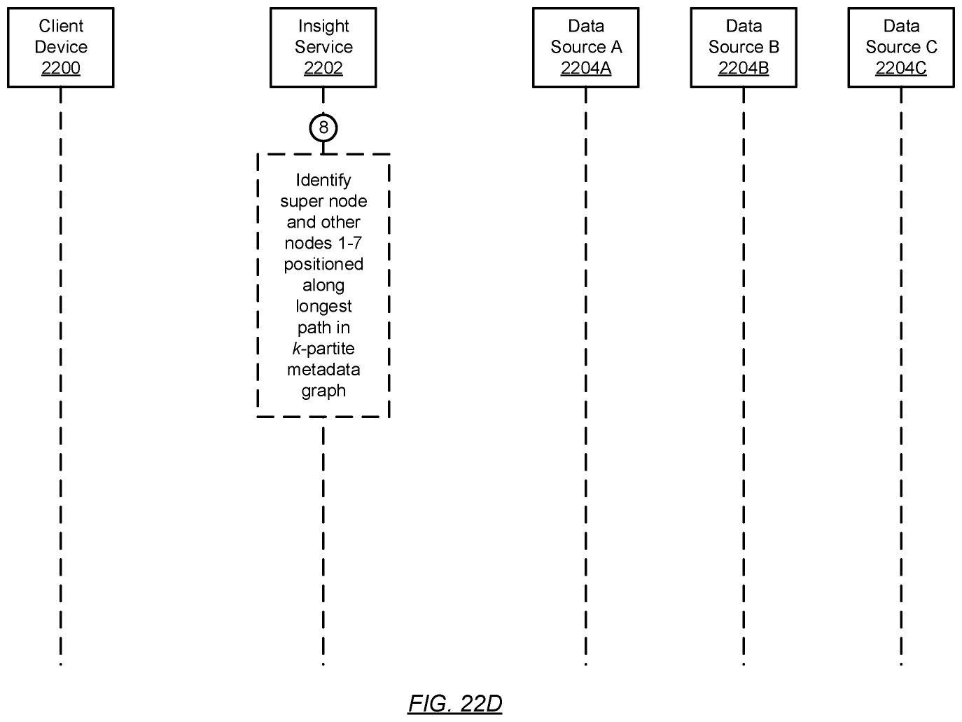

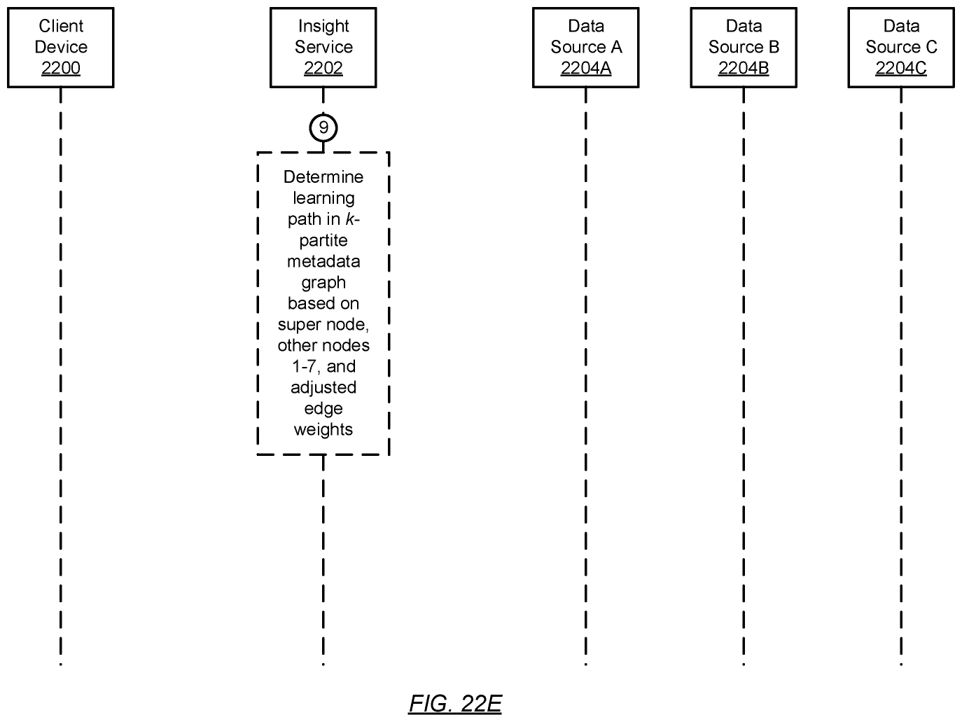

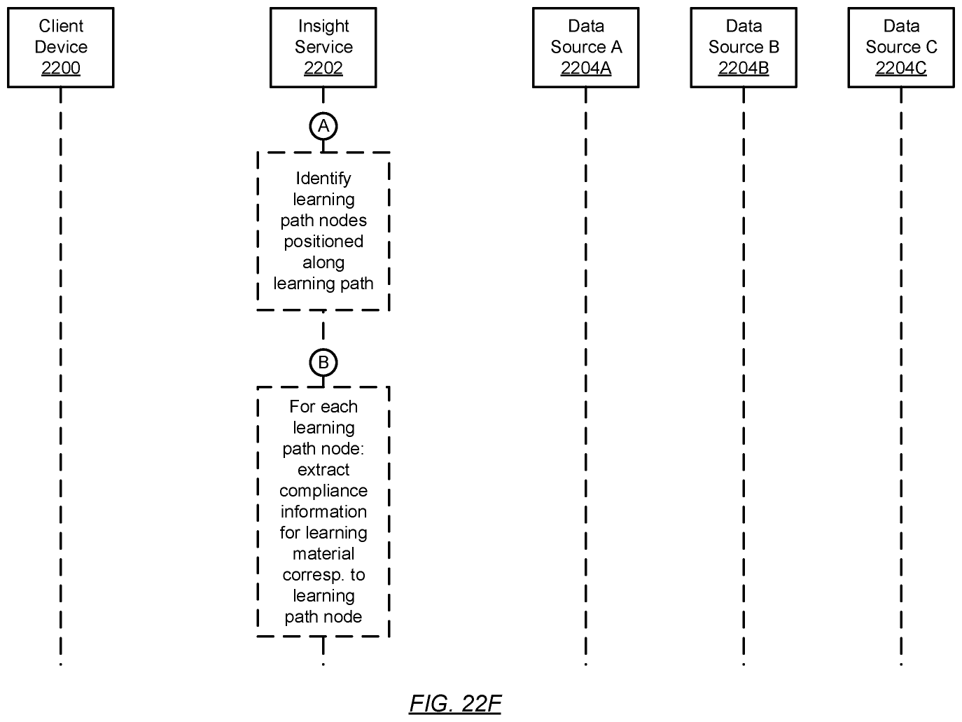

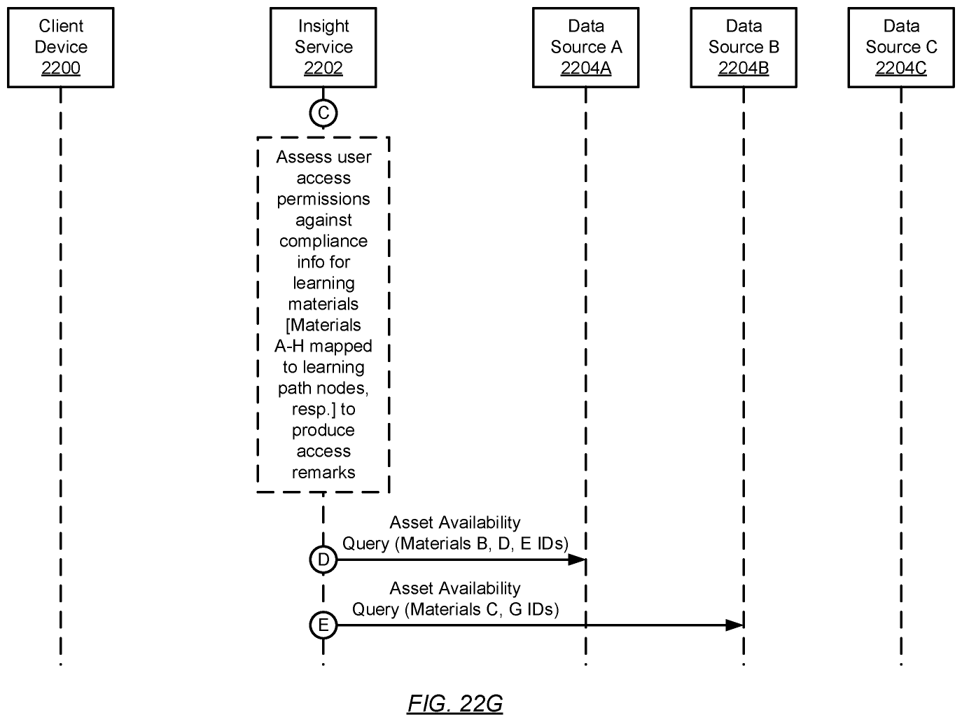

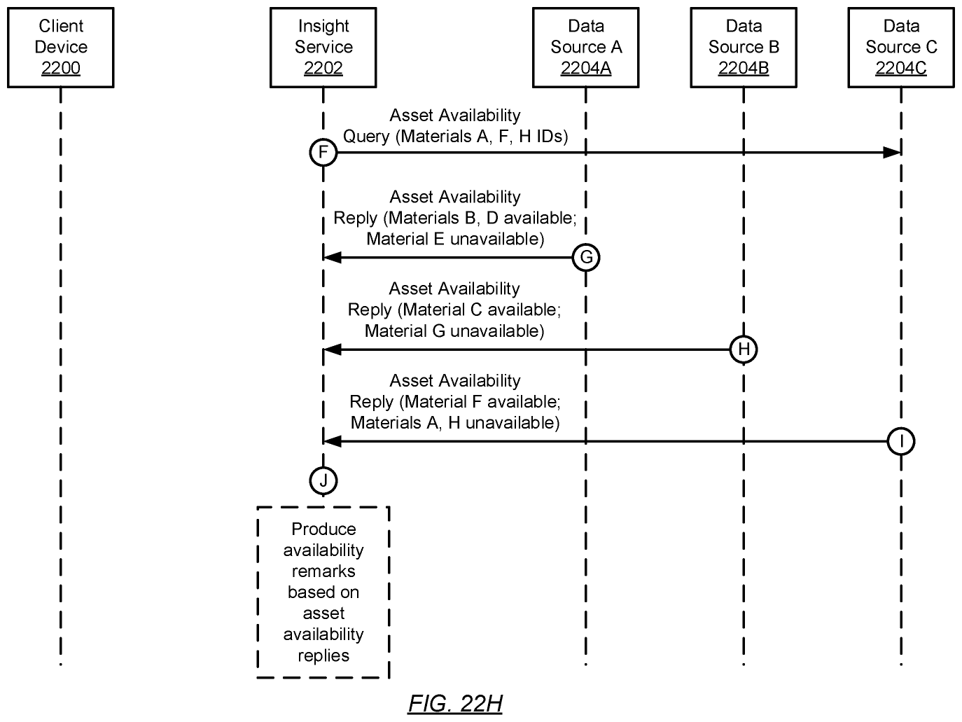

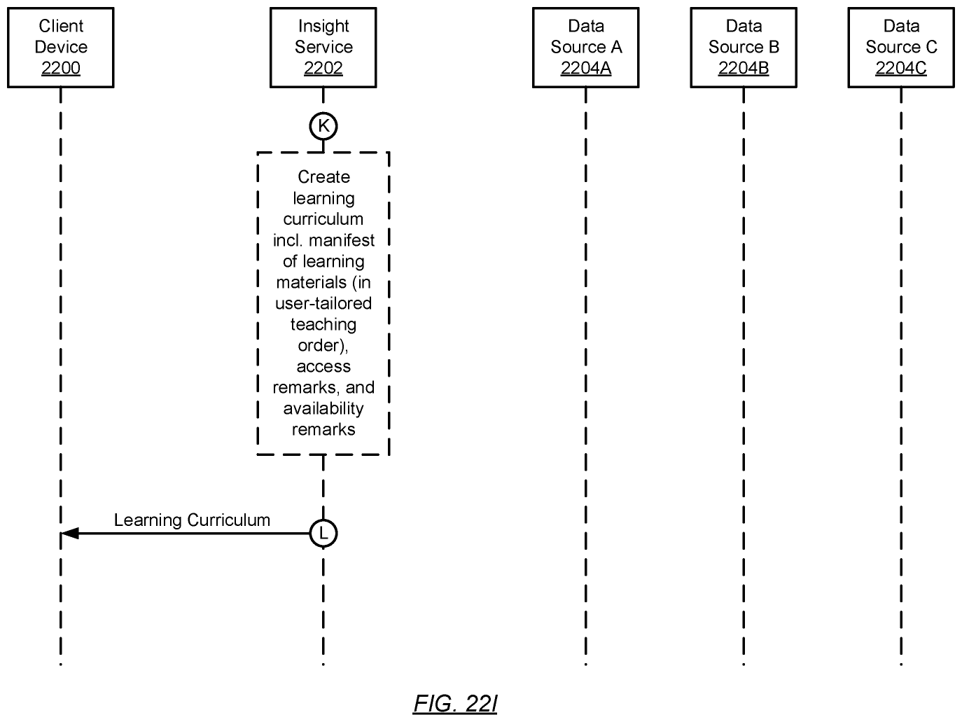

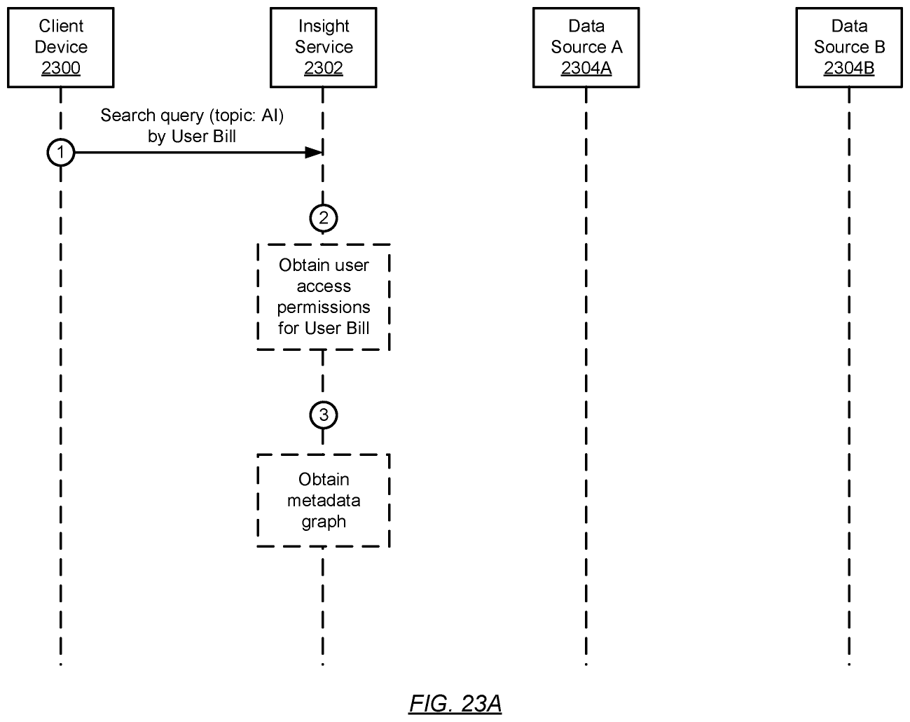

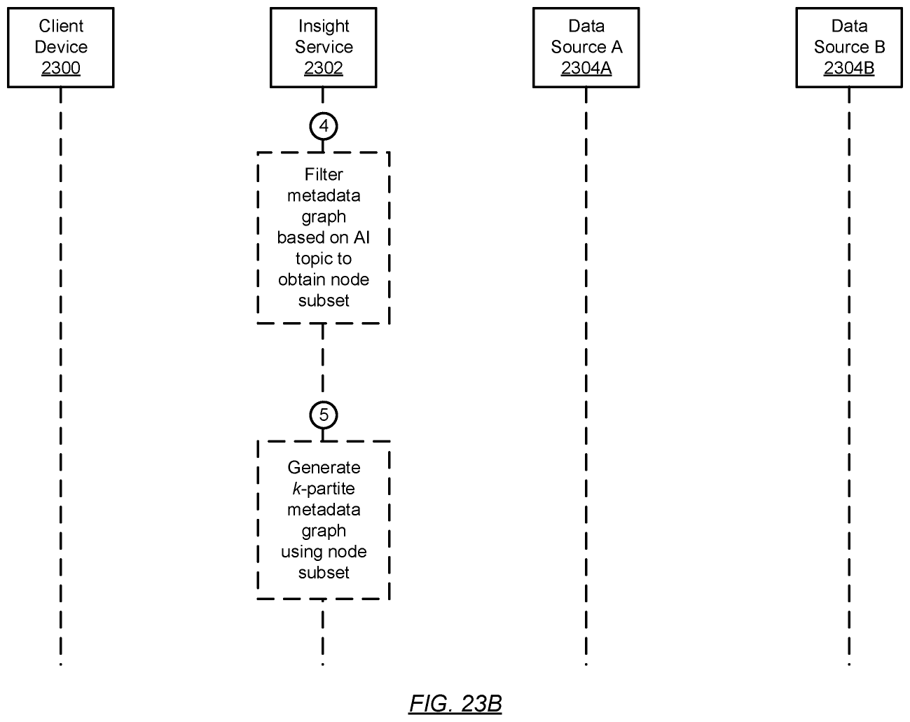

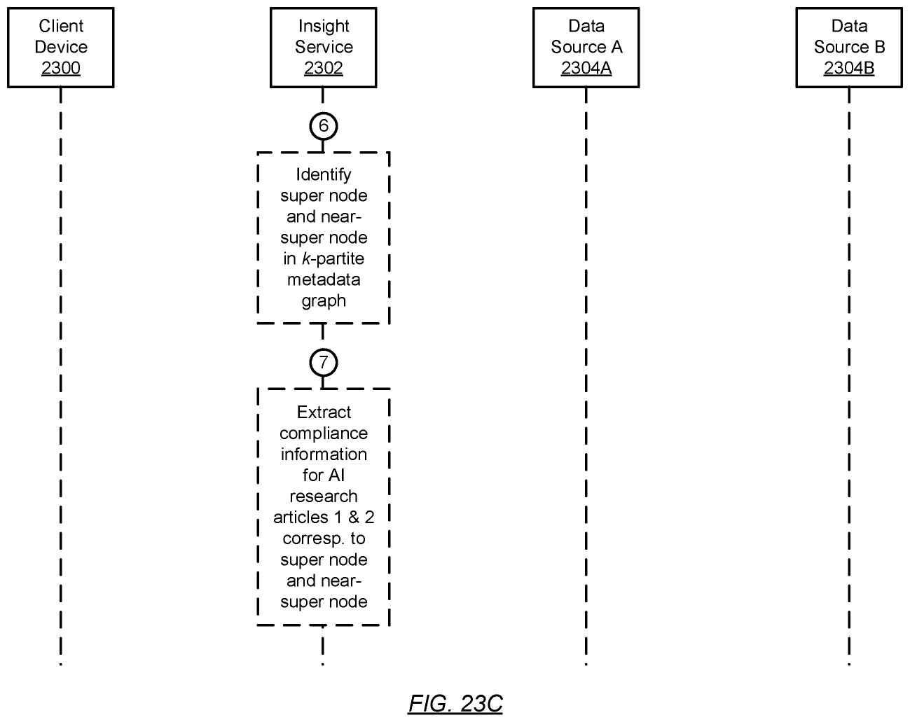

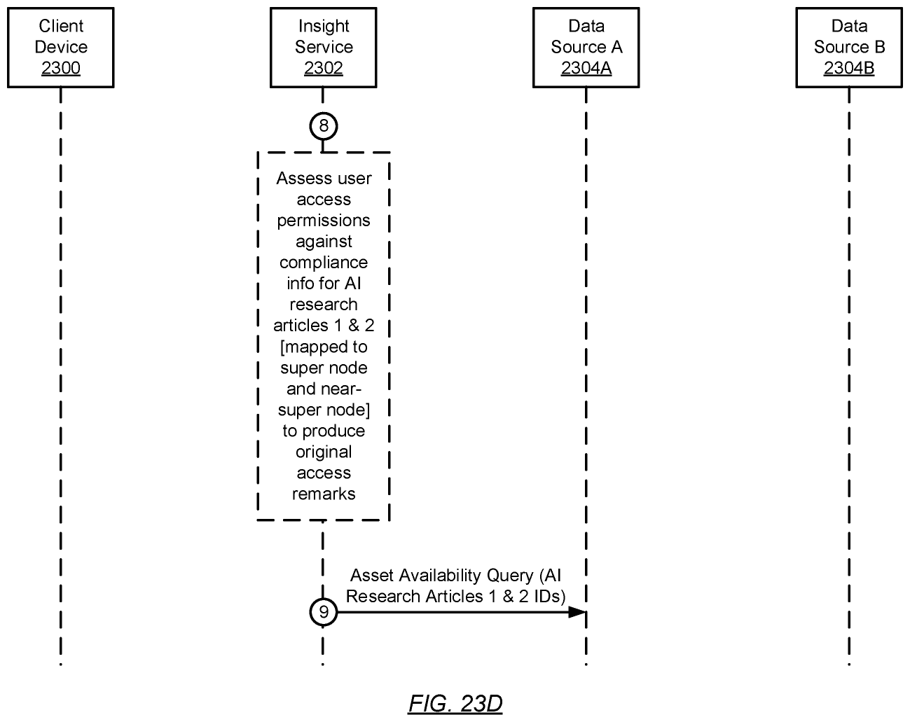

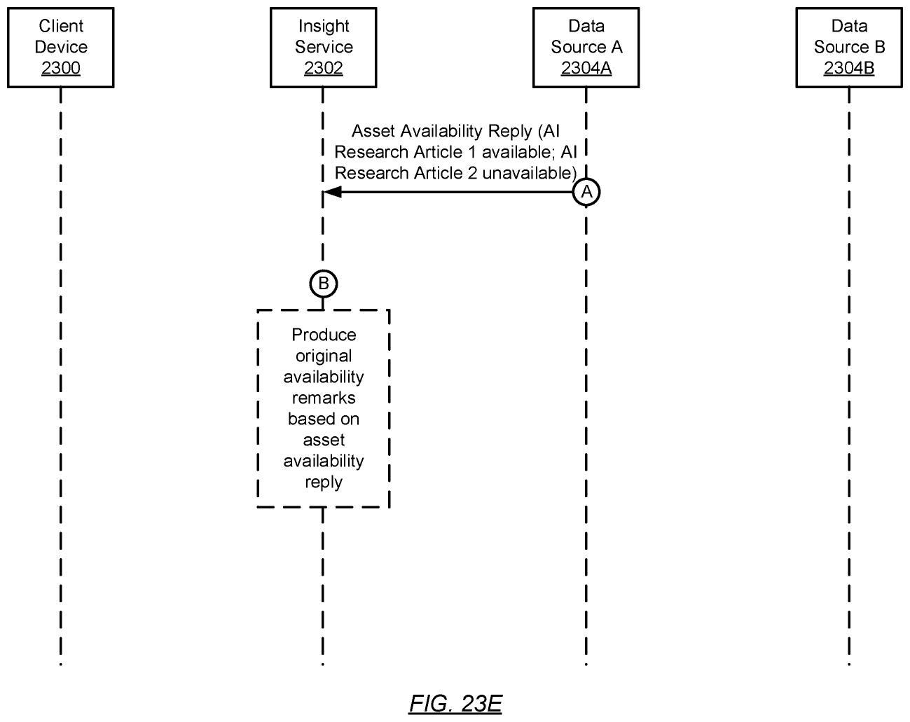

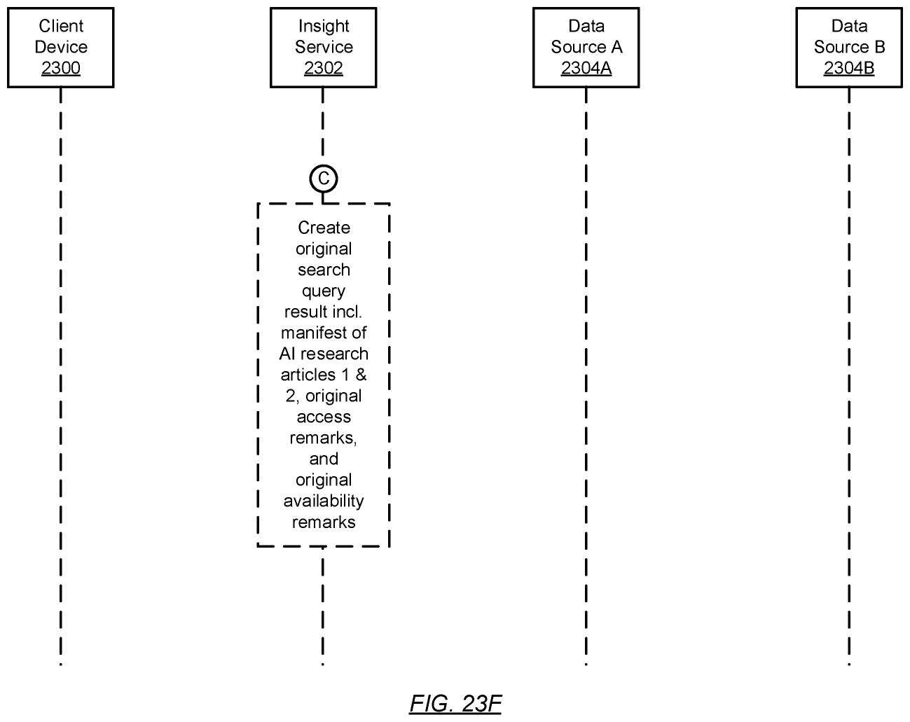

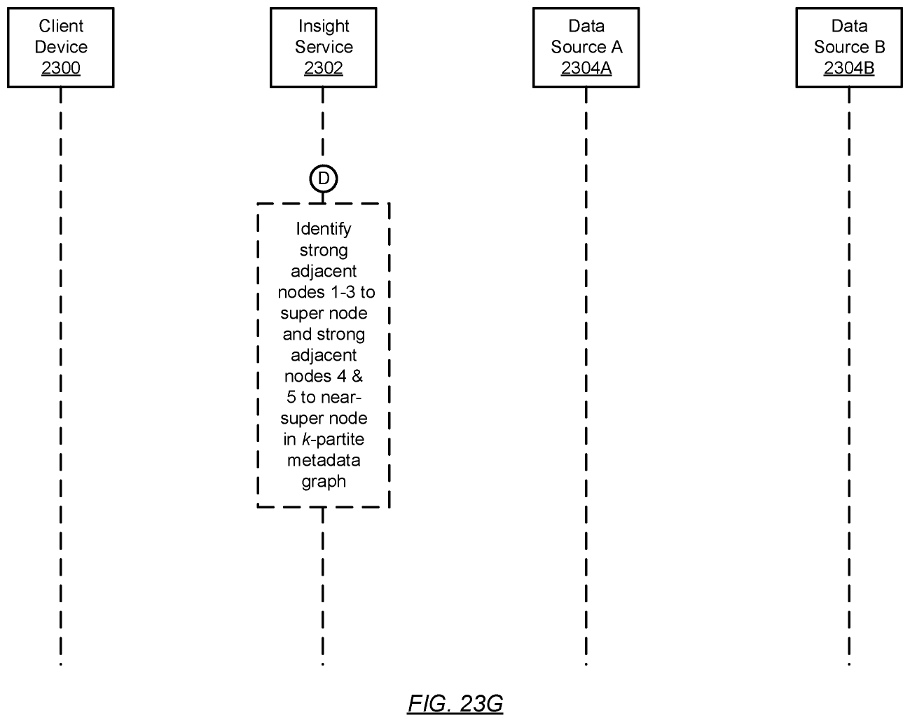

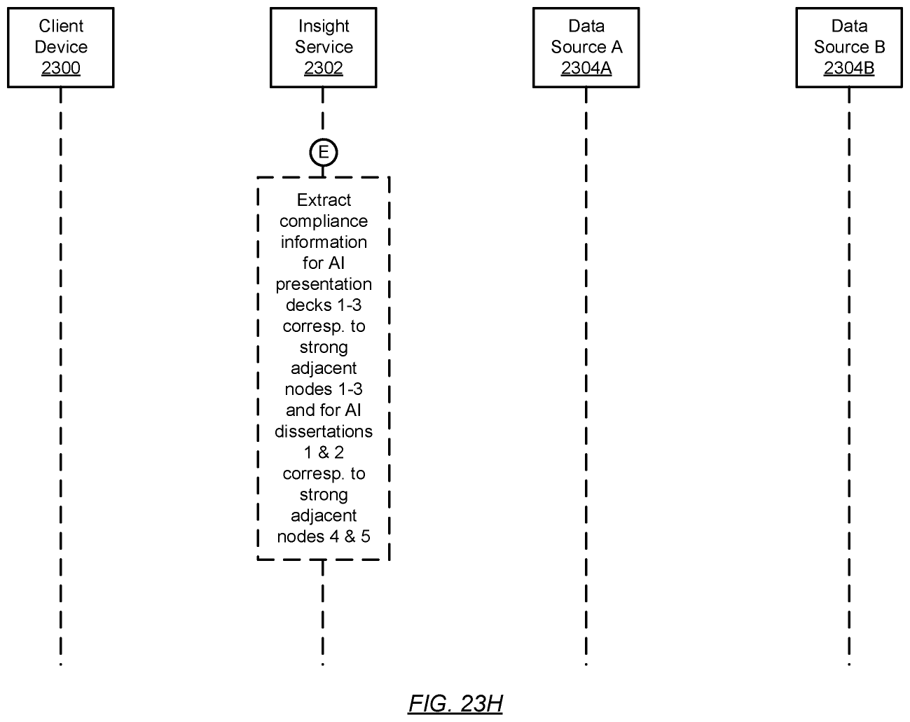

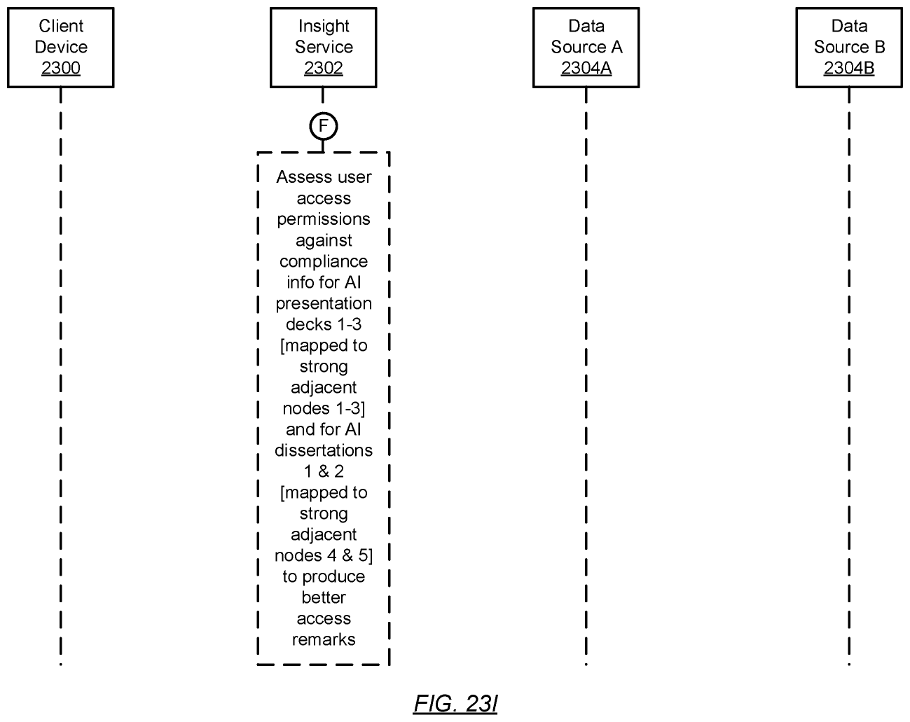

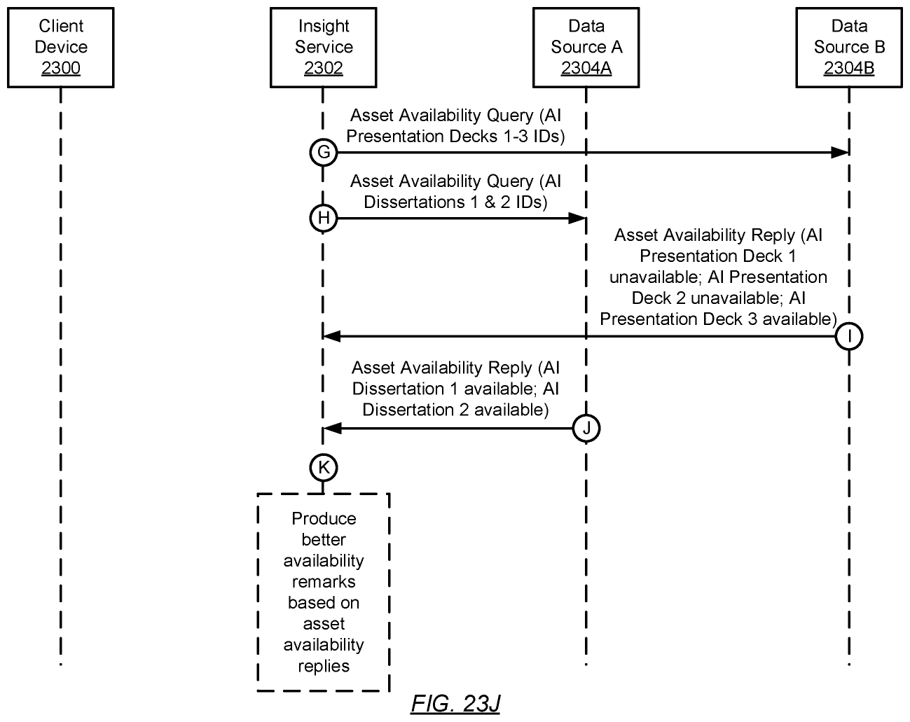

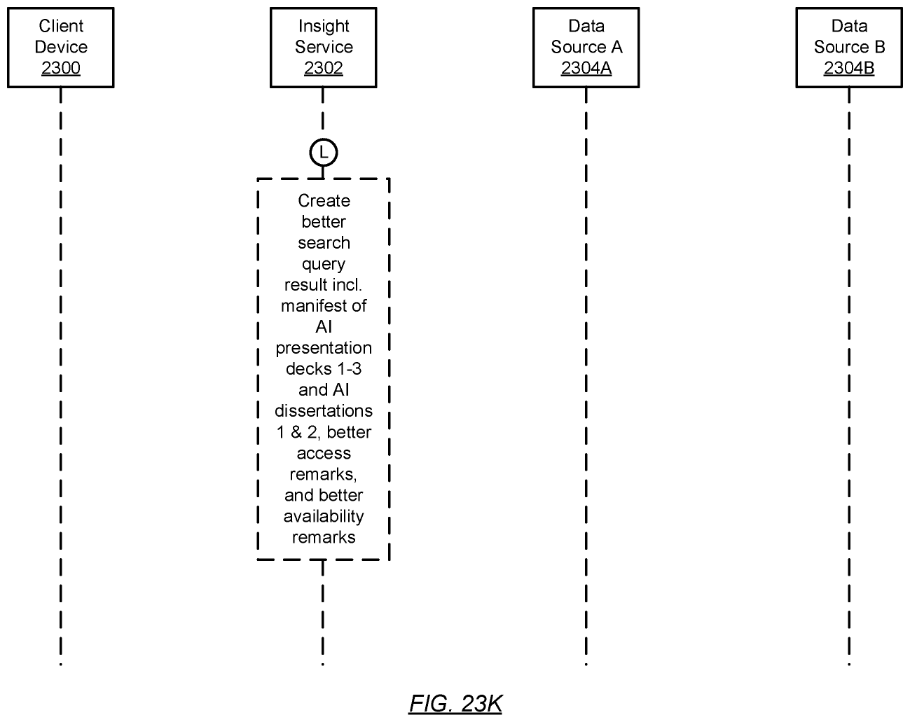

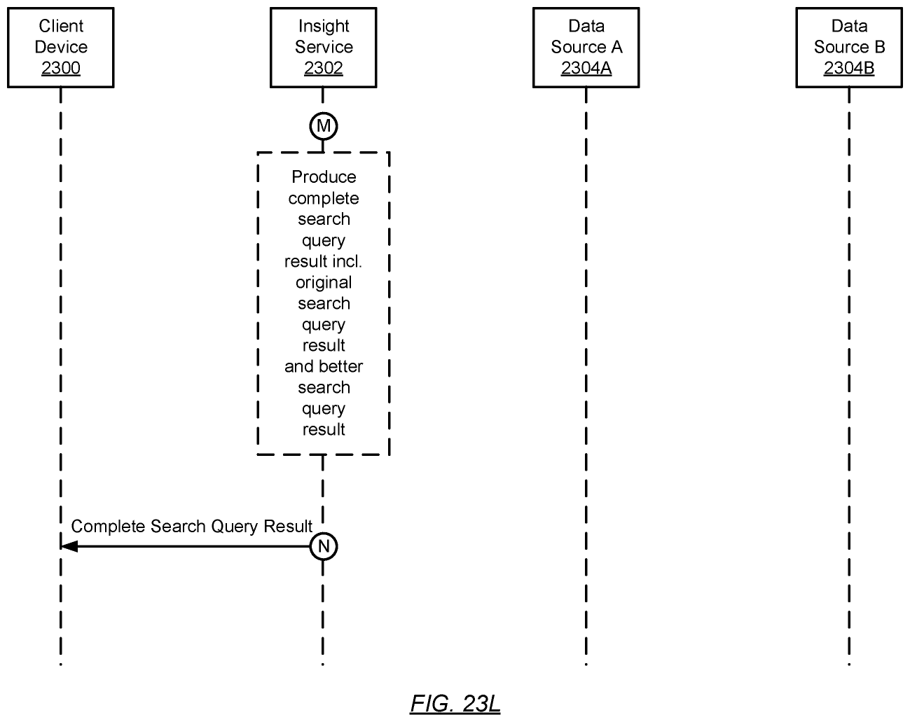

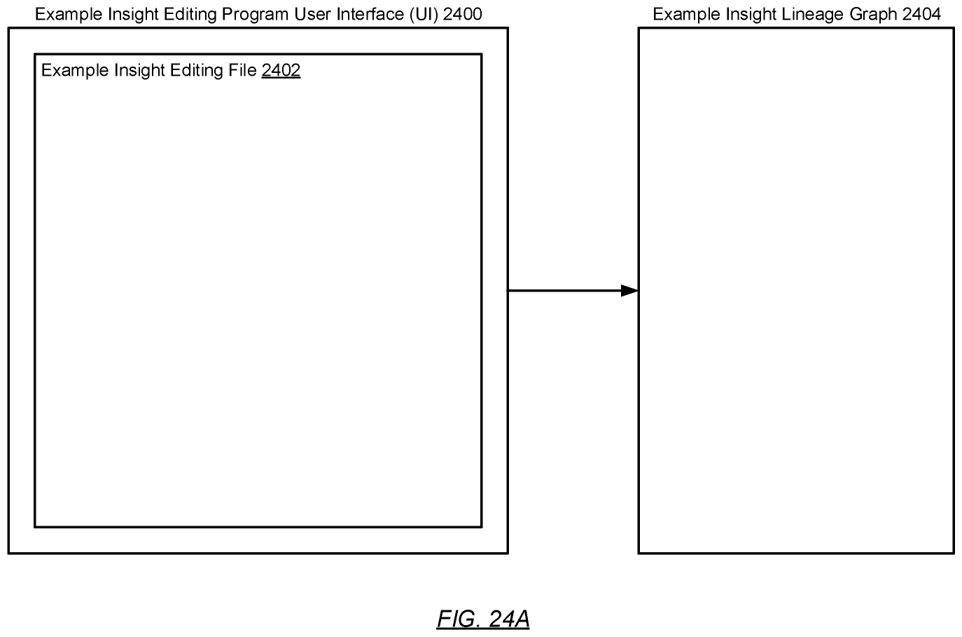

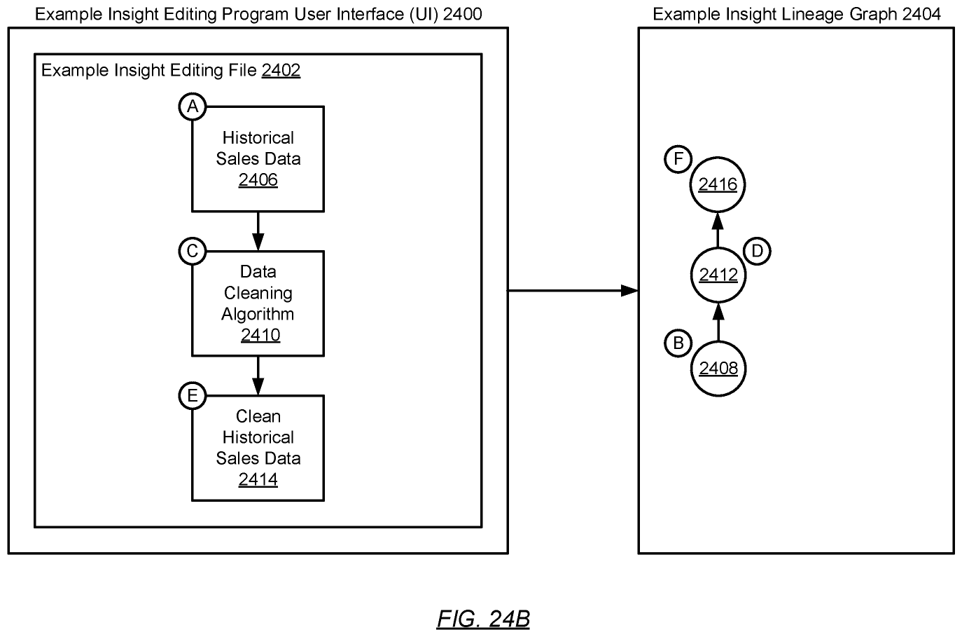

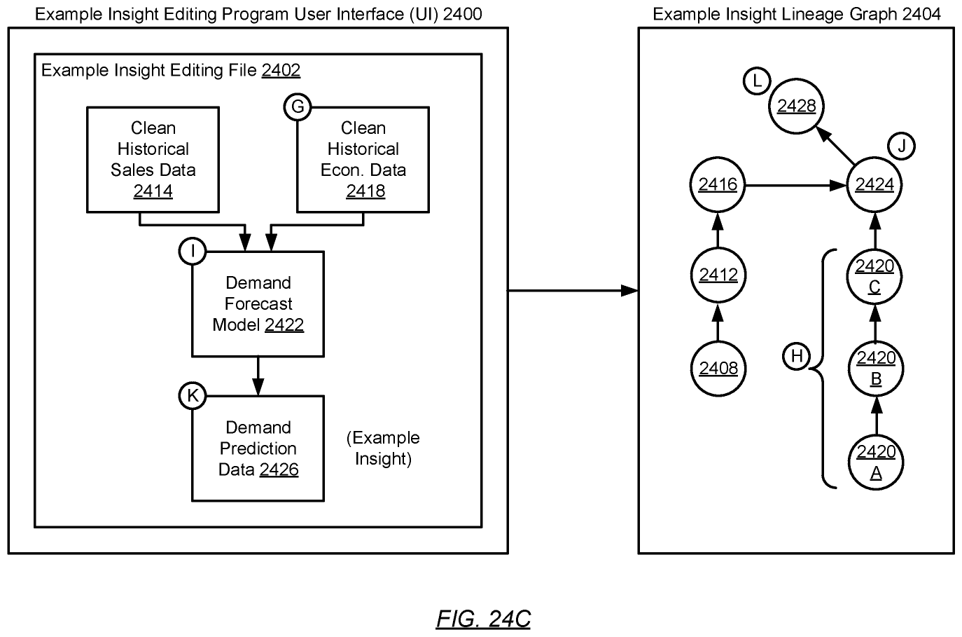

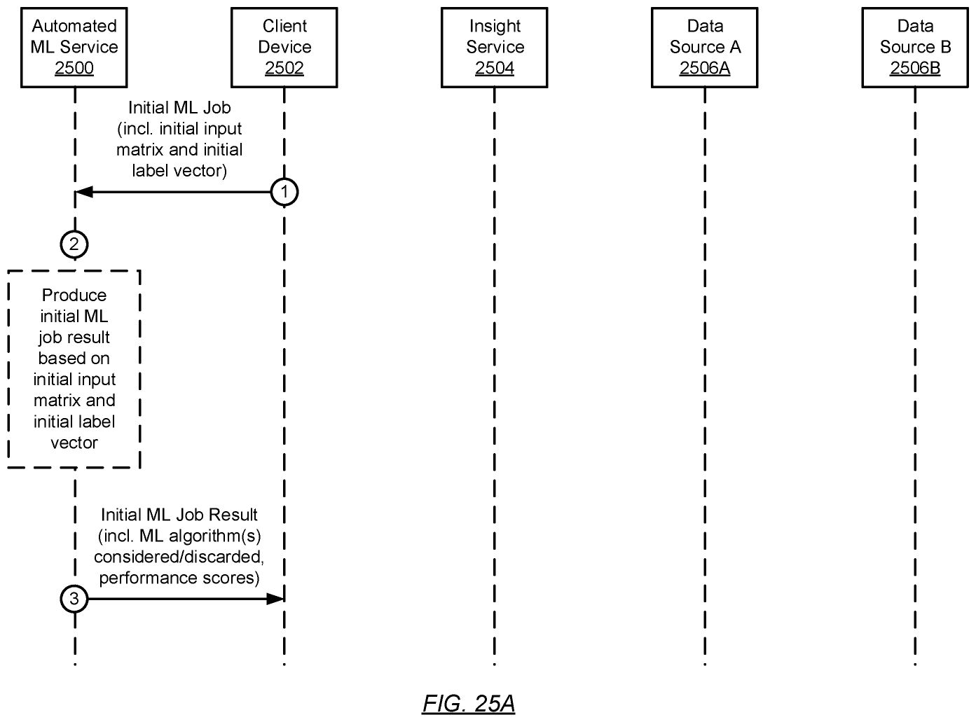

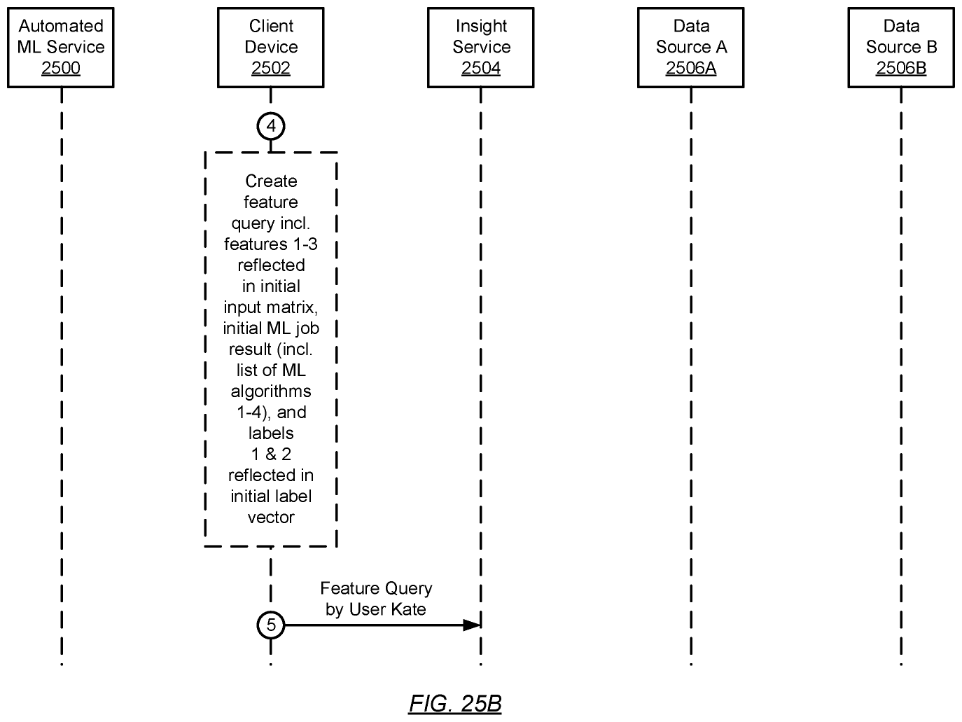

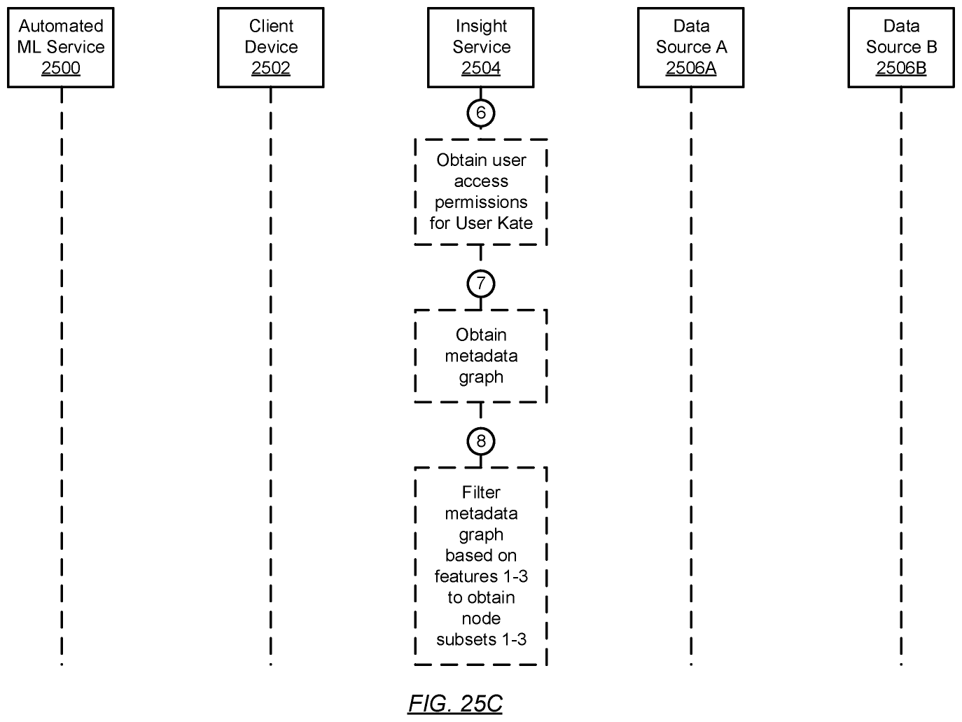

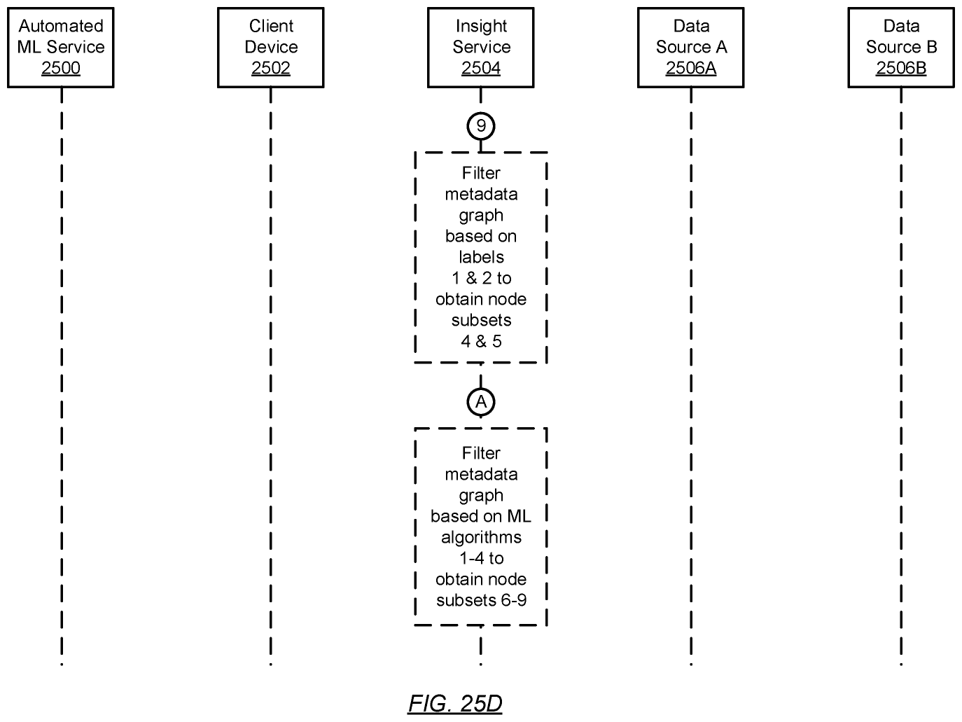

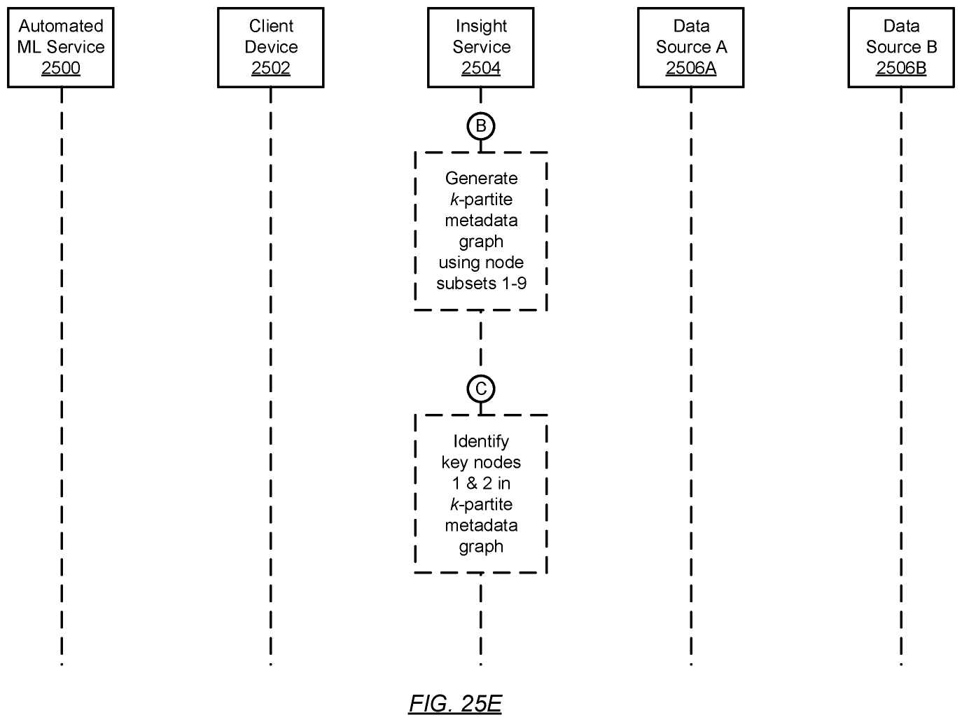

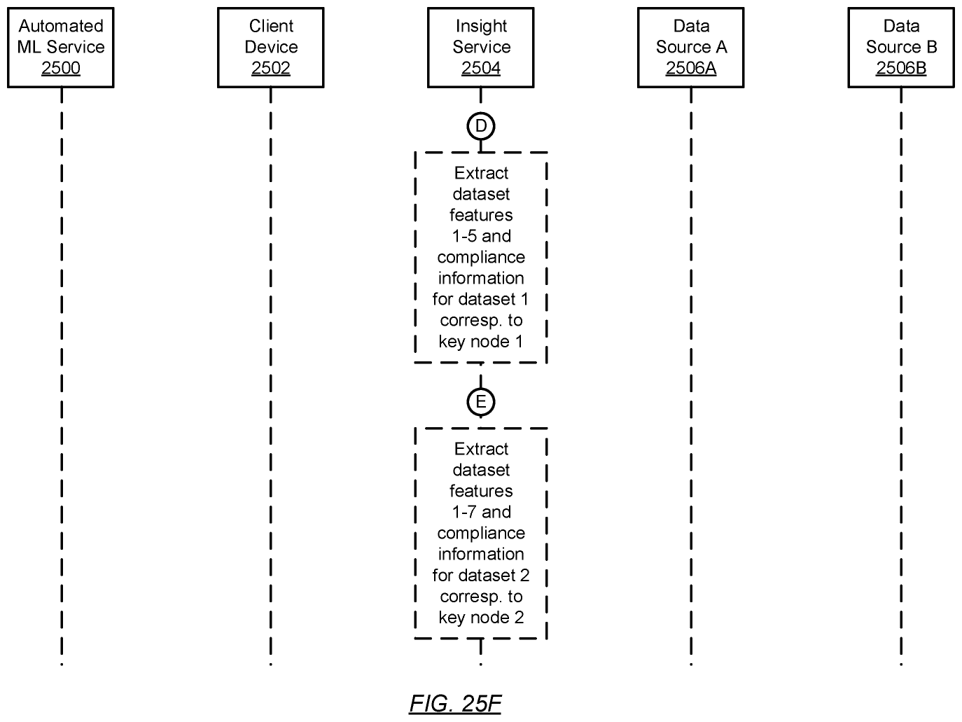

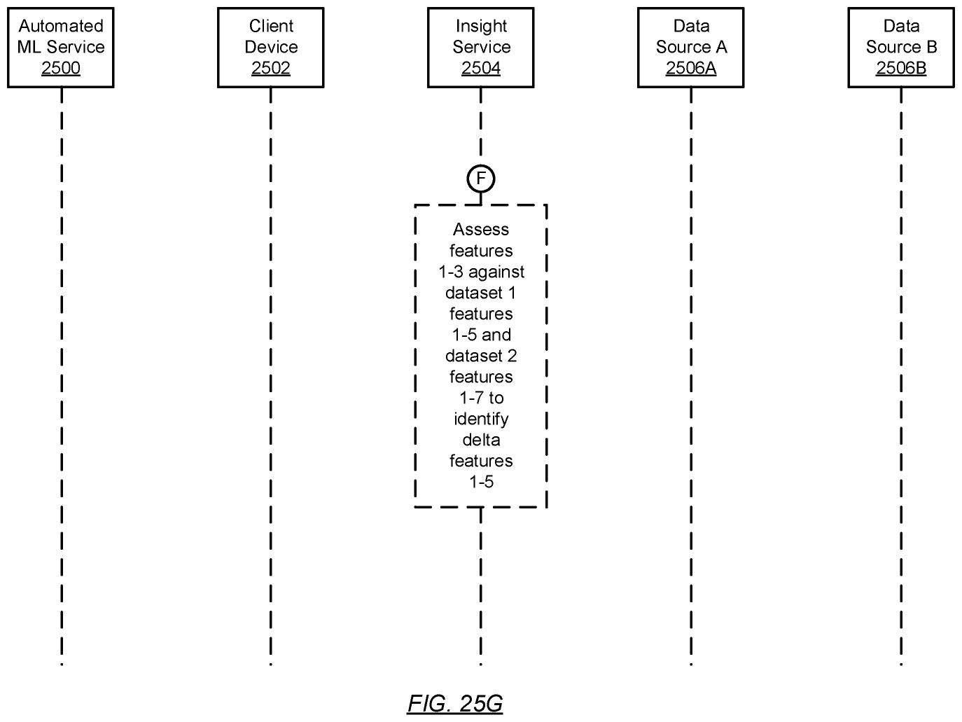

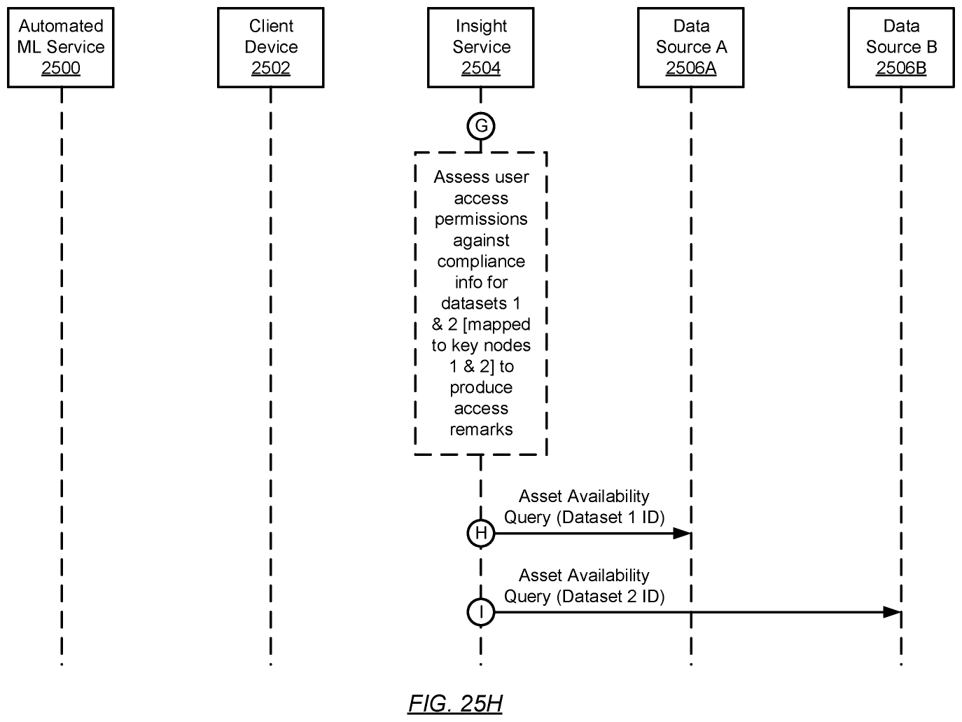

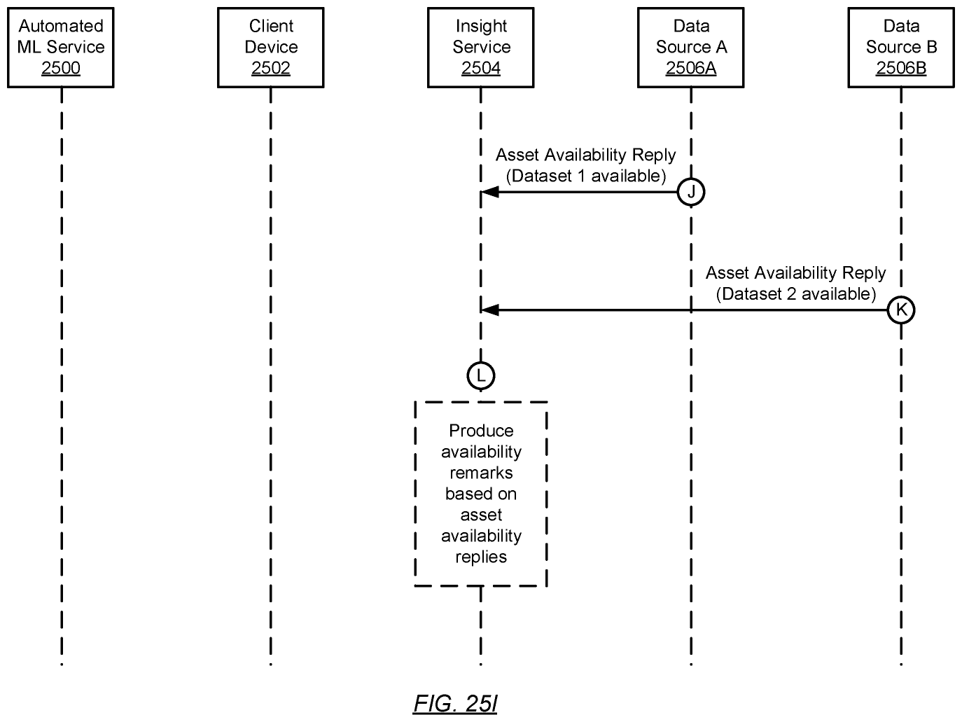

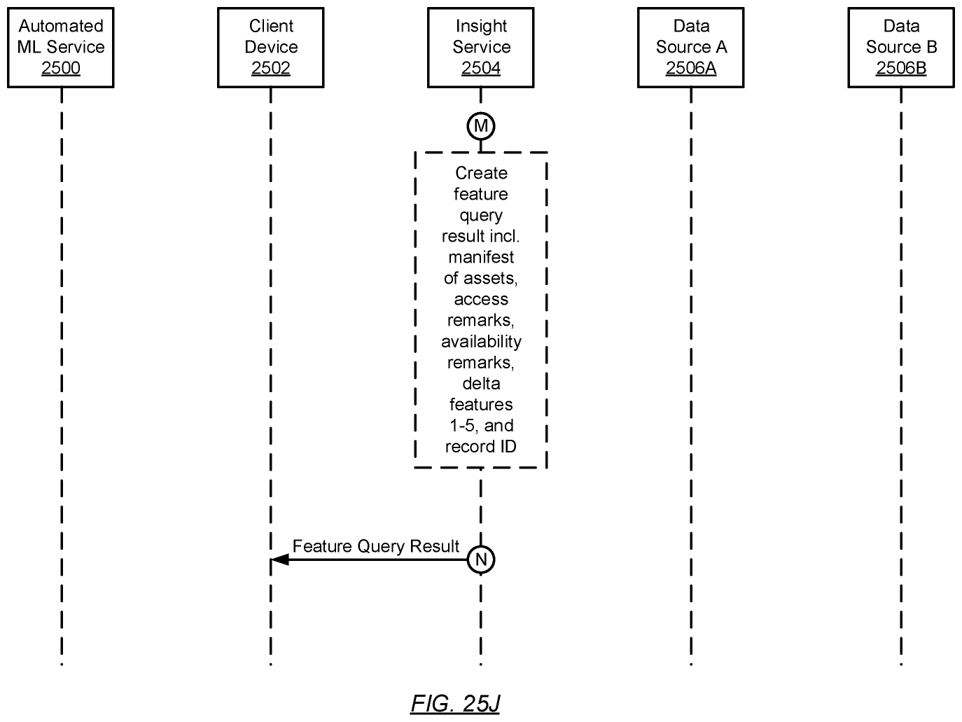

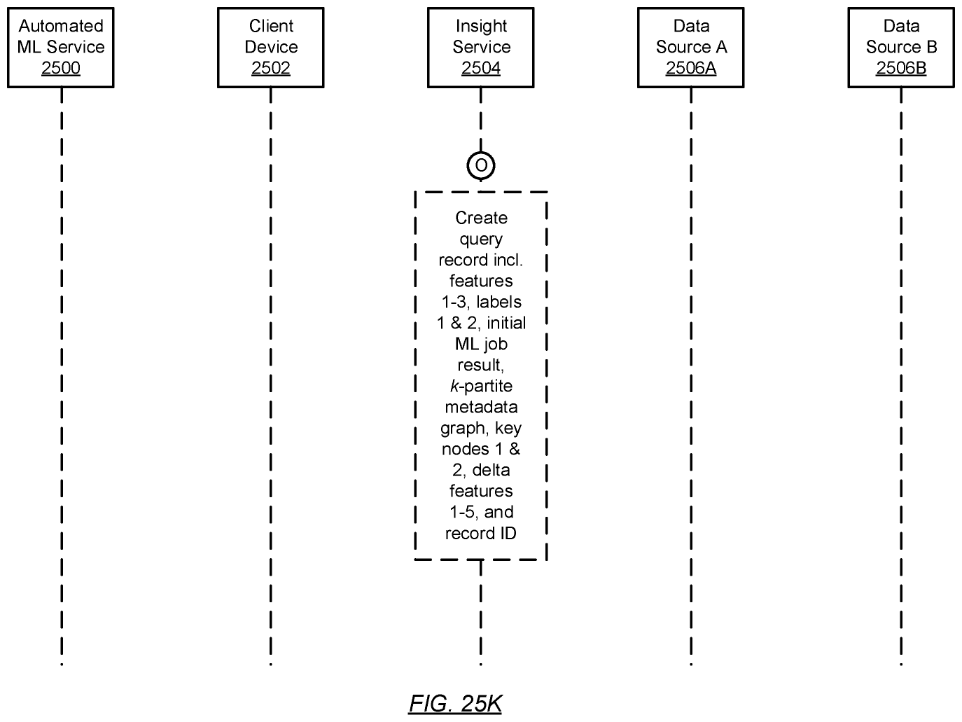

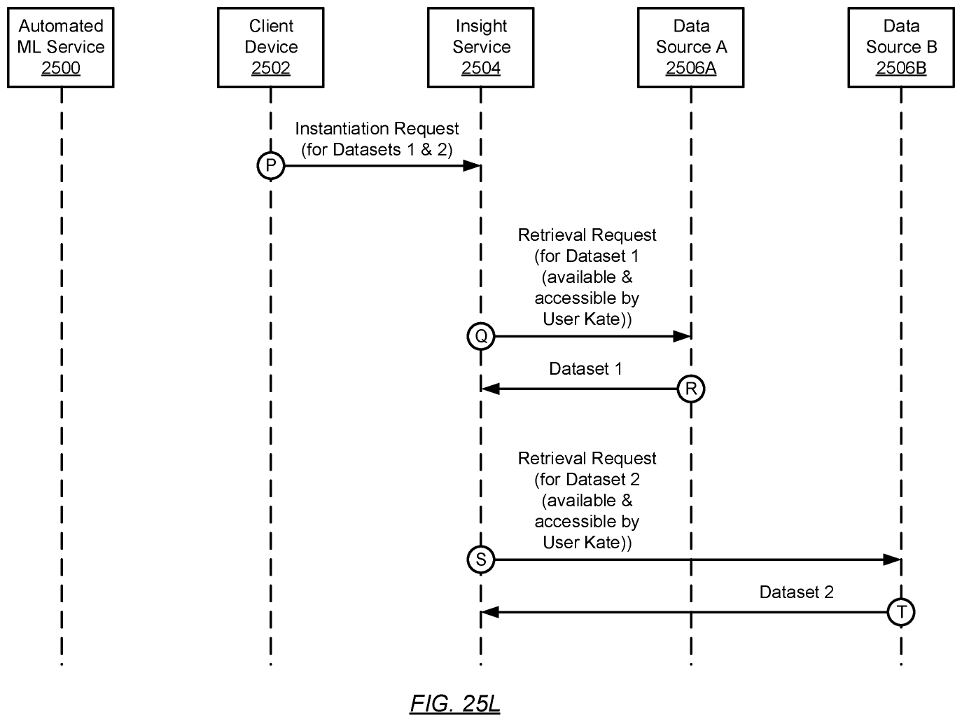

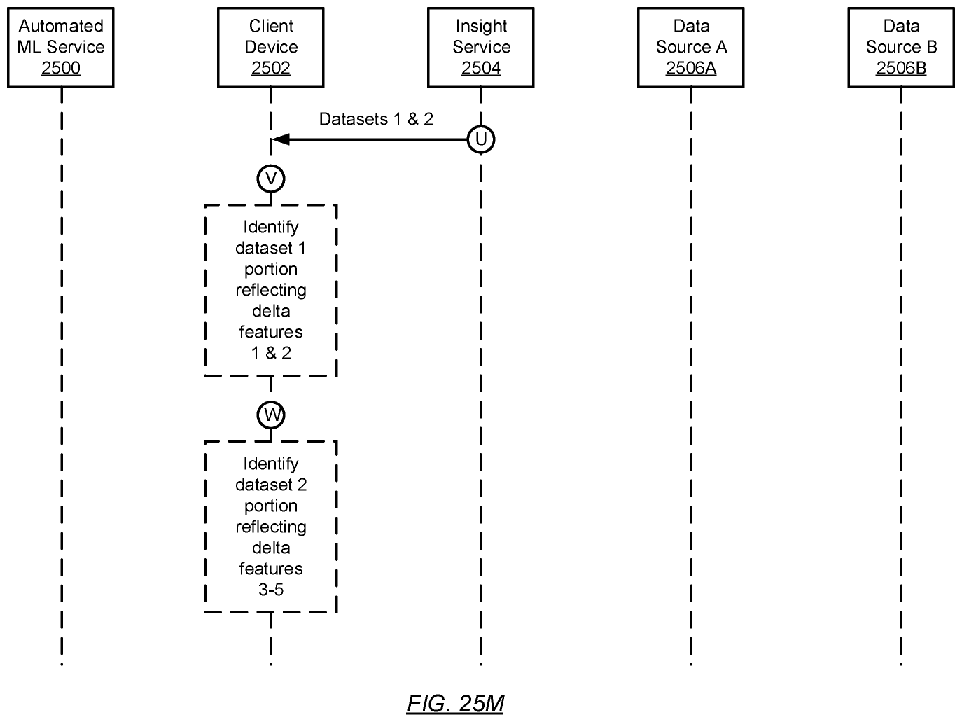

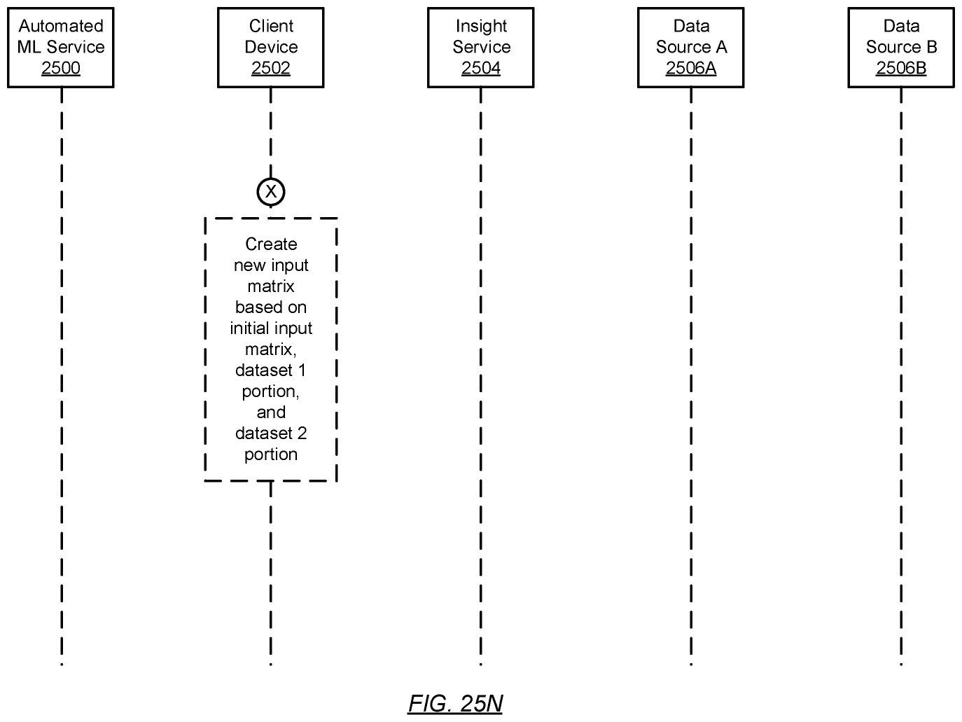

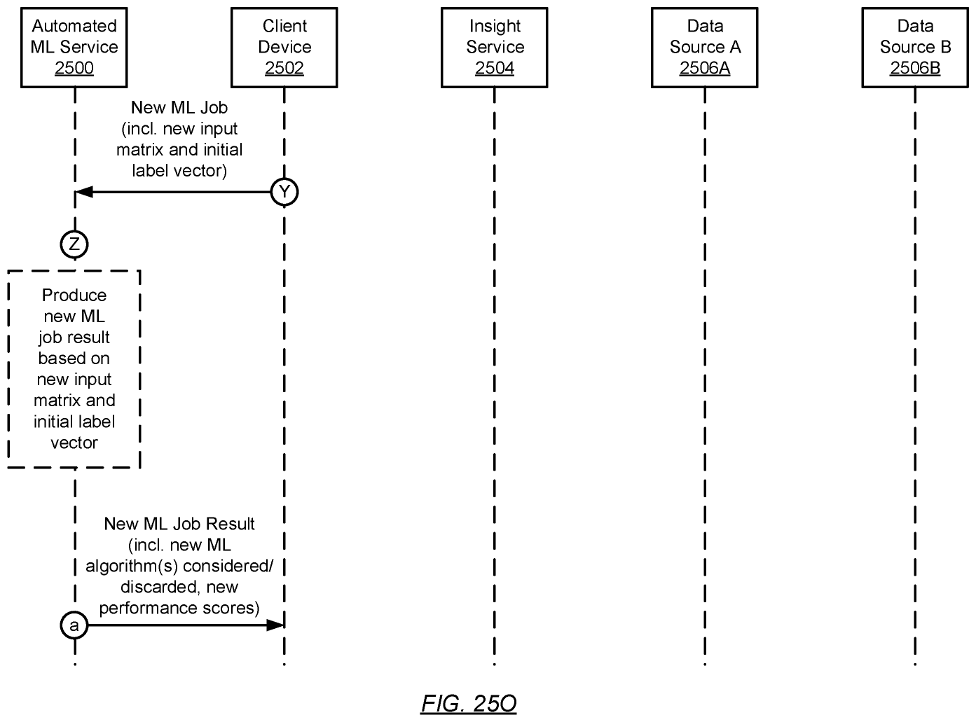

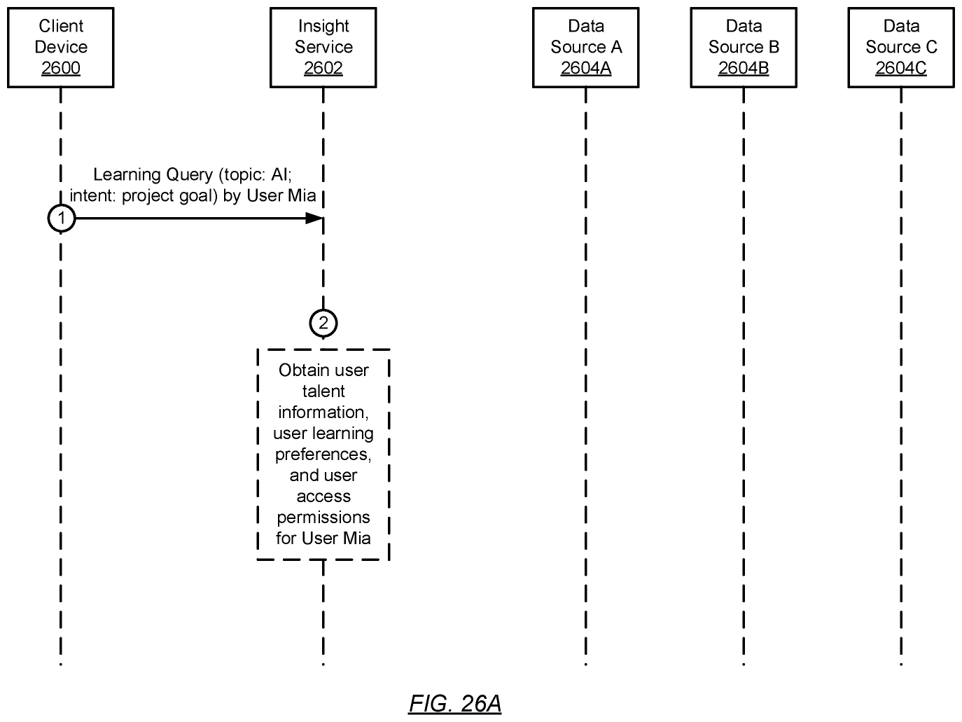

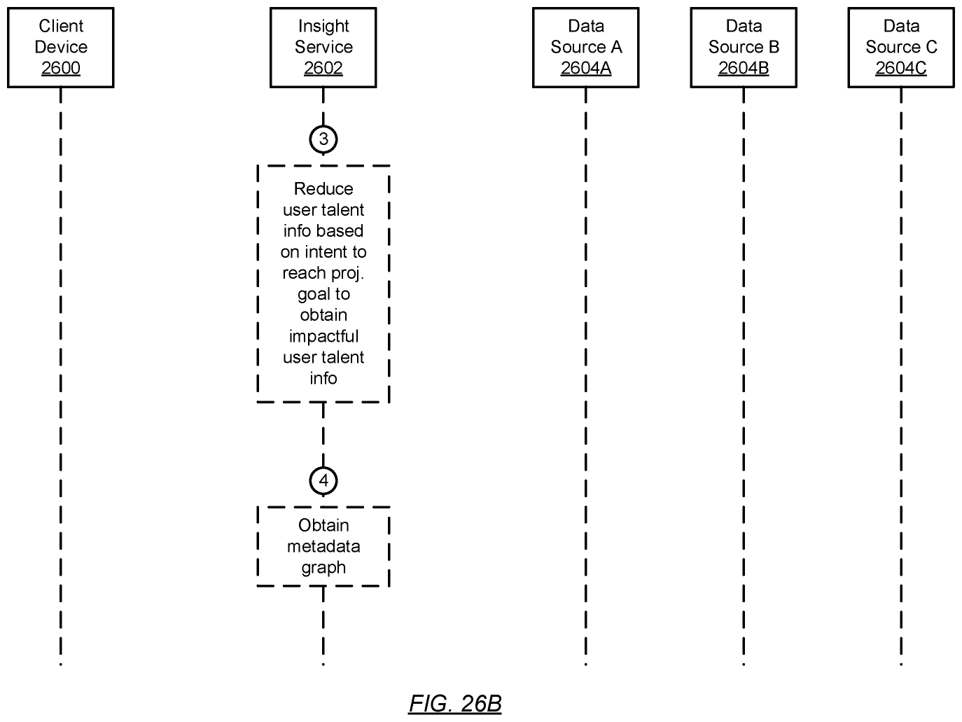

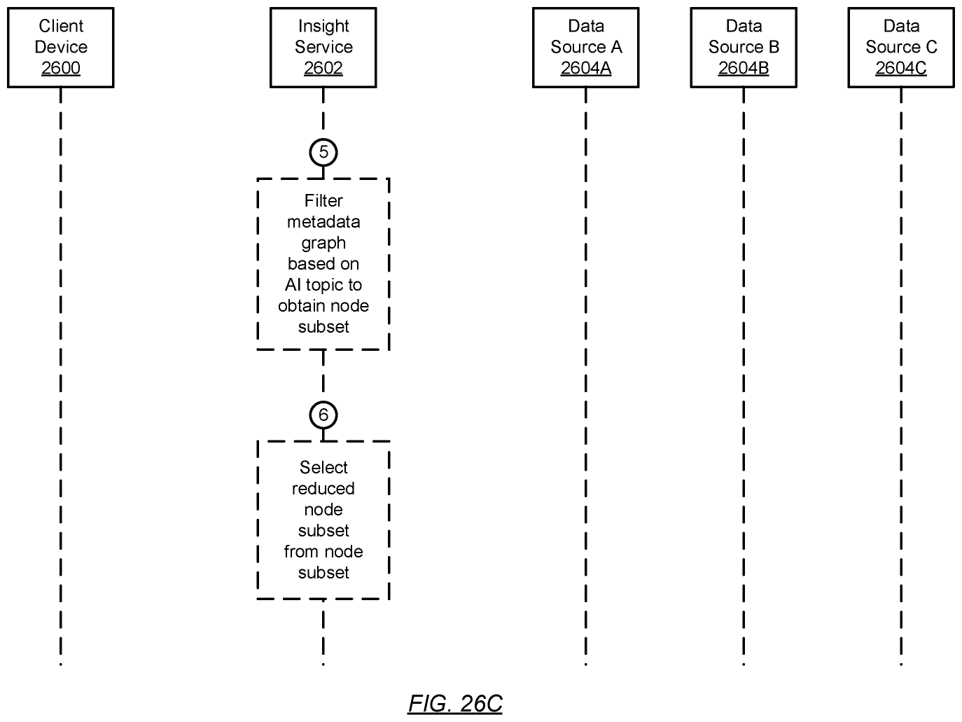

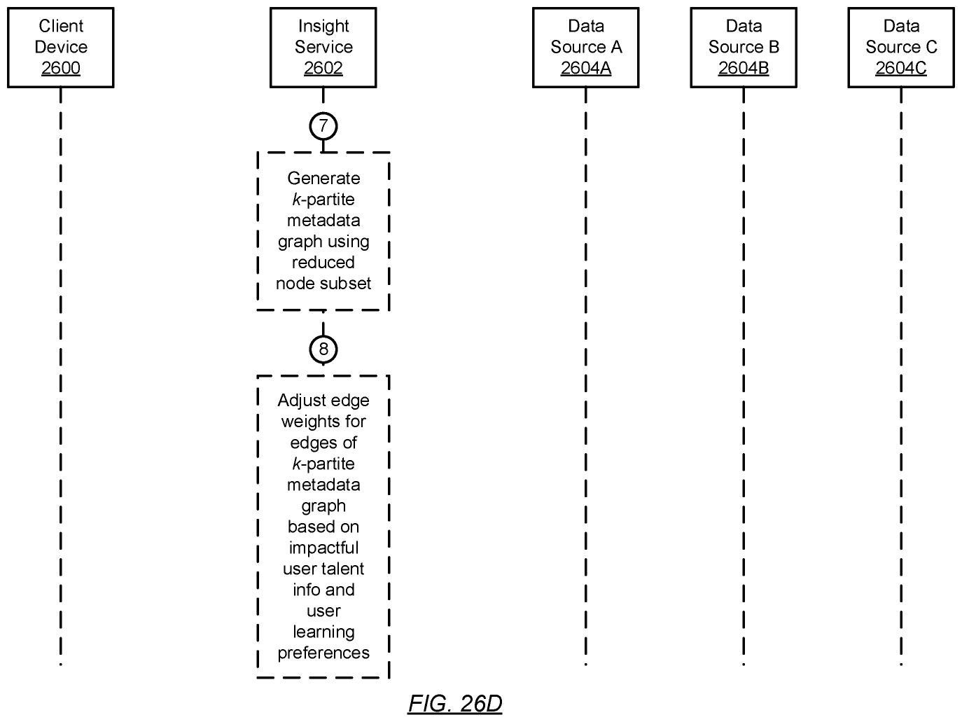

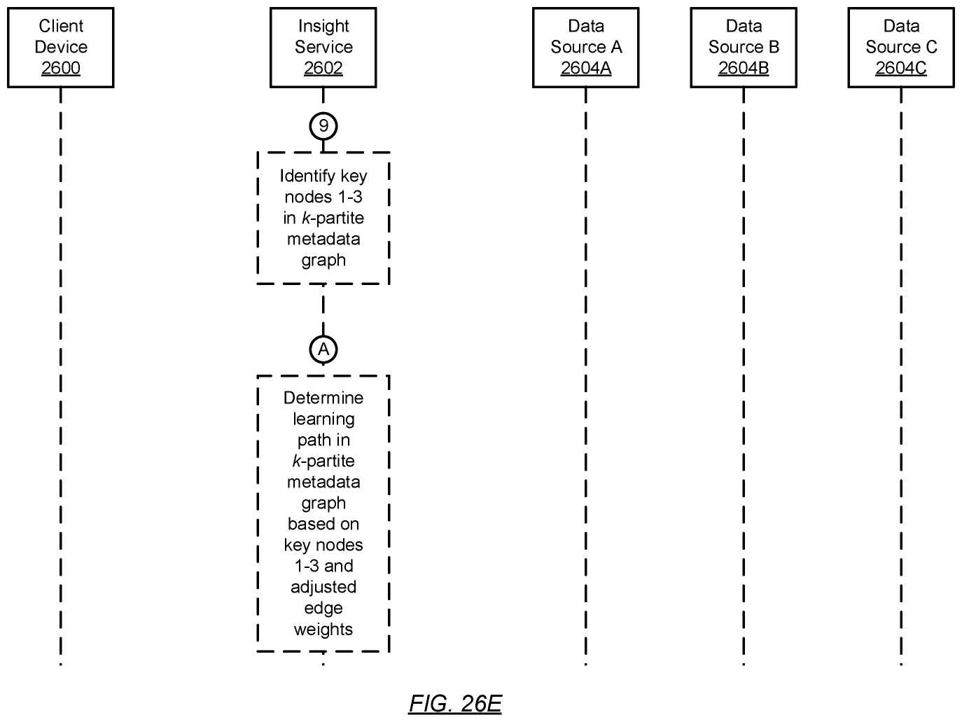

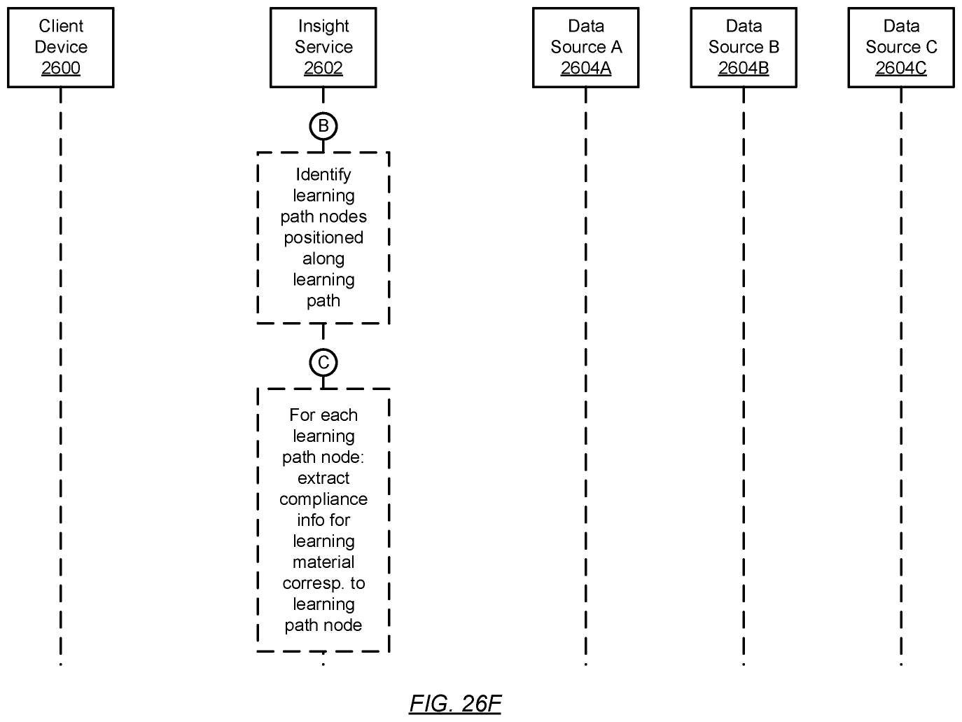

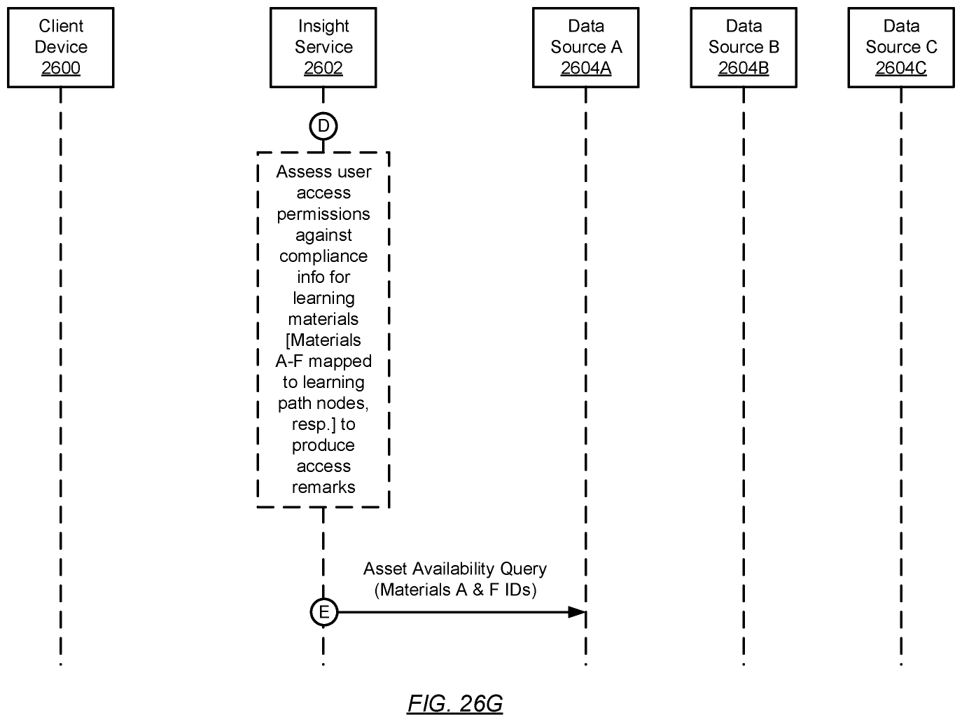

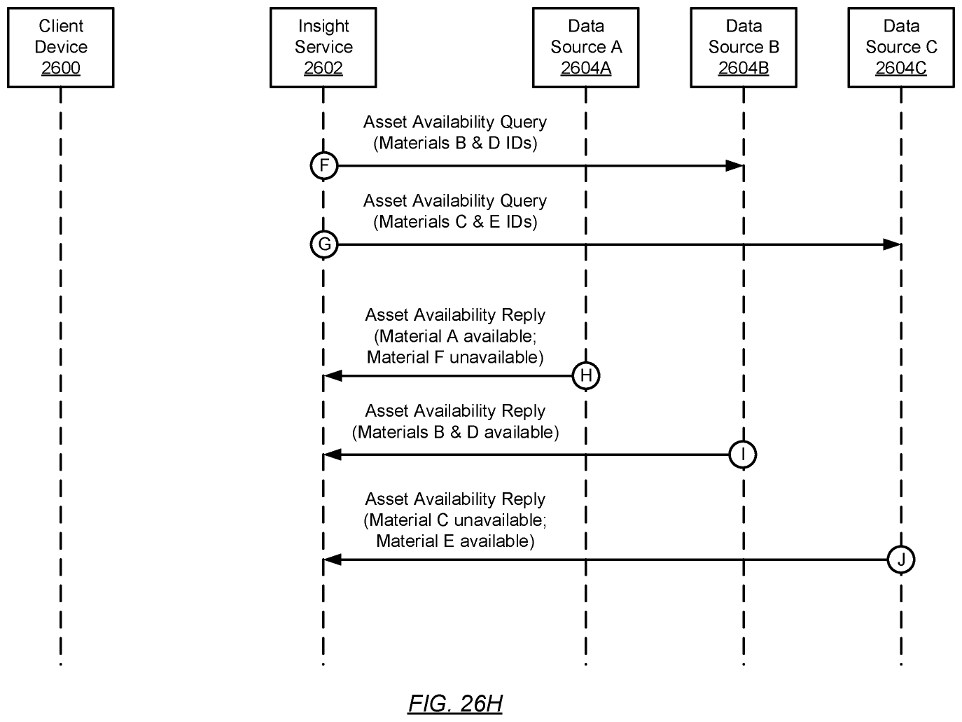

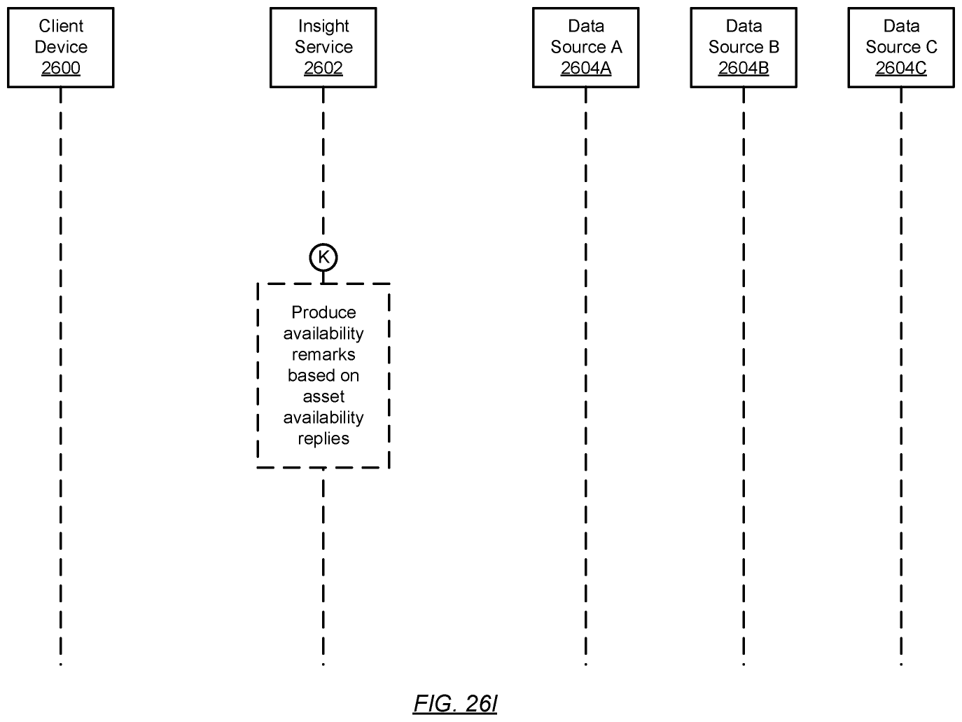

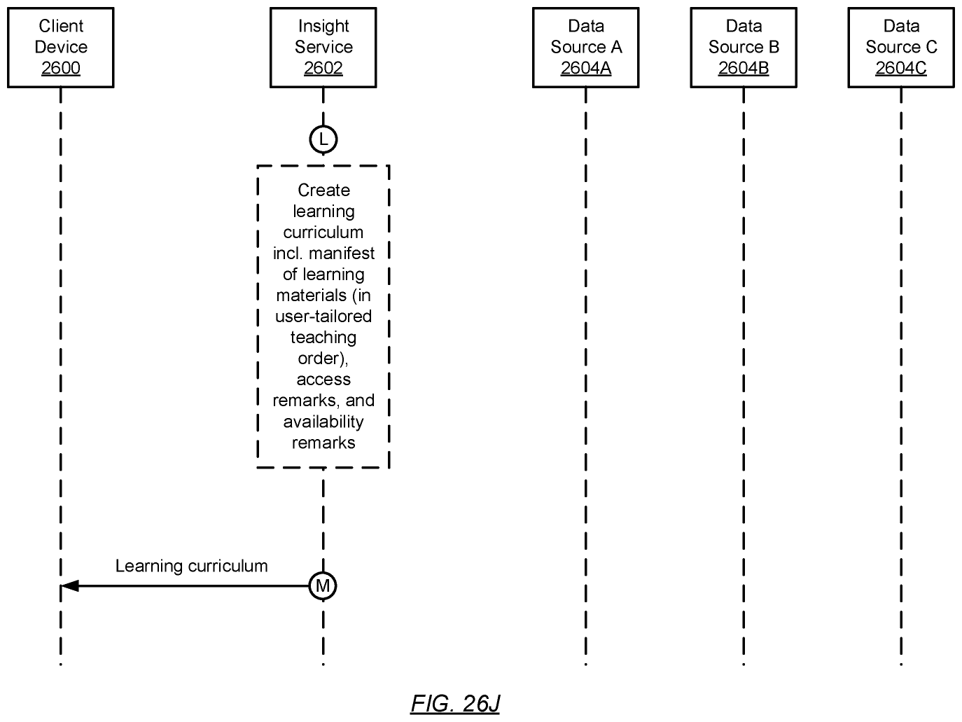

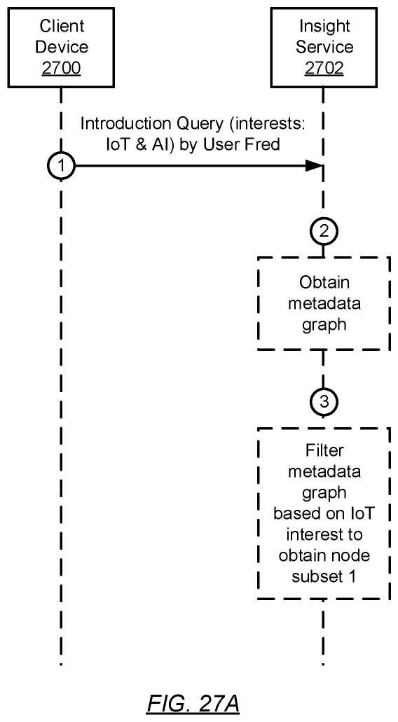

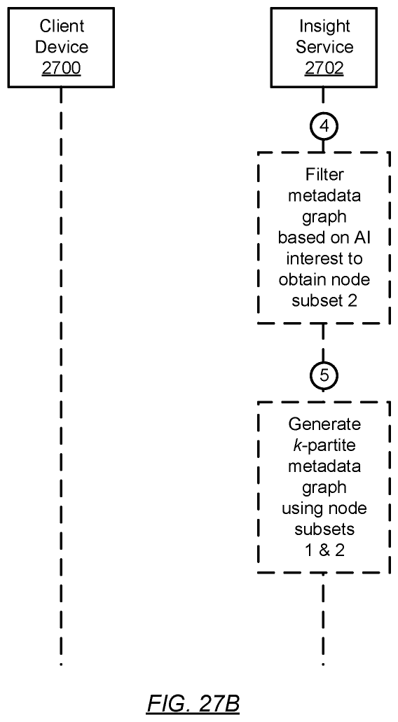

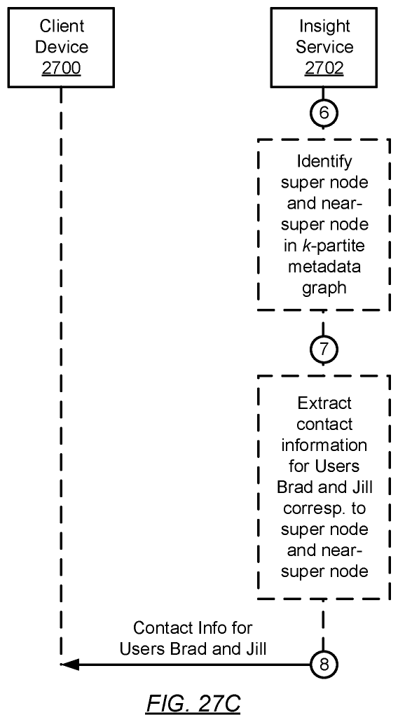

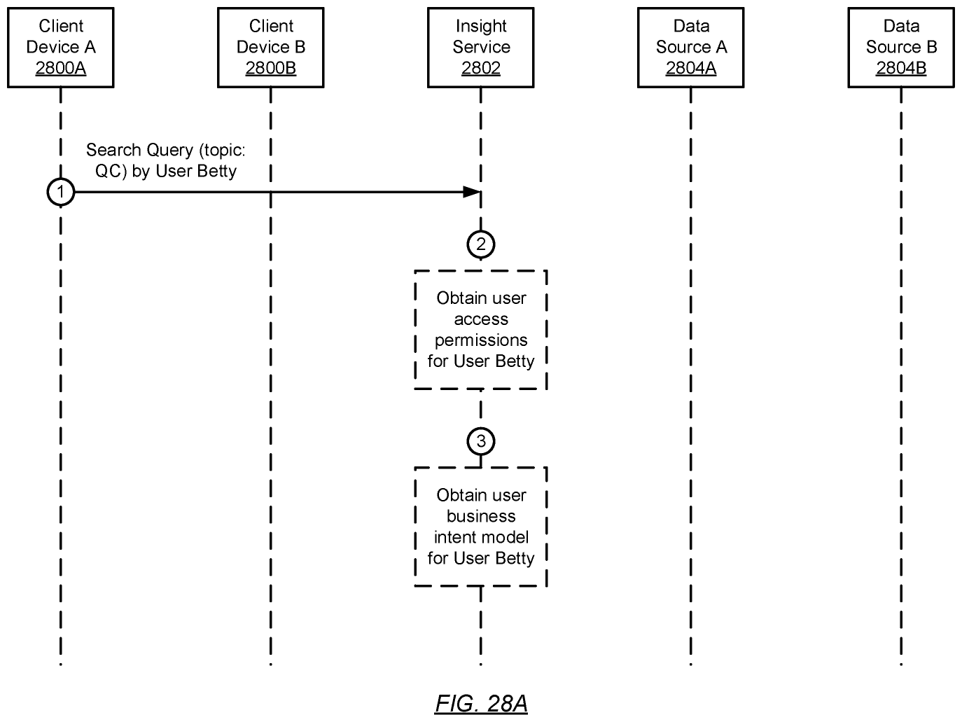

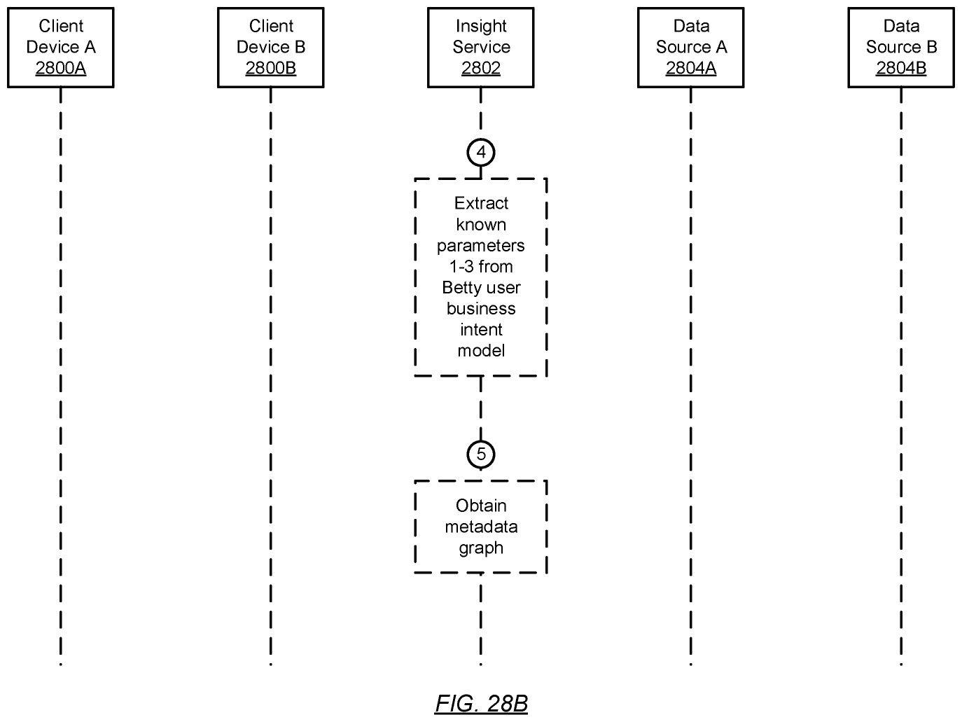

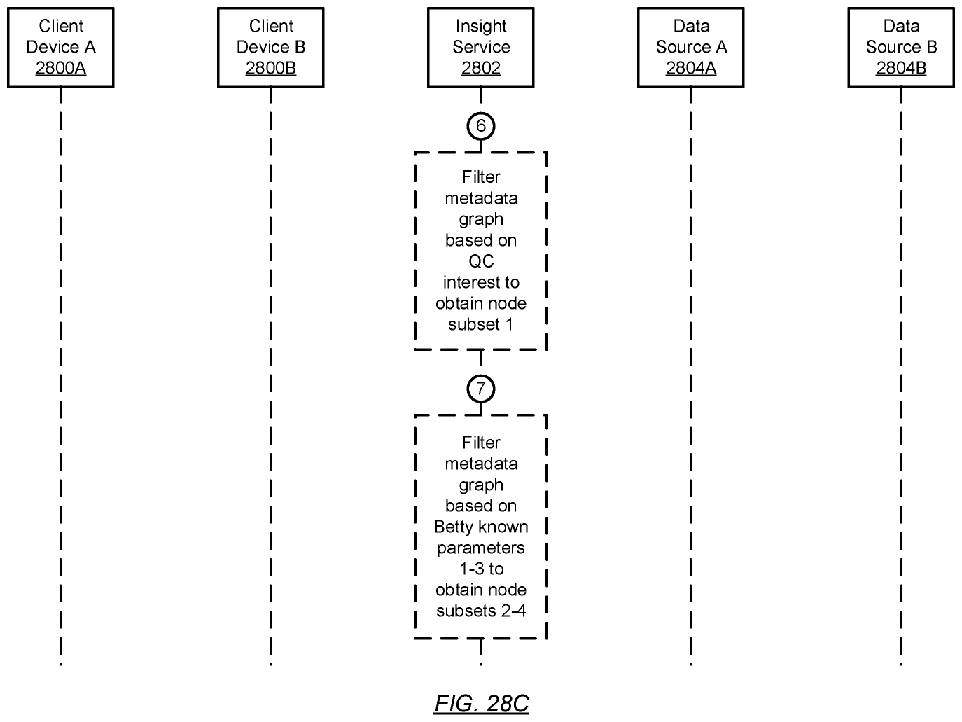

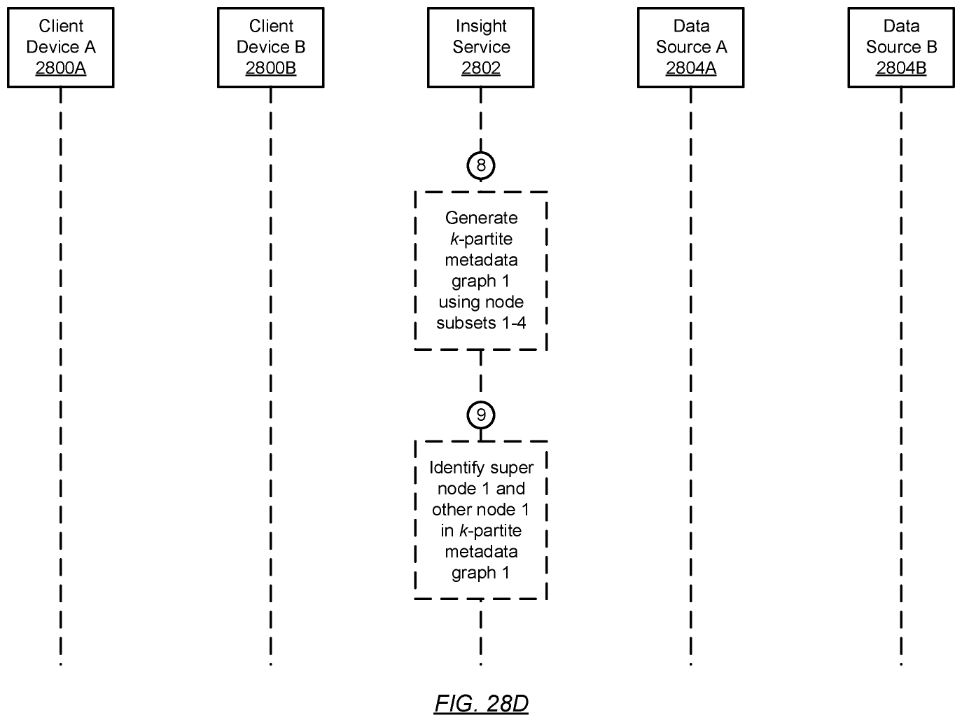

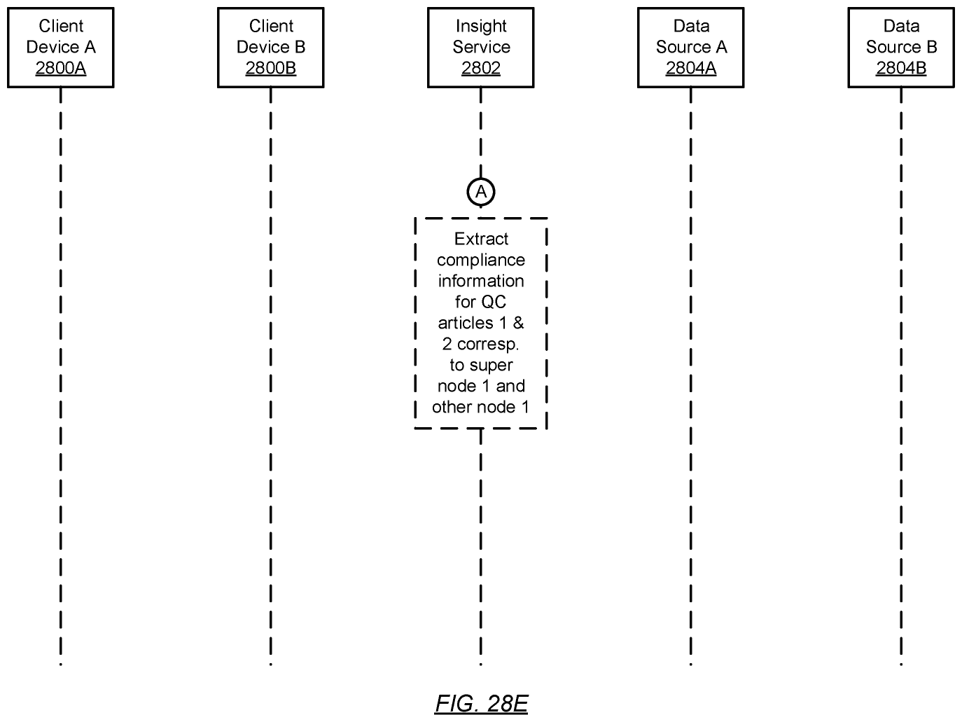

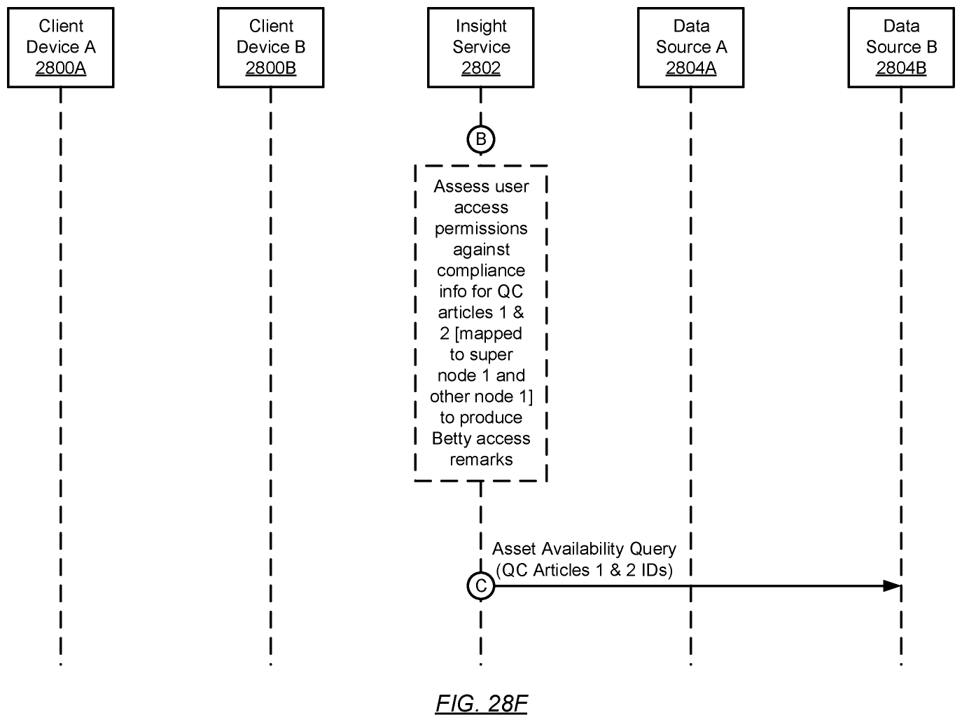

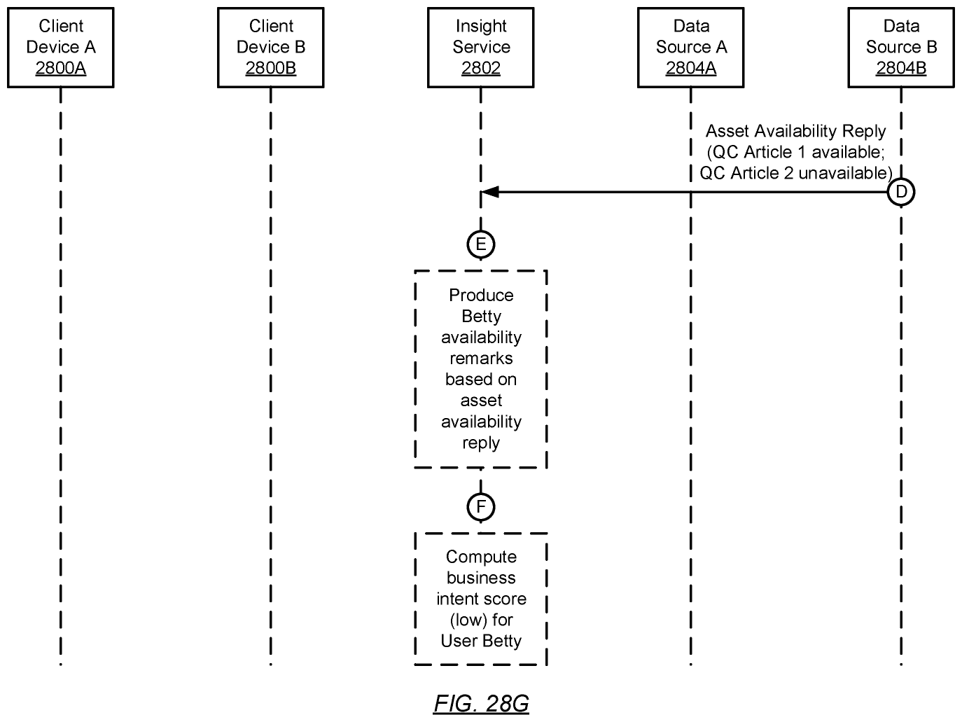

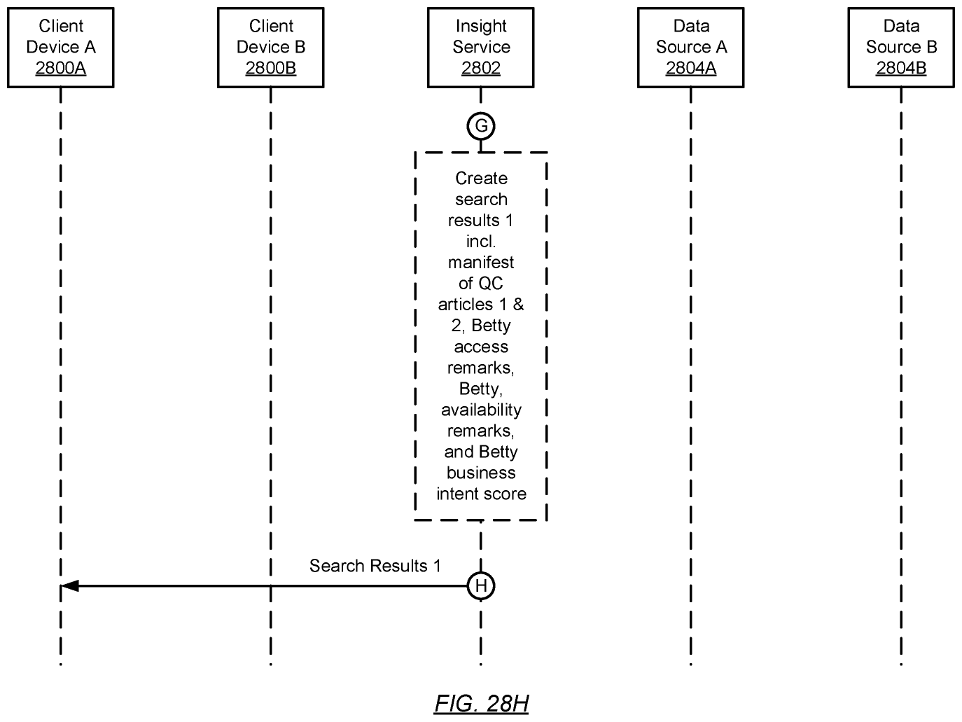

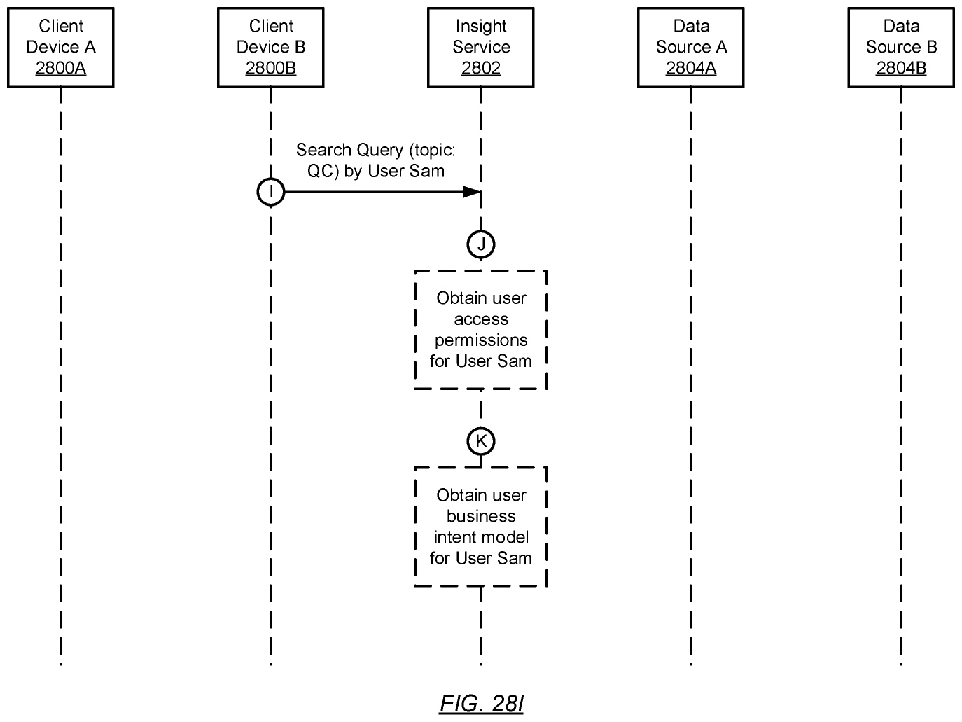

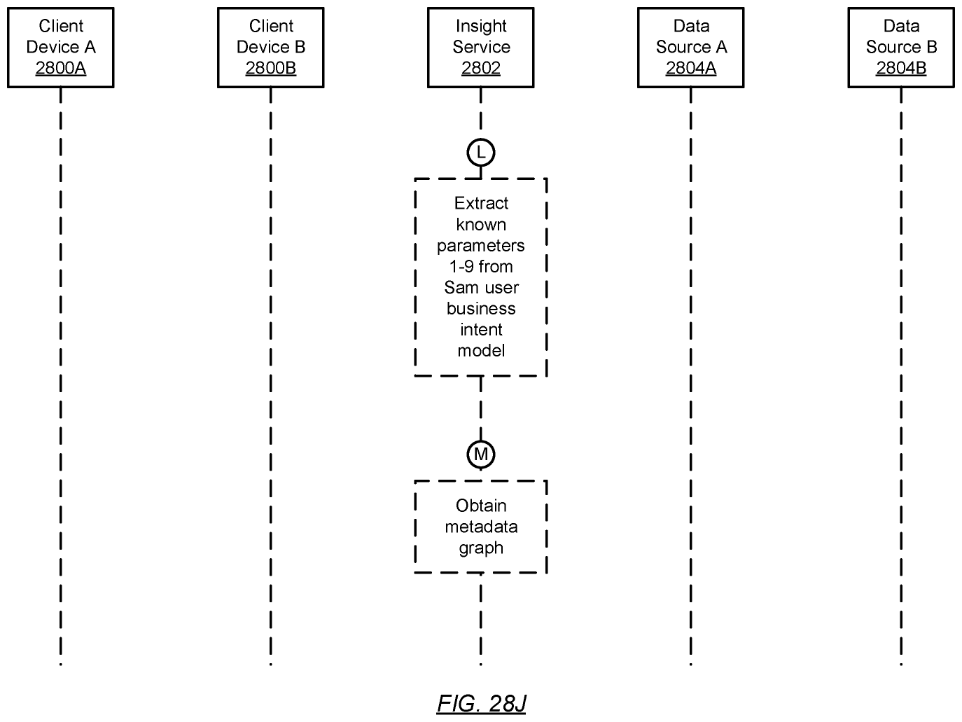

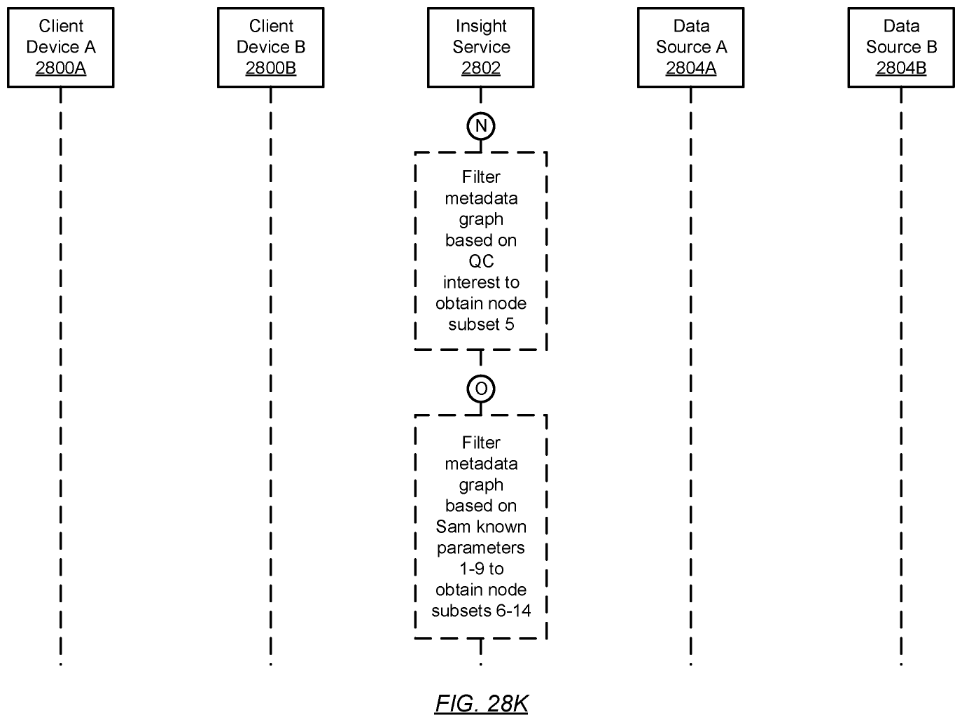

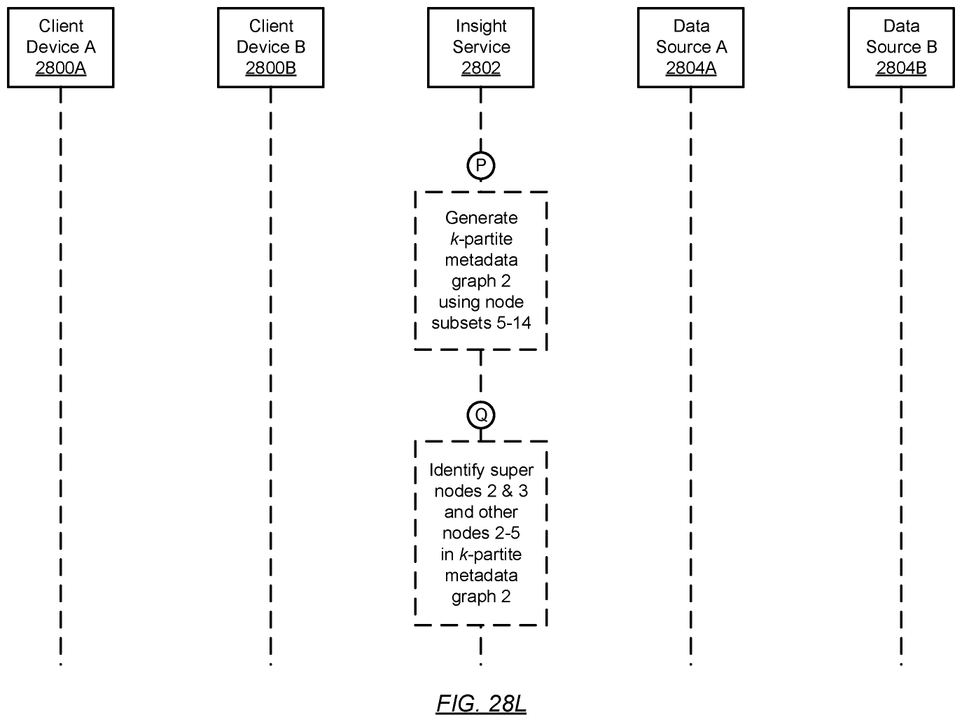

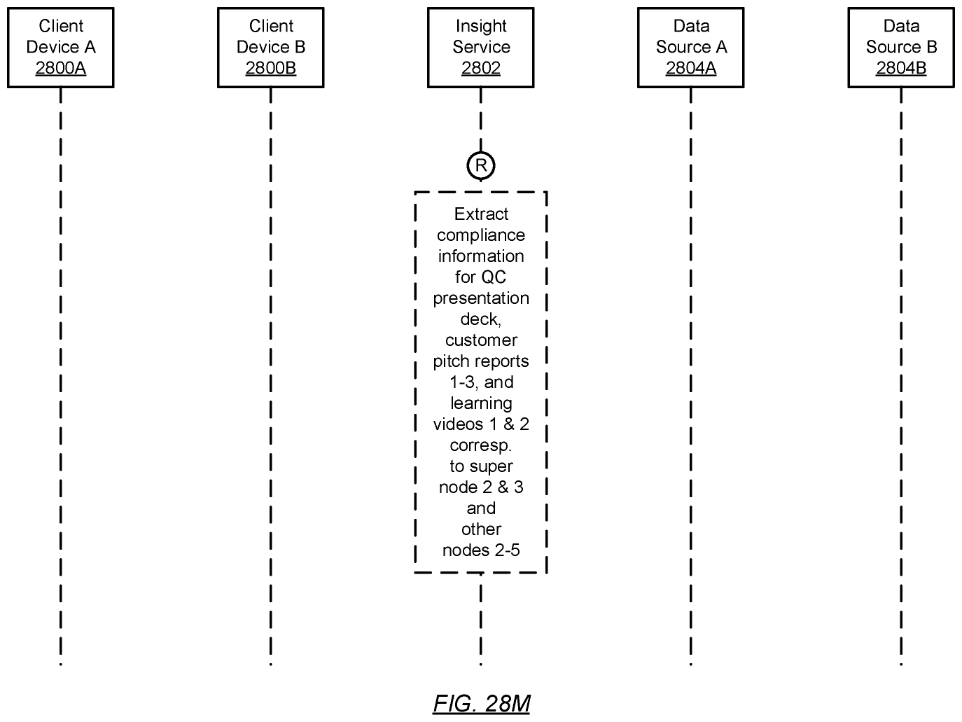

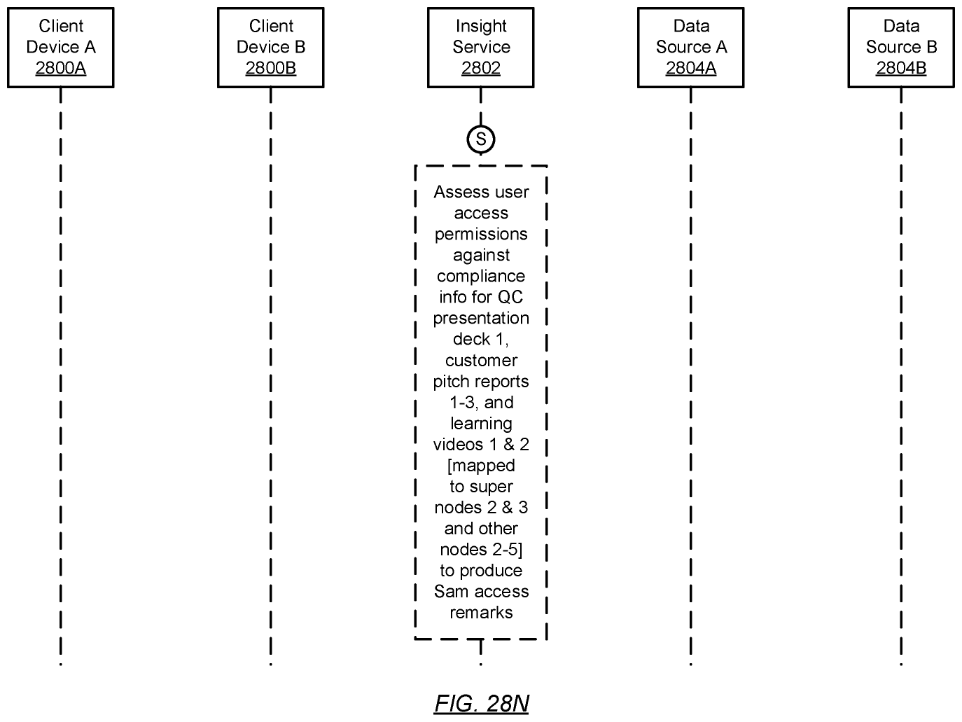

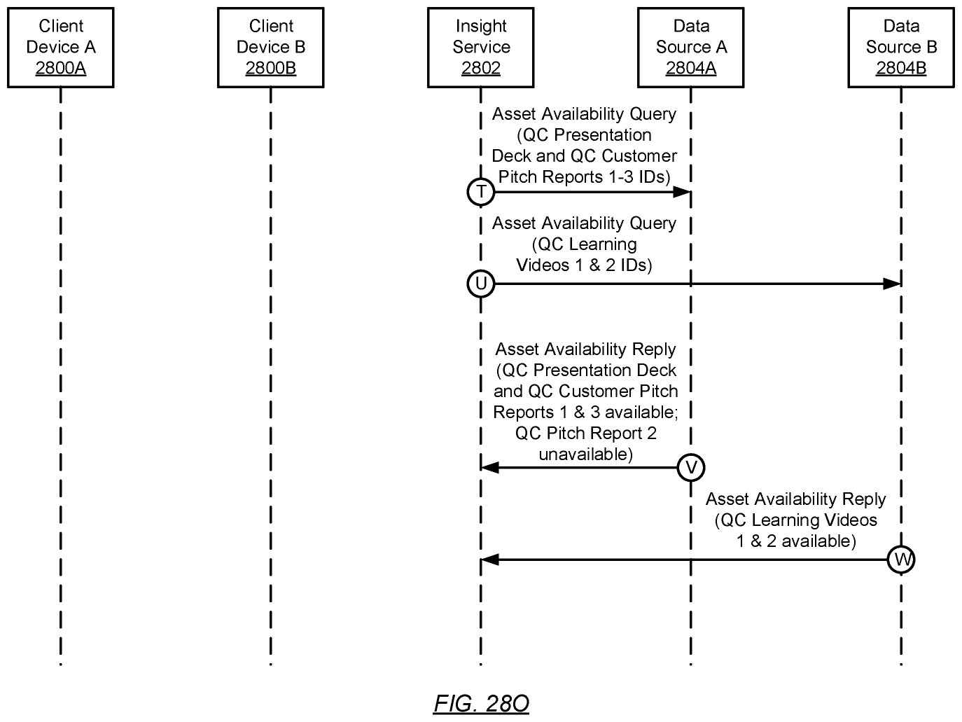

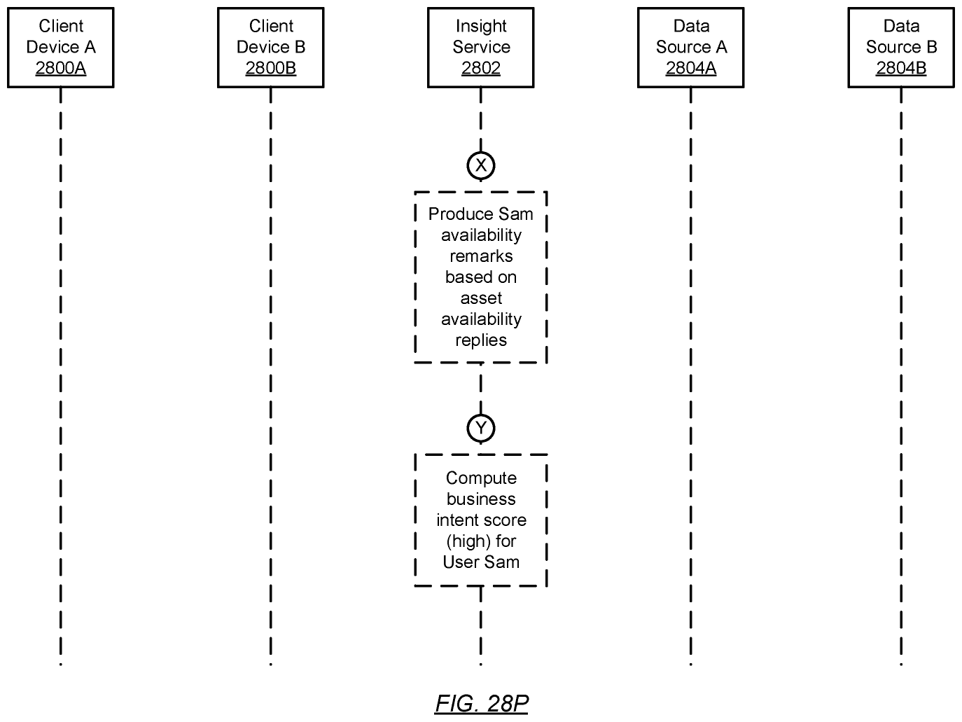

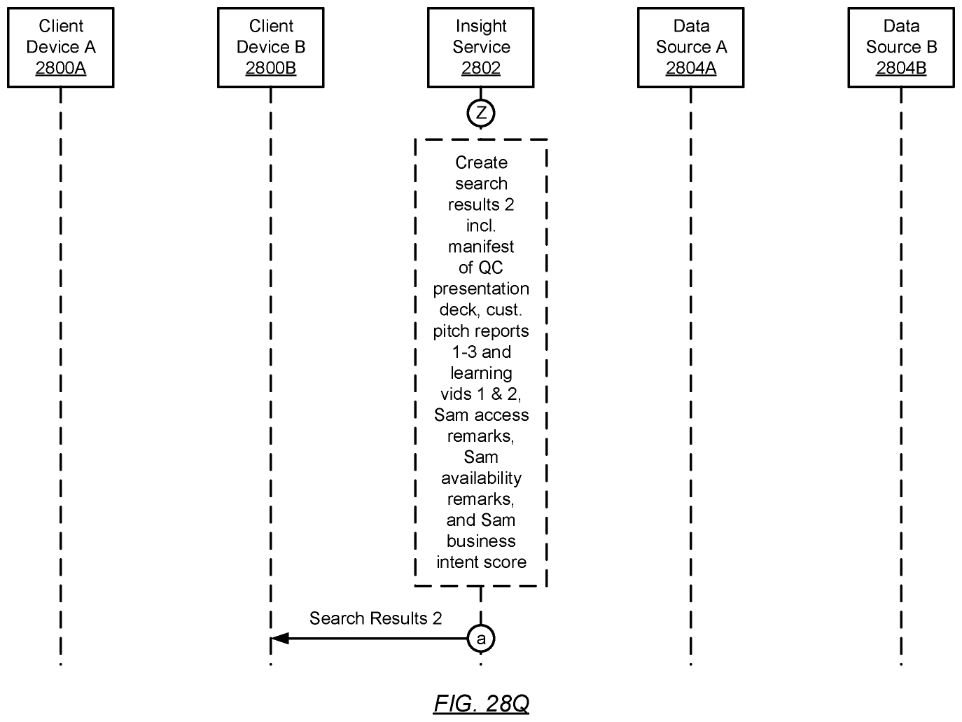

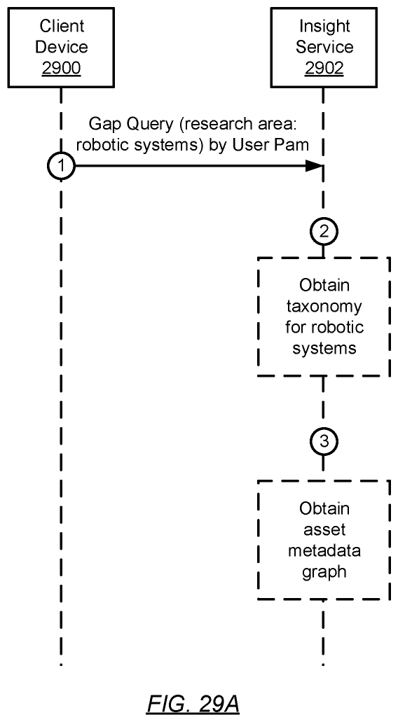

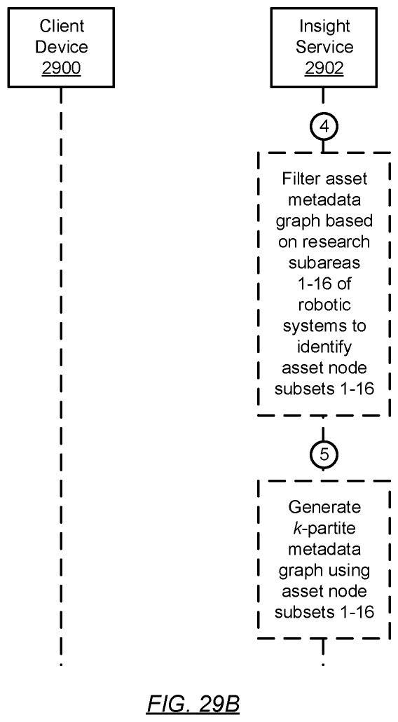

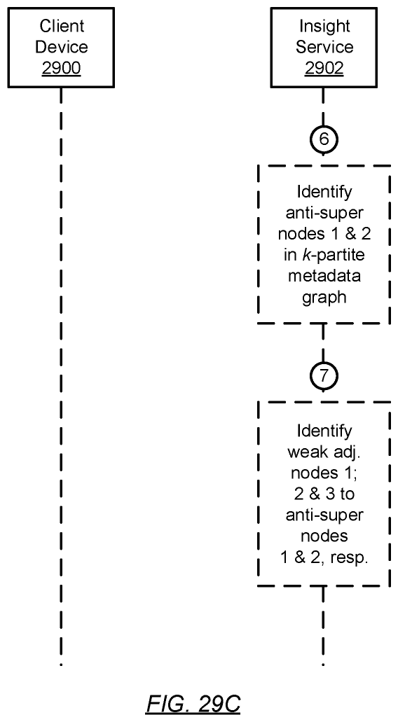

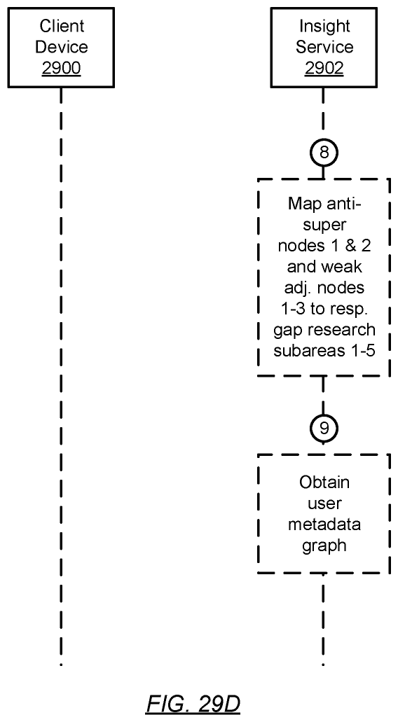

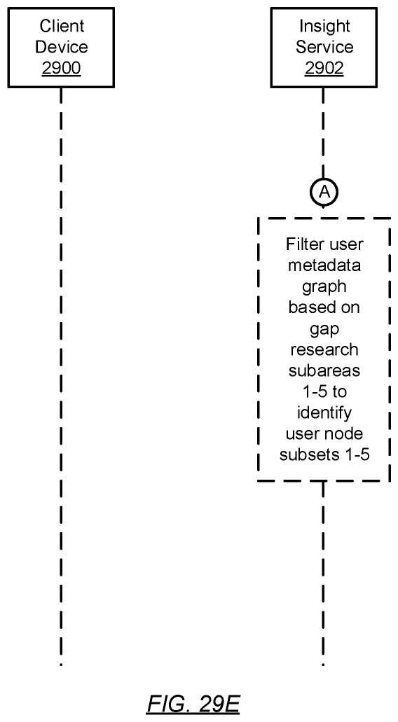

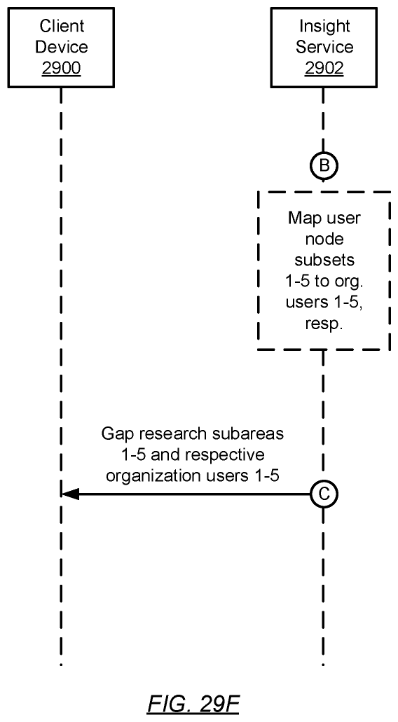

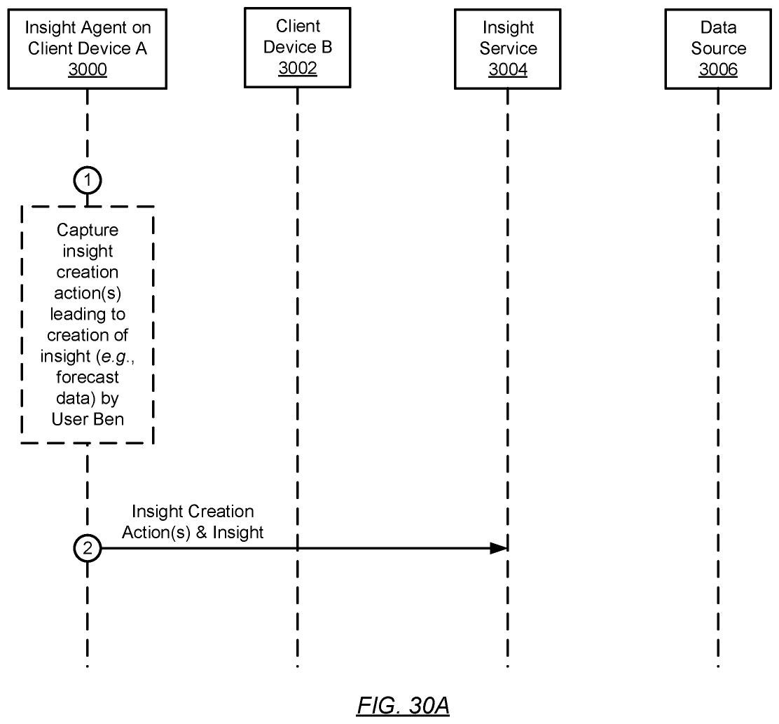

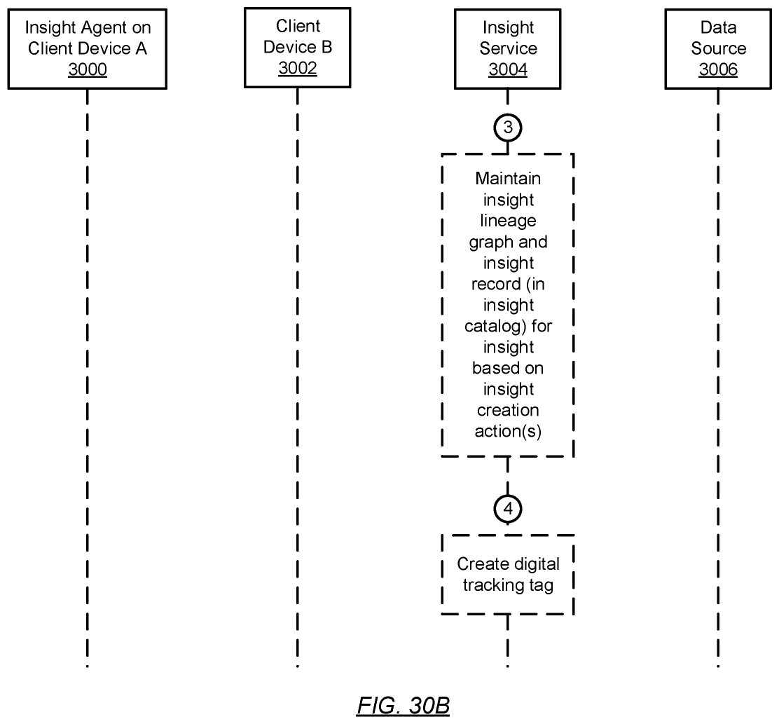

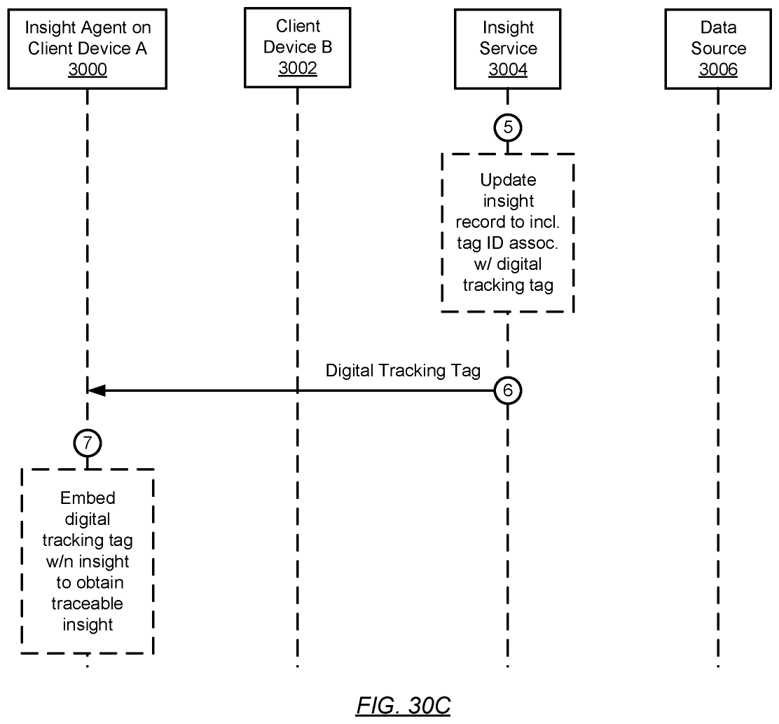

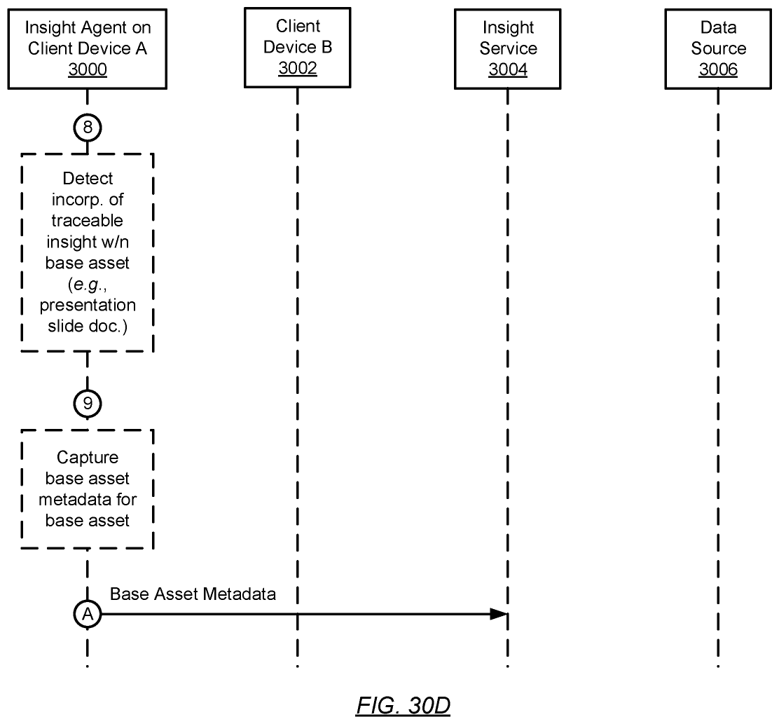

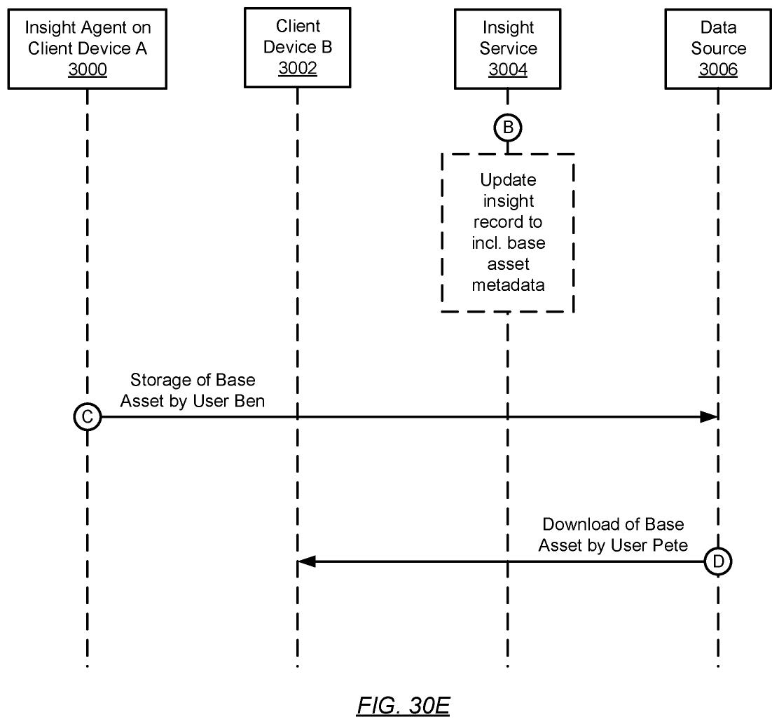

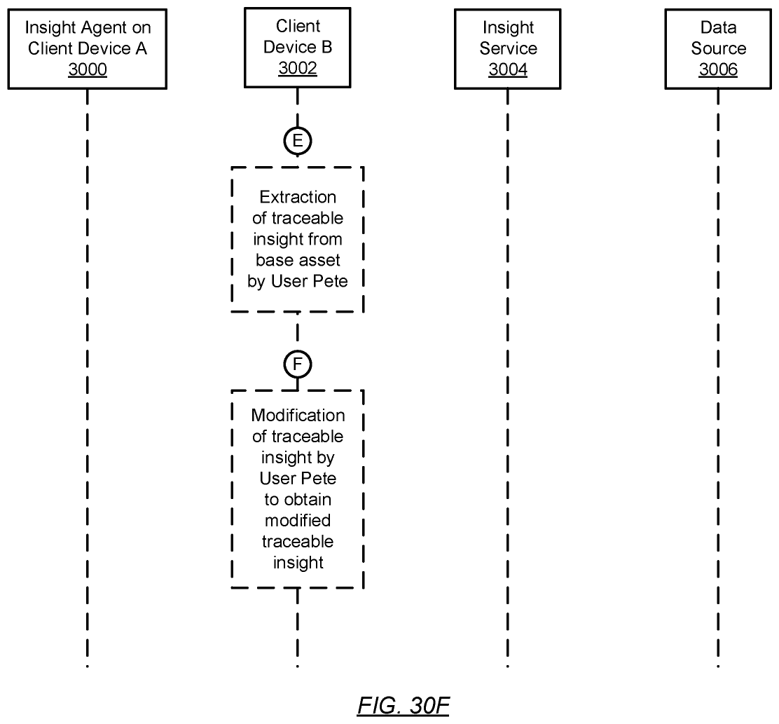

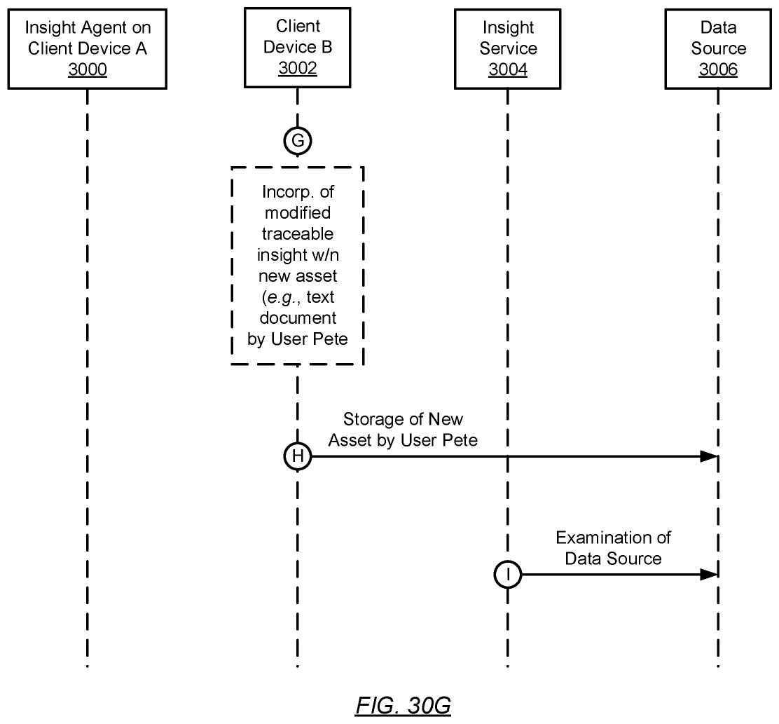

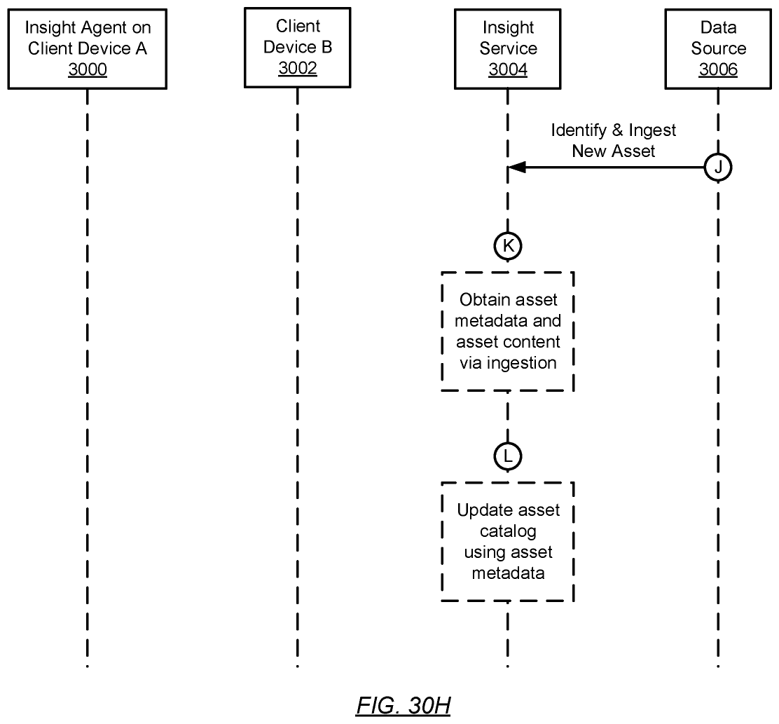

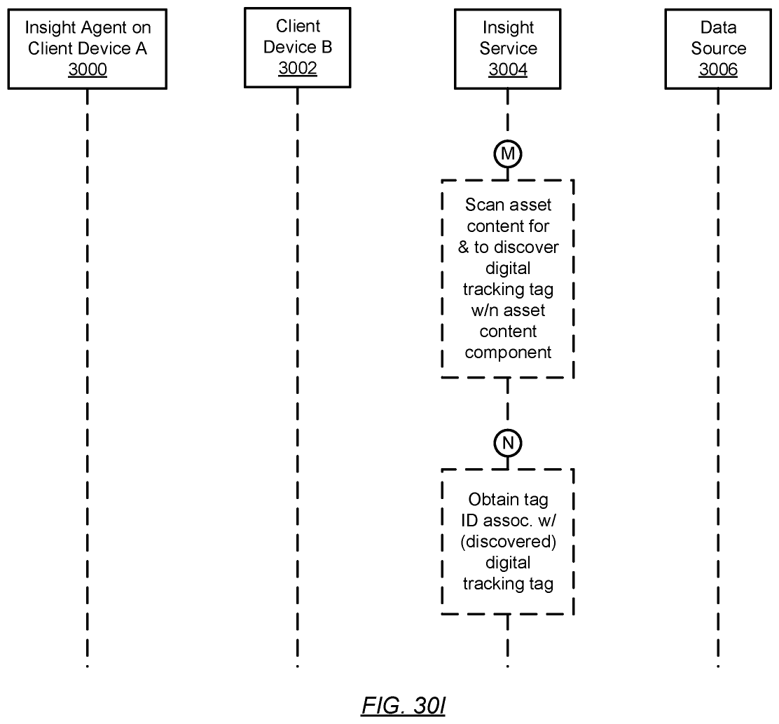

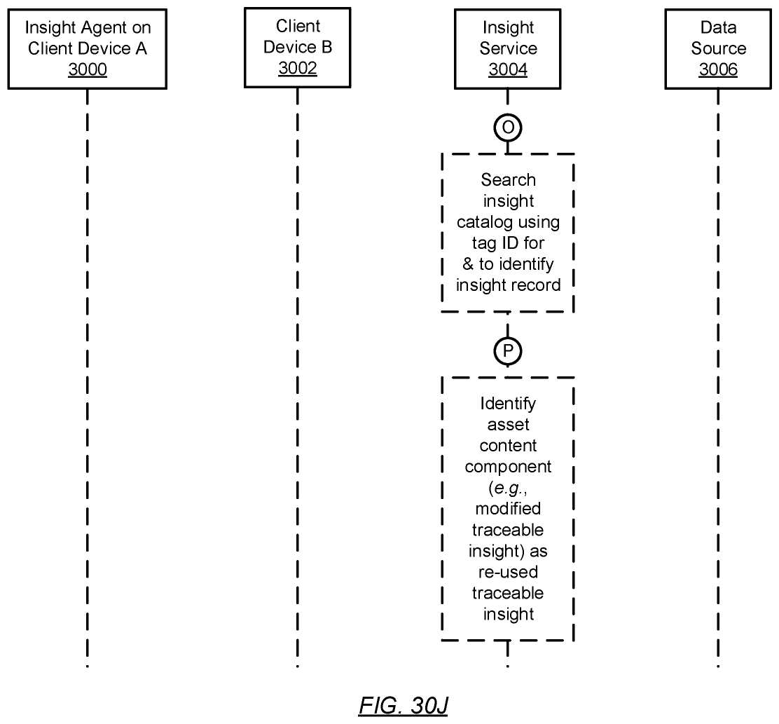

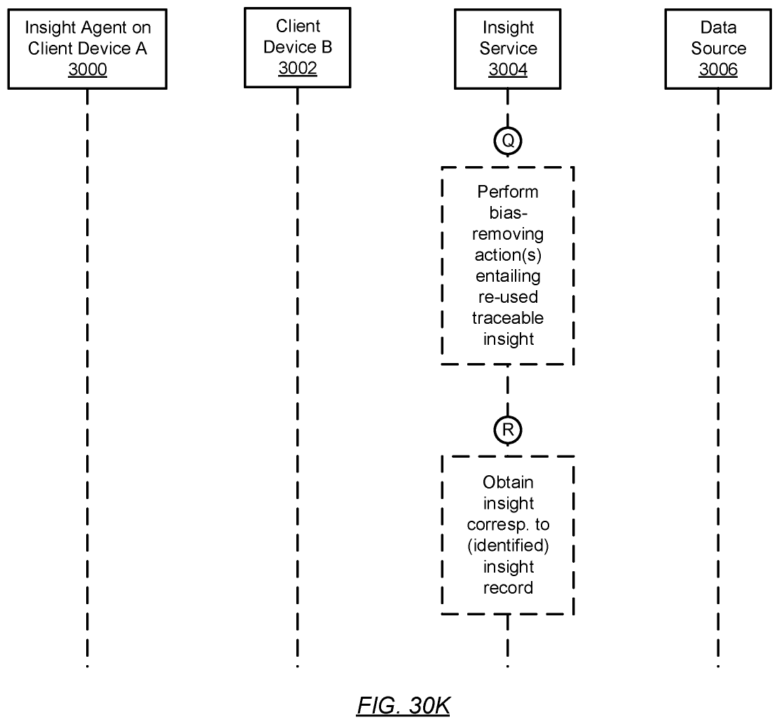

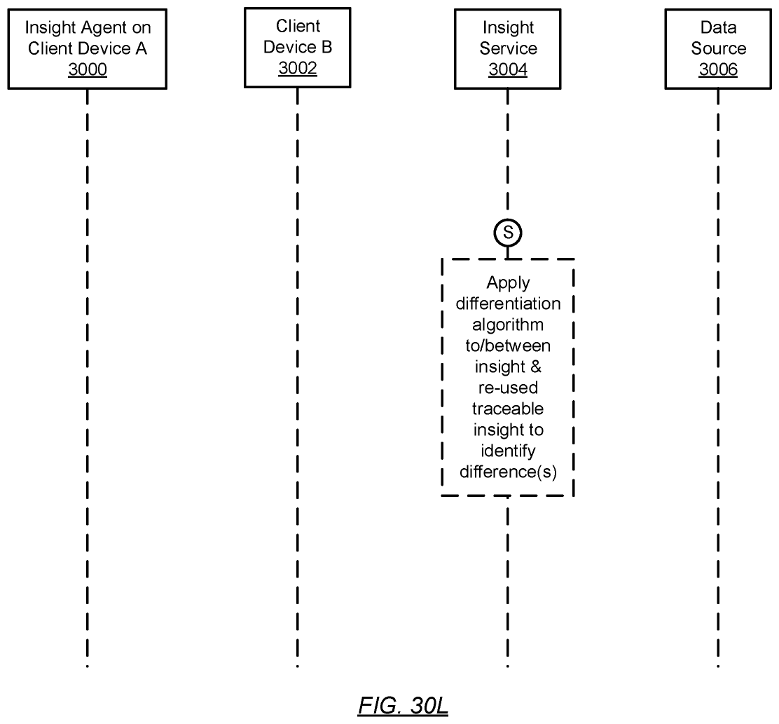

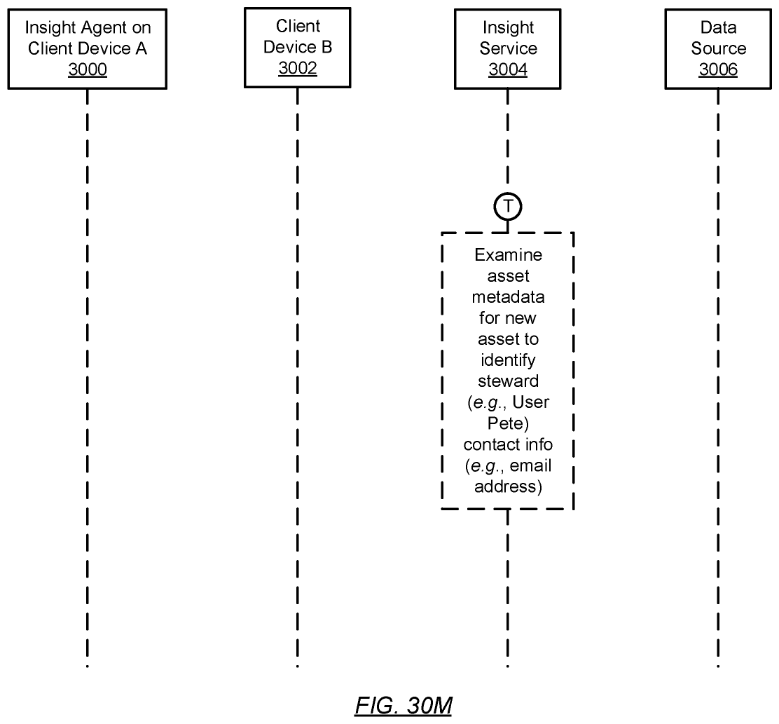

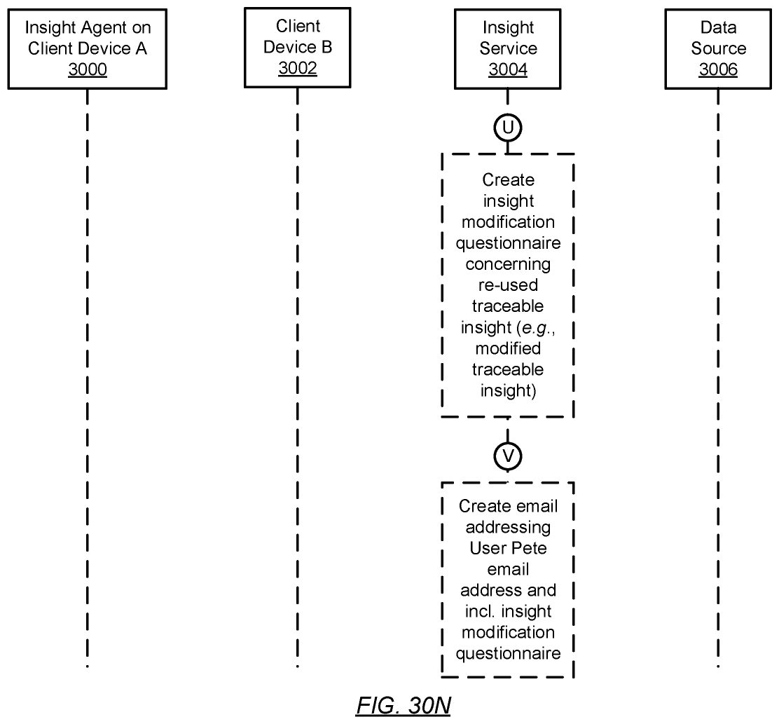

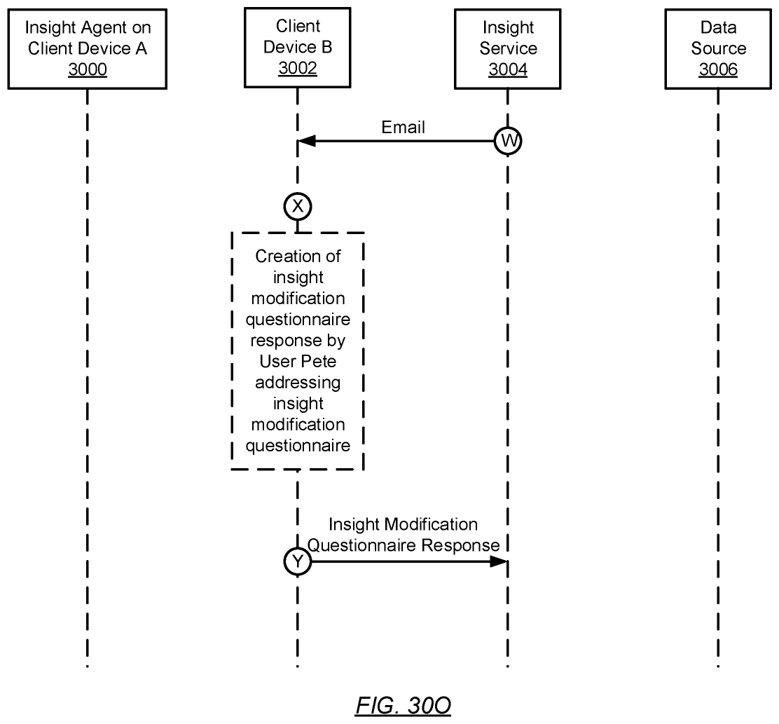

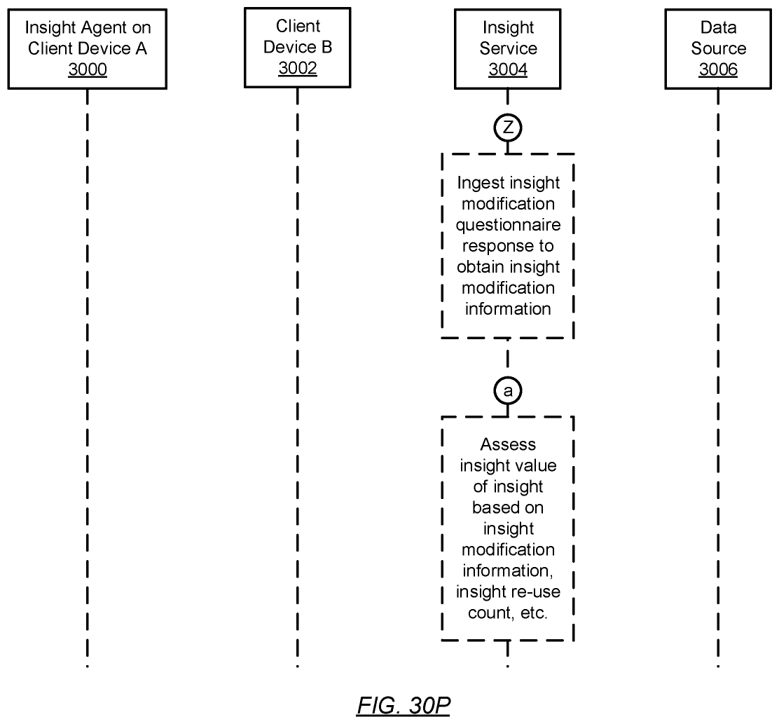

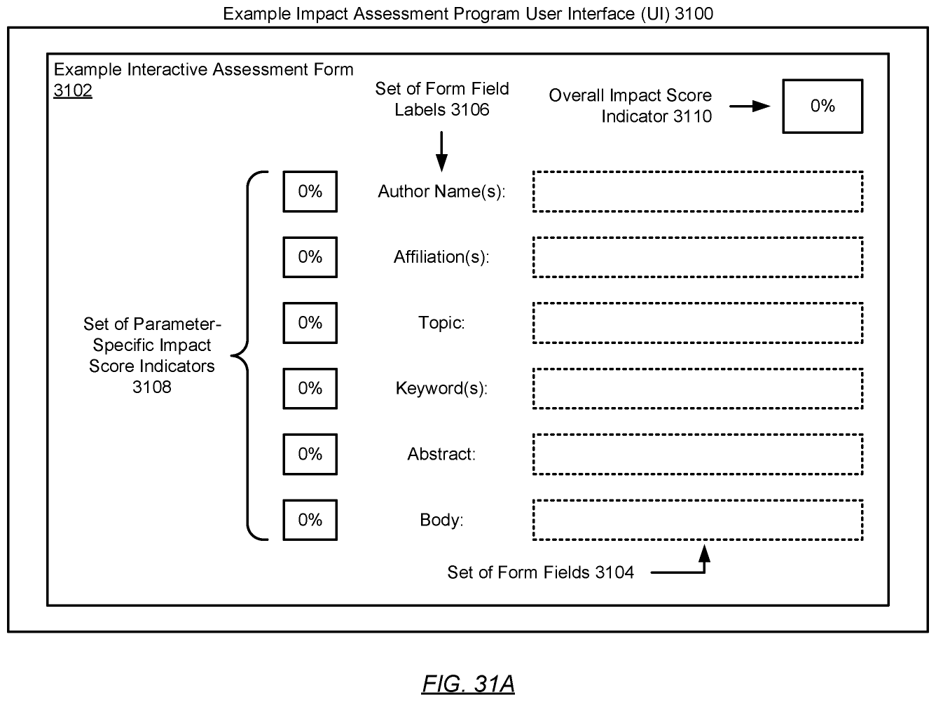

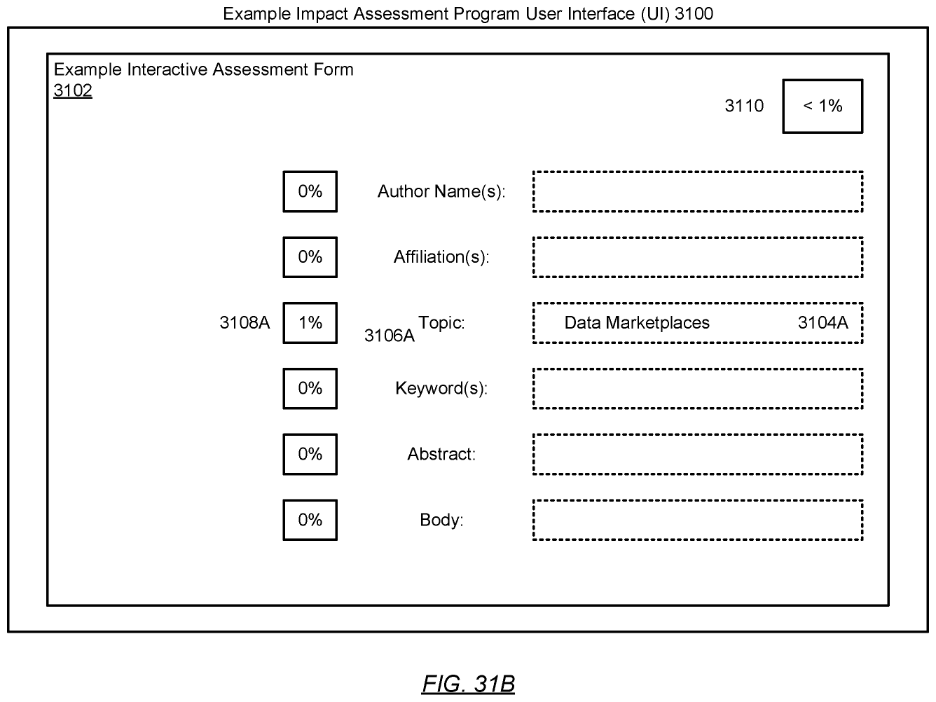

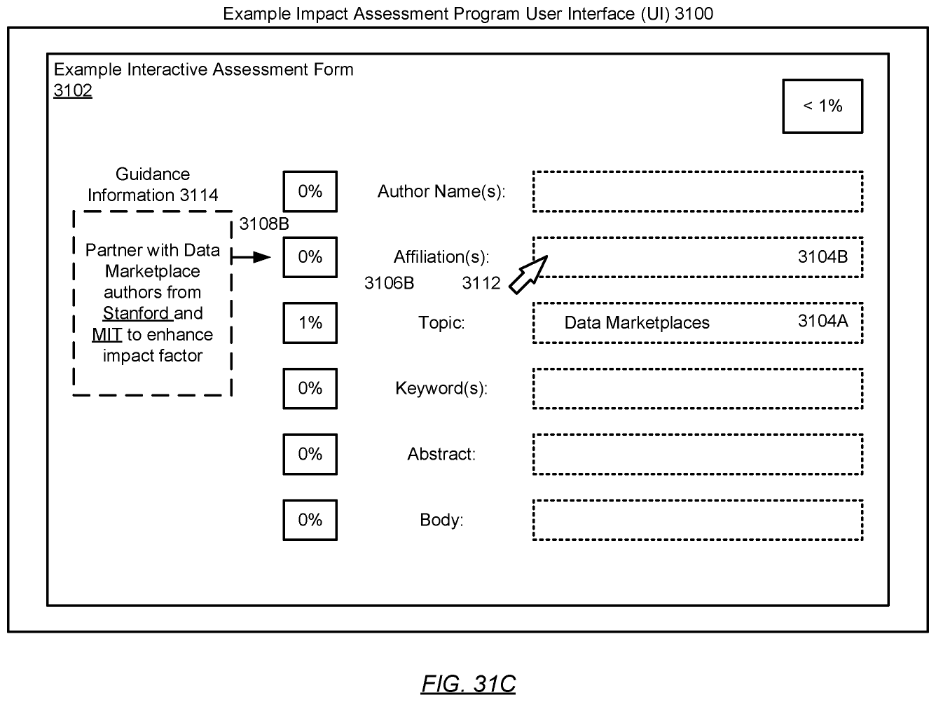

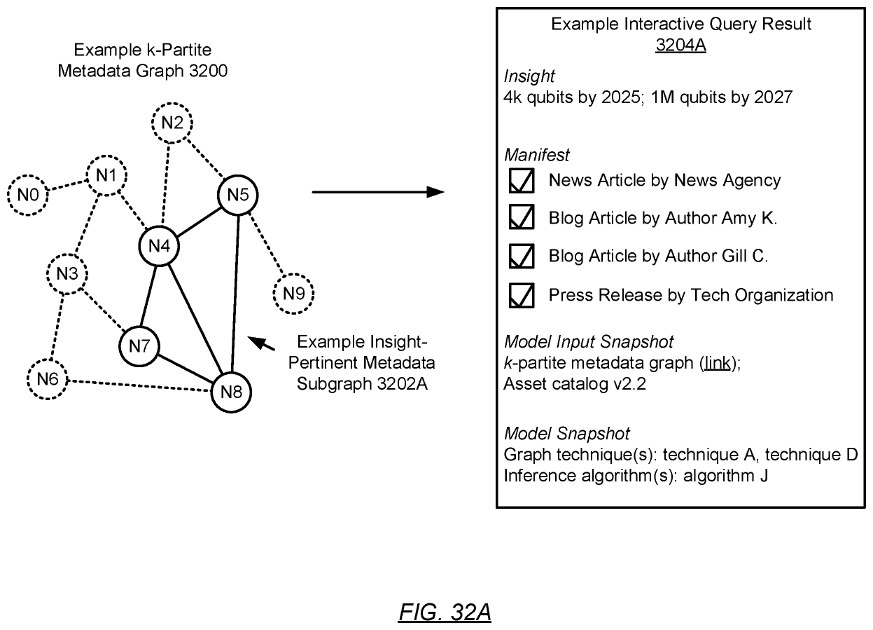

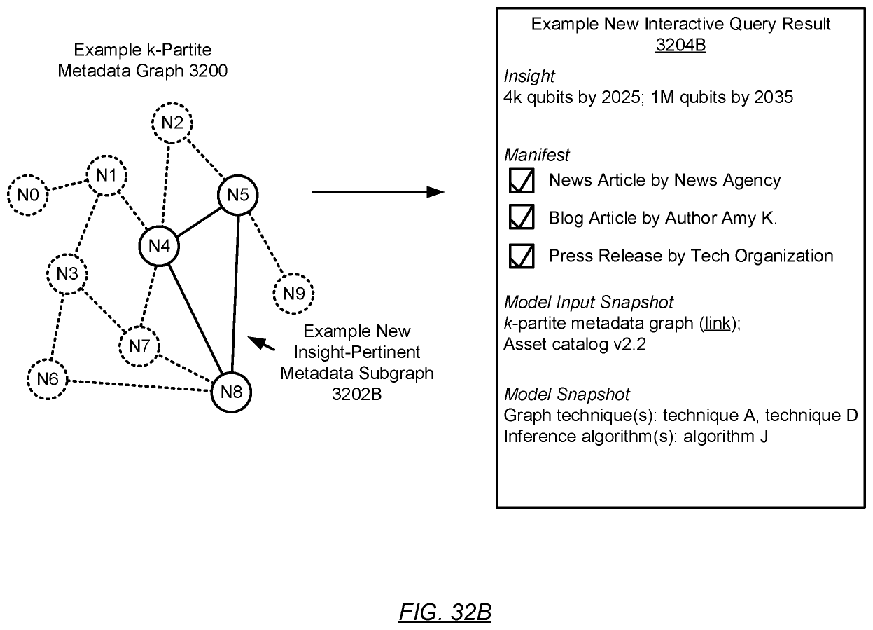

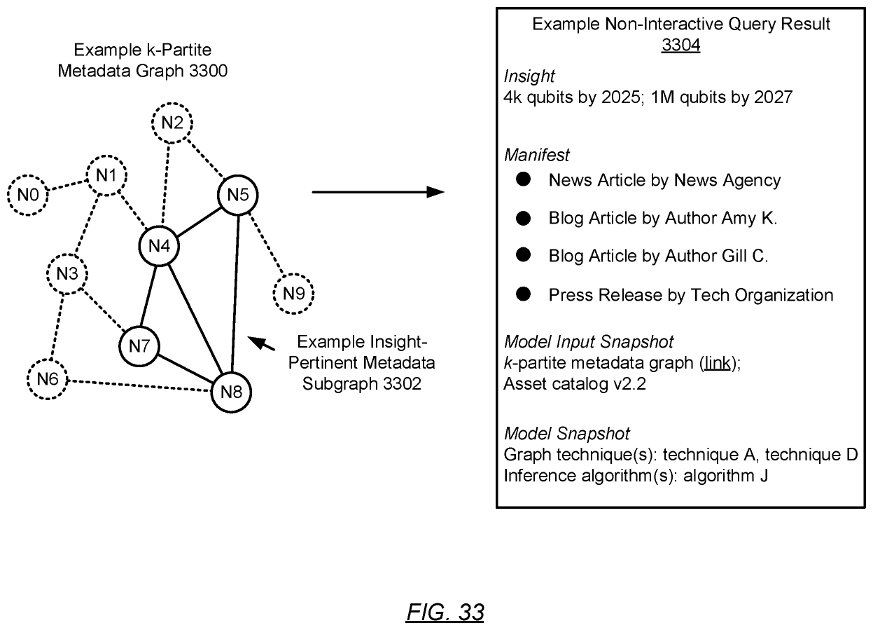

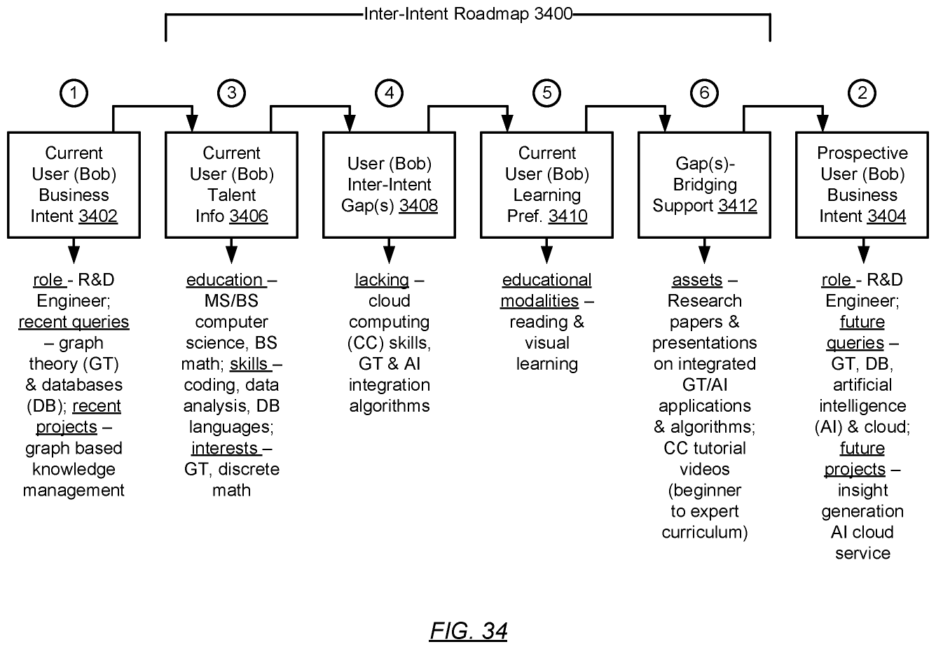

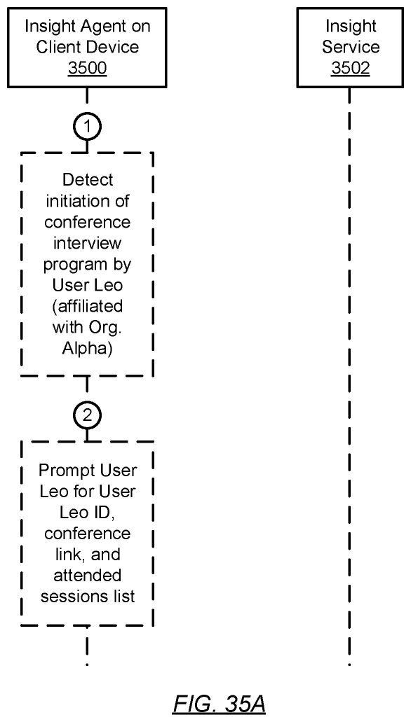

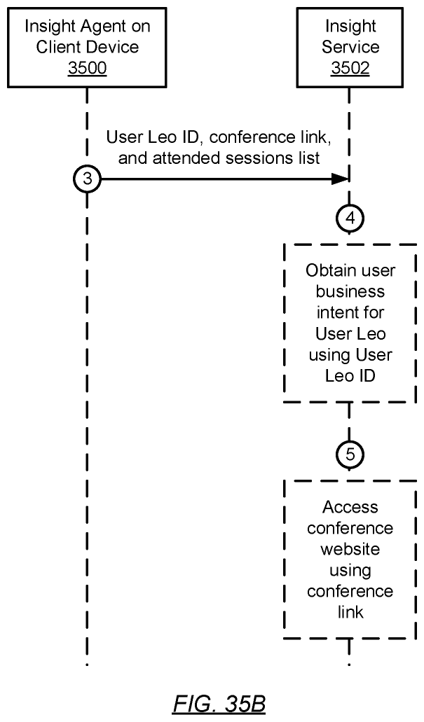

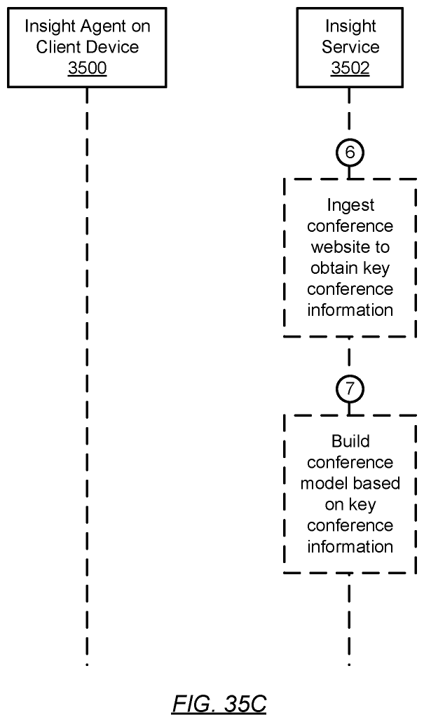

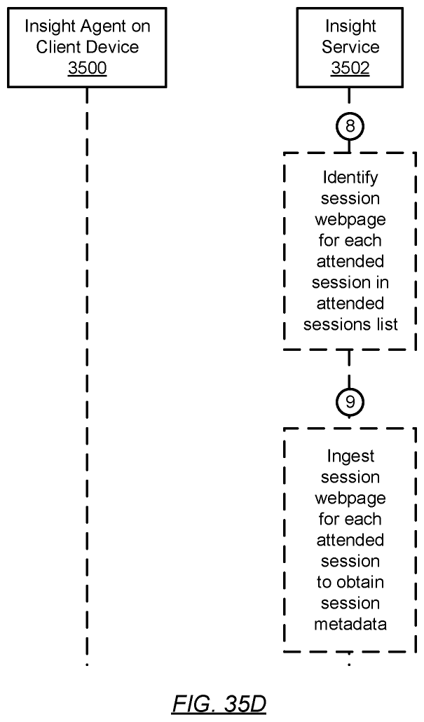

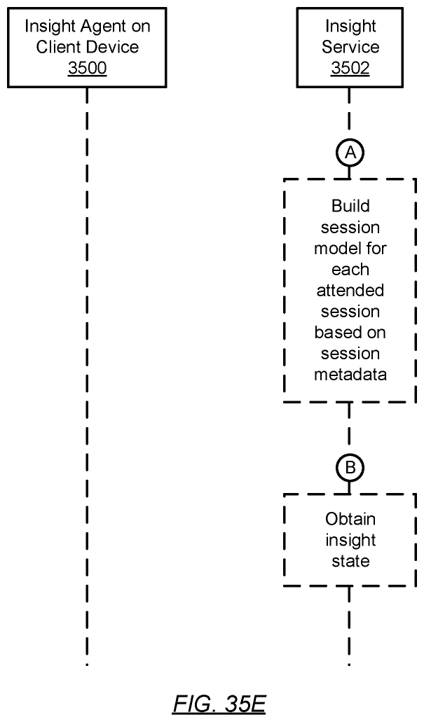

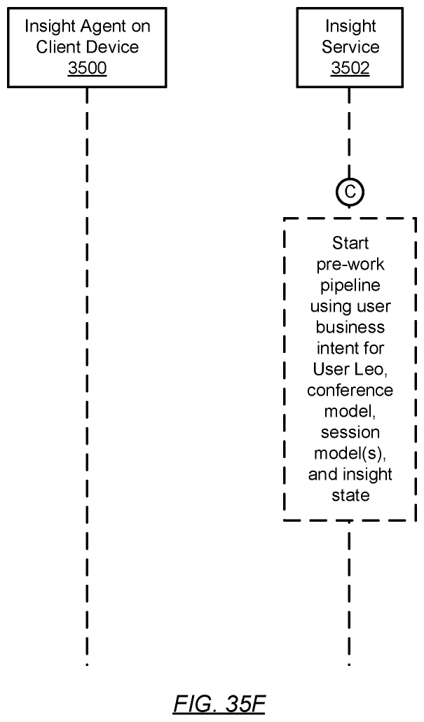

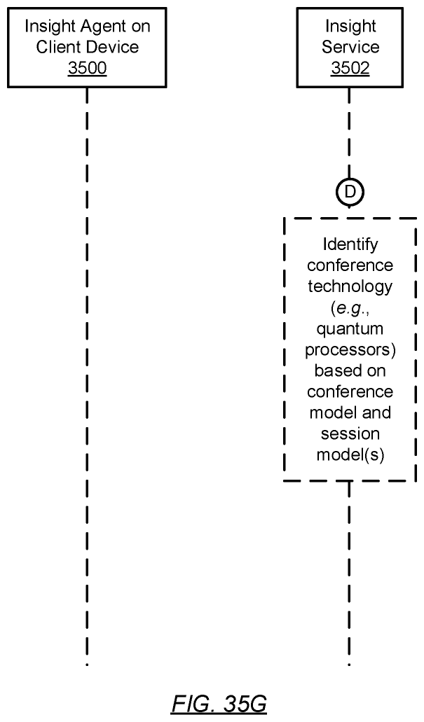

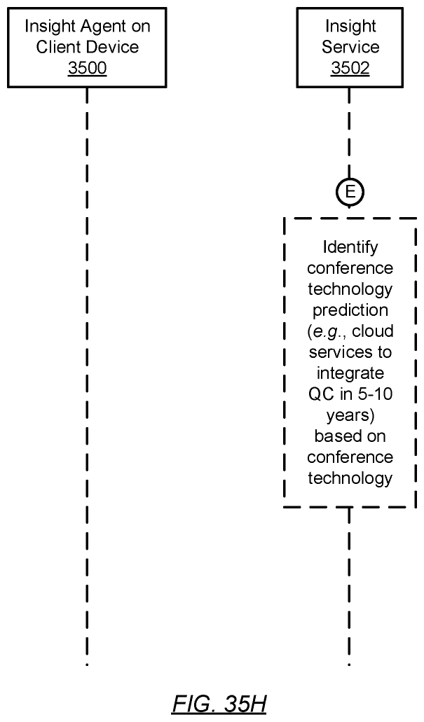

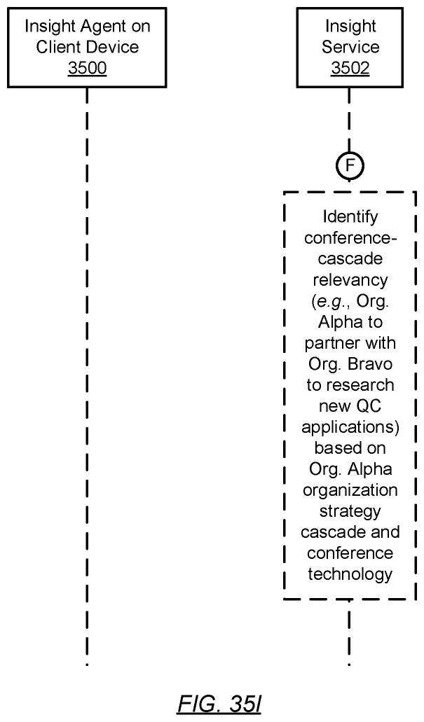

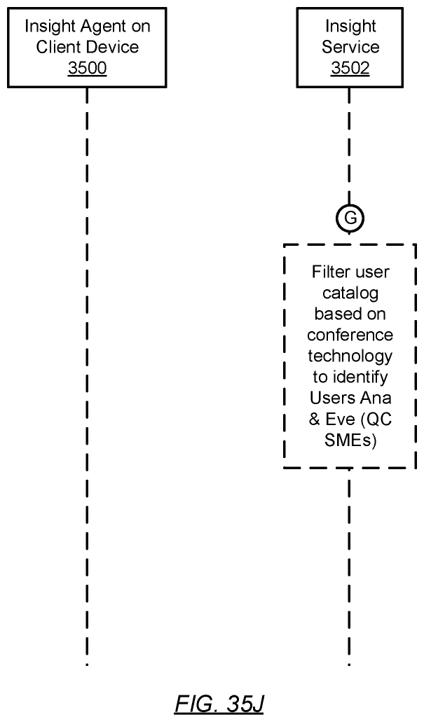

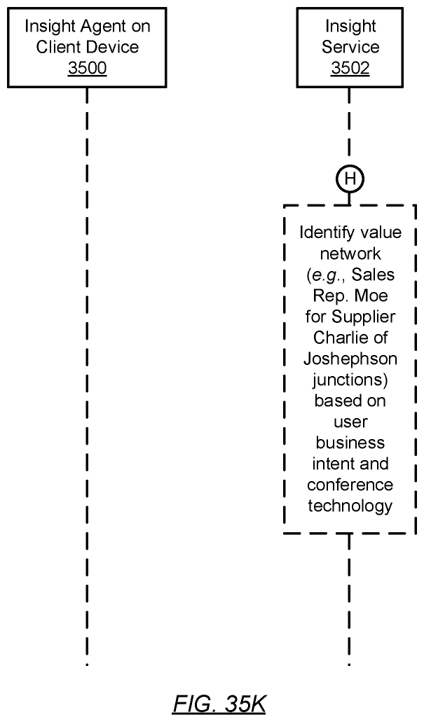

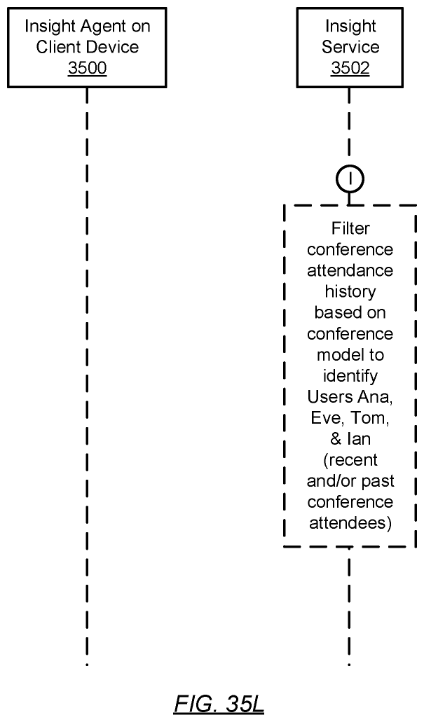

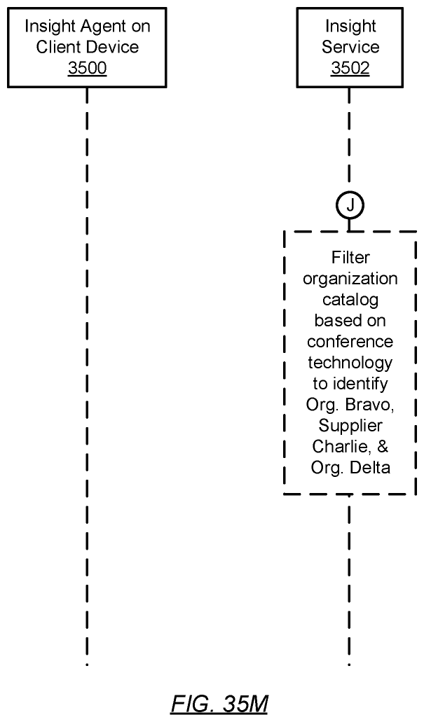

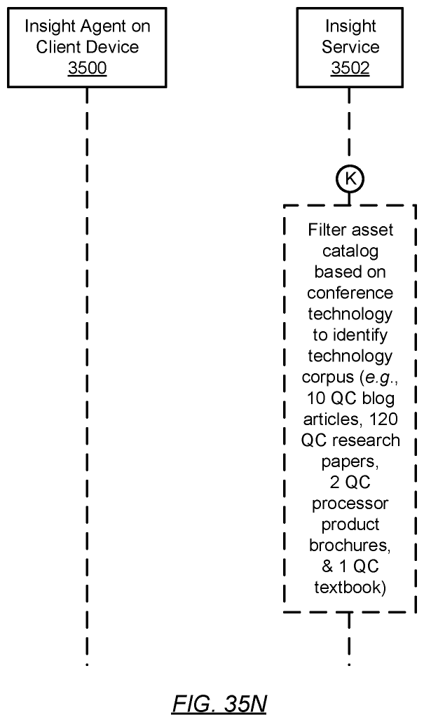

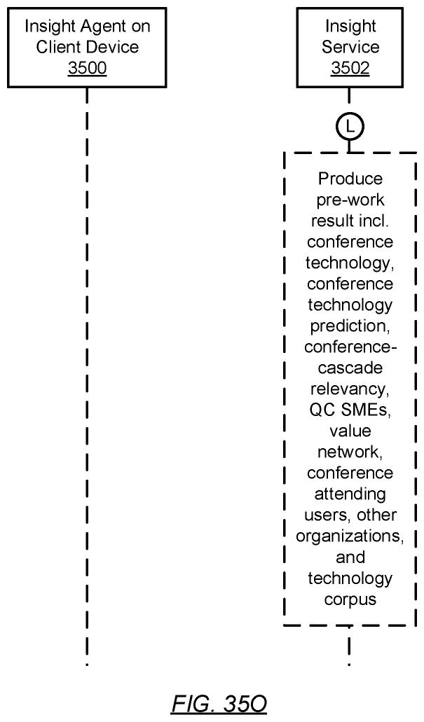

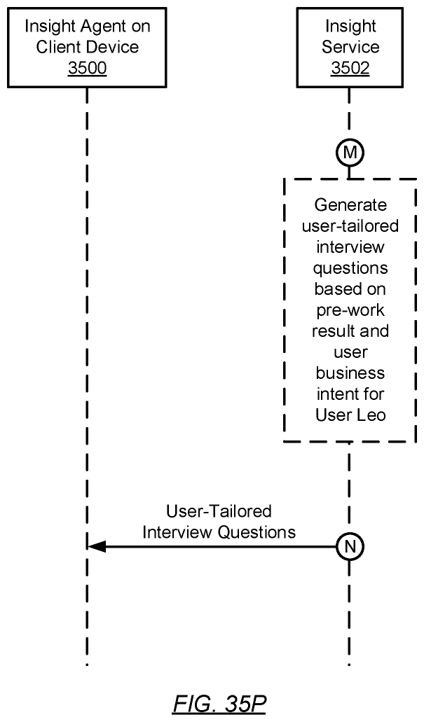

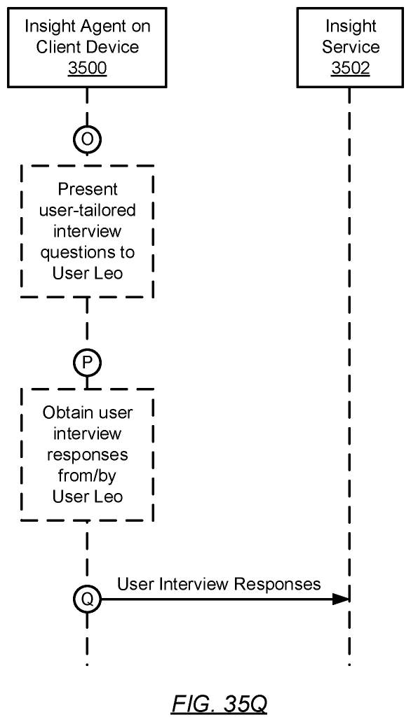

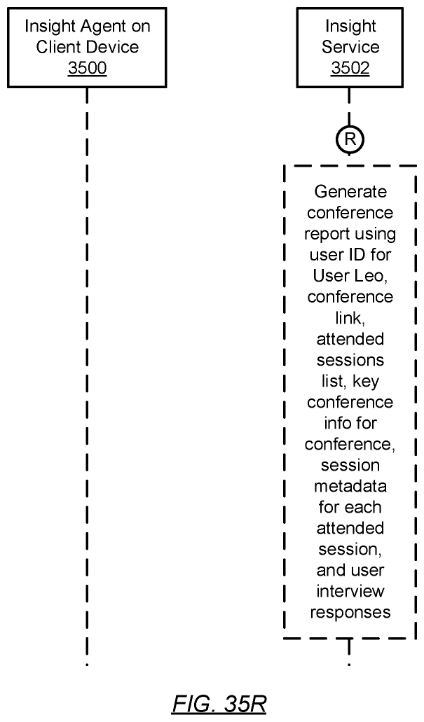

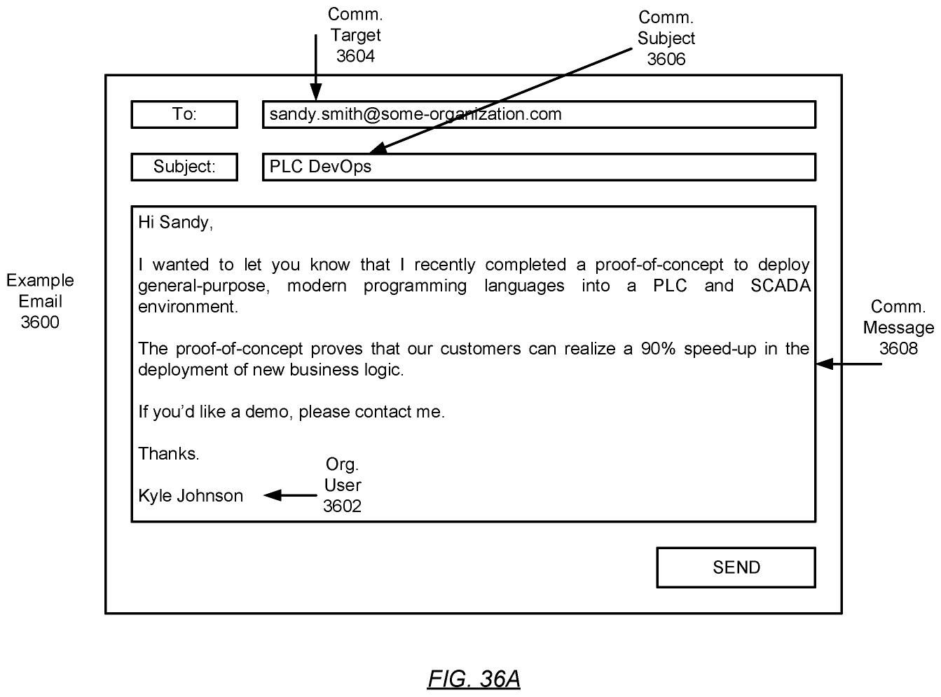

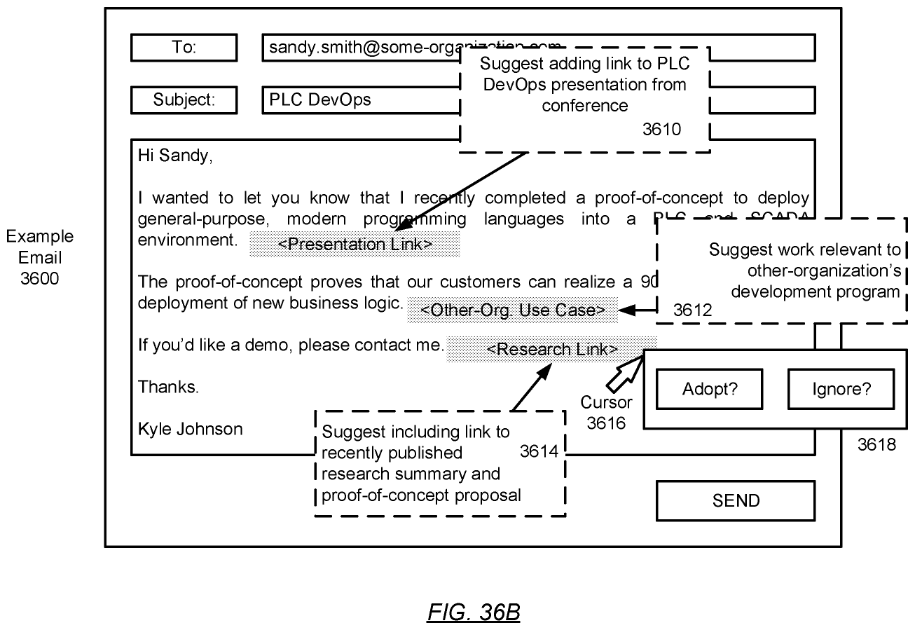

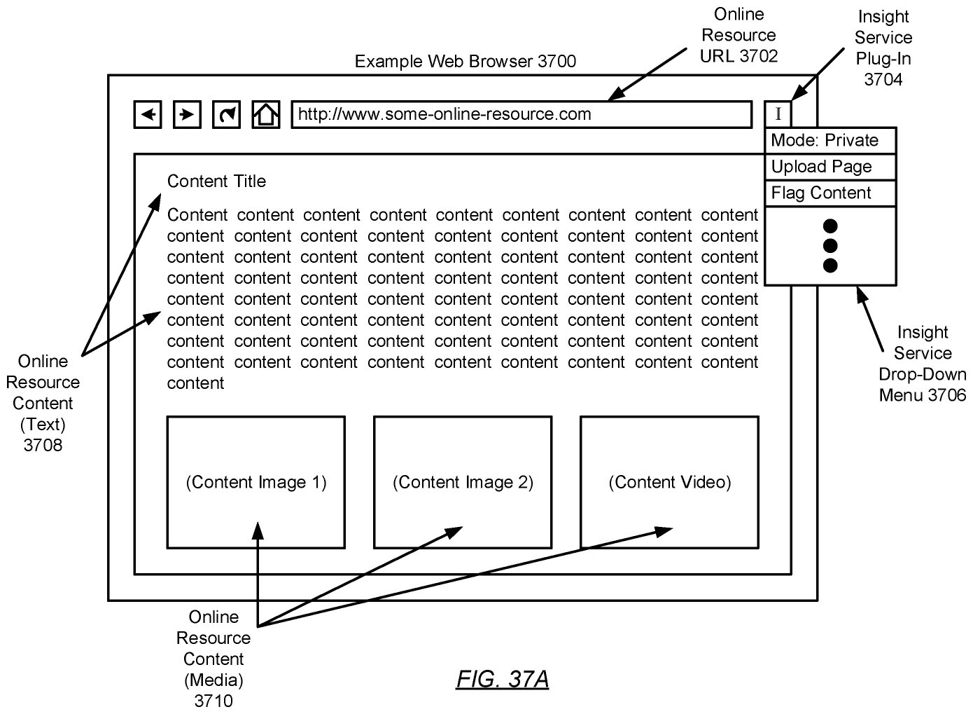

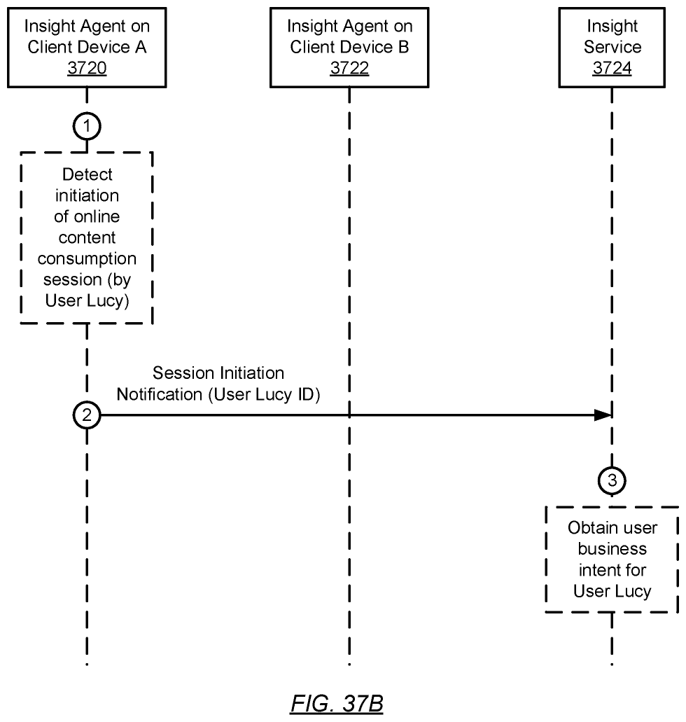

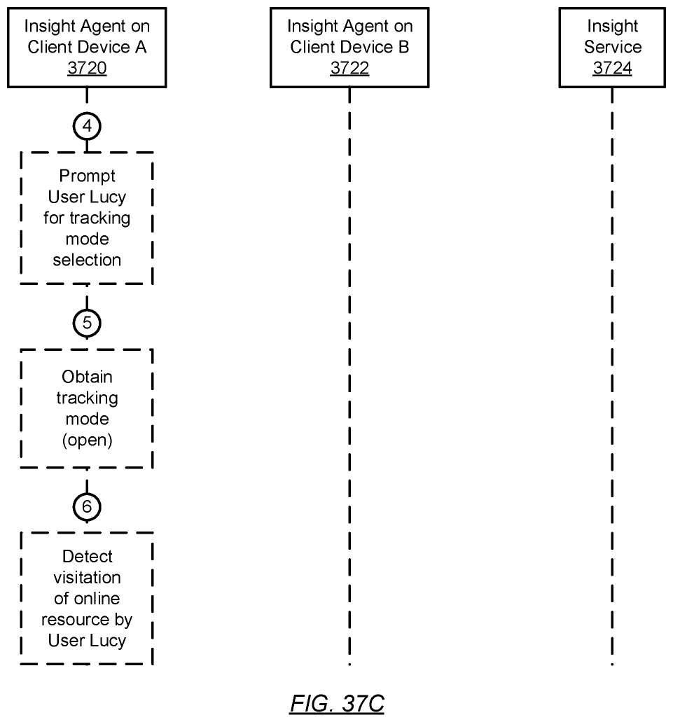

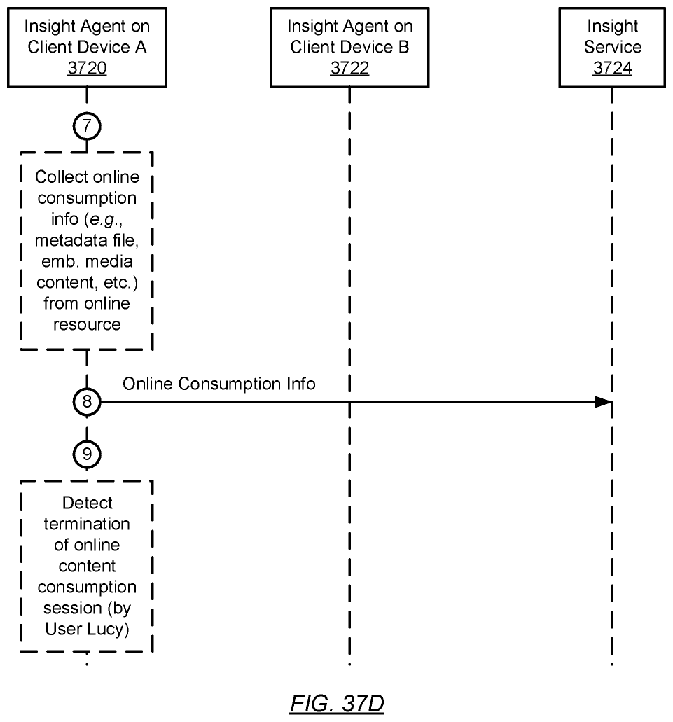

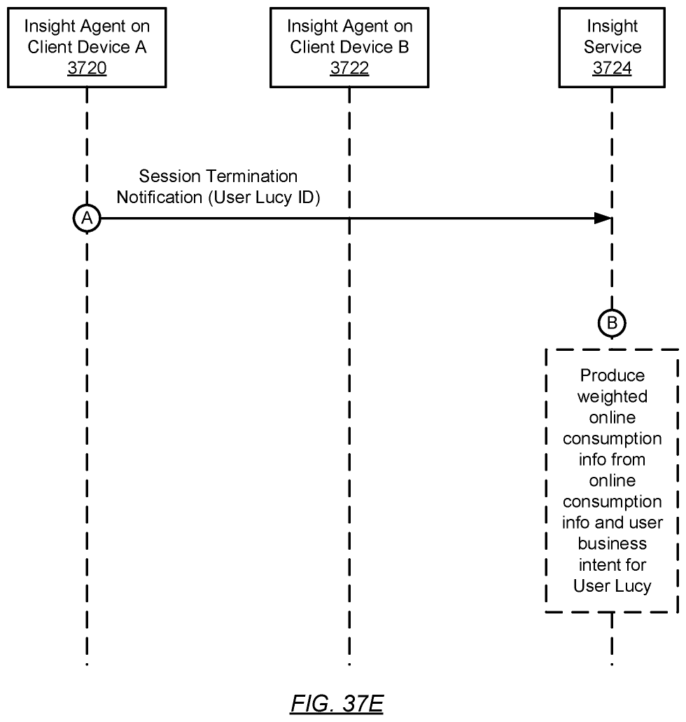

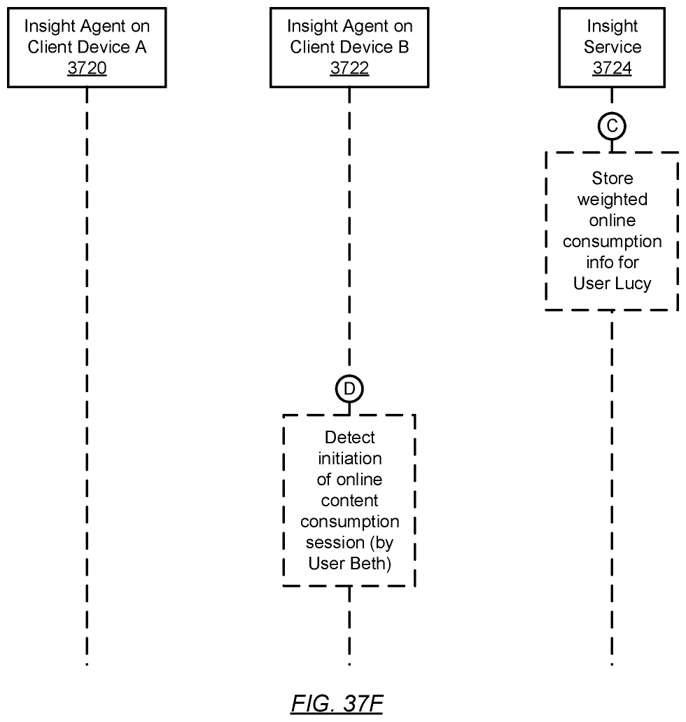

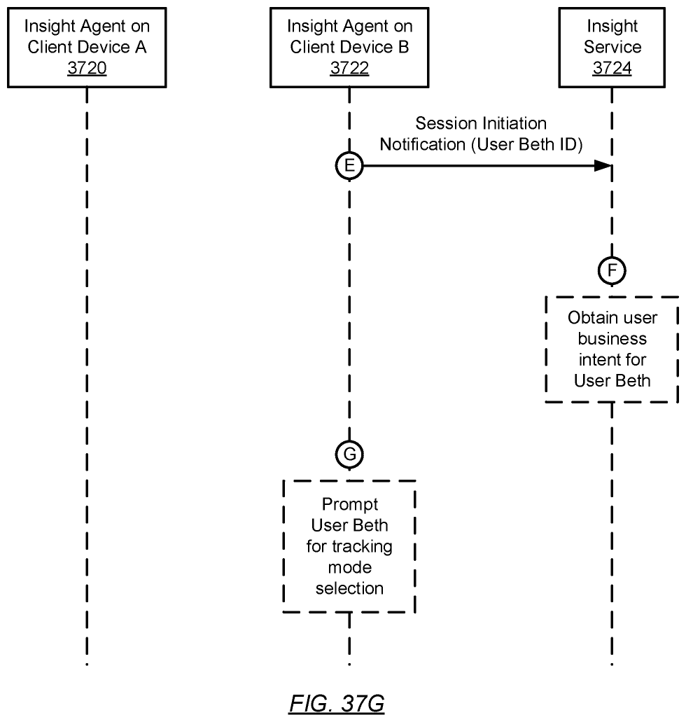

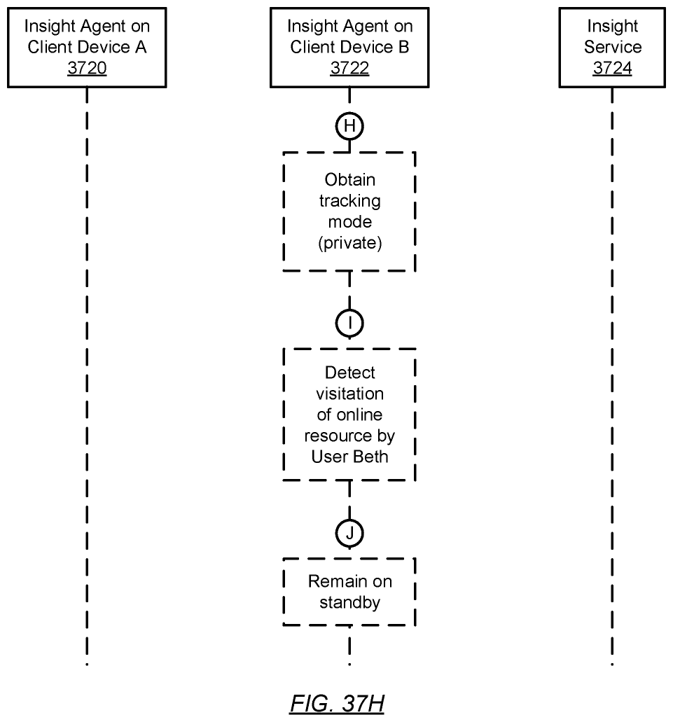

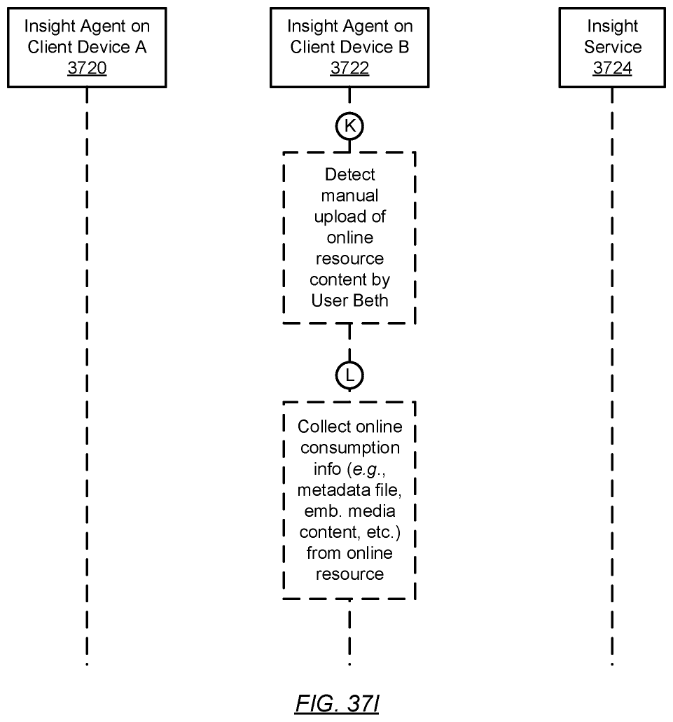

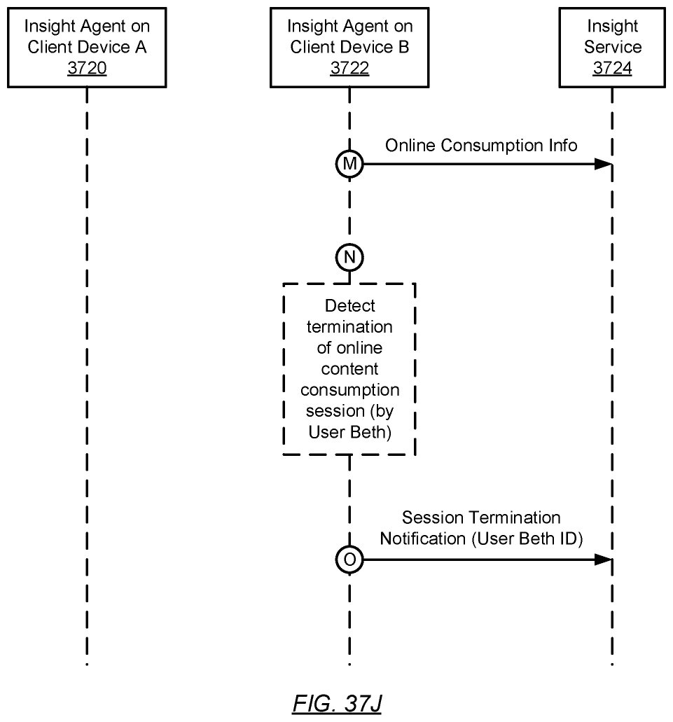

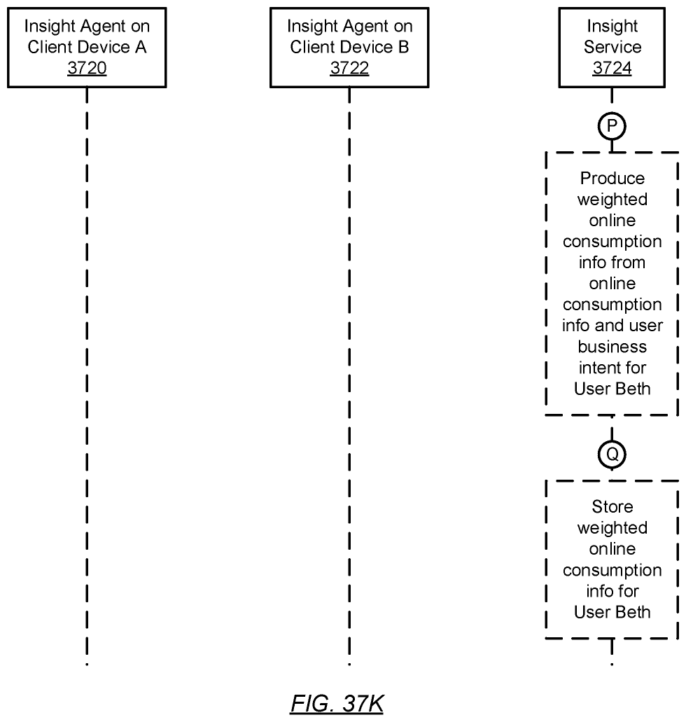

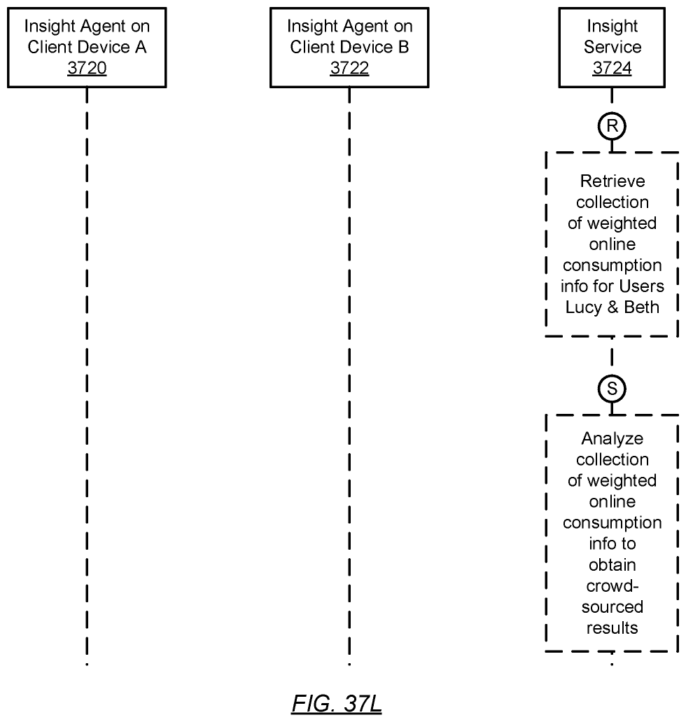

In one or many embodiment(s) disclosed herein, the insight service (106) may be configured with various capabilities or functionalities directed to digitally-assisted organization strategy. Said capabilities/functionalities may include: (a) dynamic data product creation, as described in FIGS. 3A-3D as well as exemplified in FIGS. 21A-21G, below; (b) metadata-based learning curriculum generation, as described in FIGS. 4A and 4B as well as exemplified in FIGS. 22A-22I, below; (c) metadata-based query rewriting, as described in 5A-5C as well as exemplified in FIGS. 23A-23L, below; (d) insight lineage tracking, as described in FIGS. 6A-6C as well as exemplified in FIG. 24, below; (e) metadata-based feature expansion for automated machine learning processes, as described in FIG. 7A-7H as well as exemplified in FIGS. 25A-250, below; (f) business intent-driven adaptive learning delivery, as described in FIG. 8 as well as exemplified in FIG. 26, below; (g) learning acceleration using insight-assisted introductions, as described in FIG. 9 as well as exemplified in FIGS. 27A-27C, below; (h) business intent-assisted search, as described in FIGS. 10A and 10B as well as exemplified in FIGS. 28A-28Q, below; (i) insight gap recommendations, as described in FIG. 11 as well as exemplified in FIGS. 29A-29F, below; insight value assessment using post-insight feedback, as described in FIG. 12 as well as exemplified in FIG. 30, below; (j) impact enhancing recommendations for research papers and initiatives, as described in FIG. 13 as well as exemplified in FIG. 31, below; (k) insight creation filtering, as described in FIGS. 14A-14C as well as exemplified in FIG. 32, below; (l) insight creation transparency, as described in FIGS. 15A and 15B as well as exemplified in FIG. 33, below; (m) prediction of and support readiness for future business intents, as described in FIGS. 16A and 16B as well as exemplified in FIG. 34, below; (n) dynamic questioning intelligence, as described in FIG. 17 as well as exemplified in FIG. 35, below; (o) business intent based communications enhancement, as described in FIGS. 18A and 18B as well as exemplified in FIGS. 36A and 36B, below; and crowd-sourced research relevance tracking and analytics, as described in FIG. 19 as well as exemplified in FIGS. 37A-37L, below. Further, the insight service (106) may perform other capabilities/functionalities without departing from the scope disclosed herein.

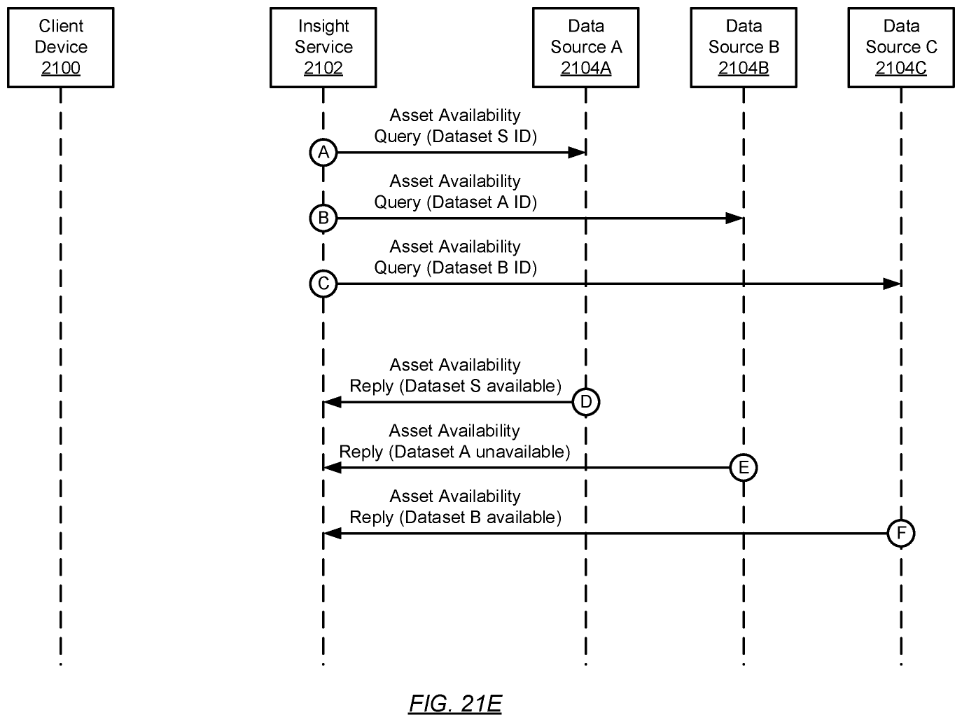

In one or many embodiment(s) disclosed herein, the insight service (106) may be implemented through on-premises infrastructure, cloud computing infrastructure, or any hybrid infrastructure thereof. The insight service (106), accordingly, may be implemented using one or more network servers (not shown), where each network server may represent a physical or a virtual network server. Additionally, or alternatively, the insight service (106) may be implemented using one or more computing systems each similar to the example computing system shown and described with respect to FIG. 20, below.

In one or many embodiment(s) disclosed herein, a client device (108) may represent any physical appliance or computing system operated by one or more organization users and configured to receive, generate, process, store, and/or transmit data/information (e.g., assets), as well as to provide an environment in which one or more computer programs (e.g., applications, insight agents, etc.) may execute thereon. An organization user, briefly, may refer to any individual whom is affiliated with, and fulfills one or more roles pertaining to, the organization that serves as the proprietor of the organization-internal environment (102). Further, in providing an execution environment for any computer programs, a client device (108) may include and allocate various resources (e.g., computer processors, memory, storage, virtualization, network bandwidth, etc.), as needed, to the computer programs and the tasks (or processes) instantiated thereby. Examples of a client device (108) may include, but are not limited to, a desktop computer, a laptop computer, a tablet computer, a smartphone, or any other computing system similar to the example computing system shown and described with respect to FIG. 20, below. Moreover, any client device (108) is described in further detail through FIG. 1B, below.

In one or many embodiment(s) disclosed herein, the organization-external environment (110) may represent any number of digital (e.g., IT) ecosystems not belonging to, and thus not managed by, an/the organization serving as the proprietor of the organization-internal environment (102). The organization-external environment (110), accordingly, may at least reference any public networks including any respective service(s) and data/information (e.g., assets). Further, the organization-external environment (110) may include one or more external data sources (112) and one or more third-party services (114). Each of these organization-external environment (110) subcomponents may or may not be co-located, and thus reside and/or operate, in the same physical or geographical space. Moreover, each of these organization-external environment (110) subcomponents is described below.

In one or many embodiment(s) disclosed herein, an external data source (112) may represent any data source (described above) not belonging to, and thus not managed by, an/the organization serving as the proprietor of the organization-internal environment (102). Any external data source (112), more specially, may refer to a location that stores at least a portion of the asset(s) found across any public networks. Further, depending on their respective access permissions, entities within the organization-internal environment (102), as well as those throughout the organization-external environment (110), may or may not be permitted to access any external data source (104) and, therefore, may or may not be permitted to access any asset(s) maintained therein.

Moreover, in one or many embodiment(s) disclosed herein, any external data source (112) may be implemented as physical storage (and/or as logical/virtual storage spanning at least a portion of the physical storage). The physical storage may, at least in part, include persistent storage, where examples of persistent storage may include, but are not limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM).

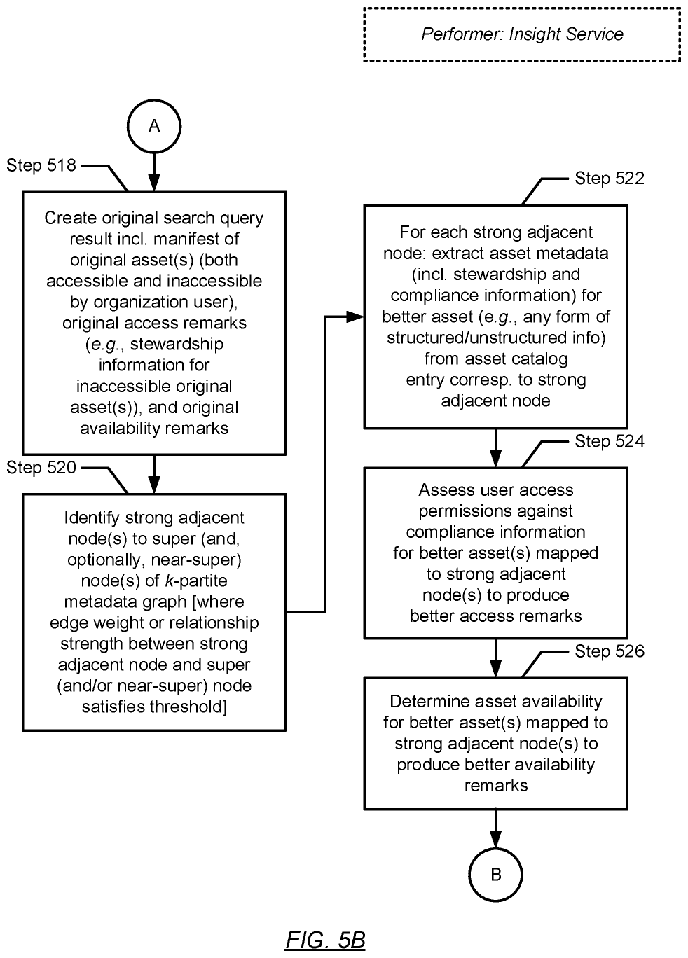

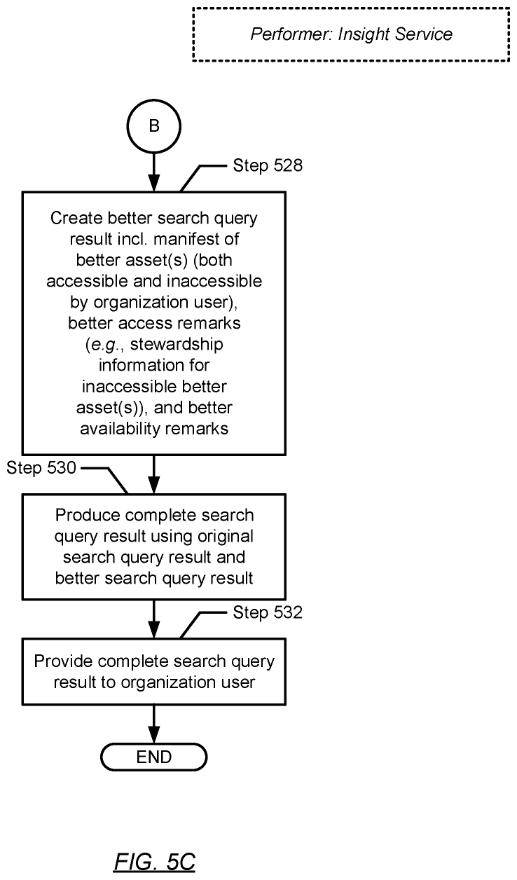

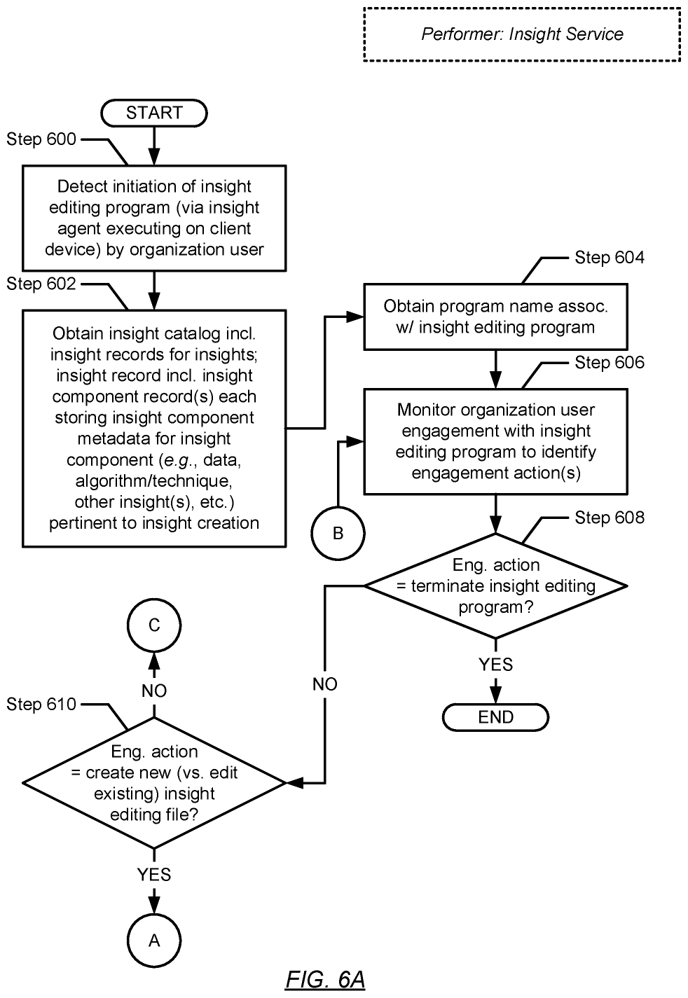

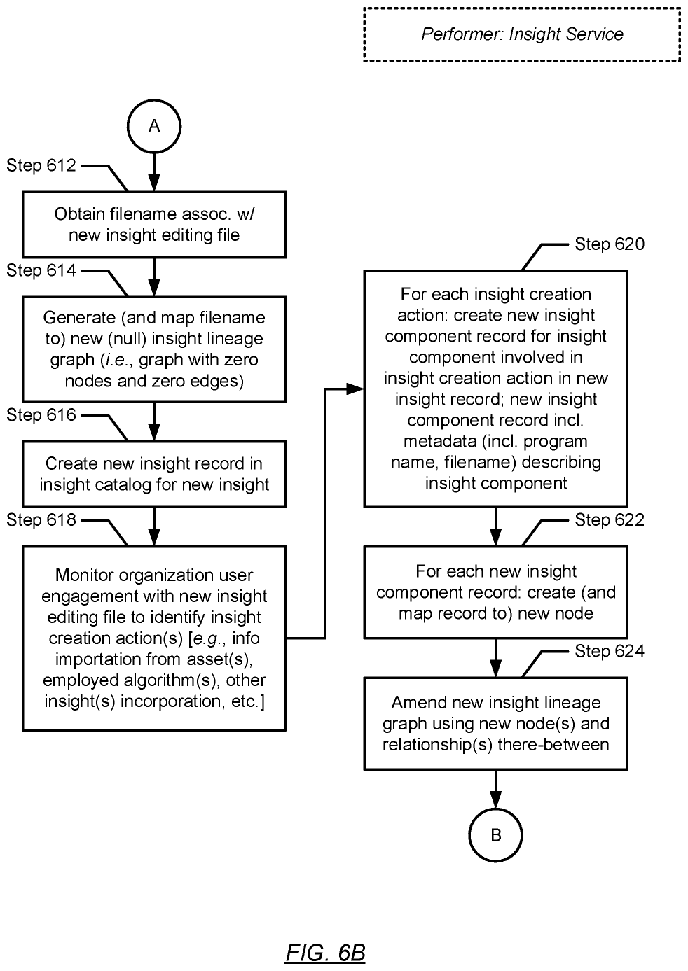

In one or many embodiment(s) disclosed herein, a third party service (114) may represent information technology infrastructure configured for any number of purposes and/or applications. A third party, whom may implement and manage one or more third party services (114), may refer to an individual, a group of individuals, or another organization (i.e., not the organization serving as the proprietor of the organization-internal environment (102)) that serves as the proprietor of said third party service(s) (114). By way of an example, one such third party service (114), as disclosed herein (see e.g., FIGS. 5A-5C and 23A-23L) may be exemplified by an automated machine learning (ML) service. A purpose of the automated ML service may be directed to automating the selection, composition, and parameterization of ML models. That is, more simply, the automated ML service may be configured to automatically identify one or more optimal ML algorithms from which one or more ML models may be constructed and fit to a submitted dataset in order to best achieve any given set of tasks. Further, any third party service (114) is not limited to the aforementioned specific example.

In one or many embodiment(s) disclosed herein, any third party service (114) may be implemented through on-premises infrastructure, cloud computing infrastructure, or any hybrid infrastructure thereof. Any third party service (114), accordingly, may be implemented using one or more network servers (not shown), where each network server may represent a physical or a virtual network server. Additionally, or alternatively, any third party service (114) may be implemented using one or more computing systems each similar to the example computing system shown and described with respect to FIG. 20, below.

In one or many embodiment(s) disclosed herein, the above-mentioned system (100) components, and their respective subcomponents, may communicate with one another through a network (not shown) (e.g., a local area network (LAN), a wide area network (WAN) such as the Internet, a mobile network, any other communication network type, or a combination thereof). The network may be implemented using any combination of wired and/or wireless connections. Further, the network may encompass various interconnected, network-enabled subcomponents (or systems) (e.g., switches, routers, gateways, etc.) that may facilitate communications between the above-mentioned system (100) components and their respective subcomponents. Moreover, in communicating with one another, the above-mentioned system (100) components, and their respective subcomponents, may employ any combination of existing wired and/or wireless communication protocols.

While FIG. 1A shows a configuration of components and/or subcomponents, other system (100) configurations may be used without departing from the scope disclosed herein.

FIG. 1B shows a client device in accordance with one or more embodiments disclosed herein. The client device (108) (described above as well) (see e.g., FIG. 1A) may host or include one or more applications (116A-116N). Each application (116A-116N), in turn, may host or include an insight agent (118A-118N). Each of these client device (108) subcomponents is described below.

In one or many embodiment(s) disclosed herein, an application (116A-116N) (also referred to herein as a software application or program) may represent a computer program, or a collection of computer instructions, configured to perform one or more specific functions. Broadly, examples of said specific function(s) may include, but are not limited to, receiving, generating and/or modifying, processing and/or analyzing, storing or deleting, and transmitting data/information (e.g., assets) (or at least portions thereof). That is, said specific function(s) may generally entail one or more interactions with data/information either maintained locally on the client device (108) or remotely across one or more data sources. Examples of an application (116A-116N) may include a word processor, a spreadsheet editor, a presentation editor, a database manager, a graphics renderer, a video editor, an audio editor, a web browser, a collaboration tool or platform, and an electronic mail (or email) client. Any application (116A-116N), further, is not limited to the aforementioned specific examples.

In one or many embodiment(s) disclosed herein, any application (116A-116N) may be employed by one or more organization users, which may be operating the client device (108), to achieve one or more tasks, at least in part, contingent on the specific function(s) that the application (116A-116N) may be configured to perform. Said task(s) may or may not be directed to supporting and/or achieving any short-term and/or long-term goal(s) outlined by an/the organization with which the organization user(s) may be affiliated.

In one or many embodiment(s) disclosed herein, an insight agent (118A-118N) may represent a computer program, or a collection of computer instructions, configured to perform any number of tasks in support, or as extensions, of the capabilities or functionalities of the insight service (106) (described above) (see e.g., FIG. 1A). With respect to their assigned application (116A-116N), examples of said tasks, which may be carried out by a given insight agent (118A-118N), may include: detecting an initiation of their assigned application (116A-116N) by the organization user(s) operating the client device (108); monitoring any engagement (or interaction), by the organization user(s), with their assigned application (116A-116N) following the detected initiation thereof; identifying certain engagement/interaction actions, performed by the organization user(s), based on said engagement/interaction monitoring; executing any number of procedures or algorithms, relevant to one or more insight service (106) capabilities/functionalities, in response to one or more of the identified certain engagement/interaction actions; providing periodic and/or on-demand telemetry to the insight service (106), where said telemetry may include, for example, data/information requiring processing or analysis to be performed on/by the insight service (106); and receive periodic and/or on-demand updates (and/or instructions) from the insight service (106). Further, the tasks carried out by any insight agent (118A-118N) are not limited to the aforementioned specific examples.

While FIG. 1B shows a configuration of components and/or subcomponents, other client device (108) configurations may be used without departing from the scope disclosed herein. For example, in one or many embodiment(s) disclosed herein, not all of the application(s) (116A-116N), executing on the client device (108), may host or include an insight agent (118A-118N). That is, in said embodiment(s), an insight agent (118A-118N) may not be assigned to or associated with any of at least a subset of the application(s) (116A-116N) installed on the client device (108).

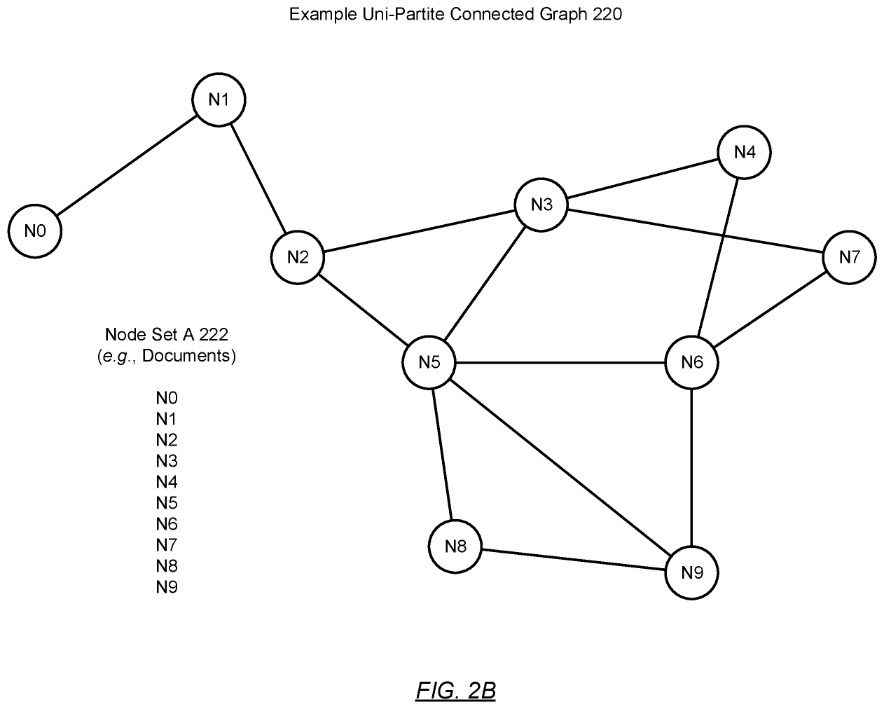

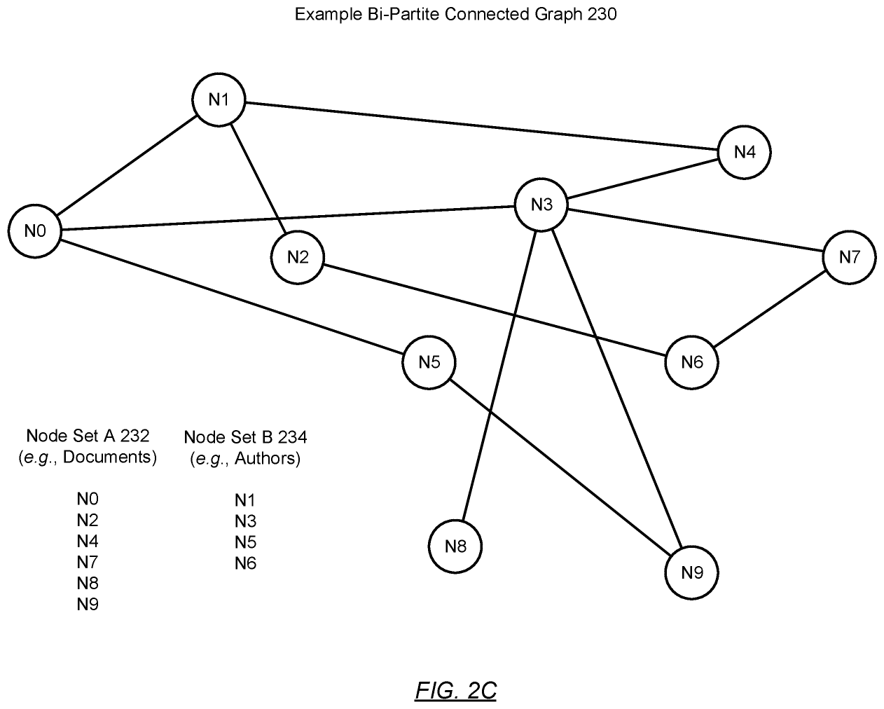

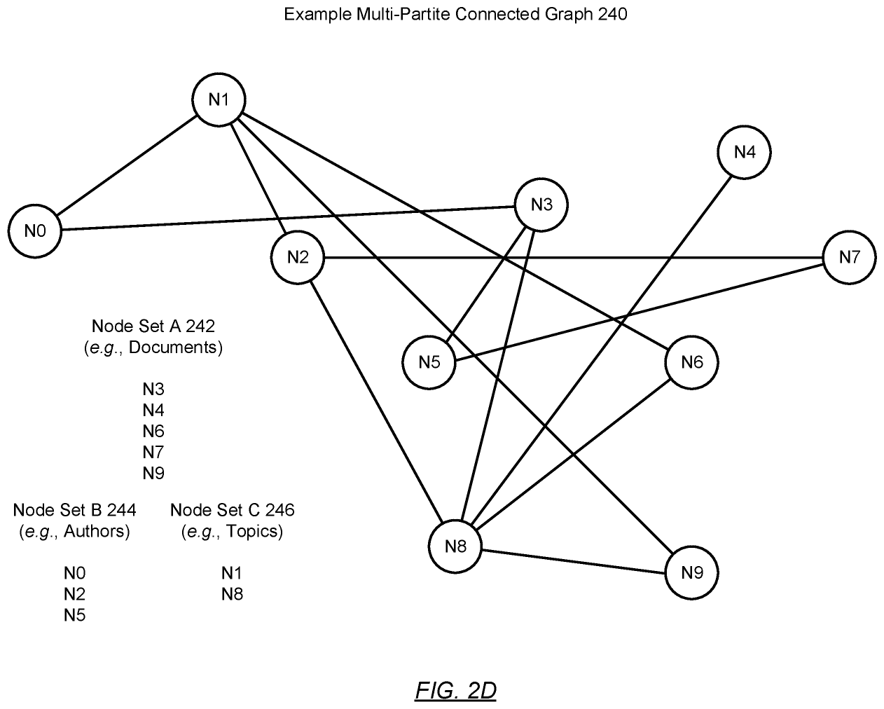

FIG. 2A shows an example connected graph in accordance with one or more embodiments disclosed herein. A connected graph (200), as disclosed herein, may refer to a set of nodes (202) (denoted in the example by the circles labeled N0, N1, N2, . . . , N9) interconnected by a set of edges (204, 216) (denoted in the example by the lines labeled EA, EB, EC, . . . , EQ between pairs of nodes). Each node (202) may represent or correspond to an object (e.g., a catalog entry, a record, specific data/information, a person, etc.) whereas each edge (204, 216), between or connecting any pair of nodes, may represent or correspond to a relationship, or relationships, associating the objects mapped to the pair of nodes. A connected graph (200), accordingly, may reference a data structure that reflects associations amongst any number, or a collection, of objects.

In one or many embodiment(s) disclosed herein, each node (202), in a connected graph (200), may also be referred to herein, and thus may serve, as an endpoint (of a pair of endpoints) of/to at least one edge (204). Further, based on a number of edges connected thereto, any node (202), in a connected graph (200), may be designated or identified as a super node (208), a near-super node (210), or an anti-super node (212). A super node (208) may reference any node where the number of edges, connected thereto, meets or exceeds a (high) threshold number of edges (e.g., six (6) edges). A near-super node (210), meanwhile, may reference any node where the number of edges, connected thereto, meets or exceeds a first (high) threshold number of edges (e.g., five (5) edges) yet lies below a second (higher) threshold number of edges (e.g., six (6) edges), where said second threshold number of edges defines the criterion for designating/identifying a super node (208). Lastly, an anti-super node (212) may reference any node where the number of edges, connected thereto, lies below a (low) threshold number of edges (e.g., two (2) edges).

In one or many embodiment(s) disclosed herein, each edge (204, 216), in a connected graph (200), may either be designated or identified as an undirected edge (204) or, conversely, as a directed edge (216). An undirected edge (204) may reference any edge specifying a bidirectional relationship between objects mapped to the pair of endpoints (i.e., pair of nodes (202)) connected by the edge. A directed edge (216), on the other hand, may reference any edge specifying a unidirectional relationship between objects mapped to the pair of endpoints connected by the edge.

In one or many embodiment(s) disclosed herein, each edge (204, 216), in a connected graph (200), may be associated with or assigned an edge weight (206) (denoted in the example by the labels Wgt-A, Wgt-B, Wgt-C, . . . , Wgt-Q). An edge weight (206), of a given edge (204, 216), may reflect a strength of the relationship(s) represented by the given edge (204, 216). Further, any edge weight (206) may be expressed as or through a positive numerical value within a predefined spectrum or range of positive numerical values (e.g., 0.1 to 1.0, 1 to 100, etc.). Moreover, across the said predefined spectrum/range of positive numerical values, higher positive numerical values may reflect stronger relationships, while lower positive numerical values may alternatively reflect weaker relationships.

In one or many embodiment(s) disclosed herein, based on an edge weight (206) associated with or assigned to an edge (204, 216) connected thereto, any node (202), in a connected graph (200), may be designated or identified as a strong adjacent node (not shown) or a weak adjacent node (not shown) with respect to the other endpoint of (i.e., the other node connected to the node (202) through) the edge (204, 216). That is, a strong adjacent node may reference any node of a pair of nodes connected by an edge, where an edge weight of the edge meets or exceeds a (high) edge weight threshold. Alternatively, a weak adjacent node may reference any node of a pair of nodes connected by an edge, where an edge weight of the edge lies below a (low) edge weight threshold.

In one or many embodiment(s) disclosed herein, a connected graph (200) may include one or more subgraphs (214) (also referred to as neighborhoods). A subgraph (214) may refer to a smaller connected graph found within a (larger) connected graph (200). A subgraph (214), accordingly, may include a node subset of the set of nodes (202), and an edge subset of the set of edges (204, 216), that form a connected graph (200), where the edge subset interconnects the node subset.

While FIG. 2A shows a configuration of components and/or subcomponents, other connected graph (200) configurations may be used without departing from the scope disclosed herein.

FIGS. 2B-2D show example k-partite connected graphs in accordance with one or more embodiments disclosed herein. Generally, any k-partite connected graph may represent a connected graph (described above) (see e.g., FIG. 2A) that encompasses k independent sets of nodes and a set of edges interconnecting (and thus defining relationships between) pairs of nodes: (a) both belonging to the same, single independent set of nodes in any (k=1)-partite connected graph; or (b) each belonging to a different independent set of nodes in any (k>1)-partite connected graph. Further, any k-partite connected graph, as disclosed herein, may fall into one of three possible classifications: (a) a uni-partite connected graph, where k=1; (b) a bi-partite connected graph, where k=2; or (c) a multi-partite connected graph, where k≥3.

Turning to FIG. 2B, an example uni-partite connected graph (220) is depicted. The uni-partite connected graph (220) includes one (k=1) independent set of nodes—i.e., a node set (222), which collectively maps or belongs to a single object class (e.g., documents).

Further, in the example, the node set is denoted by the circles labeled N0, N1, N2, . . . , N9. Each said circle, in the node set (222), subsequently denotes a node that represents or corresponds to a given object (e.g., a document) in a collection of objects (e.g., a group of documents) of the same object class (e.g., documents).

Moreover, the uni-partite connected graph (220) additionally includes a set of edges (denoted in the example by the lines interconnecting pairs of nodes, where the first and second nodes in a given node pair belongs to the node set (222)). Each edge, in the example, thus reflects a relationship, or relationships, between any two nodes of the node set (222) (and, by association, any two objects of the same object class) directly connected via the edge.

Turning to FIG. 2C, an example bi-partite connected graph (230) is depicted. The bi-partite connected graph (230) includes two (k=2) independent sets of nodes—i.e., a first node set (232) and a second node set (234), where the former collectively maps or belongs to a first object class (e.g., documents) whereas the latter collectively maps or belongs to a second object class (e.g., authors).

Further, in the example, the first node set (232) is denoted by the circles labeled N0, N2, N4, N7, N8, and N9, while the second node set (234) is denoted by the circles labeled N1, N3, N5, and N6. Each circle, in the first node set (232), subsequently denotes a node that represents or corresponds to a given first object (e.g., a document) in a collection of first objects (e.g., a group of documents) of the first object class (e.g., documents). Meanwhile, each circle, in the second node set (234), subsequently denotes a node that represents or corresponds to a given second object (e.g., an author) in a collection of second objects (e.g., a group of authors) of the second object class (e.g., authors).

Moreover, the bi-partite connected graph (230) additionally includes a set of edges (denoted in the example by the lines interconnecting pairs of nodes, where a first node in a given node pair belongs to the first node set (232) and a second node in the given node pair belongs to the second node set (234)). Each edge, in the example, thus reflects a relationship, or relationships, between any one node of the first node set (232) and any one node of the second node set (234) (and, by association, any one object of the first object class and any one object of the second object class) directly connected via the edge.

Turning to FIG. 2D, an example multi-partite connected graph (240) is depicted. The multi-partite connected graph (240) includes three (k=3) independent sets of nodes—i.e., a first node set (242), a second node set (244), and a third node set (246). The first node set (242) collectively maps or belongs to a first object class (e.g., documents); the second node set (244) collectively maps or belongs to a second object class (e.g., authors); and the third node set (246) collectively maps or belongs to a third object class (e.g., topics).

Further, in the example, the first node set (242) is denoted by the circles labeled N3, N4, N6, N7, and N9; the second node set (244) is denoted by the circles labeled N0, N2, and N5; and the third node set (246) is denoted by the circles labeled N1 and N8. Each circle, in the first node set (242), subsequently denotes a node that represents or corresponds to a given first object (e.g., a document) in a collection of first objects (e.g., a group of documents) of the first object class (e.g., documents). Meanwhile, each circle, in the second node set (244), subsequently denotes a node that represents or corresponds to a given second object (e.g., an author) in a collection of second objects (e.g., a group of authors) of the second object class (e.g., authors). Lastly, each circle, in the third node set (246), subsequently denotes a node that represents or corresponds to a given third object (e.g., a topic) in a collection of third objects (e.g., a group of topics) of the third object class (e.g., topics).

Moreover, the multi-partite connected graph (240) additionally includes a set of edges (denoted in the example by the lines interconnecting pairs of nodes, where a first node in a given node pair belongs to one object class from the three available object classes, and a second node in the given node pair belongs to another object class from the two remaining object classes (that excludes the one object class to which the first node in the given node pair belongs)). Each edge, in the example, thus reflects a relationship, or relationships, between any one node of one object class (from the three available object classes) and any one node of another object class (from the two remaining object class excluding the one object class) directly connected via the edge.

FIGS. 3A-3C show flowcharts describing a method for dynamic data product creation in accordance with one or more embodiments disclosed herein. The various steps outlined below may be performed by an insight service (see e.g., FIG. 1). Further, while the various steps in the flowchart are presented and described sequentially, one of ordinary skill will appreciate that some or all steps may be executed in different orders, may be combined or omitted, and some or all steps may be executed in parallel.

Turning to FIG. 3A, in Step 300, a data query is received. In one or many embodiment(s) disclosed herein, the data query may include or specify one or more data topics. A data topic may refer to a subject or domain to which data (e.g., one or more datasets) may belong or may be associated with. Further, the data query may have been submitted by an organization user. As such, the data query may represent an inquiry, by the organization user, with regards to the availability of datasets (e.g., one or more collections of data) concerning the specified data topic(s).

In Step 302, a user profile is obtained. In one or many embodiment(s) disclosed herein, the user profile may pertain to the organization user (from which the data query had been received in Step 300). The user profile may refer to a collection of settings and information associated with the organization user. As such, the user profile may include, but is not limited to, a user identifier (ID) and user access permissions.

In one or many embodiment(s) disclosed herein, the user ID may reflect a character string that uniquely identifies the organization user. The character string may be of any arbitrary length and may be formed from any combination or order of characters, where the characters may include, but are not limited to, one or more letters, one or more numbers, and/or one or more symbols.

In one or many embodiment(s) disclosed herein, the user access permissions may reflect the level of authorization granted to the organization user for accessing specific resources. The granted level of authorization, for any given organization user, may, for example, be contingent on any number of factors, which may include, but is/are not limited to: one or more user organization roles (e.g., title(s) and/or position(s)) within an organization that may be associated with the given organization user; one or more organization responsibilities (e.g., assigned project(s) or task(s)) within an organization that may be associated with the given organization user; a client device (and the security hygiene or characteristics thereof) operated by the given organization user; and a geographical location where the given organization user may be physically situated. The factor(s) affecting the user access permissions for any given organization user is/are not limited to the aforementioned specific examples.

In Step 304, a determination is made as to whether the user ID (obtained in Step 302) is associated with any existing data products. The determination may, for example, entail a lookup in a data products database or catalog using the user ID to identify zero or more database/catalog entries, where each database/catalog entry may retain metadata for, or information descriptive of, a given existing data product. Subsequently, in one or many embodiment(s) disclosed herein, if it is determined that one or more existing data products is/are associated with the user ID, then the method proceeds to Step 306. On the other hand, in one or many other embodiment(s) disclosed herein, if it is alternatively determined that zero existing data products are associated with the user ID, then the method alternatively proceeds to Step 320 (see e.g., FIG. 3B).

In Step 306, following the determination (made in Step 304) that at least one existing data product is associated with the user ID (obtained in Step 302), another determination is made as to whether the at least one existing data product is associated with any of the data topic(s) (specified in the data query received in Step 300). The determination may, for example, entail topic matching (e.g., case-insensitive word or phrase matching) between the data topic(s) and any retained metadata descriptive of the at least one existing data product. Subsequently, in one or many embodiment(s) disclosed herein, if it is determined that one or more existing data products is/are associated with any of the data topic(s), then the method proceeds to Step 308. On the other hand, if it is alternatively determined that zero existing data products are associated with any of the data topic(s), then the method alternatively proceeds to Step 320 (see e.g., FIG. 3B).

In Step 308, following the determination (made in Step 306) that at least one existing data product is associated with any of the data topic(s) (specified in the data query received in Step 300), availability remarks, concerning one or more assets specified in the at least one existing data product, are updated. In one or many embodiment(s) disclosed herein, an asset may refer to any network-reachable resource (e.g., a dataset) known to or catalogued by the insight service (see e.g., FIG. 1). Further, any availability remarks may refer to information expressing whether the asset(s) is/are available or unavailable at/on one or more data sources that the asset(s) currently reside, or at one time, had resided. Said updating of the availability remarks, for asset(s) specified in the at least one existing data product, is illustrated and described in further detail with respect to FIG. 3D, below.

In Step 310, the at least one existing data product (identified through the determination made in Step 306) is provided in response to the data query (received in Step 300). Particularly, in one or many embodiment(s) disclosed herein, the at least one existing data product may be provided to the organization user who had submitted the data query. Further, the at least one existing data product may include availability remarks (updated in Step 308, if applicable) regarding one or more assets specified therein.

In Step 312, an instantiation request is received. In one or many embodiment(s) disclosed herein, the instantiation request may pertain to realizing an existing data product of the at least one existing data product (provided in Step 310). Realizing the existing data product may, for example, entail attaining an instance or instances of the asset(s) (e.g., one or more datasets) specified in the existing data product. Further, the instantiation request may be submitted by the organization user (whom which had also submitted the data query in Step 300).

In Step 314, one or more accessible and available assets (e.g., one or more datasets) (if any) is/are selected from the asset(s) specified in the existing data product (for which the instantiation request had been received in Step 312). In one or many embodiment(s) disclosed herein, an accessible asset may refer to an asset that the organization user may be authorized to access based on a combination of the user access permissions (obtained in Step 302) for the organization user and compliance information associated with the asset. Meanwhile, an available asset may refer to an asset, which may reside at/on a respective data source, that may be obtained, used, or reached. Accordingly, an accessible and available asset may reference any asset that may be readily acquired or employed and that the organization user is authorized to access.

In Step 316, the accessible and available asset(s) (if any) (selected in Step 314) is/are retrieved. In one or many embodiment(s) disclosed herein, each accessible and available asset may reside, or may be maintained, on a respective (appropriate) internal or external data source (see e.g., FIG. 1) wherefrom the accessible and available asset may be retrieved.

In Step 318, the accessible and available asset(s) (if any) (retrieved from their respective data source(s) in Step 316) is/are provided in response to the instantiation request (received in Step 312). Particularly, in one or many embodiment(s) disclosed herein, the accessible and available asset(s) may be provided to the organization user who had submitted the instantiation request. Further, the accessible and available asset(s) may be provided by way of a select delivery mode, which may, for example, be via a digital reference link (e.g., uniform resource locator or hyperlink) tied to a storage location where the accessible and available asset(s) may be accessed by the organization user, via an archive or compressed file storing the accessible and available asset(s), or any other delivery mediums through which the accessible and available asset(s) may be provided to the organization user.

Turning to FIG. 3B, in Step 320, following the determination (made in Step 304) that none of the existing data products are associated with the user ID (obtained in Step 302), or following the determination (made in Step 306) that none of the existing data products are associated with the data topic(s) (received via the data query in Step 300), a metadata graph is obtained. In one or many embodiment(s) disclosed herein, the metadata graph may refer to a connected graph (see e.g., FIG. 2A) representative of an asset catalog. To that end, the metadata graph may include a set of nodes interconnected by a set of edges, where the set of nodes are representative of asset catalog entries and the set of edges are representative of connections or relationships there-between. Further, each node may pertain to a given asset (e.g., dataset), where the representative asset catalog entry thereof may store metadata for, or information descriptive of, the given asset.

Examples of said asset metadata may include, but is not limited to: a brief description of the asset; stewardship (or ownership) information (e.g., individual or group name(s), contact information, etc.) pertaining to the steward(s)/owner(s) of the asset; a version character string reflective of a version or state of the asset at/for a given point-in-time; one or more categories, topics, and/or aspects associated with the asset; an asset identifier uniquely identifying the asset; one or more tags, keywords, or terms further describing the asset; a source identifier and/or location associated with an internal or external data source (see e.g., FIG. 1) where the asset resides or is maintained; and compliance information specifying laws, regulations, and standards surrounding the asset, as well as policies directed to data governance (e.g., availability, usability, integrity, and security) pertinent to the asset. The asset metadata for any asset is not limited to the aforementioned specific examples.

In Step 322, for each data topic of the data topic(s) (received via the data query in Step 300), the metadata graph (obtained in Step 320) is filtered based on the data topic. In one or many embodiment(s) disclosed herein, filtering of the metadata graph may, for example, entail topic matching (e.g., case-insensitive word or phrase matching) between a given data topic and the asset metadata for assets catalogued in the asset catalog entries of which nodes of the metadata graph are representative. Further, for each data topic, the filtering of the metadata graph based thereon may result in the identification of a node subset of the set of nodes forming the metadata graph. The identified node subset, subsequently, may include one or more nodes representative of one or more assets, respectively, that may be associated with the data topic.

In Step 324, a k-partite metadata graph is generated using the node subset(s) (identified in Step 322). In one or many embodiment(s) disclosed herein, the k-partite metadata graph (see e.g., FIGS. 2B-2D) may reflect a new representation of, which may be based on one or more particular perspectives on, the metadata graph (obtained in Step 320). The k-partite metadata graph, further, may reflect a connected graph that encompasses k independent sets of nodes (i.e., the node subset(s), where k equals the number or cardinality of node subset(s)) and a set of edges interconnecting (and thus defining relationships between) pairs of nodes each belonging to a different independent set of nodes (or node subset)—with the exception of uni-(k=1) partite metadata graphs (see e.g., FIG. 2B) where the set of edges interconnect nodes of the single independent set of nodes (or single node subset) forming the uni-partite metadata graphs.

In Step 326, one or more super nodes, in/of the k-partite metadata graph (generated in Step 324), is/are identified. In one or many embodiment(s) disclosed herein, a super node may refer to a densely connected node or a node with a disproportionately high number of edges connected thereto. Additionally, or alternatively, a super node may be identified as any node representing a most connected node (e.g., any node that serves as an endpoint of a pair of endpoints to a highest number of edges) in the k-partite metadata graph, which may otherwise be defined as any node that serves as an endpoint of a pair of endpoints to a number of edges, where the number of edges meets or exceeds a threshold number of edges (that may be dynamically set). For example, the threshold number of edges may be set to ten edges, where any node(s) in the k-partite metadata graph that serves as an endpoint (of a pair of endpoints) to at least ten edges may be labeled as a super node.

In Step 328, for each super node of the super node(s) (identified in Step 326), at least a portion of asset metadata, for an asset (e.g., dataset) corresponding to the super node, is extracted. In one or many embodiment(s) disclosed herein, the extracted portion of asset metadata may include, but is not limited to, stewardship (or ownership) information and compliance information (both briefly defined above—see e.g., Step 320) associated with the asset.

In Step 330, for each super node of the super node(s) (identified in Step 326), one or more strong adjacent nodes, which may be found in the k-partite metadata graph (generated in Step 324), is/are identified. In one or many embodiment(s) disclosed herein, with respect to a given super node, a strong adjacent node linked to the given super node may refer to a node connected thereto via an edge representative of a strong relationship there-between. Quantification of said strong relationship may, for example, entail an edge weight assigned to the edge interconnecting the given super node and the strong adjacent node, where the edge weight (e.g., expressed as a numerical value) meets or exceeds an edge weight threshold. The edge weight threshold, in turn, may be dynamically set and may denote the criterion for determining whether the associated edge is reflective of a strong relationship between a pair of assets (e.g., pair of datasets) corresponding to the given super node and a strong adjacent node.

In Step 332, for each strong adjacent node of the strong adjacent node(s) (identified in Step 330), at least a portion of asset metadata, for an asset (e.g., dataset) corresponding to the strong adjacent node, is extracted. In one or many embodiment(s) disclosed herein, the extracted portion of asset metadata may include, but is not limited to, stewardship (or ownership) information and compliance information (both briefly defined above—see e.g., Step 320) associated with the asset.

In Step 334, one or more other nodes, which may be found in the k-partite metadata graph (generated in Step 324), is/are identified. In one or many embodiment(s) disclosed herein, the other node(s) may be identified based on the satisfaction of one or more other criteria. Examples of said criteria may include, but is not limited to: whether a node is positioned along a longest path traversing the k-partite metadata graph; and whether a node is positioned along a shortest path traversing the k-partite metadata graph.

In Step 336, for each other node of the other node(s) (identified in Step 334), at least a portion of asset metadata, for an asset (e.g., dataset) corresponding to the other node, is extracted. In one or many embodiment(s) disclosed herein, the extracted portion of asset metadata may include, but is not limited to, stewardship (or ownership) information and compliance information (both briefly defined above—see e.g., Step 320) associated with the asset.

Turning to FIG. 3C, in Step 338, the user access permissions (obtained in Step 302), associated with the organization user, is assessed against the compliance information (extracted in Steps 328, 332, and/or 336) associated with one or more assets. In one or many embodiment(s) disclosed herein, the asset(s) may map to asset catalog entry/entries represented by the super node(s) (identified in Step 326), the strong adjacent node(s) (identified in Step 330), and/or the other node(s) (identified in Step 334).

Further, assessment of the user access permissions, against the asset compliance information, may, for example, entail determining: whether a geographical location of the organization user is within the geographical restrictions or boundaries, at least in part, defining access to an asset; whether the organization, with which the organization user is associated, is of a particular type (e.g., a commercial business, an educational institution, etc.) to which access and usability of an asset is granted; and whether one or more organization roles (e.g., title(s) and/or position(s)) and/or professional affiliation(s) (e.g., membership(s) to professional organization(s)), with which the organization user is associated, satisfies criteria for permitting access to an asset.

Moreover, the above-mentioned assessment, between the user access permissions and the asset compliance information, may result in producing access remarks that concern the asset(s) associated with the extracted compliance information. In one or many embodiment(s) disclosed herein, any access remarks may refer to information expressing whether the asset(s) is/are accessible or inaccessible to/by the organization user. Said information (for any given asset) may include, but is not limited to: an accessibility statement indicating that the given asset can or cannot be accessed by the organization user; one or more reasons explaining or supporting the accessibility statement; a digital reference link (e.g., uniform resource locator or hyperlink) or an access protocol through which the organization user can access the given asset should the accessibility statement indicate that the given asset can be accessed by the organization user; and/or the stewardship information (extracted in Steps 324, 328, and/or 332) associated with the given asset should the accessibility statement alternatively indicate that the given asset cannot be accessed by the organization user.

In one or many embodiment(s) disclosed herein, stewardship information may be integrated, as part of the access remarks for a given asset (if applicable—e.g., if the given asset is deemed inaccessible), in order to provide the organization user with an opportunity to potentially gain access to the given asset through communications with the steward(s) or owner(s) of the given asset. The potential to gain access to the given asset through this avenue, however, may be moot or disregarded in view of other, higher-tiered compliance policies such as those outlined by geographical restrictions, as well as national and/or international laws, regulations, and standards.

In Step 340, an asset availability, for each of one or more assets (e.g., one or more datasets), is determined. In one or many embodiment(s) disclosed herein, the asset(s) may map to asset catalog entry/entries represented by the super node(s) (identified in Step 326), the strong adjacent node(s) (identified in Step 330), and/or the other node(s) (identified in Step 334). Further, the determination of asset availability for any given asset may, for example, entail the submission of an asset availability query to an appropriate (i.e., internal or external) data source identified in the asset metadata describing the given asset. Any asset availability query may include or specify an asset identifier (also found in the asset metadata) that uniquely identifies the given asset. Moreover, in response to any asset availability query, a corresponding asset availability reply may be received, which may include or specify an asset availability state indicating whether the given asset is available (e.g., obtainable, usable, or reachable) or unavailable (e.g., unobtainable, unusable, or unreachable). Thereafter, the returned asset availability state(s) for the asset(s), respectively, may be used to produce availability remarks (described above) (see e.g., Step 308) concerning the asset(s).

In Step 342, a new data product is created. In one or many embodiment(s) disclosed herein, the new data product may include or specify a manifest of the asset(s) mapped to asset catalog entry/entries represented by the super node(s) (identified in Step 326), the strong adjacent node(s) (identified in Step 330), and/or the other node(s) (identified in Step 334), the access remarks (produced in Step 338), and the availability remarks (produced in Step 340). The manifest of the asset(s) may refer to a list that itemizes the asset(s).

In Step 344, the new data product (created in Step 342) is provided in response to the data query (received in Step 300). Particularly, in one or many embodiment(s) disclosed herein, the new data product may be provided to the organization user who had submitted the data query.

In Step 346, an instantiation request is received. In one or many embodiment(s) disclosed herein, the instantiation request may pertain to realizing the new data product (provided in Step 344). Realizing the new data product may, for example, entail attaining an instance or instances of the asset(s) (e.g., one or more datasets) specified in the new data product. Further, the instantiation request may be submitted by the organization user (whom which had also submitted the data query in Step 300).

In Step 348, one or more accessible and available assets (described above) (see e.g., Step 314) (e.g., one or more datasets) (if any) is/are selected from the asset(s) specified in the new data product (for which the instantiation request had been received in Step 346).

In Step 350, the accessible and available asset(s) (if any) (selected in Step 348) is/are retrieved. In one or many embodiment(s) disclosed herein, each accessible and available asset may reside, or may be maintained, on a respective (appropriate) internal or external data source (see e.g., FIG. 1) wherefrom the accessible and available asset may be retrieved.

In Step 352, the accessible and available asset(s) (if any) (retrieved from their respective data source(s) in Step 350) is/are provided in response to the instantiation request (received in Step 346). Particularly, in one or many embodiment(s) disclosed herein, the accessible and available asset(s) may be provided to the organization user who had submitted the instantiation request. Further, the accessible and available asset(s) may be provided by way of a select delivery mode, which may, for example, be via a digital reference link (e.g., uniform resource locator or hyperlink) tied to a storage location where the accessible and available asset(s) may be accessed by the organization user, via an archive or compressed file storing the accessible and available asset(s), or any other delivery mediums through which the accessible and available asset(s) may be provided to the organization user.

FIG. 3D shows a flowchart describing a method for updating availability remarks in accordance with one or more embodiments disclosed herein. The various steps outlined below may be performed by an insight service (see e.g., FIG. 1). Further, while the various steps in the flowchart are presented and described sequentially, one of ordinary skill will appreciate that some or all steps may be executed in different orders, may be combined or omitted, and some or all steps may be executed in parallel.

Turning to FIG. 3D, the various steps (i.e., Steps 360, 362, 364, 366, and 368) presented and described hereinafter are pertinent to, and thus are performed for, each existing data product of the at least one existing data product (identified to be associated with one or more data topics specified in a data query (see e.g., FIG. 3A)).

In Step 360, a manifest of one or more assets (e.g., one or more datasets) is identified. In one or many embodiment(s) disclosed herein, the manifest of the asset(s) may be specified in, and thus may reflect at least a portion of, the existing data product, where the manifest of the asset(s) may refer to a list that itemizes the asset(s).

A steps subset (i.e., Steps 362, 364, 366, and 368) presented and described hereinafter are pertinent to, and thus are performed for, each asset of the at least one asset (itemized through the identified manifest of asset(s) in Step 360).

In Step 362, an asset availability query, pertaining to the asset, is generated. In one or many embodiment(s) disclosed herein, the asset availability query may include or specify an asset identifier (found in the asset metadata describing the asset) that uniquely identifies the asset.

In Step 364, the asset availability query (generated in Step 362) is submitted to an appropriate data source. In one or many embodiment(s) disclosed herein, the appropriate (i.e., internal or external) data source may be identified also by way of the asset metadata descriptive of the asset.

In Step 366, in response to the asset availability query (submitted in Step 364), an asset availability reply is received from the appropriate data source. In one or many embodiment(s) disclosed herein, the asset availability reply may include or specify an asset availability state indicating whether the asset is available (e.g., obtainable, usable, or reachable) or unavailable (e.g., unobtainable, unusable, or unreachable).

In Step 368, using the asset availability state (received via the asset availability reply in Step 366), availability remarks (described above) (see e.g., Step 308 in FIG. 3A), concerning the asset, are updated.

FIGS. 4A and 4B show flowcharts describing a method for metadata-based learning curriculum generation in accordance with one or more embodiments disclosed herein. The various steps outlined below may be performed by an insight service (see e.g., FIG. 1). Further, while the various steps in the flowchart are presented and described sequentially, one of ordinary skill will appreciate that some or all steps may be executed in different orders, may be combined or omitted, and some or all steps may be executed in parallel.

Turning to FIG. 4A, in Step 400, a learning query is received. In one or many embodiment(s) disclosed herein, the learning query may include or specify a learning topic and, optionally, one or more learning contexts. A learning topic may refer to subject matter about which new information, knowledge, and/or skills is sought to be acquired, whereas a learning context may refer to a domain or setting within which the learning topic may be constrained. Further, the learning query may have been submitted by an organization user. As such, the learning query may represent an inquiry, by the organization user, with regards to the selection of known or available materials, as well as the ordered introduction thereof, through which subject matter proficiency may be attained.

In Step 402, a user profile is obtained. In one or many embodiment(s) disclosed herein, the user profile may pertain to the organization user (from which the learning query had been received in Step 400). The user profile may refer to a collection of settings and information associated with the organization user. As such, the user profile may include, but is not limited to, user talent information, user learning preferences, and user access permissions.

In one or many embodiment(s) disclosed herein, the user talent information may reflect a compilation of talent- and development-related details associated with the organization user. Examples of said details may include, but are not limited to: an education level (e.g., degree(s) in which domain(s), as well as which tier(s) of degree(s)) earned by the organization user; any professional certification(s) gained by the organization user; one or more competencies (as well as their respective level(s) and/or potential(s)) characterizing the organization user; and any business- or research-related interest(s) (as well as their respective proficiency/proficiencies) expressed by the organization user. The compiled details defining the user talent information for any given organization user are not limited to the aforementioned specific examples.

In one or many embodiment(s) disclosed herein, the user learning preferences may reflect one or more educational modalities that the organization user may favor over others in order to optimize learning topic comprehension and retention. Said educational modality/modalities may include, but is/are not limited to, visual learning (i.e., learning assisted through images, videos, animations, and/or multimedia), auditory learning (i.e., learning assisted through audio), and reading learning (i.e., learning assisted through text-based content).

In one or many embodiment(s) disclosed herein, the user access permissions may reflect the level of authorization granted to the organization user for accessing specific resources. The granted level of authorization, for any given organization user, may, for example, be contingent on any number of factors, which may include, but is/are not limited to: one or more user organization roles (e.g., title(s) and/or position(s)) within an organization that may be associated with the given organization user; one or more organization responsibilities (e.g., assigned project(s) or task(s)) within an organization that may be associated with the given organization user; a client device (and the security hygiene or characteristics thereof) operated by the given organization user; and a geographical location where the given organization user may be physically situated. The factor(s) affecting the user access permissions for any given organization user is/are not limited to the aforementioned specific examples.

In Step 404, a metadata graph is obtained. In one or many embodiment(s) disclosed herein, the metadata graph may refer to a connected graph (see e.g., FIG. 2A) representative of an asset catalog. To that end, the metadata graph may include a set of nodes interconnected by a set of edges, where the set of nodes are representative of asset catalog entries and the set of edges are representative of connections or relationships there-between. Further, each node may pertain to a given asset (e.g., a text document, multimedia, a presentation deck, an audio book or podcast, or any other forms of digital learning materials), where the representative asset catalog entry thereof may store metadata for, or information descriptive of, the given asset.

Examples of said asset metadata may include, but is not limited to: a brief description of the asset; stewardship (or ownership) information (e.g., individual or group name(s), contact information, etc.) pertaining to the steward(s)/owner(s) of the asset; a version character string reflective of a version or state of the asset at/for a given point-in-time; one or more categories, topics, and/or aspects associated with the asset; an asset identifier uniquely identifying the asset; one or more tags, keywords, or terms further describing the asset; a source identifier and/or location associated with an internal or external data source (see e.g., FIG. 1) where the asset resides or is maintained; and compliance information specifying laws, regulations, and standards surrounding the asset, as well as policies directed to data governance (e.g., availability, usability, integrity, and security) pertinent to the asset. The asset metadata for any asset is not limited to the aforementioned specific examples.

In Step 406, the metadata graph (obtained in Step 404) is filtered based on the learning topic (received via the learning query in Step 400). In one or many embodiment(s) disclosed herein, filtering of the metadata graph may, for example, entail topic matching (e.g., case-insensitive word or phrase matching) between the learning topic and the asset metadata for assets catalogued in the asset catalog entries of which nodes of the metadata graph are representative. Further, filtering of the metadata graph based on the learning topic may result in the identification of a node subset of the set of nodes forming the metadata graph. The identified node subset, subsequently, may include one or more nodes representative of one or more assets, respectively, that may be associated with the learning topic.

Hereinafter, in one or many embodiment(s) disclosed herein, if at least one learning context is received via the learning query in Step 400, then the method proceeds to Step 408. On the other hand, in one or many other embodiment(s) disclosed herein, if zero learning contexts are received via the learning query in Step 400, then Step 408 is skipped and, alternatively, the method proceeds to Step 410.

In Step 408, for each learning context of the learning context(s) (if any) (received via the learning query in Step 400), the metadata graph (obtained in Step 404) is filtered based on the learning context. In one or many embodiment(s) disclosed herein, filtering of the metadata graph may, for example, entail topic matching (e.g., case-insensitive word or phrase matching) between a given learning context and the asset metadata for assets catalogued in the asset catalog entries of which nodes of the metadata graph are representative. Further, for each learning context, the filtering of the metadata graph based thereon may result in the identification of a node subset of the set of nodes forming the metadata graph. The identified node subset, subsequently, may include one or more nodes representative of one or more assets, respectively, that may be associated with the learning context.

In Step 410, a k-partite metadata graph is generated using the node subset(s) (identified in Step 406 and, optionally, in Step 408). In one or many embodiment(s) disclosed herein, the k-partite metadata graph (see e.g., FIGS. 2B-2D) may reflect a new representation of, which may be based on one or more particular perspectives on, the metadata graph (obtained in Step 404). The k-partite metadata graph, further, may reflect a connected graph that encompasses k independent sets of nodes (i.e., the node subset(s), where k equals the number or cardinality of node subset(s)) and a set of edges interconnecting (and thus defining relationships between) pairs of nodes each belonging to a different independent set of nodes (or node subset)—with the exception of uni-(k=1) partite metadata graphs (see e.g., FIG. 2B) where the set of edges interconnect nodes of the single independent set of nodes (or single node subset) forming the uni-partite metadata graphs.

In Step 412, one or more edge weights (e.g., each expressed as a numerical value) is/are set or adjusted. In one or many embodiment(s) disclosed herein, the set/adjusted edge weight(s) may be assigned to or associated with one or more edges, respectively, in/of the k-partite metadata graph (generated in Step 410). The affected edge(s), specifically, may represent a relationship or relationships between a pair or pairs of assets (e.g., text documents, multimedia, presentation decks, audio books or podcasts, or any other forms of digital learning materials) relevant or related to the learning topic (and, optionally, the learning context(s)) (received via the learning query in Step 400).

Further, in one or many embodiment(s) disclosed herein, the edge weight for any affected edge(s) may be set/adjusted based on the user talent information and/or the user learning preferences (either or both obtained in Step 402). By way of an example, any edge(s) connecting nodes, representative of assets of a format (e.g., text, video, audio, multimedia, image, etc.) matching the educational modality/modalities favored by the organization user and/or representative of assets likened to the talent- and/or development-related details describing the organization user, may have their respective edge weight(s) set/adjusted to a high(er) value in comparison to other edge(s) (e.g., edge(s) connecting nodes alternatively representative of assets of a format mismatching the educational modality/modalities favored by the organization user and/or representative of assets opposing the talent- and/or development-related details describing the organization user) in/of the k-partite metadata graph. The high(er) edge weight value may reflect a strong(er) relationship between any affected pair of nodes, and thus also the corresponding assets, where any strong(er) relationship(s) may be considered in the determination of a learning path (described below) (see e.g., Step 416) tailored to the organization user.

Additionally, or alternatively, the edge weight(s) assigned to, or associated with, the above-mentioned other edge(s) (e.g., edge(s) connecting nodes alternatively representative of assets of a format (e.g., text, video, audio, multimedia, image, etc.) mismatching the educational modality/modalities favored by the organization user and/or representative of assets opposing the talent- and/or development-related details describing the organization user) in/of the k-partite metadata graph may be set/adjusted to a low(er) value in comparison to any edge(s) connecting nodes, representative of assets of a format matching the educational modality/modalities favored by the organization user and/or representative of assets likened to the talent- and/or development-related details describing the organization user. The low(er) edge weight value may reflect a weak(er) relationship between any affected pair of nodes, and thus also the corresponding assets, where any weak(er) relationship(s) may be disregarded in the determination of a learning path tailored to the organization user.

In Step 414, one or more super nodes, in/of the k-partite metadata graph (generated in Step 410), is/are identified. In one or many embodiment(s) disclosed herein, a super node may refer to a densely connected node or a node with a disproportionately high number of edges connected thereto. Additionally, or alternatively, a super node may be identified as any node representing a most connected node (e.g., any node that serves as an endpoint of a pair of endpoints to a highest number of edges) in the k-partite metadata graph, which may otherwise be defined as any node that serves as an endpoint of a pair of endpoints to a number of edges, where the number of edges meets or exceeds a threshold number of edges (that may be dynamically set). For example, the threshold number of edges may be set to ten edges, where any node(s) in the k-partite metadata graph that serves as an endpoint (of a pair of endpoints) to at least ten edges may be classified or labeled as a super node in/of the k-partite metadata graph.

Additionally, or alternatively, one or more most connected nodes, within one or more metadata subgraphs in/of the k-partite metadata graph (generated in Step 410), is/are identified. In one or many embodiment(s) disclosed herein, a metadata subgraph may generally refer to a connected graph that may be found within, and therefore may include at least a portion of the elements (e.g., a set of nodes interconnected by a set of edges) forming, a larger connected graph (e.g., the k-partite metadata graph). A most connected node within any metadata subgraph, accordingly, may be defined as any node found within the metadata subgraph that serves as an endpoint of a pair of endpoints to a second number of edges, where the second number of edges meets or exceeds a second threshold of edges (that may be dynamically set). For example, the second threshold of edges may be set to ten edges, where any node(s) found within any given metadata subgraph(s), in the k-partite metadata graph, that serves as an endpoint (of a pair of endpoints) to at least ten edges may be classified or labeled as a most connected node in/of the given metadata subgraph.

Additionally, or alternatively, one or more other nodes, which may be found in the k-partite metadata graph (generated in Step 410), is/are identified. In one or many embodiment(s) disclosed herein, the other node(s) may be identified based on the satisfaction of one or more other criteria. Examples of said criteria may include, but is not limited to: whether a node is positioned along a longest path traversing the k-partite metadata graph; and whether a node is positioned along a shortest path traversing the k-partite metadata graph.

In Step 416, a learning path, traversing through at least a portion of the k-partite metadata graph (generated in Step 410), is determined. In one or many embodiment(s) disclosed herein, the learning path may refer to a sequence of one or more edges (also referred to herein as learning path edge(s)), which interconnect(s) a sequence of two or more nodes (also referred to herein as learning path nodes), in/of the k-partite metadata graph. The learning path nodes, accordingly, may include: a path-starting node representing the first node in the sequence of nodes; a path-ending node representing the last node in the sequence of nodes; and zero or more path-body nodes respectively representing zero or more intermediate nodes collectively connecting the path-starting node to the path-ending node.

In one or many embodiment(s) disclosed herein, in forming at least a portion of the k-partite metadata graph, each learning path node in/of (i.e., positioned along) the learning path may correspond to an asset catalog entry in an asset catalog, which in turn specifies asset metadata describing a given asset (e.g., a text document, multimedia, a presentation deck, an audio book or podcast, or any other forms of digital learning materials) known to or catalogued by the insight service, and relevant to the learning topic (and, optionally, the learning context(s)) (received via the learning query in Step 400).

Further, in one or many embodiment(s) disclosed herein, the learning path may represent a directed path, or any path encompassing one or more edges each having a direction and, thus, each connecting one node (e.g., the path-starting node or a path-body node) to another node (e.g., a path-body node or the path-ending node) via said direction. Also, in traversing the learning path from the path-starting node to the path-ending node, each learning path node is visited, while each learning path edge between a pair of learning path nodes is crossed, only once. Accordingly, each learning path edge in/of the learning path may be oriented towards the same direction.

In one or many embodiment(s) disclosed herein, determination of the learning path may rely on any combination of the super node(s), most connected node(s) within one or more metadata subgraphs, and/or the other node(s) (identified in Step 414), as well as the edge weight(s) (set/adjusted in Step 412). For example, a learning path maybe as simple as the entire path that connects the super nodes. Alternatively, the learning path may be as complex as identifying the assets that are deemed the most impactful within the subgraph or context in which the inquiry originated. To determine the most impactful asset embodiment may utilize metadata, such as, other views and visits, ratings, forward and backward citations, impact of authors and network power they poses within the specific domain(s). Utilizing this metadata as a weight that is assigned to these assets in combination with a ranking algorithm, such as, a simple page rank, a learning path that includes a start node and ‘n’ next steps for the user to take may be determined. Further, in various embodiments, the learning path may not be static; rather depending on the selection of the next step(s) by the user, the weights associated with the next steps may change. This may result in an updated learning path, e.g., based on the user's selection the system may recommend learning paths that are more in depth or recommend more complex assets to view. Additionally, or alternatively, the system may recommend that the user move into a new domain or subdomain that was identified or mentioned within the previous assets. In this manner, based on selection and the business intent, the learning paths maybe re-evaluated after each interaction with the assets. For certain domains or subdomains the impact analysis and weights can be predetermined due to other relationship information that is known, which may result in the start and the end nodes to become almost static.

In one or many embodiment(s) disclosed herein, the sequence in which the learning path nodes may be ordered may reflect a spectrum of assets (e.g., learning materials) teaching progressively more difficult or more advanced aspects of the learning topic (and, optionally, the learning context(s)) (received via the learning query in Step 400). For example, the path-starting node in/of the learning path may correspond to an asset commensurate to a novice/basic knowledge level or, alternatively, a standing/current knowledge level that the organization user may retain, concerning the learning topic (and, optionally, the learning context(s)). On the other hand, the path-ending node in/of the learning path may correspond to another asset representative of a mastery knowledge level concerning the learning topic (and, optionally, the learning context(s)). Any path-body node(s) there-between may each correspond to, or introduce, yet another asset that may serve to progressively advance the proficiency, of/by the organization user, in terms of the learning topic (and, optionally, the learning context(s)).

Turning to FIG. 4B, in Step 418, a set of learning path nodes is/are identified. In one or many embodiment(s) disclosed herein, and as re-iterated from above, the set of learning path nodes may include one or more nodes that, at least in part, form and, therefore, is/are positioned along, the learning path (determined in Step 416).

In Step 420, for each learning path node in the set of learning path nodes (identified in Step 418), at least a portion of asset metadata, for an asset (e.g., a text document, multimedia, a presentation deck, an audio book or podcast, or any other forms of digital learning materials) corresponding to the learning path node, is extracted. In one or many embodiment(s) disclosed herein, the extracted portion of asset metadata may include, but is not limited to, stewardship (or ownership) information and compliance information (both briefly defined above—see e.g., Step 404) associated with the asset.

In Step 422, the user access permissions (obtained in Step 402), associated with the organization user, is assessed against the compliance information (extracted in Step 420) associated with one or more assets. In one or many embodiment(s) disclosed herein, the asset(s) may map to asset catalog entry/entries represented by the set of learning path nodes (identified in Step 410).

Further, assessment of the user access permissions, against the asset compliance information, may, for example, entail determining: whether a geographical location of the organization user is within the geographical restrictions or boundaries, at least in part, defining access to an asset; whether the organization, with which the organization user is associated, is of a particular type (e.g., a commercial business, an educational institution, etc.) to which access and usability of an asset is granted; and whether one or more organization roles (e.g., title(s) and/or position(s)) and/or professional affiliation(s) (e.g., membership(s) to professional organization(s)), with which the organization user is associated, satisfies criteria for permitting access to an asset.

Moreover, the above-mentioned assessment, between the user access permissions and the asset compliance information, may result in producing access remarks that concern the asset(s) associated with the extracted compliance information. In one or many embodiment(s) disclosed herein, any access remarks may refer to information expressing whether the asset(s) is/are accessible or inaccessible to/by the organization user. Said information (for any given asset) may include, but is not limited to: an accessibility statement indicating that the given asset can or cannot be accessed by the organization user; one or more reasons explaining or supporting the accessibility statement; a digital reference link (e.g., uniform resource locator or hyperlink) or an access protocol through which the organization user can access the given asset should the accessibility statement indicate that the given asset can be accessed by the organization user; and/or the stewardship information (extracted in Step 420) associated with the given asset should the accessibility statement alternatively indicate that the given asset cannot be accessed by the organization user.

In one or many embodiment(s) disclosed herein, stewardship information may be integrated, as part of the access remarks for a given asset (if applicable—e.g., if the given asset is deemed inaccessible), in order to provide the organization user with an opportunity to potentially gain access to the given asset through communications with the steward(s) or owner(s) of the given asset. The potential to gain access to the given asset through this avenue, however, may be moot or disregarded in view of other, higher-tiered compliance policies such as those outlined by geographical restrictions, as well as national and/or international laws, regulations, and standards.

In Step 424, an asset availability, for each of one or more assets (e.g., one or more documents, multimedia, presentation decks, audio books or podcasts, or any other forms of digital learning materials), is determined. In one or many embodiment(s) disclosed herein, the asset(s) may map to asset catalog entry/entries represented by the set of learning path nodes (identified in Step 410). Further, the determination of asset availability for any given asset may, for example, entail the submission of an asset availability query to an appropriate (i.e., internal or external) data source identified in the asset metadata describing the given asset. Any asset availability query may include or specify an asset identifier (also found in the asset metadata) that uniquely identifies the given asset. Moreover, in response to any asset availability query, a corresponding asset availability reply may be received, which may include or specify an asset availability state indicating whether the given asset is available (e.g., obtainable, usable, or reachable) or unavailable (e.g., unobtainable, unusable, or unreachable). Thereafter, the returned asset availability state(s) for the asset(s), respectively, may be used to produce availability remarks concerning the asset(s). Any availability remarks may refer to information expressing whether the asset(s) is/are available or unavailable at/on one or more data sources that the asset(s) currently reside, or at one time, had resided.

In Step 426, a learning curriculum is created. In one or many embodiment(s) disclosed herein, the learning curriculum may refer to an ordered itemization/listing (or sequenced itemization/listing) (also referred to herein as a manifest) of learning materials and/or content that progressively teaches improved proficiency in the learning topic (and, optionally, the learning context(s)) (received via the learning query in Step 400). The learning curriculum, further, may be tailored to, and therefore may align with the user talent information and/or the user learning preferences (obtained in Step 402) of, the organization user. Other information, moreover, may also be enclosed within or may accompany the learning curriculum. Said other information may include, but is not limited to, the access remarks (produced in Step 422) and the availability remarks (produced in Step 424).

In Step 428, the learning curriculum (created in Step 426) is provided in response to the learning query (received in Step 400). Particularly, in one or many embodiment(s) disclosed herein, the learning curriculum may be provided to the organization user who had submitted the learning query.

In Step 430, learning curriculum feedback is received. In one or many embodiment(s) disclosed herein, the learning curriculum feedback may speak to the effectiveness of the learning curriculum (provided in Step 428) in progressively improving the organization user proficiency surrounding the learning topic (and, optionally, the learning context(s)) (received via the learning query in Step 400). Examples of learning curriculum feedback may include, but are not limited to: measurement(s) and/or metric(s) (e.g., time to consume (i.e., read, listen to, watch) the learning material(s), etc.) reflecting organization user engagement with learning curriculum (or the asset(s)—e.g., one or more text documents, multimedia, presentation decks, audio books or podcasts, or any other forms of digital learning materials—listed therein); a user review rating (via any rating scale—e.g., 1-5 stars, etc.) indicating an efficacy of the learning curriculum experienced by the organization user; and a post-learning survey, directed to the organization user, that may inquire, for example, whether the learning curriculum, at least in part, aided in achieving any organizational (or business) goals.

In Step 432, the learning curriculum (provided in Step 428), or the process of learning curriculum generation in general, is adjusted based on the learning curriculum feedback (received in Step 430). In one or many embodiment(s) disclosed herein, adjustment of the learning curriculum (or of the generation of learning curriculums generally) may, for example, entail understanding metrics, ratings, comments, acknowledgements, mentions, referrals, etc. to understand if the reader know has an expected understanding of the domain or subdomain. If this knowledge is deemed enough for their business intent then the next assets can be accessed or recommended. If the business intent requires more detailed knowledge then the more complexity ranked, and impactful assets are recommended. This continues until the desired level of knowledge and understanding is achieved.

FIGS. 5A-5C show flowcharts describing a method for metadata-based query rewriting in accordance with one or more embodiments disclosed herein. The various steps outlined below may be performed by an insight service (see e.g., FIG. 1). Further, while the various steps in the flowchart are presented and described sequentially, one of ordinary skill will appreciate that some or all steps may be executed in different orders, may be combined or omitted, and some or all steps may be executed in parallel.

Turning to FIG. 5A, in Step 500, a search query is received. In one or many embodiment(s) disclosed herein, the search query may include or specify one or more search topics. A search topic may refer to a subject or domain to which sought information may belong or may be associated with. Further, the search query may have been submitted by an organization user. As such, the search query may represent an inquiry, by the organization user, with regards to known or catalogued assets (e.g., any existing forms of structured and/or unstructured information) concerning the specified search topic(s).

In Step 502, a user profile is obtained. In one or many embodiment(s) disclosed herein, the user profile may pertain to the organization user (from which the search query had been received in Step 500). The user profile may refer to a collection of settings and information associated with the organization user. As such, the user profile may include, but is not limited to, user access permissions.

In one or many embodiment(s) disclosed herein, the user access permissions may reflect the level of authorization granted to the organization user for accessing specific resources. The granted level of authorization, for any given organization user, may, for example, be contingent on any number of factors, which may include, but is/are not limited to: one or more user organization roles (e.g., title(s) and/or position(s)) within an organization that may be associated with the given organization user; one or more organization responsibilities (e.g., assigned project(s) or task(s)) within an organization that may be associated with the given organization user; a client device (and the security hygiene or characteristics thereof) operated by the given organization user; and a geographical location where the given organization user may be physically situated. The factor(s) affecting the user access permissions for any given organization user is/are not limited to the aforementioned specific examples.

In Step 504, a metadata graph is obtained. In one or many embodiment(s) disclosed herein, the metadata graph may refer to a connected graph (see e.g., FIG. 2A) representative of an asset catalog. To that end, the metadata graph may include a set of nodes interconnected by a set of edges, where the set of nodes are representative of asset catalog entries and the set of edges are representative of connections or relationships there-between. Further, each node may pertain to a given asset (e.g., any existing structured and/or unstructured form of information), where the representative asset catalog entry thereof may store metadata for, or information descriptive of, the given asset.

Examples of said asset metadata may include, but is not limited to: a brief description of the asset; stewardship (or ownership) information (e.g., individual or group name(s), contact information, etc.) pertaining to the steward(s)/owner(s) of the asset; a version character string reflective of a version or state of the asset at/for a given point-in-time; one or more categories, topics, and/or aspects associated with the asset; an asset identifier uniquely identifying the asset; one or more tags, keywords, or terms further describing the asset; a source identifier and/or location associated with an internal or external data source (see e.g., FIG. 1) where the asset resides or is maintained; and compliance information specifying laws, regulations, and standards surrounding the asset, as well as policies directed to data governance (e.g., availability, usability, integrity, and security) pertinent to the asset. The asset metadata for any asset is not limited to the aforementioned specific examples.

In Step 506, for each search topic of the search topic(s) (received via the search query in Step 500), the metadata graph (obtained in Step 504) is filtered based on the search topic. In one or many embodiment(s) disclosed herein, filtering of the metadata graph may, for example, entail topic matching (e.g., case-insensitive word or phrase matching) between a given search topic and the asset metadata for assets catalogued in the asset catalog entries of which nodes of the metadata graph are representative. Further, for each search topic, the filtering of the metadata graph based thereon may result in the identification of a node subset of the set of nodes forming the metadata graph. The identified node subset, subsequently, may include one or more nodes representative of one or more assets, respectively, that may be associated with the search topic.

In Step 508, a k-partite metadata graph is generated using the node subset(s) (identified in Step 506). In one or many embodiment(s) disclosed herein, the k-partite metadata graph (see e.g., FIGS. 2B-2D) may reflect a new representation of, which may be based on one or more particular perspectives on, the metadata graph (obtained in Step 504). The k-partite metadata graph, further, may reflect a connected graph that encompasses k independent sets of nodes (i.e., the node subset(s), where k equals the number or cardinality of node subset(s)) and a set of edges interconnecting (and thus defining relationships between) pairs of nodes each belonging to a different independent set of nodes (or node subset)—with the exception of uni-(k=1) partite metadata graphs (see e.g., FIG. 2B) where the set of edges interconnect nodes of the single independent set of nodes (or single node subset) forming the uni-partite metadata graphs.

In Step 510, one or more super nodes, in/of the k-partite metadata graph (generated in Step 508), is/are identified. In one or many embodiment(s) disclosed herein, a super node may refer to a densely connected node or a node with a disproportionately high number of edges connected thereto. Additionally, or alternatively, a super node may be identified as any node representing a most connected node (e.g., any node that serves as an endpoint of a pair of endpoints to a highest number of edges) in the k-partite metadata graph, which may otherwise be defined as any node that serves as an endpoint of a pair of endpoints to a number of edges, where the number of edges meets or exceeds a threshold number of edges (that may be dynamically set). For example, the threshold number of edges may be set to ten edges, where any node(s) in the k-partite metadata graph that serves as an endpoint (of a pair of endpoints) to at least ten edges may be classified or labeled as a super node in/of the k-partite metadata graph.

Optionally, one or more near-super nodes, in/of the k-partite metadata graph (generated in Step 508), is/are further identified. In one or many embodiment(s) disclosed herein, a near-super node may refer to any node that nearly satisfies, but still falls short, of the criterion/criteria for being classified or labeled as a super node. Additionally, or alternatively, a near-super node may be identified or defined as any node that serves as an endpoint of a pair of endpoints to a second number of edges, where the second number of edges lies below the above-mentioned threshold number of edges (i.e., serving as the criterion for identifying super nodes), however, meets or exceeds a second threshold number of edges (that may also be dynamically set). For example, the threshold number of edges may be set to ten edges and the second threshold number of edges may be set to seven edges, where any node(s) in the k-partite metadata graph that serves as an endpoint (of a pair of endpoints) to at least seven edges, but no more than nine edges, may be classified or labeled as a near-super node.

In Step 512, for each super node of the super node(s) (identified in Step 510), and/or for each near-super node of the near-super node(s) (optionally identified in Step 510), at least a portion of asset metadata, for an original asset (e.g., any existing structured and/or unstructured form of information) corresponding to the super node, and/or near-super node, is extracted. In one or many embodiment(s) disclosed herein, the extracted portion of asset metadata may include, but is not limited to, stewardship (or ownership) information and compliance information (both briefly defined above—see e.g., Step 504) associated with the original asset.

In one or many embodiment(s) disclosed herein, any identified super node(s) and/or near-super node(s) may represent asset metadata, describing one or more assets, that may exemplify returned query result(s) that is/are relevant to the search query (received in Step 500) or, more specifically, to the original search query token(s)/phrase(s) (i.e., search topic(s)) posed therein. Accordingly, said asset(s) is/are also referred to herein as original asset(s). Similarly, any access remarks, any availability remarks, and any search query result associated with any original asset(s) may also be referred to herein as original access remarks, original availability remarks, and an/the original search query result.

In Step 514, the user access permissions (obtained in Step 502), associated with the organization user, is assessed against the compliance information (extracted in Step 512) associated with one or more original assets. In one or many embodiment(s) disclosed herein, the original asset(s) may map to asset catalog entry/entries represented by the super node(s) (and/or, optionally, the near-super node(s)) (identified in Step 510).

Further, assessment of the user access permissions, against the asset compliance information, may, for example, entail determining: whether a geographical location of the organization user is within the geographical restrictions or boundaries, at least in part, defining access to an original asset; whether the organization, with which the organization user is associated, is of a particular type (e.g., a commercial business, an educational institution, etc.) to which access and usability of an original asset is granted; and whether one or more organization roles (e.g., title(s) and/or position(s)) and/or professional affiliation(s) (e.g., membership(s) to professional organization(s)), with which the organization user is associated, satisfies criteria for permitting access to an original asset.

Moreover, the above-mentioned assessment, between the user access permissions and the asset compliance information, may result in producing original access remarks that concern the original asset(s) associated with the extracted compliance information. In one or many embodiment(s) disclosed herein, any original access remarks may refer to information expressing whether the original asset(s) is/are accessible or inaccessible to/by the organization user. Said information (for any given original asset) may include, but is not limited to: an accessibility statement indicating that the given original asset can or cannot be accessed by the organization user; one or more reasons explaining or supporting the accessibility statement; a digital reference link (e.g., uniform resource locator or hyperlink) or an access protocol through which the organization user can access the given original asset should the accessibility statement indicate that the given original asset can be accessed by the organization user; and/or the stewardship information (extracted in Step 512) associated with the given original asset should the accessibility statement alternatively indicate that the given original asset cannot be accessed by the organization user.

In one or many embodiment(s) disclosed herein, stewardship information may be integrated, as part of the original access remarks for a given original asset (if applicable—e.g., if the given original asset is deemed inaccessible), in order to provide the organization user with an opportunity to potentially gain access to the given original asset through communications with the steward(s) or owner(s) of the given original asset. The potential to gain access to the given original asset through this avenue, however, may be moot or disregarded in view of other, higher-tiered compliance policies such as those outlined by geographical restrictions, as well as national and/or international laws, regulations, and standards.

In Step 516, an asset availability, for each of one or more original assets (e.g., any existing structured and/or unstructured form(s) of information), is determined. In one or many embodiment(s) disclosed herein, the original asset(s) may map to asset catalog entry/entries represented by the super node(s) (and/or, optionally, the near-super node(s)) (identified in Step 510). Further, the determination of asset availability for any given original asset may, for example, entail the submission of an asset availability query to an appropriate (i.e., internal or external) data source identified in the asset metadata describing the given original asset. Any asset availability query may include or specify an asset identifier (also found in the asset metadata) that uniquely identifies the given original asset. Moreover, in response to any asset availability query, a corresponding asset availability reply may be received, which may include or specify an asset availability state indicating whether the given original asset is available (e.g., obtainable, usable, or reachable) or unavailable (e.g., unobtainable, unusable, or unreachable). Thereafter, the returned asset availability state(s) for the original asset(s), respectively, may be used to produce original availability remarks concerning the original asset(s). Any original availability remarks may refer to information expressing whether the original asset(s) is/are available or unavailable at/on one or more data sources that the original asset(s) currently reside, or at one time, had resided.

Turning to FIG. 5B, in Step 518, an original search query result is created. In one or many embodiment(s) disclosed herein, the original search query result may include or specify a manifest of the original asset(s) mapped to asset catalog entry/entries represented by the super node(s) (and/or, optionally, the near-super node(s)) (identified in Step 510), the original access remarks (produced in Step 514), and the original availability remarks (produced in Step 516).

In Step 520, for each super node of the super node(s) (identified in Step 510), and/or for each near-super node of the near-super node(s) (optionally identified in Step 510), one or more strong adjacent nodes, which may be found in the k-partite metadata graph (generated in Step 508), is/are identified. In one or many embodiment(s) disclosed herein, with respect to a given super node (and/or, optionally, a given near-super node), a strong adjacent node linked to the given super node (and/or, optionally, the given near-super node) may refer to a node connected thereto via an edge representative of a strong relationship there-between. Quantification of said strong relationship may, for example, entail an edge weight assigned to the edge interconnecting the given super node (and/or, optionally, the given near-super node) and the strong adjacent node, where the edge weight (e.g., expressed as a numerical value) meets or exceeds an edge weight threshold. The edge weight threshold, in turn, may be dynamically set and may denote the criterion for determining whether the associated edge is reflective of a strong relationship between a pair of assets (e.g., pair of any existing structure or unstructured forms of information) corresponding to the given super node (and/or, optionally, the given near-super node) and a strong adjacent node.

In Step 522, for each strong adjacent node of the strong adjacent node(s) (identified in Step 520), at least a portion of asset metadata, for an better asset (e.g., any existing structured and/or unstructured form of information) corresponding to the strong adjacent node, is extracted. In one or many embodiment(s) disclosed herein, the extracted portion of asset metadata may include, but is not limited to, stewardship (or ownership) information and compliance information (both briefly defined above—see e.g., Step 504) associated with the better asset.

In one or many embodiment(s) disclosed herein, any identified strong adjacent node(s) may represent asset metadata, describing one or more assets, that better exemplify/exemplifies the search intent of the organization user. Accordingly, said asset(s) is/are also referred to herein as better asset(s). Similarly, any access remarks, any availability remarks, and any search query result associated with any better asset(s) may also be referred to herein as better access remarks, better availability remarks, and a/the better search query result.

Further, betterment of any said search intent may, for example, entail increasing a recall and/or a precision of the returned query result(s). By increasing recall, a larger set of relevant query result(s) may be returned, whereas a reduction in a number of irrelevant query result(s) being returned may take effect by increasing precision. Increased recall may be brought about through query expansion (e.g., broadening of the search query via the addition of one or more tokens/phrases related to the original search query token(s)/phrase(s) (i.e., search topic(s))) and/or through query relaxation (e.g., narrowing of the search query via the removal of one or more tokens/phrases unrelated to the original search query token(s)/phrase(s)). Meanwhile, increased precision may be brought about through query segmentation (e.g., division of the original search query token(s)/phrase(s) into semantic units also referred to as search query segments) and/or through query scoping (e.g., matching of each search query segment to an intended asset attribute). As disclosed herein, identification of any better asset(s), through the identification of any strong adjacent node(s), and through one or more existing graph techniques, may be equivalent to performing any combination of query expansion, query relaxation, query segmentation, and/or query scoping.

In Step 524, the user access permissions (obtained in Step 502), associated with the organization user, is assessed against the compliance information (extracted in Step 522) associated with one or more better assets. In one or many embodiment(s) disclosed herein, the better asset(s) may map to asset catalog entry/entries represented by the strong adjacent node(s) (identified in Step 520).

Further, assessment of the user access permissions, against the asset compliance information, may, for example, entail determining: whether a geographical location of the organization user is within the geographical restrictions or boundaries, at least in part, defining access to an better asset; whether the organization, with which the organization user is associated, is of a particular type (e.g., a commercial business, an educational institution, etc.) to which access and usability of an better asset is granted; and whether one or more organization roles (e.g., title(s) and/or position(s)) and/or professional affiliation(s) (e.g., membership(s) to professional organization(s)), with which the organization user is associated, satisfies criteria for permitting access to an better asset.

Moreover, the above-mentioned assessment, between the user access permissions and the asset compliance information, may result in producing better access remarks that concern the better asset(s) associated with the extracted compliance information. In one or many embodiment(s) disclosed herein, any better access remarks may refer to information expressing whether the better asset(s) is/are accessible or inaccessible to/by the organization user. Said information (for any given better asset) may include, but is not limited to: an accessibility statement indicating that the given better asset can or cannot be accessed by the organization user; one or more reasons explaining or supporting the accessibility statement; a digital reference link (e.g., uniform resource locator or hyperlink) or an access protocol through which the organization user can access the given better asset should the accessibility statement indicate that the given better asset can be accessed by the organization user; and/or the stewardship information (extracted in Step 522) associated with the given better asset should the accessibility statement alternatively indicate that the given better asset cannot be accessed by the organization user.

In one or many embodiment(s) disclosed herein, stewardship information may be integrated, as part of the better access remarks for a given better asset (if applicable—e.g., if the given better asset is deemed inaccessible), in order to provide the organization user with an opportunity to potentially gain access to the given better asset through communications with the steward(s) or owner(s) of the given better asset. The potential to gain access to the given better asset through this avenue, however, may be moot or disregarded in view of other, higher-tiered compliance policies such as those outlined by geographical restrictions, as well as national and/or international laws, regulations, and standards.

In Step 526, an asset availability, for each of one or more better assets (e.g., any existing structured and/or unstructured form(s) of information), is determined. In one or many embodiment(s) disclosed herein, the better asset(s) may map to asset catalog entry/entries represented by the strong adjacent node(s) (identified in Step 520). Further, the determination of asset availability for any given better asset may, for example, entail the submission of an asset availability query to an appropriate (i.e., internal or external) data source identified in the asset metadata describing the given better asset. Any asset availability query may include or specify an asset identifier (also found in the asset metadata) that uniquely identifies the given better asset. Moreover, in response to any asset availability query, a corresponding asset availability reply may be received, which may include or specify an asset availability state indicating whether the given better asset is available (e.g., obtainable, usable, or reachable) or unavailable (e.g., unobtainable, unusable, or unreachable). Thereafter, the returned asset availability state(s) for the better asset(s), respectively, may be used to produce better availability remarks concerning the better asset(s). Any better availability remarks may refer to information expressing whether the better asset(s) is/are available or unavailable at/on one or more data sources that the better asset(s) currently reside, or at one time, had resided.

Turning to FIG. 5C, in Step 528, a better search query result is created. In one or many embodiment(s) disclosed herein, the better search query result may include or specify a manifest of the better asset(s) mapped to asset catalog entry/entries represented by the strong adjacent node(s) (identified in Step 520), the better access remarks (produced in Step 524), and the better availability remarks (produced in Step 526).

In Step 530, a complete search query result is produced. In one or many embodiment(s) disclosed herein, the complete search query result may include or specify the original search query result (created in Step 518) and the better search query result (created in Step 528).

In Step 532, the complete search query result (produced in Step 530) is provided in response to the search query (received in Step 500). Particularly, in one or many embodiment(s) disclosed herein, the complete search query result may be provided to the organization user who had submitted the search query.

FIGS. 6A-6C show flowcharts describing a method for insight lineage tracking in accordance with one or more embodiments disclosed herein. The various steps outlined below may be performed by an insight service (see e.g., FIG. 1A). Further, while the various steps in the flowchart are presented and described sequentially, one of ordinary skill will appreciate that some or all steps may be executed in different orders, may be combined or omitted, and some or all steps may be executed in parallel.

Turning to FIG. 6A, in Step 600, an initiation of an insight editing program, by an organization user, is detected. In one or many embodiment(s) disclosed herein, the insight editing program may refer to any software application configured for insight (described below) creation and/or editing. Examples of the insight editing program may include, an artificial intelligence and/or machine learning based inference computer program, a text editor, a spreadsheet editor, a presentation editor, an integrated development environment (IDE), an audio editor, a video editor, and an image and/or graphic editor. The insight editing program is not limited to the aforementioned specific examples. Further, detection of the initiation of the insight editing program may, for example, involve the receiving of telemetry from one or more insight agents (see e.g., FIG. 1B) executing on a client device operated by the organization user, where the insight editing program also executes on the aforementioned client device. The insight agent(s), accordingly, may be embedded within, or may otherwise be associated with, the insight editing program.

In one or many embodiment(s) disclosed herein, an insight may be defined as a finding (or more broadly, as useful knowledge) gained through data analytics or, more precisely, through the discovery of patterns and/or relationships amongst any given assortment of data/information. Moreover, an insight may take form through any existing data/information format—examples of which may include tabular data (e.g., a dataset), text, a data graphic (e.g., a chart) visualizing tabular data, an image, an audio track, and a video clip. The form (or format) of any insight is not limited to the aforementioned specific examples.

In Step 602, an insight catalog is obtained. In one or many embodiment(s) disclosed herein, the insight catalog may represent a data structure configured to maintain insight component metadata that describes one or more creation aspects (also referred to herein as insight component(s)) pertaining to a set of existing insights. Each existing insight, in the set of existing insights, may refer to an insight of which a respective insight creation process has already begun either by an organization user (e.g., the same or a different organization user as the organization user whom initiated the insight editing program detected in Step 600) or the insight service. Further, the insight catalog may include, and may thus be organized through, a set of insight records, where each insight record corresponds to a given existing insight in the set of existing insights. Each insight record, moreover, may include (individual) insight metadata (described below) and a set of insight component records, where each insight component record: corresponds to a given insight component, in a set of insight components, associated with a given existing insight to which the insight record corresponds; and stores (individual) insight component metadata (described below) particular to the given insight component to which the insight component record corresponds.

In one or many embodiment(s) disclosed herein, any insight component, associated with any given insight, may reference an object that contributed to the creation of the given insight. Examples of any object that may be referenced by any insight component, associated with any given insight, may include: any structured or unstructured form of information (e.g., tabular data or a dataset, text, a data graphic visualizing tabular data, an image, an audio track, a video clip, etc.); any information processing algorithm (e.g., a machine learning model, a dataset editing algorithm, a text editing algorithm, an image editing algorithm, an audio editing algorithm, a video editing algorithm, etc.) configured to process one or more forms of information; and any other insight (i.e., that is not the given insight with which the insight component is originally associated). Further, any insight component is not limited to the aforementioned specific examples.

Examples of (individual) insight component metadata, respective to any given insight component, may include: a program name associated with any insight editing program within which a creation, importation, editing, and/or processing of an object (described and exemplified above) referenced by the given insight component may be enabled/facilitated; a filename associated with an insight editing file within which the object referenced by the given insight component had been (or is being) created, imported, edited, and/or processed; the object (or a storage location thereof) to which the given insight component references; author(s) who created or embedded the given insight within another asset (e.g., a document, a presentation, a talk, a video, a meeting transcript, meeting notes, etc.,), which allows for the re-ingestion of the given asset into the asset catalog with references to the original insight(s) or asset(s) as to help not bias the data and models on which the insight service relies to derive or infer insights (including the given insight), where the context of the use of the asset(s) or insight(s) are calculated to verify and construct additional relationships to other nodes or even the creation of other nodes; data that was used to create any asset or any insight; any data as well as any machine learning and/or AI models that were used to generate knowledge from said data; and context that was created or determined from how asset(s) and insight(s) are used. Furthermore, the (individual) insight component metadata, respective to any given insight component, is not limited to the aforementioned specific examples.

Examples of (individual) insight metadata, respective to any given insight, may include: a storage location at which the given insight may be stored; at least a portion of any available insight editing file metadata (e.g., author, creation timestamp, last modified timestamp, etc.) describing the insight editing file within which the given insight had been (or is being) created and/or edited; an insight lineage graph (described below) (or a storage location thereof) associated with the given insight; context in how the given insight was used such as via talks, meetings, papers, etc.; how many times the given insight is re-used (e.g., a count of re-uses of the given insight in a same context, and/or a count of re-uses of the given insight in a different context); how the given insight is being displayed (e.g., via a type of chart, text, images, etc.) to help with understanding the context, which may serve to not bias the data and/or inference models that the insight service relies on to generate insights. Further, the (individual) insight metadata, respective to any given insight, is not limited to the aforementioned specific examples.

In Step 604, a program name is obtained. In one or many embodiment(s) disclosed herein, the program name may be associated with insight editing program, which had been initiated by the organization user (as detected in Step 600).

In Step 606, engagement (or interaction) with the insight editing program is monitored. In one or many embodiment(s) disclosed herein, said engagement/interaction may be performed by the organization user whom initiated the insight editing program (detected in Step 600) and may refer to any number of engagement actions through which the organization user engages/interacts with, or employs one or more features of, the insight editing program. Examples of said engagement actions may include, but are not limited to, terminating the insight editing program, creating a new insight editing file, and editing an existing insight editing file. The organization user may interact with the insight editing program through other engagement actions not explicitly described hereinafter without departing from the scope disclosed herein.

In Step 608, based on the insight editing program engagement (monitored in Step 606), a determination is made as to whether any engagement action reflects a terminating of the insight editing program. The organization user may terminate the insight editing program by, for example, closing a user interface for, associated with, or representative of the insight editing program. As such, in one or many embodiment(s) disclosed herein, if it is determined that any engagement action terminates the insight editing program, then the method ends. On the other hand, in one or many other embodiment(s) disclosed herein, if it is alternatively determined that any engagement action does not terminate the insight editing program, then the method alternatively proceeds to Step 610.

In Step 610, following the determination (made in Step 608) that any engagement action, based on the insight editing program engagement (monitored in Step 606), does not terminate the insight editing program, a determination is made as to whether said any engagement action reflects a creating of a new insight editing file. As such, in one or many embodiment(s) disclosed herein, if it is determined that any engagement action creates a new insight editing file, then the method proceeds to Step 612 (see e.g., FIG. 6B). On the other hand, in one or many other embodiment(s) disclosed herein, if it is alternatively determined that any engagement action does not create a new insight editing file (but rather reflects an editing of an existing insight editing file), then the method alternatively proceeds to Step 626 (see e.g., FIG. 6C).

Turning to FIG. 6B, in Step 612, following the determination (made in Step 610) that any engagement action, based on the insight editing program engagement (monitored in Step 606), creates a new insight editing file, a filename is obtained. In one or many embodiment(s) disclosed herein, the filename may be associated with the newly created insight editing file, which may be provided by the organization user.

In Step 614, a new insight lineage graph is generated. In one or many embodiment(s) disclosed herein, an insight lineage graph may refer to a connected graph (see e.g., FIG. 2A) representative of insight record (or, more specifically, of a set of insight component records thereof). To that end, an insight lineage graph may include a set of nodes interconnected by a set of edges, where the set of nodes are representative of (and thus map/correspond to) the set of insight component records (described above—see e.g., Step 602) and the set of edges are representative of connections or relationships there-between. Further, each node may pertain to a given object (described/exemplified above—see e.g., Step 602) referenced by a given insight component of the insight, where the representative insight component record thereof may store insight component metadata for, or information descriptive of, the given insight component and/or the referenced given object.

In one or many embodiment(s) disclosed herein, an insight lineage graph, for any given insight, may visually convey the dependencies amongst a set of objects that contributed towards the creation and/or editing of said given insight. For an example insight lineage graph, as well as a construction thereof based on a set of objects and their respective dependencies, refer to the example scenario illustrated and described with respect to FIGS. 24A-24C, below.

In one or many embodiment(s) disclosed herein, the new insight lineage graph (generated in Step 614), however, may reflect a null graph. A null graph may generally refer to an empty graph space that includes zero nodes and zero edges. Once the empty graph space is amended to include, or is occupied with, at least one node, the (new) insight lineage graph may transition from a null graph to a non-null graph. A non-null graph, in contrast to a null graph, may generally refer to a non-empty graph space that includes at least one node. One or more edges may only begin to be included, or otherwise occupy, a non-null graph once two or more nodes are also present for the edge(s) to interconnect. Further, following generation of the new insight lineage graph, the new insight lineage graph may be mapped to the filename (obtained in Step 612).

In Step 616, a new insight record is created for an insight of which an insight creation process, respective thereto, has yet to begin. In one or many embodiment(s) disclosed herein, the new insight record may be maintained in the insight catalog (obtained in Step 602) and may, for example, initially specify or include the new insight lineage graph (generated in Step 614) (or a storage location thereof).

In Step 618, engagement (or interaction) with the new insight editing file (created via the determination made in Step 610) is monitored. In one or many embodiment(s) disclosed herein, said engagement/interaction may be performed by the organization user whom initiated the insight editing program (detected in Step 600) and may refer to any number of insight creation actions through which the organization user engages/interacts with, or employs one or more features of, the new insight editing file. Examples of said insight creation actions may include, but are not limited to, manually entering or composing one or more items of data/information within the new insight editing file; applying one or more information processing algorithms (described above—see e.g., Step 602), within the new insight editing file, to at least one item of data/information, thereby resulting in the production of one or more processed items of data/information (which may or may not include the insight); and importing, into the new insight editing file, one or more other (existing) insights. The organization user may interact with the new insight editing file through other insight creation actions not explicitly described herein without departing from the scope disclosed herein.

In Step 620, for any given insight creation action (identified in Step 618) based on the new insight editing file engagement (monitored also in Step 618), one or more new insight component records is/are created. In one or many embodiment(s) disclosed herein, the new insight component record(s) may be maintained in the new insight record (created in Step 616) and may pertain to an insight component (described above—see e.g., Step 602) involved in the given insight creation action.

For example, if the given insight creation action reflects a manual entering or composing of an item of data/information, the involved insight component(s) may include a sole insight component referencing the manually entered/composed item of data/information. By way of another example, if the given insight creation action reflects an applying of an information processing algorithm to at least one item of data/information, which results in a producing of at least one processed item of data/information, the involved insight component(s) may include a first insight component referencing the information processing algorithm and at least one second insight component referencing the at least one processed item of data/information, respectively. By way of yet another example, if the given insight creation action reflects an importing of another (existing) insight, the involved insight component(s) may include a set of insight components associated with the other (existing) insight, where each insight component, in the set of insight components, may reference a manually entered/composed item of data/information, an information processing algorithm, or yet another (existing) insight.

In one or more embodiment(s) disclosed herein, creation of the new insight component record(s), for any given insight creation action (identified in Step 618) based on the new insight editing file engagement (monitored also in Step 618), may entail different procedures depending on the given insight creation action.

For example, if the given insight creation action reflects a manual entering or composing of an item of data/information, a single, new insight component record may be created. In such an example, the single, new insight component record may map/correspond to the insight component referencing the manually entered/composed item of data/information and, accordingly, may specify or include insight component metadata describing the insight component (or, more specifically, the object (i.e., the manually entered/composed item of data/information) to which the insight component references). Examples of (individual) insight component metadata, which may be specified/included in the single, new insight component record, may be disclosed above with respect to Step 602.

By way of another example, if the given insight creation action reflects an applying of an information processing algorithm to at least one item of data/information, which results in a producing of at least one processed item of data/information, at least two new insight component records may be created. In such an example, a first new insight component record (of the at least two new insight component records) may map/correspond to a first insight component referencing the information processing algorithm and, accordingly, may specify or include (individual) insight component metadata describing the first insight component (or, more specifically, the object (i.e., the information processing algorithm) to which the insight component references). Further, each remaining (e.g., second, third, fourth, etc.) new insight component record (of the at least two new insight component records) may map/correspond to a given remaining (e.g., second, third, fourth, etc.) insight component referencing a given processed item of data/information (of the at least one processed item of data/information) and, accordingly, may specify or include (individual) insight component metadata describing the given remaining insight component (or, more specifically, the object (i.e., the given processed item of data/information) to which the given remaining insight component references). Examples of (individual) insight component metadata, which may be specified/included in each of the at least two new insight component records, may be disclosed above with respect to Step 602.

By way of yet another example, if the given insight creation action reflects an importing of another (existing) insight, a set of new insight component records may be created. In such an example, the set of new insight component records may refer to copies of a set of existing insight component records associated with the other (existing) insight. Creation of the set of new insight component records, accordingly, may entail: identifying an (existing) insight record, maintained in the insight catalog (obtained in Step 602), that maps/corresponds to the other (existing) insight; identifying the set of existing insight component records maintained in the identified (existing) insight record; and copying/appending the identified set of existing insight component records into/to the new insight record (created in Step 616). Each existing insight component record, in the set of existing insight component records, may map/correspond to an insight component that references an object (e.g., a manually entered/composed item of data/information, an information processing algorithm, or yet another (existing) insight) that contributed to the creation of the other (existing) insight and, via the given insight creation action reflecting an importing thereof, now also contributes to the creation of the new insight being created. Further, each existing insight component record, in the set of existing insight component records, may specify or include (individual) insight component metadata describing a respective given insight component (or, more specifically, the object (i.e., a manually entered/composed item of data/information, an information processing algorithm, or yet another (existing) insight) to which the respective given insight component references). Examples of (individual) insight component metadata, which may be specified/included in each of existing insight component record (in the set of existing insight component records), may be disclosed above with respect to Step 602.

In Step 622, for each new insight component record, of the new insight component record(s) (created in Step 620), a new node is created. In one or many embodiment(s) disclosed herein, the new node may refer to a non-null graph (described above—see e.g., Step 614) element that, at least in part, forms the non-null graph (e.g., an insight lineage graph including at least one node). Further, following creation of the new node for each new insight component record, the respective new insight component record may be mapped to the new node.

In Step 624, the new insight lineage graph (generated in Step 614) is amended or updated using the new node(s) (created in Step 622). In one or many embodiment(s) disclosed herein, said amending/updating of the new insight lineage graph may at least entail insertion of the new node(s) into the empty graph space defining a null graph of which the new insight lineage graph had been reflective. In one or many other embodiment(s) disclosed herein, if a cardinality or number of the new nodes exceeds one, then said amending/updating of the new insight lineage graph may further entail insertion of one or more directed edges. Each directed edge may refer to an edge that connects a pair of new nodes and, also, specifies a direction from one new node (of the pair of new nodes) to another new node (of the pair of new nodes). For said pair of new nodes connected by a given directed edge, the given directed edge may visually convey a dependency (e.g., applied to, results in, etc.) one of the new nodes (of the pair of new nodes) has on the other of the new nodes (of the pair of new nodes).

From Step 624, the method proceeds to Step 606, where further engagement, by the organization user and with the insight editing program, is monitored.

Turning to FIG. 6C, in Step 626, following the alternative determination (made in Step 610) that any engagement action, based on the insight editing program engagement (monitored in Step 606), edits an existing insight editing file, a filename is obtained. In one or many embodiment(s) disclosed herein, the filename may be associated with the existing insight editing file, which may be provided by the organization user.

In Step 628, an existing insight lineage graph is obtained. In one or many embodiment(s) disclosed herein, an insight lineage graph may refer to a connected graph (see e.g., FIG. 2A) representative of insight record (or, more specifically, of a set of insight component records thereof). To that end, an insight lineage graph may include a set of nodes interconnected by a set of edges, where the set of nodes are representative of (and thus map/correspond to) the set of insight component records (described above—see e.g., Step 602) and the set of edges are representative of connections or relationships there-between. Further, each node may pertain to a given object (described/exemplified above—see e.g., Step 602) referenced by a given insight component of the insight, where the representative insight component record thereof may store insight component metadata for, or information descriptive of, the given insight component and/or the referenced given object.

In one or many embodiment(s) disclosed herein, an insight lineage graph, for any given insight, may visually convey the dependencies amongst a set of objects that contributed towards the creation and/or editing of said given insight. For an example insight lineage graph, as well as a construction thereof based on a set of objects and their respective dependencies, refer to the example scenario illustrated and described with respect to FIGS. 24A-24C, below.

In one or many embodiment(s) disclosed herein, the existing insight lineage graph (obtained in Step 628) may reflect a null graph or a non-null graph depending on a current creation progression of an insight that had been (or is being) created and/or edited. A null graph may generally refer to an empty graph space that includes zero nodes and zero edges. Once the empty graph space is amended to include, or is occupied with, at least one node, the (new) insight lineage graph may transition from a null graph to a non-null graph. A non-null graph, in contrast to a null graph, may generally refer to a non-empty graph space that includes at least one node. One or more edges may only begin to be included, or otherwise occupy, a non-null graph once two or more nodes are also present for the edge(s) to interconnect. Further, the existing insight lineage graph may be obtained through a mapping therefrom to the filename (obtained in Step 626).

In Step 630, an existing insight record is identified for an (existing) insight of which an insight creation process, respective thereto, has begun and is ongoing (or has completed and is currently being adjusted). In one or many embodiment(s) disclosed herein, the existing insight record may be maintained in the insight catalog (obtained in Step 602).

In Step 632, engagement (or interaction) with the existing insight editing file (edited via the determination made in Step 610) is monitored. In one or many embodiment(s) disclosed herein, said engagement/interaction may be performed by the organization user whom initiated the insight editing program (detected in Step 600) and may refer to any number of insight creation actions through which the organization user engages/interacts with, or employs one or more features of, the existing insight editing file. Examples of said insight creation actions may include, but are not limited to, manually entering or composing one or more items of data/information within the existing insight editing file; applying one or more information processing algorithms (described above—see e.g., Step 602), within the existing insight editing file, to at least one item of data/information, thereby resulting in the production of one or more processed items of data/information (which may or may not include the insight); and importing, into the existing insight editing file, one or more other (existing) insights. The organization user may interact with the existing insight editing file through other insight creation actions not explicitly described herein without departing from the scope disclosed herein.

In Step 634, for any given insight creation action (identified in Step 632) based on the existing insight editing file engagement (monitored also in Step 632), one or more new insight component records is/are created and/or one or more existing insight component records is/are edited. In one or many embodiment(s) disclosed herein, the new and/or existing insight component record(s) may be maintained in the existing insight record (identified in Step 630) and may pertain to an insight component (described above—see e.g., Step 602) involved in the given insight creation action.

For example, if the given insight creation action reflects a manual entering or composing of an item of data/information, the involved insight component(s) may include a sole insight component referencing the manually entered/composed item of data/information. By way of another example, if the given insight creation action reflects an applying of an information processing algorithm to at least one item of data/information, which results in a producing of at least one processed item of data/information, the involved insight component(s) may include a first insight component referencing the information processing algorithm and at least one second insight component referencing the at least one processed item of data/information, respectively. By way of yet another example, if the given insight creation action reflects an importing of another (existing) insight, the involved insight component(s) may include a set of insight components associated with the other (existing) insight, where each insight component, in the set of insight components, may reference a manually entered/composed item of data/information, an information processing algorithm, or yet another (existing) insight.

In one or more embodiment(s) disclosed herein, creation of any new insight component record(s), for any given insight creation action (identified in Step 632) based on the existing insight editing file engagement (monitored also in Step 632), may entail different procedures depending on the given insight creation action.

For example, if the given insight creation action reflects a manual entering or composing of an item of data/information, a single, new insight component record may be created. In such an example, the single, new insight component record may map/correspond to the insight component referencing the manually entered/composed item of data/information and, accordingly, may specify or include insight component metadata describing the insight component (or, more specifically, the object (i.e., the manually entered/composed item of data/information) to which the insight component references). Examples of (individual) insight component metadata, which may be specified/included in the single, new insight component record, may be disclosed above with respect to Step 602.

By way of another example, if the given insight creation action reflects an applying of an information processing algorithm to at least one item of data/information, which results in a producing of at least one processed item of data/information, at least two new insight component records may be created. In such an example, a first new insight component record (of the at least two new insight component records) may map/correspond to a first insight component referencing the information processing algorithm and, accordingly, may specify or include (individual) insight component metadata describing the first insight component (or, more specifically, the object (i.e., the information processing algorithm) to which the insight component references). Further, each remaining (e.g., second, third, fourth, etc.) new insight component record (of the at least two new insight component records) may map/correspond to a given remaining (e.g., second, third, fourth, etc.) insight component referencing a given processed item of data/information (of the at least one processed item of data/information) and, accordingly, may specify or include (individual) insight component metadata describing the given remaining insight component (or, more specifically, the object (i.e., the given processed item of data/information) to which the given remaining insight component references). Examples of (individual) insight component metadata, which may be specified/included in each of the at least two new insight component records, may be disclosed above with respect to Step 602.

By way of yet another example, if the given insight creation action reflects an importing of another (existing) insight, a set of new insight component records may be created. In such an example, the set of new insight component records may refer to copies of a set of existing insight component records associated with the other (existing) insight. Creation of the set of new insight component records, accordingly, may entail: identifying another (existing) insight record, maintained in the insight catalog (obtained in Step 602), that maps/corresponds to the other (existing) insight; identifying the set of existing insight component records maintained in the identified other (existing) insight record; and copying/appending the identified set of existing insight component records into/to the existing insight record (identified in Step 630). Each existing insight component record, in the set of existing insight component records, may map/correspond to an insight component that references an object (e.g., a manually entered/composed item of data/information, an information processing algorithm, or yet another (existing) insight) that contributed to the creation of the other (existing) insight and, via the given insight creation action reflecting an importing thereof, now also contributes to the creation of the existing insight being edited. Further, each existing insight component record, in the set of existing insight component records, may specify or include (individual) insight component metadata describing a respective given insight component (or, more specifically, the object (i.e., a manually entered/composed item of data/information, an information processing algorithm, or yet another (existing) insight) to which the respective given insight component references). Examples of (individual) insight component metadata, which may be specified/included in each of existing insight component record (in the set of existing insight component records), may be disclosed above with respect to Step 602.

In Step 636, for each new insight component record, of any new insight component record(s) (created in Step 634), a new node is created. In one or many embodiment(s) disclosed herein, the new node may refer to a non-null graph (described above—see e.g., Step 628) element that, at least in part, forms the non-null graph (e.g., an insight lineage graph including at least one node). Further, following creation of the new node for each new insight component record, the respective new insight component record may be mapped to the new node.

In Step 638, the existing insight lineage graph (identified in Step 628) is amended or updated using the new node(s) (created in Step 636). In one or many embodiment(s) disclosed herein, said amending/updating of the existing insight lineage graph may at least entail insertion of the new node(s) into the empty graph space defining a null graph, or the non-empty graph space defining a non-null graph, of which the existing insight lineage graph had been reflective. In one or many other embodiment(s) disclosed herein, if the existing insight lineage graph reflects a null graph and a cardinality or number of the new nodes exceeds one, then said amending/updating of the existing insight lineage graph may further entail insertion of one or more directed edges. In one or many other embodiment(s) disclosed herein, if the existing insight lineage graph alternatively reflects a non-null graph and a cardinality or number of the new nodes exceeds zero, then said amending/updating of the existing insight lineage graph may or may not further entail insertion of one or more directed edges based on the relationship(s) (e.g., dependency/dependencies) between the inserted new node(s). Each directed edge may refer to an edge that connects a pair of new nodes and, also, specifies a direction from one new node (of the pair of new nodes) to another new node (of the pair of new nodes). For said pair of new nodes connected by a given directed edge, the given directed edge may visually convey a dependency (e.g., applied to, results in, etc.) one of the new nodes (of the pair of new nodes) has on the other of the new nodes (of the pair of new nodes).

From Step 638, the method proceeds to Step 606, where further engagement, by the organization user and with the insight editing program, is monitored.

FIGS. 7A-7H show flowcharts describing a method for metadata-based feature expansion for automated machine learning processes in accordance with one or more embodiments disclosed herein. The various steps outlined below may be performed by an insight service (see e.g., FIG. 1). Further, while the various steps in the flowchart are presented and described sequentially, one of ordinary skill will appreciate that some or all steps may be executed in different orders, may be combined or omitted, and some or all steps may be executed in parallel.

Turning to FIG. 7A, in Step 700, a feature query is received. In one or many embodiment(s) disclosed herein, the feature query may include or specify a set of features and a machine learning (ML) job result. Optionally, the feature query may further include or specify one or more labels and/or a record identifier (ID). Each of these feature query enclosures is described below. Further, the feature query may have been submitted by an organization user. As such, the feature query may represent an inquiry, by the organization user, with regards to the selection or suggestion of one or more supplemental features, which should (however may or may not) enhance a performance of one or more ML models (described below) being evaluated by the organization user.

In one or many embodiment(s) disclosed herein, the set of features may refer to a collection of one or more features. Each feature may represent an independent facet (e.g., a property, a factor, or a variable) reflected in the input data to one or more ML models, where each feature, further, may be considered pertinent to obtaining or identifying an accurate prediction output, classification output, or other form of data analysis output (depending on the architecture of the ML model) that typically results from the processing of said input data by the ML model(s). Any ML model, in turn, may generally refer to an analytical model (i.e., representing a real-world process for addressing a real-world problem) through which ‘learning’ transpires by way of data being leveraged to improve the performance of one or more tasks. Moreover, an architecture (e.g., including optimized parameters and hyper-parameters) of any ML model may derive from the ML algorithm (described below) on which the ML model is based. Accordingly, a ML algorithm may be perceived as a default template of a learning process attempting to perform a set of tasks, whereas the ML model represents a trained, tested, and/or otherwise, optimized, version of the ML algorithm on which the ML model is based.

In one or many embodiment(s) disclosed herein, an entirety of the set of features may reflect original feature(s) considered or selected by the organization user. In such embodiment(s), the received feature query may represent an original feature query directed to one or more new ML models being evaluated by the organization user. Alternatively, in one or many other embodiment(s) disclosed herein, a subset of the set of features may reflect original feature(s) considered or selected by the organization user, while a remaining subset of the set of features may reflect supplemental feature(s) previously selected or suggested by the insight service. Further, in the(se) other embodiment(s), the received feature query may represent a successive feature query directed to one or more existing ML models being re-evaluated by the organization user.

In one or many embodiment(s) disclosed herein, the ML job result may refer to a collection of information provided by an automated ML service following processing thereby of a submitted ML job (usually by the organization user). The automated ML service may refer to a third-party service directed to automating the selection, composition, and parameterization of ML models. That is, more simply, the automated ML service may automatically identify one or more optimal machine learning algorithms from which one or more ML models may be constructed and fit to a submitted dataset in order to best achieve any given set of tasks. A ML job may generally refer to a request to perform a desired functionality of the automated ML service, the desired functionality being, for example, producing the ML job result based on one or more input arguments submitted thereto and enclosed with the ML job. The ML job result, meanwhile, may at least include: a list of ML algorithms; and one or more sets of performance scores.

In one or many embodiment(s) disclosed herein, the list of ML algorithms may refer to any number of ML algorithms, at the disposal of the automated ML service, from which one or more of said algorithms may be identified, through training and validation, as a best-fit to the argument(s) (e.g., an input matrix and a label vector (described below)) defining a given submitted ML job. Each listed ML algorithm may be designated as either a considered ML algorithm or a discarded ML algorithm in view of the given submitted ML job. A considered ML algorithm may refer to a ML algorithm that can be applied (or can execute) given the argument(s) of the given submitted ML job, whereas a discarded ML algorithm may alternatively refer to a ML algorithm that cannot be applied (or cannot execute) given the argument(s) of the given submitted ML job. Lastly, any ML algorithm may generally refer to an artificial intelligence driven procedure employed to discern patterns with data and, subsequently, learn from said data. Examples of a ML algorithm may include, but are not limited to: regression (e.g., linear, logistic, etc.); neural networks (e.g., recurrent, convoluted, etc.); decision trees or random forests; support vector machines; k-means or kNN clustering; Markov decision processes; Naïve Bayes classifiers; classification and regression trees (CART); Apriori analyzers; principal component analysis (PCA); and ensemble classifiers (e.g., bagging, boosting, stacking, etc.). Moreover, any ML algorithm is not limited to the aforementioned specific examples.

In one or many embodiment(s) disclosed herein, a performance score (or metric) may refer to a measurement for evaluating ML model performance. Any given performance score may measure performance relatable to the form of data analysis (e.g., regression, classification, ranking, computer vision, natural language processing, deep learning, etc.) being performed by the given ML model being evaluated. Further, a performance score may be used throughout training and/or testing phase(s) of the building of a given ML model in order to guide a betterment of the given ML model in the achievement of its assigned task(s). Examples of a performance score may include, but are not limited to: for classification data analysis—accuracy, precision, recall, F1-score, sensitivity, specificity, receiver operating characteristic (ROC) curve, area under the curve (AUC), etc.; for regression data analysis—mean squared error (MSE), mean absolute error (MAE), inlier ratio, root mean squared error (RMSE), R² (R-squared coefficient), etc.; for ranking data analysis—mean reciprocal rank (MRR), mean average precision (MAP), hit ratio, normalized discounted cumulative gain (NDCG), etc.; for computer vision data analysis—peak noise-to-signal ratio (PSNR), structured similarity indexing method (SSIM), feature similarity indexing method (FSIM), etc.; for natural language processing data analysis—perplexity, bilingual evaluation understudy (BLEU) score, etc.; and for deep learning data analysis—inception score, Frechet inception distance, etc. Further, a performance is not limited to the aforementioned specific examples.

In one or many embodiment(s) disclosed herein, and by way of an example, the process through which the automated ML service may produce a given ML job result from a given ML job may include, but is not limited to: (a) receiving the given ML job at least specifying an input matrix and a label vector, where the input matrix represents a S×F dataset (S for samples and F for features) that specifies the input data for ML model training and testing purposes, and where the label vector represents a 1×S (S for samples) array that specifies a desired/target output (e.g., continuous/numerical or categorical) for each data sample reflected in the input matrix; (b) selecting one or more ML algorithms (i.e., considered ML algorithm(s) (described above)) (from a pool of available ML algorithms) that can handle the input matrix as input(s) and, subsequently, can produce output(s) that can be assessed against the label vector; (c) building one or more ML models based, respectively, on the one or more selected ML algorithms; (d) training the one or more built ML models, using at least a portion of the input matrix and a corresponding at least portion of the label vector, to obtain one or more trained ML models; (e) testing the one or more trained ML models, using at least a remaining portion of the input matrix and a corresponding remaining portion of the label vector, to obtain one or more tested ML models and a set of performance scores quantifying a performance of each tested ML model; and (f) producing the given ML job result to at least include a list of ML algorithms specifying the selected (i.e., considered) ML algorithm(s) and non-selected (i.e., discarded) ML algorithm(s), reason(s) explaining the selection and/or non-selection of certain ML algorithm(s), and one or more sets of performance scores respectively for the one or more tested ML models. The above-described process, undertaken by the automated ML service, is only for explanatory purposes only and not intended to limit the scope disclosed herein.

In one or many embodiment(s) disclosed herein, a label (if any had been received) may refer to a desired or target output, respective to a given data sample of a dataset, to which an output of any given ML model should strive to match. Further, a nature or data type of any given label may be contingent on the form of data analysis being performed by the given ML model. For example, a label for a regression driven ML model may be reflective of a numerical value or a range of numerical values. By way of another example, a label for a classification driven ML model may be reflective of a categorical (e.g., text) value. Moreover, a label is not limited to the aforementioned specific examples.

In one or many embodiment(s) disclosed herein, the record ID (if any had been received) may refer to a character string that uniquely identifies a given query record (described below). Said character string may be of any arbitrary size/length and may be expressed, for example, as a concatenation of one or more of any subset or all of the character types: an alphabetic letter, a whole number, and a non-alphanumeric symbol.

In Step 702, a user profile is obtained. In one or many embodiment(s) disclosed herein, the user profile may pertain to the organization user (from which the feature query had been received in Step 700). The user profile may refer to a collection of settings and information associated with the organization user. As such, the user profile may include, but is not limited to, user access permissions.

In one or many embodiment(s) disclosed herein, the user access permissions may reflect the level of authorization granted to the organization user for accessing specific resources. The granted level of authorization, for any given organization user, may, for example, be contingent on any number of factors, which may include, but is/are not limited to: one or more user organization roles (e.g., title(s) and/or position(s)) within an organization that may be associated with the given organization user; one or more organization responsibilities (e.g., assigned project(s) or task(s)) within an organization that may be associated with the given organization user; a client device (and the security hygiene or characteristics thereof) operated by the given organization user; and a geographical location where the given organization user may be physically situated. The factor(s) affecting the user access permissions for any given organization user is/are not limited to the aforementioned specific examples.

In Step 704, a determination is made as to whether a record ID had been received via the feature query (in Step 700). In one or many embodiment(s) disclosed herein, if it is determined that the feature query excluded a record ID, then the method proceeds to Step 706. On the other hand, in one or many other embodiment(s) disclosed herein, if it is alternatively determined that the feature query included a record ID, then the method alternatively proceeds to Step 762 (see e.g., FIG. 7E).

In Step 706, following the determination (made in Step 704) that a record ID had not been received via the feature query (in Step 700), a metadata graph is obtained. In one or many embodiment(s) disclosed herein, the metadata graph may refer to a connected graph (see e.g., FIG. 2A) representative of an asset catalog. To that end, the metadata graph may include a set of nodes interconnected by a set of edges, where the set of nodes are representative of asset catalog entries and the set of edges are representative of connections or relationships there-between. Further, each node may pertain to a given asset (e.g., any dataset or other structured/tabular form of information), where the representative asset catalog entry thereof may store metadata for, or information descriptive of, the given asset.

Examples of said asset metadata may include, but is not limited to: a brief description of the asset; stewardship (or ownership) information (e.g., individual or group name(s), contact information, etc.) pertaining to the steward(s)/owner(s) of the asset; a version character string reflective of a version or state of the asset at/for a given point-in-time; one or more categories, topics, and/or aspects associated with the asset; an asset identifier uniquely identifying the asset; one or more tags, keywords, or terms further describing the asset; a source identifier and/or location associated with an internal or external data source (see e.g., FIG. 1) where the asset resides or is maintained; and compliance information specifying laws, regulations, and standards surrounding the asset, as well as policies directed to data governance (e.g., availability, usability, integrity, and security) pertinent to the asset. The asset metadata for any asset is not limited to the aforementioned specific examples.

In one or many embodiment(s) disclosed herein, the asset metadata may reflect other information especially descriptive of any given asset being of the form of a dataset (or any other structured/tabular form of information). Examples of said dataset-specific asset metadata may include, but is not limited to: a set of dataset features (e.g., properties, factors, or variables) reflected in the given dataset; a set of dataset labels (e.g., desired/target outputs) mapped to samples of the given dataset; and one or more dataset ML algorithms that can be appropriately applied to (or that is configured to appropriately consume) the given dataset. Further, said dataset-specific asset metadata is not limited to the aforementioned specific examples.

In Step 708, for each feature in the feature(s) (received via the feature query in Step 700), the metadata graph (obtained in Step 706) is filtered based on the feature. In one or many embodiment(s) disclosed herein, filtering of the metadata graph may, for example, entail topic matching (e.g., case-insensitive word or phrase matching) and/or semantic similarity calculation between the feature and the asset metadata (e.g., the dataset feature(s)) for assets catalogued in the asset catalog entries of which nodes of the metadata graph are representative. Further, for each feature, filtering of the metadata graph based thereon may result in the identification of a node subset of the set of nodes forming the metadata graph. The identified node subset, subsequently, may include one or more nodes representative of one or more assets, respectively, that may be associated with the feature.

Additionally, or optionally, for each label of the labels(s) (if any) (received via the feature query in Step 700), the metadata graph (obtained in Step 706) is filtered based on the label. In one or many embodiment(s) disclosed herein, filtering of the metadata graph may, for example, entail topic matching (e.g., case-insensitive word or phrase matching) and/or semantic similarity calculation between the label and the asset metadata (e.g., the dataset label(s)) for assets catalogued in the asset catalog entries of which nodes of the metadata graph are representative. Further, for each label, the filtering of the metadata graph based thereon may result in the identification of a node subset of the set of nodes forming the metadata graph. The identified node subset, subsequently, may include one or more nodes representative of one or more assets, respectively, that may be associated with the label.

Additionally, or optionally, for each ML algorithm of the ML algorithm(s) (received as part of the ML job results via the feature query in Step 700), the metadata graph (obtained in Step 706) is filtered based on the ML algorithm. In one or many embodiment(s) disclosed herein, filtering of the metadata graph may, for example, entail topic matching (e.g., case-insensitive word or phrase matching) and/or semantic similarity calculation between the ML algorithm and the asset metadata (e.g., the dataset ML algorithm(s)) for assets catalogued in the asset catalog entries of which nodes of the metadata graph are representative. Further, for each ML algorithm, the filtering of the metadata graph based thereon may result in the identification of a node subset of the set of nodes forming the metadata graph. The identified node subset, subsequently, may include one or more nodes representative of one or more assets, respectively, that may be associated with the ML algorithm.

In Step 714, a k-partite metadata graph is generated using the node subset(s) (identified in Step(s) 708, 710, and/or 712). In one or many embodiment(s) disclosed herein, the k-partite metadata graph (see e.g., FIGS. 2B-2D) may reflect a new representation of, which may be based on one or more particular perspectives on, the metadata graph (obtained in Step 706). The k-partite metadata graph, further, may reflect a connected graph that encompasses k independent sets of nodes (i.e., the node subset(s), where k equals the number or cardinality of node subset(s)) and a set of edges interconnecting (and thus defining relationships between) pairs of nodes each belonging to a different independent set of nodes (or node subset)—with the exception of uni-(k=1) partite metadata graphs (see e.g., FIG. 2B) where the set of edges interconnect nodes of the single independent set of nodes (or single node subset) forming the uni-partite metadata graphs.

In Step 716, one or more key nodes, in/of the k-partite metadata graph (generated in Step 714), is/are identified. In one or many embodiment(s) disclosed herein, any key node of the identified key node(s) may be exemplified by a super node. A super node may refer to a densely connected node or a node with a disproportionately high number of edges connected thereto. Additionally, or alternatively, a super node may be identified as any node representing a most connected node (e.g., any node that serves as an endpoint of a pair of endpoints to a highest number of edges) in the k-partite metadata graph, which may otherwise be defined as any node that serves as an endpoint of a pair of endpoints to a number of edges, where the number of edges meets or exceeds a threshold number of edges (that may be dynamically set). For example, the threshold number of edges may be set to ten edges, where any node(s) in the k-partite metadata graph that serves as an endpoint (of a pair of endpoints) to at least ten edges may be classified or labeled as a super node in/of the k-partite metadata graph.

Alternatively, in one or many embodiment(s) disclosed herein, any key node of the identified key node(s) may be exemplified by a most connected node within a metadata subgraph in/of the k-partite metadata graph (generated in Step 714). A metadata subgraph may generally refer to a connected graph that may be found within, and therefore may include at least a portion of the elements (e.g., a set of nodes interconnected by a set of edges) forming, a larger connected graph (e.g., the k-partite metadata graph). A most connected node within any metadata subgraph, accordingly, may be defined as any node found within the metadata subgraph that serves as an endpoint of a pair of endpoints to a second number of edges, where the second number of edges meets or exceeds a second threshold of edges (that may be dynamically set). For example, the second threshold of edges may be set to ten edges, where any node(s) found within any given metadata subgraph(s), in the k-partite metadata graph, that serves as an endpoint (of a pair of endpoints) to at least ten edges may be classified or labeled as a most connected node in/of the given metadata subgraph.

Alternatively, in one or many embodiment(s) disclosed herein, any key node of the identified key node(s) may be exemplified by another node, which may be found in the k-partite metadata graph (generated in Step 714) that satisfies one or more other identification criteria. Examples of said other identification criteria may include, but is not limited to: whether a node is positioned along a longest path traversing the k-partite metadata graph; and whether a node is positioned along a shortest path traversing the k-partite metadata graph.

Turning to FIG. 7B, in Step 718, for each key node of the key node(s) (identified in Step 716), at least a portion of asset metadata, for a key asset (e.g., any dataset or other structured/tabular form of information) corresponding to the key node, is extracted. In one or many embodiment(s) disclosed herein, the extracted portion of asset metadata may include, but is not limited to, one or more dataset features, stewardship (or ownership) information, and compliance information (all briefly defined above—see e.g., Step 706) associated with the key asset.

In Step 720, the feature(s) (received via the feature query in Step 700) is/are assessed against the dataset feature(s) (extracted in Step 718) for each key asset corresponding respectively to each key node of the key node(s) (identified in Step 716). In one or many embodiment(s) disclosed herein, the assessment may, for example, entail word/phrase matching and/or semantic similarity calculation between each feature of the feature(s) and each dataset feature of the dataset feature(s) for each key asset. Further, the assessment may result in the identification of zero or more delta features. A delta feature (if any) may refer to any non-duplicative (or unique) dataset feature found to be excluded or distinct from any feature of the feature(s). Accordingly, any identified delta feature(s) may represent a supplemental property, factor, or variable that could boost the performance of the ML model(s) being evaluated by the organization user.

In Step 722, a determination is made as to whether the delta feature(s) (if any) (identified in Step 720) reflect(s) an empty set (i.e., a cardinality thereof equals zero). In one or many embodiment(s) disclosed herein, if it is determined that the delta feature(s) (if any) reflect(s) a non-empty set (i.e., a cardinality thereof exceeds zero), then the method proceeds to Step 724. On the other hand, in one or many other embodiment(s) disclosed herein, if it is alternatively determined that the delta feature(s) (if any) reflect(s) an empty set, then the method alternatively proceeds to Step 736 (see e.g., FIG. 7C).

In Step 724, following the determination (made in Step 722) that the delta feature(s) (if any) (identified in Step 720) reflect(s) a non-empty set (i.e., a cardinality thereof exceeds zero), a key asset subset is identified. In one or many embodiment(s) disclosed herein, the key asset subset may refer to one or more key assets representative of at least a portion of the key asset(s) (e.g., each a dataset or any other structured/tabular form of information) corresponding respectively to the key node(s) (identified in Step 716). Further, one or more delta features of the delta feature(s) (identified in Step 720) may map to a separate key asset in the key asset subset. For example, Delta Features 1 & 2 may map to Key Asset 1, Delta Feature 3 may map to Key Asset 2, and Delta Features 4-6 may map to Key Asset 3.

In Step 726, the user access permissions (obtained in Step 702), associated with the organization user, is assessed against the compliance information (extracted in Step 718) associated with one or more key assets. In one or many embodiment(s) disclosed herein, the key asset(s) may pertain to the key asset subset (identified in Step 724) and may map to asset catalog entry/entries represented by a key node subset of the key node(s) (identified in Step 716).

Further, assessment of the user access permissions, against the asset compliance information, may, for example, entail determining: whether a geographical location of the organization user is within the geographical restrictions or boundaries, at least in part, defining access to a key asset; whether the organization, with which the organization user is associated, is of a particular type (e.g., a commercial business, an educational institution, etc.) to which access and usability of a key asset is granted; and whether one or more organization roles (e.g., title(s) and/or position(s)) and/or professional affiliation(s) (e.g., membership(s) to professional organization(s)), with which the organization user is associated, satisfies criteria for permitting access to a key asset.

Moreover, the above-mentioned assessment, between the user access permissions and the asset compliance information, may result in producing access remarks that concern the key asset(s), of the key asset subset, associated with the extracted compliance information. In one or many embodiment(s) disclosed herein, any access remarks may refer to information expressing whether the key asset(s) is/are accessible or inaccessible to/by the organization user. Said information (for any given key asset of the key asset subset) may include, but is not limited to: an accessibility statement indicating that the given key asset can or cannot be accessed by the organization user; one or more reasons explaining or supporting the accessibility statement; a digital reference link (e.g., uniform resource locator or hyperlink) or an access protocol through which the organization user can access the given key asset should the accessibility statement indicate that the given key asset can be accessed by the organization user; and/or the stewardship information (extracted in Step 718) associated with the given key asset should the accessibility statement alternatively indicate that the given key asset cannot be accessed by the organization user.

In one or many embodiment(s) disclosed herein, stewardship information may be integrated, as part of the access remarks for a given key asset of the key asset subset (if applicable—e.g., if the given key asset is deemed inaccessible), in order to provide the organization user with an opportunity to potentially gain access to the given key asset through communications with the steward(s) or owner(s) of the given key asset. The potential to gain access to the given key asset through this avenue, however, may be moot or disregarded in view of other, higher-tiered compliance policies such as those outlined by geographical restrictions, as well as national and/or international laws, regulations, and standards.

In Step 728, an asset availability, for each of one or more key assets (e.g., one or more datasets or any other structured/tabular forms of information) of the key asset subset (identified in Step 724), is determined. In one or many embodiment(s) disclosed herein, the key asset(s) may map to asset catalog entry/entries represented by a key node subset of the key node(s) (identified in Step 716). Further, the determination of asset availability for any given key asset may, for example, entail the submission of an asset availability query to an appropriate (i.e., internal or external) data source identified in the asset metadata describing the given key asset. Any asset availability query may include or specify an asset identifier (also found in the asset metadata) that uniquely identifies the given key asset. Moreover, in response to any asset availability query, a corresponding asset availability reply may be received, which may include or specify an asset availability state indicating whether the given key asset is available (e.g., obtainable, usable, or reachable) or unavailable (e.g., unobtainable, unusable, or unreachable). Thereafter, the returned asset availability state(s) for the key asset(s), respectively, may be used to produce availability remarks concerning the key asset(s). Any availability remarks may refer to information expressing whether the key asset(s) is/are available or unavailable at/on one or more data sources that the key asset(s) currently reside, or at one time, had resided.

In Step 730, a feature query result is created. In one or many embodiment(s) disclosed herein, the feature query result may include: a manifest of asset(s) listing each of the key asset(s) of the key asset subset (identified in Step 724); the access remarks (produced in Step 726); the availability remarks (produced in Step 728); the delta feature(s) (identified in Step 720); and a new record identifier (ID) representing, for example, a character string that uniquely identifies a query record (described below—see e.g., Step 734).

Examples of said tracked query-pertinent information (also referred to herein as tracked query state) may include, but is not limited to: the feature(s) and the ML job result (received via the feature query in Step 700); the label(s) (if any) (optionally received via the feature query in Step 700); the k-partite metadata graph (generated in Step 714); the key node(s) (identified in Step 716); the delta feature(s) (identified in Step 720); and the new record ID.

Turning to FIG. 7C, in Step 732, the feature query result (created in Step 730) is provided in response to the feature query (received in Step 700). Particularly, in one or many embodiment(s) disclosed herein, the feature query result may be provided to the organization user who had submitted the feature query.

In Step 734, a new query record is created. In one or many embodiment(s) disclosed herein, the new query record may refer to a data directory, or a data container, in which the above-mentioned tracked query state may be maintained. The new query record, further, may be identified using the new record ID (mentioned in Step 730) and, accordingly, may be associated with the feature query (received in Step 700).

In Step 736, following the alternate determination (made in Step 722) that the delta feature(s) (if any) (identified in Step 720) reflect(s) an empty set (i.e., a cardinality thereof equals zero), and for each key node of the key node(s) (identified in Step 716), one or more strong adjacent nodes, in/of the k-partite metadata graph (generated in Step 714), is/are identified. In one or many embodiment(s) disclosed herein, with respect to a given key node, a strong adjacent node linked to the given key node may refer to a node connected thereto via an edge representative of a strong relationship there-between. Quantification of said strong relationship may, for example, entail an edge weight assigned to the edge interconnecting the given key node and the strong adjacent node, where the edge weight (e.g., expressed as a numerical value) meets or exceeds an edge weight threshold. The edge weight threshold, in turn, may be dynamically set and may denote the criterion for determining whether the associated edge is reflective of a strong relationship between a pair of assets (e.g., a pair of separate datasets or any other structured/tabular forms of information) corresponding to the given key node and a strong adjacent node.

In Step 738, for each strong adjacent node of the strong adjacent node(s) (identified in Step 736), at least a portion of asset metadata, for a strong asset (e.g., any dataset or other structured/tabular form of information) corresponding to the strong adjacent node, is extracted. In one or many embodiment(s) disclosed herein, the extracted portion of asset metadata may include, but is not limited to, one or more dataset features, stewardship (or ownership) information, and compliance information (all briefly defined above—see e.g., Step 706) associated with the strong asset.

Additionally, or alternatively, in Step 740, for each key node of the key node(s) (identified in Step 716), one or more weak adjacent nodes, in/of the k-partite metadata graph (generated in Step 714), is/are identified. In one or many embodiment(s) disclosed herein, with respect to a given key node, a weak adjacent node linked to the given key node may refer to a node connected thereto via an edge representative of a weak relationship there-between. Quantification of said weak relationship may, for example, entail an edge weight assigned to the edge interconnecting the given key node and the weak adjacent node, where the edge weight (e.g., expressed as a numerical value) falls or lies below an edge weight threshold. The edge weight threshold, in turn, may be dynamically set and may denote the criterion for determining whether the associated edge is reflective of a weak relationship between a pair of assets (e.g., a pair of separate datasets or any other structured/tabular forms of information) corresponding to the given key node and a weak adjacent node.

In Step 742, for each weak adjacent node of the weak adjacent node(s) (identified in Step 740), at least a portion of asset metadata, for a weak asset (e.g., any dataset or other structured/tabular form of information) corresponding to the weak adjacent node, is extracted. In one or many embodiment(s) disclosed herein, the extracted portion of asset metadata may include, but is not limited to, one or more dataset features, stewardship (or ownership) information, and compliance information (all briefly defined above—see e.g., Step 706) associated with the weak asset.

Turning to FIG. 7D, in Step 744, the feature(s) (received via the feature query in Step 700) is/are assessed against the dataset feature(s) (extracted in Step(s) 738 and/or 742) for each strong asset, corresponding respectively to each strong adjacent node of the strong adjacent node(s) (identified in Step 736) and/or for each weak asset corresponding to each weak adjacent node of the weak adjacent node(s) (identified in Step 740). In one or many embodiment(s) disclosed herein, the assessment may, for example, entail word/phrase matching and/or semantic similarity calculation between each feature of the feature(s) and each dataset feature of the dataset feature(s) for each strong asset and/or for each weak asset. Further, the assessment may result in the identification of zero or more delta features. A delta feature (if any) may refer to any non-duplicative (or unique) dataset feature found to be excluded or distinct from any feature of the feature(s). Accordingly, any identified delta feature(s) may represent a supplemental property, factor, or variable that could boost the performance of the ML model(s) being evaluated by the organization user.

In Step 746, a determination is made as to whether the delta feature(s) (if any) (identified in Step 744) reflect(s) an empty set (i.e., a cardinality thereof equals zero). In one or many embodiment(s) disclosed herein, if it is determined that the delta feature(s) (if any) reflect(s) the empty set, then the method proceeds to Step 748. On the other hand, in one or many other embodiment(s) disclosed herein, if it is alternatively determined that the delta feature(s) (if any) reflect(s) a non-empty set (i.e., a cardinality thereof exceeds zero), then the method alternatively proceeds to Step 750.

In Step 748, following the determination (made in Step 746) that the delta feature(s) (if any) (identified in Step 744) reflect(s) an empty set (i.e., a cardinality thereof equals zero), the edge weight threshold(s), defining the criterion(s) for identifying any strong adjacent node(s) and/or any weak adjacent node(s), is/are adjusted. In one or many embodiment(s) disclosed herein, adjustment of any edge weight threshold may generally result in the identification of one or more additional strong adjacent nodes and/or one or more additional weak adjacent nodes. For example, to effect the identification of additional strong adjacent node(s), the edge weight threshold, which denotes the identification criterion for any strong adjacent node, may be lowered. By way of another example, to effect the identification of additional weak adjacent node(s), the edge weight threshold, which denotes the identification criterion for any weak adjacent node, may be raised.

From here, following the adjustment of the edge weight threshold(s) for any strong and/or weak adjacent node(s), the method proceeds to Step 736 (described above) (see e.g., FIG. 7C), where the identification of additional strong and/or weak adjacent node(s) transpire(s) based on the adjusted edge weight threshold(s) associated therewith.

In Step 750, following the alternate determination (made in Step 746) that the delta feature(s) (if any) (identified in Step 744) reflect(s) a non-empty set (i.e., a cardinality thereof exceeds zero), a strong asset subset and/or a weak asset subset is/are identified. In one or many embodiment(s) disclosed herein, the strong asset subset may refer to one or more strong assets representative of at least a portion of the strong asset(s) (e.g., each a dataset or any other structured/tabular form of information) corresponding respectively to the strong adjacent node(s) (identified in Step 736). Meanwhile, the weak asset subset may refer to one or more weak assets representative of at least a portion of the weak asset(s) (e.g., each a dataset or any other structured/tabular form of information) corresponding respectively to the weak adjacent node(s) (identified in Step 740). Further, one or more delta features of the delta feature(s) (identified in Step 744) may map to a separate strong asset in the strong asset subset, or a separate weak asset in the weak asset subset. For example, Delta Features 1 & 2 may map to Strong Asset 1, Delta Features 3-5 may map to Weak Asset 1, Delta Feature 6 may map to Strong Asset 2, and Delta Feature 7 may map to Weak Asset 2.

In Step 752, the user access permissions (obtained in Step 702), associated with the organization user, is assessed against the compliance information (extracted in Step(s) 738 and/or 742) associated with one or more strong assets and/or one or more weak assets. In one or many embodiment(s) disclosed herein, the strong asset(s) may pertain to the strong asset subset (identified in Step 750) and may map to asset catalog entry/entries represented by a strong adjacent node subset of the strong adjacent node(s) (identified in Step 736), whereas the weak asset(s) may pertain to the weak asset subset (additionally, or alternatively, identified in Step 750) and may map to asset catalog entry/entries represented by a weak adjacent node subset of the weak adjacent node(s) (identified in Step 740).

Further, assessment of the user access permissions, against the asset compliance information, may, for example, entail determining: whether a geographical location of the organization user is within the geographical restrictions or boundaries, at least in part, defining access to a strong or weak asset; whether the organization, with which the organization user is associated, is of a particular type (e.g., a commercial business, an educational institution, etc.) to which access and usability of a strong or weak asset is granted; and whether one or more organization roles (e.g., title(s) and/or position(s)) and/or professional affiliation(s) (e.g., membership(s) to professional organization(s)), with which the organization user is associated, satisfies criteria for permitting access to a strong or weak asset.

Moreover, the above-mentioned assessment, between the user access permissions and the asset compliance information, may result in producing access remarks that concern the strong asset(s) of the strong asset subset and/or the weak asset(s) of the weak asset subset, associated with the extracted compliance information. In one or many embodiment(s) disclosed herein, any access remarks may refer to information expressing whether the strong and/or weak asset(s) is/are accessible or inaccessible to/by the organization user. Said information (for any given strong asset of the strong asset subset or any weak asset of the weak asset subset) may include, but is not limited to: an accessibility statement indicating that the given strong or weak asset can or cannot be accessed by the organization user; one or more reasons explaining or supporting the accessibility statement; a digital reference link (e.g., uniform resource locator or hyperlink) or an access protocol through which the organization user can access the given strong or weak asset should the accessibility statement indicate that the given strong or weak asset can be accessed by the organization user; and/or the stewardship information (extracted in Step(s) 738 and/or 742) associated with the given strong or weak asset should the accessibility statement alternatively indicate that the given strong or weak asset cannot be accessed by the organization user.

In one or many embodiment(s) disclosed herein, stewardship information may be integrated, as part of the access remarks for a given strong asset of the strong asset subset and/or for a given weak asset of the weak asset subset (if applicable—e.g., if the given strong or weak asset is deemed inaccessible), in order to provide the organization user with an opportunity to potentially gain access to the given strong or weak asset through communications with the steward(s) or owner(s) of the given strong or weak asset. The potential to gain access to the given strong or weak asset through this avenue, however, may be moot or disregarded in view of other, higher-tiered compliance policies such as those outlined by geographical restrictions, as well as national and/or international laws, regulations, and standards.

In Step 754, an asset availability, for each of one or more strong assets of the strong asset subset (identified in Step 750), and/or for each of one or more weak assets of the weak asset subset (additionally, or alternatively, identified in Step 750), is determined. In one or many embodiment(s) disclosed herein, the strong asset(s) may map to asset catalog entry/entries represented by a strong adjacent node subset of the strong adjacent node(s) (identified in Step 736), whereas the weak asset(s) may map to asset catalog entry/entries represented by a weak adjacent node subset of the weak adjacent node(s) (identified in Step 740). Further, the determination of asset availability for any given strong or weak asset may, for example, entail the submission of an asset availability query to an appropriate (i.e., internal or external) data source identified in the asset metadata describing the given strong or weak asset. Any asset availability query may include or specify an asset identifier (also found in the asset metadata) that uniquely identifies the given strong or weak asset. Moreover, in response to any asset availability query, a corresponding asset availability reply may be received, which may include or specify an asset availability state indicating whether the given strong or weak asset is available (e.g., obtainable, usable, or reachable) or unavailable (e.g., unobtainable, unusable, or unreachable). Thereafter, the returned asset availability state(s) for the strong and/or weak asset(s), respectively, may be used to produce availability remarks concerning the strong and/or weak asset(s). Any availability remarks may refer to information expressing whether the strong and/or weak asset(s) is/are available or unavailable at/on one or more data sources that the strong and/or weak asset(s) currently reside, or at one time, had resided.

Turning to FIG. 7E, in Step 756, a feature query result is created. In one or many embodiment(s) disclosed herein, the feature query result may include: a manifest of asset(s) listing each of the strong asset(s) of the strong asset subset (identified in Step 750) and/or each of the weak asset(s) of the weak asset subset (additionally, or alternatively, identified in Step 750); the access remarks (produced in Step 752); the availability remarks (produced in Step 754); the delta feature(s) (identified in Step 744); and a new record identifier (ID) representing, for example, a character string that uniquely identifies a query record (described above—see e.g., Step 734).

Examples of said tracked query-pertinent information (also referred to herein as tracked query state) may include, but is not limited to: the feature(s) and the MLL job results (received via the feature query in Step 700); the label(s) (if any) (optionally received via the feature query in Step 700); the k-partite metadata graph (generated in Step 714); the key node(s) (identified in Step 716); the strong adjacent node(s) (identified in Step 736); the weak adjacent node(s) (identified in Step 740); the delta feature(s) (identified in Step 744); the (strong) edge weight threshold defining the criterion for identifying the strong adjacent node(s); the (weak) edge weight threshold defining the criterion for identifying the weak adjacent node(s); and the new record ID.

In Step 758, the feature query result (created in Step 756) is provided in response to the feature query (received in Step 700). Particularly, in one or many embodiment(s) disclosed herein, the feature query result may be provided to the organization user who had submitted the feature query.

In Step 760, a new query record is created. In one or many embodiment(s) disclosed herein, the new query record may be identified using the new record ID (mentioned in Step 756) and, accordingly, may be associated with the feature query (received in Step 700).

In Step 762, following the alternate determination (made in Step 704) that a record ID had been received via the feature query (in Step 700), an existing query record is obtained. In one or many embodiment(s) disclosed herein, the existing query record may be associated with, and thus may be recalled/retrieved using, the aforementioned record ID. Further, the existing query record include existing tracked query state.

By way of examples, the existing tracked query state may include, but is not limited to: one or more previous features (i.e., one or more features submitted in a previous feature query by the organization user concerning one or more evaluated ML models); one or more previous labels (if any had optionally been received) (i.e., one or more labels submitted in a previous feature query by the organization user concerning one or more evaluated ML models; a previous ML job result (i.e., the ML job result submitted in a previous feature query by the organization user concerning one or more evaluated ML models) and/or any previous difference(s) between separate, successive ML job results (which may have been submitted in multiple previous feature queries by the organization user concerning one or more evaluated ML models); a k-partite metadata graph (generated during a processing of a previous/original feature query submitted by the organization that concerned one or more evaluated ML models); one or more key nodes (identified in/of the aforementioned k-partite metadata graph during a processing of a previous/original feature query submitted by the organization user that concerned one or more evaluated ML models); (optionally) one or more previous strong adjacent nodes (i.e., one or more strong adjacent nodes if any had been identified during the processing of a previous feature query submitted by the organization user that concerned one or more evaluated ML models); (optionally) one or more previous weak adjacent nodes (i.e., one or more weak adjacent nodes if any had been identified during the processing of a previous feature query submitted by the organization user that concerned one or more evaluated ML models); one or more previous delta features (i.e., one or more delta features identified during the processing of a previous feature query submitted by the organization user that concerned one or more evaluated ML models); (optionally) a previous (strong) edge weight threshold defining the criterion for identifying the previous strong adjacent node(s) (i.e., an edge weight threshold for identifying one or more strong adjacent nodes that had been employed during the processing of a previous feature query submitted by the organization user that concerned one or more evaluated ML models); and (optionally) a previous (weak) edge weight threshold defining the criterion for identifying the previous weak adjacent node(s) (i.e., an edge weight threshold for identifying one or more weak adjacent nodes that had been employed during the processing of a previous feature query submitted by the organization user that concerned one or more evaluated ML models). The existing tracked query state, further, is not limited to the aforementioned specific examples.

In Step 764, the existing query record (obtained in Step 762) (or at least a portion thereof) is amended. In one or many embodiment(s) disclosed herein, amending of the existing query record (or at least a portion thereof) may, for example, entail: replacing the previous feature(s) specified therein with the feature(s) (received via the feature query in Step 700); replacing the previous ML job result with the ML job result (also received via the feature query in Step 700) and/or (a) determining any difference(s) between the previous ML job result and the ML job result, and (b) replacing the previous difference(s) with the determined difference(s); and/or replacing the previous label(s) with the label(s) (if any had been received via the feature query in Step 700).

In Step 766, a determination is made as to whether the existing query record (obtained in Step 762) includes or specifies a previous (strong) edge weight threshold and/or a previous (weak) edge weight threshold. In one or many embodiment(s) disclosed herein, if it is determined that the existing query record includes/specifies any previous (strong and/or weak) edge weight threshold(s), then the method proceeds to Step 768 (see e.g., FIG. 7F). On the other hand, in one or many other embodiment(s) disclosed herein, if it is alternatively determined that the existing query record does not include/specify any previous (strong and/or weak) edge weight threshold(s), then the method alternatively proceeds to Step 772 (see e.g., FIG. 7F).

Turning to FIG. 7F, in Step 768, following the determination (made in Step 766) that the existing query record (obtained in Step 762) includes/specifies any previous (strong and/or weak) edge weight threshold(s), said previous (strong and/or weak) edge weight threshold(s) is/are extracted therefrom.

In Step 770, the previous (strong and/or weak) edge weight threshold(s) (extracted in Step 768) is/are adjusted. In one or many embodiment(s) disclosed herein, adjustment of any edge weight threshold may generally result in the identification of one or more additional strong adjacent nodes and/or one or more additional weak adjacent nodes. For example, to effect the identification of additional strong adjacent node(s), the (strong) edge weight threshold, which denotes the identification criterion for any strong adjacent node, may be lowered. By way of another example, to effect the identification of additional weak adjacent node(s), the (weak) edge weight threshold, which denotes the identification criterion for any weak adjacent node, may be raised.

In Step 772, following adjustment of the previous (strong and/or weak) edge weight threshold(s) (in Step 770), the k-partite metadata graph, the key node(s), the previous strong adjacent node(s), and the previous weak adjacent node(s) are extracted from the existing query record. Alternatively, following the alternate determination (made in Step 766) that the existing query record (obtained in Step 762) does not include/specify any said previous (strong and/or weak) edge weight threshold(s), only the k-partite metadata graph and the key node(s) are extracted from the existing query record.

In Step 774, for each key node of the key node(s) (extracted in Step 772), one or more (new) strong adjacent nodes, in/of the k-partite metadata graph (also extracted in Step 772), is/are identified. In one or many embodiment(s) disclosed herein, the (new) strong adjacent node(s) may be identified based on either a default (strong) edge weight threshold (if Steps 768 and 770 had not transpired) or an adjusted (strong) edge weight threshold (if Steps 768 and 770 had transpired).

Optionally, in Step 776, the (new) strong adjacent node(s) (identified in Step 774) is/are adjusted. Specifically, in one or many embodiment(s) disclosed herein, any previous strong adjacent node(s) (extracted in Step 772) is/are removed from the (new) strong adjacent node(s). The resulting (new) strong adjacent node(s), therefore, may include at least one strong adjacent node that has yet to be identified during the processing of any previous (or the original) feature query submitted by the organization user that concerns the evaluated ML model(s).

In Step 778, for each (new) strong adjacent node of the (new) strong adjacent node(s) (identified in Step 774 or resulted via the adjustment in Step 776), at least a portion of asset metadata, for a (new) strong asset (e.g., any dataset or other structured/tabular form of information) corresponding to the (new) strong adjacent node, is extracted. In one or many embodiment(s) disclosed herein, the extracted portion of asset metadata may include, but is not limited to, one or more dataset features, stewardship (or ownership) information, and compliance information (all briefly defined above—see e.g., Step 706) associated with the (new) strong asset.

Additionally, or alternatively, in Step 780, for each key node of the key node(s) (extracted in Step 772), one or more (new) weak adjacent nodes, in/of the k-partite metadata graph (also extracted in Step 772), is/are identified. In one or many embodiment(s) disclosed herein, the (new) weak adjacent node(s) may be identified based on either a default (weak) edge weight threshold (if Steps 768 and 770 had not transpired) or an adjusted (weak) edge weight threshold (if Steps 768 and 770 had transpired).

Optionally, in Step 782, the (new) weak adjacent node(s) (identified in Step 780) is/are adjusted. Specifically, in one or many embodiment(s) disclosed herein, any previous weak adjacent node(s) (extracted in Step 772) is/are removed from the (new) weak adjacent node(s). The resulting (new) weak adjacent node(s), therefore, may include at least one weak adjacent node that has yet to be identified during the processing of any previous (or the original) feature query submitted by the organization user that concerns the evaluated ML model(s).

Turning to FIG. 7G, in Step 784, for each (new) weak adjacent node of the (new) weak adjacent node(s) (identified in Step 780 or resulted via the adjustment in Step 782), at least a portion of asset metadata, for a (new) weak asset (e.g., any dataset or other structured/tabular form of information) corresponding to the (new) weak adjacent node, is extracted. In one or many embodiment(s) disclosed herein, the extracted portion of asset metadata may include, but is not limited to, one or more dataset features, stewardship (or ownership) information, and compliance information (all briefly defined above—see e.g., Step 706) associated with the (new) weak asset.

In Step 786, the feature(s) (received via the feature query in Step 700) is/are assessed against the dataset feature(s) (extracted in Step(s) 778 and/or 784) for each (new) strong asset, corresponding respectively to each (new) strong adjacent node of the (new) strong adjacent node(s) (identified in Step 774 or resulted via the adjustment in Step 776) and/or for each (new) weak asset corresponding to each (new) weak adjacent node of the (new) weak adjacent node(s) (identified in Step 780 or resulted via the adjustment in Step 782). In one or many embodiment(s) disclosed herein, the assessment may, for example, entail word/phrase matching and/or calculating a semantic similarity between each feature of the feature(s) and each dataset feature of the dataset feature(s) for each (new) strong asset and/or for each (new) weak asset. Further, the assessment may result in the identification of zero or more (new) delta features. A (new) delta feature (if any) may refer to any non-duplicative (or unique) dataset feature found to be excluded or distinct from any feature of the feature(s). Accordingly, any identified delta feature(s) may represent a supplemental property, factor, or variable that could boost the performance of the ML model(s) being evaluated by the organization user.

In Step 788, a determination is made as to whether the (new) delta feature(s) (if any) (identified in Step 786) reflect(s) an empty set (i.e., a cardinality thereof equals zero). In one or many embodiment(s) disclosed herein, if it is determined that the (new) delta feature(s) (if any) reflect(s) the empty set, then the method proceeds to Step 790. On the other hand, in one or many other embodiment(s) disclosed herein, if it is alternatively determined that the (new) delta feature(s) (if any) reflect(s) a non-empty set (i.e., a cardinality thereof exceeds zero), then the method alternatively proceeds to Step 792.

In Step 790, following the determination (made in Step 788) that the (new) delta feature(s) (if any) (identified in Step 786) reflect(s) an empty set (i.e., a cardinality thereof equals zero), the edge weight threshold(s), defining the criterion(s) for identifying any (new) strong adjacent node(s) and/or any (new) weak adjacent node(s), is/are adjusted. In one or many embodiment(s) disclosed herein, adjustment of any edge weight threshold may generally result in the identification of one or more additional (new) strong adjacent nodes and/or one or more additional (new) weak adjacent nodes. For example, to effect the identification of additional (new) strong adjacent node(s), the (strong) edge weight threshold, which denotes the identification criterion for any (new) strong adjacent node, may be lowered. By way of another example, to effect the identification of additional (new) weak adjacent node(s), the (weak) edge weight threshold, which denotes the identification criterion for any (new) weak adjacent node, may be raised.

From here, following the adjustment of the edge weight threshold(s) for any (new) strong and/or (new) weak adjacent node(s), the method proceeds to Step 774 (described above) (see e.g., FIG. 7F), where the identification of additional (new) strong and/or (new) weak adjacent node(s) transpire(s) based on the adjusted edge weight threshold(s) associated therewith.

In Step 792, following the alternate determination (made in Step 788) that the (new) delta feature(s) (if any) (identified in Step 786) reflect(s) a non-empty set (i.e., a cardinality thereof exceeds zero), a (new) strong asset subset and/or a (new) weak asset subset is/are identified. In one or many embodiment(s) disclosed herein, the (new) strong asset subset may refer to one or more (new) strong assets representative of at least a portion of the (new) strong asset(s) (e.g., each a dataset or any other structured/tabular form of information) corresponding respectively to the (new) strong adjacent node(s) (identified in Step 774 or resulted via the adjustment in Step 776). Meanwhile, the (new) weak asset subset may refer to one or more (new) weak assets representative of at least a portion of the (new) weak asset(s) (e.g., each a dataset or any other structured/tabular form of information) corresponding respectively to the (new) weak adjacent node(s) (identified in Step 780 or resulted via the adjustment in Step 782). Further, one or more (new) delta features of the (new) delta feature(s) (identified in Step 786) may map to a separate (new) strong asset in the (new) strong asset subset, or a separate (new) weak asset in the (new) weak asset subset. For example, New Delta Features 1 & 2 may map to New Strong Asset 1, New Delta Features 3-5 may map to New Weak Asset 1, New Delta Feature 6 may map to New Strong Asset 2, and New Delta Feature 7 may map to New Weak Asset 2.

In Step 794, the user access permissions (obtained in Step 702), associated with the organization user, is assessed against the compliance information (extracted in Step(s) 778 and/or 784) associated with one or more (new) strong assets and/or one or more (new) weak assets. In one or many embodiment(s) disclosed herein, the (new) strong asset(s) may pertain to the (new) strong asset subset (identified in Step 792) and may map to asset catalog entry/entries represented by a (new) strong adjacent node subset of the (new) strong adjacent node(s) (identified in Step 774 or resulted via the adjustment in Step 776), whereas the (new) weak asset(s) may pertain to the (new) weak asset subset (additionally, or alternatively, identified in Step 792) and may map to asset catalog entry/entries represented by a (new) weak adjacent node subset of the (new) weak adjacent node(s) (identified in Step 780 or resulted via the adjustment in Step 782).

Further, assessment of the user access permissions, against the asset compliance information, may, for example, entail determining: whether a geographical location of the organization user is within the geographical restrictions or boundaries, at least in part, defining access to a (new) strong or (new) weak asset; whether the organization, with which the organization user is associated, is of a particular type (e.g., a commercial business, an educational institution, etc.) to which access and usability of a (new) strong or (new) weak asset is granted; and whether one or more organization roles (e.g., title(s) and/or position(s)) and/or professional affiliation(s) (e.g., membership(s) to professional organization(s)), with which the organization user is associated, satisfies criteria for permitting access to a (new) strong or (new) weak asset.

Moreover, the above-mentioned assessment, between the user access permissions and the asset compliance information, may result in producing (new) access remarks that concern the (new) strong asset(s) of the (new) strong asset subset and/or the (new) weak asset(s) of the (new) weak asset subset, associated with the extracted compliance information. In one or many embodiment(s) disclosed herein, any (new) access remarks may refer to information expressing whether the (new) strong and/or (new) weak asset(s) is/are accessible or inaccessible to/by the organization user. Said information (for any given (new) strong asset of the (new) strong asset subset or any (new) weak asset of the (new) weak asset subset) may include, but is not limited to: an accessibility statement indicating that the given (new) strong or (new) weak asset can or cannot be accessed by the organization user; one or more reasons explaining or supporting the accessibility statement; a digital reference link (e.g., uniform resource locator or hyperlink) or an access protocol through which the organization user can access the given (new) strong or (new) weak asset should the accessibility statement indicate that the given (new) strong or (new) weak asset can be accessed by the organization user; and/or the stewardship information (extracted in Step(s) 778 and/or 784) associated with the given (new) strong or (new) weak asset should the accessibility statement alternatively indicate that the given (new) strong or (new) weak asset cannot be accessed by the organization user.

In one or many embodiment(s) disclosed herein, stewardship information may be integrated, as part of the (new) access remarks for a given (new) strong asset of the (new) strong asset subset and/or for a given (new) weak asset of the (new) weak asset subset (if applicable—e.g., if the given (new) strong or (new) weak asset is deemed inaccessible), in order to provide the organization user with an opportunity to potentially gain access to the given (new) strong or (new) weak asset through communications with the steward(s) or owner(s) of the given (new) strong or (new) weak asset. The potential to gain access to the given (new) strong or (new) weak asset through this avenue, however, may be moot or disregarded in view of other, higher-tiered compliance policies such as those outlined by geographical restrictions, as well as national and/or international laws, regulations, and standards.

In Step 796, a/an (new) asset availability, for each of one or more (new) strong assets of the (new) strong asset subset (identified in Step 792), and/or for each of one or more (new) weak assets of the (new) weak asset subset (additionally, or alternatively, identified in Step 792), is determined. In one or many embodiment(s) disclosed herein, the (new) strong asset(s) may map to asset catalog entry/entries represented by a (new) strong adjacent node subset of the (new) strong adjacent node(s) (identified in Step 774 or resulted via the adjustment in Step 776), whereas the (new) weak asset(s) may map to asset catalog entry/entries represented by a (new) weak adjacent node subset of the (new) weak adjacent node(s) (identified in Step 780 or resulted via the adjustment in Step 782). Further, the determination of (new) asset availability for any given (new) strong or (new) weak asset may, for example, entail the submission of an asset availability query to an appropriate (i.e., internal or external) data source identified in the asset metadata describing the given (new) strong or (new) weak asset. Any asset availability query may include or specify an asset identifier (also found in the asset metadata) that uniquely identifies the given (new) strong or (new) weak asset. Moreover, in response to any asset availability query, a corresponding asset availability reply may be received, which may include or specify an asset availability state indicating whether the given (new) strong or (new) weak asset is available (e.g., obtainable, usable, or reachable) or unavailable (e.g., unobtainable, unusable, or unreachable). Thereafter, the returned asset availability state(s) for the (new) strong and/or (new) weak asset(s), respectively, may be used to produce (new) availability remarks concerning the (new) strong and/or (new) weak asset(s). Any (new) availability remarks may refer to information expressing whether the (new) strong and/or (new) weak asset(s) is/are available or unavailable at/on one or more data sources that the (new) strong and/or (new) weak asset(s) currently reside, or at one time, had resided.

Turning to FIG. 7H, in Step 798, a feature query result is created. In one or many embodiment(s) disclosed herein, the feature query result may include: a manifest of asset(s) listing each of the (new) strong asset(s) of the (new) strong asset subset (identified in Step 792) and/or each of the (new) weak asset(s) of the (new) weak asset subset (additionally, or alternatively, identified in Step 792); the (new) access remarks (produced in Step 794); the (new) availability remarks (produced in Step 796); the (new) delta feature(s) (identified in Step 786); and the record ID (received via the feature query in Step 700).

In Step 798A, the feature query result (created in Step 798) is provided in response to the feature query (received in Step 700). Particularly, in one or many embodiment(s) disclosed herein, the feature query result may be provided to the organization user who had submitted the feature query.

In Step 798B, the existing query record (amended in Step 764) (or at least a portion thereof) is further amended. In one or many embodiment(s) disclosed herein, further amending of the existing query record (or at least a portion thereof) may, for example, entail: adding the (new) strong adjacent node(s) (identified in Step 774 or resulted via the adjustment in Step 776) (i.e., if it had been determined in Step 766 that the existing query record excluded any previous strong edge weight threshold) or replacing the previous strong adjacent node(s), included/specified in the existing query record, with the aforementioned (new) strong adjacent node(s) (i.e., if it had alternatively been determined in Step 766 that the existing query record included any previous strong edge weight threshold); adding the (new) weak adjacent node(s) (identified in Step 780 or resulted via the adjustment in Step 782) (i.e., if it had been determined in Step 766 that the existing query record excluded any previous weak edge weight threshold) or replacing the previous weak adjacent node(s), included/specified in the existing query record, with the aforementioned (new) weak adjacent node(s) (i.e., if it had alternatively been determined in Step 766 that the existing query record included any previous weak edge weight threshold); replacing the previous delta feature(s) with the (new) delta feature(s) (identified in Step 786); adding (a) the default (strong) edge weight threshold (if Steps 768 and 770 had not transpired) or (b) the adjusted (strong) edge weight threshold (if Steps 768 and 770 had transpired) (i.e., if for either case (a) or (b), it had been determined in Step 766 that the existing query record excluded any previous strong edge weight threshold) or replacing the previous (strong) edge weight threshold, included/specified in the existing query record, with the aforementioned adjusted (strong) edge weight threshold; and adding (c) the default (weak) edge weight threshold (if Steps 768 and 770 had not transpired) or (d) the adjusted (weak) edge weight threshold (if Steps 768 and 770 had transpired) (i.e., if for either case (c) or (d), it had been determined in Step 766 that the existing query record excluded any previous weak edge weight threshold) or replacing the previous (weak) edge weight threshold, included/specified in the existing query record, with the aforementioned adjusted (weak) edge weight threshold.

FIGS. 8A and 8B flowcharts describing a method for intent-driven adaptive learning delivery in accordance with one or more embodiments disclosed herein. The various steps outlined below may be performed by an insight service (see e.g., FIG. 1A). Further, while the various steps in the flowchart are presented and described sequentially, one of ordinary skill will appreciate that some or all steps may be executed in different orders, may be combined or omitted, and some or all steps may be executed in parallel.

Turning to FIG. 8A, in Step 800, a learning query is received. In one or many embodiment(s) disclosed herein, the learning query may include or specify a learning topic and a learning intent. The learning topic may refer to subject matter about which new information, knowledge, and/or skills is sought to be acquired, whereas the learning intent may refer to the reason for seeking said subject matter. For example, a learning topic (or new information, knowledge, and/or skills concerning a certain subject matter) may be sought in support of personal growth. By way of another example, a learning topic may be sought in support of a project goal or an organization strategy goal. Further, the learning query may have been submitted by an organization user. As such, the learning query may represent an inquiry, by the organization user, with regards to the selection of known or available materials, as well as the ordered introduction thereof, through which subject matter (i.e., learning topic) proficiency may be attained and, in turn, the reason (i.e., learning intent), for attaining said subject matter proficiency, may be satisfied.

In Step 802, a user profile is obtained. In one or many embodiment(s) disclosed herein, the user profile may pertain to the organization user (from which the learning query had been received in Step 800). The user profile may refer to a collection of settings and information associated with the organization user. As such, the user profile may include, but is not limited to, user talent information, user learning preferences, and user access permissions.

In one or many embodiment(s) disclosed herein, the user talent information may reflect a compilation of talent- and development-related details associated with the organization user. Examples of said details may include, but are not limited to: an education level (e.g., degree(s) in which domain(s), as well as which tier(s) of degree(s)) earned by the organization user; any professional certification(s) gained by the organization user; one or more competencies (as well as their respective level(s) and/or potential(s)) characterizing the organization user; and any business- or research-related interest(s) (as well as their respective proficiency/proficiencies) expressed by the organization user. The compiled details defining the user talent information for any given organization user are not limited to the aforementioned specific examples.

In one or many embodiment(s) disclosed herein, the user learning preferences may reflect one or more educational modalities that the organization user may favor over others in order to optimize learning topic comprehension and retention. Said educational modality/modalities may include, but is/are not limited to, visual learning (i.e., learning assisted through images, videos, animations, and/or multimedia), auditory learning (i.e., learning assisted through audio), and reading learning (i.e., learning assisted through text-based content).

In one or many embodiment(s) disclosed herein, the user access permissions may reflect the level of authorization granted to the organization user for accessing specific resources. The granted level of authorization, for any given organization user, may, for example, be contingent on any number of factors, which may include, but is/are not limited to: one or more user organization roles (e.g., title(s) and/or position(s)) within an organization that may be associated with the given organization user; one or more organization responsibilities (e.g., assigned project(s) or task(s)) within an organization that may be associated with the given organization user; a client device (and the security hygiene or characteristics thereof) operated by the given organization user; and a geographical location where the given organization user may be physically situated. The factor(s) affecting the user access permissions for any given organization user is/are not limited to the aforementioned specific examples.

In Step 804, the user talent information (obtained in Step 802) is reduced. In one or many embodiment(s) disclosed herein, reduction of the user talent information may entail a filtering thereof, based on the learning intent (received via the learning query in Step 800), to obtain a subset thereof (also referred to herein as impactful user talent information). Said impactful user talent information, accordingly, may encompass a subset of the user talent information found to be most impactful in/towards satisfying the learning intent. Further, said filtering of the user talent information may, for example, involve: an assigning of weights to the various details (exemplified above) reflected in the user talent information based on their relevance (and/or one or more other relationship metrics) respective to the learning intent; and a selecting of a subset of the various details, with assigned weights meeting or exceeding a weight threshold, to derive/obtain the impactful user talent information. Moreover, obtaining of the impactful user talent information is not limited to the aforementioned specific example.

In Step 806, a metadata graph is obtained. In one or many embodiment(s) disclosed herein, the metadata graph may refer to a connected graph (see e.g., FIG. 2A) representative of an asset catalog. To that end, the metadata graph may include a set of nodes interconnected by a set of edges, where the set of nodes are representative of asset catalog entries and the set of edges are representative of connections or relationships there-between. Further, each node may pertain to a given asset (e.g., a text document, multimedia, a presentation deck, an audio book or podcast, or any other forms of digital learning materials), where the representative asset catalog entry thereof may store metadata for, or information descriptive of, the given asset.

Examples of said asset metadata may include, but is not limited to: a brief description of the asset; stewardship (or ownership) information (e.g., individual or group name(s), contact information, etc.) pertaining to the steward(s)/owner(s) of the asset; a version character string reflective of a version or state of the asset at/for a given point-in-time; one or more categories, topics, and/or aspects associated with the asset; an asset identifier uniquely identifying the asset; one or more tags, keywords, or terms further describing the asset; a source identifier and/or location associated with an internal or external data source (see e.g., FIG. 1A) where the asset resides or is maintained; and compliance information specifying laws, regulations, and standards surrounding the asset, as well as policies directed to data governance (e.g., availability, usability, integrity, and security) pertinent to the asset. The asset metadata for any asset is not limited to the aforementioned specific examples.

In Step 808, the metadata graph (obtained in Step 806) is filtered based on the learning topic (received via the learning query in Step 800). In one or many embodiment(s) disclosed herein, filtering of the metadata graph may, for example, entail topic matching (e.g., case-insensitive word or phrase matching) and/or semantic similarity calculation between the learning topic and the asset metadata for assets catalogued in the asset catalog entries of which nodes of the metadata graph are representative. Further, filtering of the metadata graph based on the learning topic may result in the identification of a node subset of the set of nodes forming the metadata graph. The identified node subset, subsequently, may include one or more nodes representative of one or more assets, respectively, that may at least be associated with the learning topic.

In Step 810, a reduced node subset, from the node subset (identified in Step 808), is selected. In one or many embodiment(s) disclosed herein, selection of the reduced node subset may a filtering of the node subset, based on the learning intent (received via the learning query in Step 800), to obtain the reduced node subset. The reduced node subset, accordingly, may encompass a subset of the node subset found to be most impactful in/towards satisfying the learning intent. Further, said filtering of the node subset may, for example, involve: an examining of asset metadata pertaining to assets mapped to the node subset; an assigning of weights to the mapped assets based on the examined asset metadata and their relevance (and/or one or more other relationship metrics) respective to the learning intent; and an identifying of a subset of the node subset, with assigned weights meeting or exceeding a weight threshold, to select the reduced node subset. Moreover, selecting of the reduced node subset is not limited to the aforementioned specific example.

In Step 812, a k-partite metadata graph is generated using the reduced node subset (selected in Step 810). In one or many embodiment(s) disclosed herein, the k-partite metadata graph (see e.g., FIGS. 2B-2D) may reflect a new representation of, which may be based on one or more particular perspectives on, the metadata graph (obtained in Step 806). The k-partite metadata graph (or uni-partite metadata graph), further, may reflect a connected graph that encompasses a single (k=1), independent set of nodes (i.e., the reduced node subset) and a set of edges interconnecting (and thus defining relationships between) pairs of nodes in the single, independent set of nodes.

In Step 814, one or more edge weights (e.g., each expressed as a numerical value) is/are set or adjusted. In one or many embodiment(s) disclosed herein, the set/adjusted edge weight(s) may be assigned to or associated with one or more edges, respectively, in/of the k-partite metadata graph (generated in Step 812). The affected edge(s), specifically, may represent a relationship or relationships between a pair or pairs of assets (e.g., text documents, multimedia, presentation decks, audio books or podcasts, or any other forms of digital learning materials) relevant or related to the learning topic (received via the learning query in Step 800) as well as impactful in/towards satisfying the learning intent (also received via the learning query in Step 800).

Further, in one or many embodiment(s) disclosed herein, the edge weight for any affected edge(s) may be set/adjusted based on the impactful user talent information (obtained in Step 804) and/or the user learning preferences (obtained in Step 802). By way of an example, any edge(s) connecting nodes, representative of assets of a format (e.g., text, video, audio, multimedia, image, etc.) matching the educational modality/modalities favored by the organization user and/or representative of assets likened to the talent- and/or development-related details describing the organization user, may have their respective edge weight(s) set/adjusted to a high(er) value in comparison to other edge(s) (e.g., edge(s) connecting nodes alternatively representative of assets of a format mismatching the educational modality/modalities favored by the organization user and/or representative of assets opposing the talent- and/or development-related details describing the organization user) in/of the k-partite metadata graph. The high(er) edge weight value may reflect a strong(er) relationship between any affected pair of nodes, and thus also the corresponding assets, where any strong(er) relationship(s) may be considered in the determination of a learning path (described below) (see e.g., Step 818) tailored to the organization user.

Additionally, or alternatively, the edge weight(s) assigned to, or associated with, the above-mentioned other edge(s) (e.g., edge(s) connecting nodes alternatively representative of assets of a format (e.g., text, video, audio, multimedia, image, etc.) mismatching the educational modality/modalities favored by the organization user and/or representative of assets opposing the talent- and/or development-related details describing the organization user) in/of the k-partite metadata graph may be set/adjusted to a low(er) value in comparison to any edge(s) connecting nodes, representative of assets of a format matching the educational modality/modalities favored by the organization user and/or representative of assets likened to the talent- and/or development-related details describing the organization user. The low(er) edge weight value may reflect a weak(er) relationship between any affected pair of nodes, and thus also the corresponding assets, where any weak(er) relationship(s) may be disregarded in the determination of a learning path tailored to the organization user.

Turning to FIG. 8B, in Step 816, one or more key nodes, in/of the k-partite metadata graph (generated in Step 812), is/are identified. In one or many embodiment(s) disclosed herein, any key node of the identified key node(s) may be exemplified by a super node. A super node may refer to a densely connected node or a node with a disproportionately high number of edges connected thereto. Additionally, or alternatively, a super node may be identified as any node representing a most connected node (e.g., any node that serves as an endpoint of a pair of endpoints to a highest number of edges) in the k-partite metadata graph, which may otherwise be defined as any node that serves as an endpoint of a pair of endpoints to a number of edges, where the number of edges meets or exceeds a threshold number of edges (that may be dynamically set). For example, the threshold number of edges may be set to ten edges, where any node(s) in the k-partite metadata graph that serves as an endpoint (of a pair of endpoints) to at least ten edges may be classified or labeled as a super node in/of the k-partite metadata graph.

Alternatively, in one or many embodiment(s) disclosed herein, any key node of the identified key node(s) may be exemplified by a most connected node within a metadata subgraph in/of the k-partite metadata graph (generated in Step 812). A metadata subgraph may generally refer to a connected graph that may be found within, and therefore may include at least a portion of the elements (e.g., a set of nodes interconnected by a set of edges) forming, a larger connected graph (e.g., the k-partite metadata graph). A most connected node within any metadata subgraph, accordingly, may be defined as any node found within the metadata subgraph that serves as an endpoint of a pair of endpoints to a second number of edges, where the second number of edges meets or exceeds a second threshold of edges (that may be dynamically set). For example, the second threshold of edges may be set to ten edges, where any node(s) found within any given metadata subgraph(s), in the k-partite metadata graph, that serves as an endpoint (of a pair of endpoints) to at least ten edges may be classified or labeled as a most connected node in/of the given metadata subgraph.

Alternatively, in one or many embodiment(s) disclosed herein, any key node of the identified key node(s) may be exemplified by another node, which may be found in the k-partite metadata graph (generated in Step 812) that satisfies one or more other identification criteria. Examples of said other identification criteria may include, but is not limited to: whether a node is positioned along a longest path traversing the k-partite metadata graph; and whether a node is positioned along a shortest path traversing the k-partite metadata graph.

In Step 818, a learning path, traversing through at least a portion of the k-partite metadata graph (generated in Step 812), is determined. In one or many embodiment(s) disclosed herein, the learning path may refer to a sequence of one or more edges (also referred to herein as learning path edge(s)), which interconnect(s) a sequence of two or more nodes (also referred to herein as learning path nodes), in/of the k-partite metadata graph. The learning path nodes, accordingly, may include: a path-starting node representing the first node in the sequence of nodes; a path-ending node representing the last node in the sequence of nodes; and zero or more path-body nodes respectively representing zero or more intermediate nodes collectively connecting the path-starting node to the path-ending node.

In one or many embodiment(s) disclosed herein, in forming at least a portion of the k-partite metadata graph, each learning path node in/of (i.e., positioned along) the learning path may correspond to an asset catalog entry in an asset catalog, which in turn specifies asset metadata describing a given asset (e.g., a text document, multimedia, a presentation deck, an audio book or podcast, or any other forms of digital learning materials) known to or catalogued by the insight service, and relevant to the learning topic (received via the learning query in Step 800) as well as impactful in/towards satisfying the learning intent (also received via the learning query in Step 800).

Further, in one or many embodiment(s) disclosed herein, the learning path may represent a directed path, or any path encompassing one or more edges each having a direction and, thus, each connecting one node (e.g., the path-starting node or a path-body node) to another node (e.g., a path-body node or the path-ending node) via said direction. Also, in traversing the learning path from the path-starting node to the path-ending node, each learning path node is visited, while each learning path edge between a pair of learning path nodes is crossed, only once. Accordingly, each learning path edge in/of the learning path may be oriented towards the same direction.

In one or many embodiment(s) disclosed herein, determination of the learning path may rely on the key node(s) (identified in Step 816), as well as the edge weight(s) (set/adjusted in Step 814). For example, determining the learning path may be as simple as using a longest (or a shortest) path that includes the key node(s). By way of another example, determining the learning path may be as complex as pursuing the following determination pipeline: (a) examining asset metadata (e.g., views and visits, ratings, forward and backward citations, impact of authors and network power they pose within domain(s) relevant or related to the learning topic, etc.) pertaining to assets mapped to the nodes in/of the k-partite metadata graph (generated in Step 812); (b) assigning weights to the nodes, respectively, based on the examined asset metadata; (c) applying a ranking algorithm to the mapped assets based on the assigned weights in order to obtain ranked assets; (d) identifying a node, of the nodes, mapped to a topmost (or highest) ranked asset, of the ranked assets, as the path-starting node; (e) identifying another node, of the nodes, mapped to a bottommost (or lowest) ranked asset, of the ranked assets, as the path-ending node; and (f) selecting a longest (or a shortest) path that connects the path-starting node to the path-ending node, that includes the key node(s), and that considers the adjusted edge weight(s) in the selection of edges forming the learning path. Further, determination of the learning path is not limited to the aforementioned specific examples.

In one or many embodiment(s) disclosed herein, the sequence in which the learning path nodes may be ordered may reflect a spectrum of assets (e.g., learning materials) teaching progressively more difficult or more advanced aspects of the learning topic (received via the learning query in Step 800). For example, the path-starting node in/of the learning path may correspond to an asset commensurate to a novice/basic knowledge level or, alternatively, a standing/current knowledge level that the organization user may retain, concerning the learning topic. On the other hand, the path-ending node in/of the learning path may correspond to another asset representative of a mastery knowledge level concerning the learning topic. Any path-body node(s) there-between may each correspond to, or introduce, yet another asset that may serve to progressively advance the proficiency, of/by the organization user, in terms of the learning topic.

In Step 820, a set of learning path nodes is/are identified. In one or many embodiment(s) disclosed herein, and as re-iterated from above, the set of learning path nodes may include one or more nodes that, at least in part, form and, therefore, is/are positioned along, the learning path (determined in Step 818).

In Step 822, for each learning path node in the set of learning path nodes (identified in Step 820), at least a portion of asset metadata, for an asset (e.g., a text document, multimedia, a presentation deck, an audio book or podcast, or any other forms of digital learning materials) corresponding to the learning path node, is extracted. In one or many embodiment(s) disclosed herein, the extracted portion of asset metadata may include, but is not limited to, stewardship (or ownership) information and compliance information (both briefly defined above—see e.g., Step 806) associated with the asset.

In Step 824, the user access permissions (obtained in Step 802), associated with the organization user, is assessed against the compliance information (extracted in Step 822) associated with one or more assets. In one or many embodiment(s) disclosed herein, the asset(s) may map to asset catalog entry/entries represented by the set of learning path nodes (identified in Step 820).

Further, assessment of the user access permissions, against the asset compliance information, may, for example, entail determining: whether a geographical location of the organization user is within the geographical restrictions or boundaries, at least in part, defining access to an asset; whether the organization, with which the organization user is associated, is of a particular type (e.g., a commercial business, an educational institution, etc.) to which access and usability of an asset is granted; and whether one or more organization roles (e.g., title(s) and/or position(s)) and/or professional affiliation(s) (e.g., membership(s) to professional organization(s)), with which the organization user is associated, satisfies criteria for permitting access to an asset.

Moreover, the above-mentioned assessment, between the user access permissions and the asset compliance information, may result in producing access remarks that concern the asset(s) associated with the extracted compliance information. In one or many embodiment(s) disclosed herein, any access remarks may refer to information expressing whether the asset(s) is/are accessible or inaccessible to/by the organization user. Said information (for any given asset) may include, but is not limited to: an accessibility statement indicating that the given asset can or cannot be accessed by the organization user; one or more reasons explaining or supporting the accessibility statement; a digital reference link (e.g., uniform resource locator or hyperlink) or an access protocol through which the organization user can access the given asset should the accessibility statement indicate that the given asset can be accessed by the organization user; and/or the stewardship information (extracted in Step 822) associated with the given asset should the accessibility statement alternatively indicate that the given asset cannot be accessed by the organization user.

In one or many embodiment(s) disclosed herein, stewardship information may be integrated, as part of the access remarks for a given asset (if applicable—e.g., if the given asset is deemed inaccessible), in order to provide the organization user with an opportunity to potentially gain access to the given asset through communications with the steward(s) or owner(s) of the given asset. The potential to gain access to the given asset through this avenue, however, may be moot or disregarded in view of other, higher-tiered compliance policies such as those outlined by geographical restrictions, as well as national and/or international laws, regulations, and standards.

In Step 826, an asset availability, for each of one or more assets (e.g., one or more documents, multimedia, presentation decks, audio books or podcasts, or any other forms of digital learning materials), is determined. In one or many embodiment(s) disclosed herein, the asset(s) may map to asset catalog entry/entries represented by the set of learning path nodes (identified in Step 820). Further, the determination of asset availability for any given asset may, for example, entail the submission of an asset availability query to an appropriate (i.e., internal or external) data source identified in the asset metadata describing the given asset. Any asset availability query may include or specify an asset identifier (also found in the asset metadata) that uniquely identifies the given asset. Moreover, in response to any asset availability query, a corresponding asset availability reply may be received, which may include or specify an asset availability state indicating whether the given asset is available (e.g., obtainable, usable, or reachable) or unavailable (e.g., unobtainable, unusable, or unreachable). Thereafter, the returned asset availability state(s) for the asset(s), respectively, may be used to produce availability remarks concerning the asset(s). Any availability remarks may refer to information expressing whether the asset(s) is/are available or unavailable at/on one or more data sources that the asset(s) currently reside, or at one time, had resided.

In Step 828, a learning curriculum is created. In one or many embodiment(s) disclosed herein, the learning curriculum may refer to an ordered itemization/listing (or sequenced itemization/listing) (also referred to herein as a manifest) of learning materials and/or content (e.g., assets) that progressively teaches improved proficiency in the learning topic in order to satisfy the learning intent (both received via the learning query in Step 800). The learning curriculum, further, may be tailored to, and therefore may align with the impactful user talent information (obtained in Step 804) and/or the user learning preferences (obtained in Step 802) of the organization user. Other information, moreover, may also be enclosed within or may accompany the learning curriculum. Said other information may include, but is not limited to, the access remarks (produced in Step 824) and the availability remarks (produced in Step 826).

In Step 830, the learning curriculum (created in Step 828) is provided in response to the learning query (received in Step 800). Particularly, in one or many embodiment(s) disclosed herein, the learning curriculum may be provided to the organization user who had submitted the learning query.

FIG. 9 shows a flowchart describing a method for learning acceleration using insight-assisted introductions in accordance with one or more embodiments disclosed herein. The various steps outlined below may be performed by an insight service (see e.g., FIG. 1). Further, while the various steps in the flowchart are presented and described sequentially, one of ordinary skill will appreciate that some or all steps may be executed in different orders, may be combined or omitted, and some or all steps may be executed in parallel.

Turning to FIG. 9, in Step 900, an introduction query is received. In one or many embodiment(s) disclosed herein, the introduction query may include or specify one or more interests. An interest may refer to a subject or domain through which introductions between organization users may be suggested. As such, the introduction query may have been submitted by an (inquiring) organization user, and may represent an inquiry, by the organization user, with regards to other organization user(s) that may share matching/similar fascinations, or may be acknowledged as subject matter expert(s) in said interest(s). Accordingly, the organization user may seek out the other organization user(s) in order to prospectively pursue and/or produce joint collaborative work directed to, for example, one or more research and/or organization goals.

In Step 902, a metadata graph is obtained. In one or many embodiment(s) disclosed herein, the metadata graph may refer to a connected graph (see e.g., FIG. 2A) representative of a user catalog. To that end, the metadata graph may include a set of nodes interconnected by a set of edges, where the set of nodes are representative of user catalog entries (also referred to herein as user profiles) and the set of edges are representative of connections or relationships there-between. Further, each node may pertain to a given organization user within an organization (e.g., a commercial business, an educational institution, etc.) where the representative user catalog entry (or user profile) thereof may store metadata for, or information descriptive of, the given organization user.

In one or many embodiment(s) disclosed herein, a user profile for any given organization user may refer to a collection of settings and information associated with the given organization user. Examples of said user metadata (or collection of settings/information) may include, but is not limited to: one or more user identifiers (e.g., a username assigned to the given organization user within an organization, the personal name with which the given organization user may be referred, etc.); one or more user domains (e.g., one or more subjects, topics, specialties, and/or interests to which the given organization user contributes and in which the given organization user may be knowledgeable; and user contact information (e.g., personal and/or organization phone number(s) through which the given organization user may be reached via existing telephonic technologies, personal and/or organization email address(es) through which the given organization user may be reached via existing electronic mail technologies, etc.). User metadata is not limited to the aforementioned specific examples.

In Step 904, for each interest of the interest(s) (received via the introduction query in Step 900), the metadata graph (obtained in Step 902) is filtered based on the interest. In one or many embodiment(s) disclosed herein, filtering of the metadata graph may, for example, entail topic matching (e.g., case-insensitive word or phrase matching) between a given interest and the user metadata for organization users catalogued in the user catalog entries (or user profiles) of which nodes of the metadata graph are representative. Further, for each interest, the filtering of the metadata graph based thereon may result in the identification of a node subset of the set of nodes forming the metadata graph. The identified node subset, subsequently, may include one or more nodes representative of one or more organization users, respectively, that may be associated with the interest.

In Step 906, a k-partite metadata graph is generated using the node subset(s) (identified in Step 904). In one or many embodiment(s) disclosed herein, the k-partite metadata graph (see e.g., FIGS. 2B-2D) may reflect a new representation of, which may be based on one or more particular perspectives on, the metadata graph (obtained in Step 902). The k-partite metadata graph, further, may reflect a connected graph that encompasses k independent sets of nodes (i.e., the node subset(s), where k equals the number or cardinality of node subset(s)) and a set of edges interconnecting (and thus defining relationships between) pairs of nodes each belonging to a different independent set of nodes (or node subset)—with the exception of uni-(k=1) partite metadata graphs (see e.g., FIG. 2B) where the set of edges interconnect nodes of the single independent set of nodes (or single node subset) forming the uni-partite metadata graphs.

In Step 908, one or more super nodes, in/of the k-partite metadata graph (generated in Step 906), is/are identified. In one or many embodiment(s) disclosed herein, a super node may refer to a densely connected node or a node with a disproportionately high number of edges connected thereto. Additionally, or alternatively, a super node may be identified as any node representing a most connected node (e.g., any node that serves as an endpoint of a pair of endpoints to a highest number of edges) in the k-partite metadata graph, which may otherwise be defined as any node that serves as an endpoint of a pair of endpoints to a number of edges, where the number of edges meets or exceeds a threshold number of edges (that may be dynamically set). For example, the threshold number of edges may be set to ten edges, where any node(s) in the k-partite metadata graph that serves as an endpoint (of a pair of endpoints) to at least ten edges may be classified or labeled as a super node in/of the k-partite metadata graph.

Optionally, one or more near-super nodes, in/of the k-partite metadata graph (generated in Step 906), is/are further identified. In one or many embodiment(s) disclosed herein, a near-super node may refer to any node that nearly satisfies, but still falls short, of the criterion/criteria for being classified or labeled as a super node. Additionally, or alternatively, a near-super node may be identified or defined as any node that serves as an endpoint of a pair of endpoints to a second number of edges, where the second number of edges lies below the above-mentioned threshold number of edges (i.e., serving as the criterion for identifying super nodes), however, meets or exceeds a second threshold number of edges (that may also be dynamically set). For example, the threshold number of edges may be set to ten edges and the second threshold number of edges may be set to seven edges, where any node(s) in the k-partite metadata graph that serves as an endpoint (of a pair of endpoints) to at least seven edges, but no more than nine edges, may be classified or labeled as a near-super node.

In Step 910, for each super node of the super node(s) (identified in Step 908), and/or for each near-super node of the near-super node(s) (optionally identified in Step 908), at least a portion of user metadata, for another organization user (i.e., not the organization user that submitted the introduction query) corresponding to the super node, and/or near-super node, is extracted. In one or many embodiment(s) disclosed herein, the extracted portion of user metadata may include, but is not limited to, one or more user identifiers, one or more user domains, and user contact information (all briefly defined above—see e.g., Step 902) associated with the other organization user.

In Step 912, the at least portion of user metadata (extracted in Step 910), respective to one or more other organization users, is provided in response to the introduction query (received in Step 900). Particularly, in one or many embodiment(s) disclosed herein, the at least portion of user metadata may be provided to the organization user who had submitted the introduction query.

FIGS. 10A and 10B show flowcharts describing a method for business intent-assisted search in accordance with one or more embodiments disclosed herein. The various steps outlined below may be performed by an insight service (see e.g., FIG. 1). Further, while the various steps in the flowchart are presented and described sequentially, one of ordinary skill will appreciate that some or all steps may be executed in different orders, may be combined or omitted, and some or all steps may be executed in parallel.

Turning to FIG. 10A, in Step 1000, a search query is received. In one or many embodiment(s) disclosed herein, the search query may include or specify a search topic. The search topic may refer to a subject or domain to which sought information may belong or may be associated with. Further, the search query may have been submitted by an organization user. As such, the search query may represent an inquiry, by the organization user, with regards to known or catalogued assets (e.g., any existing forms of structured and/or unstructured information) concerning the specified search topic.

In Step 1002, a user profile is obtained. In one or many embodiment(s) disclosed herein, the user profile may pertain to the organization user (from which the search query had been received in Step 1000). The user profile may refer to a collection of settings and information associated with the organization user. As such, the user profile may include, but is not limited to, user access permissions.

In one or many embodiment(s) disclosed herein, the user access permissions may reflect the level of authorization granted to the organization user for accessing specific resources. The granted level of authorization, for any given organization user, may, for example, be contingent on any number of factors, which may include, but is/are not limited to: one or more user organization roles (e.g., title(s) and/or position(s)) within an organization that may be associated with the given organization user; one or more organization responsibilities (e.g., assigned project(s) or task(s)) within an organization that may be associated with the given organization user; a client device (and the security hygiene or characteristics thereof) operated by the given organization user; and a geographical location where the given organization user may be physically situated. The factor(s) affecting the user access permissions for any given organization user is/are not limited to the aforementioned specific examples.

In Step 1004, a user business intent model, for the organization user, is obtained. In one or many embodiment(s) disclosed herein, the user business intent model may refer to a data model (or an abstract representation) of the known business intent thus far captured for the organization user. Business intent, in turn, may generally refer to information, respective to the organization user, which may pertain to or describe the engagement of the organization user within and/or outside their organization (e.g., a commercial business, an education institution, etc.).

Further, in one or many embodiment(s) disclosed herein, business intent, and thus any user business intent model, may be represented through a set of business intent parameters. Examples of said business intent parameter(s) (as they pertain to any given organization user) may include, but is/are not limited to: one or more user organization roles (e.g., title(s) and/or position(s)) within an organization that may be associated with the given organization user; one or more other organization users within the organization with which the given organization user interacts and/or had interacted; one or more suppliers, distributors, customers, collaborators, and/or other actors outside the organization (also collectively referred to herein as one or more value networks) with which the given organization user interacts and/or had interacted; a search query history reflecting one or more past search queries, as well as the search topic(s) entailed, which had been previously submitted by the given organization user; one or more organization departments of the organization with which the given organization user is associated; one or more organization responsibilities (e.g., assigned project(s) or task(s)) within the organization that the given organization user is currently undertaking or had undertaken in the past; and one or more success metrics indicating a level of success that the aforementioned organization responsibility/responsibilities have brought to the organization. Said business intent parameter(s) is/are not limited to the aforementioned specific examples.

In one or many embodiment(s) disclosed herein, a business intent, and thus a user business intent model (or portions thereof), respective to a given organization user, may be captured or recorded through any number of mechanisms. By way of an example, said business intent may be captured/recorded through direct input of one or more business intent parameters by the organization user. By way of another example, said business intent may be captured/recorded through information available within a strategy cascade (e.g., a strategic plan) outlining one or more organization goals, as well as the distribution thereof internally, for the organization for any one or more given periods of time. By way of yet another example, said business intent may be captured/recorded through gamification, which may entail the attempted input(s) or population(s) of one or more business intent parameters, by the organization user, via the creation of similar experiences to those experienced when playing games in order to motivate or engage the organization user. The capturing or recording of business intent is/are not limited to the aforementioned specific examples.

In one or many embodiment(s) disclosed herein, a business intent, and thus a user business intent model, respective to a given organization user and at any given point-in-time, may be associated with a completeness thereof. That is, a completeness of a business intent and/or the user business intent model may refer to a measurable degree (also referred to herein as a business intent score) to which the set of business intent parameters, representative of the business intent and/or user business intent model for the given organization user, may be known or captured at the given point-in-time.

In Step 1006, a set of known business intent parameters is extracted from the user business intent model (obtained in Step 1004). In one or many embodiment(s) disclosed herein, the set of known business intent parameters may include zero or more business intent parameters (described above—see e.g., Step 1004) that may be captured or recorded for the organization user. As such, the set of known business intent parameters may be reflective of an empty set (i.e., including zero captured/recorded business intent parameters for the organization user) or a non-empty set (i.e., including at least one captured/recorded business intent parameter for the organization user).

In Step 1008, a metadata graph is obtained. In one or many embodiment(s) disclosed herein, the metadata graph may refer to a connected graph (see e.g., FIG. 2A) representative of an asset catalog. To that end, the metadata graph may include a set of nodes interconnected by a set of edges, where the set of nodes are representative of asset catalog entries and the set of edges are representative of connections or relationships there-between. Further, each node may pertain to a given asset (e.g., any existing structured and/or unstructured form of information), where the representative asset catalog entry thereof may store metadata for, or information descriptive of, the given asset.

Examples of said asset metadata may include, but is not limited to: a brief description of the asset; stewardship (or ownership) information (e.g., individual or group name(s), contact information, etc.) pertaining to the steward(s)/owner(s) of the asset; a version character string reflective of a version or state of the asset at/for a given point-in-time; one or more categories, topics, and/or aspects associated with the asset; an asset identifier uniquely identifying the asset; one or more tags, keywords, or terms further describing the asset; a source identifier and/or location associated with an internal or external data source (see e.g., FIG. 1) where the asset resides or is maintained; and compliance information specifying laws, regulations, and standards surrounding the asset, as well as policies directed to data governance (e.g., availability, usability, integrity, and security) pertinent to the asset. The asset metadata for any asset is not limited to the aforementioned specific examples.

In Step 1010, the metadata graph (obtained in Step 1008) is filtered based on the search topic (received via the search query in Step 1000). In one or many embodiment(s) disclosed herein, filtering of the metadata graph may, for example, entail topic matching (e.g., case-insensitive word or phrase matching) between the search topic and the asset metadata for assets catalogued in the asset catalog entries of which nodes of the metadata graph are representative. Further, filtering of the metadata graph based on the search topic may result in the identification of a node subset of the set of nodes forming the metadata graph. The identified node subset, subsequently, may include one or more nodes representative of one or more assets, respectively, that may be associated with the search topic.

In Step 1012, for each known business intent parameter of the known business intent parameter(s) (if any) (extracted in Step 1006), the metadata graph (obtained in Step 1004) is filtered based on the known business intent parameter. In one or many embodiment(s) disclosed herein, filtering of the metadata graph may, for example, entail topic matching (e.g., case-insensitive word or phrase matching) between a given known business intent parameter and the asset metadata for assets catalogued in the asset catalog entries of which nodes of the metadata graph are representative. Further, for each known business intent parameter, the filtering of the metadata graph based thereon may result in the identification of a node subset of the set of nodes forming the metadata graph. The identified node subset, subsequently, may include one or more nodes representative of one or more assets, respectively, that may be associated with the known business intent parameter.

In Step 1014, a k-partite metadata graph is generated using the node subsets (identified collectively in Steps 1010 and 1012). In one or many embodiment(s) disclosed herein, the k-partite metadata graph (see e.g., FIGS. 2B-2D) may reflect a new representation of, which may be based on one or more particular perspectives on, the metadata graph (obtained in Step 1006). The k-partite metadata graph, further, may reflect a connected graph that encompasses k independent sets of nodes (i.e., the node subset(s), where k equals the number or cardinality of node subset(s)) and a set of edges interconnecting (and thus defining relationships between) pairs of nodes each belonging to a different independent set of nodes (or node subset)—with the exception of uni-(k=1) partite metadata graphs (see e.g., FIG. 2B) where the set of edges interconnect nodes of the single independent set of nodes (or single node subset) forming the uni-partite metadata graphs.

Turning to FIG. 10B, in Step 1016, one or more super nodes, in/of the k-partite metadata graph (generated in Step 1014), is/are identified. In one or many embodiment(s) disclosed herein, a super node may refer to a densely connected node or a node with a disproportionately high number of edges connected thereto. Additionally, or alternatively, a super node may be identified as any node representing a most connected node (e.g., any node that serves as an endpoint of a pair of endpoints to a highest number of edges) in the k-partite metadata graph, which may otherwise be defined as any node that serves as an endpoint of a pair of endpoints to a number of edges, where the number of edges meets or exceeds a threshold number of edges (that may be dynamically set). For example, the threshold number of edges may be set to ten edges, where any node(s) in the k-partite metadata graph that serves as an endpoint (of a pair of endpoints) to at least ten edges may be classified or labeled as a super node in/of the k-partite metadata graph.

Additionally, or alternatively, one or more most connected nodes, within one or more metadata subgraphs in/of the k-partite metadata graph (generated in Step 1014), is/are identified. In one or many embodiment(s) disclosed herein, a metadata subgraph may generally refer to a connected graph that may be found within, and therefore may include at least a portion of the elements (e.g., a set of nodes interconnected by a set of edges) forming, a larger connected graph (e.g., the k-partite metadata graph). A most connected node within any metadata subgraph, accordingly, may be defined as any node found within the metadata subgraph that serves as an endpoint of a pair of endpoints to a second number of edges, where the second number of edges meets or exceeds a second threshold of edges (that may be dynamically set). For example, the second threshold of edges may be set to ten edges, where any node(s) found within any given metadata subgraph(s), in the k-partite metadata graph, that serves as an endpoint (of a pair of endpoints) to at least ten edges may be classified or labeled as a most connected node in/of the given metadata subgraph.

Additionally, or alternatively, one or more other nodes, which may be found in the k-partite metadata graph (generated in Step 1014), is/are identified. In one or many embodiment(s) disclosed herein, the other node(s) may be identified based on the satisfaction of one or more other criteria. Examples of said criteria may include, but is not limited to: whether a node is positioned along a longest path traversing the k-partite metadata graph; and whether a node is positioned along a shortest path traversing the k-partite metadata graph.

In one or many embodiment(s) disclosed herein, the collective number of super node(s), most connected node(s), and other node(s) (identified in Step 1016) may be directly correlated to the set of known business intent parameter(s) (extracted in Step 1006). That is, the more business intent parameters captured/recorded for the organization user, and thus reflective of the set of known business intent parameter(s), the more super node(s), most connected node(s), and/or other node(s) that may be identified.

In Step 1018, for each super node, most connected node, or other node (identified in Step 1016), at least a portion of asset metadata, for an asset (e.g., any existing structured and/or unstructured form of information) corresponding to the super node, most connected node, or other node, is extracted. In one or many embodiment(s) disclosed herein, the extracted portion of asset metadata may include, but is not limited to, stewardship (or ownership) information and compliance information (both briefly defined above—see e.g., Step 1008) associated with the asset.

In Step 1020, the user access permissions (obtained in Step 1002), associated with the organization user, is assessed against the compliance information (extracted in Step 1018) associated with one or more assets. In one or many embodiment(s) disclosed herein, the asset(s) may map to asset catalog entry/entries represented by the super node(s), most connected node(s), and/or other node(s) (identified in Step 1016).

Further, assessment of the user access permissions, against the asset compliance information, may, for example, entail determining: whether a geographical location of the organization user is within the geographical restrictions or boundaries, at least in part, defining access to an asset; whether the organization, with which the organization user is associated, is of a particular type (e.g., a commercial business, an educational institution, etc.) to which access and usability of an asset is granted; and whether one or more organization roles (e.g., title(s) and/or position(s)) and/or professional affiliation(s) (e.g., membership(s) to professional organization(s)), with which the organization user is associated, satisfies criteria for permitting access to an asset.

Moreover, the above-mentioned assessment, between the user access permissions and the asset compliance information, may result in producing access remarks that concern the asset(s) associated with the extracted compliance information. In one or many embodiment(s) disclosed herein, any access remarks may refer to information expressing whether the asset(s) is/are accessible or inaccessible to/by the organization user. Said information (for any given asset) may include, but is not limited to: an accessibility statement indicating that the given asset can or cannot be accessed by the organization user; one or more reasons explaining or supporting the accessibility statement; a digital reference link (e.g., uniform resource locator or hyperlink) or an access protocol through which the organization user can access the given asset should the accessibility statement indicate that the given asset can be accessed by the organization user; and/or the stewardship information (extracted in Step 1018) associated with the given asset should the accessibility statement alternatively indicate that the given asset cannot be accessed by the organization user.

In one or many embodiment(s) disclosed herein, stewardship information may be integrated, as part of the access remarks for a given asset (if applicable—e.g., if the given asset is deemed inaccessible), in order to provide the organization user with an opportunity to potentially gain access to the given asset through communications with the steward(s) or owner(s) of the given asset. The potential to gain access to the given asset through this avenue, however, may be moot or disregarded in view of other, higher-tiered compliance policies such as those outlined by geographical restrictions, as well as national and/or international laws, regulations, and standards.

In Step 1022, an asset availability, for each of one or more assets (e.g., any existing structured and/or unstructured form of information), is determined. In one or many embodiment(s) disclosed herein, the asset(s) may map to asset catalog entry/entries represented by the super node(s), most connected node(s), and/or other node(s) (identified in Step 1016). Further, the determination of asset availability for any given asset may, for example, entail the submission of an asset availability query to an appropriate (i.e., internal or external) data source identified in the asset metadata describing the given asset. Any asset availability query may include or specify an asset identifier (also found in the asset metadata) that uniquely identifies the given asset. Moreover, in response to any asset availability query, a corresponding asset availability reply may be received, which may include or specify an asset availability state indicating whether the given asset is available (e.g., obtainable, usable, or reachable) or unavailable (e.g., unobtainable, unusable, or unreachable). Thereafter, the returned asset availability state(s) for the asset(s), respectively, may be used to produce availability remarks concerning the asset(s). Any availability remarks may refer to information expressing whether the asset(s) is/are available or unavailable at/on one or more data sources that the asset(s) currently reside, or at one time, had resided.

In Step 1024, a business intent score, associated with the organization user, is computed. In one or many embodiment(s) disclosed herein, the business intent score may refer to a measurable degree to which the set of business intent parameters, representative of the business intent and/or user business intent model (obtained in Step 1004) for the given organization user, may be known or captured at any given point-in-time. The business intent score, accordingly, may be based on or derived from the user business intent model or, more specifically, the set of known business intent parameters (extracted in Step 1006). Further, by way of an example, the business intent score may be expressed as a percentage value reflecting a proportion or ratio of captured/recorded business intent parameter(s) to an entirety or total of business intent parameter(s).

In Step 1026, search results are created. In one or many embodiment(s) disclosed herein, the search results may include or specify a manifest (or listing) of the asset(s) mapped to asset catalog entry/entries represented by the super node(s), most connected node(s), and/or other node(s) (identified in Step 1016), the access remarks (produced in Step 1020), the availability remarks (produced in Step 1022), and the business intent score (computed in Step 1024).

In one or many embodiment(s) disclosed herein, a recall may describe (or may be associated with) the above-mentioned manifest of asset(s). With respect to relevant information returned (e.g., the manifest of asset(s)) in response to any given search query (e.g., the search query received in Step 1000), recall may refer to a measure of search relevance thereof or, more specifically, may reflect a percentage or quantity of said returned relevant information. Subsequently, a higher recall may be indicative of a larger set of relevant information (e.g., the more assets may be listed in the manifest of asset(s)) that may be returned to address the search query. Further, said recall describing the manifest of asset(s) may be contingent (or depend) on a completeness (described above) of the user business intent model (obtained in Step 1004). That is, the higher the number of known business intent parameters (extracted in Step 1006), the higher the recall and, by association, the higher the percentage or quantity of returned relevant information.

In Step 1028, the search results (created in Step 1026) are provide in response to the search query (received in Step 1000). Particularly, in one or many embodiment(s) disclosed herein, the search results may be provided to the organization user who had submitted the search query.

FIG. 11 shows a flow chart describing a method for insight gap recommendations in accordance with one or more embodiments disclosed herein. The various steps outlined below may be performed by an insight service (see e.g., FIG. 1). Further, while the various steps in the flowchart are presented and described sequentially, one of ordinary skill will appreciate that some or all steps may be executed in different orders, may be combined or omitted, and some or all steps may be executed in parallel.

Turning to FIG. 11, in Step 1100, a gap query is received. In one or many embodiment(s) disclosed herein, the gap query may include or specify one or more research areas. A research area may refer to a broad subset of any space (e.g., science, technology, business/commercial, or any other discipline) in which research, pertaining to that space, may be pursued. As such, the gap query may have been submitted by an (inquiring) organization user, and may represent an inquiry, by said (inquiring) organization user, with regards to isolating one or more gaps, or sparsely catalogued research subarea(s) (described below), that reflect a future worth and effort in pursuing.

In Step 1102, for each research area of the research area(s) (received via the gap query in Step 1100), a research area taxonomy is obtained. In one or many embodiment(s) disclosed herein, a research area taxonomy, for any given research area, may refer to a classification schema that reflects the interrelations between a set of research subareas of the given research area. Each research subarea may represent a more specific subject or topic within, and that may be classified under, the given research area or a less specific (i.e., broader) research subarea. Further, the research area taxonomy may be expressed and/or structured in one of existing many forms—e.g., as a hierarchical taxonomy, a faceted taxonomy, etc.

By way of an example, consider a research area of propulsion systems deployed in outer space. A non-limiting research area taxonomy, respective to space propulsion systems, may include the following research subareas (organized or classified in the following hierarchical manner):

### Space Propulsion Systems (Research Area)

1. Chemical Propulsion (Research Subarea of Research Area)
   1.1 Earth Storable (Research Subarea of Research Subarea)
   1.2 Cryogenic (Research Subarea of Research Subarea)
   1.3 Solids (Research Subarea of Research Subarea)
   1.4 Hybrids (Research Subarea of Research Subarea)
   1.5 Gels (Research Subarea of Research Subarea)
   1.6 Cold Gas (Research Subarea of Research Subarea)
   1.7 Warm Gas (Research Subarea of Research Subarea)
2. Electrical Propulsion (Research Subarea of Research Area)
   2.1 Electrostatic (Research Subarea of Research Subarea)
   2.2 Electromagnetic (Research Subarea of Research Subarea)
   2.3 Electro-thermal (Research Subarea of Research Subarea)
3. Aero Propulsion (Research Subarea of Research Area)
   3.1 Turbine Based Combined Cycle (Research Subarea of Research Subarea)
   3.2 Rocket Based Combined Cycle (Research Subarea of Research Subarea)
   3.3 Pressure Gain Combustion (Research Subarea of Research Subarea)
   3.4 Turbine Based Jet Engine (Research Subarea of Research Subarea)
   3.5 Ramject/Scramjet (Research Subarea of Research Subarea)
   3.6 Reciprocating Internal Combustion (Research Subarea of Research Subarea)
   3.7 All Electric Propulsion (Research Subarea of Research Subarea)
   3.8 Hybrid Electric Systems (Research Subarea of Research Subarea)
   3.9 Turboelectric Propulsion (Research Subarea of Research Subarea)
4. Advanced Propulsion (Research Subarea of Research Area)
   4.1 Solar Sails (Research Subarea of Research Subarea)
   4.2 Electromagnetic Tethers (Research Subarea of Research Subarea)
   4.3 Nuclear Thermal Propulsion (Research Subarea of Research Subarea)

In Step 1104, an asset metadata graph is obtained. In one or many embodiment(s) disclosed herein, the asset metadata graph may refer to a connected graph (see e.g., FIG. 2A) representative of an asset catalog. To that end, the asset metadata graph may include a set of nodes interconnected by a set of edges, where the set of nodes are representative of asset catalog entries and the set of edges are representative of connections or relationships there-between. Further, each node may pertain to a given asset (e.g., a research journal article, a research white paper, a research dissertation or thesis, or any other form of information describing one or more research subareas), where the representative asset catalog entry thereof may store metadata for, or information descriptive of, the given asset.

Examples of said asset metadata may include, but is not limited to: a brief description of the asset; stewardship (or ownership) information (e.g., individual or group name(s), contact information, etc.) pertaining to the steward(s)/owner(s) of the asset; a version character string reflective of a version or state of the asset at/for a given point-in-time; one or more research areas and/or one or more research subareas (e.g., categories, topics, and/or aspects) associated with the asset; an asset identifier uniquely identifying the asset; one or more tags, keywords, or terms further describing the asset; a source identifier and/or location associated with an internal or external data source (see e.g., FIG. 1) where the asset resides or is maintained; and compliance information specifying laws, regulations, and standards surrounding the asset, as well as policies directed to data governance (e.g., availability, usability, integrity, and security) pertinent to the asset. The asset metadata for any asset is not limited to the aforementioned specific examples.

In Step 1106, for each research subarea (identified in Step 1102) across each research area (received via the gap query in Step 1100), the asset metadata graph (obtained in Step 1104) is filtered based on the research subarea. In one or many embodiment(s) disclosed herein, filtering of the asset metadata graph may, for example, entail topic matching (e.g., case-insensitive word or phrase matching) and/or semantic similarity calculation between the research subarea and the asset metadata for assets catalogued in the asset catalog entries of which nodes of the asset metadata graph are representative. Further, for each research subarea, the filtering of the asset metadata graph based thereon may result in the identification of an asset node subset of the set of nodes forming the asset metadata graph. The identified asset node subset, subsequently, may include one or more nodes representative of one or more assets, respectively, that may at least be associated with the research subarea.

In Step 1108, a k-partite metadata graph is generated using the asset node subset(s) (identified in Step 1106). In one or many embodiment(s) disclosed herein, the k-partite metadata graph (see e.g., FIGS. 2B-2D) may reflect a new representation of, which may be based on one or more particular perspectives on, the asset metadata graph (obtained in Step 1104). The k-partite metadata graph, further, may reflect a connected graph that encompasses k independent sets of nodes (i.e., the asset node subset(s), where k equals the number or cardinality of asset node subset(s)) and a set of edges interconnecting (and thus defining relationships between) pairs of nodes each belonging to a different independent set of nodes (or asset node subset)—with the exception of uni-(k=1) partite metadata graphs (see e.g., FIG. 2B) where the set of edges interconnect nodes of the single independent set of nodes (or single asset node subset) forming the uni-partite metadata graphs.

In Step 1110, one or more anti-super nodes, in/of the k-partite metadata graph (generated in Step 1108), is/are identified. In one or many embodiment(s) disclosed herein, an anti-super node may refer to a minimally connected node or a node with a disproportionately low number of edges connected thereto. Additionally, or alternatively, an anti-super node may be identified as any node that serves as an endpoint of a pair of endpoints to a number of edges, where the number of edges falls below a threshold number of edges (that may be dynamically set). For example, the threshold number of edges may be set to three edges, where any node(s) in the k-partite metadata graph that serves as an endpoint (of a pair of endpoints) to no more than two edges may be classified or labeled as an anti-super node in/of the k-partite metadata graph.

Additionally, or optionally, in Step 1112, for each anti-super node of the anti-super node(s) (identified in Step 1110), one or more weak adjacent nodes, in/of the k-partite metadata graph (generated in Step 1108), is/are identified. In one or many embodiment(s) disclosed herein, with respect to a given anti-super node, a weak adjacent node linked to the given anti-super node may refer to a node connected thereto via an edge representative of a weak relationship there-between. Quantification of said weak relationship may, for example, entail an edge weight assigned to the edge interconnecting the given anti-super node and the weak adjacent node, where the edge weight (e.g., expressed as a numerical value) falls or lies below an edge weight threshold. The edge weight threshold, in turn, may be dynamically set and may denote the criterion for determining whether the associated edge is reflective of a weak relationship between a pair of assets (e.g., research journal articles, research white papers, research dissertations or theses, or any other forms of information each describing one or more research subareas) corresponding to the given anti-super node and a weak adjacent node.

In Step 1114, the anti-super node(s) (identified in Step 1110) is/are mapped, respectively, to one or more gap research subareas. That is, in one or many embodiment(s) disclosed herein, the mapping, for a given anti-super node, may entail: identifying, of the asset catalog (represented by the asset metadata graph obtained in Step 1104), an asset catalog entry corresponding to the given anti-super node; identifying, of a plethora of assets for which asset metadata thereof may be catalogued by the insight service, an asset corresponding to the identified asset catalog entry; and identifying, from amongst the asset metadata of the identified asset, at least one research subarea specified therein with which the identified asset may be associated. The aforementioned, identified research subarea(s) may also be referred to herein as gap research subarea(s).

Additionally, or optionally, the weak adjacent node(s) (identified in Step 1112) is/are mapped, respectively, to one or more gap research subareas. In one or many embodiment(s) disclosed herein, the mapping, for a given weak adjacent node, may follow a substantially similar procedure as the one described above with respect to anti-super nodes.

In Step 1116, a user metadata graph is obtained. In one or many embodiment(s) disclosed herein, the user metadata graph may refer to a connected graph (see e.g., FIG. 2A) representative of a user catalog. To that end, the user metadata graph may include a set of nodes interconnected by a set of edges, where the set of nodes are representative of user catalog entries (also referred to herein as user profiles) and the set of edges are representative of connections or relationships there-between. Further, each node may pertain to a given organization user within an organization (e.g., a commercial business, an educational institution, etc.) where the representative user catalog entry (or user profile) thereof may store metadata for, or information descriptive of, the given organization user.

In one or many embodiment(s) disclosed herein, a user profile for any given organization user may refer to a collection of settings and information associated with the given organization user. Examples of said user metadata (or collection of settings/information) may include, but is not limited to: one or more user identifiers (e.g., a username assigned to the given organization user within an organization, the personal name with which the given organization user may be referred, etc.); one or more user domains (e.g., one or more subjects, topics, specialties, and/or interests (e.g., one or more research areas and/or one or more research subareas) to which the given organization user contributes and in which the given organization user may be knowledgeable; and user contact information (e.g., personal and/or organization phone number(s) through which the given organization user may be reached via existing telephonic technologies, personal and/or organization email address(es) through which the given organization user may be reached via existing electronic mail technologies, etc.). User metadata is not limited to the aforementioned specific examples.

In Step 1118, for each gap research subarea of the gap research subarea(s) (mapped to in Step 1114), the user metadata graph (obtained in Step 1116) is filtered based on the gap research subarea. In one or many embodiment(s) disclosed herein, filtering of the user metadata graph may, for example, entail topic matching (e.g., case-insensitive word or phrase matching) and/or semantic similarity calculation between a given gap research subarea and the user metadata for organization users catalogued in the user catalog entries (or user profiles) of which nodes of the user metadata graph are representative. Further, for each gap research subarea, the filtering of the user metadata graph based thereon may result in the identification of a user node subset of the set of nodes forming the user metadata graph. The identified user node subset, subsequently, may include one or more nodes representative of one or more organization users, respectively, that may at least be associated with (or knowledgeable in and thus suited or capable of pursuing/developing insight(s) pertaining to) the gap research subarea.

In Step 1122, the gap research subarea(s) (mapped to in Step 1114) is/are provided in response to the gap query (received in Step 1100). Particularly, in one or many embodiment(s) disclosed herein, the gap research subarea(s) may be provided to the organization user who had submitted the gap query. Further, the organization user(s) (mapped to in Step 1120), corresponding to each gap research subarea, may additionally be provided in response to the gap query.

FIGS. 12A-12D show flowcharts describing a method for insight value assessments using post-insight feedback in accordance with one or more embodiments disclosed herein. The various steps outlined below may be performed by an insight service (see e.g., FIG. 1A). Further, while the various steps in the flowchart are presented and described sequentially, one of ordinary skill will appreciate that some or all steps may be executed in different orders, may be combined or omitted, and some or all steps may be executed in parallel.

Turning to FIG. 12A, in Step 1200, an insight, an insight lineage graph, and an insight record are obtained. In one or many embodiment(s) disclosed herein, the insight may be defined as a finding (or more broadly, as useful knowledge) gained through data analytics or, more precisely, through the discovery of patterns and/or relationships amongst any given assortment of data/information. The insight lineage graph, on the other hand, may refer to a connected graph (see e.g., FIG. 2A) representative of the insight record (or, more specifically, of a set of insight component records thereof). To that end, an insight lineage graph may include a set of nodes interconnected by a set of edges, where the set of nodes are representative of (and thus map/correspond to) the set of insight component records (described below) and the set of edges are representative of connections or relationships there-between. Further, each node may pertain to a given object (described below) referenced by a given insight component of the insight, where the representative insight component record thereof may store insight component metadata for, or information descriptive of, the given insight component and/or the referenced given object.

Further, in one or many embodiment(s) disclosed herein, the insight record may refer to a portion of an insight catalog particularly dedicated to storing insight metadata, for the insight, and insight component metadata for a set of insight components. The aforementioned insight catalog may represent a data structure configured to maintain insight component metadata that describes one or more creation aspects (also referred to herein as insight component(s)) pertaining to a set of existing insights. Each existing insight, in the set of existing insights, may refer to an insight of which a respective insight creation process has already begun either by an organization user or the insight service. Further, the insight catalog may include, and may thus be organized through, a set of insight records (including the insight record), where each insight record corresponds to a given existing insight (e.g., the insight) in the set of existing insights. Each insight record, moreover, may include (individual) insight metadata (described below) and a set of insight component records, where each insight component record: corresponds to a given insight component, in a set of insight components, associated with a given existing insight to which the insight record corresponds; and stores (individual) insight component metadata (described below) particular to the given insight component to which the insight component record corresponds.

In one or many embodiment(s) disclosed herein, any insight component, associated with any given insight, may reference an object that contributed to the creation of the given insight. Examples of any object that may be referenced by any insight component, associated with any given insight, may include: any structured or unstructured form of information (e.g., tabular data or a dataset, text, a data graphic visualizing tabular data, an image, an audio track, a video clip, etc.); any information processing algorithm (e.g., a machine learning model, a dataset editing algorithm, a text editing algorithm, an image editing algorithm, an audio editing algorithm, a video editing algorithm, etc.) configured to process one or more forms of information; and any other insight (i.e., that is not the given insight with which the insight component is originally associated). Further, any insight component is not limited to the aforementioned specific examples.

Examples of (individual) insight component metadata, respective to any given insight component, may include: a program name associated with any insight editing program within which a creation, importation, editing, and/or processing of an object (described and exemplified above) referenced by the given insight component may be enabled/facilitated; a filename associated with an insight editing file within which the object referenced by the given insight component had been (or is being) created, imported, edited, and/or processed; the object (or a storage location thereof) to which the given insight component references; a context reflecting a usage of the given insight component; if the given insight component references any structured/unstructured form of information—a source of said information, any pipeline(s) used to produce said information, any access permissions associated with said information, a format of said information, a version associated with said information, and a last modified/updated timestamp for said information; if the given insight component references any processing algorithm—a version associated with said algorithm, a source code implementing said algorithm, any dataset(s) used in a training and/or validation of said algorithm (if applicable such as if the algorithm is machine learning based), and one or more authors/creators of said algorithm; and if the given insight component references any other insight—any subset or all of the above examples respective to any information and any algorithms applied thereto that contributed towards producing said other insight. Furthermore, the (individual) insight component metadata, respective to any given insight component, is not limited to the aforementioned specific examples.

Examples of (individual) insight metadata, respective to any given insight, may include: a storage location at which the given insight may be stored; at least a portion of any available insight editing file metadata (e.g., author, creation timestamp, last modified timestamp, etc.) describing the insight editing file within which the given insight had been (or is being) created and/or edited; an insight lineage graph (described below) (or a storage location thereof) associated with the given insight; one or more contexts reflecting a utilization of the given insight; and any user/author metadata (e.g., organization role(s), social network(s), etc.) describing an original creator of the given insight. Further, the (individual) insight metadata, respective to any given insight, is not limited to the aforementioned specific examples.

In Step 1202, a digital tracking tag is embedded within the insight (obtained in Step 1200). In one or many embodiment(s) disclosed herein, the digital tracking tag may represent embeddable computer readable program code configured, or directed, to enabling a tracing of any usage of the insight as any asset(s), incorporating the insight (or any variations thereof), is/are ingested and catalogued by the insight service. Further, in embedding the digital tracking tag within the insight, a traceable insight may be obtained.

In Step 1204, the insight record (obtained in Step 1200) is updated. Specifically, in one or many embodiment(s) disclosed herein, the insight record may be updated to further include a tag identifier (ID) associated with, and there uniquely identifying, the digital tracking tag (embedded in Step 1202).

In Step 1206, an incorporation of the traceable insight (obtained in Step 1202), into a base asset, is detected. In one or many embodiment(s) disclosed herein, the base asset may refer to any first or original asset within which the traceable insight may be incorporated as at least a portion of the asset content presented there-throughout. Further, the base asset may generally refer to any asset originating (e.g., instantiated, or created, and completed) from within (or internal to) an organization-internal environment (see e.g., FIG. 1A) belonging and managed by an organization. Detection of said incorporation of the traceable insight, moreover, may, for example, involve the receiving of telemetry from one or more insight agents (see e.g., FIG. 1B) executing on a client device operated by an organization user whom conducted said incorporation using any insight editing program (described below), where the employed insight editing program may also execute on the aforementioned client device. The insight agent(s), accordingly, may be embedded within, or may otherwise be associated with, the employed insight editing program.

In one or many embodiment(s) disclosed herein, any insight editing program may refer to any software application configured for insight creation and/or editing. Examples of the insight editing program may include, an artificial intelligence and/or machine learning based inference computer program, a text editor, a spreadsheet editor, a presentation editor, an integrated development environment (IDE), an audio editor, a video editor, and an image and/or graphic editor. The insight editing program is not limited to the aforementioned specific examples.

In one or many embodiment(s) disclosed herein, following incorporation of traceable insight within the base asset, and/or following a completion of the base asset, the organization user (responsible for instantiating, or creating, and thus completing the base asset) may opt to store the completed, or an incomplete, base asset on one or more internal and/or external data source(s) (see e.g., FIG. 1A).

In Step 1208, the insight record (obtained in Step 1200) is updated further. Specifically, in one or many embodiment(s) disclosed herein, the insight record may be updated to further include base asset metadata describing the base asset (mentioned in Step 1206). Examples of base asset metadata may include: a filename, or any equivalent identifier, which may uniquely identify the base asset; an author name (or username) associated with an author or creator of the base asset; a creation timestamp encoding a date and/or time at which the base asset had been instantiated or created; and a last modified timestamp encoding a date and/or time at which the base asset had been modified last. Further, the base asset metadata is not limited to the aforementioned specific examples.

In Step 1210, and over time, the traceable insight (incorporated in the base asset in Step 1206) may be repeatedly re-used, or plagiarized, by other organization user(s) (e.g., whom is/are not the original organization user credited with originally instantiating/creating the insight (obtained in Step 1200) from which the traceable insight is derived), as well as by other individual(s) not affiliated with an organization with which at least the original organization user and the other organization user(s) may be associated. Further, any time the traceable insight may be re-used, an original state of the traceable insight may be retained and thus used by a plagiarist. Alternatively, any time the traceable insight may be re-used, a plagiarist may modify (via the application of one or more modifications to) the original state of the traceable insight to obtain a variation of the traceable insight (also referred to herein as a modified traceable insight). Moreover, whether the traceable insight retains its original state or is modified, any re-use (or plagiarism) of the traceable insight may be incorporated into one or more new assets authored/created by any one or more plagiarist(s). The aforementioned new asset(s), subsequently, may encompass at least a new asset subset, in a set of new assets, that may be stored (in a completed or incomplete state) across one or more internal and/or external data sources.

In one or many embodiment(s) disclosed herein, Step 1210 may transpire at any time following a storage of the base asset (mentioned in Step 1206) across one or more internal and/or external data sources. Further, Step 1210 may serve as background filler information describing events, entailing the traceable insight, which may transpire in the background while the disclosed method may be progressing. Accordingly, Step 1210 is not representative of an operation that may be performed by the insight service with or without assistance through one or more insight agents.

Returning to the disclosed method, in Step 1212, one or more data sources is/are examined. In one or many embodiment(s) disclosed herein, the data source(s) may include one or more internal data sources and/or one or more external data sources. Further, examination of the data source(s) may be a periodic operation, performed by the insight service, in order to periodically update an asset catalog (described below) maintained thereby. Examination of the data source(s) may, subsequently, result in the identification of a set of, or at least one, new asset that has yet to be catalogued by the insight service.

Hereinafter, the remaining steps (e.g., Step 1214 through Step 1252) may collectively represent an outer iteration, which may be performed sequentially or in parallel for each new asset of the new asset(s) (identified in Step 1212).

In Step 1214, a/the new asset (identified in Step 1212) is ingested. In one or many embodiment(s) disclosed herein, ingestion of a/the new asset may, for example, entail any existing data/content scraping technique(s) through which asset metadata (examples of which are disclosed below), describing a/the new asset, may be extracted, or otherwise obtained, therefrom. Further, ingestion of a/the asset may further result in identifying and/or obtaining asset content (e.g., item(s) of data/information in one or more forms or formats) presented through a/the new asset.

Examples of said asset metadata may include, but is not limited to: a brief description of a/the asset; stewardship (or ownership or authorship) information (e.g., individual or group name(s), contact information, etc.) pertaining to the steward(s)/owner(s)/author(s) of a/the asset; a version character string reflective of a version or state of a/the asset at/for a given point-in-time; one or more categories, topics, and/or aspects associated with a/the asset; an asset identifier uniquely identifying a/the asset; one or more tags, keywords, or terms further describing a/the asset; a source identifier and/or location associated with an internal or external data source (see e.g., FIG. 1A) where a/the asset resides or is maintained; and compliance information specifying laws, regulations, and standards surrounding a/the asset, as well as policies directed to data governance (e.g., availability, usability, integrity, and security) pertinent to a/the asset. The asset metadata for any asset is not limited to the aforementioned specific examples.

Turning to FIG. 12B, in Step 1216, an asset catalog is updated using the asset metadata (obtained in Step 1214). In one or many embodiment(s) disclosed herein, the asset catalog may refer to a data structure that maintains (aggregated) asset metadata describing a set of assets (e.g., a collection of structured information/content such as tabular data or datasets, and/or of unstructured information/content such as text, videos, images, audio, multimedia, etc.). The asset catalog, further, may organize said (aggregated) asset metadata across a set of asset catalog entries. Each asset catalog entry, in the set of asset catalog entries, may pertain to an asset in the set of assets and, therefore, may store (individual) asset metadata particular to said asset. Accordingly, an updating of the asset catalog, using the asset metadata (obtained in Step 1214), may entail: a creation of a new asset catalog entry, in the asset catalog, that may pertain to a/the new asset (identified in Step 1212); and a storage of the obtained asset metadata, descriptive of a/the new asset, within the new asset catalog entry.

In Step 1218, the asset content (identified/obtained in Step 1212) is scanned. In one or many embodiment(s) disclosed herein, scanning of the asset content may employ any existing content scanning technique(s) particularly focused on searching for and identifying any digital tracking tag(s) embedded within any portion(s) of (e.g., one or more items of data/information forming) the asset content.

In Step 1220, a determination is made as to whether any (e.g., at least one) digital tracking tag(s) had been discovered based on a scanning (performed in Step 1218) of the asset content (identified/obtained in Step 1212). In one or many embodiment(s) disclosed herein, if it is determined that at least one digital tracking tag had been discovered, then the method proceeds to Step 1222. On the other hand, in one or many other embodiment(s) disclosed herein, if it is determined that zero digital tracking tags had been discovered. Then the method alternatively proceeds to Step 1214 (described above—see e.g., FIG. 12A), where another new asset (if any) (identified in Step 1212) may be ingested.

Hereinafter, the remaining steps (e.g., Step 1222 through Step 1252) may collectively represent an inner iteration, which may be performed sequentially or in parallel for each digital tracking tag of the digital tracking tag(s) (discovered through asset content scanning performed in Step 1218).

In Step 1222, following a determination (made in Step 1220) that at least one digital tracking tag had been discovered (based on the scan performed in Step 1218), a tag ID is obtained. In one or many embodiment(s) disclosed herein, the tag ID may be associated with, and thus may uniquely identify, a/the digital tracking tag (discovered in Step 1218).

In Step 1224, a search is performed across the insight catalog (described above—see e.g., Step 1200) using the tag ID (obtained in Step 1222). In one or many embodiment(s) disclosed herein, the search may be performed in an attempt to identify any insight record, in the set of insight records included in the insight catalog, that stores the tag ID.

In Step 1226, a determination is made, based on the search (performed in Step 1224), as to whether an insight record had been identified, where the insight record (if identified), and as mentioned above, includes the tag ID used to perform the search. As such, in one or many embodiment(s) disclosed herein, if it is determined that an insight record had been identified, then the method proceeds to Step 1228. On the other hand, in one or many other embodiment(s) disclosed herein, if it is alternatively determined that an insight record had not been identified, then the method alternatively proceeds to Step 1214 (described above—see e.g., FIG. 12A), where another new asset (if any) (identified in Step 1212) may be ingested.

In Step 1228, following a determination (made in Step 1226) that an insight record, in a set of insight records included in the insight catalog, had been identified based on the search (performed in Step 1224), an asset content component is identified from the asset content (identified/obtained in Step 1214). In one or many embodiment(s) disclosed herein, the asset content component may refer to an item of data/information (e.g., in the form of any existing structured or unstructured data/information format) of any number of items of data/information collectively forming the asset content. Further, the identified asset content component may be associated, or may be embedded, with a/the digital tracking tag (discovered in Step 1218). Moreover, as the tag ID (obtained in Step 1222) of a/the digital tracking tag had been determined (via Step 1226) to correspond to an identified insight record (and, thus by association, an existing insight respective to the identified insight record), then the identified asset content component may also be identified as a re-used traceable insight derived from or related to the aforementioned existing insight).

In Step 1230, one or more bias-removing actions is/are performed, which involve or relate to the re-used traceable insight (identified in Step 1228). In one or more embodiment(s) disclosed herein, a bias-removing action may refer to an operation that minimizes, if not eliminates, bias(es) across one or more insight inference models that may be implemented/employed by the insight model. Said bias(es), further, may be caused by any re-used and (re-)ingested insight(s) (e.g., as originally produced or including at least one modification during any re-use(s) thereof) that the insight service is unaware is/are insight(s) derived or inferred through one or more capabilities (or functionalities) of the insight service itself. Examples of the bias-removing action(s) may include: identifying said previously produced insight(s) (e.g., the re-used traceable insight) and omitting the identified previously produced insight(s) from the training dataset(s) employed in a training of prospective insight generating model(s) (e.g., machine learning model(s)) as well as from the inferencing dataset(s) processed by said prospective insight generating model(s) leading to the inference of prospective insight(s); and utilizing any existing causal inference framework(s) to verify whether the re-used traceable insight causes bias, and if so, omitting the re-used traceable insight, as described above, from future insight generation processes. Moreover, any bias-removing action(s) is/are not limited to the aforementioned specific examples.

Turning to FIG. 12C, in Step 1232, an (existing) insight is obtained. In one or many embodiment(s) disclosed herein, the (existing) insight may correspond to the insight record (identified by the search performed in Step 1224).

In Step 1234, one or differentiation algorithm(s) is/are applied to, or between, the insight (obtained in Step 1232) and the re-used traceable insight (identified in Step 1228). In one or many embodiment(s) disclosed herein, any differentiation algorithm may refer to a process, a model, a set of rules, etc. configured to examine/analyze two items of data/information, of a same/common form or format, and identify any difference(s) differentiating said two items of data/information. Examples of said applied differentiating algorithm(s) may include: (a) for text formatted items of data/information—a Myers O(ND) Diff algorithm; (b) for image/graphic formatted items of data/information—a Scale Invariant Feature Transform (SIFT) algorithm; and (c) for video formatted items—a frame-by-frame comparison algorithm. Further any applied differentiation algorithm(s) is/are not limited to the aforementioned specific examples. Any difference(s) (if identified), moreover, may correspond to any modification(s) applied to the insight to derive the re-used traceable insight.

In Step 1236, a determination is made as to whether any (e.g., at least one) difference(s) had been identified between the insight (obtained in Step 1232) and the re-used traceable insight (identified in Step 1228) based on the differentiation algorithm(s) (applied thereto in Step 1234). In one or many embodiment(s) disclosed herein, if it is determined that at least one difference had been identified, then the method proceeds to Step 1238. On the other hand, in one or many other embodiment(s) disclosed herein, if it is alternatively determined that zero differences had been identified, then the method alternatively proceeds to Step 1214 (described above—see e.g., FIG. 12A), where another new asset (if any) (identified in Step 1212) may be ingested.

In Step 1238, following the determination (made in Step 1236) that at least one difference had been identified between the insight (obtained in Step 1232) and the re-used traceable insight (identified in Step 1228) based on the differentiation algorithm(s) (applied thereto in Step 1234), authorship information, for a/the new asset (identified in Step 1212), is examined. In one or many embodiment(s) disclosed herein, the authorship information may be included in, and thus may be extracted from, the asset metadata (obtained in Step 1214) respective to a/the new asset. Further, the authorship information may encompass metadata particular to an author, or authors, (e.g., creator(s)) of a/the new asset.

In Step 1240, a determination is made, based on the examination (performed in Step 1238) of the authorship information for a/the new asset (identified in Step 1212), as to whether said authorship information includes at least one contact email address. In one or more embodiment(s) disclosed herein, if it is determined that said authorship information includes at least one contact email address, for contacting an author, or authors, of a/the new asset, then the method proceeds to Step 1242. On the other hand, in one or many other embodiment(s) disclosed herein, if it is alternatively determined that said authorship information includes zero contact email addresses, then the method alternatively proceeds to Step 1214 (described above—see e.g., FIG. 12A), where another new asset (if any) (identified in Step 1212) may be ingested.

In Step 1242, following the determination (made in Step 1240), based on the examination (performed in Step 1238) of authorship information for a/the new asset (identified in 1212), that said authorship information includes at least one contact email address for contacting the author, or authors, of a/the new asset, an insight modification questionnaire is created. In one or many embodiment(s) disclosed herein, the insight modification questionnaire may refer to an electronic document specifying or including a set of questions centered on difference(s) (identified in Step 1234) (or modification(s)) differentiating the re-used traceable insight (identified in Step 1228) from the insight (obtained in Step 1232). By way of an example, the set of questions may inquire what/which modification(s) had been applied to the insight to derive the re-used traceable insight, how the modification(s) were applied, and why the modification(s) were applied. Further, though centered on the identified difference(s) or modification(s), at least a portion of the set of questions may inquire about author metadata (e.g., organization role(s), affiliated organization(s), domain expertise(s), etc.) descriptive of the author(s) of a/the new asset. The set of questions, moreover, is/are not limited to the aforementioned specific examples.

In Step 1244, an insight modification email is created. In one or many embodiment(s) disclosed herein, the insight modification email may represent an electronic mail message that includes either the insight modification questionnaire (created in Step 1242) or a web address (or link) (e.g., a uniform resource locator (URL)) referencing, or otherwise pointing to, a storage location where the insight modification questionnaire may be stored/located (and, subsequently, accessed).

In Step 1246, the insight modification email (created in Step 1244) is transmitted to each contact email address of the at least one contact email address (identified via examination of the authorship information in Step 1238).

Turning to FIG. 12D, in Step 1248, following a choosing of the author(s) of a/the new asset (identified in Step 1212) to address at least a portion of the insight modification questionnaire (transmitted via email in Step 1246), an insight modification questionnaire response is received therefrom. In one or many embodiment(s) disclosed herein, the insight modification questionnaire response may represent a returned insight modification questionnaire that specifies or includes a respective answer, by said author(s), for at least one question, in the set of questions, outlined in the insight modification questionnaire.

In Step 1250, the insight modification questionnaire response (received in Step 1248) is ingested. In one or many embodiment(s) disclosed herein, ingestion of insight modification questionnaire response may, for example, entail any existing data/content scraping technique(s) through which insight modification information may be extracted, or otherwise obtained, therefrom. By way of an example, the insight modification information may include a justification statement elaborating on (or providing reasoning behind) the modification(s) applied to the insight (obtained in Step 1232) to derive the re-used traceable insight (identified in Step 1228). Further, the insight modification information is not limited to the aforementioned specific example.

In Step 1252, an insight value, of/for the insight (obtained in Step 1232), is assessed. In one or many embodiment(s) disclosed herein, the insight value may reflect or measure a significance, worth, or usefulness of the insight at any point-in time. Assessment of the insight value, of/for the insight, may account for any number of factors, including, but not limited to: the insight modification information (obtained in Step 1250); an insight re-use count representing a tracked metric that reflects a number of times the insight has been re-used (or plagiarized) within a same context (or a different context) as an original context reflecting a utilization for/of the insight and/or the base asset (mentioned in Step 1206) in which the insight had originally been embedded; and an original author, or authors, (e.g., creator(s)) (or more specifically, author metadata (e.g., organization role(s), domain expertise(s), etc.) describing said original author(s)) of the insight.

In one or many embodiment(s) disclosed herein, assessment of the insight value, of/for the insight, may lead to a computation or quantification thereof. For example, after an insight is created and published (e.g., stored across one or more internal and/or external data sources), an executive of an organization takes it and uses in it a keynote at a large conference, then the insight value of the insight goes up. If the impact score of a new asset goes up, likewise so does the insight value of the insight re-used therein.

As the insight value increases, the insight will show up higher in searches based on simple page rank algorithm. Because of this, the insight will be protected more within the scope of the infrastructure, meaning more snapshots of the data and models are needed to verify the insight and make sure no data, model, or the insight itself is lost. Many traditional infrastructure techniques can be used here. Each has a cost associated to it, so the insight value has to remain above the cost otherwise the insight will be moved to a cheaper infrastructure technique, or one that is not as fault tolerant. Also the number of copies of the insight being cached throughout the system will be reduced.

Once the insight value is reduced the amount of re-calculations or re-training will be reduced as well. Once the insight value has been low for a period of time then the insight may be archived. The insight will never be fully removed as the whole premise of the system is to utilize historical data. Some insights could also be considered predictions that need to be kept to verify how close the prediction is or was. In this case, a prediction from 10 years ago might still be relevant depending on time period of the prediction. In other cases, this period would have long expired and the insight value of the insight may be at its lowest point. But even then, the insight may be needed to help train the next set of algorithms and models as a labeled dataset.

FIGS. 13A-13F show flowcharts describing a method for impact enhancing recommendations for research papers and initiatives in accordance with one or more embodiments disclosed herein. The various steps outlined below may be performed by an insight service (see e.g., FIG. 1A). Further, while the various steps in the flowchart are presented and described sequentially, one of ordinary skill will appreciate that some or all steps may be executed in different orders, may be combined or omitted, and some or all steps may be executed in parallel.

Turning to FIG. 13A, in Step 1300, an initiation of an impact assessment program, by an organization user, is detected. In one or many embodiment(s) disclosed herein, the impact assessment program may refer to any software application configured to evaluate unbegun research (e.g., a research paper that has yet to be drafted or a research initiative that has yet to be pursued) and, subsequently, provide guidance with respect to enhancing an impact factor of said unbegun research. The impact factor, in turn, may refer to a measure of the prospective usefulness and/or success of the unbegun research to, for example, stimulate advances in technology development and/or steer the overall direction of one or more industries. Further, detection of the initiation of the impact assessment program may, for example, involve the receiving of telemetry from one or more insight agents (see e.g., FIG. 1B) executing on a client device operated by the organization user, where the impact assessment program also executes on the aforementioned client device. The insight agent(s), accordingly, may be embedded within, or may otherwise be associated with, the impact assessment program.

In Step 1302, a set of assessment parameters is/are obtained. In one or many embodiment(s) disclosed herein, an assessment parameter may refer to metadata descriptive, and thus also a point of assessment, of any unbegun research. Examples of an assessment parameter, as pertaining to the description and/or evaluation of a given unbegun research, may include: (a) a number of authors associated with the given unbegun research; (b) one or more author names each belonging to an author associated with the given unbegun research; (c) one or more organizations (e.g., a business/commercial entity, a higher education school, a government agency, a research institute, etc.) with which the author(s), associated with the given unbegun research, may be affiliated; (d) one or more geographical locations (e.g., cities, states, and/or countries) within which the author(s), associated with the given unbegun research, may reside; (e) an abstract summarizing the given unbegun research; (f) one or more keywords pertaining to the given unbegun research; (g) one or more topics on which the given unbegun research may be centered; (h) an introduction, associated with, and capturing a scope, a context, and/or a significance of, the given unbegun research; (i) a body, associated with, and capturing a hypothesis (or argument) and/or a methodology of, the given unbegun research; (j) a conclusion associated with, and capturing one or more key points of, the given unbegun research; (k) one or more contributor names (e.g., representative of acknowledgements) each belonging to a contributor whom may aid in a carrying out of the given unbegun research; and (l) one or more references (or citations) to other research work reflective of a source, or sources, of the given unbegun research (or at least a portion thereof). Further, any assessment parameter is not limited to the aforementioned specific examples.

In Step 1304, an interactive assessment form is instantiated. In one or many embodiment(s) disclosed herein, an interactive form may generally refer to an electronic document that responds to engagement, or interaction, from/by a user. As such, the interactive assessment form may reference an interactive form, aiming to determine and enhance an impact factor (described above) for any given unbegun research, which responds to engagement/interaction thereof from/by the organization user. Further, instantiation of the interactive assessment form may be contingent on the set of assessment parameters (obtained in Step 1302). That is, the set of assessment parameters may influence, for example, a structure/presentation and/or a response functionality of the interactive assessment form. The interactive assessment form, moreover, may be implemented through a collection of interactive form components.

In one or many embodiment(s) disclosed herein, the interactive assessment form may include, and thus may visually convey, a set of form fields (e.g., a set of interactive form components). Any form field may represent an editable text field wherein the organization user may enter (or input) and/or edit text of any arbitrary length. Further, each form field, in the set of form fields, may map or correspond to an assessment parameter in the set of assessment parameters (obtained in Step 1302). Accordingly, any (editable) text (also referred to herein as a field input), which may be entered/inputted and/or edited by the organization user within a given form field, may recite information pertaining to or capturing a given assessment parameter to which the given form field maps/corresponds.

In one or many embodiment(s) disclosed herein, any form field, in the set of form fields, may be associated with a form field status thereof. The form field status of any given form field may thus reflect a state thereof based on the (editable) text (if any) specified there-within. By way of an example, should no (editable) text (e.g., zero characters of text) be present or specified within a given form field, then the form field status thereof may reflect that the given form field is in an empty state (and, therefore, the given form field may be representative of an empty form field). Conversely, by way of another example, should at least one character of text be present or specified within a given form field, then the form field status thereof may reflect that the given form field is in a non-empty state (and, therefore, the given form field may be representative of a non-empty form field).

In one or many embodiment(s) disclosed herein, any form field, in the set of form fields, may further be associated with a form field class thereof. The form field class of any given form field may reflect a complexity of the given assessment parameter to which the given form field maps/corresponds. In turn, a complexity of a given assessment parameter may be measured, for example, by way of the length, and/or the extent of the effort contributive, of the (editable) text expected to be entered/inputted and/or edited, within the given form field by the organization user, where said (editable) text sufficiently captures the context of the given assessment parameter. Further, as disclosed herein, any given form field may be associated with one of two possible form field classes—i.e., a simple form field class reflective of any form field predefined as a simple form field, and a complex form field class reflective of any form field predefined as a complex form field. From the above-listed example assessment parameters (see e.g., Step 1302), a subset thereof, mapping/corresponding to a simple form field, may include: the number of authors; the author name(s); the affiliated organization(s); the geographical location(s); the keyword(s); the topic(s); and the contributor name(s). Conversely, from the above-listed example assessment parameters, another subset thereof, mapping/corresponding to a complex form field, may include: the abstract; the introduction; the body; the conclusion; and the reference(s).

In one or many embodiment(s) disclosed herein, the interactive assessment form may include, and thus may visually convey, a set of form field labels (e.g., a set of interactive form components). Any form field label may represent a static text field that cannot be altered by the organization user. Further, each form field label, in the set of form field labels, may map or correspond to an assessment parameter in the set of assessment parameters (obtained in Step 1302) (and, by association, may also map or correspond to a respective form field in the set of form fields). Accordingly, any (static) text, representative of a given form field label, may recite a human-readable identifier or name for a given assessment parameter, as well as hint at the information expected to be entered/inputted and/or edited by the organization user within a given form field, to which the given form field label maps/corresponds.

In one or many embodiment(s) disclosed herein, the interactive assessment form may include, and thus may visually convey, a set of parameter-specific impact score indicators (e.g., a set of interactive form components). Any parameter-specific impact score indicator may represent a response-driven text field that cannot be altered by the organization user, however, any displayed text (e.g., reflective of a parameter-specific impact score) therein can nevertheless change in response to one or more interactions, by the organization user, with the interactive assessment form. Further, each parameter-specific impact score indicator, in the set of parameter-specific impact score indicators, may map or correspond to an assessment parameter in the set of assessment parameters (obtained in Step 1302) (and, by association, may also map or correspond to a respective form field in the set of form fields, as well as a respective form field label in the set of form field labels). Moreover, any parameter-specific impact score, which may be displayed through any given parameter-specific impact score indicator, may refer to an item of information (e.g., usually expressed as a positive numerical value or a percentage value) that conveys a partial impact factor of an unbegun research being currently evaluated using the interactive assessment form. The partial impact factor, in turn, may measure a prospective usefulness and/or success of the unbegun research as said prospective usefulness and/or success pertains to (or considers) a particular assessment parameter (e.g., the assessment parameter to which the given parameter-specific impact score indicator maps/corresponds).

In one or many embodiment(s) disclosed herein, the interactive assessment form may include, and thus may visually convey, an overall impact score indicator (e.g., an interactive form component). The overall impact score indicator may represent a response-driven text field that cannot be altered by the organization user, however, any displayed text (e.g., reflective of an overall impact score) therein can nevertheless change in response to one or more interactions, by the organization user, with the interactive assessment form. Further, the overall impact score may refer to an item of information (e.g., usually expressed as a positive numerical value or a percentage value) that conveys a total impact factor of an unbegun research being currently evaluated using the interactive assessment form. The total impact factor, in turn, may measure a prospective usefulness and/or success of the unbegun research as said prospective usefulness and/or success pertains to (or considers) all assessment parameters in the set of assessment parameters (obtained in Step 1302).

For an example interactive assessment form, including examples of the above-described interactive form components, refer to the example scenario illustrated and discussed with respect to FIGS. 31A-31C, below. Furthermore, any interactive assessment form, as disclosed herein, is not limited to being composed of/by any combination of the above-described interactive form components.

In Step 1306, the interactive assessment form (instantiated in Step 1304) is subsequently presented/provided to the organization user. In one or many embodiment(s) disclosed herein, the interactive assessment form, more specifically, may be presented by way of the impact assessment program.

In Step 1308, following a presentation of the interactive assessment form (in Step 1306), following a presentation of guidance information (in Step 1332 or Step 1372) (described below—see e.g., FIG. 13B or FIG. 13E), following an updating of the interactive assessment form (in Step 1350) (described below—see e.g., FIG. 13C), following an alternative determination (made in Step 1374) (described below—see e.g., FIG. 13E) that any engagement action hovers (using a cursor) over any given parameter-specific impact score indicator, or following a presentation of an impactful-to-overall asset ratio (in Step 1390) (described below—see e.g., FIG. 13F), engagement (or interaction) with the interactive assessment form (presented in Step 1306) is monitored. In one or many embodiment(s) disclosed herein, said engagement/interaction may be performed by the organization user whom initiated the impact assessment program (detected in Step 1300) and may refer to any number of engagement actions through which the organization user interacts with, or employs one or more features of, the interactive assessment form. Examples of said engagement actions may include, but are not limited to, terminating the impact assessment program (and, by association, the interactive assessment form), hovering (using a cursor) over any form field, editing any simple form field, editing any complex form field, and hovering (using a cursor) over any parameter-specific impact score indicator. The organization user may interact with the interactive assessment form, and/or the impact assessment program, through other engagement actions not explicitly described hereinafter without departing from the scope disclosed herein.

In Step 1310, based on the interactive assessment form engagement/interaction (monitored in Step 1308), a determination is made as to whether any engagement action reflects a terminating of the impact assessment program. The organization user may terminate the impact assessment program (and thus the interactive assessment form) by, for example, closing a user interface for, associated with, or representative of the impact assessment program. As such, in one or many embodiment(s) disclosed herein, if it is determined that any engagement action terminates the impact assessment program, then the method ends. On the other hand, in one or many other embodiment(s) disclosed herein, if it is alternatively determined that any engagement action does not terminate the impact assessment program, then the method alternatively proceeds to Step 1312.

In Step 1312, following the determination (made in Step 1310) that any engagement action, based on the interactive assessment form engagement/interaction (monitored in Step 1308), does not terminate the impact assessment program, a determination is made as to whether said any engagement action reflects a hovering (using a cursor) of any given form field. As such, in one or more embodiment(s) disclosed herein, if it is determined that any engagement action hovers over any given form field, then the method proceeds to Step 1314. On the other hand, in one or many other embodiment(s) disclosed herein, if it is alternatively determined that any engagement action does not hover over any given form field, then the method alternatively proceeds to Step 1334 (see e.g., FIG. 13C).

In Step 1314, following the determination (made in Step 1312) that any engagement action, based on the interactive assessment form engagement/interaction (monitored in Step 1308), hovers (using a cursor) over any given form field, a guiding assessment parameter is identified. In one or many embodiment(s) disclosed herein, said guiding assessment parameter may represent a/the assessment parameter to which the given form field maps/corresponds.

From Step 1314, the method proceeds to Step 1316 (see e.g., FIG. 13B).

Turning to FIG. 13B, in Step 1316, an impactful corpus catalog is obtained. In one or many embodiment(s) disclosed herein, the impactful corpus catalog may represent a data structure that maintains asset metadata describing, and thus pertaining to, a collection of impactful assets forming an impactful corpus. Each (impactful) asset in the impactful corpus may refer to any research-centered and predominantly text-based item of information (e.g., a research paper, a research thesis, a research proposal, etc.) that, over time, has, for example, positively impacted, influenced, or steered: other (future) research work in a same research space, or in one or more adjacent research spaces, as that associated with the asset; one or more advances in technology; and/or an overall direction of one or more industries. Furthermore, the asset metadata, maintained in the impactful corpus catalog, may be organized across a set of (impactful corpus) catalog entries. Each (impactful corpus) catalog entry, in the set of (impactful corpus) catalog entries, may pertain to an (impactful) asset in the impactful corpus and, therefore, may store asset metadata particular to said (impactful) asset. Further, any asset metadata may be divided into a set of metadata fields, where each metadata field further organizes the asset metadata based on a given context.

Examples of asset metadata, for any given (impactful) asset, may include the following context(s) (i.e., metadata field(s)): (a) a number of authors associated with the given (impactful) asset; (b) one or more author names each belonging to an author associated with the given (impactful) asset; (c) one or more organizations (e.g., a business/commercial entity, a higher education school, a government agency, a research institute, etc.) with which the author(s), associated with the given (impactful) asset, may be affiliated; (d) one or more geographical locations (e.g., cities, states, and/or countries) within which the author(s), associated with the given (impactful) asset, may reside; (e) an abstract summarizing the given (impactful) asset; (f) one or more keywords pertaining to the given (impactful) asset; (g) one or more topics on which the given (impactful) asset may be centered; (h) an introduction, associated with, and capturing a scope, a context, and/or a significance of, the given (impactful) asset; (i) a body, associated with, and capturing a hypothesis (or argument) and/or a methodology of, the given (impactful) asset; (j) a conclusion associated with, and capturing one or more key points of, the given (impactful) asset; (k) one or more contributor names (e.g., representative of acknowledgements) each belonging to a contributor whom may have aided in a carrying out of the given (impactful) asset; and (l) one or more references (or citations) to other research work reflective of a source, or sources, of the given (impactful) asset (or at least a portion thereof). Further, asset metadata is not limited to the aforementioned specific (metadata field) examples.

In Step 1318, a search, across or involving the set of form fields, at least in part, composing the interactive assessment form (presented in Step 1306), is performed. In one or many embodiment(s) disclosed herein, the search may attempt to identify any non-empty form fields (described above—see e.g., Step 1304) in the set of form fields.

In Step 1320, a determination is made, based on the search (performed in Step 1318), as to whether at least one non-empty form field, in the set of form fields, at least in part, composing the interactive assessment form (presented in Step 1306), had been identified. As such, in one or many embodiment(s) disclosed herein, if it is determined that said search succeeded in identifying at least one non-empty form field, then the method proceeds to Step 1322. On the other hand, in one or many other embodiment(s) disclosed herein, if it is alternatively determined that said search failed in identifying at least one non-empty form field, then the method alternatively proceeds to Step 1328.

In Step 1322, following the determination (made in Step 1320) that the search (performed in Step 1318) succeeded in identifying at least one non-empty form field, a field input, for each non-empty form field in the at least one non-empty form field, is extracted therefrom (thereby obtaining at least one field input). In one or many embodiment(s) disclosed herein, the field input, for any given non-empty form field, may refer to the (editable) text found within the given form field, which the organization user, at some prior point-in-time, had entered/inputted and/or edited there-within.

In Step 1324, at least one filtering assessment parameter is identified. In one or many embodiment(s) disclosed herein, each filtering assessment parameter, in the at least one filtering assessment parameter, may refer to an assessment parameter, in the set of assessment parameters (obtained in Step 1302). Further, identification of each filtering assessment parameter may entail mapping a non-empty form field, in the at least one non-empty form field (identified via the search performed in Step 1318), to their respective assessment parameter.

In Step 1326, the impactful corpus catalog (obtained in Step 1316) is filtered at least based on the at least one field input (obtained in Step 1322). In one or many embodiment(s) disclosed herein, filtering of the impactful corpus catalog may, for example, entail topic matching (e.g., case-insensitive word or phrase matching) and/or semantic similarity calculation between the at least one field input (or each field input therein) and the asset metadata, for (impactful) assets, maintained across the (impactful corpus) catalog entries of the impactful corpus catalog. Further, said filtering may result in the identification of a catalog entry subset in (or a subset of) the set of catalog entries organizing the asset metadata in the impactful corpus catalog. Each catalog entry, in the catalog entry subset, may include asset metadata that, at least in part, matches (or is substantially similar to) one or more field input(s) in the at least one field input. Each catalog entry, in the catalog entry subset, further, may map/correspond to an (impactful) asset that at least discusses one or more field input(s) in the at least one field input.

In one or many embodiment(s) disclosed herein, the impactful corpus catalog (obtained in Step 1316) may be further filtered using or based on the at least one filtering assessment parameter (identified in Step 1324). More specifically, when filtering the impactful corpus catalog, only certain metadata field(s) of the asset metadata, maintained across the set of catalog entries, may be considered. Further, each metadata field, in said certain metadata field(s), may match a filtering assessment parameter in the at least one filtering assessment parameter.

In Step 1328, following the alternative determination (made in Step 1320)) that the search (performed in Step 1318) failed in identifying at least one non-empty form field, or following the identification of a catalog entry subset (in Step 1326), an asset metadata subset is identified. In one or many embodiment(s) disclosed herein, the asset metadata subset may encompass a certain metadata field of the collective asset metadata that spans across either the set of catalog entries (obtained via the impactful corpus catalog in Step 1316) or the catalog entry subset (in said set of catalog entries identified in Step 1326). Further, said certain metadata field may match the guiding assessment parameter (identified in Step 1314).

In Step 1330, the asset metadata subset (identified in Step 1328) is analyzed. In one or many embodiment(s) disclosed herein, analysis of the asset metadata subset may result in the obtaining of guidance information. Said guidance information may include one or more recommendations for enhancing an impact factor of an unbegun research being currently evaluated using the interactive assessment form (presented to the organization user in Step 1306), where the recommendation(s) center on the guiding assessment parameter (identified in Step 1314).

In Step 1332, the guidance information (obtained in Step 1330) is subsequently presented/provided to the organization user. In one or many embodiment(s) disclosed herein, the guidance information, more specifically, may be presented by way of the interactive assessment form (presented in Step 1306). Further, concerning the presentation thereof, the guidance information may be revealed, for example, as a comment, an annotation, or a dialog box. For an example revelation of guidance information, through an example interactive assessment form, refer to the example scenario illustrated and discussed with respect to FIGS. 31A-31C, below.

From Step 1332, the method proceeds to Step 1308 (see e.g., FIG. 13A), where further engagement, by the organization user and with the interactive assessment form, is monitored.

Turning to FIG. 13C, in Step 1334, following the alternative determination (made in Step 1312) that any engagement action, based on the interactive assessment form engagement/interaction (monitored in Step 1308), does not hovers (using a cursor) over any given form field, a determination is made as to whether said any engagement action reflects an editing of any given simple form field (described above—see e.g., Step 1304). As such, in one or many embodiment(s) disclosed herein, if it is determined that any engagement action edits any given simple form field, then the method proceeds to Step 1336. On the other hand, in one or many other embodiment(s) disclosed herein, if it is alternatively determined that any engagement action does not edit any given simple form field, then the method alternatively proceeds to Step 1352 (see e.g., FIG. 13D).

In Step 1336, following the determination (made in Step 1334) that any engagement action, based on the interactive assessment form engagement/interaction (monitored in Step 1308), edits any given simple form field, an assessment parameter is identified. In one or many embodiment(s) disclosed herein, said assessment parameter may represent one of the assessment parameter(s), in the set of assessment parameters (obtained in Step 1302), to which the given simple form field maps/corresponds.

In Step 1338, a field input, for the given simple form field, is extracted therefrom. In one or many embodiment(s) disclosed herein, the field input may refer to the (editable) text found within the given simple form field, which the organization user, via said any engagement action reflecting an editing of said given simple form field, had entered/inputted and/or edited there-within.

In Step 1340, an impactful corpus catalog is obtained. In one or many embodiment(s) disclosed herein, the impactful corpus catalog may represent a data structure that maintains asset metadata describing, and thus pertaining to, a collection of impactful assets forming an impactful corpus. Each (impactful) asset in the impactful corpus may refer to any research-centered and predominantly text-based item of information (e.g., a research paper, a research thesis, a research proposal, etc.) that, over time, has, for example, positively impacted, influenced, or steered: other (future) research work in a same research space, or in one or more adjacent research spaces, as that associated with the asset; one or more advances in technology; and/or an overall direction of one or more industries. Furthermore, the asset metadata, maintained in the impactful corpus catalog, may be organized across a set of (impactful corpus) catalog entries. Each (impactful corpus) catalog entry, in the set of (impactful corpus) catalog entries, may pertain to an (impactful) asset in the impactful corpus and, therefore, may store asset metadata particular to said (impactful) asset. Further, any asset metadata may be divided into a set of metadata fields, where each metadata field further organizes the asset metadata based on a given context. Examples of asset metadata, or more specifically, metadata fields thereof, are disclosed with respect to Step 1316 (see e.g., FIG. 13B), above.

In Step 1342, the impactful corpus catalog (obtained in Step 1340) is filtered at least based on the field input (extracted in Step 1338). In one or many embodiment(s) disclosed herein, filtering of the impactful corpus catalog may, for example, entail topic matching (e.g., case-insensitive word or phrase matching) and/or semantic similarity calculation between the field input and the asset metadata, for (impactful) assets, maintained across the (impactful corpus) catalog entries of the impactful corpus catalog. Further, said filtering may result in the identification of a catalog entry subset in (or a subset of) the set of catalog entries organizing the asset metadata in the impactful corpus catalog. Each catalog entry, in the catalog entry subset, may include asset metadata that, at least in part, matches (or is substantially similar to) the input field. Each catalog entry, in the catalog entry subset, further, may map/correspond to an (impactful) asset that at least discusses the input field.

In one or many embodiment(s) disclosed herein, the impactful corpus catalog (obtained in Step 1340) may be further filtered using or based on the assessment parameter (identified in Step 1336). More specifically, when filtering the impactful corpus catalog, only a certain metadata field of the asset metadata, maintained across the set of (impactful corpus) catalog entries, may be considered. Further, the certain metadata field may match the assessment parameter.

In Step 1344, an overall corpus catalog is obtained. In one or many embodiment(s) disclosed herein, the overall corpus catalog may represent a data structure that maintains asset metadata describing, and thus pertaining to, a collection of assets forming an overall corpus, where the overall corpus represents a superset of assets that includes the asset(s) forming the impactful corpus. Each asset in the overall corpus, accordingly, may refer to any research-centered and predominantly text-based item of information (e.g., a research paper, a research thesis, a research proposal, etc.), which may or may not be representative of an impactful asset. Furthermore, the asset metadata, maintained in the overall corpus catalog, may be organized across a set of (overall corpus) catalog entries. Each (overall corpus) catalog entry, in the set of (overall corpus) catalog entries, may pertain to an asset in the overall corpus and, therefore, may store asset metadata particular to said asset. Further, any asset metadata may be divided into a set of metadata fields, where each metadata field further organizes the asset metadata based on a given context. Examples of asset metadata, or more specifically, metadata fields thereof, are disclosed with respect to Step 1316 (see e.g., FIG. 13B), above.

In Step 1346, a parameter-specific impact score is computed. In one or many embodiment(s) disclosed herein, the parameter-specific impact score may refer to an item of information (e.g., usually expressed as a positive numerical value or a percentage value) that conveys a partial impact factor of an unbegun research being currently evaluated using the interactive assessment form (presented to the organization user in Step 1306). The partial impact factor, in turn, may measure a prospective usefulness and/or success of the unbegun research as said prospective usefulness and/or success pertains to (or considers) a particular assessment parameter (e.g., the assessment parameter (identified in Step 1336)). Further, computation of the parameter-specific impact score may rely on a cardinality of the (impactful corpus) catalog entry subset (identified in Step 1342) (i.e., a number of catalog entries forming the (impactful corpus) catalog entry subset) and a cardinality of the set of catalog entries forming the overall corpus catalog (obtained in Step 1344) (i.e., a number of catalog entries forming the overall corpus catalog).

By way of an example, the parameter-specific impact score may be calculated via a simple mathematical division function, where the numerator (or dividend) of said division is represented by the number of catalog entries forming the (impactful corpus) catalog entry subset, while the denominator (or divisor) of said division is represented by the number of catalog entries forming the overall corpus catalog. Accordingly, in such an example, the parameter-specific impact score may represent the quotient resulting from said division, which may be expressed as a positive decimal value or a percentage value. Further, computation of the parameter-specific impact score, based on the number of (impactful corpus) catalog subset entries and the number of (overall corpus) catalog entries, is not limited to the aforementioned specific example.

In Step 1348, an overall impact score is computed. In one or many embodiment(s) disclosed herein, the overall impact score may refer to an item of information (e.g., usually expressed as a positive numerical value or a percentage value) that conveys a total impact factor of an unbegun research being currently evaluated using the interactive assessment form (presented to the organization user in Step 1306). The total impact factor, in turn, may measure a prospective usefulness and/or success of the unbegun research as said prospective usefulness and/or success pertains to (or considers) all assessment parameters in the set of assessment parameters (obtained in Step 1302). Further, each assessment parameter, in the set of assessment parameters, may be associated with a respective parameter-specific impact score in a set of parameter-specific impact scores (including the parameter-specific impact score (computed in Step 1346)). Accordingly, computation of the overall impact score may rely on the set of parameter-specific impact scores.

For example, the overall impact score may be calculated using a weighted mathematical function involving each parameter-specific impact score (e.g., whether the parameter-specific impact score reflects a zero or non-zero numerical or percentage value) in the set of parameter-specific impact scores. In such an example, the overall impact score may represent the result of said weighted mathematical function, which may be expressed as a positive numerical value or a percentage value. Further, computation of the overall impact score, based on the set of parameter-specific impact scores, is not limited to the aforementioned specific example.

In Step 1350, the interactive assessment form (presented in Step 1306) is updated. Specifically, in one or many embodiment(s) disclosed herein, of the collection of interactive form components composing the interactive assessment form: one parameter-specific impact score indicator, in the set of parameter-specific impact score indicators, may be updated using the parameter-specific impact score (computed in Step 1346); and an/the overall impact score indicator may be updated using the overall impact score (computed in Step 1348). More specifically, a previous parameter-specific impact score, displayed by the one parameter-specific impact score indicator, may be replaced with the recently computed parameter-specific impact score; whereas a previous overall impact score, displayed by the overall score indicator, may be replaced with the recently computed overall impact score. Further, the one parameter-specific impact score indicator may map or correspond to the assessment parameter (identified in Step 1336).

From Step 1350, the method proceeds to Step 1308 (see e.g., FIG. 13A), where further engagement, by the organization user and with the interactive assessment form, is monitored.

Turning to FIG. 13D, in Step 1352, following the determination (made in Step 1334) that any engagement action, based on the interactive assessment form engagement/interaction (monitored in Step 1308), does not edit any given simple form field, a determination is made as to whether said any engagement action reflects an editing of any given complex form field (described above—see e.g., Step 1304). As such, in one or many embodiment(s) disclosed herein, if it is determined that any engagement action edits any given complex form field, then the method proceeds to Step 1354. On the other hand, in one or many other embodiment(s) disclosed herein, if it is alternatively determined that any engagement action does not edit any given complex form field, then the method alternatively proceeds to Step 1374 (see e.g., FIG. 13E).

In Step 1354, following the determination (made in Step 1352) that any engagement action, based on the interactive assessment form engagement/interaction (monitored in Step 1308), edits any given complex form field, an assessment parameter is identified. In one or many embodiment(s) disclosed herein, said assessment parameter may represent one of the assessment parameter(s), in the set of assessment parameters (obtained in Step 1302), to which the given complex form field maps/corresponds.

In Step 1356, a field input, for the given complex form field, is extracted therefrom. In one or many embodiment(s) disclosed herein, the field input may refer to the (editable) text found within the given complex form field, which the organization user, via said any engagement action reflecting an editing of said given complex form field, had entered/inputted and/or edited there-within.

In Step 1358, an impactful corpus catalog is obtained. In one or many embodiment(s) disclosed herein, the impactful corpus catalog may represent a data structure that maintains asset metadata describing, and thus pertaining to, a collection of impactful assets forming an impactful corpus. Each (impactful) asset in the impactful corpus may refer to any research-centered and predominantly text-based item of information (e.g., a research paper, a research thesis, a research proposal, etc.) that, over time, has, for example, positively impacted, influenced, or steered: other (future) research work in a same research space, or in one or more adjacent research spaces, as that associated with the asset; one or more advances in technology; and/or an overall direction of one or more industries. Furthermore, the asset metadata, maintained in the impactful corpus catalog, may be organized across a set of (impactful corpus) catalog entries. Each (impactful corpus) catalog entry, in the set of (impactful corpus) catalog entries, may pertain to an (impactful) asset in the impactful corpus and, therefore, may store asset metadata particular to said (impactful) asset. Further, any asset metadata may be divided into a set of metadata fields, where each metadata field further organizes the asset metadata based on a given context. Examples of asset metadata, or more specifically, metadata fields thereof, are disclosed with respect to Step 1316 (see e.g., FIG. 13B), above.

In Step 1360, the impactful corpus catalog (obtained in Step 1358) is filtered at least based on the field input (extracted in Step 1356). In one or many embodiment(s) disclosed herein, filtering of the impactful corpus catalog may, for example, entail topic matching (e.g., case-insensitive word or phrase matching) and/or semantic similarity calculation between the field input and the asset metadata, for (impactful) assets, maintained across the (impactful corpus) catalog entries of the impactful corpus catalog. Further, said filtering may result in the identification of a catalog entry subset in (or a subset of) the set of catalog entries organizing the asset metadata in the impactful corpus catalog. Each catalog entry, in the catalog entry subset, may include asset metadata that, at least in part, matches (or is substantially similar to) the input field. Each catalog entry, in the catalog entry subset, further, may map/correspond to an (impactful) asset that at least discusses the input field.

In one or many embodiment(s) disclosed herein, the impactful corpus catalog (obtained in Step 1358) may be further filtered using or based on the assessment parameter (identified in Step 1354). More specifically, when filtering the impactful corpus catalog, only a certain metadata field of the asset metadata, maintained across the set of (impactful corpus) catalog entries, may be considered. Further, the certain metadata field may match the assessment parameter.

In Step 1362, an overall corpus catalog is obtained. In one or many embodiment(s) disclosed herein, the overall corpus catalog may represent a data structure that maintains asset metadata describing, and thus pertaining to, a collection of assets forming an overall corpus, where the overall corpus represents a superset of assets that includes the asset(s) forming the impactful corpus. Each asset in the overall corpus, accordingly, may refer to any research-centered and predominantly text-based item of information (e.g., a research paper, a research thesis, a research proposal, etc.), which may or may not be representative of an impactful asset. Furthermore, the asset metadata, maintained in the overall corpus catalog, may be organized across a set of (overall corpus) catalog entries. Each (overall corpus) catalog entry, in the set of (overall corpus) catalog entries, may pertain to an asset in the overall corpus and, therefore, may store asset metadata particular to said asset. Further, any asset metadata may be divided into a set of metadata fields, where each metadata field further organizes the asset metadata based on a given context. Examples of asset metadata, or more specifically, metadata fields thereof, are disclosed with respect to Step 1316 (see e.g., FIG. 13B), above.

In Step 1364, a parameter-specific impact score is computed. In one or many embodiment(s) disclosed herein, the parameter-specific impact score may refer to an item of information (e.g., usually expressed as a positive numerical value or a percentage value) that conveys a partial impact factor of an unbegun research being currently evaluated using the interactive assessment form (presented to the organization user in Step 1306). The partial impact factor, in turn, may measure a prospective usefulness and/or success of the unbegun research as said prospective usefulness and/or success pertains to (or considers) a particular assessment parameter (e.g., the assessment parameter (identified in Step 1354)). Further, computation of the parameter-specific impact score may rely on a cardinality of the (impactful corpus) catalog entry subset (identified in Step 1360) (i.e., a number of catalog entries forming the (impactful corpus) catalog entry subset) and a cardinality of the set of catalog entries forming the overall corpus catalog (obtained in Step 1362) (i.e., a number of catalog entries forming the overall corpus catalog).

By way of an example, the parameter-specific impact score may be calculated via a simple mathematical division function, where the numerator (or dividend) of said division is represented by the number of catalog entries forming the (impactful corpus) catalog entry subset, while the denominator (or divisor) of said division is represented by the number of catalog entries forming the overall corpus catalog. Accordingly, in such an example, the parameter-specific impact score may represent the quotient resulting from said division, which may be expressed as a positive decimal value or a percentage value. Further, computation of the parameter-specific impact score, based on the number of (impactful corpus) catalog subset entries and the number of (overall corpus) catalog entries, is not limited to the aforementioned specific example.

In Step 1366, an overall impact score is computed. In one or many embodiment(s) disclosed herein, the overall impact score may refer to an item of information (e.g., usually expressed as a positive numerical value or a percentage value) that conveys a total impact factor of an unbegun research being currently evaluated using the interactive assessment form (presented to the organization user in Step 1306). The total impact factor, in turn, may measure a prospective usefulness and/or success of the unbegun research as said prospective usefulness and/or success pertains to (or considers) all assessment parameters in the set of assessment parameters (obtained in Step 1302). Further, each assessment parameter, in the set of assessment parameters, may be associated with a respective parameter-specific impact score in a set of parameter-specific impact scores (including the parameter-specific impact score (computed in Step 1364)). Accordingly, computation of the overall impact score may rely on the set of parameter-specific impact scores.

For example, the overall impact score may be calculated using a weighted mathematical function involving each parameter-specific impact score (e.g., whether the parameter-specific impact score reflects a zero or non-zero numerical or percentage value) in the set of parameter-specific impact scores. In such an example, the overall impact score may represent the result of said weighted mathematical function, which may be expressed as a positive numerical value or a percentage value. Further, computation of the overall impact score, based on the set of parameter-specific impact scores, is not limited to the aforementioned specific example.

In Step 1368, the interactive assessment form (presented in Step 1306) is updated. Specifically, in one or many embodiment(s) disclosed herein, of the collection of interactive form components composing the interactive assessment form: one parameter-specific impact score indicator, in the set of parameter-specific impact score indicators, may be updated using the parameter-specific impact score (computed in Step 1364); and an/the overall impact score indicator may be updated using the overall impact score (computed in Step 1366). More specifically, a previous parameter-specific impact score, displayed by the one parameter-specific impact score indicator, may be replaced with the recently computed parameter-specific impact score; whereas a previous overall impact score, displayed by the overall score indicator, may be replaced with the recently computed overall impact score. Further, the one parameter-specific impact score indicator may map or correspond to the assessment parameter (identified in Step 1354).

From Step 1368, the method proceeds to Step 1370 (see e.g., FIG. 13E).

Turning to FIG. 13E, in Step 1370, an asset metadata subset is identified and analyzed. In one or many embodiment(s) disclosed herein, the asset metadata subset may encompass a certain metadata field of the collective asset metadata that spans across the (impactful corpus) catalog entry subset (identified in Step 1360). Further, said certain metadata field may match the assessment parameter (identified in Step 1354). Further, analysis of the asset metadata subset may result in the obtaining of guidance information. Said guidance information may include one or more recommendations for enhancing an impact factor of an unbegun research being currently evaluated using the interactive assessment form (presented to the organization user in Step 1306), where the recommendation(s) center on any impactful prose (or language) captured as asset metadata for one or more impactful assets mapped, respectively, to one or more (impactful corpus) catalog entries in the (impactful corpus) catalog entry subset (identified in Step 1360).

In Step 1372, the guidance information (obtained in Step 1370) is subsequently presented/provided to the organization user. In one or many embodiment(s) disclosed herein, the guidance information, more specifically, may be presented by way of the interactive assessment form (presented in Step 1306). Further, concerning the presentation thereof, the guidance information may be revealed, for example, as a comment, an annotation, or a dialog box. For an example revelation of guidance information, through an example interactive assessment form, refer to the example scenario illustrated and discussed with respect to FIGS. 31A-31C, below.

From Step 1372, the method proceeds to Step 1308 (see e.g., FIG. 13A), where further engagement, by the organization user and with the interactive assessment form, is monitored.

In Step 1374, following the alternative determination (made in Step 1352) that any engagement action, based on the interactive assessment form engagement/interaction (monitored in Step 1308), does not edit any given complex form field, a determination is made as to whether said any engagement action reflects a hovering (using a cursor) over any given parameter-specific impact score indicator (described above—see e.g., Step 1304). As such, in one or many embodiment(s) disclosed herein, if it is determined that any engagement action hovers over any given parameter-specific impact score indicator, then the method proceeds to Step 1376. On the other hand, in one or many other embodiment(s) disclosed herein, if it is alternatively determined that any engagement action does not hover over any given parameter-specific impact score indicator, then the method alternatively proceeds to Step 1308 (see e.g., FIG. 13A), where further engagement, by the organization user and with the interactive assessment form, is monitored.

In Step 1376, following the determination (made in Step 1374) that any engagement action, based on the interactive assessment form engagement/interaction (monitored in Step 1308), hovers (using a cursor) over any given parameter-specific impact score indicator, an assessment parameter, and a corresponding form field, are identified. In one or many embodiment(s) disclosed herein, said assessment parameter may represent one of the assessment parameter(s), in the set of assessment parameters (obtained in Step 1302), to which the given parameter-specific impact score indicator maps/corresponds. Meanwhile, said form field may represent one of the form field(s), in the set of form fields, at least in part, composing the interactive assessment form (presented in Step 1306), to which the given parameter-specific impact score indicator maps/corresponds.

In Step 1378, a field input, for the form field (identified in Step 1376), is extracted therefrom. In one or many embodiment(s) disclosed herein, the field input may refer to the (editable) text found within the form field, which the organization user, at some prior point-in-time, had entered/inputted and/or edited there-within.

In Step 1380, an impactful corpus catalog is obtained. In one or many embodiment(s) disclosed herein, the impactful corpus catalog may represent a data structure that maintains asset metadata describing, and thus pertaining to, a collection of impactful assets forming an impactful corpus. Each (impactful) asset in the impactful corpus may refer to any research-centered and predominantly text-based item of information (e.g., a research paper, a research thesis, a research proposal, etc.) that, over time, has, for example, positively impacted, influenced, or steered: other (future) research work in a same research space, or in one or more adjacent research spaces, as that associated with the asset; one or more advances in technology; and/or an overall direction of one or more industries. Furthermore, the asset metadata, maintained in the impactful corpus catalog, may be organized across a set of (impactful corpus) catalog entries. Each (impactful corpus) catalog entry, in the set of (impactful corpus) catalog entries, may pertain to an (impactful) asset in the impactful corpus and, therefore, may store asset metadata particular to said (impactful) asset. Further, any asset metadata may be divided into a set of metadata fields, where each metadata field further organizes the asset metadata based on a given context. Examples of asset metadata, or more specifically, metadata fields thereof, are disclosed with respect to Step 1316 (see e.g., FIG. 13B), above.

In Step 1382, the impactful corpus catalog (obtained in Step 1380) is filtered at least based on the field input (extracted in Step 1378). In one or many embodiment(s) disclosed herein, filtering of the impactful corpus catalog may, for example, entail topic matching (e.g., case-insensitive word or phrase matching) and/or semantic similarity calculation between the field input and the asset metadata, for (impactful) assets, maintained across the (impactful corpus) catalog entries of the impactful corpus catalog. Further, said filtering may result in the identification of a catalog entry subset in (or a subset of) the set of catalog entries organizing the asset metadata in the impactful corpus catalog. Each catalog entry, in the catalog entry subset, may include asset metadata that, at least in part, matches (or is substantially similar to) the input field. Each catalog entry, in the catalog entry subset, further, may map/correspond to an (impactful) asset that at least discusses the input field.

In one or many embodiment(s) disclosed herein, the impactful corpus catalog (obtained in Step 1380) may be further filtered using or based on the assessment parameter (identified in Step 1376). More specifically, when filtering the impactful corpus catalog, only a certain metadata field of the asset metadata, maintained across the set of (impactful corpus) catalog entries, may be considered. Further, the certain metadata field may match the assessment parameter.

In Step 1384, an overall corpus catalog is obtained. In one or many embodiment(s) disclosed herein, the overall corpus catalog may represent a data structure that maintains asset metadata describing, and thus pertaining to, a collection of assets forming an overall corpus, where the overall corpus represents a superset of assets that includes the asset(s) forming the impactful corpus. Each asset in the overall corpus, accordingly, may refer to any research-centered and predominantly text-based item of information (e.g., a research paper, a research thesis, a research proposal, etc.), which may or may not be representative of an impactful asset. Furthermore, the asset metadata, maintained in the overall corpus catalog, may be organized across a set of (overall corpus) catalog entries. Each (overall corpus) catalog entry, in the set of (overall corpus) catalog entries, may pertain to an asset in the overall corpus and, therefore, may store asset metadata particular to said asset. Further, any asset metadata may be divided into a set of metadata fields, where each metadata field further organizes the asset metadata based on a given context. Examples of asset metadata, or more specifically, metadata fields thereof, are disclosed with respect to Step 1316 (see e.g., FIG. 13B), above.

From Step 1384, the method proceeds to Step 1386 (see e.g., FIG. 13F).

Turning to FIG. 13F, in Step 1386, cardinalities for the (impactful corpus) catalog entry subset (identified in Step 1382) and the set of (overall corpus) catalog entries, the latter respective to the overall corpus catalog (obtained in Step 1384), are obtained. In one or many embodiment(s) disclosed herein, a cardinality of the (impactful corpus) catalog entry subset may reference a number of catalog entries forming the (impactful corpus) catalog entry subset. Meanwhile, a cardinality of the set of catalog entries respective to (or forming) the overall corpus catalog may reference a number of catalog entries forming the overall corpus catalog.

In Step 1388, an impactful-to-overall asset ratio is derived. In one or many embodiment(s) disclosed herein, a ratio may generally reference a relationship between two objects, or a relationship a first object of the two objects has with respect to a second object of the two objects. To that end, the impactful-to-overall asset ratio, which may be derived using the cardinalities (obtained in Step 1386) for the (impactful corpus) catalog entry set (identified in Step 1382) and the set of (overall corpus) catalog entries forming the overall corpus catalog (obtained in Step 1384), may reflect a relationship between the two said cardinalities.

In Step 1390, the impactful-to-overall asset ratio (derived in Step 1388) is presented to the organization user. In one or many embodiment(s) disclosed herein, the impactful-to-overall asset ratio, more specifically, may be presented by way of the interactive assessment form (presented in Step 1306). Further, concerning the presentation thereof, the impactful-to-overall asset ratio may be revealed, for example, as a comment, an annotation, or a dialog box. For an example revelation of the impactful-to-overall asset ratio, through an example interactive assessment form, refer to the example scenario illustrated and discussed with respect to FIGS. 31A-31C, below.

From Step 1390, the method proceeds to Step 1308 (see e.g., FIG. 13A), where further engagement, by the organization user and with the interactive assessment form, is monitored.

FIGS. 14A-14C show flowcharts describing a method for insight creation filtering in accordance with one or more embodiments disclosed herein. The various steps outlined below may be performed by an insight service (see e.g., FIG. 1A). Further, while the various steps in the flowchart are presented and described sequentially, one of ordinary skill will appreciate that some or all steps may be executed in different orders, may be combined or omitted, and some or all steps may be executed in parallel.

Turning to FIG. 14A, in Step 1400, a transparent insight query is received. In one or many embodiment(s) disclosed herein, the transparent insight query may include or specify a query expression. The query expression, in turn, may refer to a series of terms (e.g., a sentence), either expressed through text or vocal input, which represents a given query being posed. Further, the transparent insight query may have been submitted by an organization user seeking one or more insights addressing the query expression, as well as other information providing transparency as to how the sought insight(s) may have been derived or inferred. Any insight, meanwhile, may be defined as a finding (or more broadly, as useful knowledge) gained through data analytics or, more precisely, through the discovery of patterns and/or relationships amongst any given assortment of data/information.

In Step 1402, the query expression (received via the transparent insight query in Step 1400) is analyzed. In one or many embodiment(s) disclosed herein, analysis of the query expression may, for example, employ or apply any existing keyword extraction algorithm(s). The analysis of the query expression, accordingly, may result in the extraction of one or more expression keywords, where the extracted expression keyword(s) may best describe, or otherwise represent, the query expression.

In Step 1404, a metadata graph is obtained. In one or many embodiment(s) disclosed herein, the metadata graph may refer to a connected graph (see e.g., FIG. 2A) representative of an asset catalog. The asset catalog may refer to a data structure configured to maintain asset metadata (examples of which are disclosed below) describing a collection of assets known to the insight service, where any asset, in said collection of assets, may refer to either a structured item of information (e.g., tabular data or a dataset) or an unstructured item of information (e.g., text, an image, a video, audio, multimedia, etc.). Further, the asset metadata, maintained in the asset catalog, may be organized across a set of asset catalog entries, where each asset catalog entry may map/correspond to a given asset in the collection of assets and, therefore, may store asset metadata particular to the given asset. The metadata graph, meanwhile, may include or be composed from a set of nodes interconnected by a set of edges, where the set of nodes are representative of the set of asset catalog entries, respectively, whereas the set of edges are representative of connections or relationships there-between.

Examples of said asset metadata, describing any given asset, may include: an asset title or name associated with the given asset; a brief description of the asset; stewardship (or ownership, or authorship) information (e.g., individual or group name(s), contact information, etc.) pertaining to the steward(s)/owner(s)/author(s) of the given asset; a version character string reflective of a version or state of the given asset at/for a given point-in-time; one or more categories, topics, and/or aspects associated with the given asset; an asset identifier uniquely identifying the given asset; one or more tags, keywords, or terms further describing the given asset; a source identifier and/or location associated with an internal or external data source (see e.g., FIG. 1A) where the given asset resides or is maintained; and compliance information specifying laws, regulations, and standards surrounding the given asset, as well as policies directed to data governance (e.g., availability, usability, integrity, and security) pertinent to the given asset. Further, the asset metadata, for any given asset, is not limited to the aforementioned specific examples.

In Step 1406, for each expression keyword, of the expression keyword(s) (extracted in Step 1402), the metadata graph (obtained in Step 1404) is filtered based on the expression keyword. In one or many embodiment(s) disclosed herein, each filtering of the metadata graph may, for example, entail topic or keyword matching (e.g., case-insensitive word or phrase matching) and/or semantic similarity calculation between a given expression keyword and the asset metadata, for the collection of assets, maintained in the set of asset catalog entries, of the asset catalog, to which the set of nodes of the metadata graph map/correspond. Further, each filtering of the metadata graph, based on a given expression keyword, may result in the identification of a node subset of the set of nodes forming the metadata graph. The identified node subset, subsequently, may include one or more nodes mapping/corresponding to one or more assets, respectively, that may be associated, at least in part, with the given expression keyword.

In Step 1408, a k-partite metadata graph is generated using the node subset(s) (identified in Step 1406). In one or many embodiment(s) disclosed herein, the k-partite metadata graph (see e.g., FIGS. 2B-2D) may reflect a new representation of, which may be based on one or more particular perspectives on, the metadata graph (obtained in Step 1404). The k-partite metadata graph, further, may reflect a connected graph that encompasses k independent sets of nodes (i.e., the node subset(s), where k equals the number or cardinality of node subset(s)) and a set of edges interconnecting (and thus defining relationships between) pairs of nodes each belonging to a different independent set of nodes (or node subset)—with the exception of uni-(k=1) partite metadata graphs (see e.g., FIG. 2B) where the set of edges interconnect nodes of the single independent set of nodes (or single node subset) forming the uni-partite metadata graphs.

In Step 1410, a model input snapshot is created. In one or many embodiment(s) disclosed herein, the model input snapshot may represent an item of information (e.g., a data file) that captures the state of a model input at a given point-in-time. The model input, in turn, may refer to one or more items of information that serve(s) as input to an insight inferring model (e.g., a machine learning or artificial intelligence driven model), which may be employed by the insight service, to render one or more insights. Any insight, as disclosed herein, may be defined as a finding (or more broadly, as useful knowledge) gained through data analytics or, more precisely, through the discovery of patterns and/or relationships amongst an assortment of data/information (e.g., the model input). Further, the created model input snapshot may include the following model input state: the k-partite metadata graph (generated in Step 1408); and an asset catalog version/version number associated with the asset catalog represented by the metadata graph (obtained in Step 1404).

In Step 1412, the k-partite metadata graph (generated in Step 1408) is traversed. In one or many embodiment(s) disclosed herein, traversal of the k-partite metadata graph may, for example, employ one or more existing graph theory techniques directed to identifying a subset of nodes from the set of nodes forming the k-partite metadata graph, where each node in the subset of nodes may be deemed most impactful to the derivation, or inference, of any insight(s) addressing the transparent insight query (or the query expression thereof) (received in Step 1400).

In one or many embodiment(s) disclosed herein, identification of the subset of nodes, or any node(s) deemed most impactful to the derivation or inference of any insight(s), may alternatively entail: (a) examining asset metadata pertaining to assets mapped to the nodes in/of the k-partite metadata graph (generated in Step 1408); (b) assigning weights to the nodes, respectively, based on the examined asset metadata; (c) applying a ranking algorithm to the mapped assets based on the assigned weights in order to obtain ranked assets; (d) identifying, or selecting, a subset of the ranked assets, where each ranked asset in the subset of ranked assets holds a rank meeting and/or exceeding a predefined rank threshold; and (e) mapping the subset of ranked assets, respectively, to the subset of nodes.

Further, in one or many embodiment(s) disclosed herein, traversal of the k-partite metadata graph may result in the identification of an insight-pertinent metadata subgraph. A metadata subgraph may generally refer to a connected graph that may be found within, and therefore may include at least a portion of the elements (e.g., a set of nodes interconnected by a set of edges) forming, a larger connected graph (e.g., the k-partite metadata graph). The insight-pertinent metadata subgraph, accordingly, may reference a metadata subgraph, of the k-partite metadata graph, that has been deemed most impactful to the derivation, or inference, of any insight(s) addressing the transparent insight query (or the query expression thereof) (received in Step 1400). The insight-pertinent metadata subgraph, moreover, may include the above-mentioned subset of nodes (also referred to herein as a/the set of subgraph nodes), as well as any subset or all edges (also referred to herein as a/the set of subgraph edges) interconnecting said set of subgraph nodes, from the set of nodes and the set of edges forming the k-partite metadata graph, which may also (by association) be deemed the most impactful to the derivation, or inference, of the any said insight(s).

In Step 1414, an asset catalog subset is identified. In one or many embodiment(s) disclosed herein, the asset catalog subset may include, and thus refer to, one or more asset catalog entries representing at least a subset of the set of asset catalog entries of the asset catalog (mentioned in Step 1404). Further, each asset catalog entry, in the asset catalog subset, may map/correspond to a (different) node in the set of subgraph nodes, at least in part, forming the insight-pertinent metadata subgraph (identified in Step 1412).

In Step 1416, an asset metadata corpus is obtained from, or based on, the asset catalog subset (identified in Step 1414). In one or many embodiment(s) disclosed herein, the asset metadata corpus may refer to a collection of (or aggregated) asset metadata, which may include (individual) asset metadata particular to, and therefore descriptive of, one or more assets (described above—see e.g., Step 1404). Further, obtaining the asset metadata corpus may, for example, entail: extracting the (individual) asset metadata stored in each asset catalog entry in the asset catalog subset; and aggregating the extracted (individual) asset metadata to form the asset metadata corpus.

In Step 1418, the asset metadata corpus (obtained in Step 1416) is subsequently analyzed. In one or many embodiment(s) disclosed herein, analysis of the asset metadata corpus may, for example, employ one or more inference forming algorithms (examples of which are disclosed below) directed to deriving, or inferring, one or more findings (or useful knowledge). Said analysis of the asset metadata corpus, accordingly, may result in the production of one or more insights that may address the transparent insight query (or the query expression thereof) (received in Step 1400).

Examples of the inference forming algorithm(s), which may be employed in the analysis of the asset metadata corpus, may include any existing rule-based, machine learning, and/or deep learning classification algorithms. Further, the inference forming algorithm(s) is/are not limited to the aforementioned specific examples.

Turning to FIG. 14B, in Step 1420, a manifest of (or listing) one or more insight-pertinent assets is created based on the asset metadata corpus (obtained in Step 1416). In one or many embodiment(s) disclosed herein, any insight-pertinent asset may refer to an asset that has been deemed most impactful to the derivation, or inference, of the insight(s) (produced in Step 1418) that address the transparent insight query (or the query expression thereof) (received in Step 1400). Further, identification of each insight-pertinent asset, of the insight-pertinent asset(s) listed in the manifest, may, for example, entail: obtaining an (individual) asset metadata from the (aggregated) asset metadata forming the asset metadata corpus; and examining at least a portion (e.g., an asset identifier) of the (individual) asset metadata to identify the insight-pertinent asset being described by the (individual) asset metadata. Further, for any insight-pertinent asset listed therein, the manifest may specify or include one or more other items of information (e.g., an asset title/name, an asset version, any asset stewardship/ownership/authorship information, any associated topic(s), aspect(s), tag(s), and/or keyword(s), etc.) that may be extracted from the (individual) asset metadata respective to the insight-pertinent asset.

In Step 1422, a model snapshot is created. In one or many embodiment(s) disclosed herein, the model snapshot may represent an item of information (e.g., a data file) that captures the state of an insight inferring model (e.g., a machine learning or artificial intelligence driven model), which may be employed by the insight service, to render one or more insights. Further, the created model snapshot may include the following insight inferring model state: the graph theory technique(s) (employed in the traversal of the k-partite metadata graph in Step 1412); and the inference forming algorithm(s) (employed in the analysis of the asset metadata corpus in Step 1418).

In Step 1424, an interactive query result is created. In one or many embodiment(s) disclosed herein, the interactive query result may refer to an electronic document (e.g., a query result page) displaying editable content that can be adjusted through user engagement or interaction. Further, said content may include, but is not limited to: the insight(s) (produced in Step 1418), the model input snapshot (created in Step 1410), the manifest of (or listing) the insight-pertinent asset(s) (created in Step 1420), and the model snapshot (created in Step 1422).

In one or many embodiment(s) disclosed herein, and as recalled from above, the transparent insight query (received in Step 1400) may have been submitted by the organization user whom seeks the insight(s) (produced in Step 1418) that address the query expression received via the transparent insight query, but also seeks information that provides transparency as to how the insight(s) may have been derived or inferred. From the non-interactive query result (created in Step 1424), said sought information may include the model input snapshot (created in Step 1410), the manifest of (or listing) the insight-pertinent asset(s) (created in Step 1420), and the model snapshot (created in Step 1422). That is, the model input snapshot may reveal the input(s) used in deriving/inferring the insight(s); the manifest of (or listing) the insight-pertinent asset(s) may reveal the asset(s) (or, more specifically, the asset metadata thereof) deemed most impactful in deriving/inferring the insight(s); and the model snapshot may reveal the technique(s)/algorithm(s), applied to the input(s) and the asset metadata, and thus used in deriving/inferring the insight(s).

In Step 1426, the interactive query result (created in Step 1425) is provided in response to the transparent insight query (received in Step 1400). Particularly, in one or many embodiment(s) disclosed herein, the interactive query result may be provided to the organization user who had submitted the transparent insight query.

In Step 1428, a user interaction with the interactive query result (provided in Step 1416), by the organization user, is detected. In one or many embodiment(s) disclosed herein, the user interaction may reflect an adjustment to (e.g., a pruning of) the manifest of (or listing) the insight-pertinent asset(s) (created in Step 1420), which is included in the interactive query result. Further, detection of the user interaction may, for example, involve the receiving of telemetry from one or more insight agents (see e.g., FIG. 1B) executing on a client device operated by the organization user, where the interactive query result had been forwarded to the client device in order to provide the interactive query result to the organization user.

In one or many embodiment(s) disclosed herein, the organization user may opt to adjust (or prune) the manifest of (or listing) the insight-pertinent asset(s) after, for example, (a) examining the asset metadata (e.g., an asset title/name, an asset version, any asset stewardship/ownership/authorship information, any associated topic(s), aspect(s), tag(s), and/or keyword(s), etc.) recited in the manifest and, (b) based on their respective, recited asset metadata, identifying one or more insight-pertinent assets that the organization user sees as irrelevant to the query expression, or untrustworthy to consider. The organization user may opt to adjust (or prune) the manifest for one or more additional, or alternative, reasons without departing from the scope disclosed herein.

In Step 1430, a subgraph node subset is identified. In one or many embodiment(s) disclosed herein, the subgraph node subset may include, and thus refer to, one or more subgraph nodes representing at least a subset of the set of subgraph nodes, at least in part, forming the insight-pertinent metadata subgraph (identified in Step 1412). Further, each subgraph node, in the subgraph node subset, may map/correspond to an (different) insight-pertinent asset in the set of insight-pertinent assets listed in the manifest (created in Step 1424), where the (different) insight-pertinent asset is impacted by the user interaction (detected in Step 1428). For example, the adjustment to the manifest, by the organization user, may entail a removal or deletion of one or more insight-pertinent assets from the manifest. In such an example, the removed/deleted insight-pertinent asset(s) may, respectively, map/correspond to one or more subgraph nodes in the subgraph node subset.

In Step 1432, a new insight-pertinent metadata subgraph is derived. In one or many embodiment(s) disclosed herein, the new insight-pertinent metadata subgraph may reference a metadata subgraph (described above—see e.g., Step 1412), of the insight-pertinent metadata subgraph (identified in Step 1412), which may be derived from the insight-pertinent metadata subgraph and the subgraph node subset (identified in Step 1430). By way of an example, derivation of the new insight-pertinent metadata subgraph may entail removing, from the insight-pertinent metadata subgraph: the subgraph node subset; and any subgraph edge(s), in the set of subgraph edges of the insight-pertinent metadata subgraph, which may connect to at least any subgraph node(s) in the subgraph node subset. The new insight-pertinent metadata subgraph, accordingly, may include a subset of the set of subgraph nodes, as well as a subset of the set of subgraph edges, that had formed the insight-pertinent metadata subgraph.

In Step 1434, a new asset catalog subset is identified. In one or many embodiment(s) disclosed herein, the new asset catalog subset may include, and thus refer to, one or more asset catalog entries representing at least a subset of the set of asset catalog entries of the asset catalog (mentioned in Step 1404). Further, each asset catalog entry, in the new asset catalog subset, may map/correspond to a (different) node in the new set of subgraph nodes, at least in part, forming the new insight-pertinent metadata subgraph (derived in Step 1432).

Turning to FIG. 14C, in Step 1436, a new asset metadata corpus is obtained from, or based on, the new asset catalog subset (identified in Step 1434). In one or many embodiment(s) disclosed herein, the new asset metadata corpus may refer to a collection of (or aggregated) asset metadata, which may include (individual) asset metadata particular to, and therefore descriptive of, one or more assets (described above—see e.g., Step 1404). Further, obtaining the new asset metadata corpus may, for example, entail: extracting the (individual) asset metadata stored in each asset catalog entry in the new asset catalog subset; and aggregating the extracted (individual) asset metadata to form the new asset metadata corpus.

In Step 1438, the new asset metadata corpus (obtained in Step 1436) is subsequently analyzed. In one or many embodiment(s) disclosed herein, analysis of the new asset metadata corpus may, for example, employ one or more inference forming algorithms (examples of which are disclosed above—see e.g., Step 1418) directed to deriving, or inferring, one or more findings (or useful knowledge). Said analysis of the new asset metadata corpus, accordingly, may result in the production of one or more new insights that may address the transparent insight query (or the query expression thereof) (received in Step 1400). Further, the new insight(s) may either reflect the same insight(s) as, or different insight(s) from, the insight(s) (produced in Step 1418).

In Step 1444, a new manifest of (or listing) one or more new insight-pertinent assets is created based on the new asset metadata corpus (obtained in Step 1436). In one or many embodiment(s) disclosed herein, any new insight-pertinent asset may refer to an asset that has been deemed most impactful to the derivation, or inference, of the new insight(s) (produced in Step 1438) that address the transparent insight query (or the query expression thereof) (received in Step 1400). Further, identification of each new insight-pertinent asset, of the new insight-pertinent asset(s) listed in the new manifest, may, for example, entail: obtaining an (individual) asset metadata from the (aggregated) asset metadata forming the new asset metadata corpus; and examining at least a portion (e.g., an asset identifier) of the (individual) asset metadata to identify the new insight-pertinent asset being described by the (individual) asset metadata. Further, for any new insight-pertinent asset listed therein, the new manifest may specify or include one or more other items of information (e.g., an asset title/name, an asset version, any asset stewardship/ownership/authorship information, any associated topic(s), aspect(s), tag(s), and/or keyword(s), etc.) that may be extracted from the (individual) asset metadata respective to the new insight-pertinent asset.

In Step 1442, a new interactive query result is created. In one or many embodiment(s) disclosed herein, the new interactive query result may resemble the interactive query result (created in Step 1424) and, therefore, may also refer to an electronic document (e.g., a query result page) displaying editable content that can be adjusted through user engagement or interaction. Further, said content may include, but is not limited to: the new insight(s) (produced in Step 1438), the model input snapshot (created in Step 1410), the new manifest of (or listing) the new insight-pertinent asset(s) (created in Step 1440), and the model snapshot (created in Step 1422).

In one or many embodiment(s) disclosed herein, and as recalled from above, the transparent insight query (received in Step 1400) may have been submitted by the organization user whom seeks the insight(s) (produced in Step 1418) and, later, the new insight(s) (produced in Step 1438)—each of which may address the query expression received via the transparent insight query—however, the organization user also seeks information that provides transparency as to how the insight(s) and/or the new insight(s) may have been derived or inferred. From the new interactive query result (created in Step 1442), said sought information may include the model input snapshot (created in Step 1410), the new manifest of (or listing) the new insight-pertinent asset(s) (created in Step 1440), and the model snapshot (created in Step 1422). That is, the model input snapshot may reveal the input(s) used in deriving/inferring the insight(s); the new manifest of (or listing) the new insight-pertinent asset(s) may reveal the asset(s) (or, more specifically, the asset metadata thereof) deemed most impactful in deriving/inferring the new insight(s); and the model snapshot may reveal the technique(s)/algorithm(s), applied to the input(s) and the asset metadata, and thus used in deriving/inferring the insight(s).

In Step 1444, the new interactive query result (created in Step 1442) is provided in response to the user interaction (detected in Step 1428). Particularly, in one or many embodiment(s) disclosed herein, the new interactive query result may be provided to the organization user who had performed the user interaction.

FIGS. 15A and 15B show flowcharts describing a method for insight creation transparency in accordance with one or more embodiments disclosed herein. The various steps outlined below may be performed by an insight service (see e.g., FIG. 1A). Further, while the various steps in the flowchart are presented and described sequentially, one of ordinary skill will appreciate that some or all steps may be executed in different orders, may be combined or omitted, and some or all steps may be executed in parallel.

Turning to FIG. 15A, in Step 1500, a transparent insight query is received. In one or many embodiment(s) disclosed herein, the transparent insight query may include or specify a query expression. The query expression, in turn, may refer to a series of terms (e.g., a sentence), either expressed through text or vocal input, which represents a given query being posed. Further, the transparent insight query may have been submitted by an organization user seeking one or more insights addressing the query expression, as well as other information providing transparency as to how the sought insight(s) may have been derived or inferred. Any insight, meanwhile, may be defined as a finding (or more broadly, as useful knowledge) gained through data analytics or, more precisely, through the discovery of patterns and/or relationships amongst any given assortment of data/information.

In Step 1502, the query expression (received via the transparent insight query in Step 1500) is analyzed. In one or many embodiment(s) disclosed herein, analysis of the query expression may, for example, employ or apply any existing keyword extraction algorithm(s). The analysis of the query expression, accordingly, may result in the extraction of one or more expression keywords, where the extracted expression keyword(s) may best describe, or otherwise represent, the query expression.

In Step 1504, a metadata graph is obtained. In one or many embodiment(s) disclosed herein, the metadata graph may refer to a connected graph (see e.g., FIG. 2A) representative of an asset catalog. The asset catalog may refer to a data structure configured to maintain asset metadata (examples of which are disclosed below) describing a collection of assets known to the insight service, where any asset, in said collection of assets, may refer to either a structured item of information (e.g., tabular data or a dataset) or an unstructured item of information (e.g., text, an image, a video, audio, multimedia, etc.). Further, the asset metadata, maintained in the asset catalog, may be organized across a set of asset catalog entries, where each asset catalog entry may map/correspond to a given asset in the collection of assets and, therefore, may store asset metadata particular to the given asset. The metadata graph, meanwhile, may include or be composed from a set of nodes interconnected by a set of edges, where the set of nodes are representative of the set of asset catalog entries, respectively, whereas the set of edges are representative of connections or relationships there-between.

Examples of said asset metadata, describing any given asset, may include: an asset title or name associated with the given asset; a brief description of the asset; stewardship (or ownership, or authorship) information (e.g., individual or group name(s), contact information, etc.) pertaining to the steward(s)/owner(s)/author(s) of the given asset; a version character string reflective of a version or state of the given asset at/for a given point-in-time; one or more categories, topics, and/or aspects associated with the given asset; an asset identifier uniquely identifying the given asset; one or more tags, keywords, or terms further describing the given asset; a source identifier and/or location associated with an internal or external data source (see e.g., FIG. 1A) where the given asset resides or is maintained; and compliance information specifying laws, regulations, and standards surrounding the given asset, as well as policies directed to data governance (e.g., availability, usability, integrity, and security) pertinent to the given asset. Further, the asset metadata, for any given asset, is not limited to the aforementioned specific examples.

In Step 1506, for each expression keyword, of the expression keyword(s) (extracted in Step 1502), the metadata graph (obtained in Step 1504) is filtered based on the expression keyword. In one or many embodiment(s) disclosed herein, each filtering of the metadata graph may, for example, entail topic or keyword matching (e.g., case-insensitive word or phrase matching) and/or semantic similarity calculation between a given expression keyword and the asset metadata, for the collection of assets, maintained in the set of asset catalog entries, of the asset catalog, to which the set of nodes of the metadata graph map/correspond. Further, each filtering of the metadata graph, based on a given expression keyword, may result in the identification of a node subset of the set of nodes forming the metadata graph. The identified node subset, subsequently, may include one or more nodes mapping/corresponding to one or more assets, respectively, that may be associated, at least in part, with the given expression keyword.

In Step 1508, a k-partite metadata graph is generated using the node subset(s) (identified in Step 1506). In one or many embodiment(s) disclosed herein, the k-partite metadata graph (see e.g., FIGS. 2B-2D) may reflect a new representation of, which may be based on one or more particular perspectives on, the metadata graph (obtained in Step 1504). The k-partite metadata graph, further, may reflect a connected graph that encompasses k independent sets of nodes (i.e., the node subset(s), where k equals the number or cardinality of node subset(s)) and a set of edges interconnecting (and thus defining relationships between) pairs of nodes each belonging to a different independent set of nodes (or node subset)—with the exception of uni-(k=1) partite metadata graphs (see e.g., FIG. 2B) where the set of edges interconnect nodes of the single independent set of nodes (or single node subset) forming the uni-partite metadata graphs.

In Step 1510, a model input snapshot is created. In one or many embodiment(s) disclosed herein, the model input snapshot may represent an item of information (e.g., a data file) that captures the state of a model input at a given point-in-time. The model input, in turn, may refer to one or more items of information that serve(s) as input to an insight inferring model (e.g., a machine learning or artificial intelligence driven model), which may be employed by the insight service, to render one or more insights. Any insight, as disclosed herein, may be defined as a finding (or more broadly, as useful knowledge) gained through data analytics or, more precisely, through the discovery of patterns and/or relationships amongst an assortment of data/information (e.g., the model input). Further, the created model input snapshot may include the following model input state: the k-partite metadata graph (generated in Step 1508); and an asset catalog version/version number associated with the asset catalog represented by the metadata graph (obtained in Step 1504).

In Step 1512, the k-partite metadata graph (generated in Step 1508) is traversed. In one or many embodiment(s) disclosed herein, traversal of the k-partite metadata graph may, for example, employ one or more graph theory techniques directed to identifying a subset of nodes from the set of nodes forming the k-partite metadata graph, where each node in the subset of nodes may be deemed most impactful to the derivation, or inference, of any insight(s) addressing the transparent insight query (or the query expression thereof) (received in Step 1500).

In one or many embodiment(s) disclosed herein, identification of the subset of nodes, or any node(s) deemed most impactful to the derivation or inference of any insight(s), may alternatively entail: (a) examining asset metadata pertaining to assets mapped to the nodes in/of the k-partite metadata graph (generated in Step 1508); (b) assigning weights to the nodes, respectively, based on the examined asset metadata; (c) applying a ranking algorithm to the mapped assets based on the assigned weights in order to obtain ranked assets; (d) identifying, or selecting, a subset of the ranked assets, where each ranked asset in the subset of ranked assets holds a rank meeting and/or exceeding a predefined rank threshold; and (e) mapping the subset of ranked assets, respectively, to the subset of nodes.

Further, in one or many embodiment(s) disclosed herein, traversal of the k-partite metadata graph may result in the identification of an insight-pertinent metadata subgraph. A metadata subgraph may generally refer to a connected graph that may be found within, and therefore may include at least a portion of the elements (e.g., a set of nodes interconnected by a set of edges) forming, a larger connected graph (e.g., the k-partite metadata graph). The insight-pertinent metadata subgraph, accordingly, may reference a metadata subgraph, of the k-partite metadata graph, that has been deemed most impactful to the derivation, or inference, of any insight(s) addressing the transparent insight query (or the query expression thereof) (received in Step 1500). The insight-pertinent metadata subgraph, moreover, may include the above-mentioned subset of nodes (also referred to herein as a/the set of subgraph nodes), as well as any subset or all edges (also referred to herein as a/the set of subgraph edges) interconnecting said set of subgraph nodes, from the set of nodes and the set of edges forming the k-partite metadata graph, which may also (by association) be deemed the most impactful to the derivation, or inference, of the any said insight(s).

In Step 1514, an asset catalog subset is identified. In one or many embodiment(s) disclosed herein, the asset catalog subset may include, and thus refer to, one or more asset catalog entries representing at least a subset of the set of asset catalog entries of the asset catalog (mentioned in Step 1504). Further, each asset catalog entry, in the asset catalog subset, may map/correspond to a (different) node in the set of subgraph nodes, at least in part, forming the insight-pertinent metadata subgraph (identified in Step 1512).

In Step 1516, an asset metadata corpus is obtained from, or based on, the asset catalog subset (identified in Step 1514). In one or many embodiment(s) disclosed herein, the asset metadata corpus may refer to a collection of (or aggregated) asset metadata, which may include (individual) asset metadata particular to, and therefore descriptive of, one or more assets (described above—see e.g., Step 1504). Further, obtaining the asset metadata corpus may, for example, entail: extracting the (individual) asset metadata stored in each asset catalog entry in the asset catalog subset; and aggregating the extracted (individual) asset metadata to form the asset metadata corpus.

In Step 1518, the asset metadata corpus (obtained in Step 1516) is subsequently analyzed. In one or many embodiment(s) disclosed herein, analysis of the asset metadata corpus may, for example, employ one or more inference forming algorithms (examples of which are disclosed below) directed to deriving, or inferring, one or more findings (or useful knowledge). Said analysis of the asset metadata corpus, accordingly, may result in the production of one or more insights that may address the transparent insight query (or the query expression thereof) (received in Step 1500).

Examples of the inference forming algorithm(s), which may be employed in the analysis of the asset metadata corpus, may include any existing rule-based, machine learning, and/or deep learning classification algorithms. Further, the inference forming algorithm(s) is/are not limited to the aforementioned specific examples.

Turning to FIG. 15B, in Step 1520, a manifest of (or listing) one or more insight-pertinent assets is created based on the asset metadata corpus (obtained in Step 1516). In one or many embodiment(s) disclosed herein, any insight-pertinent asset may refer to an asset that has been deemed most impactful to the derivation, or inference, of the insight(s) (produced in Step 1518) that address the transparent insight query (or the query expression thereof) (received in Step 1500). Further, identification of each insight-pertinent asset, of the insight-pertinent asset(s) listed in the manifest, may, for example, entail: obtaining an (individual) asset metadata from the (aggregated) asset metadata forming the asset metadata corpus; and examining at least a portion (e.g., an asset identifier) of the (individual) asset metadata to identify the insight-pertinent asset being described by the (individual) asset metadata. Further, for any insight-pertinent asset listed therein, the manifest may specify or include one or more other items of information (e.g., an asset title/name, an asset version, any asset stewardship/ownership/authorship information, any associated topic(s), aspect(s), tag(s), and/or keyword(s), etc.) that may be extracted from the (individual) asset metadata respective to the insight-pertinent asset.

In Step 1522, a model snapshot is created. In one or many embodiment(s) disclosed herein, the model snapshot may represent an item of information (e.g., a data file) that captures the state of an insight inferring model (e.g., a machine learning or artificial intelligence driven model), which may be employed by the insight service, to render one or more insights. Further, the created model snapshot may include the following insight inferring model state: the graph theory technique(s) (employed in the traversal of the k-partite metadata graph in Step 1512); and the inference forming algorithm(s) (employed in the analysis of the asset metadata corpus in Step 1518).

In Step 1524, a non-interactive query result is created. In one or many embodiment(s) disclosed herein, the non-interactive query result may refer to an electronic document (e.g., a query result page) displaying static content that cannot be adjusted through user engagement or interaction. Further, said content may include, but is not limited to: the insight(s) (produced in Step 1518), the model input snapshot (created in Step 1510), the manifest of (or listing) the insight-pertinent asset(s) (created in Step 1520), and the model snapshot (created in Step 1522).

In one or many embodiment(s) disclosed herein, and as recalled from above, the transparent insight query (received in Step 1500) may have been submitted by the organization user whom seeks the insight(s) (produced in Step 1518) that address the query expression received via the transparent insight query, but also seeks information that provides transparency as to how the insight(s) may have been derived or inferred. From the non-interactive query result (created in Step 1524), said sought information may include the model input snapshot (created in Step 1510), the manifest of (or listing) the insight-pertinent asset(s) (created in Step 1520), and the model snapshot (created in Step 1522). That is, the model input snapshot may reveal the input(s) used in deriving/inferring the insight(s); the manifest of (or listing) the insight-pertinent asset(s) may reveal the asset(s) (or, more specifically, the asset metadata thereof) deemed most impactful in deriving/inferring the insight(s); and the model snapshot may reveal the technique(s)/algorithm(s), applied to the input(s) and the asset metadata, and thus used in deriving/inferring the insight(s).

In Step 1526, the non-interactive query result (created in Step 1524) is provided in response to the transparent insight query (received in Step 1500). Particularly, in one or many embodiment(s) disclosed herein, the non-interactive query result may be provided to the organization user who had submitted the transparent insight query.

FIG. 16A shows a flowchart describing a method for the prediction of and support readiness for future business intents in accordance with one or more embodiments disclosed herein. The various steps outlined below may be performed by an insight service (see e.g., FIG. 1A). Further, while the various steps in the flowchart are presented and described sequentially, one of ordinary skill will appreciate that some or all steps may be executed in different orders, may be combined or omitted, and some or all steps may be executed in parallel.

Turning to FIG. 16A, in Step 1600, an organization user is identified. In one or many embodiment(s) disclosed herein, the organization user may refer to an individual whom may be employed by, or may otherwise be affiliated with, an organization. Examples of said organization may include, but are not limited to, a business/commercial entity, a higher education school, a government agency, and a research institute. Further, the organization user may be identified at random or based on an identification criterion (e.g., detection of the recent completion of an organization goal assigned to and by the organization user).

In Step 1602, a (current) user business intent is obtained. In one or many embodiment(s) disclosed herein, the (current) user business intent may pertain to the organization user (identified in Step 1600). Further, the user business intent may refer to information, respective to the organization user, which may pertain to or describe the engagement of the organization user within and/or outside their organization.

In one or many embodiment(s) disclosed herein, the (current) user business intent, moreover, may be represented through a set of business intent parameters. Examples of said business intent parameter(s) (as they pertain to any given organization user) may include, but is/are not limited to: one or more user organization roles (e.g., title(s) and/or position(s)) within an organization that may be associated with the given organization user; one or more other organization users within the organization with which the given organization user interacts and/or had interacted; one or more suppliers, distributors, customers, collaborators, and/or other actors outside the organization (also collectively referred to herein as one or more value networks) with which the given organization user interacts and/or had interacted; a search query history reflecting one or more past search queries, as well as the search topic(s) entailed, which had been previously submitted by the given organization user; one or more organization departments of the organization with which the given organization user is associated; one or more organization responsibilities (e.g., assigned project(s) or task(s)) within the organization that the given organization user is currently undertaking or had undertaken in the past; and one or more success metrics indicating a level of success that the aforementioned organization responsibility/responsibilities have brought to the organization. Said business intent parameter(s) is/are not limited to the aforementioned specific examples.

In Step 1604, one or more intent predictive models is/are built. In one or many embodiment(s) disclosed herein, any intent predictive model may refer to a machine learning based analytical computer program designed and configured to forecast, or extrapolate, future or prospective user business intents (described below). Further, building of any intent predictive model may follow existing methodologies for creating a machine learning model, including, for example: selecting a machine learning algorithm (e.g., neural networks, decision trees, random forests, linear/logistic regression, support vector machines, etc.) to serve as a template for the machine learning model; optimizing, through one or more iterations of training, the parameters and/or hyper-parameters specific to the selected machine learning algorithm using one or more training datasets; and obtaining the machine learning model defined by the optimized parameters and/or hyper-parameters post-training.

In Step 1606, one or more prospective user business intents, for the organization user (identified in Step 1600), is/are extrapolated. In one or many embodiment(s) disclosed herein, any prospective user business intent may refer to information, respective to the organization user, which may outline a possible or potential evolution in one or more business intent parameters (described above) representing the (current) user business intent (obtained in Step 1602). For example, a prospective user business intent may include predictions concerning future search queries that may be (or have a high likelihood of being) submitted by the organization user in one or more future points-in-time based at least on the search query history associated with the organization user. By way of another example, a prospective user business intent may include predictions concerning future organization responsibilities (e.g., future projects, tasks, and/or goals) that may be (or have a high likelihood of being) undertaken by the organization user in one or more future points-in-time based at least on past and/or current organization responsibilities undertaken by the organization user and any historical and/or recent organization strategy cascade(s).

Further, in one or many embodiment(s) disclosed herein, extrapolation of the prospective user business intent(s) may result from usage of the intent predictive model(s) (built in Step 1604)—the intent predictive model(s) being configured to: ingest, and subsequently identify patterns throughout, the (current) user business intent; and forecast, or extrapolate, future or prospective user business intent(s) based on the identified patterns. Should more than one intent predictive model be used, said two or more intent predictive models may be assembled into an intent predictive model pipeline reflecting a series of data processing stages. Each data processing stage may involve one of the at least two intent predictive models being employed. Moreover, each data processing stage may use the output of a previous data processing stage in the series (if any) as input to be processed, by the involved intent predictive model, in order to produce an output for the data processing stage. For example: the input(s) for a first data processing stage may include the (current) user business intent, which may be processed by a first intent predictive model to obtain a first stage output; the input(s) for a second data processing stage may include the first stage output, which may be processed by a second intent predictive model to obtain a second stage output; and so forth. The stage output, for a last data processing stage in the series, may include any future/prospective user business intent(s).

In Step 1608, for each prospective user business intent of the prospective user business intent(s) (extrapolated in Step 1606), an inter-intent roadmap is pursued. In one or many embodiment(s) disclosed herein, the inter-intent roadmap may refer to a readiness pipeline for supporting the prospective user business intent, which uses the (current) user business intent (obtained in Step 1602) as a baseline or starting point. The readiness pipeline, in turn, may outline a series of inter-intent bridging steps aiming to achieve the prospective user business intent, from said baseline, should the organization user actually embark in the prospective user business intent at any given future point-in-time. Pursuit of the inter-intent roadmap is illustrated and described in further detail with respect to FIG. 16B, below.

FIG. 16B shows a flowchart describing a method for pursuing an inter-intent roadmap in accordance with one or more embodiments disclosed herein. The various steps outlined below may be performed by an insight service (see e.g., FIG. 1A). Further, while the various steps in the flowchart are presented and described sequentially, one of ordinary skill will appreciate that some or all steps may be executed in different orders, may be combined or omitted, and some or all steps may be executed in parallel.

Turning to FIG. 16B, in Step 1610, (current) user talent information is obtained. In one or many embodiment(s) disclosed herein, the (current) user talent information may pertain to an organization user (identified in FIG. 16A—see e.g. Step 1600). Further, the (current) user talent information may reflect a compilation of talent- and development-related details associated with the organization user. Examples of said details may include, but are not limited to: an education level (e.g., degree(s) in which domain(s), as well as which tier(s) of degree(s)) earned by the organization user; any professional certification(s) gained by the organization user; one or more competencies (as well as their respective level(s) and/or potential(s)) characterizing the organization user; and any business- or research-related interest(s) (as well as their respective proficiency/proficiencies) expressed by the organization user. The compiled details defining the user talent information for any given organization user are not limited to the aforementioned specific examples.

In Step 1612, one or more user inter-intent gaps is/are identified. In one or many embodiment(s) disclosed herein, a user inter-intent gap may refer to an inferred differentiator (e.g., what is lacking) between the prospective user business intent and a current user intent state for the organization user. The prospective user business intent may refer to one of the prospective user business intent(s) (extrapolated in FIG. 16A—see e.g., Step 1606) for which support is being readied through pursuit of an inter-intent roadmap outlined by the instant method. Meanwhile, the current user intent state may collectively reference a (current) user business intent (obtained in FIG. 16A—see e.g., Step 1602) and the (current) user talent information (obtained in Step 1610). Furthermore, identification of the user inter-intent gap(s) may result, for example, from any existing algorithm(s) directed to gap or needs analysis, and that may be applied between the prospective user business intent and the current user intent state.

In Step 1614, (current) user learning preferences are obtained. In one or many embodiment(s) disclosed herein, the (current) user learning preferences may pertain to the organization user (identified in FIG. 16A—see e.g., Step 1600). Further, the (current) user learning preferences may reflect one or more educational modalities that the organization user may favor over others in order to optimize learning topic comprehension and retention. Said educational modality/modalities may include, but is/are not limited to, visual learning (i.e., learning assisted through images, videos, animations, and/or multimedia), auditory learning (i.e., learning assisted through audio), and reading learning (i.e., learning assisted through text-based content).

In Step 1616, gap-bridging support is selected. In one or many embodiment(s) disclosed herein, the gap-bridging support may include one or more assets (e.g., structured information such as tabular data, and/or unstructured information such as text, images, audio, videos, multimedia, etc.) catalogued by, and thus known to, the insight service. Further, the asset(s) may be selected such that they (separately or in combination) discuss, or otherwise capture, one or more topics or domains that address the user inter-intent gap(s) (identified in Step 1612); and such that they (each) match or align with the (current) user learning preferences (obtained in Step 1614).

In one or many embodiment(s) disclosed herein, any asset catalogued by, and thus known to, the insight service may be recorded in an asset catalog entry of an asset catalog. An asset catalog entry, for any given asset, may store metadata for, or information descriptive of, the given asset.

Examples of said asset metadata may include, but is not limited to: a brief description of the asset; stewardship (or ownership) information (e.g., individual or group name(s), contact information, etc.) pertaining to the steward(s)/owner(s) of the asset; a version character string reflective of a version or state of the asset at/for a given point-in-time; one or more categories, topics, and/or aspects associated with the asset; an asset identifier uniquely identifying the asset; one or more tags, keywords, or terms further describing the asset; a source identifier and/or location associated with an internal or external data source (see e.g., FIG. 1A) where the asset resides or is maintained; and compliance information specifying laws, regulations, and standards surrounding the asset, as well as policies directed to data governance (e.g., availability, usability, integrity, and security) pertinent to the asset. The asset metadata for any asset is not limited to the aforementioned specific examples.

In one or many other embodiment(s) disclosed herein, the gap-bridging support may additionally, or alternatively, include a learning curriculum. The learning curriculum may refer to an ordered itemization/listing (or sequenced itemization/listing) of learning materials and/or content (i.e., collectively, one or more assets) that progressively teaches improved proficiency in one or more given learning topics. Each learning topic may, at least in part, address the user inter-intent gap(s) (identified in Step 1612). The learning curriculum, further, may be tailored to, and therefore may align with the (current) user talent information (obtained in Step 1610) and/or the (current) user learning preferences (obtained in Step 1614).

That is, in one or many embodiment(s) disclosed herein, the learning curriculum may reflect a series, or an ordered set, of assets that teach progressively more difficult or more advanced aspects of the learning topic(s) sought to overcome the user inter-intent gap(s) (identified in Step 1612). For example, an initially ordered asset specified in the learning curriculum may be commensurate to a novice/basic knowledge level or, alternatively, a standing/current knowledge level that the organization user may retain, concerning the learning topic(s). On the other hand, a lastly ordered asset specified in the learning curriculum may be representative of a mastery knowledge level concerning the learning topic(s). Further, any asset ordered there-between may serve to progressively advance the proficiency, of/by the organization user, in terms of the learning topic(s).

In Step 1618, user access permissions are obtained. In one or many embodiment(s) disclosed herein, the user access permissions may pertain to the organization user (identified in FIG. 16A—see e.g., Step 1600). Further, the user access permissions may reflect the level of authorization granted to the organization user for accessing specific resources. The granted level of authorization, for any given organization user, may, for example, be contingent on any number of factors, which may include, but is/are not limited to: one or more user organization roles (e.g., title(s) and/or position(s)) within an organization that may be associated with the given organization user; one or more organization responsibilities (e.g., assigned project(s) or task(s)) within an organization that may be associated with the given organization user; a client device (and the security hygiene or characteristics thereof) operated by the given organization user; and a geographical location where the given organization user may be physically situated. The factor(s) affecting the user access permissions for any given organization user is/are not limited to the aforementioned specific examples.

In Step 1620, the user access permissions (obtained in Step 1618) are assessed against compliance information for the gap-bridging support (or more specifically, the forming set of assets) (selected in Step 1616). In one or many embodiment(s) disclosed herein, assessment of the user access permissions, against the asset compliance information, may, for example, entail determining: whether a geographical location of the organization user is within the geographical restrictions or boundaries, at least in part, defining access to an asset; whether the organization, with which the organization user is associated, is of a particular type (e.g., a commercial business, an educational institution, etc.) to which access and usability of an asset is granted; and whether one or more organization roles (e.g., title(s) and/or position(s)) and/or professional affiliation(s) (e.g., membership(s) to professional organization(s)), with which the organization user is associated, satisfies criteria for permitting access to an asset.

Moreover, the above-mentioned assessment, between the user access permissions and the asset compliance information, may result in producing access remarks that concern the asset(s) associated with the compliance information. In one or many embodiment(s) disclosed herein, any access remarks may refer to information expressing whether the asset(s) is/are accessible or inaccessible to/by the organization user. Said information (for any given asset) may include, but is not limited to: an accessibility statement indicating that the given asset can or cannot be accessed by the organization user; one or more reasons explaining or supporting the accessibility statement; a digital reference link (e.g., uniform resource locator or hyperlink) or an access protocol through which the organization user can access the given asset should the accessibility statement indicate that the given asset can be accessed by the organization user; and/or the stewardship information (mentioned in Step 1616) associated with the given asset should the accessibility statement alternatively indicate that the given asset cannot be accessed by the organization user.

In one or many embodiment(s) disclosed herein, stewardship information may be integrated, as part of the access remarks for a given asset (if applicable—e.g., if the given asset is deemed inaccessible), in order to provide the organization user with an opportunity to potentially gain access to the given asset through communications with the steward(s) or owner(s) of the given asset. The potential to gain access to the given asset through this avenue, however, may be moot or disregarded in view of other, higher-tiered compliance policies such as those outlined by geographical restrictions, as well as national and/or international laws, regulations, and standards.

In Step 1622, a support availability is determined. In one or many embodiment(s) disclosed herein, the support availability may pertain to the gap-bridging support (or more specifically, the forming set of assets) (selected in Step 1616). Further, the determination of support (e.g., asset) availability for any given asset may, for example, entail the submission of an asset availability query to an appropriate (i.e., internal or external) data source identified in the asset metadata describing the given asset. Any asset availability query may include or specify an asset identifier (also found in the asset metadata) that uniquely identifies the given asset. Moreover, in response to any asset availability query, a corresponding asset availability reply may be received, which may include or specify an asset availability state indicating whether the given asset is available (e.g., obtainable, usable, or reachable) or unavailable (e.g., unobtainable, unusable, or unreachable). Thereafter, the returned asset availability state(s) for the asset(s), respectively, may be used to produce availability remarks concerning the asset(s). Any availability remarks may refer to information expressing whether the asset(s) is/are available or unavailable at/on one or more data sources that the asset(s) currently reside, or at one time, had resided.

In Step 1624, a user identifier (ID) is obtained. In one or many embodiment(s) disclosed herein, the user ID may pertain to the organization user (identified in FIG. 16A—see e.g., Step 1600). Further, the user ID may reflect a character string that uniquely identifies the organization user. The character string may be of any arbitrary length and may be formed from any combination or order of characters, where the characters may include, but are not limited to, one or more letters, one or more numbers, and/or one or more symbols.

In Step 1626, a roadmap record is created (and subsequently stored). In one or many embodiment(s) disclosed herein, the roadmap record may be exemplified by a database entry, an information container, or a data directory (for maintaining information across one or more data files). Further, the roadmap record may include: the user ID (obtained in Step 1624); the prospective user business intent (i.e., one of the prospective user business intent(s) (extrapolated in FIG. 16A—see e.g., Step 1606)) for which support is being readied through pursuit of an inter-intent roadmap outlined by the instant method; a manifest of, and thus listing, the gap-bridging support (selected in Step 1616); the access remarks (produced in Step 1620); and the availability remarks (produced in Step 1622).

FIGS. 17A and 17B show flowcharts describing a method for dynamic questioning intelligence in accordance with one or more embodiments disclosed herein. The various steps outlined below may be performed by an insight service (see e.g., FIG. 1A). Further, while the various steps in the flowchart are presented and described sequentially, one of ordinary skill will appreciate that some or all steps may be executed in different orders, may be combined or omitted, and some or all steps may be executed in parallel.

Turning to FIG. 17A, in Step 1700, an initiation of a conference interview program, by an organization user, is detected. In one or many embodiment(s) disclosed herein, the conference interview program may refer to any software application configured to question any user thereof (e.g., the organization user) about any conference(s) recently attended by the user. A conference, in turn, may reference a large, formal meeting organized around one or more themes (e.g., business, technology, etc.) discoursed through a combination of forums, seminars, workshops, presentations, etc. A conference may also host retailers and suppliers, representing organizations related to and/or involved in said theme(s), whom usually seek to find markets and customers from among the conference attendees. Further, detection of the initiation of the conference interview program may, for example, entail the receiving of telemetry from one or more insight agents (see e.g., FIG. 1B) executing on a client device operated by the organization user, where the conference interview program also executes on the aforementioned client device. The insight agent(s), accordingly, may be embedded within, or may otherwise be associated with, the conference interview program.

In Step 1702, following initiation of the conference interview program (detected in Step 1700), the organization user is prompted for a few preliminary inputs. In one or many embodiment(s) disclosed herein, the few preliminary inputs include a user identifier (ID), a conference link, and an attended sessions list. The user ID may refer to a character string (e.g., an account username, an employee number, etc.) that uniquely identifies the organization user within an organization (e.g., a commercial/business entity, a higher education school, a government agency, a research institute, etc.) with which the organization user is affiliated. The conference link, meanwhile, may refer to a universal resource locator (URL) associated with a conference website for the conference that had been recently attended by the organization user. The attended sessions list, lastly, may refer to a list of conference sessions (e.g., segments of a conference during which discussions tend to be directed to particular topics under the conference theme(s)) that had been attended by the organization user. Furthermore, the organization user may be prompted for said few preliminary inputs through, for example, a user interface of the conference interview program, where said prompting may be facilitated by the insight agent(s) executing on the client device (operated by the organization user) and associated with the conference interview program.

In Step 1704, a user business intent is obtained. In one or many embodiment(s) disclosed herein, the user business intent may pertain to the organization user whom initiated the conference interview program (detected in Step 1700) and, therefore, may be obtained using the user ID (obtained via prompting of the organization user in Step 1702). Further, the user business intent may refer to information, respective to the organization user, which may pertain to or describe the engagement of the organization user within and/or outside their organization (e.g., a commercial business, an education institute, etc.). The user business intent, further, may be represented through a set of business intent parameters.

Examples of said business intent parameter(s) (as they pertain to any given organization user) may include, but is/are not limited to: one or more user organization roles (e.g., title(s) and/or position(s)) within an organization that may be associated with the given organization user; one or more other organization users within the organization with which the given organization user interacts and/or had interacted; one or more suppliers, distributors, customers, collaborators, and/or other actors outside the organization (also collectively referred to herein as one or more value networks) with which the given organization user interacts and/or had interacted; a search query history reflecting one or more past search queries, as well as the search topic(s) entailed, which had been previously submitted by the given organization user; one or more organization departments of the organization with which the given organization user is associated; one or more organization responsibilities (e.g., assigned project(s) or task(s)) within the organization that the given organization user is currently undertaking or had undertaken in the past; and one or more success metrics indicating a level of success that the aforementioned organization responsibility/responsibilities have brought to the organization. Said business intent parameter(s) is/are not limited to the aforementioned specific examples.

In Step 1706, a conference website, associated with the conference that had been recently attended by the organization user, is accessed. In one or many embodiment(s) disclosed herein, said conference website may be accessed through the conference link (obtained via prompting of the organization user in Step 1702). Further, tending to be the case for any website, the conference website may include a collection of webpages.

In Step 1708, the conference website (accessed in Step 1706) is subsequently ingested. In one or many embodiment(s) disclosed herein, ingestion of the conference website may, for example, entail applying the technique of data scraping to the entirety, or at least a portion, of the conference website. Further, through said ingestion, key conference information may be extracted or obtained. The key conference information, which may describe the conference, may include: a conference agenda providing an overview of what to expect throughout the conference; a list of one or more organizations sponsoring the conference; an abstract for each conference session, in a set of conference sessions, scheduled throughout the conference; and a list of conference speakers, or individuals leading discussions, centered on the conference theme(s), throughout the conference. Moreover, the key conference information is not limited to the aforementioned specific examples.

In Step 1710, a conference model is built based on the key conference information (obtained in Step 1708). In one or many embodiment(s) disclosed herein, the conference model may refer to an abstract representation (e.g., a data model) of the various information items, of the key conference information, and any relationships there-between. Further, the conference model may be constructed into a graph structure where the various information items, of the key conference information, may correspond, respectively, to a set of nodes forming the graph structure. The graph structure may further include a set of edges that interconnect the set of nodes based on identified relationships between the various items of the key conference information. Additionally, an edge weight may be assigned to one or more edges, in the set of edges, based at least on the user business intent (obtained in Step 1704).

In Step 1712, from the conference website (accessed in Step 1706), a set of session webpages is identified. In one or many embodiment(s) disclosed herein, each session webpage, in the set of session webpages, may pertain or map to a conference session (also referred to hereinafter as an attended session), specified in the attended sessions list (obtained via prompting of the organization user in Step 1702), that the organization user attended throughout the conference.

In Step 1714, each session webpage, in the set of session webpages (identified in Step 1712), is ingested. In one or many embodiment(s) disclosed herein, ingestion of any session webpage may, for example, entail applying the technique of data scraping to the entirety, or at least a portion, of the session webpage. Further, through said ingestion, session metadata may be extracted or obtained. The session metadata, which may describe any attended session, may include: a session title associated with the attended session; a session topic associated with the attended session; a list of session presenters, or individuals leading the discussion(s) centered on the session topic; and a list of session organizations each sponsoring the attended session. Moreover, the session metadata, for any given attended session, is not limited to the aforementioned specific examples.

In Step 1716, for each attended session in the attended sessions list (obtained via prompting of the organization user in Step 1702), a session model is built based on the session metadata respective thereto (obtained in Step 1714). In one or many embodiment(s) disclosed herein, any session model may refer to an abstract representation (e.g., a data model) of the various information items, of the session metadata (respective to the session model), and any relationships there-between. Further, any session model may be constructed into a graph structure where the various information items, of the session metadata (respective to the session model), may correspond, respectively, to a set of nodes forming the graph structure. The graph structure may further include a set of edges that interconnect the set of nodes based on identified relationships between the various items of the session metadata (respective to the session model). Additionally, an edge weight may be assigned to one or more edges, in the set of edges, based at least on the user business intent (obtained in Step 1704).

In Step 1718, insight state is obtained. In one or many embodiment(s) disclosed herein, the insight state may reference any information (and/or knowledge/insights derived from said information) known to (and/or inferred by) the insight service. Further, said insight state may include, but is not limited to: an overall set (or superset) of technology predictions, an organization strategy cascade, a user catalog, a conference attendance history, an organization catalog, and an asset catalog.

In one or many embodiment(s) disclosed herein, any technology prediction (in the superset of technology predictions) may represent an inference, based on any and all information known to the insight service, as to a timeline indicative of when a particular emergent technology theme (e.g., trends, innovations, etc. in a given technology space) may shift (e.g., become a publicly available product, commodity, and/or service). The superset of technology predictions, accordingly, may represent numerous inferences pertaining to various emergent technology themes.

In one or many embodiment(s) disclosed herein, an organization strategy may reference a plan (or a sum of actions), intended to be pursued by an organization (e.g., the organization with which the organization user may be affiliated), directed to leveraging organization resources towards achieving one or more long-term goals. Said long-term goal(s) may, for example, relate to identifying or predicting future or emergent trends across one or more industries. An organization strategy cascade, meanwhile, may reference a scheme outlining a division or distribution of an organization strategy, in the form of smaller goals, projects, and other responsibilities, across the various units (e.g., departments), as well as across the organizational hierarchy (e.g., a tiered arrangement of organization personnel usually based on status or authority), of an organization.

In one or many embodiment(s) disclosed herein, a user catalog may refer to a data structure that maintains user metadata describing a set of organization users working for, or otherwise affiliated with, an organization. The user catalog, further, may organize said user metadata across a set of (user) catalog entries. Each (user) catalog entry, in the set of (user) catalog entries, may pertain to an organization user in the set of organization users and, therefore, may store user metadata particular to said organization user.

Examples of user metadata, for any given organization user, may include: one or more user identifiers (e.g., a username assigned to the given organization user within an organization, the personal name with which the given organization user may be referred, etc.); one or more user domains (e.g., one or more subjects, topics, specialties, and/or interests to which the given organization user contributes and in which the given organization user may be knowledgeable; and user contact information (e.g., personal and/or organization phone number(s) through which the given organization user may be reached via existing telephonic technologies, personal and/or organization email address(es) through which the given organization user may be reached via existing electronic mail technologies, etc.). Further, user metadata is not limited to the aforementioned specific examples.

In one or many embodiment(s) disclosed herein, a conference attendance history may refer to a data structure that maintains attendance records, and conference metadata, for a set of past conferences, which organization users of an organization (e.g., the organization with which the organization user may be affiliated) may have attended. The conference attendance history, further, may organize said attendance records and conference metadata across a set of attendance history entries. Each attendance history entry, in the set of attendance history entries, may pertain to a past conference in the set of past conferences and, therefore, may store an attendance record (e.g., a verified list of organization users whom attended the past conference) and conference metadata particular to said past conference.

Examples of conference metadata, for any given past conference, may include: a conference agenda providing an overview of the given past conference; a list of one or more organizations sponsoring the given past conference; an abstract for each conference session, in a set of conference sessions, scheduled throughout the given past conference; a list of conference speakers, or individuals leading discussions, centered on any conference theme(s), throughout the given past conference; and one or more references (if any) to related other past conference(s) (e.g., other past conference(s) identified by a same or similar conference name yet transpired at a different year). Further, conference metadata is not limited to the aforementioned specific examples.

In one or many embodiment(s) disclosed herein, an organization catalog may refer to a data structure that maintains organization metadata describing a set of (other) organizations, excluding the organization with which the organization user may be affiliated. The organization catalog, further, may organize said organization metadata across a set of (organization) catalog entries. Each (organization) catalog entry, in the set of (organization) catalog entries, may pertain to an (other) organization in the set of (other) organizations and, therefore, may store organization metadata particular to said (other) organization.

Examples of organization metadata, for any given (other) organization, may include: an identifier or name associated with the given (other) organization; a list of technologies and/or industries in which the given (other) organization is involved or predicted to be involved; a relationship status (e.g., competitor, collaborator, customer, supplier, distributor, etc.) describing a relationship between the organization and the given (other) organization; a brief description of the given (other) organization; an organization website link for the given (other) organization; and a list of contacts (if any) within the given (other) organization, including contact name(s), contact role(s), and contact information (e.g., telephone number(s), email address(es), etc.) for the contact(s). Further, organization metadata is not limited to the aforementioned specific examples.

In one or many embodiment(s) disclosed herein, an asset catalog may refer to a data structure that maintains asset metadata describing a set of assets (e.g., a collection of structured information/content such as tabular data or datasets, and/or of unstructured information/content such as text, videos, images, audio, multimedia, etc.). The asset catalog, further, may organize said asset metadata across a set of (asset) catalog entries. Each (asset) catalog entry, in the set of (asset) catalog entries, may pertain to an asset in the set of assets and, therefore, may store asset metadata particular to said asset.

Examples of asset metadata, for any given asset, may include: a brief description of the given asset; stewardship (or ownership) information (e.g., individual or group name(s), contact information, etc.) pertaining to the steward(s)/owner(s) of the given asset; a version character string reflective of a version or state of the given asset at/for a given point-in-time; one or more categories, topics, and/or aspects associated with the given asset; an asset identifier uniquely identifying the given asset; one or more tags, keywords, or terms further describing the given asset; a source identifier and/or location associated with an internal or external data source (see e.g., FIG. 1A) where the given asset resides or is maintained; and compliance information specifying laws, regulations, and standards surrounding the asset, as well as policies directed to data governance (e.g., availability, usability, integrity, and security) pertinent to the given asset. Further, asset metadata is not limited to the aforementioned specific examples.

Turning to FIG. 17B, in Step 1720, a pre-work pipeline is performed. In one or many embodiment(s) disclosed herein, the pre-work pipeline may refer to a series of pre-work steps aiming to gather various information from which any interview question(s), tailored or customized for the organization user, may be derived. The pre-work pipeline, further, may be performed using the user business intent (obtained in 1704), the conference model (built in 1710), the session model(s) (built in 1716), and/or the insight state (obtained in Step 1718). Moreover, in performing the pre-work pipeline, a pre-work result may be produced. Performance of the pre-work pipeline is illustrated and described in further detail with respect to FIGS. 17C and 17D, below.

In Step 1722, a set of user-tailored interview questions is generated. In one or many embodiment(s) disclosed herein, the set of user-tailored interview questions may be directed to the conference that had been attended by the organization user. Further, the set of user-tailored interview questions may be generated based on the pre-work result (produced in Step 1720). Moreover, the set of user-tailored interview questions may be customized, for the organization user, in view of (or considering) the user business intent (obtained in Step 1704).

In one scenario, for example, an obtained user business intent may at least specify that the organization user holds a role of a salesperson in their respective organization. Based on their role as a salesperson, it may be further recognized that the organization user contributes value to their respective organization through the selling of products and/or services to customers. Subsequently, a set of user-tailored interview questions, customized based at least on said role and contribution value information associated with the organization user, may be generated.

In another scenario, by way of another example, an obtained user business intent may at least specify that the organization user holds a role of a research and development (R&D) engineer in their respective organization. Based on their role as a R&D engineer, it may be further recognized that the organization user contributes value to their respective organization through the creation and execution of ideas that lead to the building of new features and/or products for the organization. Subsequently, a set of user-tailored interview questions, customized based at least on said role and contribution value information associated with the organization user, may be generated.

In Step 1724, the set of user-tailored interview questions (generated in Step 1722) is subsequently presented or provided to the organization user. In one or many embodiment(s) disclosed herein, the set of user-tailored interview questions may be conveyed to the organization user through the user interface of the conference interview program, where said conveyance may be facilitated by the insight agent(s) executing on the client device (operated by the organization user) and associated with the conference interview program.

In Step 1726, a set of user interview responses, from/by the organization user, is obtained. In one or many embodiment(s) disclosed herein, the set of user interview responses may address the set of user-tailored interview questions (provided in Step 1724).

In Step 1728, a conference report is produced. In one or many embodiment(s) disclosed herein, the conference report (e.g., in the form of a text document) may represent a detailed account of the conference, attended by the organization user, from the experiences and noted observations thereof respective to the organization user. Further, the conference report may include the user ID (obtained via prompting of the organization user in Step 1702), the conference link (also obtained via prompting of the organization user in Step 1702), the attended sessions list (also obtained via prompting of the organization user in Step 1702), the key conference information (obtained in Step 1708), the session metadata (obtained in Step 1714) for each attended session in the attended sessions list, and at least a portion of the set of user interview responses (obtained in Step 1726). The conference report, moreover, is not limited to the aforementioned specific information.

In Step 1730, the conference report (produced in Step 1728) is stored. In one or many embodiment(s) disclosed herein, the stored conference report may, going forward, become searchable and/or discoverable in the conference interview process of one or more other organization users whom may have attended the same conference as the organization user. In one or many other embodiment(s) disclosed herein, the stored conference report may, going forward, additionally become searchable and/or discoverable in the performance of one or more other capabilities or functionalities of the insight service.

In Step 1732, one or more post-interview actions is/are performed. In one or many embodiment(s) disclosed herein, the post-interview action(s) may be centered around the conference report (stored in Step 1730). Examples of post-interview actions may include: (a) notifying relevant organization users, including the organization user, of the conference report; (b) scheduling a collaborative meeting, centered on the conference report, amongst the notified relevant organization users; and (c) adding the conference report, as input, to any insight inference algorithm(s) employed by the insight service. Further, any post-interview action is not limited to the aforementioned specific examples.

FIGS. 17C and 17D show flowcharts describing a method for performing a pre-work pipeline in accordance with one or more embodiments disclosed herein. The various steps outlined below may be performed by an insight service (see e.g., FIG. 1A). Further, while the various steps in the flowchart are presented and described sequentially, one of ordinary skill will appreciate that some or all steps may be executed in different orders, may be combined or omitted, and some or all steps may be executed in parallel.

Turning to FIG. 17C, in Step 1740, a set of conference technologies is identified. In one or many embodiment(s) disclosed herein, any conference technology, in the set of conference technologies, may refer to an emergent technology theme (e.g., trends, innovations, etc. in a given technology space) that had been introduced in a conference attended by an organization user (discussed above) (see e.g., FIGS. 17A and 17B). Further, any conference technology, in the set of conference technologies, may have been identified using a technology classifier.

In one or many embodiment(s) disclosed herein, the technology classifier may refer to a machine learning model, based on any existing machine learning algorithm, which may be configured to: ingest certain model inputs; process said certain model inputs, at least based on a set of parameters and/or hyper-parameters (optimized through training of the base machine learning algorithm to arrive at, and thus define, the machine learning model); and output the set of conference technologies based on said processing of the certain model inputs. The certain model inputs, moreover, may include, but are not limited to: a conference model for the above-mentioned conference (built in Step 1710 of FIG. 17A); and one or more session models (built in Step 1716 of FIG. 17A) for one or more attended (conference) sessions in which the organization user participated throughout the conference.

In Step 1742, one or more conference technology predictions is/are identified. In one or many embodiment(s) disclosed herein, the conference technology prediction(s) may be identified from, and thus may represent at least a subset of, an overall set (or superset) of technology predictions. Any conference technology prediction, accordingly, may reference a technology prediction relevant or related to one or more conference technologies in the set of conference technologies (identified in Step 1740). Further, any technology prediction (and thus any conference technology prediction) may represent an inference, based on any and all information known to the insight service, as to a timeline indicative of when a particular emergent technology theme may shift (e.g., become a publicly available product, commodity, and/or service). In the case of any conference technology prediction, the aforementioned particular emergent technology theme may be one of the conference technologies, if not the sole conference technology, disclosed through the conference.

In Step 1744, an organization strategy cascade is analyzed in view of (or considering) the set of conference technologies (identified in Step 1740). In one or many embodiment(s) disclosed herein, the organization strategy cascade may reference a scheme outlining a division or distribution of an organization strategy, in the form of smaller goals, projects, and other responsibilities, across the various units (e.g., departments), as well as across the organizational hierarchy (e.g., a tiered arrangement of organization personnel usually based on status or authority), of an organization (e.g., the organization with which the organization user may be affiliated). Further, analysis of the organization strategy cascade may result in the identification of one or more conference-cascade relevancies. A conference-cascade relevancy, in turn, may refer to a relation of/connecting at least one of the conference technologies, in the set of conference technologies, to at least a portion of the organization strategy cascade.

In Step 1746, a user catalog is filtered based on the set of conference technologies (identified in Step 1740). In one or many embodiment(s) disclosed herein, filtering of the user catalog may, for example, entail topic matching (e.g., case-insensitive word or phrase matching) and/or semantic similarity calculation between the set of conference technologies and the user metadata, for organization users, maintained across the (user) catalog entries of the user catalog. Further, said filtering may result in the identification of one or more (user) catalog entries, where each identified (user) catalog entry includes user metadata, which, at least in part, reflects or has relevance to at least one conference technology in the set of conference technologies. The identified one or more (user) catalog entries, in turn, map to one or more organization users (e.g., other organization user(s) that is/are not the organization user), respectively, whom may be interested, and/or whom may be considered a subject matter expert, in at least one conference technology in the set of conference technologies.

In Step 1748, a set of value networks is filtered based on the set of conference technologies (identified in Step 1742). In one or many embodiment(s) disclosed herein, the set of value networks may, foremost, be extracted from, and thus may represent at least a portion of, a user business intent (obtained in Step 1702 of FIG. 17A) for the organization user. A value network, in turn, may refer to any group of actors (e.g., suppliers, distributors, customers, collaborators, etc.) outside the organization with which the organization user may be affiliated and with which the organization user interacts and/or had interacted. Filtering of the set of value networks, subsequently, may, for example, entail topic matching (e.g., case-insensitive word or phrase matching) and/or semantic similarity calculation between the set of conference technologies and network metadata for each value network in the set of value networks. Further, said filtering may result in the identification of a value network subset including at least one value network, in the set of value networks, that has relevance to at least one conference technology in the set of conference technologies.

In Step 1750, a conference attendance history is filtered based on the conference model (built in Step 1710 of FIG. 17A). In one or many embodiment(s) disclosed herein, filtering of the conference attendance history may, for example, entail topic matching (e.g., case-insensitive word or phrase matching) and/or semantic similarity calculation between the conference model and conference metadata, for a set of past conferences (including the recent conference attended by the organization user), maintained across the attendance history entries of the conference attendance history. Further, said filtering may result in the identification of one or more attendance history entries, where each identified attendance history entry includes conference metadata, which, at least in part, reflects or has relevance to the conference of which the conference model is representative. Each identified attendance history entry, moreover, stores an attendance record that lists one or more organization users that had attended the past conference mapped to the identified attendance history entry. Accordingly, filtering of the conference attendance history may lead to the identification of other attending organization user(s) (e.g., excluding the organization user) whom had attended also attended the recent conference, attended by the organization user, and/or any other past conference(s) (e.g., transpiring in the past year(s)) that hold the same or similar conference name as the recent conference.

Turning to FIG. 17D, in Step 1752, an organization catalog is filtered based on the set of conference technologies (identified in Step 1740). In one or many embodiment(s) disclosed herein, filtering of the organization catalog may, for example, entail topic matching (e.g., case-insensitive word or phrase matching) and/or semantic similarity calculation between the set of conference technologies and the organization metadata, for other organizations (e.g., excluding the organization with which the organization user may be affiliated), maintained across the (organization) catalog entries of the organization catalog. Further, said filtering may result in the identification of one or more (organization) catalog entries, where each identified (organization) catalog entry includes organization metadata, which, at least in part, reflects or has relevance to at least one conference technology in the set of conference technologies. The identified one or more (organization) catalog entries, in turn, map to one or more other organizations, respectively, which may be involved, or is predicted to be involved, in at least one conference technology in the set of conference technologies.

In Step 1754, an asset catalog is filtered based on the set of conference technologies (identified in Step 1740). In one or many embodiment(s) disclosed herein, filtering of the asset catalog may, for example, entail topic matching (e.g., case-insensitive word or phrase matching) and/or semantic similarity calculation between each conference technology, in the set of conference technologies, and the asset metadata, for assets, maintained across the (asset) catalog entries of the asset catalog. Further, said filtering may result in the identification of one or more sets of (asset) catalog entries, where each identified set of (asset) catalog entries includes asset metadata, which, at least in part, reflects or has relevance to a given conference technology in the set of conference technologies. Each identified set of (asset) catalog entries, in turn, map to an identified set of assets (and, more specifically, asset(s) in the form of text documents such as papers, books, reports, etc.), respectively, that at least discuss or disclose a given conference technology in the set of conference technologies. Moreover, as used herein, any identified set of assets, directed to a given conference technology, may also be referred to as a technology corpus.

In Step 1756, a pre-work result is produced. In one or many embodiment(s) disclosed herein, the pre-work result may represent an outcome of, or the information gained from/by, the pre-work pipeline. The pre-work result, accordingly, may include, but is not limited to: the set of conference technologies (identified in Step 1740); the conference prediction(s) (identified in Step 1742); the at least one conference-cascade relevancy (identified in Step 1744); the (other) organization user(s) (identified in Step 1746); the at least one value network (identified in Step 1748); the (other) attending organization user(s) (identified in Step 1750); the other organization(s) (identified in Step 1752); and the at least one technology corpus (identified in Step 1754).

FIGS. 18A and 18B show flowcharts describing a method for business intent based communications enhancement in accordance with one or more embodiments disclosed herein. The various steps outlined below may be performed by an insight service (see e.g., FIG. 1A). Further, while the various steps in the flowchart are presented and described sequentially, one of ordinary skill will appreciate that some or all steps may be executed in different orders, may be combined or omitted, and some or all steps may be executed in parallel.

Turning to FIG. 18A, in Step 1800, an initiation of a communication program, by an organization user, is detected. In one or many embodiment(s) disclosed herein, the communication program may refer to any software application configured to facilitate text-based communications between parties. Examples of the communication program (or forms thereof) may include, but are not limited to, an electronic mail (or email) client, a collaboration platform client, an instant messaging (IM) client, and a short messaging service (SMS) client. Further, detection of the initiation of the communication program may, for example, involve the receiving of telemetry from one or more insight agents (see e.g., FIG. 1B) executing on a client device operated by the organization user, where the communication program also executes on the aforementioned client device. The insight agent(s), accordingly, may be embedded within, or may otherwise be associated with, the communication program.

In Step 1802, a user business intent is obtained. In one or many embodiment(s) disclosed herein, the user business intent may pertain to the organization user whom initiated the communication program (detected in Step 1800). Further, the user business intent may refer to information, respective to the organization user, which may pertain to or describe the engagement of the organization user within and/or outside their organization (e.g., a commercial business, an education institute, etc.). The user business intent, further, may be represented through a set of business intent parameters. Examples of said business intent parameter(s) (as they pertain to any given organization user) may include, but is/are not limited to: one or more user organization roles (e.g., title(s) and/or position(s)) within an organization that may be associated with the given organization user; one or more other organization users within the organization with which the given organization user interacts and/or had interacted; one or more suppliers, distributors, customers, collaborators, and/or other actors outside the organization (also collectively referred to herein as one or more value networks) with which the given organization user interacts and/or had interacted; a search query history reflecting one or more past search queries, as well as the search topic(s) entailed, which had been previously submitted by the given organization user; one or more organization departments of the organization with which the given organization user is associated; one or more organization responsibilities (e.g., assigned project(s) or task(s)) within the organization that the given organization user is currently undertaking or had undertaken in the past; and one or more success metrics indicating a level of success that the aforementioned organization responsibility/responsibilities have brought to the organization. Said business intent parameter(s) is/are not limited to the aforementioned specific examples.

In Step 1804, engagement with the communication program is monitored. In one or many embodiment(s) disclosed herein, said engagement may be performed by the organization user whom initiated the communication program (detected in Step 1800) and may refer to any number of engagement actions through which the organization user interacts with, or employs one or more features of, the communication program. Examples of said engagement actions may include, but are not limited to, terminating the communication program, specifying one or more communication targets, specifying a communication subject, and specifying a communication message. The organization user may interact with the communication program through other engagement actions not explicitly described hereinafter without departing from the scope disclosed herein.

In Step 1806, based on the communication program engagement (monitored in Step 1804), a determination is made as to whether any engagement action reflects a terminating of the communication program. The organization user may terminate the communication program by, for example, closing a user interface for, associated with, or representative of the communication program. As such, in one or many embodiment(s) disclosed herein, if it is determined that any engagement action terminates the communication program, then the method ends. On the other hand, in one or many other embodiment(s) disclosed herein, if it is alternatively determined that any engagement action does not terminate the communication program, then the method alternatively proceeds to Step 1808.

In Step 1808, following the determination (made in Step 1806) that any engagement action, based on the communication program engagement (monitored in Step 1804), does not terminate the communication program, a determination is made as to whether said any engagement action reflects a specifying of one or more communication targets (described below). As such, in one or many embodiment(s) disclosed herein, if it is determined that any engagement action specifies one or more communication targets, then the method proceeds to Step 1810. On the other hand, in one or many other embodiment(s) disclosed herein, if it is alternatively determined that any engagement action does not specify one or more communication targets, then the method alternatively proceeds to Step 1812.

In one or many embodiment(s) disclosed herein, a communication target may refer to an individual (e.g., another organization user (i.e., someone within the organization with which the organization user is affiliated) or a non-organization user (i.e., someone outside the organization with which the organization user is affiliated)) with whom the organization user may be communicating using the communication program. Further, the organization user may specify each communication target by, for example, selecting the communication target from a contact list or an address book managed by the communication program.

In Step 1810, following the determination (made in Step 1808) that any engagement action, based on the communication program engagement (monitored in Step 1804), specifies one or more communication targets, a target user business intent is obtained for each communication target of the specified communication target(s). In one or many embodiment(s) disclosed herein, the target user business intent may refer to information, respective to a communication target, which may pertain to or describe the engagement of the communication target within and/or outside their organization (e.g., a commercial business, an education institute, etc.). The target user business intent, further, may be represented through a set of target business intent parameters. Examples of said target business intent parameter(s) (as they pertain to a communication target) may include, but is/are not limited to: one or more user organization roles (e.g., title(s) and/or position(s)) within an organization that may be associated with the communication target; one or more other users/individuals within the organization with which the communication target interacts and/or had interacted; one or more suppliers, distributors, customers, collaborators, and/or other actors outside the organization (also collectively referred to herein as one or more value networks) with which the communication target interacts and/or had interacted; a search query history reflecting one or more past search queries, as well as the search topic(s) entailed, which had been previously submitted by the communication target; one or more organization departments of the organization with which the communication target is associated; one or more organization responsibilities (e.g., assigned project(s) or task(s)) within the organization that the communication target is currently undertaking or had undertaken in the past; and one or more success metrics indicating a level of success that the aforementioned organization responsibility/responsibilities have brought to the organization. Said target business intent parameter(s) is/are not limited to the aforementioned specific examples.

From Step 1810, the method proceeds to Step 1804, where further engagement, by the organization user and with the communication program, is monitored.

In Step 1812, following the alternative determination (made in Step 1808) that any engagement action, based on the communication program engagement (monitored in Step 1804), does not specify one or more communication targets, a determination is made as to whether said any engagement action reflects a specifying of a communication subject and/or a communication message (both described below). As such, in one or many embodiment(s) disclosed herein, if it is determined that any engagement action specifies the communication subject and/or the communication message, then the method proceeds to Step 1814 (see e.g., FIG. 18B). On the other hand, in one or many other embodiment(s) disclosed herein, if it is alternatively determined that any engagement action does not specify the communication subject and/or the communication message, then the method alternatively proceeds to Step 1804, where further engagement, by the organization user and with the communication program, is monitored.

In one or many embodiment(s) disclosed herein, a communication subject (if any) may refer to concise information (e.g., a single line of text) that captures a topic, or topics, concerning which the organization user wishes or intends to communicate to the communication target(s). A communication message, meanwhile, may refer to detailed information (e.g., one or more lines of text) that expands upon a topic, or topics, concerning which the organization user wishes or intends to communicate to the communication target(s). Further, though any communication program form provides the organization user with a means (e.g., a portion of a user interface) to compose and/or edit a communication message, not all communication forms provide said means to compose and/or edit a communication subject. For example, an email client may provide an email subject field and an email body field, via an email user interface, through which the organization user may enter and/or alter a communication subject and a communication message, respectively; however, an IM client may solely provide a message field, via an IM user interface, through which a communication message may be entered and/or altered by the organization user.

Turning to FIG. 18B, in Step 1814, following the determination (made in Step 1812) that any engagement action, based on the communication program engagement (monitored in Step 1804), specifies a communication subject and/or a communication message, the specified communication subject and/or communication message is/are analyzed. In one or many embodiment(s) disclosed herein, the applied analysis, or analyses, may result in the identification of one or more communication keywords. A communication keyword may refer to a term/phrase or an expression that is deemed relevant to the specified communication subject and/or communication message. Further, any communication keyword may be identified, or deemed relevant, through any existing algorithms or techniques (e.g., natural language processing (NLP) based machine learning) directed to keyword detection, extraction, and/or analysis.

In Step 1816, for each communication keyword (identified in Step 1814), an asset catalog is filtered based on the communication keyword. In one or many embodiment(s) disclosed herein, the asset catalog may reference a collection of metadata pertaining to, and thus descriptive of, any number of assets known to the insight service. The asset catalog may also, or alternatively, be viewed as a data structure including any number of asset catalog entries, where each asset catalog entry corresponds to a known given asset and includes a subset of the collection of metadata particularly relevant to the known given asset. An asset, in turn, may refer to any form or format of data—i.e., structured (e.g., tabular data) or unstructured (e.g., text, multimedia, image, video, audio, or any combination thereof)—that resides or may be maintained on one or more internal and/or external data sources (see e.g., FIG. 1A).

Examples of said asset metadata may include, but is not limited to: a brief description of the asset; stewardship (or ownership) information (e.g., individual or group name(s), contact information, etc.) pertaining to the steward(s)/owner(s) of the asset; a version character string reflective of a version or state of the asset at/for a given point-in-time; one or more categories, topics, and/or aspects associated with the asset; an asset identifier uniquely identifying the asset; one or more tags, keywords, or terms further describing the asset; a source identifier and/or location associated with an internal or external data source (see e.g., FIG. 1A) where the asset resides or is maintained; and compliance information specifying laws, regulations, and standards surrounding the asset, as well as policies directed to data governance (e.g., availability, usability, integrity, and security) pertinent to the asset. The asset metadata for any asset is not limited to the aforementioned specific examples.

Furthermore, in one or many embodiment(s) disclosed herein, filtering of the asset catalog may, for example, entail topic matching (e.g., case-insensitive word or phrase matching) and/or semantic similarity calculation between a given communication keyword and the asset metadata specified across the asset catalog entries representative of the known assets. Said filtering, moreover, may result in the identification of one or more asset catalog entries for, and thus relevant to, each communication keyword. Thereafter, the collective asset metadata across an aggregate, or superset, of all identified asset catalog entries (corresponding to the communication keyword(s)) may subsequently be examined/used to: retrieve the asset(s) (e.g. research papers, standards bodies, organization strategy cascades, conference summaries and presentations, etc.) (or at least portions thereof) respective to the aggregate, identified asset catalog entries; and additionally, or alternatively, produce/obtain one or more keyword-relevant insights (e.g., research and technology maps and/or ontologies, emerging research and technology trends or predictions, etc.).

In Step 1818, one or more editing suggestions is/are generated. In one or many embodiment(s) disclosed herein, an editing suggestion may reference a proposed addition or alteration to the specified communication subject and/or communication message, which may serve to enhance the receptive value or appeal of the concise and/or detailed information, respectively, being conveyed to the communication target(s). Further, the editing suggestion(s) may be generated using any existing machine learning based suggestion (or recommendation) algorithm, where said algorithm may be configured to consume any subset or all of. the user business intent (obtained in Step 1802), the target user business intent(s) (obtained in Step 1810), and the collective asset metadata as well as the keyword-relevant insight(s) (obtained in Step 1816), to produce the editing suggestion(s).

In Step 1820, the editing suggestion(s) (generated in Step 1818) is/are provided to the organization user. In one or many embodiment(s) disclosed herein, the editing suggestion(s) may each be conveyed to the organization user through the user interface of the communication program (and, more specifically, embedded within, proximal to, or overlapping field(s) of the user interface directed to the communication subject and/or communication message), where said conveyance may be facilitated by the insight agent(s) executing on the client device (operated by the organization user) and associated with the communication program. Further, concerning presentation, the editing suggestion(s) may each be revealed, for example, as a comment, an annotation, a placeholder text, or any other markup feature capable of providing the editing suggestion(s) to the organization user through the user interface of the communication program.

In Step 1822, an adoption or ignorance of the editing suggestion(s) (provided in Step 1820), by the organization user, is detected. In one or many embodiment(s) disclosed herein, the organization user may opt to adopt/accept any subset or all of the provided editing suggestion(s). Additionally, or alternatively, the organization user may opt to ignore/discard any subset or all of the provided editing suggestion(s). In order to adopt any given editing suggestion, the organization user may, for example, interact with the user interface of the communication program to: select the given editing suggestion, which may lead to the presentation of a dialog box prompting the organization user to opt between adopting or ignoring the given editing suggestion; and, subsequently, obtaining, and thus detecting, a selection by the organization user, and in response to the prompt via the dialog box, to adopt the given editing suggestion. Conversely, in order to ignore any given editing suggestion, the organization user may, for example, interact with the user interface of the communication program to: select the given editing selection, which may lead to the presentation of a dialog box prompting the organization user to opt between adopting or ignoring the given editing suggestion; and, subsequently, obtaining, and thus detecting, a selection by the organization user, and in response to prompt via the dialog box, to alternatively ignore the given editing suggestion.

In Step 1824, a determination is made as to whether all of the editing suggestion(s) (provided in Step 1820) had been ignored by the organization user. In one or many embodiment( ) disclosed herein, if it is determined that the editing suggestion(s) had been ignored, then the method proceeds to Step 1826. On the other hand, in one or many other embodiment(s) disclosed herein, if it is alternatively determined that at least one editing suggestion had been adopted by the organization user, then the method alternatively proceeds to Step 1828.

In Step 1826, following the determination (made in Step 1824) that all of the editing suggestion(s) (provided in Step 1820) had been ignored by the organization user, the suggestion algorithm (mentioned in Step 1818) is adjusted. In one or many embodiment(s) disclosed herein, adjustment of the algorithm may, for example, entail the tuning or refinement of any machine learning model parameters and/or hyper-parameters (e.g., configuration variables defining a structure and governing a behavior) of a machine learning model representative of the suggestion algorithm.

From Step 1826, the method proceeds to Step 1804, where further engagement, by the organization user and with the communication program, is monitored.

In Step 1828, following the alternative determination (made in Step 1824) that at least one editing suggestion (provided in Step 1820) had been adopted by the organization user, a response from each communication target, of the specified communication target(s), is tracked. In one or many embodiment(s) disclosed herein, any given response: may pertain to an enhanced communication message that may have been sent, by the organization user, to the communication target(s); and, further, may reflect either a positive reaction or negative reaction by a given communication target. The enhanced communication message may refer to a communication message that has been supplemented with at least one adopted editing suggestion. Meanwhile, a response reflective of a positive reaction may be indicated, for example, through a follow-up communication message composed by a communication target and directed back to the organization user. On the other hand, a response reflective of a negative reaction may alternatively be indicated, for example, through an ignorance or a disregard of the enhanced communication message received by a communication target.

In Step 1830, based on the respective response(s) from the communication target(s) (tracked in Step 1828), the suggestion algorithm (mentioned in Step 1818) may or may not be adjusted. That is, in one or many embodiment(s) disclosed herein, if at least one response, of the response(s) (tracked in Step 1828), is reflective of a negative reaction (described above), then the suggestion algorithm may be adjusted. Further, adjustment of the suggestion algorithm may be substantially similar to the example procedure described in Step 1826, above. On the other hand, in one or many other embodiment(s) disclosed herein, if each of the response(s) (tracked in Step 1828) is/are reflective of a positive reaction (described above), then the suggestion algorithm may not need adjustment.

From Step 1830, the method proceeds to Step 1804, where further engagement, by the organization user and with the communication program, is monitored.

FIG. 19 shows a flowchart describing a method for crowd-sourced research relevance tracking and analytics in accordance with one or more embodiments disclosed herein. The various steps outlined below may be performed by an insight service (see e.g., FIG. 1A). Further, while the various steps in the flowchart are presented and described sequentially, one of ordinary skill will appreciate that some or all steps may be executed in different orders, may be combined or omitted, and some or all steps may be executed in parallel.

Turning to FIG. 19, in Step 1900, an initiation of an online content consumption session, by an organization user, is detected. In one or many embodiment(s) disclosed herein, the online content consumption session may refer to a given time frame within which the content consumption of one or more online resources (e.g., webpage(s)), by the organization user, transpires. Content consumption, in turn, may refer to the activity of absorbing, or interacting with, any content (e.g., reading text, viewing images, watching/listening to multimedia, etc.) presented through said online resource(s). Further, detection of the initiation of the online content consumption session may, for example, involve the receiving of telemetry from one or more insight agents (see e.g., FIG. 1B) executing on a client device operated by the organization user. The insight agent(s) may be embedded within, or may otherwise be associated with, one or more software applications (e.g., web browser(s)) also executing on the client device and configured to enable the organization user to access any online resource(s) visited/viewed by the organization user during the online content consumption session.

In Step 1902, a user profile is obtained. In one or many embodiment(s) disclosed herein, the user profile may pertain to the organization user whom initiated the online content consumption session (detected in Step 1900). The user profile may refer to a collection of settings and information associated with the organization user. As such, the user profile may include, but is not limited to, a user identifier (ID) and a user business intent.

In one or many embodiment(s) disclosed herein, the user ID may reflect a character string that uniquely identifies the organization user. The character string may be of any arbitrary length and may be formed from any combination or order of characters, where each character may be represented, for example, by an alphabetic letter, a whole number, or a non-alphanumeric symbol.

In one or many embodiment(s) disclosed herein, the user business intent may refer to information, respective to the organization user, which may pertain to or describe the engagement of the organization user within and/or outside their organization (e.g., a commercial business, an education institute, etc.). The user business intent, further, may be represented through a set of business intent parameters. Examples of said business intent parameter(s) (as they pertain to any given organization user) may include, but is/are not limited to: one or more user organization roles (e.g., title(s) and/or position(s)) within an organization that may be associated with the given organization user; one or more other organization users within the organization with which the given organization user interacts and/or had interacted; one or more suppliers, distributors, customers, collaborators, and/or other actors outside the organization (also collectively referred to herein as one or more value networks) with which the given organization user interacts and/or had interacted; a search query history reflecting one or more past search queries, as well as the search topic(s) entailed, which had been previously submitted by the given organization user; one or more organization departments of the organization with which the given organization user is associated; one or more organization responsibilities (e.g., assigned project(s) or task(s)) within the organization that the given organization user is currently undertaking or had undertaken in the past; and one or more success metrics indicating a level of success that the aforementioned organization responsibility/responsibilities have brought to the organization. Said business intent parameter(s) is/are not limited to the aforementioned specific examples.

In Step 1904, the organization user, whom initiated the online content consumption session (detected in Step 1900), is prompted to perform a selection. In one or many embodiment(s) disclosed herein, said selection may pertain to a tracking mode for governing an extent to which the online activities of the organization user may be tracked throughout the online content consumption session. The selected tracking mode, accordingly, may dictate a behavior of the insight agent(s) executing on the client device operated by the organization user, as well as a quantity and/or quality of the telemetry (e.g., online consumption information (described below)) received therefrom.

By way of an example, and in one or many embodiment(s) disclosed herein, the selected tracking mode may be reflective of an open tracking mode. In such embodiment(s), the open tracking mode may permit the insight agent(s), monitoring any engagement of the organization user with any online resource(s), to collect online consumption information freely without, or with minimal, consent and/or intervention from the organization user. To that end, in operating under the open tracking mode, the insight agent(s) may include functionality to: extract any granularity of content from any online resource (e.g., webpage) visited by the organization user; generate, for any given visited online resource, a metadata file including, for example, a summary of the content presented on the given visited online resource, a universal resource locator (URL) associated with the given visited online resource, and one or more engagement metrics (e.g., time spent on the given visited online resource, etc.); transmit, for any given visited online resource, the generated metadata file to the insight service for processing and/or analysis; and extract (or copy) and forward any embedded media files or other non-webpage (e.g., non-hypertext markup language (HTML)) content to the insight service. Further, while operating in the open tracking mode, the insight agent(s) may perform other functionalities without departing from the scope disclosed herein.

By way of another example, and in one or many other embodiment(s) disclosed herein, the selected tracking mode may alternatively be reflective of a private tracking mode. In such other embodiment(s), the private tracking mode may constrain (or limit) the insight agent(s), monitoring any engagement of the organization user with any online resource(s), to freely operate. To that end, in operating under the private tracking mode, the insight agent(s) may include functionality to: remain on standby until consent by the organization user is provided by way of, for example, the manual opting (e.g., via engagement with a plug-in interface) to upload a given visited online resource (or any granularity of content thereof) to the insight service; and only upon detecting that the organization user has consented (or opted) to upload the given visited online resource (or any granularity of content thereof), then: extract any granularity of content from the given visited online resource; generate, for the given visited online resource, a metadata file including, for example, a summary of the content presented on the given visited online resource, a universal resource locator (URL) associated with the given visited online resource, and one or more engagement metrics (e.g., time spent on the given visited online resource, etc.); and transmit, for the given visited online resource, the generated metadata file to the insight service for processing and/or analysis. Should the content granularity selected for upload, by the organization user, specify any embedded media files or other non-webpage (e.g., non-hypertext markup language (HTML)) content, the insight agent(s) may also include functionality to extract (or copy) and subsequently forward said embedded media files and/or non-webpage content to the insight service. Further, while operating in the private tracking mode, the insight agent(s) may perform other functionalities without departing from the scope disclosed herein.

In one or many embodiment(s) disclosed herein, while operating in any selected tracking mode, and should a data/content scraping policy be enabled, the insight agent(s) may include further functionality to: search for, locate, and analyze any digital entitlement notification (or terms of use) indicated on any given visited online resource; based on the analysis of the digital entitlement notification (or terms of use) indicating the allowance of any data/content scraping, proceed with the scraping of any said granularity of data or content presented on the given visited online resource either automatically (while operating in the open tracking mode) or following consent by the organization user (while operating in the private tracking mode); and, alternatively, based on the analysis of the digital entitlement notification (or terms of use) indicating the denial of any data/content scraping: refrain from scraping any said granularity of data or content presented on the given visited online resource (while operating in either the open or private tracking mode); instead, prompt the organization user to activate a printing feature in any software application (e.g., web browser), employed by the organization user to access the given visited online resource, in order to obtain a digital document (in any existing exportable format—e.g., portable document format (PDF), etc.); and, subsequently, forward said obtained digital document, representative of the data/content (or at least a portion thereof) on the given visited online resource, to the insight service for storage and/or analysis. Further, while operating in any selected tracking mode, and should a data/content scraping policy be enabled, the insight agent(s) may perform other functionalities without departing from the scope disclosed herein.

In one or many embodiment(s) disclosed herein, while operating in any selected tracking mode, the insight agent(s) may include further functionality to: implement, and thus provide to the organization user, a content relevance feature whereby the organization user may flag any granularity of content on any visited online resource. In performing said flagging, the organization user may indicate a level of relevance or importance of the flagged content to them in one or more capacities (e.g., personal interest(s), professional work/project(s), subject matter expert domain(s), etc.). Further, any flagged content may be relayed, by the insight agent(s), to the insight service for trend and/or other crowdsourcing analyses.

In Step 1906, the visitation of one or more online resources (or any engagement therewith), by the organization user, is tracked based on the tracking mode (selected by the organization user in Step 1904). In one or many embodiment(s) disclosed herein, said tracking of any online resource visitation(s), based on the selected tracking mode, may transpire as described above regarding the functionalities of the insight agent(s).

Furthermore, in one or many embodiment(s) disclosed herein, online consumption information may be obtained from the result of said online resource visitation(s) tracking. Online consumption information may refer to any content and/or metadata collected, by one or more insight agents, throughout an online content consumption session; and that represents the content consumption (defined above) of the organization user during said online content consumption session. By way of examples, and as already mentioned above, online consumption information may include, but is not limited to: for any given visited online resource, a metadata file including, for example, a summary of the content presented on the given visited online resource, a universal resource locator (URL) associated with the given visited online resource, and one or more engagement metrics (e.g., time spent on the given visited online resource, etc.); for any given visited online resource, any embedded media files or other non-webpage (e.g., non-hypertext markup language (HTML)) content; and any annotations or tags (e.g., levels of content relevance or importance) associated with content flagged by the organization user. Further, online consumption information is not limited to the aforementioned specific examples.

In Step 1908, a determination is made as to whether the online content consumption session (an initiation thereof detected in Step 1900) has been terminated by the organization user. Said determination may entail detecting, via the insight agent(s) executing on the client device operated by the organization user, a closure of any software application(s) (e.g., web browser(s)) enabling the organization user to access one or more online resources. As such, in one or many embodiment(s) disclosed herein, if it is determined that the online content consumption session has indeed been terminated, then the method proceeds to Step 1910. On the other hand, in one or many other embodiment(s) disclosed herein, if it is alternatively determined that the online content consumption session has yet to be terminated, then the method alternatively proceeds to Step 1906, where additional online consumption information may be obtained through additional tracking of online resource visitation(s) by the organization user.

In Step 1910, following the determination (made in Step 1908) that the online content consumption session (an initiation thereof detected in Step 1900) has been terminated by the organization user, weighted online consumption information is produced. In one or many embodiment(s) disclosed herein, any weight, applicable to given information, may generally reference a statistical adjustment (e.g., typically expressed as a positive numerical value) reflective of an assigned level of significance that said given information holds with respect to the analysis at least thereof being performed and the other information also being considered in said analysis. Weighted online consumption information, accordingly, may refer to the online consumption information (obtained in Step 1906) to which a weight has been impressed.

Further, in one or many embodiment(s) disclosed herein, a value of said weight, and thus a level of significance applied to the online consumption information, may be determined based on at least a portion of the user business intent (obtained in Step 1902) for the organization user. More specifically, a semantic similarity calculation (e.g., a natural language processing (NLP) technique) may be performed between the online consumption information (obtained in Step 1906) and the user business intent, to obtain a semantic similarity score. The semantic similarity score, in turn, may: reflect a likeness of (or a similarity between) the meanings respective to the content in the online consumption information and the content in the user business intent; and, further, may be expressed as a positive numerical value (e.g., within a 0.0 to 1.0 range) where 0.0 may reflect that the online consumption information and the user business intent have no/zero similarities between their respective meanings, and where 1.0 may conversely reflect that the online consumption information and the user business intent match each other regarding their respective meanings. The weight, assigned to online consumption information (thereby producing the weighted online consumption information), may be a value proportional to the semantic similarity score. Thereafter, the weighted online consumption information may be stored until an analysis, or analyses, thereof may be conducted (see e.g., Step 1912).

In Step 1912, a collection of weighted online consumption information is analyzed. In one or many embodiment(s) disclosed herein, the collection of weighted online consumption information may include the weighted online consumption information (produced in Step 1910) for multiple organization users. Said multiple organization users may share one or more similar aspects of their respective user business intent (e.g., each may belong to a common professional occupation, share similar domain(s)/interest(s), interact with the same value network(s), etc.) or, alternatively, may exemplify substantially different user business intents. Further, the analysis/analyses performed may, for example, relate to existing algorithms (e.g., keyword analytics, popularity metrics, etc.) employed to predict or identify emergent trends (or topics of interests) across one or more research and/or professional domains/areas (and/or subdomains/subareas) with which the multiple organization users may be knowledgeable or of which the multiple organization users may be considered subject matter experts. Moreover, through said analysis/analyses of the collection of weighted online consumption information, crowd-sourced results may be obtained.

FIG. 20 shows an example computing system in accordance with one or more embodiments disclosed herein. The computing system (2000) may include one or more computer processors (2002), non-persistent storage (2004) (e.g., volatile memory, such as random access memory (RAM), cache memory), persistent storage (2006) (e.g., a hard disk, an optical drive such as a compact disk (CD) drive or digital versatile disk (DVD) drive, a flash memory, etc.), a communication interface (2012) (e.g., Bluetooth interface, infrared interface, network interface, optical interface, etc.), input devices (2010), output devices (2008), and numerous other elements (not shown) and functionalities. Each of these components is described below.

In one embodiment disclosed herein, the computer processor(s) (2002) may be an integrated circuit for processing instructions. For example, the computer processor(s) may be one or more cores or micro-cores of a central processing unit (CPU) and/or a graphics processing unit (GPU). The computing system (2000) may also include one or more input devices (2010), such as a touchscreen, keyboard, mouse, microphone, touchpad, electronic pen, or any other type of input device. Further, the communication interface (2012) may include an integrated circuit for connecting the computing system (2000) to a network (not shown) (e.g., a local area network (LAN), a wide area network (WAN) such as the Internet, mobile network, or any other type of network) and/or to another device, such as another computing device.

In one embodiment disclosed herein, the computing system (2000) may include one or more output devices (2008), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (2002), non-persistent storage (2004), and persistent storage (2006). Many different types of computing systems exist, and the aforementioned input and output device(s) may take other forms.

Software instructions in the form of computer readable program code to perform embodiments disclosed herein may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments disclosed herein.

FIGS. 21A-21G show an example scenario in accordance with one or more embodiments disclosed herein. The example scenario, illustrated through FIGS. 21A-21G and described below, is for explanatory purposes only and not intended to limit the scope disclosed herein.

Hereinafter, consider the following example scenario whereby an organization user, identified as Max, seeks to obtain any asset(s) (e.g., dataset(s)) respective to the artificial intelligence (AI) space for research purposes. To that end, Max relies on the disclosed capability of dynamic data product creation by the insight service to fulfill their research goals. Interactions amongst various actors—e.g., a Client Device (2100) operated by Max, the Insight Service (2102), and three separate data sources (i.e., Data Source A (2104A), Data Source B (2104B), and Data Source C (2104C))—are illustrated in conjunction with components shown across FIGS. 21A-21G and described (in an itemized manner) below. Said interactions, as well as processes performed on/by any particular actor may follow embodiments disclosed herein pertaining to dynamic data product creation as applied to the circumstances of the example scenario.

Turning to FIG. 21A:
1. User Max, operating the Client Device (2100), submits a data query to the Insight Service (2102), where the data query specifies AI as a data topic
2. The Insight Service (2102) obtains a user profile for User Max, where the user profile includes user access permissions associated with User Max
3. The Insight Service (2102) further obtains a metadata graph representative of an asset catalog
4. Based on the data topic of AI, the Insight Service (2102) filters the metadata graph to identify a node subset of a set of nodes, at least in part, forming the metadata graph, where the node subset includes one or more nodes corresponding to asset catalog entry/entries each specifying asset metadata (or at least a portion thereof) matching the data topic of AI

Turning to FIG. 21B:
5. The Insight Service (2102) generates a k-partite (i.e., uni-partite) metadata graph using the node subset
6. The Insight Service (2102) identifies a super node in/of the k-partite metadata graph

Turning to FIG. 21C:
7. In the k-partite metadata graph, the Insight Service (2102) also identifies two strong adjacent nodes (denoted as strong adjacent nodes 1 & 2) connected to the super node
8. The Insight Service (2102) extracts a portion of asset metadata from asset catalog entries corresponding to the super node and strong adjacent nodes 1 & 2, where the portion of asset metadata includes stewardship information and compliance information associated with assets (e.g., datasets) to which the extracted portion of asset metadata belongs

Turning to FIG. 21D:
9. The Insight Service (2102) assesses the user access permissions (associated with User Max) against the compliance information for the assets (e.g., datasets S, A, & B) mapped respectively to the super node, strong adjacent node 1, & strong adjacent node 2, where the assessment leads to the production of access remarks (e.g., dataset S is deemed inaccessible, whereas datasets A & B are deemed accessible, to/by User Max; further, stewardship information associated with dataset S is incorporated) concerning the assets

Turning to FIG. 21E:
A. To ascertain an asset availability for dataset S, the Insight Service (2102) submits an asset availability query to Data Source A (2104A) which is identified as the host of dataset S amongst the asset metadata thereof, where the asset availability query includes a unique asset identifier (dataset S ID) associated with dataset S
B. To ascertain an asset availability for dataset A, the Insight Service (2102) submits an asset availability query to Data Source B (2104B) which is identified as the host of dataset A amongst the asset metadata thereof, where the asset availability query includes a unique asset identifier (dataset A ID) associated with dataset A
C. To ascertain an asset availability for dataset B, the Insight Service (2102) submits an asset availability query to Data Source C (2104C) which is identified as the host of dataset B amongst the asset metadata thereof, where the asset availability query includes a unique asset identifier (dataset B ID) associated with dataset B
D. In response to the submitted asset availability query regarding dataset S, Data Source A (2104A) returns an asset availability reply to the Insight Service (2102), where the asset availability reply specifies an asset availability state indicating that dataset S is available
E. In response to the submitted asset availability query regarding dataset A, Data Source B (2104B) returns an asset availability reply to the Insight Service (2102), where the asset availability reply specifies an asset availability state indicating that dataset A is unavailable
F. In response to the submitted asset availability query regarding dataset B, Data Source C (2104C) returns an asset availability reply to the Insight Service (2102), where the asset availability reply specifies an asset availability state indicating that dataset B is available

Turning to FIG. 21F:
G. The Insight Service (2102) produces availability remarks concerning datasets S, A, & B based on the returned asset availability replies
H. The Insight Service (2102) creates a data product including a manifest listing datasets S, A, & B, as well as the produced access and availability remarks

Turning to FIG. 21G:
I. In response to the submitted data query, the Insight Service (2102) provides the created data product to the Client Device (2100) or, more specifically, to User Max
J. User Max, via the Client Device (2100), submits an instantiation request (for the provided data product) to the Insight Service (2102)
K. Based on the information presented in the data product, the Insight Service (2102) identifies dataset B as the sole asset that is both accessible to/by User Max and available, and subsequently submits a retrieval request for dataset B to the host thereof (Data Source C (2104C))
L. In response to the submitted retrieval request regarding dataset B, Data Source C (2104C) returns dataset B to the Insight Service (2102)
M. In response to the submitted instantiation request, the Insight Service (2102) provides access to dataset B via a select delivery mode (e.g., digital reference link, archive file, etc.) to the Client Device (2100) or, more specifically, to User Max

FIGS. 22A-22I show an example scenario in accordance with one or more embodiments disclosed herein. The example scenario, illustrated through FIGS. 22A-22I and described below, is explanatory purposes only and not intended to limit the scope disclosed herein.

Hereinafter, consider the following example scenario whereby an organization user, identified as Ed, seeks to gain subject matter proficiency in the artificial intelligence (AI) space in anticipation of a prospective meeting with a customer that specializes in the streamlining of widget manufacturing using AI. To that end, Ed relies on the disclosed capability of metadata-based learning curriculum generation by the insight service to fulfill their business goals. Interactions amongst various actors—e.g., a Client Device (2200) operated by Ed, the Insight Service (2202), and three separate data sources (i.e., Data Source A (2204A), Data Source B (2204B), and Data Source C (2204C))—are illustrated in conjunction with components shown across FIGS. 22A-22I and described (in an itemized manner) below. Said interactions, as well as processes performed on/by any particular actor may follow embodiments disclosed herein pertaining to metadata-based learning curriculum generation as applied to the circumstances of the example scenario.

Turning to FIG. 22A:
1. User Ed, operating the Client Device (2200), submits a learning query to the Insight Service (2202), where the learning query specifies AI as a learning topic and the customer as a learning context
2. The Insight Service (2202) obtains a user profile for User Ed, where the user profile includes user talent information, user learning preferences, and user access permissions associated with User Ed
3. The Insight Service (2202) further obtains a metadata graph representative of an asset catalog

Turning to FIG. 22B:
4. Based on the learning topic of AI, the Insight Service (2202) filters the metadata graph to identify node subset 1 of a set of nodes, at least in part, forming the metadata graph, where node subset 1 includes one or more nodes corresponding to asset catalog entry/entries each specifying asset metadata (or at least a portion thereof) matching the learning topic of AI
5. Based on the learning context of the customer, the Insight Service (2202) filters the metadata graph to identify node subset 2 of the set of nodes, at least in part, forming the metadata graph, where node subset 2 includes one or more nodes corresponding to asset catalog entry/entries each specifying asset metadata (or at least a portion thereof) matching the learning context of the customer

Turning to FIG. 22C:
6. The Insight Service (2202) generates a k-partite (i.e., bi-partite) metadata graph using node subsets 1 & 2
7. The Insight Service (2202) sets/adjusts an edge weight for an edge subset of a set of edges, at least in part, forming the k-partite metadata graph based on the user talent information and/or the user learning preferences, where the edge subset includes one or more edges each corresponding to a relationship between a pair of asset catalog entries, where a first asset catalog entry of the pair of asset catalog entries specifies asset metadata (or at least a portion thereof) matching the learning topic of AI while a second asset catalog entry of the pair of asset catalog entries specifies asset metadata (or at least a portion thereof) matching the learning context of the customer, where the edge weight for any given edge in the edge subset quantifies a relationship strength of the relationship to which the given edge corresponds

Turning to FIG. 22D:
8. The Insight Service (2202) identifies a super node, as well as other nodes 1-7 (each satisfying an identification criterion of being positioned along a longest path), in/of the k-partite metadata graph

Turning to FIG. 22E:
9. Based on the super node, other nodes 1-7, and the set/adjusted edge weight(s) for the edge subset, the Insight Service (2202) determines a learning path that traverses at least a portion of the k-partite metadata graph

Turning to FIG. 22F:
A. The Insight Service (2202) identifies a set of learning path nodes positioned along the learning path
B. The Insight Service (2202) extracts a portion of asset metadata from asset catalog entries corresponding to each learning path node in the set of learning path nodes, where the portion of asset metadata includes stewardship information and compliance information associated with assets (e.g., text document(s), multimedia, presentation deck(s), audio book(s) or podcast(s), or any other forms of digital learning materials) to which the extracted portion of asset metadata belongs

Turning to FIG. 22G:
C. The Insight Service (2202) assesses the user access permissions (associated with User Ed) against the compliance information for the assets (e.g., learning materials A-H) mapped respectively to the set of learning path nodes, where the assessment leads to the production of access remarks (e.g., learning materials A, C-F, & H are deemed accessible, whereas learning materials B & G are deemed inaccessible, to/by User Ed; further, stewardship information associated with learning materials B & G is incorporated) concerning the assets
D. To ascertain an asset availability for each of learning materials B, D, & E, the Insight Service (2202) submits an asset availability query to Data Source A (2204A) which is identified as the host of learning materials B, D, & E amongst the asset metadata thereof, where the asset availability query includes unique asset identifiers (learning materials B, D, & E IDs) associated respectively with learning materials B, D, & E
E. To ascertain an asset availability for each of learning materials C & G, the Insight Service (2202) submits an asset availability query to Data Source B (2204B) which is identified as the host of learning materials C & G amongst the asset metadata thereof, where the asset availability query includes unique asset identifiers (learning materials C & G IDs) associated respectively with learning materials C & G

Turning to FIG. 22H:
F. To ascertain an asset availability for each of learning materials A, F, & H, the Insight Service (2202) submits an asset availability query to Data Source C (2204C) which is identified as the host of learning materials A, F, & H amongst the asset metadata thereof, where the asset availability query includes unique asset identifiers (learning materials A, F, & H IDs) associated respectively with learning materials A, F, & H
G. In response to the submitted asset availability query regarding learning materials B, D, & E, Data Source A (2204A) returns an asset availability reply to the Insight Service (2202), where the asset availability reply specifies asset availability states indicating that learning materials B & D are available while learning material E is unavailable
H. In response to the submitted asset availability query regarding learning materials C & G, Data Source B (2204B) returns an asset availability reply to the Insight Service (2202), where the asset availability reply specifies asset availability states indicating that learning material C is available while learning material G is unavailable
I. In response to the submitted asset availability query regarding learning materials A, F, & H, Data Source C (2204C) returns an asset availability reply to the Insight Service (2202), where the asset availability reply specifies asset availability states indicating that learning material F is available while learning materials A & H are unavailable
J. The Insight Service (2202) produces availability remarks concerning learning materials A-H based on the returned asset availability replies

Turning to FIG. 22I:
K. The Insight Service (2202) creates a learning curriculum including a manifest listing learning materials A-H (in a progressive learning order tailored for User Ed), as well as the produced access and availability remarks
L. In response to the submitted learning query, the Insight Service (2202) provides the created learning curriculum to the Client Device (2200) or, more specifically, to User Ed

FIGS. 23A-23L show an example scenario in accordance with one or more embodiments disclosed herein. The example scenario, illustrated through FIGS. 23A-23L and described below, is explanatory purposes only and not intended to limit the scope disclosed herein.

Hereinafter, consider the following example scenario whereby an organization user, identified as Bill, seeks to obtain any asset(s) (e.g., any existing structured and/or unstructured form(s) of information) respective to the artificial intelligence (AI) space for research purposes. To that end, Bill relies on the disclosed capability of metadata-based query rewriting by the insight service to fulfill their research goals. Interactions amongst various actors—e.g., a Client Device (2300) operated by Bill, the Insight Service (2302), and two separate data sources (i.e., Data Source A (2304A) and Data Source B (2304B))—are illustrated in conjunction with components shown across FIGS. 23A-23K and described (in an itemized manner) below. Said interactions, as well as processes performed on/by any particular actor may follow embodiments disclosed herein pertaining to metadata-based query rewriting as applied to the circumstances of the example scenario.

Turning to FIG. 23A:
1. User Bill, operating the Client Device (2300), submits a search query to the Insight Service (2302), where the search query specifies AI as a search topic
2. The Insight Service (2302) obtains a user profile for User Bill, where the user profile includes user access permissions associated with User Bill
3. The Insight Service (2302) further obtains a metadata graph representative of an asset catalog

Turning to FIG. 23B:
4. Based on the search topic of AI, the Insight Service (2302) filters the metadata graph to identify a node subset of a set of nodes, at least in part, forming the metadata graph, where the node subset includes one or more nodes corresponding to asset catalog entry/entries each specifying asset metadata (or at least a portion thereof) matching the search topic of AI
5. The Insight Service (2302) generates a k-partite (i.e., uni-partite) metadata graph using the node subset

Turning to FIG. 23C:
6. The Insight Service (2302) identifies a super node and a near-super node in/of the k-partite metadata graph
7. The Insight Service (2302) extracts a portion of asset metadata from asset catalog entries corresponding to the super node and near-super node, where the portion of asset metadata includes stewardship information and compliance information associated with original assets (e.g., any existing forms of structured and/or unstructured information) to which the extracted portion of asset metadata belongs

Turning to FIG. 23D:
8. The Insight Service (2302) assesses the user access permissions (associated with User Bill) against the compliance information for the original assets (e.g., AI research articles 1 & 2) mapped respectively to the super node and the near-super node, where the assessment leads to the production of original access remarks (e.g., AI research articles 1 & 2 are both deemed accessible to/by User Bill) concerning the original assets
9. To ascertain an asset availability for AI research articles 1 & 2, the Insight Service (2302) submits an asset availability query to Data Source A (2304A) which is identified as the host of AI research articles 1 & 2 amongst the asset metadata thereof, where the asset availability query includes unique asset identifiers (AI research articles 1 & 2 IDs) associated with AI research articles 1&2

Turning to FIG. 23E:
A. In response to the submitted asset availability query regarding AI research articles 1 & 2, Data Source A (2304A) returns an asset availability reply to the Insight Service (2302), where the asset availability reply specifies asset availability states indicating that AI research article 1 is available while AI research article 2 is unavailable
B. The Insight Service (2302) produces original availability remarks concerning AI research articles 1 & 2 based on the returned asset availability reply

Turning to FIG. 23F:
C. The Insight Service (2302) creates an original search query result including a manifest listing AI research articles 1 & 2, as well as the produced original access and original availability remarks

Turning to FIG. 23G:
D. In the k-partite metadata graph, the Insight Service (2302) further identifies three strong adjacent nodes (denoted as strong adjacent nodes 1-3) connected to the super node and two other strong adjacent nodes (denoted as strong adjacent nodes 4 & 5) connected to the near-super node

Turning to FIG. 23H:
E. The Insight Service (2302) extracts a portion of asset metadata from asset catalog entries corresponding to strong adjacent nodes 1-5, where the portion of asset metadata includes stewardship information and compliance information associated with better assets (e.g., any existing forms of structured and/or unstructured information) to which the extracted portion of asset metadata belongs

Turning to FIG. 23I:
F. The Insight Service (2302) assesses the user access permissions (associated with User Bill) against the compliance information for the better assets (e.g., AI presentation decks 1-3 and AI dissertations 1 & 2) mapped respectively to strong adjacent nodes 1-5, where the assessment leads to the production of better access remarks (e.g., AI presentation deck 2 & 3 and AI dissertation 1 are deemed accessible, whereas AI presentation deck 1 and AI dissertation 2 are deemed inaccessible, to/by User Bill; further, stewardship information associated with AI presentation deck 1 and AI dissertation 2 is incorporated) concerning the better assets

Turning to FIG. 23J:
G. To ascertain an asset availability for AI presentation decks 1-3, the Insight Service (2302) submits an asset availability query to Data Source B (2304B) which is identified as the host of AI presentation decks 1-3 amongst the asset metadata thereof, where the asset availability query includes unique asset identifiers (AI presentation decks 1-3 IDs) associated with AI presentation decks 1-3
H. To ascertain an asset availability for AI dissertations 1 & 2, the Insight Service (2302) submits an asset availability query to Data Source A (2304A) which is identified as the host of AI dissertations 1 & 2 amongst the asset metadata thereof, where the asset availability query includes unique asset identifiers (AI dissertations 1 & 2 IDs) associated with AI dissertations 1 & 2
I. In response to the submitted asset availability query regarding AI presentation decks 1-3, Data Source B (2304B) returns an asset availability reply to the Insight Service (2302), where the asset availability reply specifies asset availability states indicating that AI presentation decks 1 & 2 are unavailable and AI presentation deck 3 is available
J. In response to the submitted asset availability query regarding AI dissertations 1 & 2, Data Source A (2304A) returns an asset availability reply to the Insight Service (2302), where the asset availability reply specifies asset availability states indicating that AI dissertations 1 & 2 are available
K. The Insight Service (2302) produces better availability remarks concerning AI presentation decks 1-3 and AI dissertations 1 & 2 based on the returned asset availability replies

Turning to FIG. 23K:
L. The Insight Service (2302) creates an better search query result including a manifest listing AI presentation decks 1-3 and AI dissertations 1 & 2, as well as the produced better access and better availability remarks

Turning to FIG. 23L:
M. The Insight Service (2302) produces a complete search query result including the original search query result and the better search query result
N. In response to the submitted search query, the Insight Service (2302) provides the complete search query result to the Client Device (2300) or, more specifically, to User Bill

FIGS. 24A-24C show an example scenario in accordance with one or more embodiments disclosed herein. The example scenario, illustrated through FIGS. 24A-24C and described below, is for explanatory purposes only and not intended to limit the scope disclosed herein.

Hereinafter, consider the following example scenario whereby an organization user, identified as Frank, seeks to create a new insight (e.g., in the form of a processed dataset). To that end, Frank initiates an insight editing program (e.g., an integrated development environment (IDE)) on his laptop computer (e.g., client device), where the insight editing program is configured to enable/facilitate the insight creation process of the new insight. Meanwhile, the Insight Service, in conjunction with an Insight Agent executing on the laptop computer and embedded within the insight editing program, follow embodiments disclosed herein pertaining to insight lineage tracking as applied to the circumstances of the example scenario.

Upon initiating the insight editing program, said initiation is detected by the Insight Service via the Insight Agent. Further, following said initiation, a user interface (UI) of the insight editing program (see e.g., example insight editing program UI 2400 of FIG. 24A) loads and Frank, thereafter, opts to create a new insight editing file (e.g., a new computer program code file) (see e.g., example insight editing file 2402 of FIG. 24A). The Insight Service subsequently creates a new insight record to be associated with the new insight, in an insight catalog maintained thereby, and also creates a new insight lineage graph (e.g., reflected, at least initially, as a null graph or an empty graph space) (see e.g., example insight lineage graph 2404 of FIG. 24A) to track and visually convey a creation lineage to be associated with the new insight.

From here, Frank proceeds to engage or interact with the new insight editing file in order to create the new insight. The Insight Service, via the Insight Agent, monitors the performed engagements/interactions to identify a series of insight creation actions. The identified insight creation actions, as well as any insight lineage tracking actions performed by the Insight Service in response to said insight creation actions, are illustrated in conjunction with components shown across FIGS. 24B and 24C, and also described (in an itemized manner), below.

Turning to FIG. 24B:
A. User Frank, via the insight editing program UI (2400), manually enters some historical sales data (2406) into/within the new insight editing file (2402)
B. In response to identifying a first insight creation action reflecting a manual entering of data/information, the Insight Service creates a first new insight component record (in the new insight record) (not shown) for a first insight component referencing the historical sales data (2406); further, the Insight Service creates a first new node (2408) mapping/corresponding to the first new insight component record and, then, amends/updates the insight lineage graph (2404) by inserting the first new node (2408) therein
C. User Frank, via the insight editing program UI (2400), subsequently applies, while working within the new insight editing file (2402), a data cleaning algorithm (2410) to the historical sales data (2406)
D. In response to identifying a second insight creation action reflecting an applying of an information processing algorithm, the Insight Service creates a second new insight component record (in the new insight record) (not shown) for a second insight component referencing the data cleaning algorithm (2410); moreover, the Insight Service creates a second new node (2412) mapping/corresponding to the second new insight component record, as well as a first new directed edge connecting the first new node (2408) to the second new node (2412), where the first new directed edge reflects that the data cleaning algorithm (2410) is dependent on the historical sales data (2406); next, the Insight Service amends/updates the insight lineage graph (2404) by inserting the second new node (2412) and the first new directed edge therein
E. In applying the data cleaning algorithm (2410) to the historical sales data (2406), clean historical sales data (2414) results
F. As an extension of identifying the second insight creation action, the Insight Service additionally creates a third new insight component record (in the new insight record) (not shown) for a third insight component referencing the clean historical sales data (2414); the Insight Service, subsequently, creates a third new node (2416) mapping/corresponding to the third new insight component record, as well as a second new directed edge connecting the second new node (2412) to the third new node (2416), where the second new directed edge reflects that the clean historical sales data (2414) is dependent on the data cleaning algorithm (2410); afterwards, the Insight Service amends/updates the insight lineage graph (2404) by inserting the third new node (2416) and the second new directed edge therein

Turning to FIG. 24C:
G. User Frank imports some clean historical economy data (2418) (e.g., another insight) into/within the new insight editing file (2402)
H. In response to identifying a third insight creation action reflecting an importing of an/the other insight, the Insight Service creates a set (e.g. three (3)) of fourth new insight components records (in the new insight record) (not shown) representing copies of a set of existing insight records maintained in an identified existing insight record mapping/corresponding to the clean historical economy data (2418); the Insight Service, thereafter, creates a set of fourth new nodes (2420A, 2420B, 2420C) mapping/corresponding to the set of fourth new insight component records, as well as a third new directed edge connecting a first fourth new node (2420A) to a second fourth new node (2420B) and a fourth new directed edge connecting the second fourth new node (2420B) to a third fourth new node (2420C), where the third new directed edge reflects that a second object that contributed to the creation of the clean historical economy data (2418) and mapped to the second fourth new node (2420B) is dependent on a first object that contributed to the creation of the clean historical economy data (2418) and mapped to the first fourth new node (2420A), whereas the fourth new directed edge reflects that the clean historical economy data (2418) mapped to the third fourth new node (2420C) is dependent on the second object that contributed to the creation of the clean historical economy data (2418) and mapped to the second fourth new node (2420B); next, the Insight Service amends/updates the insight lineage graph (2404) by inserting the set of fourth new nodes (2420A, 2420B, 2420C), as well as the third and fourth new directed edges, therein
I. User Frank, via the insight editing program UI (2400), subsequently applies, while working within the new insight editing file (2402), a demand forecast model (2422) to the clean historical sales data (2414) and the clean historical economy data (2418)
J. In response to identifying a fourth insight creation action reflecting an applying of an information processing algorithm, the Insight Service creates a fifth new insight component record (in the new insight record) (not shown) for a fifth insight component referencing the demand forecast model (2422); moreover, the Insight Service creates a fifth new node (2424) mapping/corresponding to the fifth new insight component record, as well as a fifth new directed edge connecting the third new node (2416) to the fifth new node (2424) and a sixth new directed edge connecting the third fourth new node (2420C) to the fifth new node (2424), where the fifth new directed edge reflects that the demand forecast model (2422) is dependent on the clean historical sales data (2414), whereas the sixth new directed edge reflects that the demand forecast model (2422) is further dependent on the clean historical economy data (2418); afterwards, the Insight Service amends/updates the insight lineage graph (2404) by inserting the fifth new node (2424), as well as the fifth and sixth new directed edges, therein
K. In applying the demand forecast model (2422) to the clean historical sales data (2414) and the clean historical economy data (2418), demand prediction data (2426) (e.g., representing the new insight sought to be created by User Frank) results
L. As an extension of identifying the fourth insight creation action, the Insight Service additionally creates a sixth new insight component record (in the new insight record) (not shown) for a sixth insight component referencing the demand prediction data (2426); the Insight Service, subsequently, creates a sixth new node (2428) mapping/corresponding to the sixth new insight component record, as well as a seventh new directed edge connecting the fifth new node (2424) to the sixth new node (2428), where the seventh new directed edge reflects that the demand prediction data (2426) is dependent on the demand forecast model (2422); afterwards, the Insight Service amends/updates the insight lineage graph (2404) by inserting the sixth new node (2428) and the seventh new directed edge therein

FIGS. 25A-250 show an example scenario in accordance with one or more embodiments disclosed herein. The example scenario, illustrated through FIGS. 25A-250 and described below, is explanatory purposes only and not intended to limit the scope disclosed herein.

Hereinafter, consider the following example scenario whereby an organization user, identified as Kate, seeks to apply machine learning (ML) to resolve a real-world problem (e.g., breast cancer detection via tumor analysis). To that end, Kate has collected a small dataset reflective of various tumor samples, where each tumor sample is representative of either a benign (i.e., non-cancerous), or a malignant (i.e., cancerous), tumor instance. The small dataset, further, specifies three (3) features (e.g., clump thickness, uniform cell size, and uniform cell shape) that Kate has selected as initial properties/factors/variables pertinent to discerning whether any given tumor is cancerous or non-cancerous (i.e., tied to one of two (2) available labels).

Further, though Kate has an initial input matrix (i.e., the small training/testing dataset) and an initial label vector (i.e., derived by manually associating an appropriate label to each of the tumor samples reflected in the small training/testing dataset), Kate is uncertain as to which ML algorithm(s) to employ in order to address her real-world problem. As such, Kate turns to an automated ML service, which proposes to not only automate the selection of the appropriate ML algorithm(s), but also automatically build one or more ML models from any selected ML algorithm(s), for her given whichever argument(s) (e.g., the initial input matrix and the initial label vector) Kate chooses to provide.

Moreover, following the submission and completion of a ML job to and by the automated ML service, Kate relies on the disclosed capability of metadata-based feature expansion for automated machine learning processes, by the insight service, to improve any performance shortcomings exhibited in the ML model(s) built by the automated ML service. Improvements in ML model performance, at least via embodiments disclosed herein, may be targeted through the selection or suggestion of additional feature(s) significant to the tackled real-world problem (e.g., breast cancer detection via tumor analysis).

Interactions amongst various actors—e.g., the Automated ML Service (2500), a Client Device (2502) operated by Kate, the Insight Service (2504), and two separate data sources (i.e., Data Source A (2506A) and Data Source B (2506B))—are illustrated in conjunction with components shown across FIGS. 25A-250 and described (in an itemized manner) below. Said interactions, as well as processes performed on/by any particular actor may follow embodiments disclosed herein pertaining to metadata-based feature expansion for automated machine learning processes as applied to the circumstances of the example scenario.

Turning to FIG. 25A:
1. User Kate, operating the Client Device (2502), submits an initial ML job to the Automated ML Service (2500), where the initial ML job specifies the initial input matrix and the initial label vector (both described above)
2. The Automated ML Service (2500) produces an initial ML job result based on the initial input matrix and the initial label vector, where the initial ML job result includes a list of four (4) ML algorithms (i.e., ML algorithms 1-4)—2 of which is designated as considered and 2 of which is designated as discarded—and a set of performance scores quantifying an evaluated performance of each considered ML algorithm in the list of ML algorithms
3. In response to the submitted initial ML job, the Automated ML Service (2500) provides the initial ML job result to the Client Device (2502) or, more specifically, to User Kate

Turning to FIG. 25B:
4. User Kate, operating the Client Device (2502), creates a feature query including the three (3) features (i.e., features 1-3) (e.g., clump thickness, uniform cell size, and uniform cell shape) reflected in the initial input matrix, the initial ML job result provided by the Automated ML Service (2500), and the two (2) (unique) labels (i.e., labels 1 & 2) (e.g., cancerous and non-cancerous) reflected in the initial label vector
5. User Kate, operating the Client Device (2502), submits the feature query to the Insight Service (2504)

Turning to FIG. 25C:
6. The Insight Service (2504) obtains a user profile for User Kate, where the user profile includes user access permissions associated with User Kate
7. The Insight Service (2504) further obtains a metadata graph representative of an asset catalog
8. Based on each of features 1-3, the Insight Service (2504) filters the metadata graph to identify node subsets 1-3 (e.g., feature 1→node subset 1; feature 2→node subset 2; feature 3→node subset 3) of a set of nodes, at least in part, forming the metadata graph, where each of node subsets 1-3 includes one or more nodes corresponding to asset catalog entry/entries each specifying asset metadata (or at least a portion thereof) matching, or semantically similar to, a respective feature

Turning to FIG. 25D:
9. Based on each of labels 1 & 2, the Insight Service (2504) filters the metadata graph to identify node subsets 4 & 5 (e.g., label 1→node subset 4; label 2→node subset 5) of a set of nodes, at least in part, forming the metadata graph, where each of node subsets 4 & 5 includes one or more nodes corresponding to asset catalog entry/entries each specifying asset metadata (or at least a portion thereof) matching, or semantically similar to, a respective label
A. Based on each of ML algorithms 1-4, the Insight Service (2504) filters the metadata graph to identify node subsets 6-9 (e.g., ML algorithm 1→node subset 6; ML algorithm 2→node subset 7; ML algorithm 3→node subset 8; ML algorithm 4→node subset 9) of a set of nodes, at least in part, forming the metadata graph, where each of node subsets 6-9 includes one or more nodes corresponding to asset catalog entry/entries each specifying asset metadata (or at least a portion thereof) matching, or semantically similar to, a respective ML algorithm

Turning to FIG. 25E:
B. The Insight Service (2504) generates a k-partite (i.e., multi-partite) metadata graph using node subsets 1-9
C. The Insight Service (2504) identifies key nodes 1 & 2 in/of the k-partite metadata graph

Turning to FIG. 25F:
D. The Insight Service (2504) extracts a portion of asset metadata from an asset catalog entry corresponding to key node 1, where the portion of asset metadata includes dataset features 1-5 (reflected in a dataset 1), as well as stewardship information and compliance information also associated with dataset 1 (i.e., key asset 1)
E. The Insight Service (2504) further extracts a portion of asset metadata from an asset catalog entry corresponding to key node 2, where the portion of asset metadata includes dataset features 1-7 (reflected in a dataset 2), as well as stewardship information and compliance information also associated with dataset 2 (i.e., key asset 2)

Turning to FIG. 25G:
F. The Insight Service (2504) assesses each of features 1-3 against each of dataset features 1-5 (of dataset 1) and against each of dataset features 1-7 (of dataset 2), where the assessment results in the identification of a non-empty set specifying delta features 1-5, where delta features 1 & 2 (e.g., marginal adhesion and bare nuclei) are distinct features in dataset 1 that do not match or are not semantically similar to any of features 1-3 and dataset features 1-7 (of dataset 2), and where delta features 3-5 (e.g., bland chromatin, mitoses, and normal nucleoli) are distinct features in dataset 2 that do not match or are not semantically similar to any of features 1-3 and dataset features 1-5 (of dataset 1)

Turning to FIG. 25H:
G. The Insight Service (2504) assesses the user access permissions (associated with User Kate) against the compliance information for key assets 1 & 2 (i.e., datasets 1 & 2) mapped respectively to key nodes 1 & 2, where the assessment results in the production of access remarks (e.g., datasets 1 & 2 are both deemed accessible to/by User Kate) concerning key assets 1 & 2
H. To ascertain an asset availability for dataset 1, the Insight Service (2504) submits an asset availability query to Data Source A (2506A) which is identified as the host of dataset 1 amongst the asset metadata thereof, where the asset availability query includes a unique asset identifier (dataset 1 ID) associated with dataset 1
I. To ascertain an asset availability for dataset 2, the Insight Service (2504) submits an asset availability query to Data Source B (2506B) which is identified as the host of dataset 2 amongst the asset metadata thereof, where the asset availability query includes a unique asset identifier (dataset 2 ID) associated with dataset 2

Turning to FIG. 25I:
J. In response to the submitted asset availability query regarding dataset 1, Data Source A (2506A) returns an asset availability reply to the Insight Service (2504), where the asset availability reply specifies an asset availability state indicating that dataset 1 is available
K. In response to the submitted asset availability query regarding dataset 2, Data Source B (2506B) returns an asset availability reply to the Insight Service (2504), where the asset availability reply specifies an asset availability state indicating that dataset 2 is available
L. The Insight Service (2504) produces availability remarks concerning datasets 1 & 2 based on the returned asset availability replies

Turning to FIG. 25J:
M. The Insight Service (2504) subsequently creates a feature query result including a manifest listing datasets 1 & 2, the produced access remarks, the produced availability remarks, identified delta features 1-5, and a new record ID (to be associated with a new query record intended to track various query state related to the submitted feature query)
N. In response to the submitted feature query, the Insight Service (2504) provides the feature query result to the Client Device (2502) or, more specifically, to User Kate

Turning to FIG. 25K:
O. The Insight Service (2504) creates the new query record to maintain the various tracked query state related to the submitted feature query, where the various tracked query state includes features 1-3, labels 1 & 2, the initial MVL job result, the generated k-partite metadata graph, identified key nodes 1 & 2, identified delta features 1-5, and the new record ID

Turning to FIG. 25L:
P. User Kate, operating the Client Device (2502), submits an instantiation request (for datasets 1 & 2) to the Insight Service (2504)
Q. Based on the information presented in the produced access remarks (indicating that dataset 1 is accessible to/by User Kate) and the produced availability remarks (indicating that dataset 1 is available), the Insight Service (2504) submits a retrieval request for dataset 1 to the host thereof (Data Source A (2506A))
R. In response to the submitted retrieval request regarding dataset 1, Data Source A (2506A) returns dataset 1 to the Insight Service (2504)
S. Based on the information presented in the produced access remarks (indicating that dataset 2 is accessible to/by User Kate) and the produced availability remarks (indicating that dataset 2 is available), the Insight Service (2504) submits a retrieval request for dataset 2 to the host thereof (Data Source B (2506B))
T. In response to the submitted retrieval request regarding dataset 2, Data Source B (2506B) returns dataset 2 to the Insight Service (2504)

Turning to FIG. 25M:
U. In response to the submitted instantiation request, the Insight Service (2504) provides access to datasets 1 & 2 via a select delivery mode (e.g., digital reference link, archive file, etc.) to the Client Device (2502) or, more specifically, to User Kate
V. User Kate, operating the Client Device (2502), identifies the portion (e.g., two columns) of dataset 1 reflecting delta features 1 & 2
W. User Kate, operating the Client Device (2502), further identifies the portion (e.g., three columns) of dataset 2 reflecting delta features 3-5

Turning to FIG. 25N:
X. User Kate, operating the Client Device (2502), creates a new input matrix from the initial input matrix and based on the identified portions of datasets 1 & 2, where the new input matrix reflects features 1-3 originally selected by User Kate and delta (e.g., supplemental) features 1-5 selected/suggested by the Insight Service (2504)

Turning to FIG. 25O:
Y. User Kate, operating the Client Device (2502), submits a new ML job to the Automated ML Service (2500), where the new ML job specifies the new input matrix and the initial label vector
Z. The Automated ML Service (2500) produces a new ML job result based on the new input matrix and the initial label vector, where the new ML job result includes a new list of four (4) ML algorithms (i.e., ML algorithms 1-4)—3 of which is designated as considered and 1 of which is designated as discarded
and a set of performance scores quantifying an evaluated performance of each considered ML algorithm in the list of ML algorithms a. In response to the submitted new ML job, the Automated ML Service (2500) provides the new ML job result to the Client Device (2502) or, more specifically, to User Kate

FIGS. 26A-26J show an example scenario in accordance with one or more embodiments disclosed herein. The example scenario, illustrated through FIGS. 26A-26J and described below, is explanatory purposes only and not intended to limit the scope disclosed herein.

Hereinafter, consider the following example scenario whereby an organization user, identified as Mia, seeks to gain subject matter proficiency in the artificial intelligence (AI) space in order to support/reach a project goal (e.g., a learning intent) of developing an AI-driven computer game. To that end, Mia relies on the disclosed capability of intent-driven adaptive learning delivery by the insight service to satisfy their learning intent. Interactions amongst various actors—e.g., a Client Device (2600) operated by Mia, the Insight Service (2602), and three separate data sources (i.e., Data Source A (2604A), Data Source B (2604B), and Data Source C (2604C))—are illustrated in conjunction with components shown across FIGS. 26A-26J and described (in an itemized manner) below. Said interactions, as well as processes performed on/by any particular actor may follow embodiments disclosed herein pertaining to intent-driven adaptive learning delivery as applied to the circumstances of the example scenario.

Turning to FIG. 26A:
1. User Mia, operating the Client Device (2600), submits a learning query to the Insight Service (2602), where the learning query specifies AI as a learning topic and a project goal (mentioned above) as a learning intent
2. The Insight Service (2602) obtains a user profile for User Mia, where the user profile includes user talent information, user learning preferences, and user access permissions associated with User Mia

Turning to FIG. 26B:
3. The Insight Service (2602) reduces the user talent information based on the learning intent in order to obtain impactful user talent information, where the impactful user talent information includes at least a portion of the user talent information determined to be most impactful to or effective in supporting/reaching the project goal
4. The Insight Service (2602) further obtains a metadata graph representative of an asset catalog

Turning to FIG. 26C:
5. Based on the learning topic of AI, the Insight Service (2602) filters the metadata graph to identify a node subset, at least in part, forming the metadata graph, where the node subset includes one or more nodes corresponding to asset catalog entry/entries each specifying asset metadata (or at least a portion thereof) matching the learning topic of AI
6. From the node subset, the Insight Service (2602) selects a reduced node subset, where the reduced node subset includes at least a subset of the node subset that corresponds to asset(s) determined to be most impactful to or effective in supporting/reaching the project goal

Turning to FIG. 26D:
7. The Insight Service (2602) generates a k-partite (i.e., uni-partite) metadata graph using the reduced node subset
8. The Insight Service (2602) sets/adjusts an edge weight for an edge subset of a set of edges, at least in part, forming the k-partite metadata graph based on the impactful user talent information and/or the user learning preferences, where the edge subset includes one or more edges each corresponding to a relationship between a pair of asset catalog entries relevant or related to the learning topic of AI as well as impactful in or effective in supporting/reaching the project goal, where the edge weight for any given edge in the edge subset quantifies a relationship strength of the relationship to which the given edge corresponds

Turning to FIG. 26E:
9. The Insight Service (2602) identifies three key nodes—i.e., key node 1 (e.g., a super node), key node 2 (e.g., a most connected node in a subgraph), and key node 3 (e.g., a node positioned along a longest path)—in/of the k-partite metadata graph
A. Based on key nodes 1-3, and the set/adjusted weight(s) for the edge subset, the Insight Service (2602) determines a learning path that traverses at least a portion of the k-partite metadata graph

Turning to FIG. 26F:
B. The Insight Service (2602) identifies a set of learning path nodes (e.g., learning path nodes A-F) positioned along the learning path
C. The Insight Service (2602) extracts a portion of asset metadata from asset catalog entries corresponding to each learning path node in the set of learning path nodes, where the portion of asset metadata includes stewardship information and compliance information associated with assets (e.g., text document(s), multimedia, presentation deck(s), audio book(s) or podcast(s), or any other forms of digital learning materials) to which the extracted portion of asset metadata belongs

Turning to FIG. 26G:
D. The Insight Service (2602) assesses the user access permissions (associated with User Mia) against the compliance information for the assets (e.g., learning materials A-F) mapped respectively to the set of learning path nodes, where the assessment leads to the production of access remarks (e.g., learning materials A, B, D, & F are deemed accessible, whereas learning materials C & E are deemed inaccessible, to/by User Mia; further, stewardship information associated with learning materials C & E is incorporated) concerning the assets
E. To ascertain an asset availability for each of learning materials A & F, the Insight Service (2602) submits an asset availability query to Data Source A (2604A) which is identified as the host of learning materials A & F amongst the asset metadata thereof, where the asset availability query includes unique asset identifiers (learning materials A & F IDs) associated respectively with learning materials A & F

Turning to FIG. 26H:
F. To ascertain an asset availability for each of learning materials B & D, the Insight Service (2602) submits an asset availability query to Data Source B (2604B) which is identified as the host of learning materials B & D amongst the asset metadata thereof, where the asset availability query includes unique asset identifiers (learning materials B & D IDs) associated respectively with learning materials B & D
G. To ascertain an asset availability for each of learning materials C & E, the Insight Service (2602) submits an asset availability query to Data Source C (2604C) which is identified as the host of learning materials C & E amongst the asset metadata thereof, where the asset availability query includes unique asset identifiers (learning materials C & E IDs) associated respectively with learning materials C & E
H. In response to the submitted asset availability query regarding learning materials A & F, Data Source A (2604A) returns an asset availability reply to the Insight Service (2602), where the asset availability reply specifies asset availability states indicating that learning material A is available while learning material F is unavailable
I. In response to the submitted asset availability query regarding learning materials B & D, Data Source B (2604B) returns an asset availability reply to the Insight Service (2602), where the asset availability reply specifies asset availability states indicating that learning materials B & D are available
J. In response to the submitted asset availability query regarding learning materials C & E, Data Source C (2604C) returns an asset availability reply to the Insight Service (2602), where the asset availability reply specifies asset availability states indicating that learning material E is available while learning material C is unavailable

Turning to FIG. 26I:
K. The Insight Service (2602) produces availability remarks concerning learning materials A-F based on the returned asset availability replies

Turning to FIG. 26J:
L. The Insight Service (2602) creates a learning curriculum including a manifest listing learning materials A-F (in a progressive learning order tailored for User Mia), as well as the produced access and availability remarks
M. In response to the submitted learning query, the Insight Service (2602) provides the created learning curriculum to the Client Device (2600) or, more specifically, to User Mia

FIGS. 27A-27C show an example scenario in accordance with one or more embodiments disclosed herein. The example scenario, illustrated through FIGS. 27A-27C and described below, is explanatory purposes only and not intended to limit the scope disclosed herein.

Hereinafter, consider the following example scenario whereby an organization user, identified as Fred, seeks other organization user(s) (e.g., one or more collaborators) for co-authoring a journal article, respective to the Internet of Things (IoT) and artificial intelligence (AI) spaces, in a technical/scientific journal. To that end, Fred relies on the disclosed capability of learning acceleration using insight-assisted introductions by the insight service to identify said collaborator(s). Interactions amongst various actors—e.g., a Client Device (2700) operated by Fred, and the Insight Service (2702)—are illustrated in conjunction with components shown across FIGS. 27A-27C and described (in an itemized manner) below. Said interactions, as well as processes performed on/by any particular actor may follow embodiments disclosed herein pertaining to learning acceleration using insight-assisted introductions as applied to the circumstances of the example scenario.

Turning to FIG. 27A:
1. User Fred, operating the Client Device (2700), submits an introduction query to the Insight Service (2702), where the introduction query specifies IoT and AI as interests
2. The Insight Service (2702) obtains a metadata graph representative of a user catalog
3. Based on the first interest of IoT, the Insight Service (2702) filters the metadata graph to identify node subset 1 of a set of nodes, at least in part, forming the metadata graph, where node subset 1 includes one or more nodes corresponding to user catalog entry/entries (i.e., user profile(s)) each specifying user metadata (or at least a portion thereof) matching the first interest of IoT

Turning to FIG. 27B:
4. Based on the second interest of AI, the Insight Service (2702) filters the metadata graph to identify node subset 2 of a set of nodes, at least in part, forming the metadata graph, where node subset 2 includes one or more nodes corresponding to user catalog entry/entries (i.e., user profile(s)) each specifying user metadata (or at least a portion thereof) matching the second interest of AI
5. The Insight Service (2702) generates a k-partite (i.e., bi-partite) metadata graph using node subsets 1 & 2

Turning to FIG. 27C:
6. The Insight Service (2702) identifies a super node and a near-super node in/of the k-partite metadata graph
7. The Insight Service (2702) extracts a portion of user metadata from user catalog entries corresponding to the super node and near-super node, where the portion of user metadata includes user identifiers (e.g., Brad and Jill), user domain(s) (e.g., IoT, AI, and quantum computing for User Brad; IoT, AI, and graph theory for User Jill), and contact information (e.g., brad@organization.com for User Brad; jill@organization.com for User Jill) associated with other organization users (e.g., User Brad and User Jill) to which the extracted portion of user metadata belongs
8. In response to the submitted introduction query, the Insight Service provides the user identifiers, user domain(s), and contact information for Users Brad and Jill to the Client Device (2700) or, more specifically, to User Fred

FIGS. 28A-28Q show example scenarios in accordance with one or more embodiments disclosed herein. The example scenarios, illustrated through FIGS. 28A-28Q and described below, are for explanatory purposes only and not intended to limit the scope disclosed herein.

A first example scenario (illustrated and described with respect to FIGS. 28A-28H, below) considers an organization user, identified as Betty, whom seeks to obtain any asset(s) (e.g., any existing structured and/or unstructured form(s) of information) respective to the quantum computing (QC) space in order to address certain business goals. A completeness of a user business intent model for Betty, however, is limited and, as such, so is the search results to her search query. A second example scenario (illustrated and described with respect to FIGS. 28I-28Q, below) considers another organization user, identified as Sam, whom also seeks to obtain any asset(s) respective to the QC space also in order to address certain business goals. A user business intent model for Sam is more complete (than the model for Betty) and, accordingly, the search results Sam receives in response to his search query also cites more assets.

To their respective ends, Betty and Sam both rely on the disclosed capability of business intent-assisted search by the insight service to achieve their respective business goals. Interactions amongst various actors—e.g., a Client Device A (2800A) operated by Betty, a Client Device B (2800B) operated by Sam, the Insight Service (2802), and two separate data sources (i.e., Data Source A (2804A) and Data Source B (2804B))—are illustrated in conjunction with components shown across FIGS. 28A-28Q and described (in an itemized manner) below. Said interactions, as well as processes performed on/by any particular actor may follow embodiments disclosed herein pertaining to business intent-assisted search as applied to the circumstances of the example scenarios.

Turning to FIG. 28A:
1. User Betty, operating Client Device A (2800A), submits a search query to the Insight Service (2802), where the search query specifies QC as the search topic
2. The Insight Service (2802) obtains a user profile for User Betty, where the user profile includes user access permissions associated with User Betty
3. The Insight Service (2802) further obtains a user business intent model for User Betty, where the user business intent model is represented via a superset of business intent parameters

Turning to FIG. 28B:
4. The Insight Service (2802) extracts known business intent parameters 1-3 from the superset of business intent parameters representative of the obtained user business intent model for User Betty
5. The Insight Service (2802) obtains a metadata graph representative of an asset catalog

Turning to FIG. 28C:
6. Based on the search topic of QC, the Insight Service (2802) filters the metadata graph to identify node subset 1 of a set of nodes, at least in part, forming the metadata graph, where node subset 1 includes one or more nodes corresponding to asset catalog entry/entries each specifying asset metadata (or at least a portion thereof) matching the search topic of QC
7. Based on each of the known business intent parameters 1-3, the Insight Service (2802) filters the metadata graph to identify node subsets 2-4 (e.g., known business intent parameter 1→node subset 2; known business intent parameter 2→node subset 3; known business intent parameter 3→node subset 4) of a set of nodes, at least in part, forming the metadata graph, where each of node subsets 2-4 includes one or more nodes corresponding to asset catalog entry/entries each specifying asset metadata (or at least a portion thereof) matching a respective known business intent parameter

Turning to FIG. 28D:
8. The Insight Service (2802) generates k-partite (i.e., multi-partite) metadata graph 1 using node subsets 1-4
9. The Insight Service (2802) identifies super node 1 and other node 1 in/of k-partite metadata graph 1

Turning to FIG. 28E:
A. The Insight Service (2802) extracts a portion of asset metadata from asset catalog entries corresponding to super node 1 and other node 1, where the portion of asset metadata includes stewardship information and compliance information associated with assets (e.g., QC articles 1 & 2) to which the extracted portion of asset metadata belongs

Turning to FIG. 28F:
B. The Insight Service (2802) assesses the user access permissions (associated with User Betty) against the compliance information for the assets (e.g., QC articles 1 & 2) mapped respectively to super node 1 and other node 1, where the assessment leads to the production of User Betty access remarks (e.g., QC article 1 is deemed accessible, whereas QC article 2 is deemed inaccessible, to/by User Betty) concerning the assets
C. To ascertain an asset availability for the assets (e.g., QC articles 1 & 2), the Insight Service (2802) submits an asset availability query to Data Source B (2804B) which is identified as the host of the assets amongst the asset metadata thereof, where the asset availability query includes unique asset identifiers (QC articles 1 & 2 IDs) associated with the assets

Turning to FIG. 28G:
D. In response to the submitted asset availability query regarding QC articles 1 & 2, Data Source B (2804B) returns an asset availability reply to the Insight Service (2802), where the asset availability reply specifies asset availability states indicating that QC article 1 is available while QC article 2 is unavailable
E. The Insight Service (2802) subsequently produces User Betty availability remarks concerning QC articles 1 & 2 based on the returned asset availability reply
F. The Insight Service (2802) computes a business intent score for User Betty, where the business intent score reflects a low value (e.g., 5%) based on what little information (i.e., known business intent parameters 1-3) is captured in the user business intent model for User Betty

Turning to FIG. 28H:
G. The Insight Service (2802) creates search results 1 including a manifest listing QC articles 1 & 2, as well as the produced User Betty access remarks, the produced User Betty availability remarks, and the computed business intent score for User Betty
H. In response to the submitted search query, the Insight Service (2802) provides search results 1 to Client Device A (2800A) or, more specifically, to User Betty

Turning to FIG. 28I:
I. User Sam, operating Client Device B (2800B), submits a search query to the Insight Service (2802), where the search query specifies QC as the search topic
J. The Insight Service (2802) obtains a user profile for User Sam, where the user profile includes user access permissions associated with User Sam
K. The Insight Service (2802) further obtains a user business intent model for User Sam, where the user business intent model is represented via a superset of business intent parameters

Turning to FIG. 28J:
L. The Insight Service (2802) extracts known business intent parameters 1-9 from the superset of business intent parameters representative of the obtained user business intent model for User Sam
M. The Insight Service (2802) re-obtains the metadata graph representative of an asset catalog

Turning to FIG. 28K:
N. Based on the search topic of QC, the Insight Service (2802) filters the metadata graph to identify node subset 5 of a set of nodes, at least in part, forming the metadata graph, where node subset 5 includes one or more nodes corresponding to asset catalog entry/entries each specifying asset metadata (or at least a portion thereof) matching the search topic of QC
O. Based on each of the known business intent parameters 1-9, the Insight Service (2802) filters the metadata graph to identify node subsets 6-14 (e.g., known business intent parameter 1→node subset 6; known business intent parameter 2→node subset 7; known business intent parameter 3→node subset 8; known business intent parameter 4→node subset 9; known business intent parameter 5→node subset 10; known business intent parameter 6→node subset 11; known business intent parameter 7→node subset 12; known business intent parameter 8→node subset 13; known business intent parameter 9→node subset 14) of a set of nodes, at least in part, forming the metadata graph, where each of node subsets 6-14 includes one or more nodes corresponding to asset catalog entry/entries each specifying asset metadata (or at least a portion thereof) matching a respective known business intent parameter

Turning to FIG. 28L:
P. The Insight Service (2802) generates k-partite (i.e., multi-partite) metadata graph 2 using node subsets 6-14
Q. The Insight Service (2802) identifies super nodes 2 & 3 and other nodes 2-5 in/of k-partite metadata graph 2

Turning to FIG. 28M:
R. The Insight Service (2802) extracts a portion of asset metadata from asset catalog entries corresponding to super nodes 2 & 3 and other nodes 2-5, where the portion of asset metadata includes stewardship information and compliance information associated with assets (e.g., QC presentation deck, QC customer pitch reports 1-3, and QC learning videos 1 & 2) to which the extracted portion of asset metadata belongs

Turning to FIG. 28N:
S. The Insight Service (2802) assesses the user access permissions (associated with User Sam) against the compliance information for the assets (e.g., QC presentation deck, QC customer pitch reports 1-3, and QC learning videos 1 & 2) mapped respectively to super nodes 2 & 3 and other nodes 2-5, where the assessment leads to the production of User Sam access remarks (e.g., QC presentation deck, QC customer pitch report 3, and QC learning video 1 are deemed accessible, whereas QC customer reports 1 & 2 and QC learning video 2 are deemed inaccessible, to/by User Sam) concerning the assets

Turning to FIG. 28O:
T. To ascertain an asset availability for some of the assets (e.g., QC presentation deck and QC customer pitch reports 1-3), the Insight Service (2802) submits an asset availability query to Data Source A (2804A) which is identified as the host of these assets amongst the asset metadata thereof, where the asset availability query includes unique asset identifiers (QC presentation deck and QC customer pitch reports 1-3 IDs) associated with these assets
U. To ascertain an asset availability for the remaining assets (e.g., QC learning videos 1 & 2), the Insight Service (2802) submits an asset availability query to Data Source B (2804B) which is identified as the host of these remaining assets amongst the asset metadata thereof, where the asset availability query includes unique asset identifiers (QC learning videos 1 & 2 IDs) associated with these remaining assets
V. In response to the submitted asset availability query regarding the QC presentation deck and QC customer pitch reports 1-3, Data Source A (2804A) returns an asset availability reply to the Insight Service (2802), where the asset availability reply specifies asset availability states indicating that the QC presentation deck and QC customer pitch reports 1 & 3 are available while QC customer pitch report 2 is unavailable
W. In response to the submitted asset availability query regarding QC learning videos 1 & 2, Data Source B (2804B) returns an asset availability reply to the Insight Service (2802), where the asset availability reply specifies asset availability states indicating that QC learning videos 1 & 2 are available

Turning to FIG. 28P:
X. The Insight Service (2802) subsequently produces User Sam availability remarks concerning the QC presentation deck, QC customer pitch reports 1-3, and QC learning videos 1 & 2 based on the returned asset availability replies
Y. The Insight Service (2802) computes a business intent score for User Sam, where the business intent score reflects a moderate value (e.g., 35%) based on what modest information (i.e., known business intent parameters 1-9) is captured in the user business intent model for User Sam

Turning to FIG. 28Q:
Z. The Insight Service (2802) creates search results 2 including a manifest listing the QC presentation deck, QC customer pitch reports 1-3, and QC learning videos 1 & 2, as well as the produced User Sam access remarks, the produced User Sam availability remarks, and the computed business intent score for User Sam a. In response to the submitted search query, the Insight Service (2802) provides search results 2 to Client Device B (2800B) or, more specifically, to User Sam

FIGS. 29A-29F show an example scenario in accordance with one or more embodiments disclosed herein. The example scenario, illustrated through FIGS. 29A-29F and described below, is explanatory purposes only and not intended to limit the scope disclosed herein.

Hereinafter, consider the following example scenario whereby an organization user, identified as Pam, seeks to identify a gap, or gaps, in a particular research space (i.e., robotic systems) in which she or one or more other colleagues in her organization (e.g., an education institution) could pursue. To that end, Pam relies on the disclosed capability of insight gap recommendations by the insight service to isolate said research gap(s) and, also, receive suggestions as to whom amongst herself and her colleagues would be best suited to pursue said research gap(s).

Interactions amongst various actors—e.g., a Client Device (2900) operated by Pam, and the Insight Service (2902)—are illustrated in conjunction with components shown across FIGS. 29A-29F and described (in an itemized manner) below. Said interactions, as well as processes performed on/by any particular actor may follow embodiments disclosed herein pertaining to insight gap recommendations as applied to the circumstances of the example scenario.

Turning to FIG. 29A:
1. User Pam, operating the Client Device (2900), submits a gap query to the Insight Service (2902), where the gap query specifies robotic systems as a research area
2. The Insight Service (2902) obtains a research area taxonomy respective to robotic systems, where the research area taxonomy includes a classification schema interrelating 16 research subareas (e.g., (1) general sensing and perception; (2) sensing for robotic systems; (3) state estimation; (4) onboard mapping and data analysis; (5) object, event, and activity recognition; (6) general mobility; (7) robot navigation and path planning; (8) collaborative mobility; (9) general manipulation; (10) dexterous manipulation; (11) grappling technologies; (12) contact dynamics modeling; (13) human-robot interaction (14) multi-modal and proximate interaction; (15) distributed collaboration and coordination; and (16) remote interaction) pertaining to robotic systems
3. The Insight Service (2902) further obtains an asset metadata graph representative of an asset catalog

Turning to FIG. 29B:
4. Based on each of the 16 research subareas of robotic systems, the Insight Service (2902) filters the asset metadata graph to identify 16 separate asset node subsets (i.e., asset node subsets 1-16), where each asset node subset represents at least a portion of a set of nodes, at least in part, forming the asset metadata graph, where each asset node subset includes one or more nodes corresponding to asset catalog entry/entries each specifying asset metadata (or at least a portion thereof) matching and/or semantically similar to a respective research subarea
5. The Insight Service (2902) generates a k-partite metadata graph (i.e., multi-partite) metadata graph using asset node subsets 1-16

Turning to FIG. 29C:
6. The Insight Service (2902) identifies two anti-super nodes (i.e., anti-super nodes 1 & 2) in/of the k-partite metadata graph
7. The Insight Service (2902) further identifies one weak adjacent node (i.e., weak adjacent node 1) respective to anti-super node 1 and two weak adjacent nodes (i.e., weak adjacent nodes 2 & 3) respective to anti-super node 2

Turning to FIG. 29D:
8. The Insight Service (2902) maps anti-super node 1 to the (gap) research subarea of collaborative mobility, anti-super node 2 to the (gap) research subarea of dexterous manipulation, weak adjacent node 1 to the (gap) research subarea of state estimation, weak adjacent node 2 to the (gap) research subarea of contact dynamics modeling, and weak adjacent node 3 to the (gap) research subarea of multi-modal and proximate interaction
9. The Insight Service (2902) obtains a user metadata graph representative of a user catalog

Turning to FIG. 29E:
A. Based on each of the (gap) research subareas, the Insight Service (2902) filters the user metadata graph to identify 5 separate user node subsets (i.e., user node subsets 1-5), where each user node subset represents at least a portion of a set of nodes, at least in part, forming the user metadata graph, where each user node subset includes one or more nodes corresponding to user catalog entry/entries (i.e., user profile(s)) each specifying user metadata (or at least a portion thereof) matching or semantically similar to a respective (gap) research subarea

Turning to FIG. 29F:
B. The Insight Service (2902) maps user node subset 1 to User Max, user node subset 2 to User Bill, user node subset 3 to User Lucy, user node subset 4 to User Gary, and user node subset 5 to User Tim
C. In response to the submitted gap query, the Insight Service (2902) provides the pairs of {collaborative mobility, User Max}, {dexterous manipulation, User Bill}, {state estimation, User Lucy}, {contact dynamics modeling, User Gary}, and {multi-modal and proximate interaction, User Tim} to the Client Device (2900) or, more specifically, to User Pam, where each {(gap) research subarea, organization user} pair specifies a research subarea in the research area of robotics systems with a sparse presence across assets (e.g., research journal articles, research white papers, research dissertations/theses, etc.) catalogued by the Insight Service (2902) and an organization user of an organization suited for, knowledgeable in, and/or capable of pursuing and developing insight(s) pertaining to the research subarea

FIGS. 30A-30P show an example scenario in accordance with one or more embodiments disclosed herein. The example scenario, illustrated through FIGS. 30A-30P and described below, is for explanatory purposes only and not intended to limit the scope disclosed herein.

Hereinafter, consider the following example scenario whereby the insight service seeks to minimize, if not eliminate, bias across one or more insight inference models implemented/employed thereby that may be caused by any re-used and (re-)ingested insight(s) (e.g., as originally produced or including at least one modification during any re-use(s) thereof) that the insight service is unaware is/are insight(s) derived or inferred through one or more capabilities (or functionalities) of the insight service. In the following example scenario, the insight service further seeks to evaluate an insight value for any insight(s) derived or inferred thereby. To achieve these ends, the insight service relies on its disclosed capability of insight value assessments using post-insight feedback.

Further, interactions amongst various actors—e.g., an Insight Agent executing on a Client Device A (3000) operated by an organization user identified as Ben, a Client Device B (3002) (without an Insight Agent) operated by another organization user identified as Pete, the Insight Service (3004), and a Data Source (3006)—are illustrated in conjunction with components shown across FIGS. 30A-30P and described (in an itemized manner) below. Said interactions, as well as processes performed on/by any particular actor may follow embodiments disclosed herein pertaining to insight value assessments using post-insight feedback as applied to the circumstances of the example scenario.

Turning to FIG. 30A:
1. User Ben, operating Client Device A, creates an insight (e.g., forecast data) through a series of insight creation actions, where said series of insight creation actions are captured by the Insight Agent on Client Device A (3000)
2. The Insight Agent on Client Device A (3000) submits the series of insight creation actions, as well as the insight, to the Insight Service (3004)

Turning to FIG. 30B:
3. Based on at least the series of insight creation actions, the Insight Service (3004) creates and maintains an insight lineage graph and an insight record both for the insight, where the insight record resides in an insight catalog and at least includes: an insight storage location at where the insight is stored, an insight lineage graph storage location at where the insight lineage graph is stored, and insight creation metadata mapped to the insight lineage graph and describing creation aspects pertaining to the insight based on the series of insight creation actions
4. The Insight Service (3004) creates a digital tracking tag to facilitate tracking of the insight, where the digital tracking tag is represented by embeddable computer readable program code

Turning to FIG. 30C:
5. The Insight Service (3004) creates/identifies a tag identifier (ID) associated with the digital tracking tag and, subsequently, updates the insight record for the insight to further include the tag ID
6. The Insight Service (3004) relays the digital tracking tag to the Insight Agent on Client Device A (3000) 7. Upon receiving the digital tracking tag, the Insight Agent on Client Device A (3000) embeds the digital tracking tag within the insight (locally available on Client Device A) to obtain a traceable insight

Turning to FIG. 30D:
8. User Ben, operating Client Device A, opts to incorporate the traceable insight within a base asset (e.g., a presentation slide file/document), where said incorporation of the traceable insight is detected by the Insight Agent on Client Device A (3000) 9. The Insight Agent on Client Device A (3000) thereafter captures base asset metadata (e.g., author, creation timestamp, last modified timestamp, etc.) describing the base asset
A. The Insight Agent on Client Device A (3000) relays the base asset metadata to the Insight Service (3004)

Turning to FIG. 30E:
B. The Insight Service (3004) updates the insight record for the insight to further include the base asset metadata received from the Insight Agent on Client Device A (3000)
C. User Ben, operating Client Device A, meanwhile, chooses to store the base asset, including the traceable insight, on the Data Source (3006)
D. At some future point-in-time, User Pete, operating Client Device B (3002), finds and downloads the base asset, stored on the Data Source (3006), therefrom, where User Pete intends to re-use the traceable insight incorporated within the base asset

Turning to FIG. 30F:
E. Once the base asset is downloaded onto Client Device B (3002), User Pete extracts the traceable insight from the base asset
F. Afterwards, User Pete, operating Client Device B (3002), modifies (e.g., applies a modification to) the traceable insight, thereby obtaining a modified traceable insight

Turning to FIG. 30G:
G. User Pete, operating Client Device B (3002), subsequently incorporates the modified traceable insight within a new asset (e.g., a predominantly text based document)
H. User Pete, operating Client Device B (3002) then stores the new asset, including the re-used traceable insight, on the Data Source (3006)
I. As is performed periodically, the Insight Service (3004) examines the Data Source (3006) for any yet to be ingested and/or catalogued asset(s) stored thereon

Turning to FIG. 30H:
J. Based on the examination of the Data Source (3006), the Insight Service (3004) identifies and ingests the new asset stored thereon earlier by User Pete
K. Through ingestion of the new asset, the Insight Service (3004) obtains asset metadata describing the new asset, as well as asset content collectively representing any item(s) of data/information presented in the new asset
L. The Insight Service (3004) updates an asset catalog using the asset metadata or, more specifically, creates a new asset catalog entry in the asset catalog, where the new asset catalog entry corresponds to the new asset and includes the asset metadata

Turning to FIG. 30I:
M. Thereafter, the Insight Service (3004) scans the asset content for, and thus discovers, a digital tracking tag embedded within an asset content component (e.g., an item of data/information presented in the new asset)
N. Through examination of the digital tracking tag, the Insight Service (3004) obtains a tag ID associated therewith

Turning to FIG. 30J:
O. Using the tag ID, the Insight Service (3004) then searches the insight catalog for, and thus identifies, the insight record for the insight, where the insight record includes the tag ID
P. Based on the identification of the insight record, the Insight Service (3004) further identifies the asset content component (e.g., the modified traceable insight), embedded with the discovered digital tracking tag, as a re-used traceable insight that is derived from the insight corresponding to the insight record

Turning to FIG. 30K:
Q. The Insight Service (3004) performs at least one bias-removing action involving or related to the re-used traceable insight
R. The Insight Service (3004) obtains the insight corresponding to the insight record by, for example, using an insight storage location included in the insight record to retrieve the insight from a storage location referenced by the insight storage location

Turning to FIG. 30L:
S. In applying a differentiation algorithm to or between the insight and the re-used traceable insight, the Insight Service (3004) identifies a difference there-between, where the difference corresponds to the modification applied to the traceable insight earlier by User Pete

Turning to FIG. 30M:
T. In response to identifying the difference (or modification), the Insight Service (3004) examines the asset metadata (e.g., more specifically, stewardship, ownership, or authorship information therein) for the new asset, which is maintained in the asset catalog, to identify contact information (or, more specifically, a contact email address) associated with a steward, owner, or author (e.g., User Pete) of the new asset

Turning to FIG. 30N:
U. In identifying the contact email address, the Insight Service (3004) creates an insight modification questionnaire concerning the re-used traceable insight and, more specifically, the modification differentiating the re-used traceable insight against the insight
V. The Insight Service (3004) creates an email that addresses the contact email address for User Pete, and includes the insight modification questionnaire or, alternatively, a web address/link referencing the insight modification questionnaire

Turning to FIG. 30O:
W. The Insight Service (3004) transmits the email to User Pete via the contact email address
X. Upon receiving the email, including the insight modification questionnaire (or the web address/link referencing the same), User Pete, operating Client Device B (3002), opts to create an insight modification questionnaire response addressing at least a portion of the insight modification questionnaire
Y. After its completion, User Pete, operating Client Device B (3002), submits the insight modification questionnaire response to the Insight Service (3004)

Turning to FIG. 30P.
Z. Once received, the Insight Service (3004) ingests the insight modification questionnaire response to obtain insight modification information, where the insight modification information includes a justification statement for applying the modification a. Based on at least the insight modification information, the Insight Service (3004) assesses an insight value of/for the insight

FIGS. 31A-31C show an example scenario in accordance with one or more embodiments disclosed herein. The example scenario, illustrated through FIGS. 31A-31C and described below, is for explanatory purposes only and not intended to limit the scope disclosed herein.

Hereinafter, consider the following example scenario whereby an organization user, identified as Scott, seeks to draft/write a research paper centered on data marketplaces. Scott, however, is uncertain whether the topic is worth the time and effort to pursue. To that end, Scott initiates an impact assessment program on his laptop computer (e.g., client device), where the impact assessment program is configured to evaluate said unbegun research (to be conveyed through a research paper medium) and provide recommendations for enhancing an impact factor thereof. Initiation of the impact assessment program is detected by the Insight Service via an Insight Agent executing on the laptop computer and embedded within (or otherwise associated with) the impact assessment program. Further, following said initiation, a set of assessment parameters (e.g., author name(s), affiliation(s), topic, keyword(s), abstract, and body) is/are obtained and, based on the set of assessment parameters, an interactive assessment form (see e.g., FIG. 31A) is instantiated and subsequently presented to Scott via a user interface (UI) of the impact assessment program.

Turning to FIG. 31A, an example impact assessment program UI (3100) is depicted, where an example interactive assessment form (3102), moreover, is instantiated there-within. The example interactive assessment form (3102) is composed of various interactive form components, including: (a) a set of form fields (3104) each representing an editable text field wherein text, respective to a corresponding assessment parameter, can be entered and edited; (b) a set of form field labels (3106) each representing a static text field serving as an associated tag to a respective form field so that Scott would know what information to enter where; (c) a set of parameter-specific impact score indicators (3108) each representing a response-driven text field displaying a current parameter-specific impact score respective to a corresponding assessment parameter; and (d) an overall impact score indicator (3110) representing a response-driven text field displaying a current overall impact score for the unbegun research (e.g., a yet to be drafted research paper centered on data marketplaces) currently being evaluated.

Following presentation of the interactive assessment form, and based on certain subsequent interactions (or engagement actions) by Scott and applied to the interactive assessment form (or the various interactive form components thereof), the Insight Service proceeds to follow embodiments disclosed herein pertaining to impact enhancing recommendations for research papers and initiatives as applied to the circumstances of the example scenario.

Turning to FIG. 31B, Scott, thereafter, identifies a form field (3104A), corresponding to a topic assessment parameter, based on an associated form field label (3106A). Then, within the identified form field (3104A), Scott enters (e.g., types in) the text “Data Marketplaces” (e.g., a field input). The Insight Service, via the Insight Agent, determines that the aforementioned engagement action, by Scott, reflects an editing of any simple form field. Based on said determination, the Insight Service identifies the topic assessment parameter, from the set of assessment parameters, as corresponding to the form field (3104A) and, subsequently, extracts the field input therefrom.

Next, the Insight Service obtains an impactful corpus catalog, maintained thereby, which includes a set of impactful corpus catalog entries each storing asset metadata (divided into various metadata fields) describing a respective impactful asset. The impactful corpus catalog is then filtered based on the topic assessment parameter and the field input, which leads to the identification of two (2) impactful corpus catalog entries representing an impactful corpus catalog entry subset.

The Insight Service, afterwards, obtains an overall corpus catalog, also maintained thereby, which includes a set of overall corpus catalog entries each storing asset metadata (divided into various metadata fields) describing a respective asset, where the asset is either an impactful asset or a non-impactful asset. A parameter-specific impact score, corresponding to the topic assessment parameter, is computed based on a number of impactful catalog entries (e.g., two) in the impactful corpus catalog entry subset and a number of overall corpus catalog entries (e.g., two-hundred) in the set of overall corpus catalog entries. A simple division function (at least for the purposes of the example scenario) is used to compute the parameter-specific impact score. Thus, the parameter-specific impact score=2/200=0.01 (or 1%). Subsequently, the Insight Service computes an overall impact score based on a (current) set of parameter-specific impact scores, which includes the recently computed parameter-specific impact score corresponding to the topic assessment parameter.

Returning to FIG. 31B, the example interactive assessment form (3102) shows the current parameter-specific impact score (e.g., 0%) for each of the remaining assessment parameters (e.g., author name(s), affiliation(s), keyword(s), abstract, and body). Using a simple weighted summation function (at least for the purposes of the example scenario), where the weight assigned to the topic assessment parameter is 0.4, the Insight Service computes the overall impact score to be 0.4×0.01=0.004 (or <1%).

The interactive assessment form is then updated using the recently computed parameter-specific impact score (e.g., 1%), corresponding to the topic assessment parameter, and the recently computed overall impact score (e.g., <1%). More specifically, as conveyed through the example interactive assessment form (3102) in FIG. 31B, the previous parameter-specific impact score (e.g., 0%), which had been displayed by a parameter-specific impact score indicator (3108A) respective to the topic assessment parameter, is replaced with the recently computed parameter-specific impact score (e.g., 1%). Further, a previous overall impact score (e.g., 0%), which had been displayed by the overall impact score indicator (3110), is replaced with the recently computed overall impact score (e.g., <1%).

Based on the topic (e.g., Data Marketplaces) for his unbegun research (e.g., a yet to be drafted research paper centered on data marketplaces) alone, and through the recently computed parameter-specific impact score (e.g., 1%) and the recently computed overall impact score (e.g., <1%), Scott can ascertain that an impact factor associated with his unbegun research is looking dismal. Not ready to give up on the matter, Scott interacts with the interactive assessment form some more in an attempt to receive guidance that could enhance the impacted factor associated with his unbegun research.

Turning to FIG. 3C, Scott, thereafter, identifies another form field (3104B), corresponding to an affiliation(s) assessment parameter, based on an associated form field label (3106B). Then, using the cursor (3112), Scott hovers over the identified form field (3104B). The Insight Service, via the Insight Agent, determines that the aforementioned engagement action, by Scott, reflects a hovering over of any form field. Based on said determination, the Insight Service identifies the affiliation(s) assessment parameter (representing a guiding assessment parameter), from the set of assessment parameters, as corresponding to the form field (3104B).

Next, the Insight Service (re-)obtains the impactful corpus catalog, maintained thereby, which includes a set of impactful corpus catalog entries each storing asset metadata (divided into various metadata fields) describing a respective impactful asset. Afterwards, a search is conducted in an attempt to identify any non-empty form field(s). The search results in the identification of the first form field (3104A), which includes the text “Data Marketplaces” (e.g., a field input) there-within and is thus determined to be a non-empty form field. The field input, within the identified first form field (3104A), is extracted therefrom and the topic assessment parameter (representing a filtering assessment parameter), from the set of assessment parameters, is identified as corresponding to the identified first form field (3104A).

The Insight Service then filters the (re-)obtained impactful corpus catalog based on the filtering assessment parameter and the field input, which again leads to the identification of two (2) impactful corpus catalog entries representing an impactful corpus catalog entry subset. Subsequently, a metadata field, of the various metadata fields dividing the asset metadata stored across the impactful corpus catalog entry subset, is identified, where the metadata field matches the guiding assessment parameter. From here, an asset metadata subset, including the collective asset metadata respective to the identified metadata field and from the two (2) impactful corpus catalog entries representing the impactful corpus catalog entry subset, is obtained.

Thereafter, the Insight Service analyzes the obtained asset metadata subset, thereby resulting in the obtaining of guidance information. The guidance information suggests partnering with Data Marketplace authors affiliated with Stanford University and the Massachusetts Institute of Technology (MIT) in order to enhance the impact factor for the unbegun research (e.g., a yet to be drafted research paper centered on data marketplaces) currently being evaluated. The guidance information, further, includes links pointing to maintained metadata describing the suggested Data Marketplace authors. The guidance information, further, is presented to Scott through the interactive assessment form.

Returning to FIG. 31C, the guidance information (3114) (at least for the purposes of the example scenario) is shown as a comment pointing at another parameter-specific impact score indicator (3108B), from the set of parameter-specific impact score indicators, which corresponds to the guiding assessment parameter (e.g., the affiliation(s) assessment parameter) and, by association, to the second form field (3104B) being hovered over using the cursor (3112). Further, within the shown comment, the above-mentioned links, pointing to maintained metadata describing the suggested Data Marketplace authors, are conveyed through the underlined terms “Stanford” and “MIT” therein.

From here, Scott may or may not opt to follow the guidance information provided by the Insight Service. Should Scott choose to follow the guidance information, he may click on the links, embedded in the guidance information, to discover the metadata describing the suggested Data Marketplace authors. Further, Scott may then enter the author names, for the suggested Data Marketplace authors and from the metadata, into the second form field (3104B) respective to the affiliation(s) assessment parameter. In doing so, Scott may observe the second parameter-specific impact score indicator (3108B) displaying a new, non-zero parameter-specific impact score corresponding to the affiliation(s) assessment parameter, as well as the overall impact score indicator (3110) displaying a new, increased overall impact score, where both said scores would be re-computed in response to Scott's interaction with (e.g., the entering of text into) the second form field (3104B).

FIGS. 32A and 32B show an example scenario in accordance with one or more embodiments disclosed herein. The example scenario, illustrated through FIGS. 32A and 32B and described below, is for explanatory purposes only and not intended to limit the scope disclosed herein.

Hereinafter, consider the following example scenario whereby an organization user, identified as Mark, seeks to not only know more regarding the prospects of quantum computing (QC) development in the technology industry, but also how any derived/inferred insight(s) came to be. To that end, Mark relies on the disclosed capability of insight creation filtering by the Insight Service—embodiments of which have been disclosed herein may be followed by the Insight Service as applied to the circumstances of the example scenario.

Mark begins by submitting a transparent insight query to the Insight Service from his laptop computer (e.g., Client Device), where the transparent insight query includes a query expression posed by the statement “future quantum computing development timeline”. The Insight Service extracts expression keyword(s) (e.g., “future”, “quantum computing”, “development timeline”) from the query expression and, based on a metadata graph of an asset catalog maintained thereby and the extracted expression keyword(s), generates a k-partite metadata graph (see e.g., example k-partite metadata graph 3200 of FIG. 32A (denoted by the combination of dotted and solid-lined nodes and edges)). After generating the k-partite metadata graph, the Insight Service creates a model input snapshot including the k-partite metadata graph (or a link pointing to a storage location at which the k-partite metadata graph is stored) and an asset catalog version number (e.g., v2.2) associated with the asset catalog.

Thereafter, the Insight Service traverses the k-partite metadata graph using one or more graph theory techniques (e.g., technique A and technique D) to identify an insight-pertinent metadata subgraph (see e.g., example insight-pertinent metadata subgraph 3202A of FIG. 32A (denoted by the solid-lined nodes and edges)). The insight-pertinent metadata subgraph, including a respective set of subgraph nodes (denoted by the four (4) solid-lined nodes labeled N4, N5, N7, and N8 in FIG. 32A), is/are determined to be the most impactful in/to deriving, or inferring, any insight(s) addressing the query expression.

The Insight Service, next, proceeds to identify an asset catalog subset (e.g., four (4) asset catalog entries) of the asset catalog that respectively map/correspond to the identified set of subgraph nodes. (Individual) asset metadata is subsequently extracted from each of the asset catalog entries, included in the identified asset catalog subset, to obtain an asset metadata corpus including (aggregated) asset metadata. The obtained asset metadata corpus is then analyzed using one or more inference forming algorithms (e.g., algorithm J), thereby producing the insight “4k qubits by 2025; 1M qubits by 2027” reflecting predicted future milestones for the availability of QC processing power.

Further, based on an examination of the asset metadata corpus, the Insight Service identifies a set of insight-pertinent assets (e.g., a News Article by a News Agency, a Blog Article by author Amy K., a Blog Article by author Gill C., and a Press Release by a Tech Organization) corresponding to the set of subgraph nodes of the insight-pertinent metadata subgraph, and creates a manifest listing the identified set of insight-pertinent assets. Following this, the Insight Service creates a model snapshot specifying the graph theory technique(s) (e.g., technique A and technique D), as well as the inference forming algorithm(s) (e.g., algorithm J), employed in the derivation, or inference, of the produced insight.

The Insight Service, using the insight, the model input snapshot, the manifest listing the set of insight-pertinent assets, and the model snapshot, then creates an interactive query result (see e.g., example interactive query result 3204A of FIG. 32A). At least a portion of the created interactive query result is permitted to be adjusted by Mark (see e.g., a check box presented alongside each insight-pertinent asset listed under the Manifest section of the example interactive query result 3204A of FIG. 32A). Hereafter, the Insight Service provides the interactive query result to Mark in response to the submitted transparent insight query.

Upon receiving the interactive query result and performing an examination thereof, Mark opts to make an adjustment to the disclosed manifest listing the set of insight-pertinent assets. More specifically, Mark believes blog author Gill C. to be untrustworthy and, accordingly, decides to remove the Blog Article by Author Gill C. (e.g., via an unchecking of a respectively presented checkbox) from the manifest.

The Insight Service, having detected the user interaction (e.g., the adjustment of the manifest) performed by Mark on the interactive query result, proceeds to identify a subgraph node subset (see e.g., solid-lined node labeled N7 of the example insight-pertinent metadata subgraph 3202A of FIG. 32A), of the insight-pertinent metadata subgraph, impacted by the detected user interaction. A new insight-pertinent metadata subgraph (see e.g., example new insight-pertinent metadata subgraph 3202B of FIG. 32B (denoted by the solid-lined nodes and edges, which excludes the identified subgraph node subset now denoted by the dotted-lined node labeled N7 and any now dotted-lined edge(s) connected thereto)) is derived from the insight-pertinent metadata graph and the identified subgraph node subset.

A resulting, new asset catalog subset (e.g., three (3) asset catalog entries) of the asset catalog is identified by the Insight Service, which respectively map/correspond to the new set of subgraph nodes forming the derived new insight-pertinent metadata subgraph. (Individual) asset metadata is subsequently extracted from each of the asset catalog entries, included in the identified new asset catalog subset, to obtain a new asset metadata corpus including (aggregated) asset metadata. The obtained new asset metadata corpus is then analyzed using one or more inference forming algorithms (e.g., algorithm J), thereby producing the insight “4k qubits by 2025; 1M qubits by 2035” reflecting new predicted future milestones for the availability of QC processing power.

Further, based on an examination of the new asset metadata corpus, the Insight Service identifies a new set of insight-pertinent assets (e.g., a News Article by a News Agency, a Blog Article by author Amy K., and a Press Release by a Tech Organization) corresponding to the new set of subgraph nodes of the new insight-pertinent metadata subgraph, and creates a manifest listing the identified new set of insight-pertinent assets.

The Insight Service, using the new insight, the model input snapshot, the new manifest listing the new set of insight-pertinent assets, and the model snapshot, then creates a new interactive query result (see e.g., example new interactive query result 3204B of FIG. 32B). At least a portion of the created new interactive query result is permitted to be adjusted by Mark (see e.g., a check box presented alongside each new insight-pertinent asset listed under the Manifest section of the example new interactive query result 3204B of FIG. 32B). Hereafter, the Insight Service provides the new interactive query result to Mark in response to the detected user interaction performed by Mark on the previously presented interactive query result.

FIG. 33 shows an example scenario in accordance with one or more embodiments disclosed herein. The example scenario, illustrated through FIG. 33 and described below, is for explanatory purposes only and not intended to limit the scope disclosed herein.

Hereinafter, consider the following example scenario whereby an organization user, identified as Mark, seeks to not only know more regarding the prospects of quantum computing (QC) development in the technology industry, but also how any derived/inferred insight(s) came to be. To that end, Mark relies on the disclosed capability of insight creation filtering by the Insight Service—embodiments of which have been disclosed herein may be followed by the Insight Service as applied to the circumstances of the example scenario.

Mark begins by submitting a transparent insight query to the Insight Service from his laptop computer (e.g., Client Device), where the transparent insight query includes a query expression posed by the statement “future quantum computing development timeline”. The Insight Service extracts expression keyword(s) (e.g., “future”, “quantum computing”, “development timeline”) from the query expression and, based on a metadata graph of an asset catalog maintained thereby and the extracted expression keyword(s), generates a k-partite metadata graph (see e.g., example k-partite metadata graph 3300 of FIG. 33 (denoted by the combination of dotted and solid-lined nodes and edges)). After generating the k-partite metadata graph, the Insight Service creates a model input snapshot including the k-partite metadata graph (or a link pointing to a storage location at which the k-partite metadata graph is stored) and an asset catalog version number (e.g., v2.2) associated with the asset catalog.

Thereafter, the Insight Service traverses the k-partite metadata graph using one or more graph theory techniques (e.g., technique A and technique D) to identify an insight-pertinent metadata subgraph (see e.g., example insight-pertinent metadata subgraph 3302 of FIG. 33 (denoted by the solid-lined nodes and edges)). The insight-pertinent metadata subgraph, including a respective set of subgraph nodes (denoted by the four (4) solid-lined nodes labeled N4, N5, N7, and N8 in FIG. 33), is/are determined to be the most impactful in/to deriving, or inferring, any insight(s) addressing the query expression.

The Insight Service, next, proceeds to identify an asset catalog subset (e.g., four (4) asset catalog entries) of the asset catalog that respectively map/correspond to the identified set of subgraph nodes. (Individual) asset metadata is subsequently extracted from each of the asset catalog entries, included in the identified asset catalog subset, to obtain an asset metadata corpus including (aggregated) asset metadata. The obtained asset metadata corpus is then analyzed using one or more inference forming algorithms (e.g., algorithm J), thereby producing the insight “4k qubits by 2025; 1M qubits by 2027” reflecting predicted future milestones for the availability of QC processing power.

Further, based on an examination of the asset metadata corpus, the Insight Service identifies a set of insight-pertinent assets (e.g., a News Article by a News Agency, a Blog Article by author Amy K., a Blog Article by author Gill C., and a Press Release by a Tech Organization) corresponding to the set of subgraph nodes of the insight-pertinent metadata subgraph, and creates a manifest listing the identified set of insight-pertinent assets. Following this, the Insight Service creates a model snapshot specifying the graph theory technique(s) (e.g., technique A and technique D), as well as the inference forming algorithm(s) (e.g., algorithm J), employed in the derivation, or inference, of the produced insight.

The Insight Service, using the insight, the model input snapshot, the manifest listing the set of insight-pertinent assets, and the model snapshot, then creates a non-interactive query result (see e.g., example non-interactive query result 3304 of FIG. 33). None of the created non-interactive query result is permitted to be adjusted by Mark. Hereafter, the Insight Service provides the non-interactive query result to Mark in response to the submitted transparent insight query.

FIG. 34 shows an example scenario in accordance with one or more embodiments disclosed herein. The example scenario, illustrated through FIG. 34 and described below, is for explanatory purposes only and not intended to limit the scope disclosed herein.

Hereinafter, consider the following example scenario whereby the disclosed capability of predicting, and providing readiness support for, future business intents is applied, by the Insight Service, to circumstances entailing an organization user identified as Bob.

To that end, and following embodiments herein pertaining to said disclosed capability, the Insight Service, foremost, obtains a current user business intent (3402) associated with Bob. The obtained current user business intent (3402) at least specifies that Bob: (a) is a research and development (R&D) engineer for/at the organization with which Bob is affiliated; (b) has made recent search queries relating to graph theory (GT), databases (DB), and/or a combination thereof, and (c) has recently completed a project directed to graph based knowledge management.

Based on the obtained current user business intent for Bob, the Insight Service proceeds to build one or more intent predictive models. The intent predictive model(s) is/are subsequently used to extrapolate a prospective user business intent (3404) for Bob. The extrapolated prospective user business intent (3404) includes the following predictions: (a) that Bob, at some future point-in-time, may submit one or more search queries relating to GT, DB, artificial intelligence (AI), cloud computing (CC), and/or any combination(s) thereof, and (b) that Bob, at some future point-in-time, may be assigned or undertake a project directed to developing a cloud computing service implementing an AI capable of insight generation.

With the obtained current user business intent (3402) and the extrapolated prospective user business intent (3404) at hand, the Insight Service thereafter pursues an inter-intent roadmap (3400) in order to ready support, to Bob, should Bob follow in the predictions specified by the extrapolated prospective user business intent (3404) at some future point-in-time.

Accordingly, as an initial step along the inter-intent roadmap (3400), the Insight Service obtains current user talent information (3406) associated with Bob. The obtained current user talent information (3406) at least specifies that Bob: (a) has earned undergraduate degrees in computer science and mathematics, as well as a graduate degree in the former; (b) has skills or proficiencies in coding, data analysis, and DB languages; and (c) has interests, whether professional and/or personal, directed to GT and discrete mathematics.

Next, the Insight Service identifies multiple user inter-intent gaps (3408) differentiating the extrapolated prospective user business intent (3404) from a current user intent state (or collectively, the obtained current user business intent (3402) and the obtained current talent information (3406)) for Bob. The identified user inter-intent gaps (3408) at least specify that Bob is lacking: (a) CC skills to successfully develop the cloud computing service representative of the future project Bob may be assigned or undertake; and (b) algorithmic knowledge integrating GT and AI to successfully implement the insight generating AI to be provided by the cloud computing service.

From here, the Insight Service obtains current user learning preferences (3410) associated with Bob. The obtained current user learning preferences (3410) at least specify that Bob has a higher affinity for comprehending and retaining information formatted in the reading and visual learning modalities.

In view of the obtained current user learning preferences (3410), the Insight Service then selects the gap-bridging support (3412) that would aid Bob should Bob follow in the predictions specified by the extrapolated prospective user business intent (3404) at some future point-in-time. The selected gap-bridging support (3412) includes: (a) a collection of research papers and slide presentations discussing integrated GT/AI applications and algorithms; and (b) a series of CC tutorial videos representative of a tailored learning curriculum from a beginner level to an expert level of understanding.

FIGS. 35A-35R show an example scenario in accordance with one or more embodiments disclosed herein. The example scenario, illustrated through FIGS. 36A and 36B and described below, is for explanatory purposes only and not intended to limit the scope disclosed herein.

Hereinafter, consider the following example scenario whereby an organization user, identified as Leo, has returned from attending a conference centered around quantum computing (QC) and, therefore, seeks to report on his experiences and observations while having attended said conference. To that end, Leo initiates a software application on his work laptop, or client device, employed by his affiliated organization, identified as Organization Alpha (or for short, Org. Alpha), where the software application (e.g., a conference interview program) is configured to inquire Leo with respect to the conference he recently had attended. The software application, further, relies on the disclosed capability of dynamic questioning intelligence by the insight service, and by extension, the insight agent executing on the client device and embedded within the software application, to provide a more human conversional line of questioning when inquiring Leo regarding the conference.

Interactions amongst various actors—e.g., the Insight Agent on the Client Device (3500), the latter of which operated by Leo, and the Insight Service (3502)—are illustrated in conjunction with components shown across FIGS. 35A-35R and described (in an itemized manner) below. Said interactions, as well as processes performed on/by any particular actor may follow embodiments disclosed herein pertaining to dynamic questioning intelligence as applied to the circumstances of the example scenario.

Turning to FIG. 35A:
1. Following initiation of the conference interview program by User Leo, the Insight Agent on the Client Device (3500), the latter of which is being operated by User Leo, detects said initiation
2. The Insight Agent on the Client Device (3500) prompts, via a user interface of the conference interview program, User Leo for (and subsequently obtains) a user identifier (e.g., User Leo ID), a conference link (e.g., www.quantumconf.com), and an attended sessions list (e.g., including conference sessions entitled “A Commercialization Roadmap for Quantum Processors” and “Use Cases of Quantum Computing for Space Exploration”)

Turning to FIG. 35B:
3. The Insight Agent on the Client Device (3500) submits the user identifier (ID), conference link, and the attended sessions list to the Insight Service (3502) 4. Based on the user ID (e.g., User Leo ID), the Insight Service (3502) obtains a user business intent associated with User Leo, where the obtained user business intent at least specifies that Leo is a materials engineer in an engineering department of Org. Alpha
5. Using the conference link (e.g., www.quantumconf.com) for the conference attended by User Leo, the Insight Service (3502) accesses a conference website for said conference

Turning to FIG. 35C:
6. The Insight Service (3502) proceeds to ingest the conference website, via data scraping, to obtain key conference information (e.g., conference agenda, list of conference sponsors, conference session abstracts, list of conference speakers, etc.)
7. Based on the key conference information, the Insight Service (3502) builds a conference model of the conference

Turning to FIG. 35D:
8. From ingesting the conference website earlier, the Insight Service (3502) identifies a session webpage, amongst the conference website, for each attended (conference) session specified in the attended sessions list (e.g., including conference sessions entitled “A Commercialization Roadmap for Quantum Processors” and “Use Cases of Quantum Computing for Space Exploration”)
9. The Insight Service (3502) subsequently ingests the session webpage, for each attended session, to obtain session metadata (e.g., session title, session topic, list of session presenters, list of session sponsors, etc.) describing the respective attended session

Turning to FIG. 35E:
A. Based on the session metadata, the Insight Service (3502) builds a session model for each attended session
B. The Insight Service (3502) obtains insight state including a superset of technology predictions for various technologies, an organization strategy cascade for Org. Alpha, a user catalog maintaining user metadata for users (e.g., employees) of Org. Alpha, a conference attendance history maintaining attendance records and conference metadata for recent and past conferences, an organization catalog maintaining organization metadata for various other organizations, and an asset catalog maintaining asset metadata for various assets

Turning to FIG. 35F:
C. Using the user business intent for User Leo, the conference model, the session models of the two attended sessions, and the insight state, the Insight Service (3502) commences a pre-work pipeline

Turning to FIG. 35G:
D. As part of the pre-work pipeline, the Insight Service (3502) identifies a conference technology (e.g., quantum processors) associated with the conference using a technology classifier fed with the conference model and the session models

Turning to FIG. 35H:
E. As part of the pre-work pipeline, the Insight Service (3502) identifies a conference technology prediction (e.g., cloud service providers will begin integrating QC into their services in 5-10 years) from the superset of technology predictions and based on the conference technology

Turning to FIG. 35I:
F. As part of the pre-work pipeline, the Insight Service (3502) identifies a conference-cascade relevancy (e.g., in the upcoming year, Org. Alpha intends to partner with Organization (or Org.) Bravo in researching new QC applications) based on the Org. Alpha organization strategy cascade and the conference technology

Turning to FIG. 35J:
G. As part of the pre-work pipeline, the Insight Service (3502) filters the user catalog based on the conference technology and, subsequently, identifies Users Ana and Eve whom also work for Org. Alpha and are considered QC subject matter experts (SMEs)

Turning to FIG. 35K:
H. As part of the pre-work pipeline, the Insight Service (3502) identifies a value network (e.g., a sales representative, identified as Moe, for an organization, identified as Supplier Charlie, that specializes in the production and sale of Joshephson junctions that serve as base materials used in superconducting qubits pertinent to constructing most existing quantum processors) from the user business intent for User Leo and based on the conference technology

Turning to FIG. 35L:
I. As part of the pre-work pipeline, the Insight Service (3502) filters the conference attendance history based on the conference model and, subsequently, identifies Users Ana, Eve, Tom, and Ian as other Org. Alpha employees whom attended the conference and/or any past conferences of a same/similar conference name

Turning to FIG. 35M:
J. As part of the pre-work pipeline, the Insight Service (3502) filters the organization catalog based on the conference technology and, subsequently, identifies Org. Bravo, Supplier Charlie, and Organization (or Org.) Delta as players in the quantum processors space

Turning to FIG. 35N:
K. As part of the pre-work pipeline, the Insight Service (3502) filters the asset catalog based on the conference technology and, subsequently, identifies a technology corpus at least relevant or related to quantum processors, where the technology corpus includes 10 QC blog articles, 120 QC research papers, 2 quantum processor product brochures, and 1 QC textbook

Turning to FIG. 35O:
L. Finishing the pre-work pipeline, the Insight Service (3502) produces a pre-work result including the conference technology (e.g., quantum processors), the conference technology prediction (e.g., cloud service providers will begin integrating QC into their services in 5-10 years), the conference-cascade relevancy (e.g., in the upcoming year, Org. Alpha intends to partner with Org. Bravo in researching new QC applications), QC SMEs (e.g., Users Ana and Eve) working for Org. Alpha, the value network (e.g., Sales Rep. Moe for Supplier Charlie), other recent and/or past conference attendees (e.g., Users Ana, Eve, Tom, and Ian), other players (e.g., Org. Bravo, Supplier Charlie, and Org. Delta) in the quantum processors space, and the technology corpus

Turning to FIG. 35P:
M. Based on the pre-work result and considering the user business intent (e.g., which at least specifies that User Leo is a materials engineer in an engineering department of Org. Alpha) for User Leo, the Insight Service (3502) generates a set of user-tailored interview questions concerning the conference recently attended by User Leo
N. The Insight Service (3502) then relays the set of user-tailored interview questions to the Insight Agent on the Client Device (3500)

Turning to FIG. 35Q:
O. The Insight Agent on the Client Device (3500) presents, via the user interface of the conference interview program, the set of user-tailored interview questions to User Leo
P. After some toiling by User Leo, the Insight Agent on the Client Device (3500) obtains a set of user interview responses addressing the set of user-tailored interview questions
Q. The Insight Agent on the Client Device (3500) submits the set of user interview responses to the Insight Service (3502)

Turning to FIG. 35R:
R. The Insight Service (3502) generates a conference report at least using the user ID (e.g., User Leo ID) for User Leo, the conference link (e.g., www.quantumconf.com) for the conference attended by User Leo, the attended sessions list (e.g., including conference sessions entitled “A Commercialization Roadmap for Quantum Processors” and “Use Cases of Quantum Computing for Space Exploration”), the key conference information (e.g., conference agenda, list of conference sponsors, conference session abstracts, list of conference speakers, etc.) associated with the conference, the session metadata (e.g., session title, session topic, list of session presenters, list of session sponsors, etc.) describing the two attended sessions specified in the attended sessions list, and the user interview responses; from here, the Insight Service (3502) stores the conference report and may then proceed to perform any number of post-interview actions (see e.g., Step 1732 of FIG. 17B)

FIGS. 36A and 36B show an example scenario in accordance with one or more embodiments disclosed herein. The example scenario, illustrated through FIGS. 36A and 36B and described below, is for explanatory purposes only and not intended to limit the scope disclosed herein.

Hereinafter, consider the following example scenario whereby an organization user, identified as Kyle Johnson, seeks to compose an email to another organization user identified as Sandy Smith. To that end, Kyle initiates his preferred email client (e.g., communication program) on his laptop computer (e.g., client device)—the initiation of the former of which is detected by the Insight Service via an Insight Agent executing on the laptop computer and associated with the email client. Moreover, based on certain subsequent interactions (or engagement actions) by Kyle and applied to the email client (or features thereof), the Insight Service may follow embodiments disclosed herein pertaining to business intent based communications enhancement as applied to the circumstances of the example scenario.

Based on a user ID and/or credentials assigned to Kyle, the Insight Service subsequently obtains a user business intent associated with him, where the obtained user business intent specifies that Kyle: (a) is a firmware developer in an edge business unit of the organization with which Sandy and he are both affiliated; (b) has published internal research papers on how to deploy general purpose software languages in a supervisory control and data acquisition (SCADA)/programmable logic controller (PLC) environment; and (c) is conducting an open innovation project with a multinational conglomerate technology company.

Following initiation of his preferred email client, Kyle (e.g., organization user) (3602 @ FIG. 36A) proceeds to draft or compose a new email (3600 @ FIG. 36A). In an addressee field of the new email, Kyle enters an email address belonging to Sandy (e.g., communication target) (3604 @ FIG. 36A).

Based on said email address belonging to Sandy, the Insight Service obtains a target user business intent associated with her, where the obtained target user business intent specifies that Sandy: (a) is a technical marketer in the edge business unit of the organization with which Kyle and she are both affiliated; (b) regularly attends LF Edge standards meeting—LF Edge being an umbrella organization aiming to establish an open, interoperable framework for edge computing independent of hardware, silicon, the cloud, or operating systems; (c) typically searches for documents related to secure device onboarding and zero-trust security; and (d) has presented to companies that are involved in industrial Internet of Things (IoT) use cases and that struggle with opening up SCADA/PLC operational technology (OT) configurations to information technology (IT) processes.

After populating the addressee field, Kyle moves to provide a single-line of text (e.g., “PLC DevOps”), denoting the topic of the email to Sandy, into the email subject line (e.g., communication subject) (3606 @ FIG. 36A) of said email.

The Insight Service analyzes the email subject line and identifies “PLC” and “DevOps” as communication keywords. An asset catalog is subsequently filtered using the identified keywords to fetch information (e.g., one or more assets, and/or one or more keyword-relevant insights) respective to the email subject line. Said fetched information may summarily reflect a current state, and/or predictions as to the future evolution, of the technology area surrounding combined software development (Dev) and IT operations (Ops) practices in the PLC space.

Kyle, thereafter, proceeds to compose the email body (e.g., communication message) (3608 @ FIG. 36A) of the email. The email body states the following text: “Hi Sandy, I wanted to let you know that I recently completed a proof-of-concept to deploy general-purpose, modern programming languages into a PLC and SCADA environment. The proof-of-concept proves that our customers can realize a 90% speed-up in the deployment of new business logic. If you'd like a demo, please contact me. Thanks. Kyle Johnson” (also, see e.g., FIG. 36A).

From here, the Insight Service analyzes the email body and identifies additional communication keywords, which are used to further filter the asset catalog to fetch additional information (e.g., one or more additional assets, and/or one or more additional keyword-relevant insights) respective to the email body. Said fetched additional information may also summarily reflect a current state, and/or predictions as to the future evolution, of the technology area surrounding combined software development (Dev) and IT operations (Ops) practices in the PLC space.

The Insight Service, furthermore, leverages the obtained user business intent for Kyle, the obtained target user business intent for Sandy, and the fetched information from analyzing the email subject line and body, to generate a few editing suggestions. Said editing suggestions include: (a) the inclusion of a link (3610 @ FIG. 36B) to a PLC DevOps presentation that Kyle had created for a recent technology conference; (b) the citation (3612 @ FIG. 36B) for a use case relevant to a development program spearheaded by another organization, the other organization being the multinational conglomerate technology company with which Kyle is conducting an open innovation project; and (c) the inclusion of a link (3614 @ FIG. 36B) to a research summary and a proof-of-concept proposal that had been recently published by Kyle. These editing suggestions may be presented to Kyle, via his preferred email client, as exemplified in FIG. 36B.

For each presented editing suggestion (3610, 3612, 3614 @ FIG. 36B), Kyle may hover over or select the editing suggestion via a cursor (3616 @ FIG. 36B). In engaging with each presented editing suggestion, a dialog box (3618 @ FIG. 36B) appears prompting Kyle to choose whether to adopt or ignore the selected editing suggestion. From here, based on Kyle's adoption or ignorance of any of the presented editing suggestions, as well as based on Sandy's response to the email (if Kyle ignores the editing suggestions) or the enhanced email (if Kyle adopts at least one editing suggestion), the Insight Service may or may not make adjustments to its suggestion algorithm.

FIG. 37A shows an example web browser in accordance with one or more embodiments disclosed herein. The example web browser, illustrated through FIG. 37A and described below, is explanatory purposes only and not intended to limit the scope disclosed herein.

The example web browser (3700) may exemplify a software application or program configured to enable access to any online resource(s) (e.g., one or more webpages). In the simplest of representations, the example web browser (3700) includes: various interactive buttons (e.g., a reverse to a previously visited webpage button, a forward to a next visited webpage button, a reload a current webpage button, a go to a home webpage button, and an access features of an insight service plug-in (3704) button); an editable address bar where the universal resource locator (URL) (3702) of any online resource may be entered; and a content window through which any given online resource (or more specifically, the content respective thereof) may be viewed or interacted with. Said content (also referred to herein as online resource content) may refer to information presented in one or more content formats—e.g., text, tables, images, videos, animations, audio, etc. Online resource content, depicted in the text (3708) and media (i.e., image and video) (3710) forms, is exemplified here in the content window of the example web browser (3700).

The example web browser (3700) further includes, or may integrate, an insight service plug-in (3704). A plug-in, when installed within a web browser, may generally refer to software that adds extra functionality or feature(s) to any existing functionality/feature(s) of the web browser. To that extent, the insight service plug-in (3704) may reference functionality-extending software that facilitates online content consumption session tracking as disclosed herein. More specifically, when activated (via interaction by an organization user), the insight service plug-in (3704) presents an insight service drop-down menu (3706). The insight service drop-down menu (3706), in turn, reveals a list of options representative of a set of features pertinent to online content consumption session tracking. Said options may include, but are not limited to: a ‘tracking mode’ (e.g., open or private) button, which when interacted with by the organization user, governs a behavior of an insight agent, at least concerning the collection of online consumption information thereby, based on the tracking mode opted by the organization user; when a private tracking mode has been selected, an ‘upload page’ button, which when interacted with by the organization user, enables the transmission of any online resource content (3708, 3710) (or any selected portion thereof), of a currently viewed/visited online resource, to the insight service (not shown) for storage and/or analysis; and a ‘flag content’ button, which when interacted with by the organization user, enables the organization user to indicate a level of relevance or importance associated with any online resource content (3708, 3710) (or any selected portion thereof) of a currently viewed/visited online resource.

FIGS. 37B-37L show example scenarios in accordance with one or more embodiments disclosed herein. The example scenarios, illustrated through FIGS. 37B-37L and described below, are for explanatory purposes only and not intended to limit the scope disclosed herein.

A first example scenario (illustrated and described with respect to FIGS. 37B-37F, below) considers an organization user, identified as Lucy, whom opts to peruse online content via an open tracking mode. While operating under the open tracking mode, an insight agent, executing on a client device belonging to Lucy, freely collects online consumption information without (or with minimal) intervention from Lucy. Conversely, a second example scenario (illustrated and described with respect to FIGS. 37F-37L) considers another organization user, identified as Beth, whom alternatively opts to peruse online content via a private tracking mode. While operating under the private tracking mode, another insight agent, executing on another client device belonging to Beth, collects online consumption information only following manual commands from Beth.

Through the disclosed capability of crowd-sourced research relevance tracking and analytics, the online activities of both Lucy and Beth are monitored, captured (albeit differently due to their respective opted tracking mode), and subsequently analyzed to produce crowd-sourced results. Interactions amongst various actors—e.g., an Insight Agent on a Client Device A (3720) operated by Lucy, an Insight Agent on a Client Device B (3722) operated by Beth, and the Insight Service (3724)—are illustrated in conjunction with components shown across FIGS. 37B-37L and described (in an itemized manner) below. Said interactions, as well as processes performed on/by any particular actor may follow embodiments disclosed herein pertaining to crowd-sourced research relevance tracking and analytics as applied to the circumstances of the example scenarios.

Turning to FIG. 37B:
1. User Lucy opens a web browser (e.g., an online resources accessing program) thus initiating an online content consumption session, where the Insight Agent on Client Device A (3720), the latter of which is being operated by User Lucy, detects said initiation of the online content consumption session
2. The Insight Agent on Client Device A (3720) submits a session initiation notification to the Insight Service (3724), where the session initiation notification specifies user credentials (User Lucy ID) pertaining to User Lucy
3. In response to the submitted session initiation notification and based on the specified user credentials, the Insight Service (3724) obtains a user business intent for User Lucy

Turning to FIG. 37C:
4. The Insight Agent on Client Device A (3720) prompts User Lucy to opt for a tracking mode selection
5. The Insight Agent on Client Device A (3720) obtains the open tracking mode opted by User Lucy
6. User Lucy proceeds to visit a webpage (e.g., an online resource) (via the opened web browser) that pertains to artificial intelligence (AI) research, where the Insight Agent on Client Device A (3720) detects said visitation of the webpage

Turning to FIG. 37D:
7. While operating under the open tracking mode (opted by User Lucy), the Insight Agent on Client Device A (3720) freely collects online consumption information (e.g., generates a metadata file including the webpage URL, at least a portion of the content provided on the webpage, and time spent at the webpage by User Lucy) from the webpage
8. The Insight Agent on Client Device A (3720) submits the collected online consumption information to the Insight Service (3724) 9. User Lucy closes the web browser thus terminating the online content consumption session, where the Insight Agent on Client Device A (3720) detects said termination of the online content consumption session

Turning to FIG. 37E:
A. The Insight Agent on Client Device A (3720) submits a session termination notification to the Insight Service (3724), where the session termination notification specifies user credentials (User Lucy ID) pertaining to User Lucy
B. In response to the submitted session termination notification, the Insight Service (3724) produces weighted online consumption information using the submitted online consumption information and at least a portion of the user business intent (e.g., occupation: engineer, project: AI based inquiry response engine) for User Lucy

Turning to FIG. 37F:
C. The Insight Service (3724) stores the produced weighted online consumption information (related to User Lucy)
D. User Beth opens a web browser (e.g., an online resources accessing program) thus initiating an online content consumption session, where the Insight Agent on Client Device B (3722), the latter of which is being operated by User Beth, detects said initiation of the online content consumption session

Turning to FIG. 37G:
E. The Insight Agent on Client Device B (3722) submits a session initiation notification to the Insight Service (3724), where the session initiation notification specifies user credentials (User Beth ID) pertaining to User Beth
F. In response to the submitted session initiation notification and based on the specified user credentials, the Insight Service (3724) obtains a user business intent for User Beth
G. The Insight Agent on Client Device B (3722) prompts User Beth to opt for a tracking mode selection

Turning to FIG. 37H:
H. The Insight Agent on Client Device B (3722) obtains the private tracking mode opted by User Beth
I. User Beth proceeds to visit a webpage (e.g., an online resource) (via the opened web browser) that pertains to AI research, where the Insight Agent on Client Device B (3722) detects said visitation of the webpage
J. While operating under the private tracking mode (opted by User Beth), the Insight Agent on Client Device B (3722) remains on standby

Turning to FIG. 37I:
K. User Beth (via an available drop-down menu (see e.g., FIG. 37A) integrated into the web browser) opts to manually upload the visited webpage, where the Insight Agent on Client Device B (3722) detects said manual upload of the webpage
L. In response to detecting said manual upload of the webpage (opted by User Beth), the Insight Agent on Client Device B (3722) collects online consumption information (e.g., generates a metadata file including the webpage URL, at least a portion of the content provided on the webpage, and time spent at the webpage by User Beth) from the webpage

Turning to FIG. 37J:
M. The Insight Agent on Client Device B (3722) submits the collected online consumption information to the Insight Service (3724)
N. User Beth closes the web browser thus terminating the online content consumption session, where the Insight Agent on Client Device B (3722) detects said termination of the online content consumption session
O. The Insight Agent on Client Device B (3722) submits a session termination notification to the Insight Service (3724), where the session termination notification specifies user credentials (User Beth ID) pertaining to User Beth

Turning to FIG. 37K:
P. In response to the submitted session termination notification, the Insight Service (3724) produces weighted online consumption information using the submitted online consumption information and at least a portion of the user business intent (e.g., occupation: engineer, project: AI based image classification engine) for User Beth
Q. The Insight Service (3724) stores the produced weighted online consumption information (related to User Beth)

Turning to FIG. 37L:
R. The Insight Service (3724) retrieves a collection of weighted online consumption information including the stored weighted online consumption information (related to User Lucy) and the stored weighted online consumption information (related to User Beth)
S. The Insight Service (3724) subsequently analyzes the retrieved collection of weighted online consumption information to obtain crowd-sourced results (e.g., emergent trends in AI relevant research)

While the embodiments disclosed herein have been described with respect to a limited number of embodiments, those skilled in the art, having benefit of this disclosure, will appreciate that other embodiments can be devised which do not depart from the scope disclosed herein as disclosed herein. Accordingly, the scope disclosed herein should be limited only by the attached claims.

What is claimed is:

1. A method for creating data products, the method comprising:
receiving a data query comprising at least one data topic;
obtaining a metadata graph representative of an asset catalog;
filtering, based on the at least one data topic, the metadata graph to identify at least one node subset;
generating a k-partite metadata graph using the at least one node subset; and
creating a data product based on the k-partite metadata graph.

2. The method of claim 1, wherein creating the data product based on the k-partite metadata graph, comprises:
identifying a super node in the k-partite metadata graph;
extracting first asset metadata from a first asset catalog entry of the asset catalog,
wherein the first asset metadata describes a first asset and the first asset catalog entry corresponds to the super node;
determining a first asset availability for the first asset;
producing availability remarks comprising the first asset availability; and
creating the data product comprising a manifest of assets and the availability remarks, wherein the manifest of assets lists the first asset.

3. The method of claim 2, wherein the super node is representative of a densely connected node in the k-partite metadata graph.

4. The method of claim 2, wherein determining the first asset availability for the first asset, comprises:
generating an asset availability query comprising an asset identifier associated with the first asset;
identifying, from the first asset metadata, a data source associated with the first asset;
submitting the asset availability query to the data source;
receiving, from the data source and in response to the asset availability query, an asset availability reply comprising an asset availability state associated with the first asset; and
determining the first asset availability based on the asset availability state.

5. The method of claim 2, wherein creating the data product based on the k-partite metadata graph, further comprises:
identifying a strong adjacent node connected to the super node and in the k-partite metadata graph;
extracting second asset metadata from a second asset catalog entry of the asset catalog, wherein the second asset metadata describes a second asset and the second asset catalog entry corresponds to the strong adjacent node;
determining a second asset availability for the second asset;
amending the availability remarks to further comprise the second asset availability; and
amending the manifest of assets to further list the second asset.

6. The method of claim 5, wherein the strong adjacent node is representative of a node, in the k-partite metadata graph, connected to the super node via an edge representative of a strong relationship there-between, wherein the strong relationship is quantified by an edge weight associated with the edge that satisfies an edge weight threshold.

7. The method of claim 5, wherein creating the data product based on the k-partite metadata graph, further comprises:
identifying another node in the k-partite metadata graph,
wherein the other node satisfies an identification criterion;
extracting third asset metadata from a third asset catalog entry of the asset catalog,
wherein the third asset metadata describes a third asset and the third asset catalog entry corresponds to the other node;
determining a third asset availability for the third asset;
amending the availability remarks to further comprise the third asset availability; and
amending the manifest of assets to further list the third asset.

8. The method of claim 7, wherein the identification criterion is one selected from a group of criterions comprising a first node positioned along a longest path traversing the k-partite metadata graph and a second node positioned along a shortest path traversing the k-partite metadata graph.

9. The method of claim 7, the method further comprising:
prior to obtaining the metadata graph:
obtaining a user profile for an organization user,
wherein the data query originates from the organization user and the user profile comprises user access permissions associated with the organization user; and
prior to determining the first asset availability, the second asset availability, and the third asset availability:
performing a first assessment of the user access permissions against first compliance information associated with the first asset;
performing a second assessment of the user access permissions against second compliance information associated with the second asset;
performing a third assessment of the user access permissions against third compliance information associated with the third asset; and
producing access remarks based on the first assessment, the second assessment, and the third assessment,
wherein the data product further comprises the access remarks.

10. The method of claim 9, wherein the first asset metadata comprises the first compliance information, wherein the second asset metadata comprises the second compliance information, and wherein the third asset metadata comprises the third compliance information.

11. The method of claim 10, wherein the first assessment results in the first asset being deemed inaccessible to the organization user, wherein the first asset metadata further comprises stewardship information associated with the first asset, and wherein the access remarks at least concerning the first asset comprises an accessibility statement indicating that the first asset is inaccessible to the organization user, at least one reason supporting the accessibility statement, and the stewardship information.

12. The method of claim 9, wherein the first asset, the second asset, and the third asset are each a dataset with relevance to the at least one data topic.

13. The method of claim 9, the method further comprising:
providing, in response to the data query, the data product to the organization user;
receiving, from the organization user, an instantiation request for the data product;
selecting at least one asset from the first asset, the second asset, and the third asset, wherein the at least one asset is both accessible and available;
retrieving the at least one asset from at least one data source; and
providing, in response to the instantiation request, the at least one asset to the organization user.

14. A non-transitory computer readable medium (CRM) comprising computer readable program code, which when executed by a computer processor, enables the computer processor to perform a method for creating data products, the method comprising:
receiving a data query comprising at least one data topic;
obtaining a metadata graph representative of an asset catalog;
filtering, based on the at least one data topic, the metadata graph to identify at least one node subset;
generating a k-partite metadata graph using the at least one node subset; and
creating a data product based on the k-partite metadata graph.

15. The non-transitory CRM of claim 14, wherein creating the data product based on the k-partite metadata graph, comprises:
identifying a super node in the k-partite metadata graph;
extracting first asset metadata from a first asset catalog entry of the asset catalog,
wherein the first asset metadata describes a first asset and the first asset catalog entry corresponds to the super node;
determining a first asset availability for the first asset;
producing availability remarks comprising the first asset availability; and
creating the data product comprising a manifest of assets and the availability remarks, wherein the manifest of assets lists the first asset.

16. The non-transitory CRM of claim 15, wherein creating the data product based on the k-partite metadata graph, further comprises:
identifying a strong adjacent node connected to the super node and in the k-partite metadata graph;
extracting second asset metadata from a second asset catalog entry of the asset catalog,
wherein the second asset metadata describes a second asset and the second asset catalog entry corresponds to the strong adjacent node;
determining a second asset availability for the second asset;
amending the availability remarks to further comprise the second asset availability; and
amending the manifest of assets to further list the second asset.

17. The non-transitory CRM of claim 16, wherein creating the data product based on the k-partite metadata graph, further comprises:
identifying another node in the k-partite metadata graph,
wherein the other node satisfies an identification criterion;
extracting third asset metadata from a third asset catalog entry of the asset catalog,
wherein the third asset metadata describes a third asset and the third asset catalog entry corresponds to the other node;
determining a third asset availability for the third asset;
amending the availability remarks to further comprise the third asset availability; and
amending the manifest of assets to further list the third asset.

18. The non-transitory CRM of claim 17, the method further comprising:
prior to obtaining the metadata graph:
obtaining a user profile for an organization user,
wherein the data query originates from the organization user and the user profile comprises user access permissions associated with the organization user; and
prior to determining the first asset availability, the second asset availability, and the third asset availability:
performing a first assessment of the user access permissions against first compliance information associated with the first asset;
performing a second assessment of the user access permissions against second compliance information associated with the second asset;
performing a third assessment of the user access permissions against third compliance information associated with the third asset; and
producing access remarks based on the first assessment, the second assessment, and the third assessment,
wherein the data product further comprises the access remarks.

19. The non-transitory CRM of claim 18, the method further comprising:
providing, in response to the data query, the data product to the organization user;
receiving, from the organization user, an instantiation request for the data product;
selecting at least one asset from the first asset, the second asset, and the third asset, wherein the at least one asset is both accessible and available;
retrieving the at least one asset from at least one data source; and
providing, in response to the instantiation request, the at least one asset to the organization user.

20. A system, the system comprising:
a client device; and
an insight service operatively connected to the client device, and comprising a computer processor configured to perform a method for creating data products, the method comprising:
receiving, from the client device, a data query comprising at least one data topic;
obtaining a metadata graph representative of an asset catalog;
filtering, based on the at least one data topic, the metadata graph to identify at least one node subset;
generating a k-partite metadata graph using the at least one node subset; and
creating a data product based on the k-partite metadata graph.
